(19) United States
(12) Patent Application Publication
(10) Pub. No.: US 2004/0016910 A1
(43) Pub. Date: Jan. 29, 2004

(54) Non-toxic corrosion-protection rinses and seals based on rare earth elements

(76) Inventors: Andrew Wells Phelps, Kettering, OH (US); Jeffrey Allen Sturgill, Fairborn, OH (US); Joseph Thomas Swartzbaugh, Clayton, OH (US)

Correspondence Address: Killworth, Gottman, Hagan & Schaeff, L.L.P., Suite 500, One Dayton Centre, Dayton, OH, 45402-2023, US

(21) Appl. No.: 10/625,886

(22) Filed: Jul. 23, 2003

Related U.S. Application Data
(63) Continuation-in-part of application No. 10/038,150, filed on Jan. 4, 2002.

(51) Int. Cl. C09K 3/00

(52) U.S. Cl. 252/387

(57) ABSTRACT

Rinsing or sealing solutions comprising a rare earth element and a valence stabilizer for barrier films. The treated films contain a rare earth/valence stabilizer complex. The rare earth element is selected from cerium, praseodymium, terbium, or combinations thereof, and at least one rare earth element is in the tetravalent oxidation state. The rinsing or sealing solution may also contain an optional preparative or solubility control agent. The oxidized rare earth element is present in the coating in a “sparingly soluble” form. The valence stabilizers can be either inorganic or organic in nature. A number of rare earth/valence stabilizer combinations that match the performance of conventional hexavalent chromium systems are presented.

### CROSS-REFERENCE TO RELATED APPLICATIONS

This application is a continuation-in-part of commonly assigned U.S. application Ser. No. 10/038,150, filed Jan. 4, 2002 and entitled “NON-TOXIC CORROSION-PROTECTION RINSES AND SEALS BASED ON COBALT.” This application is also related to U.S. application Ser. No. ______, (Attorney Docket No. UVD 0279 IA), filed ______, 2003 and entitled “NON-TOXIC CORROSION-PROTECTION PIGMENTS BASED ON RARE EARTH ELEMENTS”, which is a continuation-in-part of U.S. application Ser. No. 10/037,576, filed Jan. 4, 2002 and entitled “NON-TOXIC CORROSION-PROTECTION PIGMENTS BASED ON COBALT”, and U.S. application Ser. No. ______, (Attorney Docket No. UVD 0280 IA), filed ______, 2003 and entitled “NON-TOXIC CORROSION-PROTECTION CONVERSION COATS BASED ON RARE EARTH ELEMENTS”, which is a continuation-in-part of U.S. application Ser. No. 10/038,274, filed Jan. 4, 2002 and entitled “NON-TOXIC CORROSION-PROTECTION CONVERSION COATS BASED ON COBALT”, the disclosures of which are incorporated herein by reference.

### BACKGROUND OF THE INVENTION

This invention relates generally to compositions and methods for the formation of protective, corrosion-inhibiting rinses and seals for use to impart additional corrosion resistance to structural materials without the use of chromium in the hexavalent oxidation state. More particularly, this invention relates to non-toxic, corrosion-protective rinses and seals for metal phosphating, anodizing, and “black oxiding” processes based on tetravalent cerium, praseodymium, or terbium and methods of making and using the same.

Metals like aluminum, zinc, titanium, iron, cadmium, tin, indium, lithium, beryllium, magnesium, niobium, tantalum, zirconium, lead, rare earths, copper, and silver, their alloys, or items plated with these metals, require protection from corrosion due to their low oxidation-reduction (redox) potentials or ease of oxide formation. These metal alloys have many uses that range from architectural adornments, to protective coatings themselves, to automotive, structural aerospace, and electronic components, to name a few. The unalloyed metals typically form an outer layer of natural oxide: a “passive film” that serves to protect them and reduce their overall rate of corrosion. However, the corrosion protection offered by the naturally formed oxide layer on certain alloys of these metals is not complete and corrosion will eventually occur unless some form of additional corrosion protection is used. Thus, for example, steels are typically “phosphated” to provide an impermeable coating that not only resists corrosive attack, but also provides a paint base. Additionally, architectural and structural aluminum are frequently “anodized” to form an impermeable oxide film for the same reasons.

Inhibiting the initiation, growth, and extent of corrosion is a significant part of component and systems design for the successful long-term use of metal objects. Uniform physical performance and safety margins of a part, a component, or an entire system can be compromised by corrosion.

One method of enhancing the corrosion resistance of these alloys includes the use of a chemically- or electrolytically-generated coating such as an anodized coating (typically on aluminum), a phosphate coating (typically on electrogalvanized or bare steel), or a black oxide coating (for high strength bearing and tool steels). The metal is exposed to a compound that chemically alters the surface (in phosphating and black oxiding) or an electric current (in anodizing) and forms a coating that provides some corrosion resistance by forming a barrier film. The morphology and possibly the chemistry of the anodic coating or phosphate coating can allow for the formation of a strong bond with subsequently-applied paint systems. An anodic coating is usually applied via immersion in an electrolytic cell. A phosphating or black oxide solution may be applied by immersion, by spray, or by manual means.

These coatings frequently exhibit “flaws” such as pores, pinholes, or thin portions in the coating after formation and do not contain any inherent means to “repair” these coating breaches. The application of a second solution is necessary to fill the pores in the coating and deposit compounds that will act as long-term corrosion protective species. These “second solutions” are termed “rinses” or “seals” in the corrosion literature. The term “rinse” is typically used for the second solution applied to phosphating and black oxide coatings, whereas the term “seal” usually refers to the second solution applied to anodic coatings. These rinses and seals are typically applied via spray techniques, but immersion, fogging, and wiping are also accepted practices.

Hexavalent chromium has traditionally been the active corrosion-inhibiting agent used in rinses and seals for the formation of protective coatings for iron, electrogalvanized iron, aluminum, zinc, magnesium, titanium, cadmium, tin, indium, lithium, and their alloys. Niobium, tantalum, zirconium, beryllium, lead, rare earths, copper, and silver may also be treated with hexavalent chromium rinses and seals for special applications. The three main coating processes that use these rinses and seals are 1) the phosphating process for steel and galvanized steel products, 2) the anodization process for a host of structural metals, and 3) the black oxide process for high-strength steel and iron used for bearing materials. Table 1 illustrates the processes that typically utilize a final chrome “rinse” or “seal” to impart additional corrosion protection to a given substrate material.

TABLE 1
Current Rinse and Seal Processes Using Hexavalent Chromium

| | Comments/ | | Government/ |
|---|---|---|---|
| Process | Examples | Substrate Metals | ASTM/Mil Specs |
| Rinses for zinc | Used as a paint base | Zinc-coated steel, | MIL-P-50002 |
| phosphating on | on all automotive | zinc, or bare steel are | DoD-P-16232 |
| steel, steel products, | bodies, also for some | usual substrates. | MIL-HDBK-205 |
| and nonferrous | coil and sheet stock. | Also for aluminum, | SAE-AMS2481 |
| alloys | Used as a lubricating | magnesium, copper, | QQ-P-416 |
| | layer on tooling dies. | titanium, cadmium, | |
| | | and silver in less | |
| | | common applications. | |
| Seals for anodized | Used extensively for | Aluminum and | MIL-A-8625 |
| aluminum including | architectural and | aluminum alloys | SAE-AMS2470 |
| sulfuric, chromic, | decorative | | ASTM B580 |
| oxalic, boric, | applications, adhesive | | ASTM D1730 |
| sulfonated organic | bonding, siding, etc. | | AA46-78 |
| acids, citric, and | Also used as a paint | | |
| phosphoric acid | base. | | |
| anodizing | | | |
| Rinses for iron | Used as a paint base | Steel and iron alloys | TT-C-490 |
| phosphating on bare | on coil coatings for | | MIL-HDBK-205 |
| steels | general appliance and | | SAE-AMS2481 |
| | siding applications. | | QQ-P-416 |
| | Different from Zn and | | |
| | Mn phosphating. | | |
| Rinses for | Used solely as a solid | Mostly bare steel. | MIL-P-50002 |
| manganese | lubricant, not as a | Can also be used on | DoD-P-16232 |
| phosphating on | paint base. Used | high-strength copper | MIL-HDBK-205 |
| steel and steel | extensively on bearing | alloys. | SAE-AMS2481 |
| alloys, also on | materials. | | |
| nonferrous alloys | | | |
| Rinses for “black | Used solely as a solid | Mostly bare steel. | MIL-C-13924 |
| oxide” and other | lubricant, not as a | Can also be used on | MIL-C-46110 |
| oxide lubricating | paint base. Used | high-strength copper | SAE-AMS2485 |
| layers | extensively on bearing | alloys. | |
| | materials. | | |
| Seals for anodized | Used as a paint and | Magnesium and | MIL-M-45202 |
| magnesium | adhesive base. | magnesium alloys | ASTM D1732 |
| including sulfuric, | | | SAE-AMS2475 |
| chromic, oxalic, | | | MIL-C-13335 |
| boric, sulfonated | | | |
| organic acids, citric, | | | |
| and phosphoric acid | | | |
| anodizing | | | |
| Seals for anodized | Used as a paint and | Titanium and | SAE-AS4194 |
| titanium including | adhesive base. | titanium alloys | SAE AMS-2488 |
| sulfuric, chromic, | | | |
| oxalic, boric, citric, | | | |
| hydrofluoric, and | | | |
| phosphoric acid | | | |
| anodizing | | | |
| Seals for anodized | Used as a paint and | Zinc and zinc alloys | MIL-A-81801 |
| zinc including | adhesive base. | | |
| sulfuric, chromic, | | | |
| oxalic, boric, | | | |
| sulfonated organic | | | |
| acids, citric, and | | | |
| phosphoric acid | | | |
| anodizing | | | |
| Seals for anodized | Used as a paint and | Iron, steel, and steel | QQ-P-35 |
| steel including | adhesive base. | alloys | |
| sulfuric, chromic, | | | |
| oxalic, boric, and | | | |
| phosphoric acid | | | |
| anodizing | | | |
| Seals for anodized | Used for a number of | Copper, cadmium, | QQ-P-416 |
| copper, cadmium, | applications, | silver, tantalum, | |
| silver, tantalum, | principally as a paint | niobium, zirconium, | |
| lead, cobalt, | and adhesive base. | tin, indium, | |
| niobium, zirconium, | For example, niobium | manganese and their | |
| tin, indium, and | and tantalum | alloys | |
| manganese | capacitors, cadmium | | |
| including sulfuric, | plate, silver solder, | | |
| chromic, oxalic, | and zirconium for | | |
| boric, sulfonated | nuclear applications. | | |
| organic acids, citric, | | | |
| and phosphoric acid | | | |
| anodizing | | | |

As shown in Table 1 above, there are three “generic” phosphating processes for steel and steel alloys—zinc, manganese, and iron phosphating. Differences in the coating solutions result in different chemistries and physical attributes in the formed coatings. For example, zinc phosphating is used primarily on galvanized steel sheet, and results in an ideal surface morphology for paint adhesion if the crystals are small in size, and as a solid lubricant for larger size crystals. Manganese phosphating, however, results in a hard, lubricious coating that has no use as a paint base, but exhibits excellent characteristics as a solid lubricant. Manganese phosphating coatings are rarely subjected to a post-chrome rinse, because the corrosion resistance of these coatings is of lesser concern. Iron phosphating is also used as a paint and adhesive base, and always receives post-treatments for corrosion protection.

Similar differences are also noted in anodizing processes. Anodizing processes involve the application of an electric potential under a variety of acidic conditions to the substrate to be coated. Sulfuric acid is the conventional anodizing acid used to form hard oxide films on aluminum, although other anodization solutions have specialized applications. For example, phosphoric acid may be used for adhesive bonding applications on aluminum. Oxalic acid anodization results in a harder, denser coating with higher corrosion resistance than sulfuric acid anodization and is used more often in Europe. Boric acid anodization is used frequently for electronic capacitors although citric and tartaric acid anodization can be used for the same application. Anodization with sulfonated organic acids (such as sulfosalicylic or sulfophthalic acids) is used to impart color during the anodization process. Chromic acid anodization is used on parts with complex shapes where final sealing or rinsing is not possible. Other acids, including hydrofluoric acid, have been used for special applications or in proprietary formulations. Those skilled in the anodization art know that a wide variety of anodizing processes exist due to the multitude of substrate metals, anodizing acids, applied voltages, and final applications.

Finally, “black oxide” coatings are applied to high strength steels and copper-containing alloys to impart a lubricious coating. The difference between “black oxide” coatings and other lubricious coating processes (such as manganese phosphating) is that “black oxide” coatings are applied under caustic, elevated temperature conditions. For example, a concentrated sodium hydroxide solution is raised to its boiling point and the substrate metal is then immersed in this solution. This results in the formation of a lubricious coating of magnetite/ferrite on the surface of steel alloys.

Other coating processes that result in coatings with no inherent self-healing characteristics have also been enhanced through the use of hexavalent chromium rinses and seals. Carbonate coatings on metals such as zinc, iron, magnesium, and especially copper have been described in the early literature as providing some degree of corrosion protection. These coatings can be further enhanced through the use of hexavalent chromium rinses to deposit inhibiting compounds to self-heal coating breaches. Other oxide, phosphate, oxalate, silicate, aluminate, borate or polymeric coatings, or combinations thereof, can also be enhanced via hexavalent chromium rinses and seals.

For each of these three generic coating processes (phosphating, anodizing, and black oxiding), a second, subsequent chemical treatment is often applied. The nature of this second treatment is dependent upon the desired final characteristics of the metal piece. For phosphating and black oxiding processes, this second treatment is usually a rinse of hexavalent chromium, to impart additional corrosion protection to the coating. For anodizing processes, the second treatment can impart a number of useful attributes to the work piece. This second “sealing” process for anodized coatings can include: 1) pure boiling water (to plug the pores with a hydrated alumina composition); 2) silicates (to plug the pores with a silicate composition); 3) dyes or metal-dye complexes (to impart color to the anodic coating); 4) metal salts followed by cathodic reduction (to color the coating via the formation of metals or metal sulfides in the pores); 5) lubricating additives such as molybdenum disulfide or dispersions of polytetrafluoroethylene (to fill the pores with a lubricious additive); and 6) hexavalent chromium seals to fill the pores with chromate species. It is noteworthy that the only one of these six generic sealing processes that results in a coating with self-healing characteristics is the hexavalent chromium seal. The other sealing processes for anodic coatings may temporarily increase the corrosion resistance of the coating by plugging the pores in the oxide coating (e.g., with hydrated alumina or silicate), but the coating does not retain any corrosion-inhibitive species.

The various coating processes to which the art described in this invention is applicable are shown in Table 1 above. The frequent use of hexavalent chrome to “rinse” or “seal” the coating (phosphate, anodic, or black oxide) formed in the first unit operation of the process to impart additional corrosion resistance connects them. These solutions are usually simple formulations consisting of nothing more than dissolved chromium trioxide, chromate, or dichromate. These formulations are usually applied by spraying, although immersion, fogging, or even wiping may also be used.

Sometimes these hexavalent chromium rinse or sealing formulations will contain other constituents. Some formulations include minor concentrations of fluorides. These fluorides act to “etch back” the coating formed in the first unit operation (e.g., phosphate, anodic, or black oxide), thus further facilitating the deposition of corrosion-inhibiting species. Rinsing solutions for phosphate solutions are frequently observed to include phosphoric acid in addition to hexavalent chromium in order to reduce staining of the phosphate coating by the hexavalent chromium. These hexavalent chromium rinse or sealing solutions can also contain other constituents, such as ferricyanides or molybdates. The presence of these other constituents is significant in light of the chemistry developed and presented herein.

Significant efforts have been made to replace chromium with other metals for corrosion-inhibiting applications due to toxicity, environmental, and regulatory concerns. Cerium is one non-toxic, non-regulated metal that has been considered as a chromium replacement. Cerium (like chromium) exhibits more than one oxidation state (Ce⁺³ and Ce⁺⁴). In addition, the oxidation-reduction potential of the Ce⁺⁴—Ce⁺³ couple is comparable to the Cr⁺⁶—Cr⁺³ couple. For example, in acid solution:

Ce⁺⁴+e [symbol] Ce⁺³ +1.72 V

Cr⁺⁶+3e− [symbol] Cr⁺³ +1.36 V

Praseodymium and terbium also exhibit more than one oxidation state (Pr⁺³ and Pr⁺⁴, Tb⁺³ and Tb⁺⁴). Tetravalent praseodymium and terbium are even stronger oxidizing agents than cerium (with calculated redox potentials of +3.2 V in acidic solution—Nugent, L. J., et al., J. Inorg. Nucl. Chem. 33: 2503-30, 1971):

Pr⁺⁴+e^{- Pr} [symbol]⁺³ +3.2 V

Tb⁺⁴+e^{- Tb} [symbol]⁺³ +3.2 V

Cr⁺⁶+3e^{- Cr} [symbol]⁺³ +1.36 V

Accordingly, several processes have been reported in the literature, which make use of cerium in rinsing or sealing bath solutions. However, the coatings formed by these processes provide only limited corrosion protection and do not approach the benefit derived from the use of hexavalent chromium. None of the prior art recognizes the need to “valence stabilize” tetravalent cerium to ensure its long-term stability, nor the need to form tetravalent cerium compounds of optimum solubility characteristics.

The use of film-forming substances, such as polymers, silicates, sol-gel, etc., which have no inherent oxidizing character in sealing or rinsing coating solutions, has been described in the literature. The film formers may enhance short-term corrosion resistance by functioning as a barrier layer. Barrier layers lacking an active corrosion inhibitor have been demonstrated to be capable of inhibiting corrosion as long as the barrier is not breached, as by a scratch or other flaw. Film formers can actually enhance corrosion on a surface after failure due to the well known effects of crevice corrosion.

1) Rinses for Phosphate Coatings

U.S. Pat. No. 2,790,740 to Ayres et al. describes the use of a tetravalent cerium compound (i.e., ceric sulfate) as an accelerator for phosphate coatings on aluminum and zinc. The cerium is added simultaneously with the phosphate treatment. No provisions for post-treatment of the formed phosphate coating through an additional rinse are described. Pores formed during the phosphating step are therefore not sealed. This patent also describes the need to incorporate zinc or manganese compounds with the cerium, as cerium appears to be effective only when used in the presence of substantial proportions of zinc or manganese.

U.S. Pat. No. 2,698,266 to Thirsk decribes the use of hexavalent chromium/tetravalent cerium rinses to seal phosphate and arsenate coatings on aluminum. The use of hexavalent chromium in conjunction with tetravalent cerium represents no appreciable reduction in bath toxicity.

German Patent No. DE 40 41 091 A1 to Metallgesellschaft AG describes the use of trivalent cerium along with tetravalent cerium in a 2:1 to 9:1 ratio for the passivating of phosphated coatings on steel and aluminum. These coating solutions also incorporate fluoride, carboxylate, hydroxycarboxylate, aminocarboxylate, molybdate, and/or tungstate ions in the solution. However, the importance of tetravalent cerium within the formed coating, the “valence stabilization” of this ion, and the solubility ranges for formed tetravalent cerium compounds are not described.

2) Seals for Anodic Coatings

U.S. Pat. No. 5,192,374 to Kindler describes the formation of an aluminum oxide (boehmite) coating on structural aluminum, followed by treatment with a soluble cerium salt and a metal nitrate at 70° C. to 100° C. to form cerium oxides and hydroxides for increased corrosion resistance. The formed oxides and hydroxides are described as filling the pores in the boehmite coating. Also, Stoffer et al. in U.S. Pat. No. 5,932,083 describe the use of a solution containing cerium and an oxidizing agent for treatment of aluminum alloys. The aluminum-containing substrate is electrolyzed in this solution, forming a mixed aluminum oxide/cerium oxide (or hydrated cerium oxide) coating on the aluminum as a barrier film. The formation of tetravalent or hydrated tetravalent cerium oxide is described. However, neither Kindler nor Stoffer et al. teach the use of “valence stabilizers”, which are important for use of tetravalent cerium compounds having aqueous solubilities that are sufficiently high to ensure long-term self healing of the coating. The cerium oxides and hydrated oxides described in these patents function merely as pore-filling barrier layers, and not as active self-healing inhibitors within the coating. Further, the use of tetravalent cerium oxides and hydroxides as corrosion inhibitors results in lower corrosion performance, as is described herein, due to the fact the electrostatic double layers around these species are much smaller than those exhibited by tetravalent cerium species containing 50% or less oxide or hydroxide as attached ligands.

U.S. Pat. Nos. 5,635,084; 5,582,654; and 5,194,138, all to Mansfield et al., describe methods for treating the surface of an aluminum alloy having a relatively high copper content, so as to make the surface resistant to corrosion. The method comprises: a) removing substantially all of the copper from the surface of the alloy, b) contacting the surface with a first solution containing cerium, c) electrically charging the surface while contacting with an aqueous molybdate solution, and d) contacting the surface with a second solution containing cerium. U.S. Pat. No. 5,756,218 to Buchheit et al. describes a process for the corrosion protection of metallic materials that includes sealing a coating with an aqueous solution consisting essentially of at least one soluble metal salt (i.e., Ce). However, the '084, '654 and '218 patents make use of hexavalent chromium in the coating process, and so no advantage in toxicity reduction is achieved. Moreover, electrolysis will only oxidize cerium to the tetravalent state in the outer regions of the already-formed cerium-containing coating. The importance of tetravalent cerium and the functional parameters for tetravalent cerium-containing complexes are not described in any of these prior art references.

U.S. Pat. No. 6,022,425 to Nelson et al. describes the application of a corrosion-resistant coating for aluminum based on cerium, which cerium is oxidized to the tetravalent oxidation state, resulting in the formation of tetravalent or hydrated cerium oxides. However, these references teach tetravalent cerium compounds having aqueous solubilities that are so low they function as barrier films or sealants, rather than active corrosion inhibitors. Moreover, the use of valence stabilizers for forming complexes with tetravalent cerium is not disclosed.

European Application No. EP 0 902 103 A1 by Nippon Steel Corporation describes the application of a trivalent cerium solution with organic oxoacids to aluminum or galvanized steel. U.S. Pat. No. 6,200,672 B1 to Tadokoro et al. describes the use of rare earth and/or Group IVA solutions with selected organic molecules for treatment of metal surfaces. U.S. Pat. No. 5,964,928 to Tomlinson describes the use of a Group IVA compound (i.e., zirconium, titanium, or hafnium) in combination with a rare earth element and optionally a fluoride. European Application No. EP 0 839 931 A2 by Nihon et al. describes an aqueous, metallic surface treating solution comprising a metal element including Ce, an oxidizing source, and an oxyacid or oxyacid salt of phosphorus or an anhydride thereof. However, none of these references teach the presence of a valence stabilized, oxidized rare earth element such as cerium, praseodymium, or terbium in the formed seal, whose availability to the corroding system is controlled via the solubility of the oxidized rare earth compounds. In order to function as a true replacement for hexavalent chromium, which is itself a highly oxidized species, the rare earth compound must be oxidized in the formed seal.

U.S. Pat. No. 6,206,982 B1 to Hughes et al. describes the use of a four component system to provide corrosion protection of aluminum. One of these components includes a rare earth compound, especially cerium.

The use of colloidal suspensions of tetravalent cerium oxide (CeO₂) in anticorrosive coatings is described in U.S. Pat. Nos. 5,922,330 and 5,733,361 to Chane-Ching et al.; PCT International Publication No. WO 96/26255 by Rhone Poulenc Chimie; and PCT International Publication Nos. WO 01/36331 A1 and WO 01/38225 A1 by Rhodia Terres Rares. The CeO₂ exhibits a solubility that is too low for effective release of corrosion-inhibiting tetravalent cerium ions.

An aqueous dispersion of a cerium compound with other rare earths, transition metals, aluminum, gallium, or zirconium is described for anticorrosive agents in PCT International Publication No. WO 01/55029 A1 by Rhodia Terres Rares. Similarly, an aqueous dispersion of cerium oxide in combination with additives such as beta-diketones, alpha-hydroxycarboxylic acids, beta-hydroxycarboxylic acids, or diols is described for anticorrosive agents in U.S. Pat. No. 6,033,677 to Cabane et al. Neither of these references define the need for cerium to be in the tetravalent oxidation state to achieve anticorrosive effects.

The following U.S. patents and published applications provide further examples of corrosion-inhibiting seals from metallic surfaces: U.S. Pat. No. 6,248,184 B1 to Dull et al.; U.S. Application Publication No. 2002/0003093 A1 by Dull et al.; U.S. Application Publication No. 2003/0019391 A1 by Kendig; U.S. Application Publication No. 2003/0024432 A1 by Chung et al.; U.S. Application Publication No. 2002/0033208 A1 to Krishnaswamy, Jr.; U.S. Pat. No. 6,451,443 B1 to Daech; and U.S. Pat. No. 6,299,983 B1 to Van Alsten. However, none of these references teach the need for at least one rare earth element to be in the tetravalent oxidation state.

Accordingly, the need remains for improved rinses and seals which have an effectiveness, ease of application, and performance comparable to coatings formed with hexavalent chromium and which do so without the use of toxic or currently regulated materials.

### SUMMARY OF THE INVENTION

This need is met by the present invention which represents a significant improvement in the formulation of non-toxic rinses and seals through the use of tetravalent cerium, praseodymium, or terbium. Although the present invention is not limited to specific advantages or functionality, it is noted that the rinses and seals of the present invention inhibit corrosion to a higher degree than any other known cerium-based coating. Moreover, the rinses and seals of the present invention inhibit corrosion to a degree comparable to commercial formulations based on hexavalent chromium. As used herein, the term “sealing bath” includes both sealing baths and rinsing baths and the term “seal” includes both seals and rinses.

The present invention utilizes “valency stabilization” of the tetravalent cerium, praseodymium, or terbium ion in the as-formed coating to achieve corrosion resistance that is comparable to hexavalent chromium. More specifically, in order to achieve a high degree of corrosion resistance, a rinse or seal can result in a coating that exhibits the following characteristics:

1) The coating can contain an oxidizing species. The coatings that are subjected to rinsing and sealing (e.g., phosphate, anodic, or black oxide) do not contain oxidizing species. Therefore, the sealing or rinsing solution must supply these oxidizing species. Oxidizing species serve two important functions within the coating: a) they act to impede the flow of charged species through the coating, therefore helping reduce the transport of corrosion reactants, and b) if a scratch is formed in the coating, these oxidizing species act to “repair” the breach by oxidizing the underlying metal and quickly reforming an oxide barrier. The effectiveness of the oxidizing species is a function of its individual oxidation-reduction potential and the more highly oxidized species exhibit greater corrosion protection. An oxidation-reduction potential of approximately +0.80 V (at a pH of 0) appears to be the dividing line between inhibitors that offer some corrosion protection and those that do not. The tetravalent cerium ion, with an oxidation-reduction potential of +1.72 V (at a pH of 0), is an exceptionally good oxidizing species. Tetravalent praseodymium and terbium are even stronger oxidizing agents, with reported oxidation-reduction potentials of +3.2 V at a pH of 0. The hydroxyl and oxygen liberated from water when tetravalent cerium, praseodymium, or terbium is reduced will oxidize (“passivate”) nearby bare metal.

2) A “valence stabilizer” for the tetravalent cerium, praseodymium, or terbium can be employed to ensure that the ion will not be reduced quickly to the trivalent state in solution or in the coating. The importance of stabilizing the cerium, praseodymium, or terbium ion in its tetravalent state in a solid precipitate is important to the composition of rinsing and sealing formulations.

3) The tetravalent cerium, praseodymium, or terbium species formed in the coating (e.g., in the pores) must be present as a “sparingly soluble” material. If the formed tetravalent cerium, praseodymium, or terbium species is too soluble, then it will be washed away. If it is too insoluble, then insufficient tetravalent cerium, praseodymium, or terbium is available to inhibit corrosion. A tetravalent cerium, praseodymium, or terbium species that exhibits low solubility will not only fail to inhibit corrosion, but can also promote localized crevice corrosion and result in enhanced corrosion rates. In order to form an effective rinse or seal, the tetravalent cerium, praseodymium, or terbium compounds formed in the coating pores must be in a “sparingly soluble” form. It is difficult to place specific solubility values to these optimum “sparingly soluble” coating materials because there appear to be several variables associated with what makes an optimum coating material. If the tetravalent cerium, praseodymium, or terbium is incorporated in the coating in the form of a tetravalent cerium, praseodymium, or terbium/valence stabilizer complex which exhibits a solubility in water of between about 5×10⁻⁵ and about 5×10⁻² moles per liter of tetravalent cerium, praseodymium, or terbium, then appreciable corrosion inhibition will be observed. Coatings that incorporate stabilized tetravalent cerium, praseodymium, or terbium compounds that fall outside of this particular solubility range may also exhibit some corrosion inhibition. For example, compositions with solubilities as high as 5×10⁻¹ moles per liter or as low as 1×10⁻⁵ moles per liter of tetravalent cerium, praseodymium, or terbium exhibit some corrosion resistance, although not as great as those compounds which fall within the optimum solubility range. The degree of effectiveness will depend on the particular compound itself. The solubility characteristics of the tetravalent cerium, praseodymium, or terbium in the pores of the coating can be controlled through the use of stabilizer materials, which form compounds that fall within a desired solubility range. In this way, a “controlled release” of tetravalent cerium, praseodymium, or terbium can be achieved, much as a “timed release” of hexavalent chromium is achieved in the state-of-the-art systems.

4) The “valence stabilization” helps to establish an electrostatic barrier layer around the cation-stabilizer complex in aqueous solution. The nature and character of the electrostatic double-layer surrounding the cation-stabilizer complex may be controlled and modified by careful selection of stabilizer species. Characteristics such as the electrical dipole moment and the shape/conformation (for steric effects) of the stabilizer will influence the performance of the formed inhibitor species. In general, the electrostatic double layer formed acts to protect the cation from premature reaction with hydronium, hydroxide, and other ions in solution. The formation of electrostatic barrier layers also helps to impede the passage of corrosive ions through the coating to which the rinse or seal composition was applied, to the metallic surface.

This phenomenon is exhibited in some of the hexavalent chromium systems. For example, in rinses for phosphate coatings wherein some ferricyanide is added to the hexavalent chromium, the highly charged hexavalent chromium ion is surrounded by very polar ferricyanide ions in the as-formed complexes within the pores. The orientation of the dipoles of the ferricyanide ions with respect to the highly charged chromate ion serves to attract additional layers of ions in the aqueous solution. These ions form a protective shell around the chromium ion/ferricyanide complex.

5) The as-formed tetravalent cerium, praseodymium, or terbium/valence stabilizer complex may also exhibit ion exchange behavior towards alkali species. This optional consideration is important because alkali ions (especially sodium) are notoriously corrosive towards alloys which contain metals such as aluminum, zinc, or magnesium. The hexavalent chromium-ferricyanide complex formed in some rinse formulations also exhibits this ion exchange phenomenon. The corrosion resistance of a number of phosphated steel and anodized aluminum alloys as tested using both ASTM B-117 and ASTM G-85 has been enhanced through the use of tetravalent cerium, praseodymium, or terbium species. Their corrosion resistance is comparable to that of hexavalent chromium systems.

The valence stabilizers can be inorganic or organic. A multitude of organic and inorganic stabilizer materials have been used.

In one aspect, the invention comprises a mechanistic and chemical approach to the production of corrosion-resistant rinses and seals using tetravalent cerium, praseodymium, or terbium. This approach uses stabilizer materials which form compounds with tetravalent cerium, praseodymium, or terbium within the as-formed coating that are sparingly soluble in aqueous solution, typically around approximately 5×10⁻² to 5×10⁻⁵ moles/liter of tetravalent cerium, praseodymium, or terbium. This solubility range provides a release of tetravalent cerium, praseodymium, or terbium from the coating at a rate sufficiently slow enough that protection will be provided for an extended period of time and fast enough to inhibit corrosion during conventional accelerated corrosion testing methods such as ASTM B-117 and G-85.

Compounds that fall slightly outside of this solubility range (as high as 5×10⁻¹ to as low as 1×10⁻⁵ moles/liter of tetravalent cerium, praseodymium, or terbium) may also prove to be effective under certain conditions. However, formed compounds that exhibit aqueous solubilities far outside of the target range are unlikely to be effective corrosion inhibitors. The solubility of the formed tetravalent cerium, praseodymium, or terbium compounds within the pores therefore plays a significant role in the effectiveness of the formed coating. Solubility control may be achieved using organic or inorganic stabilizer materials.

In another aspect, the invention is the achievement of corrosion-resistant coatings derived from rinses and seals using tetravalent cerium, praseodymium, or terbium. This approach also utilizes stabilizer materials, which form compounds that exhibit dipoles so as to form electrostatic barrier layers composed of ions, such as hydronium (H₃O⁺) or hydroxide (OH⁻). The formation of these barrier layers through the use of stabilizer materials can be achieved using organic or inorganic materials.

In an optional aspect, the invention is the achievement of corrosion-resistant coatings derived from rinses and seals based on tetravalent cerium, praseodymium, or terbium by the use of stabilizer materials which form compounds that exhibit ion exchange behavior towards alkali ions. The formation of this ion exchange behavior can be achieved through the use of inorganic or organic stabilizer materials.

In another aspect, the invention is the achievement of corrosion-resistant coatings based on rinses or seals containing tetravalent cerium, praseodymium, or terbium that also uses optional preparative agents in conjunction with the cerium, praseodymium, or terbium to strip off some of the already-formed barrier film in the vicinity of the pores. The typical preparative agents for use with tetravalent cerium, praseodymium, or terbium are fluorides and fluorine-containing chemicals. Acidic species or other halides such as chlorides, bromides, and iodides can be used, but are less effective than fluorides as preparative agents.

Accordingly, it is an object of the present invention to provide non-toxic rinses and seals based on tetravalent cerium, praseodymium, or terbium and methods of making and using the same. These and other objects and advantages of the present invention will be more fully understood from the following detailed description of the invention. It is noted that the scope of the claims is defined by the recitations therein and not by the specific discussion of features and advantages set forth in the present description.

### DETAILED DESCRIPTION OF THE INVENTION

### A) Starting Materials

Five general starting materials are used for the rinse and sealing baths of the present invention. These include: a cerium, praseodymium, or terbium source; a valence stabilizer source; an oxidation source (optional if tetravalent cerium, praseodymium, or terbium is already present in the rinse or sealing bath); a preparative agent source (optional); and additional solubility control agents (optional). These materials may be included as neat compounds in the rinse and sealing baths, or may be added to the baths as already-prepared solutions. Likewise, all of the described constituents do not necessarily have to be included within one solution, and in some instances (e.g., additional solubility control agents) it is typical that these constituents are used separately. Further enhancements to the formed coating may be imparted through the use of additional starting materials. Foremost among these are agents to improve the lubricity or color-fastness of the coating.

1) Cerium, Praseodymium, or Terbium Source

a) Cerium Source

The cerium precursor compounds can be almost any cerium compound in which the cerium is in either the trivalent or tetravalent oxidation state. Water-soluble precursors are typically used. Examples of inorganic trivalent cerium (“cerous”) precursor compounds include, but are not restricted to: cerous nitrate, cerous sulfate, cerous perchlorate, cerous chloride, cerous fluoride, cerous bromide, cerous iodide, cerous bromate, and complex fluorides such as cerous fluosilicate, cerous fluotitanate, cerous fluozirconate, cerous fluoborate, and cerous fluoaluminate. Organometallic trivalent cerium precursor compounds include, but are not limited to, cerous formate, cerous acetate, cerous propionate, cerous butyrate, cerous glycolate, cerous lactate, cerous sulfonate, cerous alkylsulfonate, cerous alkoxysulfonate, cerous aromatic sulfonate, cerous aromatoxy sulfonate, cerous sulfamate, cerous alkyl phosphates, and cerous acetylacetonate. Complex trivalent cerium precursor compounds include, but are not limited to, ammonium cerous sulfate, ammonium cerous nitrate, ammonium cerous oxalate, magnesium cerous nitrate, magnesium cerous sulfate, alkali cerous nitrate, and alkali cerous sulfate.

The cerium precursor may also be a compound in which the cerium is already in the tetravalent (“ceric”) oxidation state. Examples of these compounds include, but are not restricted to: ceric chloride, ceric fluoride, ceric perchlorate, ceric sulfate, ceric nitrate, ceric acetate, ceric propionate, ceric butyrate, ammonium ceric nitrate, ammonium ceric sulfate, magnesium ceric nitrate, magnesium ceric sulfate, alkali ceric nitrate, and alkali ceric sulfate.

Insoluble trivalent or tetravalent cerium compounds may be acceptable in some coating solutions, particularly if acids are used as the preparative agent. Examples of insoluble trivalent cerium compounds include cerous carbonate, cerous phosphate, cerous sulfide, cerous fluorocarbonate, cerous benzoate, cerous oxalate, cerous malonate, cerous tartrate, cerous malate, cerous citrate, cerous thiocyanate, cerous salicylate, cerous oxide, and cerous hydroxide. Examples of insoluble tetravalent cerium precursors are ceric hydroxide species (i.e., ceric hydroxysulfate, ceric hydroxychloride, ceric hydroxynitrate, ceric hydroxyphosphate, ceric hydroxyperchlorate, and ceric hydroxyacetate) with a hydroxide content of 50% or less.

It may not be necessary to add a separate cerium source for these conversion coating solutions if a cerium-containing alloy is to be treated. The preparative agent contained within these conversion coating formulations can dissolve some of the cerium in the substrate. This will result in trivalent cerium ions being present in the coating solution. A suitable oxidizer can then oxidize the trivalent cerium to the tetravalent oxidation state during or after coating deposition.

b) Praseodymium Source

The tetravalent praseodymium ion (Pr⁺⁴) is an even better oxidizing species than Ce⁺⁴. It has a radius of 0.085 nanometers, carries a charge of ⁺⁴, and has a redox potential of approximately +3.2 V. However, it has a correspondingly lower stability both in and out of solution. Therefore, valence stabilization of this ion is needed in order to use it effectively in a conversion coating. The very large redox potential of Pr⁺⁴ makes it prone to rapid reduction, and few materials will effectively valence stabilize Pr⁺⁴ in a sparingly soluble complex, which make its routine application problematic. Tetravalent praseodymium can be made using chemical or electrolytic oxidation, as can trivalent praseodymium.

Praseodymium precursors can be nearly any water soluble praseodymium compound in which the praseodymium has a trivalent or tetravalent oxidation state. Water-soluble precursors are typically used. Inorganic praseodymium precursor compounds include, but are not limited to, praseodymium nitrate, praseodymium sulfate, praseodymium perchlorate, praseodymium chloride, praseodymium fluoride, praseodymium bromide, praseodymium iodide, praseodymium bromate, and complex fluorides such as praseodymium fluosilicate, praseodymium fluotitanate, praseodymium fluozirconate, praseodymium fluoborate, and praseodymium fluoaluminate. Organometallic praseodymium precursor compounds include, but are not limited to, praseodymium formate, praseodymium acetate, praseodymium propionate, praseodymium lactate, praseodymium benzenesulfonate, and praseodymium acetylacetonate. Complex praseodymium precursor compounds include, but are not limited to, ammonium praseodymium sulfate, ammonium praseodymium nitrate, magnesium praseodymium nitrate, magnesium praseodymium sulfate, alkali praseodymium nitrate, and alkali praseodymium sulfate.

c) Terbium Source

The tetravalent terbium ion (Tb⁺⁴) is an even better oxidizing species than Ce⁺⁴. It has a radius of 0.076 nanometers, carries a charge of ⁺⁴, and has a redox potential of approximately +3.2 V. However, it has a correspondingly lower stability both in and out of solution. Therefore, valence stabilization of this ion is needed in order to use it effectively in a conversion coating. The very large redox potential of Tb⁺⁴ makes it prone to rapid reduction, and few materials will effectively valence stabilize Tb⁺⁴ in a sparingly soluble complex, which make its routine application problematic. Tetravalent terbium can be made using chemical or electrolytic oxidation, as can trivalent terbium.

Terbium precursors can be nearly any water soluble terbium compound in which the terbium has a trivalent or tetravalent oxidation state. Water-soluble precursors are typically used. Inorganic terbium precursor compounds include, but are not limited to, terbium nitrate, terbium sulfate, terbium perchlorate, terbium chloride, terbium fluoride, terbium bromide, terbium iodide, terbium bromate, and complex fluorides such as terbium fluosilicate, terbium fluotitanate, terbium fluozirconate, terbium fluoborate, and terbium fluoaluminate. Organometallic terbium precursor compounds include, but are not limited to, terbium formate, terbium acetate, terbium propionate, terbium lactate, terbium benzenesulfonate, and terbium acetylacetonate. Complex terbium precursor compounds include, but are not limited to, ammonium terbium sulfate, ammonium terbium nitrate, magnesium terbium nitrate, magnesium terbium sulfate, alkali terbium nitrate, and alkali terbium sulfate.

d) Mixed Cerium, Praseodymium, and Terbium Sources

It is also possible to use mixtures of cerium, praseodymium, and/or terbium sources as feedstock for material preparation. Inclusion of other rare earths (such as yttrium, lanthanum, or neodymium) that cannot be oxidized to the tetravalent state is also permissible. Additionally, minerals that serve as ores for rare earths are ideal source materials for this application. For example, sulfuric acid is often applied to rare earth ores to separate the rare earth mixtures (REM) from native rock. If these sulfuric acid extracts were in turn to be supplied with oxidizers and valence stabilizers, source material for this application is achieved. Examples of rare earth-containing minerals suitable for this application are bastnaesite [(REM)CO₃F], monazite [(REM)PO₄], xenotime [(REM)PO₄], loparite [(REM,Na,Ca)(Ti,Nb)O₃], lanthanite [(REM)₂(CO₃)₃], rhabdophane [(REM)PO₄], fergusonite [(REM)NbO₄], cebaite [Ba₃(REM)₂(CO₃)₅F₂], aeschynite [(Ca,REM)(Ti,Nb)(O,OH)₆], lucasite [(REM)Ti₂(O,OH)₆], stillwellite [(REM,Ca)BSiO₅], samarskite [(REM,Fe)₃(Nb,Ta,Ti)₅O₁₆], parisite [Ca(REM)₂(CO₃)₃F₂], gadolinite [Be₂Fe(REM)₂Si₂O₁₀], fluocerite [(REM)F₃], cerianite [(REM)O₂₋₃], churchite [(REM)PO₄], or combinations thereof.

2) Valence Stabilizers

Corrosion resistance comparable to that of hexavalent chromium can be achieved by the use of valence stabilized tetravalent cerium, praseodymium, or terbium ions in the rinse or sealing baths. Valence stabilization has not been recognized previously as an important consideration in the development of effective corrosion-inhibiting rinses and seals. A variety of inorganic and organic stabilizers are available that can control such properties as solubility, mobility, ion exchange, and binder compatibility. The stabilizer complex can also act as an ion-exchange host and/or trap for alkali or halide ions in solution.

Cerium, praseodymium, and/or terbium are effective as oxidative corrosion inhibitors if they can be supplied in sufficient quantities in the tetravalent charge state when brought into contact with unprotected bare metal. The Ce⁺⁴ ionic radius of 87 picometers is larger than the 44 picometers of the hexavalent chromium ion, and so it will have a correspondingly lower charge density (electrostatic field) per ion. The Pr⁺⁴ and Tb⁺⁴ ionic radii of 85 and 76 picometers, respectively, are comparable in size. As noted in the Summary of the Invention, the valence stabilizer may serve one or more important functions in the establishment of a successful rinse or sealing solution. First, the valence stabilizer, when used with tetravalent cerium, praseodymium, or terbium, results in a “sparingly soluble” Ce⁺⁴-, Pr⁺⁴-, or Tb⁺⁴-valence stabilizer complex. Although the exact solubility of this complex can be slightly modified through the incorporation of different cations or anions (either through the dissolution of the coated metal, or by additional solubility control agents), appreciable corrosion inhibition will be observed if the tetravalent cerium, praseodymium, or terbium is incorporated in the coating enhanced via rinsing or sealing as a Ce⁺⁴-, Pr⁺⁴-, or Tb⁺⁴-stabilizer complex that exhibits a solubility in water of between about 5×10⁻⁵ moles per liter and about 5×10⁻² moles per liter of available Ce⁺⁴, Pr⁺⁴, or Tb⁺⁴. Therefore, any material (inorganic or organic) in the coating bath that complexes with tetravalent cerium, praseodymium, or terbium and results in the formation of a Ce⁺⁴-, Pr⁺⁴-, or Tb⁺⁴-containing complex, which exhibits solubilities within or near this solubility range, can serve as a valence stabilizer for tetravalent cerium, praseodymium, or terbium.

Rinse or sealing solutions that contain valence stabilizers that result in the formation of stabilized cerium, praseodymium, or terbium compounds that fall outside of this particular solubility range may exhibit some degree of corrosion inhibition and may be effective under certain circumstances. Although not as effective as those compounds within the optimum solubility range, compositions with solubilities as high as about 5×10⁻¹ moles per liter or as low as about 1×10⁻⁵ moles per liter of tetravalent cerium, praseodymium, or terbium at standard temperature and pressure (about 25° C. and about 760 Torr) exhibited some corrosion resistance. For example, in situations where the substrate metal pieces are exposed to environments which require much more immediate corrosion exposure (e.g., sudden immersion in seawater), adequate corrosion protection can be achieved through the formation of a tetravalent cerium, praseodymium, or terbium compound which exhibits a higher solubility in water (e.g., 5×10⁻¹ to 5×10⁻³ moles/liter tetravalent cerium, praseodymium, or terbium). In this way, a more “immediate” release of protective cerium, praseodymium, or terbium ions can be achieved, although the tetravalent cerium, praseodymium, or terbium will be depleted faster from the coating. Tetravalent cerium, praseodymium, or terbium solubilities that are lower than this optimum range (e.g., 1×10⁻⁵ to 1×10⁻³ moles/liter of tetravalent cerium, praseodymium, or terbium) may be desirable for some situations (e.g., in nearly pure water with low aeration rates). However, compounds that exhibit solubilities far outside the target range are unlikely to be effective corrosion inhibitors.

The solubility characteristics of the tetravalent cerium, praseodymium, or terbium in the rinsed or sealed coatings are controlled with stabilizer materials that form compounds within the desired solubility range. The exact solubility will be strongly dependent on the application of the rinse or sealing solutions, the nature of the barrier film being treated, and the net aqueous solubility of the overlying paints and coatings.

The formation of coatings with the proper release rate of Ce⁺⁴, Pr⁺⁴, or Tb⁺⁴ ions is problematic because of the instability of Ce⁺⁴ and especially Pr⁺⁴ or Tb⁺⁴ out of solution. Tetravalent cerium compounds such as acetate, sulfate, ammonium ceric nitrate, and ammonium ceric sulfate are generally too soluble to serve as effective corrosion inhibitors if formed from a rinse or seal solution. Oxides and hydroxides of Ce⁺⁴, Pr⁺⁴, or Tb⁺⁴ are much too insoluble in water to serve effectively as corrosion inhibitors in a coating. For example, ceric oxide (CeO₂) is so insoluble that its solubility has never been accurately determined. The more soluble “hydrated” ceric oxide (ceric hydroxide—Ce(OH)₄) is reported to exhibit a solubility product in water between 4.2×10⁻⁵¹ and 1.5×10⁻⁵¹, resulting in a cerium solubility of approximately 5×10⁻¹² moles/liter Ce⁺⁴ (see Tarayan, V. M. and Eliazyan, L. A., Izvest. Akad. Nauk Armyan. S. S. R., Ser. Khim. Nauk 10: 189-93, (1957) in General and Physical Chemistry, vol. 2, col. 9722 (1958) (Abstract)). Similarly, tetravalent praseodymium oxide (Pr₆O₁₁) is reported to exhibit solubility in water of 6.5×10⁻⁷ moles/liter Pr⁺⁴ (see Busch, W., Z. anorg. allgem. Chem. 161: 161-79 (1927) in Chemical Abstracts, vol. 21, p. 2412 (Abstract)). For these low solubility compounds, the release rates of Ce⁺⁴ or Pr⁺⁴ are too low to compare adequately to Cr⁺⁶ from the state-of-the-art coatings.

One method of providing a useful source of tetravalent cerium, praseodymium, or terbium at a metal surface is the creation of a sparingly soluble compound in which the Ce⁺⁴, Pr⁺⁴, or Tb⁺⁴ is shielded from premature reduction during and after compound formation during the rinsing or sealing treatments. The assembly of a protective shell around the highly charged Ce⁺⁴, Pr⁺⁴, or Tb⁺⁴ and its associated oxygen and hydroxyl species can help control the rate at which the cerium, praseodymium, or terbium is reduced and its oxygen is released. Proper selection of materials for forming the protective shell will allow solubility tailoring of the entire assembly to its intended application environment. Valence stabilizers are materials that, when assembled, modify the rate of reduction and solubility of the Ce⁺⁴, Pr⁺⁴, or Tb⁺⁴ ion.

The electrostatic character of the complex should also be considered in order to create a Ce⁺⁴, Pr⁺⁴, or Tb⁺⁴ stabilizer complex with optimal corrosion resistance. Valence stabilizers may also contribute to the development of a substantial electrostatic double layer. An electrostatic double layer of polar or charged species such as hydronium (H₃O⁺) or hydroxide (OH⁻) ions surrounding the stabilized cerium, praseodymium, or terbium complex will help control cerium, praseodymium, or terbium reduction and solubility and enhance the barrier properties of the treated coating. Valence stabilizers which form sparingly soluble cerium, praseodymium, or terbium complexes with enhanced electrostatic double layers will maximize the corrosion-inhibiting character of the rinsed or sealed coating.

The tetravalent cerium, praseodymium, or terbium ions are larger than the hexavalent chromium ion, with less charge density over the surface of the ions. Therefore, the valence stabilizers for Ce⁺⁴, Pr⁺⁴, or Tb⁺⁴ must be more efficient in the establishment of dipole moments than the valence stabilizers typically used for hexavalent chromium so that comparable corrosion resistance can be achieved in relation to the state-of-the-art Cr⁺⁶ compositions. Valence stabilizers which have a comparable dipole moment to the Cr⁺⁶ stabilizers, or which exhibit even less of a dipole moment than the Cr⁺⁶ stabilizers can also function as valence stabilizers, but the resultant corrosion resistance of the treated coatings will, in all probability, be less than for the current commercial hexavalent chromium-based rinses and seals.

Large spheres of hydration around corrosion inhibitors can act as electrostatic and physical barriers to the passage of large corrosive ions such as Cl⁻ and SO₄²⁻ through the coating to the metal surface. The size of the electrostatic double layer is a function of the electrostatic potential at the complex surface and is inversely proportional to the ionic strength of the surrounding solution. Compounds that can carry a charge, have a natural electrostatic dipole, or can have a dipole induced, will likely form an electrostatic double layer in aqueous solution. However, these compounds do not normally act as corrosion inhibitors because they have not been optimized for that purpose.

These facts are relevant when tetravalent cerium's propensity for attracting hydroxide species such as OH⁻ in solution is considered. While a tetravalent cerium ion surrounded solely by OH⁻ (i.e., Ce(OH)₄) may have a slight degree of aqueous solubility, the much lower charge density (electrostatic field) that is exhibited by Ce⁺⁴ (coupled with the muting effect of the surrounding OH⁻ ions) implies that the electrostatic double layer formed around this assemblage will be small. If fewer hydroxide species surround the tetravalent cerium ion (i.e., Ce(OH)₂²⁺ or Ce(OH)³⁺), the electrostatic double layer around these ionic assemblages is increased, which will result in increased corrosion protection. Tetravalent cerium surrounded by no hydroxide species offers the highest degree of corrosion protection.

A simple laboratory experiment confirms this effect. If tetravalent cerium hydroxide (Ce(OH)₄) is placed into deionized water of pH 7, only a minor pH change will be observed, implying that the ionic attraction of this species for hydronium or hydroxide species is minimal. However, if icosahedral Ce(NO₃)₆²⁻ (note that this ion contains no hydroxide) is placed into deionized water of pH 7, a quite remarkable pH drop to −1 can be observed. The released tetravalent cerium ions will scavenge virtually all of the available OH⁻ ions in solution (possibly even degrading H₂O itself to obtain OH³¹), resulting in this dramatic pH drop.

These factors account for the lower corrosion performance of the hydrous oxides and hydroxides formed in many of the prior art references. Because the electrostatic double layers of hydrated cerium oxides and hydroxides are so small, their ability to impede the progress of corroding species is very low, even in the event that a minor concentration of these complexes become soluble. Unlike other known corrosion-resistant compounds described in the art, which extol the formation of hydrous cerium oxides and hydroxides, this invention recognizes that these species result in lower corrosion performance in side-by-side tests. In fact, any oxo- or hydroxo-coordination greater than 50% on the tetravalent cerium ions (i.e., greater than Ce(OH)₂²⁺ or CeO²⁺) is objectionable. It is also for this reason that this invention does not promote the use of hydroxide or oxide precursors as cerium sources.

Optionally, the incorporation of the valence stabilizer (inorganic or organic) may result in the formation of a Ce⁺⁴-, Pr⁺⁴-, or Tb⁺⁴-valence stabilizer compound that also exhibits ion exchange behavior towards alkali ions. As noted in the Summary of the Invention, this is not a requirement of the Ce⁺⁴-, Pr⁺⁴-, or Tb⁺⁴-valence stabilizer complex, but it is a desirable characteristic for enhanced corrosion resistance. Some existing state-of-the-art chromium systems exhibit this phenomenon, but complexes derived from rinse or sealing solutions that do not exhibit this phenomenon have been successfully demonstrated to inhibit corrosive attack.

Rare earth coordination chemistry, which has been the subject of numerous scientific studies for almost 100 years, identifies chemical binding preferences, structure stability, and physical properties of the resulting compounds. Producing effective Ce⁺⁴-, Pr⁺⁴-, or Tb⁺⁴-valence stabilizer complexes requires understanding the electrostatic and structural influence of candidate species on the complex. Stabilizers can be designed that result in cerium, praseodymium, or terbium compounds with the necessary physical, electrical, and chemical properties to form corrosion inhibitors with this information. Property tailoring can also take place through selection of specific anions or cations bound to the Ce⁺⁴-, Pr⁺⁴-, or Tb⁺⁴-valence stabilizer coordination complex.

The functional anatomy of inorganic stabilizers is simple because of the limited number of atoms and structural arrangements involved in their formation. The anatomy of organic stabilizers is not as simple. An organically stabilized cerium, praseodymium, or terbium complex may have one or more organic ligands that may have one or more bonding sites that can interact with the Ce⁺⁴, Pr⁺⁴, or Tb⁺⁴ ion/oxide cluster. The bonding groups can be the same or different atoms or functional groups on an individual or a variety of ligands. An organic stabilizer can be modified in an unlimited number of ways to tailor its physical behavior with respect to such properties as chemical reactivity, solubility, electrostatic and polar character, and functional behavior.

The stability of the Ce⁺⁴-, Pr⁺⁴-, or Tb⁺⁴-valence stabilizer complex is strongly influenced by the charge, polarity, and degree of polarizability of specific binding sites. Factors influencing compound stability include: 1) ion-pair interactions for charged ligands and Ce⁺⁴, Pr⁺⁴, or Tb⁺⁴; 2) ion-dipole and ion-induced dipole interactions for neutral ligands; 3) hydrogen bonding; and 4) the hard-soft acid-base (HSAB) rules convention of coordination chemistry. HSAB rules help identify functional groups on ligands that might be effective as binding sites. Optimum binding for organic valence stabilizers to Ce⁺⁴, Pr⁺⁴, or Tb⁺⁴ will involve ligands with hard bonding species such as those that contain oxygen or nitrogen. Certain coordination complexes of the soft bases sulfur and phosphorus are also effective for binding with Ce⁺⁴, Pr⁺⁴, or Tb⁺⁴. HSAB rules can also help identify groups that might provide a degree of polarization to the stabilizer because of their large dipole moments.

The nature of bonding between the Ce⁺⁴, Pr⁺⁴, or Tb⁺⁴ ion/oxide cluster and the stabilizer ligand can be altered by using a substituent group to modify the stabilizer. Specific interactions between the ligand and Ce⁺⁴, Pr⁺⁴, or Tb⁺⁴ can be tailored by substituent group selection, coupled with altering the size or geometry of the complexing ligand. For example, some substituent groups have large dipole moments associated with them, which will increase the electrostatic barrier layers associated with the cerium, praseodymium, or terbium/valence stabilizer complexes. These include: ketones (═C═O), thioketones (═C═S), amides (—C[═O]—NR₂), thioamides (—C[═S]—NR₂), nitriles or cyano groups (—CN), isocyanides (—NC), nitroso groups (—N═O), thionitroso groups (—N═S), nitro groups (—NO₂), azido groups (—N₃), cyanamide or cyanonitrene groups (═N—CN), cyanate groups (—O—CN), isocyanate groups (—N═C═O), thiocyanate groups (—S—CN), isothiocyanate groups (—N═C═S), nitrosamine groups (═N—N═O), thionitrosamine groups (═N—N═S), nitramine groups (═N—NO₂), thionitramine groups (═N—NS₂), carbonylnitrene groups (—CO—N), thiocarbonylnitrene groups (—CS—N), sulfenyl halides (—S—X), sulfoxides (═S═O), sulfones (═S[═O]₂), sulfinyl groups (—N═S═O), thiosulfinyl groups (—N═S═S), sulfenyl thiocyanato groups (—S—S—CN), sulfenyl cyanato groups (—S—O—CN), sulfodiimine groups (═S[═NH]₂), sulfur dihaloimido groups (—N═SX₂), sulfur oxide dihaloimido groups (—N═S[═O]X₂), aminosulfur oxide trihalide groups (═N—S[═O]X₃), sulfonyl azide groups (—S[═O]₂N₃), sulfonyl thiocyanate groups (—S[═O]₂SCN), sulfonyl cyanate groups (—S[═O]₂OCN), sulfonyl cyanide groups (—S[═O]₂CN), halosulfonate groups (—S[═O]₂OX), phosphonyl thiocyanate groups (—P[═O]OHSCN), phosphonyl cyanate groups (—P[═O]OHOCN), and phosphonyl cyanide groups (—P[═O]OHCN). The polarization of the Ce⁺⁴-, Pr⁺⁴-, or Tb⁺⁴-stabilizer can therefore be optimized via evaluation of the effect of ligand type and substituents. The influence of the Ce⁺⁴, Pr⁺⁴, or Tb⁺⁴ ion on the aqueous solution outside of, or external to, the valence stabilizer shell (or hydration sphere) may play an important role in the complexation properties of a given ligand. The electrostatic action of the Ce⁺⁴, Pr⁺⁴, or Tb⁺⁴ ion on the aqueous solution will also control the diameter of the hydration shell around the Ce⁺⁴-, Pr⁺⁴-, or Tb⁺⁴-stabilizer complex.

The number of binding sites available on the complexing ligand is important to the resulting Ce⁺⁴-, Pr⁺⁴-, or Tb⁺⁴-stabilizer's properties. Several ligands are necessary to stabilize Ce⁺⁴, Pr⁺⁴, or Tb⁺⁴ effectively if the chosen ligand has only one binding site. Six NO₃⁻ ligands are needed to icosahedrally coordinate Ce⁺⁴ in the hexanitratocerate (IV) complex because NO₃⁻ has only one binding site. Bulky ligands with only one binding site, like pyridine, can be sterically hindered from packing tightly around the ion, which will result in decreased complex stability. Conversely, macrocyclic organic and polymeric inorganic ligands may have many suitable binding sites. However, instability will result if a Ce⁺⁴, Pr⁺⁴, or Tb⁺⁴ ion is not completely embraced by all of the multiple macromolecular bonding sites on the ligand. For example, if a macromolecule surrounding the Ce⁺⁴, Pr⁺⁴, or Tb⁺⁴ ion has an insufficient number of binding sites available for charge balance, then the Ce⁺⁴-, Pr⁺⁴-, or Tb⁺⁴-stabilizer complex formed will be much less stable than with a macromolecule that contains an adequate number of sites.

The physical geometry of the binding sites is also important to the stability of the Ce⁺⁴-, Pr⁺⁴-, or Tb⁺⁴-stabilizer complex. The influence of site geometry becomes evident when the solvation shell of a Ce⁺⁴, Pr⁺⁴, or Tb⁺⁴ ion is replaced by the ligand donor atoms, as when rinse or sealing solutions are applied. The number of available ligand binding sites should be at least equal to the standard coordination number of the Ce⁺⁴, Pr⁺⁴, or Tb⁺⁴ ion. The balance between solvation of the ligand and Ce⁺⁴, Pr⁺⁴, or Tb⁺⁴ and their complexation where Ce⁺⁴, Pr⁺⁴, or Tb⁺⁴ is solvated by a specific ligand is one factor in maintaining stability. Ce⁺⁴-, Pr⁺⁴-, or Tb⁺⁴-ligand attraction increases with the number of binding sites on the ligand. However, with increasing number of binding sites, site-site repulsions will also increase, resulting in lower stability.

The Ce⁺⁴, Pr⁺⁴, or Tb⁺⁴ ions generally favor complexation in the icosahedral (coordination number 12) or octahedral (coordination number 6) arrangements. However, these ions will occasionally be found in a cubic, square antiprismatic, or complex arrangement. Valence stabilizers (and stabilizer combinations) should be selected with the goal of achieving these coordinations.

Inorganic materials that tend to “polymerize” and form octahedra or icosahedra (or a combination thereof) around ions such as Ce⁺⁴, Pr⁺⁴, or Tb⁺⁴ are termed isopolyanions, and their resultant complexes with Ce⁺⁴, Pr⁺⁴, or Tb⁺⁴ are termed heteropolyanions or heteropolymetallates. This polymerization of the inorganic valence stabilizer species results in stacks of octahedra or icosahedra with central cavities, which can accommodate at least one Ce⁺⁴, Pr⁺⁴, or Tb⁺⁴ ion, thereby stabilizing it.

Valence stabilizers and combinations of stabilizers can be manipulated by the selection of “shaping groups” and heteroatoms positioned at the binding site. Inorganic valence stabilizers are typically oxygen-containing coordination compounds. Saturated organic chains can form flexible ligands that wrap around Ce⁺⁴, Pr⁺⁴, or Tb⁺⁴ and can enhance their stability. Unsaturated organics typically have less freedom to bend and contort and are less likely to be able to wrap around the Ce⁺⁴, Pr⁺⁴, or Tb⁺⁴ ion. The addition of substituents onto an organic ligand may further restrict its freedom to flex.

The actual size of the valence stabilizer complex situated around the Ce⁺⁴, Pr⁺⁴, or Tb⁺⁴ ion has an important role in solubility control. Solubility of the complex scales roughly with the inverse of its physical diameter. Ce⁺⁴, Pr⁺⁴, or Tb⁺⁴ and their layer of negatively charged hydroxyl ions is very small and results in their high degree of aqueous solubility. The field strength of the complex also scales with the inverse of its physical diameter. Large complexes with an optimal degree of solubility will not necessarily be ideal with respect to the size of the electrostatic double layer. The size of the ligand is therefore balanced against the desired electrical properties.

The addition (or subtraction) of functional groups on organic valence stabilizers can be used to modify the solubility of the formed Ce⁺⁴/, Pr⁺⁴/, or Tb⁺⁴/valence stabilizer species. For example, the addition of sulfonated groups (—SO₃⁻) to organic valence stabilizers will significantly increase the solubility in water. Other substituent groups that will increase the solubility in water include: carboxyl groups (—CO₂—), hydroxyl groups (—OH), ester groups (—CO₃—), carbonyl groups (═C═O), amine groups (—NH₂), nitrosamine groups (═N—N═O), carbonylnitrene groups (—CO—N), sulfoxide groups (═S═O), sulfone groups (═S[═O]₂), sulfinyl groups (—N═S═O), sulfodiimines (═S[═NH]₂), sulfonyl halide groups (—S[═O]₂X), sulfonamide groups (—S[═O]₂NH₂), monohalosulfonamide groups (—S[═O]₂NHX), dihalosulfonamide groups (—S[═O]₂MX₂), halosulfonate groups (—S[═O]₂OX), halosulfonate amide groups (═N—S[═O]₂X), aminosulfonate groups (═N—S[═O]₂OH), iminodisulfonate groups (—N[SO₃⁻]₂), phosphonate groups (—PO₃⁻²), phosphonamide groups (—PO₂NH₂⁻), phosphondiamide groups (—PO[NH₂]₂), aminophosphonate groups (═N—PO₃⁻²), and iminodiphosphonate groups (—N[PO₃⁻²]₂). Conversely, addition of nitro groups (—NO₂), perfluoroalkyl groups (—CₓF₂ₓ₊₁), perchloroalkyl groups (—CₓCl₂ₓ₊₁), nitramine groups (═N—NO₂), thioketone groups (═C═S), sulfenyl halide groups (—S—X), or sulfur dihaloimide groups (—N═SX₂) to an organic valence stabilizer will lower its solubility in water. In this way, the solubility characteristics of valence stabilizers can be “tailored” to meet specific needs.

The physical, chemical, and electrostatic requirements for the design of effective Ce⁺⁴-, Pr⁺⁴-, or Tb⁺⁴-stabilizer complexes result in lists of stabilizers that may be divided into wide band or narrow band stabilizer classes. The compounds listed here are general guides for the initial selection of a coordination compound and do not represent a complete or final list. New organic and inorganic compounds are continuously being developed, compound toxicity limits can change, and some currently available compounds may have been overlooked. Tailoring substituent groups and the selection of cations or anions for charge balance can influence whether a particular Ce⁺⁴-, Pr⁺⁴-, or Tb⁺⁴-stabilizer complex will have a wide band or narrow band character.

Valence stabilizers for tetravalent cerium, praseodymium, or terbium that embody the desirable characteristics of stabilizers as described above are typical when designing a rinse or seal solution for maximum effectiveness. These “wide band” stabilizers result in the formation of compounds that provide significant corrosion resistance when used with tetravalent cerium, praseodymium, or terbium. Less typical valence stabilizers (“narrow band”) result in satisfactory corrosion inhibition only under limited applications. Wide band rinse or sealing solutions for general purpose applications and narrow band derivatives for specific uses have been identified and developed. Wide band behavior (stability, solubility, and polarization) can be achieved by both inorganic and organic valence stabilizers, as can ion exchange capability.

In general, valence stabilizers that form cerium, praseodymium, or terbium complexes, which exhibit the necessary physical properties of stability, solubility, and polarization, may be achieved with both inorganic and organic valence stabilizers. Ion exchange behavior can also be achieved with both inorganic and organic coordination compounds.

2a) Wide Band Inorganic Valence Stabilizers for Tetravalent Cerium

Wide band inorganic valence stabilizers are formed around the Ce⁺⁴ ion by polymerizing in the rinse or sealing solution near the barrier layer/substrate metal surface being treated. Acidic solutions can become basic near the work piece surface (and especially within the pores in the treated barrier film) where precipitation of the cerium- or praseodymium-stabilizer complex occurs during the rinsing or sealing process. Inorganic wide band valence stabilizers for Ce⁺⁴ include, but are not limited to: molybdates (Mo⁺⁶, Mo⁺⁵, or Mo⁺⁴, for example [Ce^{+Mo}₁₂O₄₂]⁸⁻, [Ce⁺⁴Mo₇O₂₄]²⁻, and [Ce⁺⁴₂Mo₁₄O₄₈]⁴⁻); tungstates (W⁺⁶, W⁺⁵, or W⁺⁴, for example [Ce⁺⁴W₁₂O₄₂]⁸⁻, [Ce⁺⁴W₈O₂₈]⁴⁻, and [Ce⁺⁴W₁₀O₃₅]⁶⁻); vanadates (V⁺⁵ or V⁺⁴, for example [Ce⁺⁴V₁₈O₅₁]⁸⁻); niobates (Nb⁺⁵ or Nb⁺⁴, for example [Ce⁺⁴Nb₂O₆(OH)₄]²⁻); tantalates (Ta⁺⁵ or Ta⁺⁴, for example [Ce⁺⁴Ta₂O₆(OH)₄]²⁻); tellurates (Te⁺⁶ or Te⁺⁴, for example Ce⁺⁴(TeO₄)₂); periodates (I⁺⁷, for example [Ce⁺⁴IO₆]¹⁻); iodates (I⁺⁵, for example Ce⁺⁴(IO₃)₄); carbonates (C⁺⁴, for example [Ce⁺⁴(CO₃)₅]⁶⁻); antimonates (Sb⁺⁵ or Sb⁺³); stannates (Sn⁺⁴); phosphates (P⁺⁵, for example Ce⁺⁴₃(PO₄)₄, Ce⁺⁴(HPO₄)₂, Ce⁺⁴P₂O₇, and [Ce⁺⁴(P₂O₇)₂]⁴⁻); nitrates (N⁺⁵, for example [Ce⁺⁴(NO₃)₆]²⁻); bromates (Br⁺⁵, for example Ce⁺⁴(BrO₃)₄); and sulfates (S⁺⁶, for example [Ce⁺⁴(SO₄)₄]⁴⁻). Many of these inorganics form octahedral and icosahedral structures on precipitation from solution. For example, tellurate ions begin to polymerize in solution near pH 5 and will complex with Ce⁺⁴ ions near the work piece or within the treated barrier film pores as solution pH increases. The exact chemical nature of these valence stabilizers (i.e., chemical formulation and valence state of the atom in the center of the icosahedra or octahedra) is highly dependent upon the specific pH and redox conditions.

The stability of the heteropolymetallates is a function of composition and structure. The relatively unstable Ce⁺⁴ ion is protected and stabilized within the surrounding octahedral and icosahedral groups, although specific configurations of the heteropolymetallate anions differ from stabilizer to stabilizer (i.e., from molybdate to periodate to carbonate).

The dimensions of the octahedra and icosahedra are controlled by the size of the heteroatom (e.g., Mo, W, Te) around which they are assembled. A Ce⁺⁴ ion trapped by the precipitation of these heteropolymetallates and its resulting “ion within a cage” structure can exhibit an even greater apparent volume due to the development of a large electrostatic double layer. This will influence both the valence stabilization of the Ce⁺⁴ as well as the solubility of the assembled complex. These compounds are also reported to be excellent ion exchange agents for alkali ions.

This caging structure serves to lower the solubility of the Ce⁺⁴ because the chemical elements typically associated with many of these valence stabilizers (e.g., I, Te, Mo, W) are all inherently less soluble in water than Ce⁺⁴. These materials can also establish oriented dipoles with the interior Ce⁺⁴ ion, thereby forming the desired barrier layers (e.g., of hydronium ions), much as ferricyanide or molybdate contributes to some hexavalent chrome systems. Finally, the elements associated with these valence stabilizers themselves can contain high valence ions, such as V⁺⁵, Te⁺⁶, or Mo⁺⁶, which will also serve somewhat in corrosion protection, although not to the degree of Ce⁺⁴, due to their lower redox potential.

Water-soluble precursors for the formation of these valence stabilizers are desirable in order to ensure that sufficient material is available for coating deposition from aqueous solutions. Identification of suitable water-soluble precursors may be difficult, since many of the elements associated with these valence stabilizers (e.g., Mo, W, Te, etc.) do not typically form water-soluble compounds (hence, their beneficial use as a valence stabilizer). Representative examples of suitable precursors for “wide band” inorganic valence stabilizers are listed in Table 5.

The solubilities given in Table 5 are usually for the simplest salts of each compound. More complex, partially “polymerized” salts for each compound (e.g., para- or meta-polymorphs) can also be used as precursors, although these polymorphs typically exhibit slightly lower solubilities in water than the simple salts. Peroxo-salts of these compounds, especially percarbonates, permolybdates, pertungstates, and pervanadates can also be utilized as precursors. Formation of the chosen heteropolymetallates from precursors such as the fluorides, chlorides, bromides, nitrates, and perchlorates (e.g., SnCl₄ to form heterostannates, SbF₅ to form heteroantimonates, etc.) proved to be difficult, but may be acceptable under certain circumstances.

Ce⁺⁴ stabilized with a heteropolymolybdate complex is an example of a wide band inorganically stabilized cerium complex. This complex is very stable and provides significant corrosion protection when it is formed from a rinsing or sealing solution. The size of the cavity developed at the center of a ligand with three or more bonding sites is important. A cavity that is too large or too small will tend to be less stable and less effective as a corrosion inhibitor.

The valence stabilizer can be a cross between two or more of the wide-band inorganic valence stabilizers listed above. For example, in some instances it may be desirable to form a valence stabilizer out of a periodate and a molybdate. During the coating process, both of these materials will polymerize to form a mixed periodate/molybdate valence stabilizer out of the rinsing or sealing solution.

2b) Wide Band Organic Valence Stabilizers for Tetravalent Cerium

A variety of organic compounds meet the criteria to be typical valence stabilizers for Ce⁺⁴. These coordination ligands produce Ce⁺⁴ valence stabilized complexes, which fulfill the general requirements of a Ce⁺⁴ rinse or seal inhibitor material. Organic compounds can be very effective cerium stabilizers and provide the greatest degree of freedom in designing new stabilizer species with new functionalities. There are many more possible organic valence stabilizer species than inorganic valence stabilizers because of the large number of organic compounds and functionalities which exist. Some of the typical organic valence stabilizer species are listed in Table 2 below.

The number of wide band (and narrow band) organic compounds that are acceptable as valence stabilizers for tetravalent cerium is limited. Common organic compounds such as alcohols, aldehydes, ketones, esters, ethers, alkyl or aromatic halides, most carboxylic acids, anhydrides, phenols, sulfonic acids, phosphonic acids, carbohydrates, waxes, fats, sugars, and oils are not as effective as the structural types described in these Tables to stabilize the tetravalent cerium ion. At best, some of the organic types described in the Tables herein may presently be used for other industrial applications, but their incorporation into corrosion-inhibiting blends to stabilize tetravalent cerium has heretofore been unrecognized.

The choice of substituent functional groups on these general classes of valence stabilizers will affect the physicochemical properties of the Ce⁺⁴-containing complex and the corrosion resistance achieved using that complex. For example, the addition of —NH₂ or ═O substituents increases the net polarization of the overall Ce⁺⁴-valence stabilizer complex, but this will also increase its water solubility. Careful molecular design of Ce⁺⁴ complexes is necessary to achieve desired performance characteristics.

In general, the bonding atoms in typical organic valence stabilizers are oxygen or nitrogen, with sulfur or phosphorus being acceptable in some circumstances. Sulfur or phosphorus are complexed with Ce⁺⁴ most frequently in association with oxygen. Bonding atoms such as carbon, silicon, tin, arsenic, selenium, and antimony are much less desirable due to problems with valence stability, toxicity, or solubility. These valence stabilizers all serve to stabilize the Ce⁺⁴ ion within a sparingly soluble complex that can exhibit a polar character in aqueous solution.

TABLE 2
Wide Band Organic Valence Stabilizers for the Ce⁺⁴ Ion

| General Structural Name | |
|---|---|
| (Type of Organic) | Structural Representation |
| N Valence Stabilizer #1: | NH₃, NH₂R, NHR₂, and NR₃ where R |
| Monoamines (N Monodentates) | represents H or any organic functional group |
| | wherein the number of carbon atoms ranges |
| | from 0 to 40, optionally having halogen or |
| | polarizing or water-insolubilizing/solubilizing |
| | groups attached. Ligand can also contain |
| | nonbinding N, O, S, or P atoms. |
| N Valence Stabilizer #2: | R′—N—R—N—R″, where R, R′, and R″ represent H |
| Diamines (N—N Bidentates) | or any organic functional group wherein the |
| | number of carbon atoms ranges from 0 to 40, |
| | optionally having halogen or polarizing or |
| | water-insolubilizing/solubilizing groups |
| | attached. Ligand can also contain nonbinding |
| | N, O, S, or P atoms. |
| N Valence Stabilizer #3: | R—N—R′—N—R″—N—R″′, where R, R′, R″, and R″′ |
| Triamines (either N—N Bidentates or N—N | represent H or any organic functional group |
| Tridentates) | wherein the number of carbon atoms ranges |
| | from 0 to 40, optionally having halogen or |
| | polarizing or water-insolubilizing/solubilizing |
| | groups attached. Ligand can also contain |
| | nonbinding N, O, S, or P atoms. |
| N Valence Stabilizer #4: | R—N—R′—N—R″—N—R″′—N—R″″, where R, R′, R″, |
| Tetramines (N—N Bidentates, N—N | R″′, and R″″ represent H or any organic |
| Tridentates, or N—N Tetradentates) | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| N Valence Stabilizer #5: | R—N—R′—N—R″—N—R″′—N—R″″—N—R″″′, where R, |
| Pentamines (N—N Bidentates, N—N | R′, R″, R″′, R″″and R″″′ represent H or any |
| Tridentates, or N—N Tetradentates) | organic functional group wherein the number of |
| | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. |
| N Valence Stabilizer #6: | R—N—R′—N—R″—N—R″′—N—R″″—N—R″″′—N—R″″″, |
| Hexamines (N—N Bidentates, N—N | where R, R′, R″, R″′, R″″, R″″′, and R″″″ |
| Tridentates, N—N Tetradentates, or N—N | represent H or any organic functional group |
| Hexadentates) | wherein the number of carbon atoms ranges |
| | from 0 to 40, optionally having halogen or |
| | polarizing or water-insolubilizing/solubilizing |
| | groups attached. Ligand can also contain |
| | nonbinding N, O, S, or P atoms. |
| N Valence Stabilizer #7: | Five membered heterocyclic ring containing |
| Five-Membered Heterocyclic Rings | one, two, three, or four nitrogen atoms, all of |
| containing One, Two, Three, or Four | which may or may not function as binding sites. |
| Nitrogen Atoms wherein at least one | Can include other ring systems bound to this |
| Nitrogen Atom is a Binding Site (N | heterocyclic ring, but they do not coordinate |
| Monodentates or N—N Bidentates) | with the stabilized, high valence metal ion. |
| | Ring can also contain O, S, or P atoms. This 5- |
| | membered ring and/or attached, uncoordinating |
| | rings may or may not have halogen or |
| | polarizing or water-insolubilizing/solubilizing |
| | groups attached. |
| N Valence Stabilizer #8: | Six membered heterocyclic ring containing one, |
| Six-Membered Heterocyclic Rings | two, three, or four nitrogen atoms, all of which |
| containing One, Two, Three, or Four | may or may not function as binding sites. Can |
| Nitrogen Atoms wherein at least one | include other ring systems bound to this |
| Nitrogen Atom is a Binding Site (N | heterocyclic ring, but they do not coordinate |
| Monodentates or N—N Bidentates) | with the stabilized, high valence metal ion. |
| | Ring can also contain O, S, or P atoms. This 6- |
| | membered ring and/or attached, uncoordinating |
| | rings may or may not have halogen or |
| | polarizing or water-insolubilizing/solubilizing |
| | groups attached. |
| N Valence Stabilizer #9: | Five membered heterocyclic ring(s) containing |
| Five-Membered Heterocyclic Rings | one, two, three, or four nitrogen atoms. In |
| containing One, Two, Three, or Four | addition, ligand contains additional nitrogen- |
| Nitrogen Atoms and having at least one | containing substituents (usually amines) that |
| additional Nitrogen Atom Binding Site not | constitute N binding sites. Can include other |
| in a Ring (N Monodentates, N—N | ring systems bound to the heterocyclic ring or to |
| Bidentates, N Tridentates, N—N | the N-containing substituent, but they do not |
| Tetradentates, or N—N Hexadentates) | coordinate with the stabilized, high valence |
| | metal ion. Ring(s) can also contain O, S, or P |
| | atoms. This 5-membered ring(s) and/or |
| | attached, uncoordinating rings and/or N- |
| | containing substituent(s) may or may not have |
| | halogen or polarizing or water- |
| | insolubilizing/solubilizing groups attached. |
| N Valence Stabilizer #10: | Six membered heterocyclic ring(s) containing |
| Six-Membered Heterocyclic Rings | one, two, three, or four nitrogen atoms. In |
| containing One, Two, Three, or Four | addition, ligand contains additional nitrogen- |
| Nitrogen Atoms at least one additional | containing substituents (usually amines) that |
| Nitrogen Atom Binding Site not in a Ring | constitute N binding sites. Can include other |
| (N Monodentates, N—N Bidentates, N—N | ring systems bound to the heterocyclic ring or to |
| Tridentates, N—N Tetradentates, or N—N | the N-containing substituent, but they do not |
| Hexadentates) | coordinate with the stabilized, high valence |
| | metal ion. Ring(s) can also contain O, S, or P |
| | atoms. This 6-membered ring(s) and/or |
| | attached, uncoordinating rings and/or N- |
| | containing substituent(s) may or may not have |
| | halogen or polarizing or water- |
| | insolubilizing/solubilizing groups attached. |
| N Valence Stabilizer #11: | Five membered heterocyclic ring(s) containing |
| Five-Membered Heterocyclic Rings | one, two, three, or four nitrogen atoms. In |
| containing One, Two, Three, or Four | addition, ligand contains additional nitrogen- |
| Nitrogen Atoms at least one additional | containing rings that constitute N binding sites. |
| Nitrogen Atom Binding Site in a Separate | Can include other ring systems bound to the N- |
| Ring (N Monodentates, N—N Bidentates, N—N | containing heterocyclic rings, but they do not |
| Tridentates, N—N Tetradentates) | coordinate with the stabilized, high valence |
| | metal ion. Ring(s) can also contain O, S, or P |
| | atoms. This 5-membered ring(s) and/or |
| | additional N-containing ring(s) and/or attached, |
| | uncoordinating rings may or may not have |
| | halogen or polarizing or water- |
| | insolubilizing/solubilizing groups attached. |
| N Valence Stabilizer #12: | Six membered heterocyclic ring(s) containing |
| Six-Membered Heterocyclic Rings | one, two, three, or four nitrogen atoms. In |
| containing One, Two, Three, or Four | addition, ligand contains additional nitrogen- |
| Nitrogen Atoms at least one additional | containing rings that constitute N binding sites. |
| Nitrogen Atom Binding Site in a Separate | Can include other ring systems bound to the N- |
| Ring (N Monodentates, N—N Bidentates, N—N | containing heterocyclic rings, but they do not |
| Tridentates, N—N Tetradentates) | coordinate with the stabilized, high valence |
| | metal ion. Ring(s) can also contain O, S, or P |
| | atoms. This 6-membered ring(s) and/or |
| | additional N-containing ring(s) and/or attached, |
| | uncoordinating rings may or may not have |
| | halogen or polarizing or water- |
| | insolubilizing/solubilizing groups attached. |
| N Valence Stabilizer #13: | Macrocyclic ligands containing two, three, four, |
| Two-, Three-, Four-, Six-, Eight-, and Ten- | six, eight, or ten nitrogen binding sites to |
| Membered Macrocyclics, Macrobicyclics, | valence stabilize the central metal ion. Can |
| and Macropolycyclics (including | include other hydrocarbon or ring systems |
| Catapinands, Cryptands, Cyclidenes, and | bound to this macrocyclic ligand, but they do |
| Sepulchrates) wherein all Binding Sites are | not coordinate with the stabilized, high valence |
| composed of Nitrogen (usually amine or | metal ion. This ligand and/or attached, |
| imine groups) and are not contained in | uncoordinating hydrocarbons/rings may or may |
| Component Heterocyclic Rings (N—N | not have halogen or polarizing or water- |
| Bidentates, N—N Tridentates, N—N | insolubilizing/solubilizing groups attached. |
| Tetradentates, and N—N Hexadentates) | |
| N Valence Stabilizer #14: | Macrocyclic ligands containing a total of four, |
| Four-, Six-, Eight-, or Ten-Membered | six, eight, or ten five-membered heterocyclic |
| Macrocyclics, Macrobicyclics, and | rings containing nitrogen binding sites. Can |
| Macropolycyclics (including Catapinands, | include other hydrocarbon/ring systems bound |
| Cryptands, Cyclidenes, and Sepulchrates) | to this macrocyclic ligand, but they do not |
| wherein all Binding Sites are composed of | coordinate with the stabilized, high valence |
| Nitrogen and are contained in Component | metal ion. This ligand and/or attached, |
| 5-Membered Heterocyclic Rings (N—N | uncoordinating hydrocarbon/rings may or may |
| Bidentates, N—N Tridentates, N—N | not have halogen or polarizing or water- |
| Tetradentates, or N—N Hexadentates) | insolubilizing groups attached. |
| N Valence Stabilizer #15: | Macrocyclic ligands containing at least one 5- |
| Four-, Six-, Eight-, or Ten-Membered | membered heterocyclic ring. These |
| Macrocyclics, Macrobicyclics, and | heterocyclic rings provide nitrogen binding sites |
| Macropolycyclics (including Catapinands, | to valence stabilize the central metal ion. Other |
| Cryptands, Cyclidenes, and Sepulchrates) | amine or imine binding sites can also be |
| wherein all Binding Sites are composed of | included in the macrocyclic ligand, so long as |
| Nitrogen and are contained in a | the total number of binding sites is four, six, |
| Combination of 5-Membered Heterocyclic | eight, or ten. Can include other |
| Rings and Amine or Imine Groups (N—N | hydrocarbon/ring systems bound to this |
| Bidentates, N—N Tridentates, N—N | macrocyclic ligand, but they do not coordinate |
| Tetradentates, or N—N Hexadentates) | with the stabilized, high valence metal ion. This |
| | ligand and/or attached, uncoordinating |
| | hydrocarbon/rings may or may not have halogen |
| | or polarizing or water-insolubilizing groups |
| | attached. |
| N Valence Stabilizer #16: | Macrocyclic ligands containing a total of four, |
| Four-, Six-, Eight-, or Ten-Membered | six, eight, or ten six-membered heterocyclic |
| Macrocyclics, Macrobicyclics, and | rings containing nitrogen binding sites. Can |
| Macropolycyclics (including Catapinands, | include other hydrocarbon/ring systems bound |
| Cryptands, Cyclidenes, and Sepulchrates) | to this macrocyclic ligand, but they do not |
| wherein all Binding Sites are composed of | coordinate with the stabilized, high valence |
| Nitrogen and are contained in Component | metal ion. This ligand and/or attached, |
| 6-Membered Heterocyclic Rings (N—N | uncoordinating hydrocarbon/rings may or may |
| Bidentates, N—N Tridentates, N—N | not have halogen or polarizing or water- |
| Tetradentates, or N—N Hexadentates) | insolubilizing groups attached. |
| N Valence Stabilizer #17: | Macrocyclic ligands containing at least one 6- |
| Four-, Six-, Eight-, or Ten-Membered | membered heterocyclic ring. These |
| Macrocyclics, Macrobicyclics, and | heterocyclic rings provide nitrogen binding sites |
| Macropolycyclics (including Catapinands, | to valence stabilize the central metal ion. Other |
| Cryptands, Cyclidenes, and Sepulchrates) | amine or imine binding sites can also be |
| wherein all Binding Sites are composed of | included in the macrocyclic ligand, so long as |
| Nitrogen and are contained in a | the total number of binding sites is four, six, |
| Combination of 6-Membered Heterocyclic | eight, or ten. Can include other |
| Rings and Amine or Imine Groups (N—N | hydrocarbon/ring systems bound to this |
| Bidentates, N—N Tridentates, N—N | macrocyclic ligand, but they do not coordinate |
| Tetradentates, or N—N Hexadentates) | with the stablized, high valence metal ion. This |
| | ligand and/or attached, uncoordinating |
| | hydrocarbon/rings may or may not have halogen |
| | or polarizing or water-insolubilizing groups |
| | attached. |
| N Valence Stabilizer #18: | R′—NH—C(—R)═N—R″, where R, R′, and R″ |
| Amidines and Diamidines (N—N Bidentates | represent H or any organic functional group |
| and N—N Tetradentates) | wherein the number of carbon atoms ranges |
| | from 0 to 40, optionally having halogen or |
| | polarizing or water-insolubilizing/solubilizing |
| | groups attached. Ligand can also contain |
| | nonbinding N, O, S, or P atoms. |
| N Valence Stabilizer #19: | RR′—N—C(═NH)—NR″—C(═NH)—NR″′R″″ for |
| Biguanides (Imidodicarbonimidic Diamides | biguanides, RR′—N—C(═NH)—NR″—NH—C(═NH)— |
| or Dihydrazides), Biguanidines, | NR″′R″″ for biguanidines, where R, R′, R″, |
| Imidotricarbonimidic Diamides or | R″′, and R″″ represent H, NH₂, or any organic |
| Dihydrazides, Imidotetracarbonimidic | functional group wherein the number of carbon |
| Diamides or Dihydrazides, Dibiguanides, | atoms ranges from 0 to 40, halogen or |
| Bis(biguanidines), Polybiguanides, and | polarizing or water-insolubilizing/solubilizing |
| Poly(biguanidines) (N—N Bidentates, N—N | groups attached. Ligand can also contain |
| Tridentates, N—N Tetradentates, and N—N | nonbinding N, O, S, or P atoms. |
| Hexadentates) | |
| N Valence Stabilizer #20: | RR′—N—C(═NH)—CR″R″′—C(═NH)—NR″″R″″′, |
| Diamidinomethanes, | where R, R′, R″, R″′, R″″, and R″″′ represent |
| Bis(amidinomethanes), and | H, NH₂, or any organic functional group |
| Poly(amidinomethanes) (N—N Bidentates, | wherein the number of carbon atoms ranges |
| N—N Tridentates, N—N Tetradentates, and N—N | from 0 to 40, optionally having halogen or |
| Hexadentates) | polarizing or water-insolubilizing/solubilizing |
| | groups attached. Ligand can also contain |
| | nonbinding N, O, S, or P atoms. |
| N Valence Stabilizer #21: | RR′—N—C(═NH)—NR″—C(═NH)—R″′ for |
| Imidoylguanidines, Amidinoguanidines, | imidoylguanidines, and RR′—N—C(═NH)—NR″— |
| Bis(imidoylguanidines), | NH—C(═NH)—R″′ for amidinoguanidines, where |
| Bis(amidinoguanidines), | R, R′, R″, and R″′ represent H, NH₂, or any |
| Poly(imidoylguanidines), and | organic functional group wherein the number of |
| Poly(amidinoguanidines) (N—N Bidentates, | carbon atoms ranges from 0 to 40, optionally |
| N—N Tridentates, N—N Tetradentates) | having halogen or polarizing or water- |
| | insolubilizing/solubilizing groups attached. |
| | Ligand can also contain nonbinding N, O, S, or |
| | P atoms. |
| N Valence Stabilizer #22: | RR′—N—C(═NH)—O—C(═NH)—NR″R″′, where R, |
| Diformamidine oxides (Dicarbonimidic | R′, R″, and R″′ represent H, NH₂, or any |
| Diamides or Dihydrazides), | organic functional group wherein the number of |
| Tricarbonimidic Diamides or Dihydrazides, | carbon atoms ranges from 0 to 40, optionally |
| Tetracarbonimidic Diamides or | having halogen or polarizing or water- |
| Dihydrazides, Bis(diformamidine oxides), | insolubilizing/solubilizing groups attached. |
| and Poly(diformamidine oxides) (N—N | Ligand can also contain nonbinding N, O, S, or |
| Bidentates, N—N Tridentates, N—N | P atoms. |
| Tetradentates) | |
| N Valence Stabilizer #23: | RR′—N—C(═NH)—S—C(═NH)—NR″R″′, where R, |
| Diformamidine Sulfides | R′, R″, and R″′ represent H, NH₂, or any |
| (Thiodicarbonimidic Diamides or | organic functional group wherein the number of |
| Dihydrazides), Thiotricarbonimidic | carbon atoms ranges from 0 to 40, optionally |
| Diamides or Dihydrazides, | having halogen or polarizing or water- |
| Thiotetracarbonimidic Diamides or | insolubilizing/solubilizing groups attached. |
| Dihydrazides, Bis(diformamidine sulfides), | Ligand can also contain nonbinding N, O, S, or |
| and Poly(diformamidine sulfides) (N—N | P atoms. |
| Bidentates, N—N Tridentates, N—N | |
| Tetradentates) | |
| N Valence Stabilizer #24: | R—O—C(═NH)—NR′—C(═NH)—O—R″ for |
| Imidodicarbonimidic Acids, | imidodicarbomimidic acids, and R—O—C(═NH)— |
| Diimidodicarbonimidic Acids, | NR′—NH—C(═NH)—O—R″ for |
| Imidotricarbonimidic Acids, | diimidodicarbonimidic acids, where R, R′, and |
| Imidotetracarbonimidic Acids, and | R″ represent H, NH₂, or any organic functional |
| derivatives thereof (N—N Bidentates, N—N | group wherein the number of carbon atoms |
| Tridentates, N—N Tetradentates, and N—N | ranges from 0 to 40, optionally having halogen |
| Hexadentates) | or polarizing or water- |
| | insolubilizing/solubilizing groups attached. |
| | Ligand can also contain nonbinding N, O, S, or |
| | P atoms. |
| N Valence Stabilizer #25: | R—S—C(═NH)—NR′—C(═NH)—S—R″ for |
| Thioimidodicarbonimidic Acids, | thioimidodicarbonimidic acids, and R—S— |
| Thiodiimidodicarbonimidic Acids, | C(═NH)—NR′—NH—C(═NH)—S—R″ for |
| Thioimidotricarbonimidic Acids, | thiodiimidodicarbonimidic acids, where R, R′, |
| Thioimidotetracarbonimidic Acids, and | and R″ represent H, NH₂, or any organic |
| derivatives thereof (N—N Bidentates, N—N | functional group wherein the number of carbon |
| Tridentates, N—N Tetradentates, and N—N | atoms ranges from 0 to 40, optionally having |
| Hexadentates) | halogen or polarizing or water- |
| | insolubilizing/solubilizing groups attached. |
| | Ligand can also contain nonbinding N, O, S, or |
| | P atoms. |
| N Valence Stabilizer #26: | R—C(═NH)—NR′—C(═NH)—R″ for |
| Diimidoylimines, Diimidoylhydrazides, | diimidoylimines, and R—C(═NH)—NR′—NH— |
| Bis(diimidoylimines), | C(═NH)—R″ for diimidoylhydrazides, where R, |
| Bis(diimidoylhydrazides), | R′, and R″ represent H, NH₂, or any organic |
| Poly(diimidoylimines), and | functional group wherein the number of carbon |
| Poly(diimidoylhydrazides) (N—N | atoms ranges from 0 to 40, optionally having |
| Tridentates and N—N Hexadentates) | halogen or polarizing or water- |
| | insolubilizing/solubilizing groups attached. |
| | Ligand can also contain nonbinding N, O, S, or |
| | P atoms. |
| N Valence Stabilizer #27: | RR′—N—S(═NH)(═O)—OR″ or RR′—N— |
| Imidosulfamides, Diimidosulfamides, | S(═NH)(═O)—N—R″R″′ for imidosulfamides, and |
| Bis(imidosulfamides), | RR′—N—S(═NH)(═NH)—OR″ or RR′—N— |
| Bis(diimidosulfamides), | S(═NH)(═NH)—N—R″R″′ for diimidosulfamides, |
| Poly(imidosulfamides), and | where R, R′, R″, and R″′ represent H, NH₂, or |
| Poly(diimidosulfamides) (N—N Bidentates, | any organic functional group wherein the |
| N—N Tridentates, N—N Tetradentates, and N—N | number of carbon atoms ranges from 0 to 40, |
| Hexadentates) | optionally having halogen or polarizing or |
| | water-insolubilizing/solubilizing groups |
| | attached. Ligand can also contain nonbinding |
| | N, O, S, or P atoms. |
| N Valence Stabilizer #28: | (NH═)P(—NRR′)(—NR″R″′)(—NR″″R″″′), where |
| Phosphoramidimidic Triamides, | R, R′, R″, R″′, R″″, and R″″′ represent H, NH₂, |
| Bis(phosphoramidimidic triamides), and | or any organic functional group wherein the |
| Poly(phosphoramidimidic triamides) and | number of carbon atoms ranges from 0 to 40, |
| derivatives thereof (N—N Bidentates, N—N | optionally having halogen or polarizing or |
| Tridentates, N—N Tetradentates, and N—N | water-insolubilizing/solubilizing groups |
| Hexadentates) | attached. Ligand can also contain nonbinding |
| | N, O, S, or P atoms. |
| N Valence Stabilizer #29: | (NH═)P(—NRR′)(OH)₂ for phosphoramidimidic |
| Phosphoramidimidic Acid, | acid, and (NH═)P(—NRR′)(—NR″R″′)(OH) for |
| Phosphorodiamidimidic Acid, | phosphorodiamidimidic acid, where R, R′, R″, |
| Bis(Phosphoramidimidic Acid), | and R″′ represent H, NH₂, or any organic |
| Bis(Phosphorodiamidimidic Acid), | functional group wherein the number of carbon |
| Poly(Phosphoramidimidic Acid), | atoms ranges from 0 to 40, optionally having |
| Poly(Phosphorodiamidimidic Acid), and | halogen or polarizing or water- |
| derivatives thereof (N—N Bidentates, N—N | insolubilizing/solubilizing groups attached. |
| Tridentates, N—N Tetradentates, and N—N | Ligand can also contain nonbinding N, O, S, or |
| Hexadentates) | P atoms. |
| N Valence Stabilizer #30: | (NH═)P(—NRR′)(SH)₂ for |
| Phosphoramidimidodithioic Acid, | phosphoramidimidodithioic acid, and (NH═)P(— |
| Phosphorodiamidimidothioic Acid, | NRR′)(—NR″R″′)(SH) for |
| Bis(Phosphoramidimidodithioic Acid), | phosphorodiamidimidothioic acid, where R, R′, |
| Bis(Phosphorodiamidimidothioic Acid), | R″, and R″′ represent H, NH₂, or any organic |
| Poly(Phosphoramidimidodithioic Acid), | functional group wherein the number of carbon |
| Poly(Phosphorodiamidimidothioic Acid), | atoms ranges from 0 to 40, optionally having |
| and derivatives thereof (N—N Bidentates, N—N | halogen or polarizing or water- |
| Tridentates, N—N Tetradentates, and N—N | insolubilizing/solubilizing groups attached. |
| Hexadentates) | Ligand can also contain nonbinding N, O, S, or |
| | P atoms. |
| N Valence Stabilizer #31: | R—N═N—R′ for azo compounds, R—N═N—NH—R′ |
| Azo compounds including triazenes with | for triazenes, where R, and R′ represent H or |
| amino, imino, oximo, diazeno, or hydrazido | any organic functional group wherein the |
| substitution at the ortho-(for aryl) or alpha- | number of carbon atoms ranges from 0 to 40, |
| or beta-(for alkyl) positions, Bis[o-(H₂N—) | optionally having halogen or polarizing or |
| or alpha-or beta-(H₂N—)azo compounds, or | water-insolubilizing/solubilizing groups |
| Poly[o-(H₂N—) or alpha- or beta-(H₂N—)azo | attached. (Must include ortho-amino, imino, |
| compounds) (N—N Bidentates, N—N | oximo, diazeno, or hydrazido substituted aryl |
| Tridentates, N—N Tetradentates, or N—N | azo compounds, and alpha- or beta- amino, |
| Hexadentates) | imino, oximo, diazeno, or hydrazido alkyl azo |
| | compounds.) Ligand can also contain |
| | nonbinding N, O, S, or P atoms. |
| N Valence Stabilizer #32: | R—N═N—C(═NH)—NR′R″ for |
| Diazeneformimidamides | diazeneformimidamides, and R—N═N—CR′R″— |
| (Diazeneamidines), Diazeneacetimidamides | C(═NH)—NR″′R″″ for diazeneacetimidamides, |
| (Diazene-alpha-amidinoalkanes(alkenes)), | where R, R′, R″, R″′, and R″″ represent H, |
| Bis(diazeneformimidamides), | NH₂, or any organic functional group wherein |
| Bis(diazeneacetimidamides), | the number of carbon atoms ranges from 0 to |
| Poly(diazeneformimidamides), and | 40, optionally having halogen or polarizing or |
| Poly(diazeneacetimidamides) (N—N | water-insolubilizing/solubilizing groups |
| Bidentates, N—N Tetradentates, and N—N | attached. Ligand can also contain nonbinding |
| Hexadentates) | N, O, S, or P atoms. |
| N Valence Stabilizer #33: | R—N═N—C(═NH)—OR′ for diazeneformimidic |
| Diazeneformimidic Acid, | acid, and R—N═N—CR′R″—C(═NH)—OR″′ for |
| Diazeneacetimidic Acid, | diazeneacetimidic acid, where R, R′, R″, and |
| Bis(diazeneformimidic acid), | R″′ represent H, NH₂, or any organic functional |
| Bis(diazeneacetimidic acid), | group wherein the number of carbon atoms |
| Poly(diazeneformimidic acid), | ranges from 0 to 40, optionally having halogen |
| Poly(diazeneacetimidic acid), and | or polarizing or water- |
| derivatives thereof (N—N Bidentates, N—N | insolubilizing/solubilizing groups attached. |
| Tetradentates, and N—N Hexadentates) | Ligand can also contain nonbinding N, O, S, or |
| | P atoms. |
| N Valence Stabilizer #34: | R—N═N—C(═NH)—SR′ for |
| Diazeneformimidothioic Acid, | diazeneformimidothioic acid, and R—N═N— |
| Diazeneacetimidothioic Acid, | CR′R″—C(═NH)—SR″′ for |
| Bis(diazeneformimidothioic acid), | diazeneacetimidothioic acid, where R, R′, R″, |
| Bis(diazeneacetimidothioic acid), | and R″′ represent H, NH₂, or any organic |
| Poly(diazeneformimidothioic acid), | functional group wherein the number of carbon |
| Poly(diazeneacetimidothioic acid), and | atoms ranges from 0 to 40, optionally having |
| derivatives thereof (N—N Bidentates, N—N | halogen or polarizing or water- |
| Tetradentates, and N—N Hexadentates) | insolubilizing/solubilizing groups attached. |
| | Ligand can also contain nonbinding N, O, S, or |
| | P atoms. |
| N Valence Stabilizer #35: | R—N═N—C(═NH)—R′ or R—N═N—CR′R″— |
| Imidoyldiazenes, Bis(imidoyldiazenes), and | C(═NH)—R″′, where R, R′, R″, and R″′ |
| Poly(imidoyldiazenes), (N—N Bidentates, N—N | represent H, NH₂, or any organic functional |
| Tetradentates and N—N Hexadentates) | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| N Valence Stabilizer #36: | RR′—N—C(═NH)—N═N—C(═NH)—NR″R″′ for |
| Diazenediformimidamides (1,2- | diazenediformimidamides, and RR′—N—C(═NH)— |
| Diazenediamidines), | CR″R″′—N═N—CR″″R″″′—C(═NH)-NR″″″R″″″′ |
| Diazenediacetimidamides (1,2-Diazene-di- | for diazenediacetimidamides, where R, R′, R″, |
| alpha-amidinoalkanes(alkenes)), | R″′, R″″, R″″′, R″″″, and R″″″′ represent H, |
| Bis(diazenediformimidamides), | NH₂, or any organic functional group wherein |
| Bis(diazenediacetimidamides), | the number of carbon atoms ranges from 0 to |
| Poly(diazenediformimidamides), and | 40, optionally having halogen or polarizing or |
| Poly(diazenediacetimidamides) (N—N | water-insolubilizing/solubilizing groups |
| Tridentates and N—N Hexadentates) | attached. Ligand can also contain nonbinding |
| | N, O, S, or P atoms. |
| N Valence Stabilizer #37: | RO—C(═NH)—N═N—C(═NH)—OR′ for |
| Diazenediformimidic Acid, | diazenediformimidic acid, and RO—C(═NH)— |
| Diazenediacetimidic Acid, | CR′R″—N═N—CR″′R″″—C(═NH)—OR″″′ for |
| Bis(diazenediformimidic acid), | diazenediacetimidic acid, where R, R′, R″, R″′, |
| Bis(diazenediacetimidic acid), | R″″, and R″″′ represent H, NH₂, or any organic |
| Poly(diazenediformimidic acid), and | functional group wherein the number of carbon |
| Poly(diazenediacetimidic acid), and | atoms ranges from 0 to 40, optionally having |
| derivatives thereof (N—N Tridentates and N—N | halogen or polarizing or water- |
| Hexadentates) | insolubilizing/solubilizing groups attached. |
| | Ligand can also contain nonbinding N, O, S, or |
| | P atoms. |
| N Valence Stabilizer #38: | RS—C(═NH)—N═N—C(═NH)—SR′ for |
| Diazenediformimidothioic Acid, | diazenediformimidothioic acid, and RS— |
| Diazenediacetimidothioic Acid, | C(═NH)—CR′R″—N═N—CR″′R″″—C(═NH)—SR″″′ |
| Bis(diazenediformimidothioic acid), | for diazenediacetimidothioic acid, where R, R′, |
| Bis(diazenediacetimidothioic acid), | R″, R″′, R″″, and R″″′ represent H, NH₂, or any |
| Poly(diazenediformimidothioic acid), and | organic functional group wherein the number of |
| Poly(diazenediacetimidothioic acid), and | carbon atoms ranges from 0 to 40, optionally |
| derivatives thereof (N—N Tridentates and N—N | having halogen or polarizing or water- |
| Hexadentates) | insolubilizing/solubilizing groups attached. |
| | Ligand can also contain nonbinding N, O, S, or |
| | P atoms. |
| N Valence Stabilizer #39: | R—C(═NH)—N═N—C(═NH)—R″ or R—C(═NH)— |
| Diimidoyldiazenes, Bis(diimidoyldiazenes), | CR′R″—N═N—CR″′R″″—C(═NH)—R″″′, where R, |
| and Poly(diimidoyldiazenes), (N—N | R′, R″, R″′, R″″, and R″″′ represent H, NH₂, or |
| Tridentates and N—N Hexadentates) | any organic functional group wherein the |
| | number of carbon atoms ranges from 0 to 40, |
| | optionally having halogen or polarizing or |
| | water-insolubilizing/solubilizing groups |
| | attached. Ligand can also contain nonbinding |
| | N, O, S, or P atoms. |
| N Valence Stabilizer #40: | R—N═N—CR′═N—NR″R″′, where R, R′, R″, and |
| Ortho-amino (or -hydrazido) Substituted | R″′ represent H, or any organic functional |
| Formazans, Bis(o-amino or -hydrazido | group wherein the number of carbon atoms |
| substituted formazans), and Poly(o-amino | ranges from 0 to 40, optionally having halogen |
| or -hydrazido substituted formazans) (N—N | or polarizing or water- |
| Bidentates, N—N Tridentates, N—N | insolubilizing/solubilizing groups attached. |
| Tetradentates, and N—N Hexadentates) | (Must include ortho-amine or hydrazide |
| | substituted aryl R derivatives, and beta- amine or |
| | hydrazide substituted alkyl R derivatives.) |
| | Ligand can also contain nonbinding N, O, S, or |
| | P atoms. |
| N Valence Stabilizer #41: | RR′C═N—N═CR″R″′ or RR′C═N—NR″R″′ (for |
| Ortho-amino (or -hydrazido) Substituted | ketazines), where R, R′, R″, and R″′ represent |
| Azines (including ketazines), Bis(o-amino | H, or any organic functional group wherein the |
| or hydrazido substituted azines), and | number of carbon atoms ranges from 0 to 40, |
| Poly(o-amino or hydrazido substituted | optionally having halogen or polarizing or |
| azines) (N—N Bidentates, N—N Tridentates, | water-insolubilizing/solubilizing groups |
| N—N Tetradentates, and N—N Hexadentates) | attached. (Must include ortho-amine or |
| | hydrazide substituted aryl R derivatives, and |
| | beta- amine or hydrazide substituted alkyl R |
| | derivatives.) Ligand can also contain |
| | nonbinding N, O, S, or P atoms. |
| N Valence Stabilizer #42: | RR′C═N—R″, where R, R′, and R″ represent H, |
| Schiff Bases with one Imine (C═N) Group | or any organic functional group wherein the |
| and with ortho- or alpha- or beta- amino or | number of carbon atoms ranges from 0 to 40, |
| imino or oximo or diazeno or hydrazido | optionally having halogen or polarizing or |
| substitution (N—N Bidentates, N—N | water-insolubilizing/solubilizing groups |
| Tridentates, N—N Tetradentates, N—N | attached. (Must contain ortho- or alpha- or |
| Pentadentates, or N—N Hexadentates). Also | beta- amino or imino or oximo or diazeno or |
| includes hydrazones with ortho-N | hydrazido substitution.) Ligand can also |
| substitution. | contain nonbinding N, O, S, or P atoms. |
| N Valence Stabilizer #43: | RR′C═N—R″—N═CR″′R″″ or R—N═C—R′—C═N— |
| Schiff Bases with two Imine (C═N) Groups | R′ or RC═N—R′—N═CR″, where R, R′, R″, R″′, |
| and without ortho- (for aryl constituents) or | and R″″ represent H, or any organic functional |
| alpha- or beta- (for alkyl constituents) | group wherein the number of carbon atoms |
| hydroxy, carboxy, carbonyl, thiol, | ranges from 0 to 40, optionally having halogen |
| mercapto, thiocarbonyl, amino, imino, | or polarizing or water- |
| oximo, diazeno, or hydrazido substitution | insolubilizing/solubilizing groups attached. (Not |
| (N—N Bidentates). Also includes | including ortho-, alpha-, or beta-hydroxy, |
| dihydrazones. | carboxy, carbonyl, thiol, mercapto, |
| | thiocarbonyl, amino, imino, oximo, diazeno, or |
| | hydrazido substitution.) Ligand can also |
| | contain nonbinding N, O, S, or P atoms. |
| N Valence Stabilizer #44: | RR′C═N—R″—N═CR″′R″″ or R—N═C—R′—C═N— |
| Schiff Bases with two Imine (C═N) Groups | R′ or RC═N—R′—N═CR″, where R, R′, R″, R″′, |
| and with ortho- or alpha- or beta- amino or | and R″″ represent H, or any organic functional |
| imino or oximo or diazeno or hydrazido | group wherein the number of carbon atoms |
| substitution (N—N Tridentates, N—N | ranges from 0 to 40, optionally having halogen |
| Tetradentates, N—N Pentadentates, or N—N | or polarizing or water- |
| Hexadentates). Also includes hydrazones | insolubilizing/solubilizing groups attached. |
| with ortho-N substitution. | (Must contain ortho- or alpha- or beta- amino or |
| | imino or oximo or diazeno or hydrazido |
| | substitution.) Ligand can also contain |
| | nonbinding N, O, S, or P atoms. |
| N Valence Stabilizer #45: | N(—R—N═CR′R″)₃, where R, R′, and R″ |
| Schiff Bases with three Imine (C═N) | represent H, or any organic functional group |
| Groups and without ortho- (for aryl | wherein the number of carbon atoms ranges |
| constituents) or alpha- or beta- (for alkyl | from 0 to 40, optionally having halogen or |
| constituents) hydroxy, carboxy, carbonyl, | polarizing or water-insolubilizing/solubilizing |
| thiol, mercapto, thiocarbonyl, amino, imino, | groups attached. (Not including ortho-, alpha-, |
| oximo, diazeno, or hydrazido substitution | or beta-hydroxy, carboxy, carbonyl, thiol, |
| (N—N Tridentates). Also includes | mercapto, thiocarbonyl, amino, imino, oximo, |
| trihydrazones. | diazeno, or hydrazido substitution.) Ligand can |
| | also contain nonbinding N, O, S, or P atoms. |
| N Valence Stabilizer #46: | N(—R—N═CR′R″)₃, where R, R′, and R″ |
| Schiff Bases with three Imine (C═N) | represent H, or any organic functional group |
| Groups and with ortho- or alpha- or beta- | wherein the number of carbon atoms ranges |
| amino or imino or oximo or diazeno or | from 0 to 40, optionally having halogen or |
| hydrazido substitution (N—N Tetradentates, | polarizing or water-insolubilizing/solubilizing |
| N—N Pentadentates, or N—N Hexadentates) | groups attached. (Must contain ortho- or alpha- |
| | or beta- amino or imino or oximo or diazeno or |
| | hydrazido substitution.) Ligand can also |
| | contain nonbinding N, O, S, or P atoms. |
| S Valence Stabilizer #1: | Macrocyclic ligands containing two, four, or six |
| Macrocyclic, Macrobicyclic, and | thioketone binding sites to valence stabilize the |
| Macropolycyclic Oligothioketones | central metal ion. Can include other |
| (including Catapinands, Cryptands, | hydrocarbon or ring systems bound to this |
| Cyclidenes, and Sepulchrates) wherein all | macrocyclic ligand, but they do not coordinate |
| Binding Sites are composed of Thioketones | with the stabilized, high valence metal ion. This |
| (typically in the beta position) (S—S | ligand and/or attached, uncoordinating |
| Bidentates, S—S Tetradentates, and S—S | hydrocarbons/rings may or may not have |
| Hexadentates) | halogen or polarizing or water- |
| | insolubilizing/solubilizing groups attached. |
| S Valence Stabilizer #2: | Macrocyclic ligands containing two, four, six, |
| Macrocyclic, Macrobicyclic, and | or eight 1,1-dithiolene binding sites to valence |
| Macropolycyclic Dithiolenes (including | stabilize the central metal ion. Can include other |
| Catapinands, Cryptands, Cyclidenes, and | hydrocarbon or ring systems bound to this |
| Sepulchrates) wherein all Binding Sites are | macrocyclic ligand, but they do not coordinate |
| composed of alpha, alpha dithiols (meaning | with the stabilized, high valence metal ion. This |
| two thiol groups on a single carbon atom in | ligand and/or attached, uncoordinating |
| the ring) (S—S Bidentates, S—S | hydrocarbons/rings may or may not have |
| Tetradentates, and S—S Hexadentates) | halogen or polarizing or water- |
| | insolubilizing/solubilizing groups attached. |
| S Valence Stabilizer #3: | RC(═S)—NR′—C(═S)—R″ for |
| Dithioimidodialdehydes, | dithioimidodialdehydes, and RC(═S)—NR′—NH— |
| Dithiohydrazidodialdehydes (thioacyl | C(═S)—R″ for dithiohydrazidodialdehydes |
| thiohydrazides), | (thioacyl thiohydrazides), where R, R′, and R″ |
| Bis(dithioimidodialdehydes), | represent H, NH₂, or any organic functional |
| Bis(dithiohydrazidodialdehydes), | group wherein the number of carbon atoms |
| Poly(dithioimidodialdehydes), and | ranges from 0 to 40, optionally having halogen |
| Poly(dithiohydrazidodialdehydes) (S—S | or polarizing or water- |
| Bidentates, S—S Tridentates, S—S | insolubilizing/solubilizing groups attached. |
| Tetradentates) | Ligand can also contain nonbinding N, O, S, or |
| | P atoms. |
| S Valence Stabilizer #4: | R—O—C(═S)—NR′—C(═S)—O—R″ or R—S—C(═S)— |
| Dithioimidodicarbonic acids, | NR′—C(═S)—S—R″ for dithioimidodicarbonic |
| Dithiohydrazidodicarbonic acids, | acids, and R—O—C(═S)—NR′—NH—C(═S)—O—R″ or |
| Bis(dithioimidodicarbonic acids), | R—S—C(═S)—NR′—NH—C(═S)—S—R″ for |
| Bis(dithiohydrazidodicarbonic acids), | dithiohydrazidodicarbonic acids, where R, R′, |
| Poly(dithioimidodicarbonic acids), | and R″ represent H, NH₂, or any organic |
| Poly(dithiohydrazidodicarbonic acids) and | functional group wherein the number of carbon |
| derivatives thereof (S—S Bidentates, S—S | atoms ranges from 0 to 40, optionally having |
| Tridentates, S—S Tetradentates) | halogen or polarizing or water- |
| | insolubilizing/solubilizing groups |
| | attached. Ligand can also contain nonbinding N, |
| | O, S, or P atoms. |
| S Valence Stabilizer #5: | R—C(═S)—CR′R″—C(═S)—R″′ where R, R′, R″, |
| 1,3-Dithioketones (Dithio-beta-ketonates), | and R″′ represent H, NH₂, or any organic |
| 1,3,5-Trithioketones, Bis(1,3- | functional group wherein the number of carbon |
| Dithioketones), and Poly(1,3- | atoms ranges from 0 to 40, optionally having |
| Dithioketones) (S—S Bidentates, S—S | halogen or polarizing or water- |
| Tridentates, S—S Tetradentates) | insolubilizing/solubilizing groups attached. |
| | Ligand can also contain nonbinding N, O, S, or |
| | P atoms. |
| S Valence Stabilizer #6: | R—C(═S)—C(═S)—R′ where R and R′ represent H, |
| 1,2-Dithioketones (Dithiolenes, Dithio- | NH₂, or any organic functional group wherein |
| alpha-ketonates), 1,2,3-Trithioketones, | the number of carbon atoms ranges from 0 to |
| Dithiotropolonates, ortho-Dithioquinones, | 40, optionally having halogen or polarizing or |
| Bis(1,2-Dithioketones), and Poly(1,2- | water-insolubilizing/solubilizing groups |
| Dithioketones) (S—S Bidentates, S—S | attached. Ligand can also contain nonbinding N, |
| Tridentates, S—S Tetradentates) | O, S, or P atoms. |
| S Valence Stabilizer #7: | RR′—N—C(═S)—CR″R″′—C(═S)—N—R″″R″″′ where |
| Dithiomalonamides | R, R′, R″, R″′, R″″, and R″″′ represent H, NH₂, |
| (Dithiomalonodiamides), | or any organic functional group wherein the |
| Bis(dithiomalonamides), and | number of carbon atoms ranges from 0 to 40, |
| Polydithiomalonamides (S—S Bidentates, S—S | optionally having halogen or polarizing or |
| Tridentates, S—S Tetradentates) | water-insolubilizing/solubilizing groups |
| | attached. Ligand can also contain nonbinding N, |
| | O, S, or P atoms. |
| S Valence Stabilizer #8: | RR′—N—C(═S)—CR″R″′—C(═S)—R″″ where R, R′, |
| 2-Thioacylthioacetamides, Bis(2- | R″, R″′, and R″″ represent H, NH₂, or any |
| thioacylthioacetamides), and Poly(2- | organic functional group wherein the number of |
| thioacylthioacetamides) (S—S Bidentates, S—S | carbon atoms ranges from 0 to 40, optionally |
| Tridentates, S—S Tetradentates) | having halogen or polarizing or water- |
| | insolubilizing/solubilizing groups attached. |
| | Ligand can also contain nonbinding N, O, S, or |
| | P atoms. |
| S Valence Stabilizer #9: | R—C(═S)—S—C(═S)—R′ where R and R′ represent |
| Dithioacyl sulfides, Bis(dithioacyl sulfides), | H or any organic functional group wherein the |
| and Poly(dithioacyl sulfides) (S—S | number of carbon atoms ranges from 0 to 40, |
| Bidentates, S—S Tridentates, S—S | optionally having halogen or polarizing or |
| Tetradentates) | water-insolubilizing/solubilizing groups |
| | attached. Ligand can also contain nonbinding N, |
| | O, S, or P atoms. |
| S Valence Stabilizer #10: | RR′—N—C(═S)—S—C(═S)—N—R″R″′ where R, R′, |
| Trithiodicarbonic Diamides, | R″, and R″′ represent H, NH₂ or any organic |
| Bis(trithiodicarbonic diamides), and | functional group wherein the number of carbon |
| Poly(trithiodicarbonic diamides) (S—S | atoms ranges from 0 to 40, optionally having |
| Bidentates, S—S Tridentates, S—S | halogen or polarizing or water- |
| Tetradentates) | insolubilizing/solubilizing groups attached. |
| | Ligand can also contain nonbinding N, O, S, or |
| | P atoms. |
| S Valence Stabilizer #11: | R—S—C(═S)—S—C(═S)—S—R′ for |
| Pentathio-, Tetrathio-, or Trithiodicarbonic | pentathiodicarbonic acids, R—O—C(═S)—S—C(═S)— |
| Acids, Bis(pentathio-, tetrathio-, or | S—R′ for tetrathiodicarbonic acids, and R—O— |
| trithiodicarbonic acids), Poly(pentathio-, | C(═S)—S—C(═S)—O—R′ for pentathiodicarbonic |
| tetrathio-, or trithiodicarbonic acids), and | acids, where R and R′ represent H, NH₂ or any |
| derivatives thereof (S—S Bidentates, S—S | organic functional group wherein the number of |
| Tridentates, S—S Tetradentates) | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. |
| S Valence Stabilizer #12: | (R—O—)(R′—O—)P(═S)—P(═S)(—O—R″)(—O—R″′); (R— |
| Dithiohypophosphoric Acids, | O—)(R′—S—)P(═S)—P(═S)(—S—R″)(—O—R″′); or (R— |
| Bis(dithiohypophosphoric acids), and | S—)(R′—S—)P(═S)—P(═S)(—S—R″)(—S—R″′), where |
| Poly(dithiohypophosphoric acids), and | R, R′, R″, and R″′ represent H, NH₂ or any |
| derivatives thereof (S—S Bidentates, S—S | organic functional group wherein the number of |
| Tridentates, S—S Tetradentates) | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. Note: these ligands are not to be |
| | confused with hypophosphorous acid |
| | derivatives (hypophosphites) (R—O—) |
| | R″R″′P(═O) which are very reducing and |
| | therefore unacceptable for stabilization of high |
| | valence states in metal ions. |
| S Valence Stabilizer #13: | (RR′—N—)(R″R″′—N—)P(═S)—P(═S)(—N— |
| Dithiohypophosphoramides, | R″″R″″′)(—N—R″″″R″″″′), where R, R′, R″, R″′, |
| Bis(dithiohypophosphoramides), and | R″″, R″″′, R″″″, and R″″″′ represent H, NH₂ or |
| Poly(dithiohypophosphoramides) (S—S | any organic functional group wherein the |
| Bidentates, S—S Tridentates, S—S | number of carbon atoms ranges from 0 to 40, |
| Tetradentates) | optionally having halogen or polarizing or |
| | water-insolubilizing/solubilizing groups |
| | attached. Ligand can also contain nonbinding N, |
| | O, S, or P atoms. Note: these ligands are not to |
| | be confused with hypophosphorous acid |
| | derivatives (hypophosphites) (R—O—) |
| | R″R″′P(═O) which are very reducing and |
| | therefore unacceptable for stabilization of high |
| | valence states in metal ions. |
| S Valence Stabilizer #14: | (R—O—)(R′—O—)P(═S)—NH—P(═S)(—O—R″)(—O— |
| Dithioimidodiphosphoric Acids, | R″′); (R—O—)(R′—S—)P(═S)—NH—P(═S)(—S—R″)(—O— |
| Dithiohydrazidodiphosphoric Acids, | R″′); or (R—S—)(R′—S—)P(═S)—NH—P(═S)(—S—R″)(— |
| Bis(dithioimidodiphosphoric Acids), | S—R″′) for dithioimidodiphosphoric acids, and — |
| Bis(dithiohydrazidodiphosphoric Acids), | NH—NH—derivatives for |
| Poly(dithioimidodiphosphoric Acids), | dithiohydrazidodiphosphoric acids, where R, |
| Poly(dithiohydrazidodiphosphoric Acids), | R′, R″, and R″′ represent H, NH₂ or any organic |
| and derivatives thereof (S—S Bidentates, S—S | functional group wherein the number of carbon |
| Tridentates, S—S Tetradentates) | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S Valence Stabilizer #15: | (RR′—N—)(R″R″′—N—)P(═S)—NH—P(═S)(—N— |
| Dithioimidodiphosphoramides, | R″″R″″′)(—N—R″″″R″″″′) for |
| Dithiohydrazidodiphosphoramides, | dithioimidophosphoramides, and (RR′—N— |
| Bis(dithioimidodiphosphoramides), | )(R″R″′—N—)P(═S)—NH—NH—P(═S)(—N— |
| Bis(dithiohydrazidodiphosphoramides), | R″″R″″′)(—N—R″″″R″″″′) for |
| Poly(dithioimidodiphosphoramides), and | dithiohydrazidodiphosphoramides, where R, R′, |
| Poly(dithiohydrazidodiphosphoramides) (S—S | R″, R″′, R″″, R″″′, R″″″, and R″″″′ represent |
| Bidentates, S—S Tridentates, S—S | H, NH₂ or any organic functional group wherein |
| Tetradentates) | the number of carbon atoms ranges from 0 to |
| | 40, optionally having halogen or polarizing or |
| | water-insolubilizing/solubilizing groups |
| | attached. Ligand can also contain nonbinding N, |
| | O, S, or P atoms. |
| S Valence Stabilizer #16: | (RR′—N—)(R″R″′—N—)P(═S)—S—P(═S)(—N— |
| Dithiodiphosphoramides, | R″″R″″′)(—N—R″″″R″″″′), or (RR′—N—)(R″R″′— |
| Bis(dithioiphosphoramides), and | N—)P(═S)—O—P(═S)(—N—R″″R″″′)(—N— |
| Poly(dithiodiphosphoramides) (S—S | R″″″R″″″′), where R, R′, R″, R″′, R″″, R″″′, |
| Bidentates, S—S Tridentates, S—S | R″″″, and R″″″′ represent H, NH₂ or any |
| Tetradentates) | organic functional group wherein the number of |
| | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. |
| S Valence Stabilizer #17: | (R—O—)(R′—O—)P(═S)—O—P(═S)(—O—R″)(—O—R″′); |
| Dithiodiphosphoric Acids, | (R—O—)(R′—O—)P(═S)—S—P(═S)(—O—R″)(—O—R″′); |
| Bis(dithioiphosphoric Acids), | (R—O—)(R′—S—)P(═S)—O—P(═S)(—S—R″)(—O—R″′); |
| Poly(dithiodiphosphoric Acids), and | (R—O—)(R′—S—)P(═S)—S—P(═S)(—S—R″)(—O—R″′); or |
| derivatives thereof (S—S Bidentates, S—S | (R—S—)(R′—S—)P(═S)—S—P(═S)(—S—R″)(—S—R″′), |
| Tridentates, S—S Tetradentates) | where R, R′, R″, R″′, R″″, R″″′, R″″″, and |
| | R″″″′ represent H, NH₂ or any organic |
| | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S Valence Stabilizer #18: | (O═)P(—S—R)(—S—R′)(—S—R″) or (S═)P(—S—R)(—S— |
| Trithiophosphoric Acids | R′)(—O—R″), where R, R′, and R″ represent H, |
| (Phosphorotrithioic Acids), | NH₂ or any organic functional group wherein |
| Bis(trithiophosphoric acids), | the number of carbon atoms ranges from 0 to |
| Poly(trithiophosphoric acids), and | 40, optionally having halogen or polarizing or |
| derivatives thereof (S—S Bidentates, S—S | water-insolubilizing/solubilizing groups |
| Tridentates, S—S Tetradentates) | attached. Ligand can also contain nonbinding N, |
| | O, S, or P atoms. |
| S Valence Stabilizer #19: | (O═)P(—S—R)(—S—R′)(—O—R″) or (S═)P(—S—R)(—O— |
| Dithiophosphoric Acids (Phosphorodithioic | R′)(—O—R″), where R, R′, and R″ represent H, |
| Acids), Bis(dithiophosphoric acids), | NH₂ or any organic functional group wherein |
| Poly(dithiophosphoric acids), and | the number of carbon atoms ranges from 0 to |
| derivatives thereof (S—S Bidentates, S—S | 40, optionally having halogen or polarizing or |
| Tridentates, S—S Tetradentates) | water-insolubilizing/solubilizing groups |
| | attached. Ligand can also contain nonbinding N, |
| | O, S, or P atoms. |
| S Valence Stabilizer #20: | (S═)P(—S—R)(—S—R′)(—S—R″), where R, R′, and R″ |
| Tetrathiophosphoric Acids | represent H, NH₂ or any organic functional |
| (Phosphorotetrathioic Acids), | group wherein the number of carbon atoms |
| Bis(tetrathiophosphoric acids), | ranges from 0 to 40, optionally having halogen |
| Poly(tetrathiophosphoric acids), and | or polarizing or water- |
| derivatives thereof (S—S Bidentates, S—S | insolubilizing/solubilizing groups attached. |
| Tridentates, S—S Tetradentates) | Ligand can also contain nonbinding N, O, S, or |
| | P atoms. |
| S Valence Stabilizer #21: | (O═)P(—S—S—R)(—S—R′)(—S—R″) or (S═)P(—S—S— |
| Phosphoro(dithioperoxo)dithioic Acids, | R)(—S—R′)(—O—R″), where R, R′, and R″ |
| Bis[phosphoro(dithioperoxo)dithioic | represent H, NH₂ or any organic functional |
| Acids], | group wherein the number of carbon atoms |
| Poly[phosphoro(dithioperoxo)dithioic | ranges from 0 to 40, optionally having halogen |
| Acids], and derivatives thereof (S—S | or polarizing or water- |
| Bidentates, S—S Tridentates, S—S | insolubilizing/solubilizing groups attached. |
| Tetradentates) | Ligand can also contain nonbinding N, O, S, or |
| | P atoms. |
| S Valence Stabilizer #22: | (O═)P(—S—S—R)(—S—R′)(—O—R″) or (S═)P(—S—S— |
| Phosphoro(dithioperoxo)thioic Acids, | R)(—O—R′)(—O—R″), where R, R′, and R″ |
| Bis[phosphoro(dithioperoxo)thioic Acids], | represent H, NH₂ or any organic functional |
| Poly[phosphoro(dithioperoxo)thioic Acids], | group wherein the number of carbon atoms |
| and derivatives thereof (S—S Bidentates, S—S | ranges from 0 to 40, optionally having halogen |
| Tridentates, S—S Tetradentates) | or polarizing or water- |
| | insolubilizing/solubilizing groups attached. |
| | Ligand can also contain nonbinding N, O, S, or |
| | P atoms. |
| S Valence Stabilizer #23: | (S═)P(—S—S—R)(—S—R′)(—S—R″), where R, R′, and |
| Phosphoro(dithioperoxo)trithioic Acids, | R″ represent H, NH₂ or any organic functional |
| Bis[phosphoro(dithioperoxo)trithioic | group wherein the number of carbon atoms |
| Acids], | ranges from 0 to 40, optionally having halogen |
| Poly[phosphoro(dithioperoxo)trithioic | or polarizing or water- |
| Acids], and derivatives thereof (S—S | insolubilizing/solubilizing groups attached. |
| Bidentates, S—S Tridentates, S—S | Ligand can also contain nonbinding N, O, S, or |
| Tetradentates) | P atoms. |
| S Valence Stabilizer #24: | R—CR′(—SH)—CH₂ —C(═S)—R″, where R, R′, and |
| Beta-Mercaptothioketones, Beta- | R″ represent H, NH₂ or any organic functional |
| Mercaptothioaldehydes, Bis(beta- | group wherein the number of carbon atoms |
| mercaptothioketones), Bis(beta- | ranges from 0 to 40, optionally having halogen |
| mercaptothioaldehydes), Poly(beta- | or polarizing or water- |
| mercaptothioketones), and Poly(beta- | insolubilizing/solubilizing groups attached. |
| mercaptothioaldehydes) (S—S Bidentates, S—S | Ligand can also contain nonbinding N, O, S, or |
| Tridentates, S—S Tetradentates) | P atoms. |
| S Valence Stabilizer #25: | RR′—N—CH(—SH)—NR″—C(═S)—NR″′R″″, where |
| N-(Aminomethylthiol)thioureas [N— | R, R′, R″, R″′, and R″″ represent H, NH₂ or any |
| (Aminomercaptomethyl)thioureas], Bis[N— | organic functional group wherein the number of |
| (aminomethylthiol)thioureas], and Poly[N— | carbon atoms ranges from 0 to 40, optionally |
| (aminomethylthiol)thioureas] (S—S | having halogen or polarizing or water- |
| Bidentates, S—S Tridentates, S—S | insolubilizing/solubilizing groups attached. |
| Tetradentates) | Ligand can also contain nonbinding N, O, S, or |
| | P atoms. |
| S Valence Stabilizer #26: | RR′—N—C(═S)—C(═S)—N—R″R″′, where R, R′, R″, |
| Dithiooxamides, Bis(dithiooxamides), and | and R″′ represent H, NH₂ or any organic |
| Poly(dithiooxamides) (S—S Bidentates, S—S | functional group wherein the number of carbon |
| Tridentates, S—S Tetradentates) | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S Valence Stabilizer #27: | RR′—C═C(—S⁻)(—S⁻), where R and R′ represent H, |
| 1,1-Dithiolates, Bis(1,1-dithiolates), and | NH₂ or any organic functional group wherein |
| Poly(1,1-dithiolates) (S—S Bidentates and S—S | the number of carbon atoms ranges from 0 to |
| Tetradentates) | 40, optionally having halogen or polarizing or |
| | water-insolubilizing/solubilizing groups |
| | attached. Ligand can also contain nonbinding N, |
| | O, S, or P atoms. |
| S Valence Stabilizer #28: | R—C(═S)(—S—R′) for dithiomonocarboxylic acids, |
| Dithiomonocarboxylic Acids, Tri- and | and (R—S—)(S═)C—R′—C(═S)(—S—R″) for tri- and |
| Tetrathiodicarboxylic Acids, | tetrathiodicarboxylic acids, where R, R′, and R″ |
| Bis(dithiomonocarboxylic Acids), Bis(tri- | represent H, NH₂ or any organic functional |
| and tetrathiodicarboxylic acids), | group wherein the number of carbon atoms |
| Poly(dithiomonocarboxylic acids), Poly(tri- | ranges from 0 to 40, optionally having halogen |
| and tetrathiodicarboxylic acids), and | or polarizing or water- |
| derivatives thereof (S—S Bidentates and S—S | insolubilizing/solubilizing groups attached. |
| Tetradentates) | Ligand can also contain nonbinding N, O, S, or |
| | P atoms. |
| S Valence Stabilizer #29: | R—C(═S)(—S—S—R′) for perthiomonocarboxylic |
| Perthiomonocarboxylic Acids, | acids, and (R—S—S—)(S═)C—R′—C(═S)(—S—S—R″) |
| Perthiodicarboxylic Acids, | for perthiodicarboxylic acids, where R, R′, and |
| Bis(perthiomonocarboxylic acids), | R″ represent H, NH₂ or any organic functional |
| Bis(perthiodicarboxylic acids), | group wherein the number of carbon atoms |
| Poly(perthiomonocarboxylic acids), | ranges from 0 to 40, optionally having halogen |
| Poly(perthiodicarboxylic acids), and | or polarizing or water- |
| derivatives thereof (S—S Bidentates and S—S | insolubilizing/solubilizing groups attached. |
| Tetradentates) | Ligand can also contain nonbinding N, O, S, or |
| | P atoms. |
| S Valence Stabilizer #30: | R—S—C(═S)—O—R′ or R—S—C(═O)—S—R′ for |
| Dithiocarbonates, Trithiocarbonates, | dithiocarbonates, R—S—C(═S)—S—R′ for |
| Perthiocarbonates, Bis(dithiocarbonates), | trithiocarbonates, and R—S—S—C(═S)—S—R′ for |
| Bis(trithiocarbonates), and | perthiocarbonates, where R, and R′ represent H, |
| Bis(perthiocarbonates) (S—S Bidentates and | NH₂ or any organic functional group wherein |
| S—S Tetradentates) | the number of carbon atoms ranges from 0 to |
| | 40, optionally having halogen or polarizing or |
| | water-insolubilizing/solubilizing groups |
| | attached. Ligand can also contain nonbinding N, |
| | O, S, or P atoms. |
| S Valence Stabilizer #31: | RR′N⁺═C(SH)(SH), where R and R′ represent |
| Dithiocarbamates, Bis(dithiocarbamates), | H, OH, SH, OR″ (R″= C₁-C₃₀ alkyl or aryl), |
| and Poly(dithiocarbamates) (including N- | SR″ (R″= C₁-C₃₀ alkyl or aryl), NH₂ or any |
| hydroxydithiocarbamates and N- | organic functional group wherein the number of |
| mercaptodithiocarbamates) (S—S Bidentates, | carbon atoms ranges from 0 to 40, optionally |
| S—S Tridentates, and S—S Tetradentates) | having halogen or polarizing or water- |
| | insolubilizing/solubilizing groups attached. |
| | Ligand can also contain nonbinding N, O, S, or |
| | P atoms. |
| S Valence Stabilizer #32: | RR′N—NR″—C(═S)(SH), where R and R′ |
| Dithiocarbazates (Dithiocarbazides), | represent H, NH₂ or any organic functional |
| Bis(dithiocarbazates), and | group wherein the number of carbon atoms |
| Poly(dithiocarbazates) (S—S Bidentates, S—S | ranges from 0 to 40, optionally having halogen |
| Tridentates, and S—S Tetradentates; or | or polarizing or water- |
| possibly N—S Bidentates, N—S Tridentates, | insolubilizing/solubilizing groups attached. |
| and N—S Tetradentates) | Ligand can also contain nonbinding N, O, S, or |
| | P atoms. |
| S Valence Stabilizer #33: | Thiocyanates bound directly to the high valence |
| Thiocyanate ligands (S Monodentates) | metal ion. |
| O Valence Stabilizer #1: | RR′—N—C(═O)—NR″—C(═O)—NR″′R″″ for |
| Biurets (Imidodicarbonic Diamides), | biurets, and RR′—N—C(═O)—NR″—NH—C(═O)— |
| Isobiurets, Biureas, Triurets, Triureas, | NR″′R″″ for biureas, where R, R′, R″, R″′, and |
| Bis(biurets), Bis(isobiurets), Bis(biureas), | R″″ represent H, NH₂, or any organic functional |
| Poly(biurets), Poly(isobiurets), and | group wherein the number of carbon atoms |
| Poly(biureas) (O—O Bidentates, O—O | ranges from 0 to 40, optionally having halogen |
| Tridentates, O—O Tetradentates) | or polarizing or water- |
| | insolubilizing/solubilizing groups attached. |
| | Ligand can also contain nonbinding N, O, S, or |
| | P atoms. |
| O Valence Stabilizer #2: | RR′—N—C(═O)—NR″—C(═O)—R″′ where R, R′, |
| Acylureas, Aroylureas, Bis(acylureas), | R″, and R″′ represent H, NH₂, or any organic |
| Bis(aroylureas), Poly(acylureas), and | functional group wherein the number of carbon |
| Poly(aroylureas) (O—O Bidentates, O—O | atoms ranges from 0 to 40, optionally having |
| Tridentates, O—O Tetradentates) | halogen or polarizing or water- |
| | insolubilizing/solubilizing groups attached. |
| | Ligand can also contain nonbinding N, O, S, or |
| | P atoms. |
| O Valence Stabilizer #3: | RC(═O)—NR′—C(═O)—R″ for imidodialdehydes, |
| Imidodialdehydes, Hydrazidodialdehydes | and RC(═O)—NR′—NH—C(═O)—R″ for |
| (Acyl hydrazides), Bis(imidodialdehydes), | hydrazidodialdehydes (acyl hydrazides), where |
| Bis(hydrazidodialdehydes), | R, R′, and R″ represent H, NH₂, or any organic |
| Poly(imidodialdehydes), and | functional group wherein the number of carbon |
| Poly(hydrazidodialdehydes) (O—O | atoms ranges from 0 to 40, optionally having |
| Bidentates, O—O Tridentates, O—O | halogen or polarizing or water- |
| Tetradentates) | insolubilizing/solubilizing groups attached. |
| | Ligand can also contain nonbinding N, O, S, or |
| | P atoms. |
| O Valence Stabilizer #4: | R—O—C(═O)—NR′—C(═O)—O—R″ for |
| Imidodicarbonic acids, | imidodicarbonic acids, and R—O—C(═O)—NR′— |
| Hydrazidodicarbonic acids, | NH—C(═O)—O—R″ for hydrazidodicarbonic acids, |
| Bis(imidodicarbonic acids), | where R, R′, and R″ represent H, NH₂, or any |
| Bis(hydrazidodicarbonic acids), | organic functional group wherein the number of |
| Poly(imidodicarbonic acids), | carbon atoms ranges from 0 to 40, optionally |
| Poly(hydrazidodicarbonic acids) and | having halogen or polarizing or water- |
| derivatives thereof (O—O Bidentates, O—O | insolubilizing/solubilizing groups attached. |
| Tridentates, O—O Tetradentates) | Ligand can also contain nonbinding N, O, S, or |
| | P atoms. |
| O Valence Stabilizer #5: | RR′—N—S(═O)(═O)—NR″—S(═O)(═O)—NR″′R″″ |
| Imidodisulfamic Acid, Imidodisulfuric | for imidodisulfamic acid, and R—O—S(═O)(═O)— |
| Acid, Bis(Imidodisulfamic Acid), | NR′—S(═O)(═O)—OR″ for imidosulfuric acid, |
| Bis(Imidodisulfuric Acid), | where R, R′, and R″ represent H, NH₂, or any |
| Poly(Imidodisulfamic Acid), and | organic functional group wherein the number of |
| Poly(Imidodisulfuric Acid) and derivatives | carbon atoms ranges from 0 to 40, optionally |
| thereof (O—O Bidentates, O—O Tridentates, | having halogen or polarizing or water- |
| O—O Tetradentates) | insolubilizing/solubilizing groups attached. |
| | Ligand can also contain nonbinding N, O, S, or |
| | P atoms. |
| O Valence Stabilizer #6: | R—C(═O)—CR′R″—C(═O)—R″′ where R, R′, R″, |
| 1,3-Diketones (Beta-Diketonates), 1,3,5- | and R″′ represent H, NH₂, or any organic |
| Triketones, Bis(1,3-Diketones), and | functional group wherein the number of carbon |
| Poly(1,3-Diketones), all with a Molecular | atoms ranges from 0 to 40, optionally having |
| Weight Greater than 125 (O—O Bidentates, | halogen or polarizing or water- |
| O—O Tridentates, O—O Tetradentates) | insolubilizing/solubilizing groups attached. |
| | Ligand can also contain nonbinding N, O, S, or |
| | P atoms. If these ligands exhibit a molecular |
| | weight less than or equal to 125, the solubility |
| | of the resultant diketonate complex will be too |
| | high. |
| O Valence Stabilizer #7: | R—C(═O)—C(═O)—R′ where R and R′ represent |
| 1,2-Diketones (Alpha-Diketonates), 1,2,3- | H, NH_{2,}or any organic functional group |
| Triketones, Tropolonates, ortho-Quinones, | wherein the number of carbon atoms ranges |
| Bis(1,2-Diketones), and Poly(1,2- | from 0 to 40, optionally having halogen or |
| Diketones), all with a Molecular Weight | polarizing or water-insolubilizing/solubilizing |
| Greater than 100 (O—O Bidentates, O—O | groups attached. Ligand can also contain |
| Tridentates, O—O Tetradentates) | nonbinding N, O, S, or P atoms. If these ligands |
| | exhibit a molecular weight less than or equal to |
| | 100, the solubility of the resultant diketonate |
| | complex will be too high. |
| O Valence Stabilizer #8: | RR′—N—C(═O)—CR″R″′—C(═O)—N—R″″R″″′ |
| Malonamides (Malonodiamides), | where R, R′, R″, R″′, R″″, and R″″′ represent H, |
| Bis(malonamides), and Polymalonamides | NH₂, or any organic functional group wherein |
| (O—O Bidentates, O—O Tridentates, O—O | the number of carbon atoms ranges from 0 to |
| Tetradentates) | 40, optionally having halogen or polarizing or |
| | water-insolubilizing/solubilizing groups |
| | attached. Ligand can also contain nonbinding N, |
| | O, S, or P atoms. |
| O Valence Stabilizer #9: | RR'—N—C(═O)—CR″R″′—C(═O)—R″″ where R, R′, |
| 2-Acylacetamides, Bis(2-acylacetamides), | R″, R″′, and R″″ represent H, NH₂, or any |
| and Poly(2-acylacetamides) (O—O | organic functional group wherein the number of |
| Bidentates, O—O Tridentates, O—O | carbon atoms ranges from 0 to 40, optionally |
| Tetradentates) | having halogen or polarizing or water- |
| | insolubilizing/solubilizing groups attached. |
| | Ligand can also contain nonbinding N, O, S, or |
| | P atoms. |
| O Valence Stabilizer #10: | RR′—N—C(═O)—S—C(═O)—N—R″R″′ where R, R′, |
| Monothiodicarbonic Diamides, | R″, and R″′ represent H, NH₂ or any organic |
| Bis(monothiodicarbonic diamides), and | functional group wherein the number of carbon |
| Poly(monothiodicarbonic diamides) (O—O | atoms ranges from 0 to 40, optionally having |
| Bidentates, O—O Tridentates, O—O | halogen or polarizing or water- |
| Tetradentates) | insolubilizing/solubilizing groups attached. |
| | Ligand can also contain nonbinding N, O, S, or |
| | P atoms. |
| O Valence Stabilizer #11: | R—O—C(═O)—S—C(═O)—O—R′, where R and R′ |
| Monothiodicarbonic Acids, | represent H, NH₂ or any organic functional |
| Bis(monothiodicarbonic acids), | group wherein the number of carbon atoms |
| Poly(monothiodicarbonic acids), and | ranges from 0 to 40, optionally having halogen |
| derivatives thereof (O—O Bidentates, O—O | or polarizing or water- |
| Tridentates, O—O Tetradentates) | insolubilizing/solubilizing groups attached. |
| | Ligand can also contain nonbinding N, O, S, or |
| | P atoms. |
| O Valence Stabilizer #12: | R—O—S(═O)(═O)—S—S(═O)(═O)—O—R′, where R |
| Trithionic acid, Bis(trithionic acid), | and R′ represent H, NH₂ or any organic |
| Poly(trithionic acid), and derivatives | functional group wherein the number of carbon |
| thereof (O—O Bidentates, O—O Tridentates, | atoms ranges from 0 to 40, optionally having |
| O—O Tetradentates) | halogen or polarizing or water- |
| | insolubilizing/solubilizing groups attached. |
| | Ligand can also contain nonbinding N, O, S, or |
| | P atoms. |
| O Valence Stabilizer #13: | (R—O—)(R′—O—)P(═O)—P(═O)(—O—R″)(—O—R″′), |
| Hypophosphoric Acids, | where R, R′, R″, and R″′ represent H, NH₂ or |
| Bis(hypophosphoric acids), and | any organic functional group wherein the |
| Poly(hypophosphoric acids), and | number of carbon atoms ranges from 0 to 40, |
| derivatives thereof (O—O Bidentates, O—O | optionally having halogen or polarizing or |
| Tridentates, O—O Tetradentates) | water-insolubilizing/solubilizing groups |
| | attached. Ligand can also contain nonbinding N, |
| | O, S, or P atoms. Note: these ligands are not to |
| | be confused with hypophosphorous acid |
| | derivatives (hypophosphites) (R—O—) |
| | R″R″′P(═O) which are very reducing and |
| | therefore unacceptable for stabilization of high |
| | valence states in metal ions. |
| O Valence Stabilizer #14: | (RR′—N—)(R″R″′—N—)P(═O)—P(═O)(—N— |
| Hypophosphoramides, | R″″R″″′)(—N—R″″″R″″″′), where R, R′, R″, R″′, |
| Bis(hypophosphoramides), and | R″″, R″″′, R″″″, and R″″″′ represent H, NH₂ or |
| Poly(hypophosphoramides) (O—O | any organic functional group wherein the |
| Bidentates, O—O Tridentates, O—O | number of carbon atoms ranges from 0 to 40, |
| Tetradentates) | optionally having halogen or polarizing or |
| | water-insolubilizing/solubilizing groups |
| | attached. Ligand can also contain nonbinding N, |
| | O, S, or P atoms. Note: these ligands are not to |
| | be confused with hypophosphorous acid |
| | derivatives (hypophosphites) (R—O—) |
| | R″R″′P(═O) which are very reducing and |
| | therefore unacceptable for stabilization of high |
| | valence states in metal ions. |
| O Valence Stabilizer #15: | (R—O—)(R′—O—)P(═O)—NH—P(═O)(—O—R″)(—O— |
| Imidodiphosphoric Acids, | R″′) for imidodiphosphoric acids, and (R—O—) |
| Hydrazidodiphosphoric Acids, | (R′—O—)P(═O)—NH—NH—P(═O)(—O—R″)(—O—R″′) |
| Bis(imidodiphosphoric Acids), | for hydrazidodiphosphoric acids; where R, R′, |
| Bis(hydrazidodiphosphoric Acids), | R″, and R″′ represent H, NH₂ or any organic |
| Poly(imidodiphosphoric Acids), | functional group wherein the number of carbon |
| Poly(hydrazidodiphosphoric Acids), and | atoms ranges from 0 to 40, optionally having |
| derivatives thereof (O—O Bidentates, O—O | halogen or polarizing or water- |
| Tridentates, O—O Tetradentates) | insolubilizing/solubilizing groups attached. |
| | Ligand can also contain nonbinding N, O, S, or |
| | P atoms. |
| O Valence Stabilizer #16: | (RR′—N—)(R″R″′—N—)P(═O)—NH—P(═O)(—N— |
| Imidodiphosphoramides, | R″″R″″′)(—N—R″″″R″″″′) for |
| Hydrazidodiphosphoramides, | imidodiphosphoramides, and —NH—NH- |
| Bis(imidodiphosphoramides), | derivatives for hydrazidodiphosphoramides, |
| Bis(hydrazidodiphosphoramides), | where R, R′, R″, R″′, R″″, R″″′, R″″″, and |
| Poly(imidodiphosphoramides), and | R″″″′ represent H, NH₂ or any organic |
| Poly(hydrazidodiphosphoramides) (O—O | functional group wherein the number of carbon |
| Bidentates, O—O Tridentates, O—O | atoms ranges from 0 to 40, optionally having |
| Tetradentates) | halogen or polarizing or water- |
| | insolubilizing/solubilizing groups attached. |
| | Ligand can also contain nonbinding N, O, S, or |
| | P atoms. |
| O Valence Stabilizer #17: | (RR′—N—)(R″R″′—N—)P(═O)—O—P(═O)(—N— |
| Diphosphoramides, Bis(diphosphoramides), | R″″R″″′)(—N—R″″″R″″″′), where R, R′, R″, R″′, |
| and Poly(diphosphoramides) (O—O | R″″, R″″′, R″″″, and R″″″′ represent H, NH₂ or |
| Bidentates, O—O Tridentates, O—O | any organic functional group wherein the |
| Tetradentates) | number of carbon atoms ranges from 0 to 40, |
| | optionally having halogen or polarizing or |
| | water-insolubilizing/solubilizing groups |
| | attached. Ligand can also contain nonbinding N, |
| | O, S, or P atoms. |
| O Valence Stabilizer #18: | R—CR′(—OH)—CH₂—C(═O)—R″, where R, R′, and |
| Beta-Hydroxyketones, Beta- | R″ represent H, NH₂ or any organic functional |
| Hydroxyaldehydes, Bis(beta- | group wherein the number of carbon atoms |
| hydroxyketones), Bis(beta- | ranges from 0 to 40, optionally having halogen |
| hydroxyaldehydes), Poly(beta- | or polarizing or water- |
| hydroxyketones), and Poly(beta- | insolubilizing/solubilizing groups attached. |
| hydroxyaldehydes) (O—O Bidentates, O—O | Ligand can also contain nonbinding N, O, S, or |
| Tridentates, O—O Tetradentates) | P atoms. |
| O Valence Stabilizer #19: | RR′—N—C(═O)—C(═O)—N—R″R″′, where R, R′, |
| Oxamides, Bis(oxamides), and | R″, and R″′ represent H, NH₂ or any organic |
| Poly(oxamides) (O—O Bidentates, O—O | functional group wherein the number of carbon |
| Tridentates, O—O Tetradentates) | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| O Valence Stabilizer #20: | —C(—OH)═C(—OH)—, where the two carbon atoms |
| Squaric Acids and derivatives thereof (O—O | supporting the hydroxy groups are included |
| Bidentates) | within a cyclic hydrocarbon moiety, optionally |
| | having halogen or polarizing or water- |
| | insolubilizing/solubilizing groups attached. |
| | Ligand can also contain nonbinding N, O, S, or |
| | P atoms. |
| O Valence Stabilizer #21: | (R—O—)(O═)C—R′—C(═O)(—O—R″), where R, R′, |
| Dicarboxylic Acids, Bis(dicarboxylic | and R″ represent H, NH₂ or any organic |
| acids), Poly(dicarboxylic acids), and | functional group wherein the number of carbon |
| derivatives thereof (O—O Bidentates and O—O | atoms ranges from 0 to 40, optionally having |
| Tetradentates) | halogen or polarizing or water- |
| | insolubilizing/solubilizing groups attached. |
| | Ligand can also contain nonbinding N, O, S, or |
| | P atoms. |
| O Valence Stabilizer #22: | R—O—C(═O)—O—R′, where R, and R′ represent H, |
| Carbonates and Bis(carbonates) (O—O | NH₂ or any organic functional group wherein |
| Bidentates and O—O Tetradentates) | the number of carbon atoms ranges from 0 to |
| | 40, optionally having halogen or polarizing or |
| | water-insolubilizing/solubilizing groups |
| | attached. Ligand can also contain nonbinding N, |
| | O, S, or P atoms. |
| O Valence Stabilizer #23: | RR′N⁺═C(OH)(OH), where R and R′ represent |
| Carbamates, Bis(carbamates), and | H, OH, SH, OR″ (R″ = C₁—C₃₀ alkyl or aryl), |
| Poly(carbamates) (including N— | SR″ (R″ = C₁—C₃₀ alkyl or aryl), NH₂ or any |
| hydroxycarbamates and N— | organic functional group wherein the number of |
| mercaptocarbamates) (O—O Bidentates, O—O | carbon atoms ranges from 0 to 40, optionally |
| Tridentates, and O—O Tetradentates) | having halogen or polarizing or water- |
| | insolubilizing/solubilizing groups attached. |
| | Ligand can also contain nonbinding N, O, S, or |
| | P atoms. |
| O Valence Stabilizer #24: | RN═C(OH)(OH), where R represents H, NH₂ or |
| Carbimates, Bis(carbimates), and | any organic functional group wherein the |
| Poly(carbimates) (O—O Bidentates, O—O | number of carbon atoms ranges from 0 to 40, |
| Tridentates, and O—O Tetradentates) | optionally having halogen or polarizing or |
| | water-insolubilizing/solubilizing groups |
| | attached. Ligand can also contain nonbinding N, |
| | O, S, or P atoms. |
| O Valence Stabilizer #25: | RR′—N—CH(—OH) —NR″—C(═O)—NR″′R″″, where |
| N-(Aminomethylol)ureas [N- | R, R′, R″, R″′, and R″″ represent H, NH₂ or any |
| (Aminohydroxymethyl)ureas], Bis[N- | organic functional group wherein the number of |
| (aminomethylol)ureas], and Poly[N- | carbon atoms ranges from 0 to 40, optionally |
| (aminomethylol)ureas] (O—O Bidentates, O—O | having halogen or polarizing or water- |
| Tridentates, O—O Tetradentates) | insolubilizing/solubilizing groups attached. |
| | Ligand can also contain nonbinding N, O, S, or |
| | P atoms. |
| O Valence Stabilizer #26: | Cyanates bound directly to the high valence |
| Cyanate ligands (O Monodentates) | metal ion. |
| N—S Valence Stabilizer #1: | RR′—N—C(═NH)—S—S—C(═NH)—NR″R″′, where |
| Diformamidine Disulfides | R, R′, R″, and R″′ represent H, NH_{2,} or any |
| (Thioperoxydicarbonimidic Diamides or | organic functional group wherein the number of |
| Dihydrazides), Thioperoxytricarbonimidic | carbon atoms ranges from 0 to 40, optionally |
| Diamides or Dihydrazides, | having halogen or polarizing or water- |
| Thioperoxytetracarbonimidic Diamides or | insolubilizing/solubilizing groups attached. |
| Dihydrazides, Bis(diformamidine | Ligand can also contain nonbinding N, O, S, or |
| disulfides), and Poly(diformamidine | P atoms. |
| disulfides) (N—S Bidentates, N—S | |
| Tridentates, N—S Tetradentates) | |
| N—S Valence Stabilizer #2: | RR′—N—C(═NH)—S—CS—NR″R″′, where R, R′, |
| S-Amidinodithiocarbamates, Bis(S- | R″, and R″′ represent H, NH₂ or any organic |
| amidinodithiocarbamates), and Poly(S- | functional group wherein the number of carbon |
| amidinodithiocarbamates) (N—S Bidentates | atoms ranges from 0 to 40, optionally having |
| and N—S Tetradentates) | halogen or polarizing or water- |
| | insolubilizing/solubilizing groups attached. |
| | Ligand can also contain nonbinding N, O, S, or |
| | P atoms. |
| N—S Valence Stabilizer #3: | RR′—N—C(═NH)—O—CS—NR″R″′, where R, R′, |
| O-Amidinothiocarbamates, Bis(O- | R″, and R″′ represent H, NH₂ or any organic |
| amidinothiocarbamates), and Poly(O- | functional group wherein the number of carbon |
| amidinothiocarbamates) (N—S Bidentates | atoms ranges from 0 to 40, optionally having |
| and N—S Tetradentates) | halogen or polarizing or water- |
| | insolubilizing/solubilizing groups attached. |
| | Ligand can also contain nonbinding N, O, S, or |
| | P atoms. |
| N—S Valence Stabilizer #4: | RR′—N—C(═NH)—S—S—CS—NR″R″′, where R, R′, |
| S-Amidinoperoxythiocarbamates, Bis(S- | R″, and R″′ represent H, NH₂ or any organic |
| amidinoperoxythiocarbamates), and Poly(S- | functional group wherein the number of carbon |
| amidinoperoxythiocarbamates) (N—S | atoms ranges from 0 to 40, optionally having |
| Bidentates and N—S Tetradentates) | halogen or polarizing or water- |
| | insolubilizing/solubilizing groups attached. |
| | Ligand can also contain nonbinding N, O, S, or |
| | P atoms. |
| N—S Valence Stabilizer #5: | (NH═)P(—SR)(—OR′)(—OR″) for |
| Phosphorimidothioic Acid; | phosphorimidothioic acid, (NH═)P(—SR)(—SR′)(— |
| Phosphorimidodithioic Acid; | OR″) for phosphorimidodithioic acid, (NH═)P(— |
| Phosphorimidotrithioic Acid; | SR)(—SR′)(—SR″) for phosphorimidotrithioic |
| Bis(Phosphorimidothioic Acid); | acid, where R, R′, and R″ represent H, NH₂ or |
| Bis(Phosphorimidodithioic Acid); | any organic functional group wherein the |
| Bis(Phosphorimidotrithioic Acid); | number of carbon atoms ranges from 0 to 40, |
| Poly(Phosphorimidothioic Acid); | optionally having halogen or polarizing or |
| Poly(Phosphorimidodithioic Acid); | water-insolubilizing/solubilizing groups |
| Poly(Phosphorimidotrithioic Acid); and | attached. Ligand can also contain nonbinding N, |
| derivatives thereof (N—S Bidentates and N—S | O, S, or P atoms. |
| Tetradentates) | |
| N—S Valence Stabilizer #6: | (S═)P(—NRR′)(—NR″R″′)(—NR″″R″″′), where R, |
| Phosphorothioic Triamides, | R′, R″, R″′, R″″, and R″″′ represent H, NH₂ or |
| Bis(phosphorothioic triamides), and | any organic functional group wherein the |
| Poly(phosphorothioic triamides) (N—S | number of carbon atoms ranges from 0 to 40, |
| Bidentates and N—S Tetradentates) | optionally having halogen or polarizing or |
| | water-insolubilizing/solubilizing groups |
| | attached. Ligand can also contain nonbinding N, |
| | O, S, or P atoms. |
| N—S Valence Stabilizer #7: | (S═)P(—NRR′)(—SR″)(—SR″′) for |
| Phosphoramidotrithioic Acid, | phosphoramidotrithioic acid, and (S═)P(— |
| Phosphorodiamidodithioic Acid, | NRR′)(—NR″R″′)(—SR″″) for |
| Bis(phosphoramidotrithioic acid), | phosphorodiamidodithioic acid, where R, R′, |
| Bis(phosphorodiamidodithioic acid), | R″, R″′, and R″″ represent H, NH₂ or any |
| poly(phosphoramidotrithioic acid), | organic functional group wherein the number of |
| poly(phosphorodiamidodithioic acid), and | carbon atoms ranges from 0 to 40, optionally |
| derivatives thereof (N—S Bidentates and N—S | having halogen or polarizing or water- |
| Tetradentates) | insolubilizing/solubilizing groups attached. |
| | Ligand can also contain nonbinding N, O, S, or |
| | P atoms. |
| N—S Valence Stabilizer #8: | (O═)P(—NRR′)(—SR″)(—OR″′) or (S═)P(—NRR′)(— |
| Phosphoramidothioic Acid, | OR″)(—OR″′) for phosphoramidothioic acid; |
| Phosphoramidodithioic Acid, | (O═)P(—NRR′)(—SR″)(—SR″′) or (S═)P(—NRR′)(— |
| Phosphorodiamidothioic Acid, | SR″)(—OR″′) for phosphoramidodithioic acid; |
| Bis(Phosphoramidothioic Acid), | (O═)P(—NRR′)(—NR″R″′)(—SR″″) or (S═)P(— |
| Bis(Phosphoramidodithioic Acid), | NRR′)(—NR″R″′)(—OR″″) for |
| Bis(Phosphorodiamidothioic Acid), | phosphorodiamidothioic acid, where R, R′, R″, |
| Poly(Phosphoramidothioic Acid), | R″′, and R″″ represent H, NH₂ or any organic |
| Poly(Phosphoramidodithioic Acid), and | functional group wherein the number of carbon |
| Poly(Phosphorodiamidothioic Acid) (N—S | atoms ranges from 0 to 40, optionally having |
| Bidentates and N—S Tetradentates) | halogen or polarizing or water- |
| | insolubilizing/solubilizing groups attached. |
| | Ligand can also contain nonbinding N, O, S, or |
| | P atoms. |
| N—S Valence Stabilizer #9: | R′—C(═S)—N═C(—R)(—NHR″), where R is an |
| N-Thioacyl 7-Aminobenzylidenimines (N—S | aromatic derivative (i.e., —C₆H₅), and R′and R″ |
| Bidentates or N—S Tetradentates) | represent H, NH₂, or any organic functional |
| | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| N—S Valence Stabilizer #10: | R—C(═S)—NR′—OH or R—C(—SH)═N—OH, where |
| Thiohydroxamates (Thiohydroxylamines), | R and R′ represent H, NH₂, or any organic |
| Bis(thiohydroxamates), and | functional group wherein the number of carbon |
| Poly(thiohydroxamates) (N—S Bidentates, | atoms ranges from 0 to 40, optionally having |
| N—S Tetradentates, and N—S Hexadentates) | halogen or polarizing or water- |
| | insolubilizing/solubilizing groups attached. |
| | Ligand can also contain nonbinding N, O, S, or |
| | P atoms. |
| N—S Valence Stabilizer #11: | R—CH(—NHR′)—C(═S)(—OH) or R—CH(—NHR′)— |
| Alpha- or ortho-Aminothiocarboxylic | C(═S)(—SH) for aminothiocarboxylic acids, and |
| Acids, and alpha- or ortho- | (HO—)(S═)C—CH(—NHR)—R′—CH(—NHR″)— |
| Aminothiodicarboxylic Acids, and | C(═S)(—OH) or (HS—)(S═)C—CH(—NHR)—R′— |
| derivatives thereof (N—S Bidentates, N—S | CH(—NHR″)—C(═S)(—SH) for |
| Tridentates, and N—S Tetradentates) | aminothiodicarboxylic acids, where R, R′, and |
| | R″ represent any organic functional group |
| | wherein the number of carbon atoms ranges |
| | from 1 to 40, optionally having halogen or |
| | polarizing or water-insolubilizing/solubilizing |
| | groups attached. Ligand can also contain |
| | nonbinding N, O, S, or P atoms. |
| N—S Valence Stabilizer #12: | RR′—N—C(═S)—NR″—N═CR″′R″″, where R, R′, |
| Thiosemicarbazones, | R″, R″′, and R″″ represent H, or any organic |
| Bis(thiosemicarbazones), and | functional group wherein the number of carbon |
| Poly(thiosemicarbazones) (N—S Bidentates, | atoms ranges from 0 to 40, optionally having |
| N—S Tetradentates, and N—S Hexadentates) | halogen or polarizing or water- |
| | insolubilizing/solubilizing groups attached. |
| | Ligand can also contain nonbinding N, O, S, or |
| | P atoms. |
| N—S Valence Stabilizer #13: | R—C(═S)—NR′—N═CR″R″′, where R, R′, R″, and |
| Thioacyl hydrazones, Bis(thioacyl | R″′ represent H, or any organic functional |
| hydrazones), and Poly(thioacyl hydrazones) | group wherein the number of carbon atoms |
| (N—S Bidentates, N—S Tetradentates, and N—S | ranges from 0 to 40, optionally having halogen |
| Hexadentates) | or polarizing or water- |
| | insolubilizing/solubilizing groups attached. |
| | Ligand can also contain nonbinding N, O, S, or |
| | P atoms. |
| N—S Valence Stabilizer #14: | R—N═N—C(═S)—NR′—NR″R″′, where R, R′, R″, |
| Thiocarbazones (Diazenecarbothioic | and R″′ represent H, or any organic functional |
| hydrazides), Bis(thiocarbazones), and | group wherein the number of carbon atoms |
| Poly(thiocarbazones) (N—S Bidentates, N—S | ranges from 0 to 40, optionally having halogen |
| Tetradentates, and N—S Hexadentates) | or polarizing or water- |
| | insolubilizing/solubilizing groups attached. |
| | Ligand can also contain nonbinding N, O, S, or |
| | P atoms. |
| N—S Valence Stabilizer #15: | R—N═N—R′ for azo compounds, R—N═N—NH—R′ |
| Azo compounds including triazenes with | for triazenes, where R, and R′ represent H or |
| thiol or mercapto or thiocarbonyl | any organic functional group wherein the |
| substitution at the ortho- (for aryl) or alpha- | number of carbon atoms ranges from 0 to 40, |
| or beta-(for alkyl) positions, Bis[o-(HS—) or | optionally having halogen or polarizing or |
| alpha- or beta-(HS—)azo compounds], or | water-insolubilizing/solubilizing groups |
| Poly[o-(HS—) or alpha- or beta-(HS—)azo | attached. (Must include ortho-thio, mercapto, or |
| compounds) (N—S Bidentates, N—S | thiocarbonyl substituted aryl azo compounds, |
| Tridentates, N—S Tetradentates, or N—S | and alpha- or beta- thio, mercapto, or |
| Hexadentates) | thiocarbonyl alkyl azo compounds.) Ligand can |
| | also contain nonbinding N, O, S, or P atoms. |
| N—S Valence Stabilizer #16: | R—N═N—C(═S)—NR′R″ for |
| Diazeneformothioamides, | diazeneformothioamides, and R—N═N—CR′R″— |
| Diazeneacetothioamides, | C(═S)—NR″′R″″ for |
| Bis(diazeneformothioamides), | diazeneacetothioamides, where R, R′, R″, R″′, |
| Bis(diazeneacetothioamides), | and R″″ represent H, NH₂, or any organic |
| Poly(diazeneformothioamides), and | functional group wherein the number of carbon |
| Poly(diazeneacetothioamides) (N—S | atoms ranges from 0 to 40, optionally having |
| Bidentates, N—S Tetradentates, and N—S | halogen or polarizing or water- |
| Hexadentates) | insolubilizing/solubilizing groups attached. |
| | Ligand can also contain nonbinding N, O, S, or |
| | P atoms. |
| N—S Valence Stabilizer #17: | R—N═N—C(═S)—O—R′ or R—N═N—CR′R″—C(═S)— |
| Diazenecarbothioic acids, | O—R″′ for diazenecarbothioic acids, and R— |
| Diazenecarbodithioic acids, | N═N—C(═S)—S—R′ or R—N═N—CR′R″—C(═S)—S— |
| Bis(diazenecarbothioic acids), | R″′ for diazenecarbodithoic acids, where R, R′, |
| Bis(diazenecarbodithioic acids), | R″, and R″′ represent H, NH₂, or any organic |
| Poly(diazenecarbothioic acids), | functional group wherein the number of carbon |
| Poly(diazenecarbodithioic acids) and | atoms ranges from 0 to 40, optionally having |
| derivatives thereof (N—S Bidentates, N—S | halogen or polarizing or water- |
| Tetradentates, N—S Hexadentates) | insolubilizing/solubilizing groups attached. |
| | Ligand can also contain nonbinding N, O, S, or |
| | P atoms. |
| N—S Valence Stabilizer #18: | R—N═N—C(═S)—R′ for |
| Diazeneformothioaldehydes, | diazeneformothioaldehydes, and R—N═N— |
| Diazeneacetothioaldehydes, | CR′R″—C(═S)—R″′ for |
| Bis(diazeneformothioaldehydes), | diazeneacetothioaldehydes, where R, R′, R″, |
| Bis(diazeneacetothioaldehydes), | and R″′ represent H, NH₂, or any organic |
| Poly(diazeneformothioaldehydes), and | functional group wherein the number of carbon |
| Poly(diazeneacetothioaldehydes) (N—S | atoms ranges from 0 to 40, optionally having |
| Bidentates, N—S Tetradentates and N—S | halogen or polarizing or water- |
| Hexadentates) | insolubilizing/solubilizing groups attached. |
| | Ligand can also contain nonbinding N, O, S, or |
| | P atoms. |
| N—S Valence Stabilizer #19: | RR′—N—C(═S)—N═N—C(═S)—NR″R″′ or RR′—N— |
| Diazenediformothioamides, | C(═S)—N═N—C(═O)—NR″R″′ for |
| Diazenediacetothioamides, | diazenediformothioamides, and RR′—N—C(═S)— |
| Bis(diazenediformothioamides), | CR″R″′—N═N—CR″″R″″′—C(═S)—NR″″″R″″″′ or |
| Bis(diazenediacetothioamides), | RR′—N—C(═S)—CR″R″′—N═N—CR″″R″″′—C(═O)— |
| Poly(diazenediformothioamides), and | NR″″″R″″″′ for diazenediacetothioamides, |
| Poly(diazenediacetothioamides) (N—S | where R, R′, R″, R″′, R″″, R″″′, R″″″, and |
| Tridentates and N—S Hexadentates) | R″″″′ represent H, NH₂, or any organic |
| | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| N—S Valence Stabilizer #20: | R—O—C(═S)—N═N—C(═S)—O—R′, R—O—C(═S)— |
| Diazenedicarbothioic acids, | CR′R″—N═N—CR″′R″″—C(═S)—O—R″″′, R—O— |
| Diazenedicarbodithioic acids, | C(═S)—N═N—C(═O)—O—R′, or R—O—C(═S)— |
| Bis(diazenedicarbothioic acids), | CR′R″—N═N—CR″′R″″—C(═O)—O—R″″′ for |
| Bis(diazenedicarbodithioic acids), | diazenedicarbothioic acids, and R—S—C(═S)— |
| Poly(diazenedicarbothioic acids), | N═N—C(═S)—S—R′ or R—S—C(═S)—CR′R″—N═N— |
| Poly(diazenedicarbodithioic acids) and | CR″′R″″—C(═S)—S—R″″′ for |
| derivatives thereof (N—S Tridentates and N—S | diazenedicarbodithoic acids, where R, R′, R″, |
| Hexadentates) | R″′, R″″, and R″″′ represent H, NH₂, or any |
| | organic functional group wherein the number of |
| | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. |
| N—S Valence Stabilizer #21: | RC(═S)—N═N—C(═S)—R′ or RC(═S)—N═N— |
| Diazenediformothioaldehydes, | C(═O)—R′ for diazenediformothioaldehydes, and |
| Diazenediacetothioaldehydes, | RC(═S)—CR′R″—N═N—CR″′R″″—C(═S)—R″″′ or |
| Bis(diazenediformothioaldehydes), | RC(═S)—CR′R″—N═N—CR″′R″″—C(═O)—R″″′ for |
| Bis(diazenediacetothioaldehydes), | diazenediacetothioaldehydes, where R, R′, R″, |
| Poly(diazenediformothioaldehydes), and | R″′, R″″, and R″″′ represent H, NH₂, or any |
| Poly(diazenediacetothioaldehydes) (N—S | organic functional group wherein the number of |
| Tridentates and N—S Hexadentates) | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. |
| N—S Valence Stabilizer #22: | R—N═N—CR′═N—NR″R″′, where R, R′, R″, and |
| Ortho-thio (or -mercapto) Substituted | R″′ represent H, or any organic functional |
| Formazans, Bis(o-thio or -mercapto | group wherein the number of carbon atoms |
| substituted formazans), and Poly(o-thio or — | ranges from 0 to 40, optionally having halogen |
| mercapto substituted formazans) (N—S | or polarizing or water- |
| Bidentates, N—S Tridentates, N—S | insolubilizing/solubilizing groups attached. |
| Tetradentates, and N—S Hexadentates) | (Must include ortho-thio or mercapto |
| | substituted aryl R derivatives, and beta- thio or |
| | mercapto substituted alkyl R derivatives.) |
| | Ligand can also contain nonbinding N, O, S, or |
| | P atoms. |
| N—S Valence Stabilizer #23: | RR′C═N—N═CR″R″′ or RR′C═N—NR″R″′ (for |
| Ortho-thio (or -mercapto) Substituted | ketazines), where R, R′, R″, and R″′ represent |
| Azines (including ketazines), Bis(o-thio or | H, or any organic functional group wherein the |
| mercapto substituted azines), and Poly(o- | number of carbon atoms ranges from 0 to 40, |
| thio or mercapto substituted azines) (N—S | optionally having halogen or polarizing or |
| Bidentates, N—S Tridentates, N—S | water-insolubilizing/solubilizing groups |
| Tetradentates, and N—S Hexadentates) | attached. (Must include ortho-thio or mercapto |
| | substituted aryl R derivatives, and beta- thio or |
| | mercapto substituted alkyl R derivatives.) |
| | Ligand can also contain nonbinding N, O, S, or |
| | P atoms. |
| N—S Valence Stabilizer #24: | RR′C═N—R″, where R, R′, and R″ represent H, |
| Schiff Bases with one Imine (C═N) Group | or any organic functional group wherein the |
| and with ortho- or alpha- or beta- thio or | number of carbon atoms ranges from 0 to 40, |
| mercapto or thiocarbonyl substitution (N—S | optionally having halogen or polarizing or |
| Bidentates, N—S Tridentates, N—S | water-insolubilizing/solubilizing groups |
| Tetradentates, N—S Pentadentates, or N—S | attached. (Must contain ortho- or alpha- or beta- |
| Hexadentates). Also includes Schiff Bases | thio or mercapto or thiocarbonyl substitution.) |
| derived from the reaction of carbonyl | Ligand can also contain nonbinding N, O, S, or |
| compounds with dithiocarbazates, and | P atoms. |
| hydrazones with ortho-S substitution. | |
| N—S Valence Stabilizer #25: | RR′C═N—R″—N═CR″′R″″ or R—N═C—R′—C═N— |
| Schiff Bases with two Imine (C═N) Groups | R′ or RC═N—R′—N═CR″, where R, R′, R″, R″′, |
| and with ortho- or alpha- or beta- thio or | and R″″ represent H, or any organic functional |
| mercapto or thiocarbonyl substitution (N—S | group wherein the number of carbon atoms |
| Tridentates, N—S Tetradentates, N—S | ranges from 0 to 40, optionally having halogen |
| Pentadentates, or N—S Hexadentates). Also | or polarizing or water- |
| includes Schiff Bases derived from the | insolubilizing/solubilizing groups attached. |
| reaction of carbonyl compounds with | (Must contain ortho- or alpha- or beta- thio or |
| dithiocarbazates, and hydrazones with | mercapto or thiocarbonyl substitution.) Ligand |
| ortho-S substitution. | can also contain nonbinding N, O, S, or P |
| | atoms. |
| N—S Valence Stabilizer #26: | N(—R—N═CR′R″)₃, where R, R′, and R″ |
| Schiff Bases with three Imine (C═N) | represent H, or any organic functional group |
| Groups and with ortho- or alpha- or beta- | wherein the number of carbon atoms ranges |
| thio or mercapto or thiocarbonyl | from 0 to 40, optionally having halogen or |
| substitution (N—S Tetradentates, N—S | polarizing or water-insolubilizing/solubilizing |
| Pentadentates, or N—S Hexadentates). Also | groups attached. (Must contain ortho- or alpha- |
| includes Schiff Bases derived from the | or beta- thio or mercapto or thiocarbonyl |
| reaction of carbonyl compounds with | substitution.) Ligand can also contain |
| dithiocarbazates, and hydrazones with | nonbinding N, O, S, or P atoms. |
| ortho-S substitution. | |
| N—S Valence Stabilizer #27: | [R—CR′(—NR″R″′)]ₓ—R″″—[C(— |
| Thioalkyl Amines (Aminothiols or | SR″″′)R″″″R″″″′]_{y}, [R—CR′(—NR″R″′)]ₓ—R″″— |
| Aminodisulfides) and Thioalkyl Imines | [C(—S—S—R″″′)R″″″R″″″′]_{y}, or [R—CR′(— |
| (Iminothiols or Iminodisulfides) (N—S | NR″R″′)]ₓ—R″″—[C(═S)R″″′]_{y} for thioalkyl |
| Bidentates, N—S Tridentates, N—S | amines; and [R—C(═NR′)]ₓ—R″—[C(— |
| Tetradentates, and N—S Hexadentates) | SR″′)R″″R″″′]_{y}, [R—C(═NR′)]ₓ—R″—[C(—S— |
| | SR″′)R″″R″″′]_{y}, or [R—C(═NR′)]ₓ—R″— |
| | [C(═S)R″′]_{y} for thioalkyl imines, where R, R′, |
| | R″, R″′, R″″, R″″′, R″″″, and R″″″′ represent |
| | H, NH₂, or any organic functional group |
| | wherein the number of carbon atoms ranges |
| | from 0 to 40, optionally having halogen or |
| | polarizing or water-insolubilizing/solubilizing |
| | groups attached, and x and y = 1−6. Ligand can |
| | also contain nonbinding N, O, S, or P atoms. |
| N—S Valence Stabilizer #28: | [R(—NR′R″)(—SR″′)], [R(—NR′R″)(—S—S—R″′)], |
| Thioaryl Amines and Thioaryl Imines (N—S | [R(—NR′R″)(—C(═S)R″′], [R(—NR′R″)ₓ]₂S, [R(— |
| Bidentates, N—S Tridentates, N—S | NR′R″)ₓ]₂₋₃R″′(—SR″″)_{y}, [R(—SR′)ₓ]₂₋₃R″(— |
| Tetradentates, and N—S Hexadentates) | NR″′R″″)_{y}, [R(—NR′R″)ₓ]₂S₂, and [R(— |
| | NR′R″)ₓ]₂R″′(C(═S))_{y}R″″ for thioaryl amines; |
| | and [R(—SR′)ₓ]₂NH or [R(—SR′)ₓ]₂NHNH for |
| | thioaryl imines, where R, R′, R″, R″′, and R″″ |
| | represent H, NH₂, or any organic functional |
| | group wherein the number of carbon atoms |
| | ranges from 0 to 40, optionally having halogen |
| | or polarizing or water- |
| | insolubilizing/solubilizing groups attached, and |
| | x = 0−2 and y = 1−4. Ligand can also contain |
| | nonbinding N, O, S, or P atoms. |
| N—S Valence Stabilizer #29: | Five membered heterocyclic ring(s) containing |
| Five-Membered Heterocyclic Rings | one, two, three, or four nitrogen atoms. In |
| containing One, Two, Three, or Four | addition, ligand contains additional sulfur- |
| Nitrogen Atoms at least one additional | containing substituents (usually thiols, |
| Sulfur Atom Binding Site not in a Ring (N—S | mercaptans, disulfides, or thiocarbonyls) that |
| Bidentates, N—S Tridentates, N—S | constitute S binding sites. Can include other |
| Tetradentates, or N—S Hexadentates) | ring systems bound to the heterocyclic ring or to |
| | the S-containing substituent, but they do not |
| | coordinate with the stabilized, high valence |
| | metal ion. Ring(s) can also contain O, S, or P |
| | atoms. This 5-membered ring(s) and/or |
| | attached, uncoordinating rings and/or S- |
| | containing substituent(s) may or may not have |
| | halogen or polarizing or water- |
| | insolubilizing/solubilizing groups attached. |
| N—S Valence Stabilizer #30: | Six membered heterocyclic ring(s) containing |
| Six-Membered Heterocyclic Rings | one, two, three, or four nitrogen atoms. In |
| containing One, Two, Three, or Four | addition, ligand contains additional sulfur- |
| Nitrogen Atoms at least one additional | containing substituents (usually thiols, |
| Sulfur Atom Binding Site not in a Ring (N—S | mercaptans, disulfides, or thiocarbonyls) that |
| Bidentates, N—S Tridentates, N—S | constitute S binding sites. Can include other |
| Tetradentates, or N—S Hexadentates) | ring systems bound to the heterocyclic ring or to |
| | the S-containing substituent, but they do not |
| | coordinate with the stabilized, high valence |
| | metal ion. Ring(s) can also contain O, S, or P |
| | atoms. This 6-membered ring(s) and/or |
| | attached, uncoordinating rings and/or S- |
| | containing substituent(s) may or may not have |
| | halogen or polarizing or water- |
| | insolubilizing/solubilizing groups attached. |
| N—S Valence Stabilizer #31: | Five membered heterocyclic ring(s) containing |
| Five-Membered Heterocyclic Rings | one or two sulfur atoms. In addition, ligand |
| containing One or Two Sulfur Atoms at | contains additional nitrogen-containing |
| least one additional Nitrogen Atom Binding | substituents (usually amines, imines, or |
| Site not in a Ring (N—S Bidentates, N—S | hydrazides) that constitute N binding sites. Can |
| Tridentates, N—S Tetradentates, or N—S | include other ring systems bound to the |
| Hexadentates) | heterocyclic ring or to the N-containing |
| | substituent, but they do not coordinate with the |
| | stabilized, high valence metal ion. Ring(s) can |
| | also contain O, S, or P atoms. This 5-membered |
| | ring(s) and/or attached, uncoordinating rings |
| | and/or N-containing substituent(s) may or may |
| | not have halogen or polarizing or water- |
| | insolubilizing/solubilizing groups attached. |
| N—S Valence Stabilizer #32: | Six membered heterocyclic ring(s) containing |
| Six-Membered Heterocyclic Rings | one or two sulfur atoms. In addition, ligand |
| containing One or Two Sulfur Atoms at | contains additional nitrogen-containing |
| least one additional Nitrogen Atom Binding | substituents (usually amines, imines, or |
| Site not in a Ring (N—S Bidentates, N—S | hydrazides) that constitute N binding sites. Can |
| Tridentates, N—S Tetradentates, or N—S | include other ring systems bound to the |
| Hexadentates) | heterocyclic ring or to the N-containing |
| | substituent, but they do not coordinate with the |
| | stabilized, high valence metal ion. Ring(s) can |
| | also contain O, S, or P atoms. This 6-membered |
| | ring(s) and/or attached, uncoordinating rings |
| | and/or N-containing substituent(s) may or may |
| | not have halogen or polarizing or water- |
| | insolubilizing/solubilizing groups attached. |
| N—S Valence Stabilizer #33: | Five membered heterocyclic ring(s) containing |
| Five-Membered Heterocyclic Rings | one, two, three, or four nitrogen atoms. In |
| containing One, Two, Three, or Four | addition, ligand contains additional sulfur- |
| Nitrogen Atoms at least one additional | containing rings that constitute S binding sites. |
| Sulfur Atom Binding Site in a Separate | Can include other ring systems bound to the N- |
| Ring (N—S Bidentates, N—S Tridentates, N—S | or S-containing heterocyclic rings, but they do |
| Tetradentates) | not coordinate with the stabilized, high valence |
| | metal ion. Ring(s) can also contain O, S, or P |
| | atoms. This 5-membered ring(s) and/or |
| | additional S-containing ring(s) and/or attached, |
| | uncoordinating rings may or may not have |
| | halogen or polarizing or water- |
| | insolubilizing/solubilizing groups attached. |
| N—S Valence Stabilizer #34: | Six membered heterocyclic ring(s) containing |
| Six-Membered Heterocyclic Rings | one, two, three, or four nitrogen atoms. In |
| containing One, Two, Three, or Four | addition, ligand contains additional sulfur- |
| Nitrogen Atoms at least one additional | containing rings that constitute S binding sites. |
| Sulfur Atom Binding Site in a Separate | Can include other ring systems bound to the N- |
| Ring (N—S Bidentates, N—S Tridentates, N—S | or S-containing heterocyclic rings, but they do |
| Tetradentates) | not coordinate with the stabilized, high valence |
| | metal ion. Ring(s) can also contain O, S, or P |
| | atoms. This 6-membered ring(s) and/or |
| | additional S-containing ring(s) and/or attached, |
| | uncoordinating rings may or may not have |
| | halogen or polarizing or water- |
| | insolubilizing/solubilizing groups attached. |
| N—S Valence Stabilizer #35: | Macrocyclic ligands containing two, three, four, |
| Two-, Three-, Four-, Six-, Eight-, and Ten- | six, eight, or ten binding sites composed of |
| Membered Macrocyclics, Macrobicyclics, | nitrogen and sulfur to valence stabilize the |
| and Macropolycyclics (including | central metal ion. Can include other |
| Catapinands, Cryptands, Cyclidenes, and | hydrocarbon or ring systems bound to this |
| Sepulchrates) wherein all Binding Sites are | macrocyclic ligand, but they do not coordinate |
| composed of Nitrogen (usually amine or | with the stabilized, high valence metal ion. This |
| imine groups) or Sulfur (usually thiols, | ligand and/or attached, uncoordinating |
| mercaptans, or thiocarbonyls) and are not | hydrocarbons/rings may or may not have |
| contained in Component Heterocyclic | halogen or polarizing or water- |
| Rings (N—S Bidentates, N—S Tridentates, N—S | insolubilizing/solubilizing groups attached. |
| Tetradentates, and N—S Hexadentates) | |
| N—S Valence Stabilizer #36: | Macrocyclic ligands containing a total of four, |
| Four-, Six-, Eight-, or Ten-Membered | six, eight, or ten heterocyclic rings containing |
| Macrocyclics, Macrobicyclics, and | nitrogen or sulfur binding sites. Can include |
| Macropolycyclics (including Catapinands, | other hydrocarbon/ring systems bound to this |
| Cryptands, Cyclidenes, and Sepulchrates) | macrocyclic ligand, but they do not coordinate |
| wherein all Binding Sites are composed of | with the stabilized, high valence metal ion. This |
| Nitrogen or Sulfur and are contained in | ligand and/or attached, uncoordinating |
| Component Heterocyclic Rings (N—S | hydrocarbon/rings may or may not have halogen |
| Bidentates, N—S Tridentates, N—S | or polarizing or water-insolubilizing groups |
| Tetradentates, or N—S Hexadentates) | attached. |
| N—S Valence Stabilizer #37: | Macrocyclic ligands containing at least one |
| Four-, Six-, Eight-, or Ten-Membered | heterocyclic ring. These heterocyclic rings |
| Macrocyclics, Macrobicyclics, and | provide nitrogen or sulfur binding sites to |
| Macropolycyclics (including Catapinands, | valence stabilize the central metal ion. Other |
| Cryptands, Cyclidenes, and Sepulchrates) | amine, imine, thiol, mercapto, or thiocarbonyl |
| wherein all Binding Sites are composed of | binding sites can also be included in the |
| Nitrogen or Sulfur and are contained in a | macrocyclic ligand, so long as the total number |
| Combination of Heterocyclic Rings and | of binding sites is four, six, eight, or ten. Can |
| Amine, Imine, Thiol, Mercapto, or | include other hydrocarbon/ring systems bound |
| Thiocarbonyl Groups (N—S Bidentates, N—S | to this macrocyclic ligand, but they do not |
| Tridentates, N—S Tetradentates, or N—S | coordinate with the stabilized, high valence |
| Hexadentates) | metal ion. This ligand and/or attached, |
| | uncoordinating hydrocarbon/rings may or may |
| | not have halogen or polarizing or water- |
| | insolubilizing groups attached. |
| N—O Valence Stabilizer #1: | R′—N(—OH)—C(—R)═N—R″, where R, R′, and |
| N-Hydroxy(or N,N′-dihydroxy)amidines | R″represent H or any organic functional group |
| and N-Hydroxy(or N,N′- | wherein the number of carbon atoms ranges |
| dihydroxy)diamidines (N—O Bidentates, N—O | from 0 to 40, optionally having halogen or |
| Tridentates, or N—O Tetradentates) | polarizing or water-insolubilizing/solubilizing |
| | groups attached. Ligand can also contain |
| | nonbinding N, O, S, or P atoms. |
| N—O Valence Stabilizer #2: | RR′—N—C(═NH)—NR″—CO—NR″′R″″ for |
| Guanylureas, Guanidinoureas, | guanylureas, and RR′—N—C(═NH)—NR″—NH—CO— |
| Bis(guanylureas), Bis(guanidinoureas), | NR″′R″″ for guanidinoureas, where R, R′, R″, |
| Poly(guanylureas), and | R″′, and R″″ represent H, NH₂, or any organic |
| Poly(guanidinoureas) (N—O Bidentates and | functional group wherein the number of carbon |
| N—O Tetradentates) | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| N—O Valence Stabilizer #3: | RR′—N—C(═NH)—NR″—CO—R″′ for N— |
| Amidinoamides, Guanidinoamides, | amidinoamides, or RR′—N—C(═NH)—CR″R″′— |
| Bis(amidinoamides), Bis(guanidinoamides), | CO—N—R″″R″″′ for 2-amidinoacetamides, and |
| Poly(amidinoamides), and | RR′—N—C(═NH)—NR″—NH—CO—R″′ for |
| Poly(guanidinoamides) (including both N- | guanidinoamides, where R, R′, R″, R″′, R″″, |
| amidinoamides and 2-amidinoacetamides) | and R″″′ represent H, NH₂, or any organic |
| (N—O Bidentates and N—O Tetradentates) | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| N—O Valence Stabilizer #4: | R—C(═NH)—NR′—CO—R″, where R, R′, and R″, |
| Imidoylamides, Bis(imidoylamides), and | represent H or any organic functional group |
| Poly(imidoylamides) (N—O Bidentates and | wherein the number of carbon atoms ranges |
| N—O Tetradentates) | from 0 to 40, optionally having halogen or |
| | polarizing or water-insolubilizing/solubilizing |
| | groups attached. Ligand can also contain |
| | nonbinding N, O, S, or P atoms. |
| N—O Valence Stabilizer #5: | RR′—N—C(═NH)—O—CO—NR″R″′, where R, R′, |
| O-Amidinocarbamates, Bis(O- | R″, and R″′ represent H, NH₂, or any organic |
| amidinocarbamates), and Poly(O- | functional group wherein the number of carbon |
| amidinocarbamates) (N—O Bidentates and | atoms ranges from 0 to 40, optionally having |
| N—O Tetradentates) | halogen or polarizing or water- |
| | insolubilizing/solubilizing groups attached. |
| | Ligand can also contain nonbinding N, O, S, or |
| | P atoms. |
| N—O Valence Stabilizer #6: | RR′—N—C(═NH)—S—CO—NR″R″′, where R, R′, |
| S-Amidinothiocarbamates, Bis(S- | R″, and R″′ represent H, NH₂, or any organic |
| amidinothiocarbamates), and Poly(S- | functional group wherein the number of carbon |
| amidinothiocarbamates) (N—O Bidentates | atoms ranges from 0 to 40, optionally having |
| and N—O Tetradentates) | halogen or polarizing or water- |
| | insolubilizing/solubilizing groups attached. |
| | Ligand can also contain nonbinding N, O, S, or |
| | P atoms. |
| N—O Valence Stabilizer #7: | (NH═)(NH═)P(OR)(OR′), where R, R′, and R″ |
| Diimidosulfuric Acid, Bis(diimidosulfuric | represent H, NH₂, or any organic functional |
| acid), and derivatives thereof (N—O | group wherein the number of carbon atoms |
| Bidentates and N—O Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| N—O Valence Stabilizer #8: | (NH═)P(—OR)(—OR′)(—OR″), where R, R′, and |
| Phosphorimidic Acid, Bis(phosphorimidic | R″ represent H, NH₂, or any organic functional |
| acid); and Poly(phosphorimidic acid), and | group wherein the number of carbon atoms |
| derivatives thereof (N—O Bidentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| N—O Valence Stabilizer #9: | (O═)P(—NRR′)(—NR″R″′)(—NR″″R″″′), where R, |
| Phosphoric Triamides, Bis(phosphoric | R′, R″, R″′, R″″, and R″″′ represent H, NH₂, or |
| triamides), and Poly(phosphoric triamides) | any organic functional group wherein the |
| (N—O Bidentates and N—O Tetradentates) | number of carbon atoms ranges from 0 to 40, |
| | optionally having halogen or polarizing or |
| | water-insolubilizing/solubilizing groups |
| | attached. Ligand can also contain nonbinding N, |
| | O, S, or P atoms. |
| N—O Valence Stabilizer #10: | (O═)P(—NRR′)(—OR″)(—OR″′) for |
| Phosphoramidic Acid, Phosphorodiamidic | phosphoramidic acid and (O═)P(—NRR′)(— |
| Acid, Bis(phosphoramidic acid), | NR″R″′)(—OR″″) for phosphorodiamidic acid, |
| Bis(phosphorodiamidic acid), | where R, R′, R″, R″′, and R″″ represent H, |
| Poly(phosphoramidic acid), | NH₂, or any organic functional group wherein |
| Poly(phosphorodiamidic acid), and | the number of carbon atoms ranges from 0 to |
| derivatives thereof (N—O Bidentates and N—O | 40, optionally having halogen or polarizing or |
| Tetradentates) | water-insolubilizing/solubilizing groups |
| | attached. Ligand can also contain nonbinding N, |
| | O, S, or P atoms. |
| N—O Valence Stabilizer #11: | R′—C(═O)—N═C(—R)(—NHR″), where R is an |
| N-Acyl 7-Aminobenzylidenimines (N—O | aromatic derivative (i.e., —C₆H₅), and R′ and R″ |
| Bidentates or N—O Tetradentates) | represent H, NH₂, or any organic functional |
| | group wherein the number of carbon atoms |
| | ranges from 0 to 40, optionally having halogen |
| | or polarizing or waterinsolubilizing/solubilizing |
| | groups attached. Ligand can also contain |
| | nonbinding N, O, S, or P atoms. |
| N—O Valence Stabilizer #12: | R—C(═NOH)—R′ for oximes, and R—C(═NOH)— |
| Oximes, Dioximes, and Poly(oximes) (N—O | C(═NOH)—R′ for dioximes, where R and R′ |
| Bidentates, N—O Tridentates, and N—O | represent H, NH₂, or any organic functional |
| Tetradentates) | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| N—O Valence Stabilizer #13: | R—C(═O)—C(═NOH)—R′, where R and R′ |
| Carbonyl oximes, Bis(carbonyl oximes), | represent H, NH₂, or any organic functional |
| and Poly(carbonyl oximes) (N—O | group wherein the number of carbon atoms |
| Bidentates, N—O Tridentates, and N—O | ranges from 0 to 40, optionally having halogen |
| Tetradentates) | or polarizing or water- |
| | insolubilizing/solubilizing groups attached. |
| | Ligand can also contain nonbinding N, O, S, or |
| | P atoms. |
| N—O Valence Stabilizer #14: | R—C(═N—R″)—C(═NOH)—R′, where R, R′, and R″ |
| Imine oximes, Bis(imine oximes), and | represent H, NH₂, or any organic functional |
| Poly(imine oximes) (including 2-nitrogen | group wherein the number of carbon atoms |
| heterocyclic oximes) (N—O Bidentates, N—O | ranges from 0 to 40, optionally having halogen |
| Tridentates, N—O Tetradentates, and N—O | or polarizing or water- |
| Hexadentates) | insolubilizing/solubilizing groups attached. |
| | Ligand can also contain nonbinding N, O, S, or |
| | P atoms. |
| N—O Valence Stabilizer #15: | R—CH(—OH)—C(═NOH)—R′, where R, R′, and R″ |
| Hydroxy oximes, Bis(hydroxy oximes), and | represent H, NH₂, or any organic functional |
| Poly(hydroxy oximes) (including 2-oxygen | group wherein the number of carbon atoms |
| heterocyclic oximes) (N—O Bidentates, N—O | ranges from 0 to 40, optionally having halogen |
| Tridentates, N—O Tetradentates, and N—O | or polarizing or water- |
| Hexadentates) | insolubilizing/solubilizing groups attached. |
| | Ligand can also contain nonbinding N, O, S, or |
| | P atoms. |
| N—O Valence Stabilizer #16: | RR′—C(—NH—R″)—C(═NOH)—R″′, where R, R′, |
| Amino oximes, Bis(amino oximes), and | R″, and R″′ represent H, NH₂, or any organic |
| Poly(amino oximes) (N—O Bidentates, N—O | functional group wherein the number of carbon |
| Tridentates, N—O Tetradentates, and N—O | atoms ranges from 0 to 40, optionally having |
| Hexadentates) | halogen or polarizing or water- |
| | insolubilizing/solubilizing groups attached. |
| | Ligand can also contain nonbinding N, O, S, or |
| | P atoms. |
| N—O Valence Stabilizer #17: | RR′—N—C(═NOH)—R″, where R, R′, and R″ |
| Amido oximes, Bis(amido oximes), and | represent H, NH₂, or any organic functional |
| Poly(amido oximes) (N—O Bidentates, N—O | group wherein the number of carbon atoms |
| Tridentates, N—O Tetradentates, and N—O | ranges from 0 to 40, optionally having halogen |
| Hexadentates) | or polarizing or water- |
| | insolubilizing/solubilizing groups attached. |
| | Ligand can also contain nonbinding N, O, S, or |
| | P atoms. |
| N—O Valence Stabilizer #18: | R—N═N—C(═NOH)—R′ or RR′C═N—NR″— |
| Azo oximes, Bis(azo oximes), and Poly(azo | C(═NOH)—R″′, where R, R′, R″, and R″′ |
| oximes) (N—O Bidentates, N—O Tridentates, | represent H, NH₂, or any organic functional |
| N—O Tetradentates, and N—O Hexadentates). | group wherein the number of carbon atoms |
| Also includes hydrazone oximes. | ranges from 0 to 40, optionally having halogen |
| | or polarizing or water- |
| | insolubilizing/solubilizing groups attached. (R |
| | is typically an aryl group.) Ligand can also |
| | contain nonbinding N, O, S, or P atoms. |
| N—O Valence Stabilizer #19: | o-(ON—)(HO—)Ar, where Ar represents an |
| 2-Nitrosophenols (o-Quinone monoximes) | aromatic group or heterocyclic wherein the |
| (N—O Bidentates) | number of carbon atoms ranges from 6 to 40, |
| | optionally having halogen or polarizing or |
| | water-insolubilizing/solubilizing groups |
| | attached. Ligand can also contain nonbinding N, |
| | O, S, or P atoms. |
| N—O Valence Stabilizer #20: | o-(O₂N—)(HO—)Ar, where Ar represents an |
| 2-Nitrophenols (N—O Bidentates) | aromatic group or heterocyclic wherein the |
| | number of carbon atoms ranges from 6 to 40, |
| | optionally having halogen or polarizing or |
| | water-insolubilizing/solubilizing groups |
| | attached. Ligand can also contain nonbinding N, |
| | O, S, or P atoms. |
| N—O Valence Stabilizer #21: | R—C(═O)—NR′—OH or R—C(—OH)═N—OH, where |
| Hydroxamates (Hydroxylamines), | R and R′ represent H, NH₂, or any organic |
| Bis(hydroxamates), and | functional group wherein the number of carbon |
| Poly(hydroxamates) (N—O Bidentates, N—O | atoms ranges from 0 to 40, optionally having |
| Tetradentates, and N—O Hexadentates) | halogen or polarizing or water- |
| | insolubilizing/solubilizing groups attached. |
| | Ligand can also contain nonbinding N, O, S, or |
| | P atoms. |
| N—O Valence Stabilizer #22: | R—N(—NO)—OH, where R represents any organic |
| N-Nitrosohydroxylamines, Bis(N- | functional group wherein the number of carbon |
| nitrosohydroxylamines), and Poly(N- | atoms ranges from 1 to 40, optionally having |
| nitrosohydroxylamines) (N—O Bidentates, | halogen or polarizing or water- |
| N—O Tetradentates, and N—O Hexadentates) | insolubilizing/solubilizing groups attached. (R |
| | is typically an aryl or heterocyclic group.) |
| | Ligand can also contain nonbinding N, O, S, or |
| | P atoms. |
| N—O Valence Stabilizer #23: | R—CH(—NHR′)—C(═O)(—OH) for amino acids and |
| Amino Acids and ortho-Aminocarboxylic | ortho-aminocarboxylic acids, and R—CH(— |
| Acids, Peptides, Polypeptides, and Proteins | NHR′)—C(═O)—(NR″—)CH(—R″′)—C(═O)(—OH) |
| [N—O Bidentates, N—O Tridentates, and N—O | for peptides, where R, R′, R″, and R″′ represent |
| Tetradentates; possibly S—O dentates for | any organic functional group wherein the |
| sulfur-contg. examples such as | number of carbon atoms ranges from 1 to 40, |
| penicillamine and cystine] | optionally having halogen or polarizing or |
| | water-insolubilizing/solubilizing groups |
| | attached. Ligand can also contain nonbinding N, |
| | O, S, or P atoms. |
| N—O Valence Stabilizer #24: | RCONR′R″, where R, R′, and R″ represent H, |
| Amides, Bis(amides), and Poly(amides), | NH₂, or any organic functional group wherein |
| including lactams (N—O Bidentates, N—O | the number of carbon atoms ranges from 0 to |
| Tridentates, and N—O Tetradentates) | 40, optionally having halogen or polarizing or |
| | water-insolubilizing/solubilizing groups |
| | attached. Ligand can also contain nonbinding N, |
| | O, S, or P atoms. |
| N—O Valence Stabilizer #25: | RR′—N—C(═O)—NR″—N═CR″′R″″, where R, R′, |
| Semicarbazones, Bis(semicarbazones), and | R″, R″′, and R″″ represent H, or any organic |
| Poly(semicarbazones) (N—O Bidentates, N—O | functional group wherein the number of carbon |
| Tetradentates, and N—O Hexadentates) | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| N—O Valence Stabilizer #26: | R—C(═O)—NR′—N═CR″R″′, where R, R′, R″, and |
| Acyl hydrazones, Bis(acyl hydrazones), and | R″′ represent H, or any organic functional |
| Poly(acyl hydrazones) (N—O Bidentates, N—O | group wherein the number of carbon atoms |
| Tetradentates, and N—O Hexadentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| N—O Valence Stabilizer #27: | R—N═N—C(═O)—NR′—N—R″R″′, where R, R′, R″, |
| Carbazones (Diazenecarboxylic | and R″′ represent H, or any organic functional |
| hydrazides), Bis(carbazones), and | group wherein the number of carbon atoms |
| Poly(carbazones) (N—O Bidentates, N—O | ranges from 0 to 40, optionally having halogen |
| Tetradentates, and N—O Hexadentates) | or polarizing or water- |
| | insolubilizing/solubilizing groups attached. |
| | Ligand can also contain nonbinding N, O, S, or |
| | P atoms. |
| N—O Valence Stabilizer #28: | R—N═N—R′ for azo compounds, R—N═N—NH—R′ |
| Azo compounds including triazenes with | for triazenes, where R, and R′ represent H or |
| hydroxyl or carboxy or carbonyl | any organic functional group wherein the |
| substitution at the ortho- (for aryl) or alpha- | number of carbon atoms ranges from 0 to 40, |
| or beta-(for alkyl) positions, Bis[o-(HO—) | optionally having halogen or polarizing or |
| or alpha- or beta-(HO—)azo compounds], or | water-insolubilizing/solubilizing groups |
| Poly[o-(HO—) or alpha- or beta-(HO—)azo | attached. (Must include ortho-hydroxy or |
| compounds) (N—O Bidentates, N—O | carboxy or carbonyl substituted aryl azo |
| Tridentates, N—O Tetradentates, or N—O | compounds, and alpha- or beta-hydroxy or |
| Hexadentates) | carboxy or carbonyl alkyl azo compounds.) |
| | Ligand can also contain nonbinding N, O, S, or |
| | P atoms. |
| N—O Valence Stabilizer #29: | R—N═N—C(═O)—NR′R″ for diazeneformamides, |
| Diazeneformamides, Diazeneacetamides, | and R—N═N—CR′R″—C(═O)—NR″′R″″ for |
| Bis(diazeneformamides), | diazeneacetamides, where R, R′, R″, R″′, and |
| Bis(diazeneacetamides), | R″″ represent H, NH₂, or any organic functional |
| Poly(diazeneformamides), and | group wherein the number of carbon atoms |
| Poly(diazeneacetamides) (N—O Bidentates, | ranges from 0 to 40, optionally having halogen |
| N—O Tetradentates, and N—O Hexadentates) | or polarizing or water- |
| | insolubilizing/solubilizing groups attached. |
| | Ligand can also contain nonbinding N, O, S, or |
| | P atoms. |
| N—O Valence Stabilizer #30: | R—N═N—C(═O)—O—R′ for diazeneformic acid, |
| Diazeneformic acids, Diazeneacetic acids, | and R—N═N—CR′R″—C(═O)—O—R″′ for |
| Bis(diazeneformic acids), Bis(diazeneacetic | diazeneacetic acid, where R, R′, R″, and R″′ |
| acids), Poly(diazeneformic acids), | represent H, NH₂, or any organic functional |
| Poly(diazeneacetic acids), and derivatives | group wherein the number of carbon atoms |
| thereof (N—O Bidentates, N—O | ranges from 0 to 40, optionally having halogen |
| Tetradentates, N—O Hexadentates) | or polarizing or water- |
| | insolubilizing/solubilizing groups attached. |
| | Ligand can also contain nonbinding N, O, S, or |
| | P atoms. |
| N—O Valence Stabilizer #31: | R—N═N—C(═O)—R′ for diazeneformaldehydes, |
| Diazeneformaldehydes, | and R—N═N—CR′R″—C(═O)—R″′ for |
| Diazeneacetaldehydes, | diazeneacetaldehydes, where R, R′, R″, and R″′ |
| Bis(diazeneformaldehydes), | represent H, NH₂, or any organic functional |
| Bis(diazeneacetaldehydes), | group wherein the number of carbon atoms |
| Poly(diazeneformaldehydes), and | ranges from 0 to 40, optionally having halogen |
| Poly(diazeneacetaldehydes) (N—O | or polarizing or water- |
| Bidentates, N—O Tetradentates and N—O | insolubilizing/solubilizing groups attached. |
| Hexadentates) | Ligand can also contain nonbinding N, O, S, or |
| | P atoms. |
| N—O Valence Stabilizer #32: | RR′—N—C(═O)—N═N—C(═O)—NR″R″′ for |
| Diazenediformamides, | diazenediformamides, and RR′—N—C(═O)— |
| Diazenediacetamides, | CR″R″′—N═N—CR″″R″″′—C(═O)—NR″″″R″″″′ |
| Bis(diazenediformamides), | for diazenediacetamides, where R, R′, R″, R″′, |
| Bis(diazenediacetamides), | R″″, R″″′, R″″″, and R″″″′ represent H, NH₂, |
| Poly(diazenediformamides), and | or any organic functional group wherein the |
| Poly(diazenediacetamides) (N—O | number of carbon atoms ranges from 0 to 40, |
| Tridentates and N—O Hexadentates) | optionally having halogen or polarizing or |
| | water-insolubilizing/solubilizing groups |
| | attached. Ligand can also contain nonbinding N, |
| | O, S, or P atoms. |
| N—O Valence Stabilizer #33: | R—O—C(═O)—N═N—C(═O)—O—R′ for |
| Diazenediformic acids, Diazenediacetic | diazenediformic acid, and R—O—C(═O)—CR′R″— |
| acids, Bis(diazenediformic acids), | N═N—CR″′R″″—C(═O)—O—R″″′ for |
| Bis(diazenediacetic acids), | diazenediacetic acid, where R, R′, R″, R″′, R″″, |
| Poly(diazenediformic acids), | and R″″′ represent H, NH₂, or any organic |
| Poly(diazenediacetic acids) and derivatives | functional group wherein the number of carbon |
| thereof (N—O Tridentates and N—O | atoms ranges from 0 to 40, optionally having |
| Hexadentates) | halogen or polarizing or water- |
| | insolubilizing/solubilizing groups attached. |
| | Ligand can also contain nonbinding N, O, S, or |
| | P atoms. |
| N—O Valence Stabilizer #34: | RC(═O)—N═N—C(═O)—R′ for |
| Diazenediformaldehydes, | diazenediformaldehydes, and RC(═O)—CR′R″— |
| Diazenediacetaldehydes, | N═N—CR″′R″″—C(═O)—R″″′ for |
| Bis(diazenediformaldehydes), | diazenediacetaldehydes, where R, R′, R″, R″′, |
| Bis(diazenediacetaldehydes), | R″″, and R″″′ represent H, NH₂, or any organic |
| Poly(diazenediformaldehydes), and | functional group wherein the number of carbon |
| Poly(diazenediacetaldehydes) (N—O | atoms ranges from 0 to 40, optionally having |
| Tridentates and N—O Hexadentates) | halogen or polarizing or water- |
| | insolubilizing/solubilizing groups attached. |
| | Ligand can also contain nonbinding N, O, S, or |
| | P atoms. |
| N—O Valence Stabilizer #35: | R—N═N—CR′═N—NR″R″′, where R, R′, R″, and |
| Ortho-hydroxy (or —carboxy) Substituted | R″′ represent H, or any organic functional |
| Formazans, Bis(o-hydroxy or —carboxy | group wherein the number of carbon atoms |
| substituted formazans), and Poly(o-hydroxy | ranges from 0 to 40, optionally having halogen |
| or —carboxy substituted formazans) (N—O | or polarizing or water- |
| Bidentates, N—O Tridentates, N—O | insolubilizing/solubilizing groups attached. |
| Tetradentates, and N—O Hexadentates) | (Must include ortho-hydroxy or carboxy |
| | substituted aryl R derivatives, and beta-hydroxy |
| | or carboxy substituted alkyl R derivatives.) |
| | Ligand can also contain nonbinding N, O, S, or |
| | P atoms. |
| N—O Valence Stabilizer #36: | RR′C═N—N═CR″R″′ or RR′C═N—NR″R″′ (for |
| Ortho-hydroxy (or -carboxy) Substituted | ketazines), where R, R′, R″, and R″′ represent |
| Azines (including ketazines), Bis(o- | H, or any organic functional group wherein the |
| hydroxy or carboxy substituted azines), and | number of carbon atoms ranges from 0 to 40, |
| Poly(o-hydroxy or carboxy substituted | optionally having halogen or polarizing or |
| azines) (N—O Bidentates, N—O Tridentates, | water-insolubilizing/solubilizing groups |
| N—O Tetradentates, and N—O Hexadentates) | attached. (Must include ortho-hydroxy or |
| | carboxy substituted aryl R derivatives, and beta- |
| | hydroxy or carboxy substituted alkyl R |
| | derivatives.) Ligand can also contain |
| | nonbinding N, O, S, or P atoms. |
| N—O Valence Stabilizer #37: | RR′C═N—R″, where R, R′, and R″ represent H, |
| Schiff Bases with one Imine (C═N) Group | or any organic functional group wherein the |
| and with ortho- or alpha- or beta-hydroxy | number of carbon atoms ranges from 0 to 40, |
| or carboxy or carbonyl substitution (N—O | optionally having halogen or polarizing or |
| Bidentates, N—O Tridentates, N—O | water-insolubilizing/solubilizing groups |
| Tetradentates, N—O Pentadentates, or N—O | attached. (Must contain ortho- or alpha- or beta- |
| Hexadentates). Also includes hydrazones | hydroxy or carboxy or carbonyl substitution.) |
| with ortho-O substitution. | Ligand can also contain nonbinding N, O, S, or |
| | P atoms. |
| N—O Valence Stabilizer #38: | RR′C═N—R″—N═CR″′R″″ or R—N═C—R′—C═N— |
| Schiff Bases with two Imine (C═N) Groups | R′ or RC═N—R′—N═CR″, where R, R′, R″, R″′, |
| and with ortho- or alpha- or beta-hydroxy | and R″″ represent H, or any organic functional |
| or carboxy or carbonyl substitution (N—O | group wherein the number of carbon atoms |
| Tridentates, N—O Tetradentates, N—O | ranges from 0 to 40, optionally having halogen |
| Pentadentates, or N—O Hexadentates). Also | or polarizing or water- |
| includes hydrazones with ortho-O | insolubilizing/solubilizing groups attached. |
| substitution. | (Must contain ortho- or alpha- or beta-hydroxy |
| | or carboxy or carbonyl substitution.) Ligand |
| | can also contain nonbinding N, O, S, or P |
| | atoms. |
| N—O Valence Stabilizer #39: | N(—R—N═CR′R″)₃, where R, R′, and R″ |
| Schiff Bases with three Imine (C═N) | represent H, or any organic functional group |
| Groups and with ortho- or alpha- or beta- | wherein the number of carbon atoms ranges |
| hydroxy or carboxy or carbonyl substitution | from 0 to 40, optionally having halogen or |
| (N—O Tetradentates, N—O Pentadentates, or | polarizing or water-insolubilizing/solubilizing |
| N—O Hexadentates). Also includes | groups attached. (Must contain ortho- or alpha- |
| hydrazones with ortho-O substitution. | or beta-hydroxy or carboxy or carbonyl |
| | substitution.) Ligand can also contain |
| | nonbinding N, O, S, or P atoms. |
| N—O Valence Stabilizer #40: | [R—C(NR′R″)]ₓ—R″—[Si(—OR″′)_{z}R″″_{3-z}]_{y} where |
| Silylaminoalcohols (N—O Bidentates, N—O | R, R′, R″, R″′, and R″″ represent H, NH₂, or |
| Tridentates, N—O Tetradentates, and N—O | any organic functional group wherein the |
| Hexadentates) | number of carbon atoms ranges from 0 to 40, |
| | optionally having halogen or polarizing or |
| | water-insolubilizing/solubilizing groups |
| | attached, and x and y = 1−6, z = 1−3. Ligand can |
| | also contain nonbinding N, O, S, or P atoms. |
| N—O Valence Stabilizer #41: | [R—C(═NR′)]ₓ—R″—[C(—OR″′)R″″R″″′]_{y} or [R— |
| Hydroxyalkyl Imines (Imino Alcohols) (N—O | C(═NR′)]ₓ—R″—[C(═O)R″′]_{y}, where R, R′, R″, |
| Bidentates, N—O Tridentates, N—O | R″′, R″″, and R″″′ represent H, NH₂, or any |
| Tetradentates, and N—O Hexadentates) | organic functional group wherein the number of |
| | carbon atoms ranges from 0 to 40, optionally |
| | having halogen or polarizing or water- |
| | insolubilizing/solubilizing groups attached, and |
| | x and y = 1−6. Ligand can also contain |
| | nonbinding N, O, S, or P atoms. |
| N—O Valence Stabilizer #42: | [R(—NR′R″)(—OR″′)], [R(—NR′R″)(—C(═O)R″′], |
| Hydroxyaryl Amines and Hydroxyaryl | [R(—NR′R″)ₓ]₂O, [R(—NR′R″)ₓ]₂₋₃R″′(—OR″″)_{y}, |
| Imines (N—O Bidentates, N—O Tridentates, | [R(—OR′)ₓ]₂₋₃R″(—NR″′R″″)_{y}, and [R(— |
| N—O Tetradentates, and N—O Hexadentates) | NR′R″)ₓ]₂R″′(C(═O))_{y}R″″ for hydroxyaryl |
| | amines; and [R(—OR′)ₓ]₂NH or [R(— |
| | OR′)ₓ]₂NHNH for hydroxyaryl imines, where |
| | R, R′, R″, R″′, and R″″ represent H, NH₂, or |
| | any organic functional group wherein the |
| | number of carbon atoms ranges from 0 to 40, |
| | optionally having halogen or polarizing or |
| | water-insolubilizing/solubilizing groups |
| | attached, and x = 0−2 and y = 1−4. Ligand can |
| | also contain nonbinding N, O, S, or P atoms. |
| N—O Valence Stabilizer #43: | Five membered heterocyclic ring(s) containing |
| Five-Membered Heterocyclic Rings | one, two, three, or four nitrogen atoms. In |
| containing One, Two, Three, or Four | addition, ligand contains additional oxygen- |
| Nitrogen Atoms with at least one additional | containing substituents (usually hydroxy, |
| Oxygen Atom Binding Site not in a Ring | carboxy or carbonyl groups) that constitute O |
| (N—O Bidentates, N—O Tridentates, N—O | binding sites. Can include other ring systems |
| Tetradentates, or N—O Hexadentates) | bound to the heterocyclic ring or to the O- |
| | containing substituent, but they do not |
| | coordinate with the stabilized, high valence |
| | metal ion. Ring(s) can also contain O, S, or P |
| | atoms. This 5-membered ring(s) and/or |
| | attached, uncoordinating rings and/or O- |
| | containing substituent(s) may or may not have |
| | halogen or polarizing or water- |
| | insolubilizing/solubilizing groups attached. |
| N—O Valence Stabilizer #44: | Six membered heterocyclic ring(s) containing |
| Six-Membered Heterocyclic Rings | one, two, three, or four nitrogen atoms. In |
| containing One, Two, Three, or Four | addition, ligand contains additional oxygen- |
| Nitrogen Atoms with at least one additional | containing substituents (usually hydroxy, |
| Oxygen Atom Binding Site not in a Ring | carboxy, or carbonyl groups) that constitute O |
| (N—O Bidentates, N—O Tridentates, N—O | binding sites. Can include other ring systems |
| Tetradentates, or N—O Hexadentates) | bound to the heterocyclic ring or to the O- |
| | containing substituent, but they do not |
| | coordinate with the stabilized, high valence |
| | metal ion. Ring(s) can also contain O, S, or P |
| | atoms. This 6-membered ring(s) and/or |
| | attached, uncoordinating rings and/or O- |
| | containing substituent(s) may or may not have |
| | halogen or polarizing or water- |
| | insolubilizing/solubilizing groups attached. |
| N—O Valence Stabilizer #45: | Five membered heterocyclic ring(s) containing |
| Five-Membered Heterocyclic Rings | one or two oxygen atoms. In addition, ligand |
| containing One or Two Oxygen Atoms with | contains additional nitrogen-containing |
| at least one additional Nitrogen Atom | substituents (usually amines, imines, or |
| Binding Site not in a Ring (N—O Bidentates, | hydrazides) that constitute N binding sites. Can |
| N—O Tridentates, N—O Tetradentates, or N—O | include other ring systems bound to the |
| Hexadentates) | heterocyclic ring or to the N-containing |
| | substituent, but they do not coordinate with the |
| | stabilized, high valence metal ion. Ring(s) can |
| | also contain O, S, or P atoms. This 5-membered |
| | ring(s) and/or attached, uncoordinating rings |
| | and/or N-containing substituent(s) may or may |
| | not have halogen or polarizing or water- |
| | insolubilizing/solubilizing groups attached. |
| N—O Valence Stabilizer #46: | Six membered heterocyclic ring(s) containing |
| Six-Membered Heterocyclic Rings | one or two oxygen atoms. In addition, ligand |
| containing One or Two Oxygen Atoms with | contains additional nitrogen-containing |
| at least one additional Nitrogen Atom | substituents (usually amines, imines, or |
| Binding Site not in a Ring (N—O Bidentates, | hydrazides) that constitute N binding sites. Can |
| N—O Tridentates, N—O Tetradentates, or N—O | include other ring systems bound to the |
| Hexadentates) | heterocyclic ring or to the N-containing |
| | substituent, but they do not coordinate with the |
| | stabilized, high valence metal ion. Ring(s) can |
| | also contain O, S, or P atoms. This 6-membered |
| | ring(s) and/or attached, uncoordinating rings |
| | and/or N-containing substituent(s) may or may |
| | not have halogen or polarizing or water- |
| | insolubilizing/solubilizing groups attached. |
| N—O Valence Stabilizer #47: | Five membered heterocyclic ring(s) containing |
| Five-Membered Heterocyclic Rings | one, two, three, or four nitrogen atoms. In |
| containing One, Two, Three, or Four | addition, ligand contains additional oxygen- |
| Nitrogen Atoms with at least one additional | containing rings that constitute O binding sites. |
| Oxygen Atom Binding Site in a Separate | Can include other ring systems bound to the N— |
| Ring (N—O Bidentates, N—O Tridentates, N—O | or O-containing heterocyclic rings, but they do |
| Tetradentates) | not coordinate with the stabilized, high valence |
| | metal ion. Ring(s) can also contain O, S, or P |
| | atoms. This 5-membered ring(s) and/or |
| | additional O-containing ring(s) and/or attached, |
| | uncoordinating rings may or may not have |
| | halogen or polarizing or water- |
| | insolubilizing/solubilizing groups attached. |
| N—O Valence Stabilizer #48: | Six membered heterocyclic ring(s) containing |
| Six-Membered Heterocyclic Rings | one, two, three, or four nitrogen atoms. In |
| containing One, Two, Three, or Four | addition, ligand contains additional oxygen- |
| Nitrogen Atoms with at least one additional | containing rings that constitute O binding sites. |
| Oxygen Atom Binding Site in a Separate | Can include other ring systems bound to the N— |
| Ring (N—O Bidentates, N—O Tridentates, N—O | or O-containing heterocyclic rings, but they do |
| Tetradentates) | not coordinate with the stabilized, high valence |
| | metal ion. Ring(s) can also contain O, S, or P |
| | atoms. This 6-membered ring(s) and/or |
| | additional O-containing ring(s) and/or attached, |
| | uncoordinating rings may or may not have |
| | halogen or polarizing or water- |
| | insolubilizing/solubilizing groups attached. |
| N—O Valence Stabilizer #49: | Macrocyclic ligands containing two, three, four, |
| Two-, Three-, Four-, Six-, Eight-, and Ten- | six, eight, or ten binding sites composed of |
| Membered Macrocyclics, Macrobicyclics, | nitrogen and oxygen to valence stabilize the |
| and Macropolycyclics (including | central metal ion. Can include other |
| Catapinands, Cryptands, Cyclidenes, and | hydrocarbon or ring systems bound to this |
| Sepulchrates) wherein all Binding Sites are | macrocyclic ligand, but they do not coordinate |
| composed of Nitrogen (usually amine or | with the stabilized, high valence metal ion. This |
| imine groups) or Oxygen (usually hydroxy, | ligand and/or attached, uncoordinating |
| carboxy, or carbonyl groupss) and are not | hydrocarbons/rings may or may not have |
| contained in Component Heterocyclic | halogen or polarizing or water- |
| Rings (N—O Bidentates, N—O Tridentates, | insolubilizing/solubilizing groups attached. |
| N—O Tetradentates, and N—O Hexadentates) | |
| N—O Valence Stabilizer #50: | Macrocyclic ligands containing a total of four, |
| Four-, Six-, Eight-, or Ten-Membered | six, eight, or ten heterocyclic rings containing |
| Macrocyclics, Macrobicyclics, and | nitrogen or oxygen binding sites. Can include |
| Macropolycyclics (including Catapinands, | other hydrocarbon/ring systems bound to this |
| Cryptands, Cyclidenes, and Sepulchrates) | macrocyclic ligand, but they do not coordinate |
| wherein all Binding Sites are composed of | with the stabilized, high valence metal ion. This |
| Nitrogen or Oxygen and are contained in | ligand and/or attached, uncoordinating |
| Component Heterocyclic Rings (N—O | hydrocarbon/rings may or may not have halogen |
| Bidentates, N—O Tridentates, N—O | or polarizing or water-insolubilizing groups |
| Tetradentates, or N—O Hexadentates) | attached. |
| N—O Valence Stabilizer #51: | Macrocyclic ligands containing at least one |
| Four-, Six-, Eight-, or Ten-Membered | heterocyclic ring. These heterocyclic rings |
| Macrocyclics, Macrobicyclics, and | provide nitrogen or oxygen binding sites to |
| Macropolycyclics (including Catapinands, | valence stabilize the central metal ion. Other |
| Cryptands, Cyclidenes, and Sepulchrates) | amine, imine, hydroxy, carboxy, or carbonyl |
| wherein all Binding Sites are composed of | binding sites can also be included in the |
| Nitrogen or Oxygen and are contained in a | macrocyclic ligand, so long as the total number |
| Combination of Heterocyclic Rings and | of binding sites is four, six, eight, or ten. Can |
| Amine, Imine, Hydroxy, Carboxy, or | include other hydrocarbon/ring systems bound |
| Carbonyl Groups (N—O Bidentates, N—O | to this macrocyclic ligand, but they do not |
| Tridentates, N—O Tetradentates, or N—O | coordinate with the stabilized, high valence |
| Hexadentates) | metal ion. This ligand and/or attached, |
| | uncoordinating hydrocarbon/rings may or may |
| | not have halogen or polarizing or water- |
| | insolubilizing groups attached. |
| S—O Valence Stabilizer #1: | R—C(═S)—CR′R″—C(═O)—R″′ where R, R′, R″, |
| 1,3-Monothioketones (Monothio-beta- | and R″′ represent H, NH₂, or any organic |
| ketonates), 1,3,5-Monothioketones, 1,3,5- | functional group wherein the number of carbon |
| Dithioketones, Bis(1,3-Monothioketones), | atoms ranges from 0 to 40, optionally having |
| and Poly(1,3-Monothioketones) (S—O | halogen or polarizing or water- |
| Bidentates, S—O Tridentates, S—O | insolubilizing/solubilizing groups attached. |
| Tetradentates) | Ligand can also contain nonbinding N, O, S, or |
| | P atoms. |
| S—O Valence Stabilizer #2: | RR′—N—C(═S)—CR″R″′—C(═O)—N—R″″R″″′ |
| Thiomalonamides (Thiomalonodiamides), | where R, R′, R″, R″′, R″″, and R″″′ represent H, |
| Bis(thiomalonamides), and | NH₂, or any organic functional group wherein |
| Polythiomalonamides (S—O Bidentates, S—O | the number of carbon atoms ranges from 0 to |
| Tridentates, S—O Tetradentates) | 40, optionally having halogen or polarizing or |
| | water-insolubilizing/solubilizing groups |
| | attached. Ligand can also contain nonbinding N, |
| | O, S, or P atoms. |
| S—O Valence Stabilizer #3: | RR′—N—C(═O)—CR″R″′—C(═S)—R″″ for 2- |
| 2-Thioacylacetamides, 2- | thioacylacetamides, and RR′—N—C(═S)—CR″R″′- |
| Acylthioacetamides, Bis(2- | C(═O)—R″″ for 2-acylthioacetamides, where R, |
| thioacylacetamides), | R′, R″, R″′, and R″″ represent H, NH₂, or any |
| Bis(2acylthioacetamides), Poly(2- | organic functional group wherein the number of |
| thioacylacetamides), and Poly(2- | carbon atoms ranges from 0 to 40, optionally |
| Acylthioacetamides) (S—O Bidentates, S—O | having halogen or polarizing or water- |
| Tridentates, S—O Tetradentates) | insolubilizing/solubilizing groups attached. |
| | Ligand can also contain nonbinding N, O, S, or |
| | P atoms. |
| S—O Valence Stabilizer #4: | RR′—N—C(═S)—S—C(═O)—N—R″R″′ where R, R′, |
| Dithiodicarbonic Diamides, | R″, and R″′ represent H, NH₂or any organic |
| Bis(dithiodicarbonic diamides), and | functional group wherein the number of carbon |
| Poly(dithiodicarbonic diamides) (S—O | atoms ranges from 0 to 40, optionally having |
| Bidentates, S—O Tridentates, S—O | halogen or polarizing or water- |
| Tetradentates) | insolubilizing/solubilizing groups attached. |
| | Ligand can also contain nonbinding N, O, S, or |
| | P atoms. |
| S—O Valence Stabilizer #5: | (R—O—)(R′—O—)P(═S)—P(═O)(—O—R″)(—O—R″′); |
| Monothiohypophosphoric Acids, | (R—O—)(R′—S—)P(═S)—P(═O)(—S—R″)(—O—R″′); or |
| Bis(monothiohypophosphoric acids), and | (R—S—)(R′—S—)P(═S)—P(═O)(—S—R″)(—S—R″′), |
| Poly(monothiohypophosphoric acids), and | where R, R′, R″, and R″′ represent H, NH₂or |
| derivatives thereof (S—O Bidentates, S—O | any organic functional group wherein the |
| Tridentates, S—O Tetradentates) | number of carbon atoms ranges from 0 to 40, |
| | optionally having halogen or polarizing or |
| | water-insolubilizing/solubilizing groups |
| | attached. Ligand can also contain nonbinding N, |
| | O, S, or P atoms. Note: these ligands are not to |
| | be confused with hypophosphorous acid |
| | derivatives (hypophosphites) (R—O—) |
| | R″R″′P(═O) which are very reducing and |
| | therefore unacceptable for stabilization of high |
| | valence states in metal ions. |
| S—O Valence Stabilizer #6: | (RR′—N—)(R″R″′—N—)P(═S)—P(═O)(—N— |
| Monothiohypophosphoramides, | R″″R″″′)(—N—R″″″R″″″′), where R, R′, R″, R″′, |
| Bis(monothiohypophosphoramides), and | R″″, R″″′, R″″″, and R″″″′ represent H, NH₂ or |
| Poly(monothiohypophosphoramides) (S—O | any organic functional group wherein the |
| Bidentates, S—O Tridentates, S—O | number of carbon atoms ranges from 0 to 40, |
| Tetradentates) | optionally having halogen or polarizing or |
| | water-insolubilizing/solubilizing groups |
| | attached. Ligand can also contain nonbinding N, |
| | O, S, or P atoms. Note: these ligands are not to |
| | be confused with hypophosphorous acid |
| | derivatives (hypophosphites) (R—O—) |
| | R″R″′P(═O) which are very reducing and |
| | therefore unacceptable for stabilization of high |
| | valence states in metal ions. |
| S—O Valence Stabilizer #7: | (R—O—)(R′—O—)P(═S)—NH—P(═O)(—O—R″)(—O— |
| Monothioimidodiphosphoric Acids, | R″′); (R—O—)(R′—S—)P(═S)—NH—P(═O)(—S—R″)(— |
| Monothiohydrazidodiphosphoric Acids, | O—R″′); or (R—S—)(R′—S—)P(═S)—NH—P(═O)(—S— |
| Bis(monothioimidodiphosphoric Acids), | R″)(—S—R″′) for monothioimidodiphosphoric |
| Bis(monothiohydrazidodiphosphoric | acids, and —NH—NH—derivatives for |
| Acids), Poly(monothioimidodiphosphoric | monothiohydrazidodiphosphoric acids, where |
| Acids), | R, R′, R″, and R″′ represent H, NH₂ or any |
| Poly(monothioihydrazidodiphosphoric | organic functional group wherein the number of |
| Acids), and derivatives thereof (S—O | carbon atoms ranges from 0 to 40, optionally |
| Bidentates, S—O Tridentates, S—O | having halogen or polarizing or water- |
| Tetradentates) | insolubilizing/solubilizing groups attached. |
| | Ligand can also contain nonbinding N, O, S, or |
| | P atoms. |
| S—O Valence Stabilizer #8: | (RR′—N—)(R″R″′—N—)P(═S)—NH—P(═O)(—N— |
| Monothioimidodiphosphoramides, | R″″R″″′)(—N—R″″″R″″″′) for |
| Monothiohydrazidodiphosphoramides, | monothioimidodiphosphoramides, and —NH— |
| Bis(monothioimidodiphosphoramides), | NH—derivatives for |
| Bis(monothiohydrazidodiphosphoramides), | monothiohydrazidodiphosphoramides, where R, |
| Poly(monothioimidodiphosphoramides), | R′, R″, R″′, R″″, R″″′, R″″″, and R″″″′ |
| and | represent H, NH₂ or any organic functional |
| Poly(monothiohydrazidodiphosphoramides) | group wherein the number of carbon atoms |
| (S—O Bidentates, S—O Tridentates, S—O | ranges from 0 to 40, optionally having halogen |
| Tetradentates) | or polarizing or water- |
| | insolubilizing/solubilizing groups attached. |
| | Ligand can also contain nonbinding N, 0, S, or |
| | P atoms. |
| S—O Valence Stabilizer #9: | (RR′—N—)(R″R″′—N—)P(═S)—S—P(═O)(—N— |
| Monothiodiphosphoramides, | R″″R″″′)(—N—R″″″R″″″′), or (RR′—N—)(R″R″′— |
| Bis(monothioiphosphoramides), and | N—)P(═S)—O—P(═O)(—N—R″″R″″′)(—N— |
| Poly(monothiodiphosphoramides) (S—O | R″″″R″″″′), where R, R′, R″, R″′, R″″, R″″′, |
| Bidentates, S—O Tridentates, S—O | R″″″, and R″″″′ represent H, NH₂ or any |
| Tetradentates) | organic functional group wherein the number of |
| | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. |
| S—O Valence Stabilizer #10: | (R—O—)(R′—O—)P(═S)—O—P(═O)(—O—R″)(—O—R″′); |
| Monothiodiphosphoric Acids, | (R—O—)(R′—O—)P(═S)—S—P(═O)(—O—R″)(—O—R″′); |
| Bis(monothioiphosphoric Acids), | (R—O—)(R′—S—)P(═S)—O—P(═O)(—S—R″)(—O—R″′); |
| Poly(monothiodiphosphoric Acids), and | (R—O—)(R′—S—)P(═S)—S—P(═O)(—S—R″)(—O—R″′); |
| derivatives thereof (S—O Bidentates, S—O | or (R—S—)(R′—S—)P(═S)—S—P(═O) (—S—R″)(—S—R″′), |
| Tridentates, S—O Tetradentates) | where R, R′, R″, R″′, R″″, R″″′, R″″″, and |
| | R″″″′ represent H, NH₂ or any organic |
| | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S—O Valence Stabilizer #11: | RR′N⁺ ═C(OH)(SH), where R and R′ represent |
| Monothiocarbamates, | H, OH, SH, OR″(R″ = C₁—C₃₀ alkyl or aryl), SR″ |
| Bis(monothiocarbamates), and | (R″ = C₁—C₃₀ alkyl or aryl), NH₂or any organic |
| Poly(monothiocarbamates) (including N— | functional group wherein the number of carbon |
| hydroxymonothiocarbamates and N— | atoms ranges from 0 to 40, optionally having |
| mercaptomonothiocarbamates) (S—O | halogen or polarizing or water- |
| Bidentates, S—O Tridentates, and S—O | insolubilizing/solubilizing groups attached. |
| Tetradentates) | Ligand can also contain nonbinding N, O, S, or |
| | P atoms. |

N Valence Stabilizer #1: Examples of monoamines (N monodentates) that meet the requirements for use as “wide band” valence stabilizers for Ce⁺⁴ include, but are not limited to: ammonia, ethylamine, n-dodecylamine, octylamine, phenylamine, cyclohexylamine, diethylamine, dioctylamine, diphenylamine, dicyclohexylamine, azetidine, hexamethylenetetramine (Urotropin), aziridine, azepine, pyrrolidine, benzopyrrolidine, dibenzopyrrolidine, naphthopyrrolidine, piperidine, benzopiperidine, dibenzopiperidine, naphthopiperidine, azacycloheptane(hexamethyleneimine), aminonorbornane, adamantanamine, aniline, benzylamine, toluidine, phenethylamine, xylidine, cumidine, naphthylamine, polyalkylamines, polyanilines, and fluorenediamine.

N Valence Stabilizer #2: Examples of diamines (N—N bidentates) that meet the requirements for use as “wide band” valence stabilizers for Ce⁺⁴ include, but are not limited to: hydrazine, phenylhydrazine, 1,1-diphenylhydrazine, 1,2-diphenylhydrazine(hydrazobenzene), methanediamine, ethylenediamine(1,2-ethanediamine, en), trimethylenediamine(1,3-propanediamine), putrescine(1,4-butanediamine), cadaverine(1,5-pentanediamine), hexamethylenediamine(1,6-hexanediamine), 2,3-diaminobutane, stilbenediamine(1,2-diphenyl-1,2-ethanediamine), cyclohexane-1,2-diamine, cyclopentane-1,2-diamine, 1,3-diazacyclopentane, 1,3-diazacyclohexane, piperazine, benzopiperazine, dibenzopiperazine, naphthopiperazine, diazepine, thiadiazepine, oxodiazepine, sparteine(lupinidine), 2-(aminomethyl)azacyclohexane, 2-(aminomethyl)piperidine, 2-(aminomethyl)pyrrolidine, 2-(aminomethyl)azetidine, 2-(2-aminoethyl)aziridine, 1,2-diaminobenzene, benzidine, bis(2,2′-piperazino)-1,2-ethene, 1,4-diazabicyclo[2.2.2]octane, naphthylethylenediamine, and 1,2-dianilinoethane.

N Valence Stabilizer #3: Examples of triamines (N—N bidentates or N—N tridentates) that meet the requirements for use as “wide band” valence stabilizers for Ce⁺⁴ include, but are not limited to: N-(2-aminoethyl)-1,2-ethanediamine(dien, 2,2-tri); N-(2-aminoethyl)-1,3-propanediamine (2,3-tri); N-(3aminopropyl)-1,3-propanediamine(3,3-tri, dpt); N-(3-aminopropyl)-1,4-butanediamine (3,4-tri, spermidine); N-(2-aminoethyl)-1,4-butanediamine(2,4-tri); N-(6-hexyl)-1,6-hexanediamine(6,6-tri); 1,3,5-triaminocyclohexane(tach); 2-(aminomethyl)-1,3-propanediamine (tamm); 2-(aminomethyl)-2-methyl-1,3-propanediamine(tame); 2-(aminomethyl)-2-ethyl-1,3-propanediamine (tamp); 1,2,3-triaminopropane (tap); 2,3-(2-aminoethyl)aziridine; 2,4-(aminomethyl)azetidine; 2,5-(aminomethyl)pyrrolidine; 2,6-(aminomethyl)piperidine; di(2-aminobenzyl)amine; hexahydro-1,3,5-triazine; hexahydro-2,4,6-trimethyl-1,3,5-triazine; and 1,3,5-tris(aminomethyl)benzene.

N Valence Stabilizer #4: Examples of tetramines (N—N bidentates, N—N tridentates, or N—N tetradentates) that meet the requirements for use as “wide band” valence stabilizers for Ce⁺⁴ include, but are not limited to: N,N′-(2-aminoethyl)-1,2-ethanediamine (2,2,2-tet, trien (triethylenetetramine)); N,N′-(2-aminoethyl)-1,3-propanediamine (2,3,2-tet, entnen); N,N′-(3-aminopropyl)-1,2-ethanediamine (3,2,3-tet, tnentn); N-(2-aminoethyl)-N′-(3-aminopropyl)-1,2-ethanediamine (2,2,3-tet); N-(2-aminoethyl)-N′-(3-aminopropyl)-1,3-propanediamine (3,3,2-tet); N,N′-(3-aminopropyl)-1,3-propanediamine (3,3,3-tet); N,N′-(3-aminopropyl)-1,4-butanediamine (3,4,3-tet, spermine); tri(aminomethyl)amine (tren); tri(2-aminoethyl)amine (trtn); tri(3-aminopropyl)amine (trbn); 2,2-aminomethyl-1,3-propanediamine (tam); 1,2,3,4-tetraaminobutane (tab); N,N′-(2-aminophenyl)-1,2-ethanediamine; and N,N′-(2-aminophenyl)-1,3-propanediamine.

N Valence Stabilizer #5: Examples of pentamines (N—N bidentates, N—N tridentates, or N—N tetradentates) that meet the requirements for use as “wide band” valence stabilizers for Ce⁺⁴ include, but are not limited to: N-[N-(2-aminoethyl)-2-aminoethyl]-N′-(2-aminoethyl)-1,2-ethanediamine (2,2,2,2-pent, tetren); N-[N-(3-aminopropyl)-2-aminoethyl]-N′-(3-aminopropyl)-1,2-ethanediamine (3,2,2,3-pent); N-[N-(3-aminopropyl)-3-aminopropyl]-N′-(3-aminopropyl)-1,3-propanediamine (3,3,3,3-pent, caldopentamine); N-[N-(2-aminobenzyl)-2-aminoethyl]-N′-(2-aminopropyl)-1,2-ethanediamine; N-[N-(2-aminoethyl)-2-aminoethyl]-N,N-(2-aminoethyl)amine (trenen); and N-[N-(2-aminopropyl)-2-aminoethyl]-N,N-(2-aminoethyl)amine (4-Me-trenen).

N Valence Stabilizer #6: Examples of hexamines (N—N bidentates, N—N tridentates, N—N tetradentates, or N—N—N—N—N—N hexadentates) that meet the requirements for use as “wide band” valence stabilizers for Ce⁺⁴ include, but are not limited to: N,N′-[N-(2-aminoethyl)-2-aminoethyl]-1,2-ethanediamine (2,2,2,2,2-hex, linpen); N,N′-[N-(2-aminoethyl)-3-aminopropyl]-1,2-ethanediamine (2,3,2,3,2-hex); N,N,N′,N′-(2-aminoethyl)-1,2-ethanediamine (penten, ten); N,N,N′,N′-(2-aminoethyl)-1-methyl-1,2-ethanediamine (tpn, R-5-Me-penten); N,N,N′,N′-(2-aminoethyl)-1,3-propanediamine (ttn); N,N,N′,N′-(2-aminoethyl)-1,4-butanediamine (tbn); N,N,N′,N′-(2-aminoethyl)-1,3-dimethyl-1,3-propanediamine (R,R-tptn, R,S-tptn); N-(2-aminoethyl)-2,2-[N-(2-aminoethyl)aminomethyl-1-propaneamine (sen); and N-(3-aminopropyl)-2,2-[N-(3-aminopropyl)aminomethyl-1-propaneamine (stn).

N Valence Stabilizer #7a: Examples of 5-membered heterocyclic rings containing one nitrogen atom (N monodentates) that meet the requirements for use as “wide band” valence stabilizers for Ce⁺⁴ include, but are not limited to: 1-pyrroline, 2-pyrroline, 3-pyrroline, pyrrole, oxazole, isoxazole, thiazole, isothiazole, azaphosphole, benzopyrroline, benzopyrrole (indole), benzoxazole, benzisoxazole, benzothiazole, benzisothiazole, benzazapho sphole, dibenzopyrroline, dibenzopyrrole (carbazole), dibenzoxazole, dibenzisoxazole, dibenzothiazole, dibenzisothiazole, naphthopyrroline, naphthopyrrole, naphthoxazole, naphthisoxazole, naphthothiazole, naphthisothiazole, naphthazaphosphole, and polypyrroles.

N Valence Stabilizer #7b: Examples of 5-membered heterocyclic rings containing two nitrogen atoms (N monodentates or N—N bidentates) that meet the requirements for use as “wide band” valence stabilizers for Ce⁺⁴ include, but are not limited to: pyrazoline, imidazoline, imidazole (ia), pyrazole, oxadiazole, thiadiazole, diazaphosphole, benzopyrazoline, benzimidazoline, benzimidazole (azindole)(bia)(bz), benzopyrazole (indazole), benzothiadiazole (piazthiole), benzoxadiazole (benzofurazan), naphthopyrazoline, naphthimidazoline, naphthimidazole, naphthopyrazole, naphthoxadiazole, naphthothiadiazole, polybenzimidazole, and polyimidazoles (e.g. polyvinylimidazole (pvi)).

N Valence Stabilizer #7c: Examples of 5-membered heterocyclic rings containing three nitrogen atoms (N monodentates, N—N bidentates) that meet the requirements for use as “wide band” valence stabilizers for Ce⁺⁴ include, but are not limited to: triazole, oxatriazole, thiatriazole, benzotriazole (bta), tolyltriazole (tt), naphthotriazole, and triazolophthalazine.

N Valence Stabilizer #7d: Examples of 5-membered heterocyclic rings containing four nitrogen atoms (N monodentates or N—N bidentates) that meet the requirements for use as “wide band” valence stabilizers for Ce⁺⁴ include, but are not limited to: tetrazole.

N Valence Stabilizer #8a: Examples of 6-membered heterocyclic rings containing one nitrogen atom (N monodentates) that meet the requirements for use as “wide band” valence stabilizers for Ce⁺⁴ include, but are not limited to: pyridine, picoline, lutidine, -collidine, oxazine, thiazine, azaphosphorin, quinoline, isoquinoline, benzoxazine, benzothiazine, benzazaphosphorin, acridine, phenanthridine, phenothiazine (dibenzothiazine), dibenzoxazine, dibenzazaphosphorin, benzoquinoline (naphthopyridine), naphthoxazine, naphthothiazine, naphthazaphosphorin, and polypyridines.

N Valence Stabilizer #8b: Examples of 6-membered heterocyclic rings containing two nitrogen atoms (N monodentates or N—N bidentates) that meet the requirements for use as “wide band” valence stabilizers for Ce⁺⁴ include, but are not limited to: pyrazine, pyridazine, pyrimidine, oxadiazine, thiadiazine, diazaphosphorin, quinoxaline (benzopyrazine), cinnoline (benzo[c]pyridazine), quinazoline (benzopyrimidine), phthalazine (benzo[d]pyridazine), benzoxadiazine, benzothiadiazine, phenazine (dibenzopyrazine), dibenzopyridazine, naphthopyrazine, naphthopyridazine, naphthopyrimidine, naphthoxadiazine, naphthothiadiazine, and polyquinoxalines.

N Valence Stabilizer #8c: Examples of 6-membered heterocyclic rings containing three nitrogen atoms (N monodentates or N—N bidentates) that meet the requirements for use as “wide band” valence stabilizers for Ce⁺⁴ include, but are not limited to: 1,3,5-triazine, 1,2,3-triazine, benzo-1,2,3-triazine, naphtho-1,2,3-triazine, oxatriazine, thiatriazine, melamine, and cyanuric acid.

N Valence Stabilizer #8d: Examples of 6-membered heterocyclic rings containing four nitrogen atoms (N monodentates or N—N bidentates) that meet the requirements for use as “wide band” valence stabilizers for Ce⁺⁴ include, but are not limited to: tetrazine.

N Valence Stabilizer #9a: Examples of 5-membered heterocyclic rings containing one nitrogen atom and having at least one additional nitrogen atom binding site not contained in a ring (N Monodentates, N—N Bidentates, N—N Tridentates, N—N Tetradentates, or N—N Hexadentates) that meet the requirements for use as “wide band” valence stabilizers for Ce⁺⁴ include, but are not limited to: 2-(aminomethyl)-3-pyrroline; 2,5-(aminomethyl)-3-pyrroline; 2-(aminomethyl)pyrrole; 2,5-(aminomethyl)pyrrole; 3-(aminomethyl)isoxazole; 2-(aminomethyl)thiazole; 3-(aminomethyl)isothiazole; 2-(aminomethyl)indole; 2-aminobenzoxazole; 2-aminobenzothiazole (abt); 1,8-diaminocarbazole; 2-amino-6-methyl-benzothiazole (amebt); 2-amino-6-methoxybenzothiazole (ameobt); and 1,3-diiminoisoindoline.

N Valence Stabilizer #9b: Examples of 5-membered heterocyclic rings containing two nitrogen atoms at least one additional nitrogen atom binding site not contained in a ring (N Monodentates, N—N Bidentates, N—N Tridentates, N—N Tetradentates, or N—N Hexadentates) that meet the requirements for use as “wide band” valence stabilizers for Ce⁺⁴ include, but are not limited to: 2-aminoimidazoline; 1-(3-aminopropyl)imidazoline; 2-aminoimidazole; 1-(3-aminopropyl)imidazole; 4-(2-aminoethyl)imidazole [histamine]; 1-alkyl-4-(2-aminoethyl)imidazole; 3-(2-aminoethyl)pyrazole; 3,5-(2-aminoethyl)pyrazole; 1-(aminomethyl)pyrazole; 2-aminobenzimidazole; 7-(2-aminoethyl)benzimidazole; 1-(3-aminopropyl)benzimidazole; 3-(2-aminoethyl)indazole; 3,7-(2-aminoethyl)indazole; 1-(aminomethyl)indazole; 7-aminobenzothiadiazole; 4-(2-aminoethyl)benzothiadiazole; 7-aminobenzoxadiazole; 4-(2-aminoethyl)benzoxadiazole; ethylenediaminetetra(1-pyrazolylmethane) [edtp]; methylenenitrilotris(2-(1-methyl)benzimidazole) [mntb] [tris(1-methyl-2-benzimidazolylmethane)amine]; bis(alkyl-1-pyrazolylmethane)amine; bis(alkyl-1-2-(1-pyrazolyl)ethane)amine; bis(N,N-(2-benzimidazolyl)-2-aminoethane)(2-benzimidazolylmethane)amine; bis(1-(3,5-dimethyl)pyrazolylmethane)phenylamine; tris(2-(1-(3,5-dimethyl)pyrazolyl)ethane)amine; 5-(dimethylamino)pyrazole; 5-(dimethylaminomethyl)pyrazole; 2-amino-1,3,4-thiadiazole; and 1-(2-aminoethyl)imidazoline.

N Valence Stabilizer #9c: Examples of 5-membered heterocyclic rings containing three nitrogen atoms at least one additional nitrogen atom binding site not contained in a ring (N Monodentates, N—N Bidentates, N—N—N Tridentates, N—N—N—N Tetradentates, or N—N—N—N—N—N Hexadentates) that meet the requirements for use as “wide band” valence stabilizers for Ce⁺⁴ include, but are not limited to: 3-amino-1,2,4-triazole (ata); 3,5-diamino-1,2,4-triazole (dat); 5-amino-1,2,4-triazole; 3-(2-aminoethyl)-1,2,4-triazole; 5-(2-aminoethyl)-1,2,4-triazole; 3,5-(2-aminoethyl) -1,2,4-triazole; 1-(aminomethyl)-1,2,4-triazole; 3,5-(aminomethyl)-4-amino-1,2,4-triazole; 4-(2-aminoethyl)-1,2,3-triazole; 5-(2-aminoethyl)-1,2,3-triazole; 7-aminobenzotriazole; 1-(aminomethyl)-1,2,3-triazole; 1-(2-aminoethyl)-1,2,3-triazole; 4-(3-aminopropyl)benzotriazole; N-(benzotriazolylalkyl)amine; dibenzotriazole-1-ylalkylamine; bis(5-amino-1,2,4-triazol-3-yl); bis(5-amino-1,2,4-triazol-3-yl)alkanes; and 1-(aminomethyl)benzotriazole.

N Valence Stabilizer #9d: Examples of 5-membered heterocyclic rings containing four nitrogen atoms at least one additional nitrogen atom binding site not contained in a ring (N Monodentates, N—N Bidentates, N—N Tridentates, N—N Tetradentates, or N—N Hexadentates) that meet the requirements for use as “wide band” valence stabilizers for Ce⁺⁴ include, but are not limited to: 5-(2-aminoethyl)-1H-tetrazole; 1-(aminomethyl)-1H-tetrazole; and 1-(2-aminoethyl)-1H -tetrazole.

N Valence Stabilizer #10a: Examples of 6-membered heterocyclic rings containing one nitrogen atom and having at least one additional nitrogen atom binding site not contained in a ring (N Monodentates, N—N Bidentates, N—N Tridentates, N—N Tetradentates, or N—N Hexadentates) that meet the requirements for use as “wide band” valence stabilizers for Ce⁺⁴ include, but are not limited to: 2-aminopyridine; 2,6-diaminopyridine; 2-(aminomethyl)pyridine; 2,6-(aminomethyl)pyridine; 2,6-(aminoethyl)pyridine; 2-amino-4-picoline; 2,6-diamino-4-picoline; 2-amino-3,5-lutidine; 2-aminoquinoline; 8-aminoquinoline; 2-aminoisoquinoline; acriflavine; 4-aminophenanthridine; 4,5-(aminomethyl)phenothiazine; 4,5-(aminomethyl)dibenzoxazine; 10-amino-7,8-benzoquinoline; bis(2-pyridylmethane)amine; tris(2-pyridyl)amine; bis(4-(2-pyridyl) -3-azabutane)amine; bis(N,N-(2-(2-pyridyl)ethane)aminomethane)amine; 4-(N,N-dialkylaminomethyl)morpholine; 6-aminonicotinic acid; 8 -aminoacridene; and 2-hydrazinopyridine.

N Valence Stabilizer #10b: Examples of 6-membered heterocyclic rings containing two nitrogen atoms at least one additional nitrogen atom binding site not contained in a ring (N Monodentates, N—N Bidentates, N—N Tridentates, N—N Tetradentates, or N—N Hexadentates) that meet the requirements for use as “wide band” valence stabilizers for Ce⁺⁴ include, but are not limited to: 2-aminopyrazine; 2,6-diaminopyrazine; 2-(aminomethyl)pyrazine; 2,6-(aminomethyl)pyrazine; 3-(aminomethyl)pyridazine; 3,6-(aminomethyl)pyridazine; 3,6-(2-aminoethyl)pyridazine; 1-aminopyridazine; 1-(aminomethyl)pyridazine; 2-aminopyrimidine; 1-(2-aminoethyl)pyrimidine; 2-aminoquinoxaline; 2,3-diaminoquinoxaline; 2-aminocinnoline; 3-aminocinnoline; 3-(2-aminoethyl)cinnoline; 3,8-(2-aminoethyl)cinnoline; 2-aminoquinazoline; 1-(2-aminoethyl)quinazoline; 1-aminophthalazine; 1,4-(2-aminoethyl)phthalazine; 1,8-(aminomethyl)phenazine; 2-amino-4,6-dimethylpyrimidine (admp); dihydralazine; and hydralazine.

N Valence Stabilizer #10c: Examples of 6-membered heterocyclic rings containing three nitrogen atoms at least one additional nitrogen atom binding site not contained in a ring (N Monodentates, N—N Bidentates, N—N Tridentates, N—N Tetradentates, or N—N Hexadentates) that meet the requirements for use as “wide band” valence stabilizers for Ce⁺⁴ include, but are not limited to: 2-amino-1,3,5-triazine; 2-(aminomethyl)-1,3,5-triazine; 2,6-(aminomethyl)-1,3,5-triazine; 1-(3-aminopropyl)-1,3,5-triazine; 1,5-(3-aminopropyl)-1,3,5-triazine, polymelamines; melamine; and altretamine.

N Valence Stabilizer #10d: Examples of 6-membered heterocyclic rings containing four nitrogen atoms at least one additional nitrogen atom binding site not contained in a ring (N Monodentates, N—N Bidentates, N—N Tridentates, N—N Tetradentates, or N—N Hexadentates) that meet the requirements for use as “wide band” valence stabilizers for Ce⁺⁴ include, but are not limited to: 3,6-(2-aminoethyl)-1,2,4,5-tetrazine; 3,6-(1,3-diamino-2-propyl)-1,2,4,5-tetrazine; and 4,6-(aminomethyl)-1,2,3,5-tetrazine.

N Valence Stabilizer #11a: Examples of 5-membered heterocyclic rings containing one nitrogen atom and having at least one additional nitrogen atom binding site contained in a ring (N Monodentates, N—N Bidentates, N—N Tridentates, N—N Tetradentates) that meet the requirements for use as “wide band” valence stabilizers for Ce⁺⁴ include, but are not limited to: 2,2′-bi-3-pyrroline; 2,2′-bi-2-pyrroline; 2,2′-bi-1-pyrroline; 2,2′-bipyrrole; 2,2′,2″-tripyrrole; 3,3′-biisoxazole; 2,2′-bioxazole; 3,3′-biisothiazole; 2,2′-bithiazole; 2,2′-biindole; 2,2′-bibenzoxazole; 2,2′-bibenzothiazole; bilirubin; biliverdine; and 7-azaindole.

N Valence Stabilizer #11b: Examples of 5-membered heterocyclic rings containing two nitrogen atoms at least one additional nitrogen atom binding site contained in a ring (N Monodentates, N—N Bidentates, N—N Tridentates, N—N Tetradentates) that meet the requirements for use as “wide band” valence stabilizers for Ce⁺⁴ include, but are not limited to: 2,2′-bi-2-imidazoline [2,2′-bi -2-imidazolinyl] [bimd]; 2,2′-biimidazole [2,2′-biimidazolyl] [biimH₂]; 5,5′-bipyrazole; 3,3′-bipyrazole; 4,4′-bipyrazole [4,4′-bipyrazolyl] [bpz]; 2,2′-bioxadiazole; 2,2′-bithiadiazole; 2,2′-bibenzimidazole; 7,7′-biindazole; 5,5′-bibenzofurazan; 5,5′-bibenzothiadiazole; bis-1,2-(2-benzimidazole)ethane; bis(2-benzimidazole)methane; 1,2-(2-imidazolyl)benzene; 2-(2-thiazolyl)benzimidazole; 2-(2-imidazolyl)benzimidazole; benzimidazotriazine; 4-azabenzimidazole; and 2,6-bis(2-benzimidazolyl)pyridine.

N Valence Stabilizer #11c: Examples of 5-membered heterocyclic rings containing three nitrogen atoms at least one additional nitrogen atom binding site contained in a ring (N Monodentates, N—N Bidentates, N—N Tridentates, N—N Tetradentates) that meet the requirements for use as “wide band” valence stabilizers for Ce⁺⁴ include, but are not limited to: 5,5′-bi-1,2,4-triazole [btrz]; 3,3′-bi-1,2,4-triazole; 1,1′-bi-1,2,4-triazole; 1,1′-bi-1,2,3-triazole; 5,5′-bi-1,2,3-triazole; 7,7′-bibenzotriazole; 1,1′-bibenzotriazole; bis(pyridyl)aminotriazole (pat); and 8-azaadenine.

N Valence Stabilizer #11d: Examples of 5-membered heterocyclic rings containing four nitrogen atoms at least one additional nitrogen atom binding site contained in a ring (N Monodentates, N—N Bidentates, N—N Tridentates, N—N Tetradentates) that meet the requirements for use as “wide band” valence stabilizers for Ce⁺⁴ include, but are not limited to: 5,5′-bi-1H-tetrazole; and 1,1′-bi-1H-tetrazole.

N Valence Stabilizer #12a: Examples of 6-membered heterocyclic rings containing one nitrogen atom and having at least one additional nitrogen atom binding site contained in a ring (N Monodentates, N—N Bidentates, N—N Tridentates, N—N Tetradentates) that meet the requirements for use as “wide band” valence stabilizers for Ce⁺⁴ include, but are not limited to: 2,2′-bipyridine [bipy]; 2,2′,2″-tripyridine [terpyridine] [terpy]; 2,2′,2″, 2′″-tetrapyridine [tetrapy]; 6,6′-bi-2-picoline; 6,6′-bi-3-picoline; 6,6′-bi-4-picoline; 6,6′-bi-2,3-lutidine; 6,6′-bi-2,4-lutidine; 6,6′-bi -3,4-lutidine; 6,6′-bi-2,3,4-collidine; 2,2′-biquinoline; 2,2′-biisoquinoline; 3,3′-bibenzoxazine; 3,3′-bibenzothiazine; 1,10-phenanthroline [phen]; 1,8-naphthyridine; bis-1,2-(6-(2,2′-bipyridyl))ethane; bis-1,3-(6-(2,2′-bipyridyl))propane; 3,5-bis(3-pyridyl)pyrazole; 3,5-bis(2-pyridyl)triazole; 1,3-bis(2-pyridyl)-1,3,5-triazine; 1,3-bis(2-pyridyl)-5-(3-pyridyl)-1,3,5-triazine; 2,7-(N,N′-di-2-pyridyl)diaminobenzopyrroline; 2,7-(N,N′-di-2-pyridyl)diaminophthalazine; 2,6-di-(2-benzothiazolyl)pyridine; triazolopyrimidine; 2-(2-pyridyl)imidazoline; 7-azaindole; 1-(2-pyridyl)pyrazole; (1-imidazolyl)(2-pyridyl)methane; 4,5-bis(N,N′-(2-(2-pyridyl)ethyl)iminomethyl)imidazole; bathophenanthroline; 4(2-benzimidazolyl)quinoline; 1,2-bis(2-pyridyl)ethane; 4,4′-diphenyl-2,2′-dipyridyl; neocuproine; nicotine; and nornicotine.

N Valence Stabilizer #12b: Examples of 6-membered heterocyclic rings containing two nitrogen atoms at least one additional nitrogen atom binding site contained in a ring (N Monodentates, N—N Bidentates, N—N Tridentates, N—N Tetradentates) that meet the requirements for use as “wide band” valence stabilizers for Ce⁺⁴ include, but are not limited to: 2,2′-bipyrazine; 2,2′,2″-tripyrazine; 6,6′-bipyridazine; bis(3-pyridazinyl)methane; 1,2-bis(3-pyridazinyl)ethane; 2,2′-bipyrimidine; 2,2′-biquinoxaline; 8,8′-biquinoxaline; bis(3-cinnolinyl)methane; bis(3-cinnolinyl)ethane; 8,8′-bicinnoline; 2,2′-biquinazoline; 4,4′-biquinazoline; 8,8′-biquinazoline; 2,2′-biphthalazine; 1,1′-biphthalazine; 2-(2-pyridyl)benzimidazole; 8-azapurine; purine; adenine; guanine; hypoxanthine; 2,6-bis(N,N′-(2-(4-imidazolyl)ethyl)iminomethyl)pyridine; 2-(N-(2-(4-imidazolyl)ethyl)iminomethyl)pyridine; adenine (aminopurine); purine; and 2,3-bis(2-pyridyl)pyrazine.

N Valence Stabilizer #12c: Examples of 6-membered heterocyclic rings containing three nitrogen atoms at least one additional nitrogen atom binding site contained in a ring (N Monodentates, N—N Bidentates, N—N Tridentates, N—N Tetradentates) that meet the requirements for use as “wide band” valence stabilizers for Ce⁺⁴ include, but are not limited to: 2,2′-bi-1,3,5-triazine; 2,2′,2″-tri-1,3,5-triazine; 4,4′-bi-1,2,3-triazine; and 4,4′-bibenzo-1,2,3-triazine; 2,4,6-tris(2-pyridyl)-1,3,5-triazine; and benzimidazotriazines.

N Valence Stabilizer #12d: Examples of 6-membered heterocyclic rings containing four nitrogen atoms at least one additional nitrogen atom binding site contained in a ring (N Monodentates, N—N Bidentates, N—N Tridentates, N—N Tetradentates) that meet the requirements for use as “wide band” valence stabilizers for Ce⁺⁴ include, but are not limited to: 3,3′-bi-1,2,4,5-tetrazine; and 4,4′-bi-1,2,3,5-tetrazine.

N Valence Stabilizer #13a: Examples of two-membered macrocyclics, macrobicyclics, and macropolycyclics (including catapinands, cryptands, cyclidenes, and sepulchrates) wherein both binding sites are composed of nitrogen (usually amine or imine groups) and are not contained in component heterocyclic rings (N—N Bidentates) that meet the requirements for use as “wide band” valence stabilizers for Ce⁺⁴ include, but are not limited to: diazacyclobutane ([4]aneN₂); diazacyclopentane ([5]aneN₂); diazacyclohexane ([6]aneN₂); diazacycloheptane ([7]aneN₂); diazacyclooctane ([8]aneN₂); piperazine; benzopiperazine; diazacyclobutene ([4]eneN₂); diazacyclopentene ([5]eneN₂); diazacyclohexene ([6]eneN₂); diazacycloheptene ([7]eneN₂); diazacyclooctene ([8]eneN₂); diazacyclobutadiene ([4]dieneN₂); diazacyclopentadiene ([5]dieneN₂); diazacyclohexadiene ([6]dieneN₂); diazacycloheptadiene ([7]dieneN₂); and diazacyclooctadiene ([8]dieneN₂).

N Valence Stabilizer #13b: Examples of three-membered macrocyclics, macrobicyclics, and macropolycyclics (including catapinands, cryptands, cyclidenes, and sepulchrates) wherein all binding sites are composed of nitrogen (usually amine or imine groups) and are not contained in component heterocyclic rings (N—N Tridentates) that meet the requirements for use as “wide band” valence stabilizers for Ce⁺⁴ include, but are not limited to: triazacyclohexane (including hexahydro-1,3,5-triazine)([6]aneN₃); triazacycloheptane ([7]aneN₃); triazacyclooctane ([8]aneN₃); triazacyclononane ([9]aneN₃); triazacyclodecane ([10]aneN₃); triazacycloundecane ([11]aneN₃); triazacyclododecane ([12]aneN₃); triazacyclohexene ([6]eneN₃); triazacycloheptene ([7]eneN₃); triazacyclooctene ([8]eneN₃); triazacyclononene ([9]eneN₃); triazacyclodecene ([10]eneN₃); triazacycloundecene ([11]eneN₃); triazacyclododecene ([12]eneN₃); triazacyclohexatriene ([6]trieneN₃); triazacycloheptatriene ([7]trieneN₃); triazacyclooctatriene ([8]trieneN₃); triazacyclononatriene ([9]trieneN₃); triazacyclodecatriene ([10]trieneN₃); triazacycloundecatriene ([11]trieneN₃); and triazacyclododecatriene ([12]trieneN₃).

N Valence Stabilizer #13c: Examples of four-membered macrocyclics, macrobicyclics, and macropolycyclics (including catapinands, cryptands, cyclidenes, and sepulchrates) wherein all binding sites are composed of nitrogen (usually amine or imine groups) and are not contained in component heterocyclic rings (N—N Tetradentates) that meet the requirements for use as “wide band” valence stabilizers for Ce⁺⁴ include, but are not limited to: tetraazacyclooctane ([8]aneN₄); tetraazacyclononane ([9]aneN₄); tetraazacyclodecane ([10]aneN₄); tetraazacycloundecane ([11]aneN₄); tetraazacyclododecane ([12]aneN₄); tetraazacyclotridecane ([13]aneN₄); tetraazacyclotetradecane ([14]aneN₄); tetraazacyclopentadecane ([15]aneN₄); tetraazacyclohexadecane ([16]aneN₄); tetraazacycloheptadecane ([17]aneN₄); tetraazacyclooctadecane ([18]aneN₄); tetraazacyclononadecane ([19]aneN₄); tetraazacycloeicosane ([20]aneN₄); tetraazacyclooctadiene ([8]dieneN₄); tetraazacyclononadiene ([9]dieneN₄); tetraazacyclodecadiene ([10]dieneN₄); tetraazacycloundecadiene ([11]dieneN₄); tetraazacyclododecadiene ([12]dieneN₄); tetraazacyclotridecadiene ([13]dieneN₄); tetraazacyclotetradecadiene ([14]dieneN₄); tetraazacyclopentadecadiene ([15]dieneN₄); tetraazacyclohexadecadiene ([16]dieneN₄); tetraazacycloheptadecadiene ([17]dieneN₄); tetraazacyclooctadecadiene ([18]dieneN₄); tetraazacyclononadecadiene ([19]dieneN₄); tetraazacycloeicosadiene ([20]dieneN₄); tetraazacyclooctatetradiene ([8]tetradieneN₄); tetraazacyclononatetradiene ([9]tetradieneN₄); tetraazacyclodecatetradiene ([10]tetradieneN₄); tetraazacycloundecatetradiene ([11]tetradieneN₄); tetraazacyclododecatetradiene ([12]tetradieneN₄); tetraazacyclotridecatetradiene ([13]tetradieneN₄); tetraazacyclotetradecatetradiene ([14]tetradieneN₄); tetraazacyclopentadecatetradiene ([15]tetradieneN₄); tetraazacyclohexadecatetradiene ([16]tetradieneN₄); tetraazacycloheptadecatetradiene ([17]tetradieneN₄); tetraazacyclooctadecatetradiene ([18]tetradieneN₄); tetraazacyclononadecatetradiene ([19]tetradieneN₄); and tetraazacycloeicosatetradiene ([20]tetradieneN₄).

N Valence Stabilizer #13d: Examples of six-membered macrocyclics, macrobicyclics, and macropolycyclics (including catapinands, cryptands, cyclidenes, and sepulchrates) wherein all binding sites are composed of nitrogen (usually amine or imine groups) and are not contained in component heterocyclic rings (N—N Tridentates, N—N Tetradentates, or N—N Hexadentates) that meet the requirements for use as “wide band” valence stabilizers for Ce⁺⁴ include, but are not limited to: hexaazacyclododecane ([12]aneN₆); hexaazacyclotridecane ([13]aneN₆); hexaazacyclotetradecane ([14]aneN₆); hexaazacyclopentadecane ([15]aneN₆); hexaazacyclohexadecane ([16]aneN₆); hexaazacycloheptadecane ([17]aneN₆); hexaazacyclooctadecane ([18]aneN₆); hexaazacyclononadecane ([19]aneN₆); hexaazacycloeicosane ([20]aneN₆); hexaazacycloheneicosane ([21]aneN₆); hexaazacyclodocosane ([22]aneN₆); hexaazacyclotricosane ([23]aneN₆); hexaazacyclotetracosane ([24]aneN₆); hexaazacyclododecatriene ([12]trieneN₆); hexaazacyclotridecatriene ([13]trieneN₆); hexaazacyclotetradecatriene ([14]trieneN₆); hexaazacyclopentadecatriene ([15]trieneN₆); hexaazacyclohexadecatriene ([16]trieneN₆); hexaazacycloheptadecatriene ([17]trieneN₆); hexaazacyclooctadecatriene ([18]trieneN₆); hexaazacyclononadecatriene ([19]trieneN₆); hexaazacycloeicosatriene ([20]trieneN₆); hexaazacycloheneicosatriene ([21]trieneN₆); hexaazacyclodocosatriene ([22]trieneN₆); hexaazacyclotricosatriene ([23]trieneN₆); and hexaazacyclotetracosatriene ([24]trieneN₆).

N Valence Stabilizer #13e: Examples of eight-membered macrocyclics, macrobicyclics, and macropolycyclics (including catapinands, cryptands, cyclidenes, and sepulchrates) wherein all binding sites are composed of nitrogen (usually amine or imine groups) and are not contained in component heterocyclic rings (N—N Tridentates, N—N Tetradentates, or N—N Hexadentates) that meet the requirements for use as “wide band” valence stabilizers for Ce⁺⁴ include, but are not limited to: octaazacyclohexadecane ([16]aneN₈); octaazacycloheptadecane ([17]aneN₈); octaazacyclooctadecane ([18]aneN₈); octaazacyclononadecane ([19]aneN₈); octaazacycloeicosane ([20]aneN₈); octaazacycloheneicosane ([21]aneN₈); octaazacyclodocosane ([22]aneN₈); octaazacyclotricosane ([23]aneN₈); octaazacyclotetracosane ([24]aneN₈); octaazacyclohexadecatetradiene ([16]tetradieneN₈); octaazacycloheptadecatetradiene ([17]tetradieneN₈); octaazacyclooctadecatetradiene ([18]tetradieneN₈); octaazacyclononadecatetradiene ([19]tetradieneN₈); octaazacycloeicosatetradiene ([20]tetradieneN₈); octaazacycloheneicosatetradiene ([21]tetradieneN₈); octaazacyclodocosatetradiene ([22]tetradieneN₈); octaazacyclotricosatetradiene ([23]tetradieneN₈); and octaazacyclotetracosatetradiene ([24]tetradieneN₈).

N Valence Stabilizer #13f: Examples of ten-membered macrocyclics, macrobicyclics, and macropolycyclics (including catapinands, cryptands, cyclidenes, and sepulchrates) wherein all binding sites are composed of nitrogen (usually amine or imine groups) and are not contained in component heterocyclic rings (N—N Tridentates, N—N Tetradentates, or N—N Hexadentates) that meet the requirements for use as “wide band” valence stabilizers for Ce⁺⁴ include, but are not limited to: decaazacycloeicosane ([20]aneN₁₀); decaazacycloheneicosane ([21]aneN₁₀); decaazacyclodocosane ([22]aneN₁₀); decaazacyclotricosane ([23]aneN₁₀); decaazacyclotetracosane ([24]aneN₁₀); decaazacyclopentacosane ([25]aneN₁₀); decaazacyclohexacosane ([26]aneN₁₀); decaazacycloheptacosane ([27]aneN₁₀); decaazacyclooctacosane ([28]aneN₁₀); decaazacyclononacosane ([29]aneN₁₀); decaazacyclotriacontane ([30]aneN₁₀); decaazacycloeicosapentadiene ([20]pentadieneN₁₀); decaazacycloheneicosapentadiene ([21]pentadieneN₁₀); decaazacyclodocosapentadiene ([22]pentadieneN₁₀); decaazacyclotricosapentadiene ([23]pentadieneN₁₀); decaazacyclotetracosapentadiene ([24]pentadieneN₁₀); decaazacyclopentacosapentadiene ([25]pentadieneN₁₀); decaazacyclohexacosapentadiene ([26]pentadieneN₁₀); decaazacycloheptacosapentadiene ([27]pentadieneN₁₀); decaazacyclooctacosapentadiene ([28]pentadieneN₁₀); decaazacyclononacosapentadiene ([29]pentadieneN₁₀); and decaazacyclotriacontapentadiene ([30]pentadieneN₁₀).

N Valence Stabilizer #14a: Examples of four-membered macrocyclics, macrobicyclics, and macropolycyclics (including catapinands, cryptands, cyclidenes, and sepulchrates) wherein all four binding sites are composed of nitrogen and are contained in component 5-membered heterocyclic rings (N—N Tetradentates) that meet the requirements for use as “wide band” valence stabilizers for Ce⁺⁴ include, but are not limited to: porphyrins (including tetraphenylporphine (tpp); “picket fence” porphyrins, “picket tail” porphyrins, “bispocket” porphyrins, “capped” porphyrins, cyclophane porphyrins, “pagoda” porphyrins, “pocket” porphyrins, “pocket tail” porphyrins, cofacial diporphyrins, “strapped” porphyrins, “hanging base” porphyrins, bridged porphyrins, chelated mesoporphyrins, homoporphyrins, chlorophylls, and pheophytins); porphodimethanes; porphyrinogens; chlorins; bacteriochlorins; isobacteriochlorins; corroles; corrins and corrinoids; didehydrocorrins; tetradehydrocorrins; hexadehydrocorrins; octadehydrocorrins; tetraoxazoles; tetraisooxazoles; tetrathiazoles; tetraisothiazoles; tetraazaphospholes; tetraimidazoles; tetrapyrazoles; tetraoxadiazoles; tetrathiadiazoles; tetradiazaphospholes; tetratriazoles; tetraoxatriazoles; tetrathiatriazoles; coproporphyrin; etioporphyrin; and hematoporphyrin.

N Valence Stabilizer #14b: Examples of six-membered macrocyclics, macrobicyclics, and macropolycyclics (including catapinands, cryptands, cyclidenes, and sepulchrates) wherein all six binding sites are composed of nitrogen and are contained in component 5-membered heterocyclic rings (N—N Tridentates, N—N Tetradentates, or N—N Hexadentates) that meet the requirements for use as “wide band” valence stabilizers for Ce⁺⁴ include, but are not limited to: hexaphyrins (hexapyrroles); hexaoxazoles; hexaisooxazoles; hexathiazoles; hexaisothiazoles; hexaazaphospholes; hexaimidazoles; hexapyrazoles; hexaoxadiazoles; hexathiadiazoles; hexadiazaphospholes; hexatriazoles; hexaoxatriazoles; and hexathiatriazoles.

N Valence Stabilizer #14c: Examples of eight-membered macrocyclics, macrobicyclics, and macropolycyclics (including catapinands, cryptands, cyclidenes, and sepulchrates) wherein all eight binding sites are composed of nitrogen and are contained in component 5-membered heterocyclic rings (N—N Tridentates, N—N Tetradentates, or N—N Hexadentates) that meet the requirements for use as “wide band” valence stabilizers for Ce⁺⁴ include, but are not limited to: octaphyrins (octapyrroles); octaoxazoles; octaisooxazoles; octathiazoles; octaisothiazoles; octaazaphospholes; octaimidazoles; octapyrazoles; octaoxadiazoles; octathiadiazoles; octadiazaphospholes; octatriazoles; octaoxatriazoles; and octathiatriazoles.

N Valence Stabilizer #14d: Examples of ten-membered macrocyclics, macrobicyclics, and macropolycyclics (including catapinands, cryptands, cyclidenes, and sepulchrates) wherein all ten binding sites are composed of nitrogen and are contained in component 5-membered heterocyclic rings (N—N Tridentates, N—N Tetradentates, or N—N Hexadentates) that meet the requirements for use as “wide band” valence stabilizers for Ce⁺⁴ include, but are not limited to: decaphyrins (decapyrroles); decaoxazoles; decaisooxazoles; decathiazoles; decaisothiazoles; decaazaphospholes; decaimidazoles; decapyrazoles; decaoxadiazoles; decathiadiazoles; decadiazaphospholes; decatriazoles; decaoxatriazoles; and decathiatriazoles.

N Valence Stabilizer #15a: Examples of four-membered macrocyclics, macrobicyclics, and macropolycyclics (including catapinands, cryptands, cyclidenes, and sepulchrates) wherein all four binding sites are composed of nitrogen and are contained in a combination of 5-membered heterocyclic rings and amine or imine groups (N—N Tetradentates) that meet the requirements for use as “wide band” valence stabilizers for Ce⁺⁴ include, but are not limited to: porphyrazines; octahydrodiazaporphyrins; phthalocyanines; naphthalocyanines; anthracocyanines; and tetraazaporphyrins

N Valence Stabilizer #15b: Examples of six-membered macrocyclics, macrobicyclics, and macropolycyclics (including catapinands, cryptands, cyclidenes, and sepulchrates) wherein all six binding sites are composed of nitrogen and are contained in a combination of 5-membered heterocyclic rings and amine or imine groups (N—N Tridentates, N—N Tetradentates, or N—N Hexadentates) that meet the requirements for use as “wide band” valence stabilizers for Ce⁺⁴ include, but are not limited to: diazahexaphyrins; tetraazahexaphyrins; hexaazahexaphyrins; diazahexapyrazoles; tetraazahexapyrazoles; hexaazahexapyrazoles; diazahexaimidazoles; tetraazahexaimidazoles; and hexaazahexaimidazoles.

N Valence Stabilizer #15c: Examples of eight-membered macrocyclics, macrobicyclics, and macropolycyclics (including catapinands, cryptands, cyclidenes, and sepulchrates) wherein all eight binding sites are composed of nitrogen and are contained in a combination of 5-membered heterocyclic rings and amine or imine groups (N—N Tridentates, N—N Tetradentates, or N—N Hexadentates) that meet the requirements for use as “wide band” valence stabilizers for Ce⁺⁴ include, but are not limited to: diazaoctaphyrins; tetraazaoctaphyrins; hexaazaoctaphyrins; octaazaoctaphyrins; diazaoctapyrazoles; tetraazaoctapyrazoles; hexaazaoctapyrazoles; octaazaoctapyrazoles; diazaoctaimidazoles; tetraazaoctaimidazoles; hexaazaoctaimidazoles; and octaazaoctaimidazoles.

N Valence Stabilizer #15d: Examples of ten-membered macrocyclics, macrobicyclics, and macropolycyclics (including catapinands, cryptands, cyclidenes, and sepulchrates) wherein all ten binding sites are composed of nitrogen and are contained in a combination of 5-membered heterocyclic rings and amine or imine groups (N—N Tridentates, N—N Tetradentates, or N—N Hexadentates) that meet the requirements for use as “wide band” valence stabilizers for Ce⁺⁴ include, but are not limited to: diazadecaphyrins; tetraazadecaphyrins; hexaazadecaphyrins; octaazadecaphyrins; decaazadecaphyrins; diazadecapyrazoles; tetraazadecapyrazoles; hexaazadecapyrazoles; octaazadecapyrazoles; decaazadecapyrazoles; diazadecaimidazoles; tetraazadecaimidazoles; hexaazadecaimidazoles; octaazadecaimidazoles; and decaazadecaimidazoles.

N Valence Stabilizer #16a: Examples of four-membered macrocyclics, macrobicyclics, and macropolycyclics (including catapinands, cryptands, cyclidenes, and sepulchrates) wherein all four binding sites are composed of nitrogen and are contained in component 6-membered heterocyclic rings (N—N Tetradentates) that meet the requirements for use as “wide band” valence stabilizers for Ce⁺⁴ include, but are not limited to: cyclotetrapyridines; cyclotetraoxazines; cyclotetrathiazines; cyclotetraphosphorins; cyclotetraquinolines; cyclotetrapyrazines; cyclotetrapyridazines; cyclotetrapyrimidines; cyclotetraoxadiazines; cyclotetrathiadiazines; cyclotetradiazaphosphorins; cyclotetraquinoxalines; cyclotetratriazines; cyclotetrathiatriazines; and cyclotetraoxatriazines.

N Valence Stabilizer #16b: Examples of six-membered macrocyclics, macrobicyclics, and macropolycyclics (including catapinands, cryptands, cyclidenes, and sepulchrates) wherein all six binding sites are composed of nitrogen and are contained in component 6-membered heterocyclic rings (N—N Tridentates, N—N Tetradentates, or N—N Hexadentates) that meet the requirements for use as “wide band” valence stabilizers for Ce⁺⁴ include, but are not limited to: cyclosexipyridines; cyclosexioxazines; cyclosexithiazines; cyclosexiphosphorins; cyclosexiquinolines; cyclosexipyrazines; cyclosexipyridazines; cyclosexipyrimidines; cyclosexioxadiazines; cyclosexithiadiazines; cyclosexidiazaphosphorins cyclosexiquinoxalines; cyclosexitriazines; cyclosexithiatriazines; and cyclosexioxatriazines.

N Valence Stabilizer #16c: Examples of eight-membered macrocyclics, macrobicyclics, and macropolycyclics (including catapinands, cryptands, cyclidenes, and sepulchrates) wherein all six binding sites are composed of nitrogen and are contained in component 6-membered heterocyclic rings (N—N Tridentates, N—N Tetradentates, or N—N Hexadentates) that meet the requirements for use as “wide band” valence stabilizers for Ce⁺⁴ include, but are not limited to: cyclooctapyridines; cyclooctaoxazines; cyclooctathiazines; cyclooctaphosphorins; cyclooctaquinolines; cyclooctapyrazines; cyclooctapyridazines; cydooctapyrimidines; cyclooctaoxadiazines; cyclooctathiadiazines; cyclooctadiazaphosphorins; cyclooctaquinoxalines; cyclooctatriazines; cyclooctathiatriazines; and cyclooctaoxatriazines.

N Valence Stabilizer #16d: Examples of ten-membered macrocyclics, macrobicyclics, and macropolycyclics (including catapinands, cryptands, cyclidenes, and sepulchrates) wherein all six binding sites are composed of nitrogen and are contained in component 6-membered heterocyclic rings (N—N Tridentates, N—N Tetradentates, or N—N Hexadentates) that meet the requirements for use as “wide band” valence stabilizers for Ce⁺⁴ include, but are not limited to: cyclodecapyridines; cyclodecaoxazines; cyclodecathiazines; cyclodecaphosphorins; cyclodecaquinolines; cyclodecapyrazines; cyclodecapyridazines; cyclodecapyrimidines; cyclodecaoxadiazines; cyclodecathiadiazines; cyclodecadiazaphosphorins; cyclodecaquinoxalines; cyclodecatriazines; cyclodecathiatriazines; and cyclodecaoxatriazines.

N Valence Stabilizer #17a: Examples of four-membered macrocyclics, macrobicyclics, and macropolycyclics (including catapinands, cryptands, cyclidenes, and sepulchrates) wherein all four binding sites are composed of nitrogen and are contained in a combination of 6-membered heterocyclic rings and amine or imine groups (N—N Tetradentates) that meet the requirements for use as “wide band” valence stabilizers for Ce⁺⁴ include, but are not limited to: diazacyclotetrapyridines; tetraazacyclotetrapyridines; diazacyclotetraquinolines; tetraazacyclotetraquinolines; diazacyclotetrapyrazines; tetraazacyclotetrapyrazines; diazacyclotetrapyridazines; tetraazacyclotetrapyridazines; diazacyclotetrapyrimidines; tetraazacyclotetrapyrimidines; diazacyclotetratriazines; and tetraazacyclotetratriazines.

N Valence Stabilizer #17b: Examples of six-membered macrocyclics, macrobicyclics, and macropolycyclics (including catapinands, cryptands, cyclidenes, and sepulchrates) wherein all six binding sites are composed of nitrogen and are contained in a combination of 6-membered heterocyclic rings and amine or imine groups (N—N Tridentates, N—N Tetradentates, or N—N Hexadentates) that meet the requirements for use as “wide band” valence stabilizers for Ce⁺⁴ include, but are not limited to: diazacyclosexipyridines; triazacyclosexipyridines; diazacyclosexiquinolines; triazacyclosexiquinolines; diazacyclosexipyrazines; triazacyclosexipyrazines; diazacyclosexipyridazines; triazacyclosexipyridazines; diazacyclosexipyrimidines; triazacyclosexipyrimidines; diazacyclosexitriazines; and triazacyclosexitriazines.

N Valence Stabilizer #17c: Examples of eight-membered macrocyclics, macrobicyclics, and macropolycyclics (including catapinands, cryptands, cyclidenes, and sepulchrates) wherein all eight binding sites are composed of nitrogen and are contained in a combination of 6-membered heterocyclic rings and amine or imine groups (N—N Tridentates, N—N Tetradentates, or N—N Hexadentates) that meet the requirements for use as “wide band” valence stabilizers for Ce⁺⁴ include, but are not limited to: diazacyclooctapyridines; tetraazacyclooctapyridines; diazacyclooctaquinolines; tetraazacyclooctaquinolines; diazacyclooctapyrazines; tetraazacyclooctapyrazines; diazacyclooctapyridazines; tetraazacyclooctapyridazines; diazacyclooctapyrimidines; tetraazacyclooctapyrimidines; diazacyclooctatriazines; and tetraazacyclooctatriazines.

N Valence Stabilizer #17d: Examples of ten-membered macrocyclics, macrobicyclics, and macropolycyclics (including catapinands, cryptands, cyclidenes, and sepulchrates) wherein all ten binding sites are composed of nitrogen and are contained in a combination of 6-membered heterocyclic rings and amine or imine groups (N—N Tridentates, N—N Tetradentates, or N—N Hexadentates) that meet the requirements for use as “wide band” valence stabilizers for Ce⁺⁴ include, but are not limited to: diazacyclodecapyridines; pentaazacyclodecapyridines; diazacyclodecaquinolines; pentaazacyclodecaquinolines; diazacyclodecapyrazines; pentaazacyclodecapyrazines; diazacyclodecapyridazines; pentaazacyclodecapyndazines; diazacyclodecapyrimidines; pentaazacyclodecapyrimidines; diazacyclodecatriazines; and pentaazacyclodecatriazines.

N Valence Stabilizer #18: Examples of amidines and diamidines (N—N bidentates or N—N Tetradentates) that meet the requirements for use as “wide band” valence stabilizers for Ce⁺⁴ include, but are not limited to: N,N′-dimethylformamidine; N,N′-diethylformamidine; N,N′-diisopropylformamidine; N,N′-dibutylformamidine; N,N′-diphenylform amidine; N,N′-dibenzylformamidine; N,N′-dinaphthylformamidine; N,N′-dicyclohexylformamidine; N,N′-dinorbornylformamidine; N,N′-diadamantylformamidine; N,N′-dianthraquinonylformamidine; N,N′-dimethylacetamidine; N,N′-diethylacetamidine; N,N′-diisopropylacetamidine; N,N′-dibutylacetamidine; N,N′-diphenylacetamidine; N,N′-dibenzylacetamidine; N,N′-dinaphthylacetamidine; N,N′-dicyclohexylacetamidine; N,N′-dinorbornylacetamidine; N,N′-diadamantylacetamidine; N,N′-dimethylbenzamidine; N,N′-diethylbenzamidine; N,N′-diisopropylbenzamidine; N,N′-dibutylbenzamidine; N,N′-diphenylbenzamidine; N,N′-dibenzylbenzamidine; N,N′-dinaphthylbenzamidine; N,N′-dicyclohexylbenzamidine; N,N′-dinorbornylbenzamidine; N,N′-diadamantylbenzamidine; N,N′-dimethyltoluamidine; N,N′-diethyltoluamidine; N,N′-diisopropyltoluamidine; N,N′-dibutyltoluamidine; N,N′-diphenyltoluamidine; N,N′-dibenzyltoluamidine; N,N′-dinaphthyltoluamidine; N,N′-dicyclohexyltoluamidine; N,N′-dinorbornyltoluamidine; N,N′-diadamantyltoluamidine; oxalic diamidine; malonic diamidine; succinic diamidine; glutaric diamidine; adipic diamidine; pimelic diamidine; suberic diamidine; phthalic diamidine; terephthalic diamidine; isophthalic diamidine; piperazine diamidine; 2-iminopyrrolidine; 2-iminopiperidine; amidinobenzamide; benzamidine; chloroazodin; and debrisoquin.

N Valence Stabilizer #19: Examples of biguanides (imidodicarbonimidic diamides), biguanidines, imidotricarbonimidic diamides, imidotetracarbonimidic diamides, dibiguanides, bis(biguanidines), polybiguanides, and poly(biguanidines) (N—N bidentates, N—N tridentates, N—N tetradentates, and N—N hexadentates) that meet the requirements for use as “wide band” valence stabilizers for Ce⁺⁴ include, but are not limited to: biguanide (bigH); biguanidine, methylbiguanide; ethylbiguanide; isopropylbiguanide; butylbiguanide;benzylbiguanide; phenylbiguanide; tolylbiguanide; naphthylbiguanide; cyclohexylbiguanide; norbornylbiguanide; adamantylbiguanide; dimethylbiguanide; diethylbiguanide; diisopropylbiguanide; dibutylbiguanide; dibenzylbiguanide; diphenylbiguanide; ditolylbiguanide; dinaphthylbiguanide; dicyclohexylbiguanide; dinorbornylbiguanide; diadamantylbiguanide; ethylenedibiguanide; propylenedibiguanide; tetramethylenedibiguanide; pentamethylenedibiguanide; hexamethylenedibiguanide; heptamethylenedibiguanide; octamethylenedibiguanide; phenylenedibiguanide; piperazinedibiguanide; oxalyldibiguanide; malonyldibiguanide; succinyldibiguanide; glutaryldibiguanide; adipyldibiguanide; pimelyldibiguanide; suberyldibiguanide; phthalyldibiguanide; paludrine; polyhexamethylene biguanide; 2-guanidinothiazole; 2-guanidinooxazole; 2-guanidinoimidazole; 3-guanidinopyrazole; 3-guanidino-1,2,4-triazole; 5-guanidinotetrazole; alexidine; buformin; and moroxydine.

N Valence Stabilizer #20: Examples of diamidinomethanes, bis(diamidinomethanes), and poly(diamidinomethanes) (N—N bidentates, N—N tridentates, N—N tetradentates, and N—N hexadentates) that meet the requirements for use as “wide band” valence stabilizers for Ce⁺⁴ include, but are not limited to: diamidinomethane; N-methyldiamidinomethane; N-ethyldiamidinomethane; N-isopropyldiamidinomethane; N-butyldiamidinomethane; N-benzyldiamidinomethane; N-phenyldiamidinomethane; N-tolyldiamidinomethane; N-naphthyldiamidinomethane; N-cyclohexyldiamidinomethane; N-norbomyldiamidinomethane; N-adamantyldiamidinomethane; dimethyldiamidinomethane; diethyldiamidinomethane; diisopropyldiamidinomethane; dibutyldiamidinomethane; dibenzyldiamidinomethane; diphenyldiamidinomethane; ditolyldiamidinomethane; dinaphthyldiamidinomethane; dicyclohexyldiamidinomethane; dinorbomyldiamidinomethane; diadamantyldiamidinomethane; ethylenebisdiamidinomethane; propylenebisdiamidinomethane; tetramethylenebisdiamidinomethane; pentamethylenebisdiamidinomethane; hexamethylenebisdiamidinomethane; heptamethylenebisdiamidinomethane; octamethylenebisdiamidinomethane; phenylenebisdiamidinomethane; piperazinebisdiamidinomethane; oxalylbisdiamidinomethane; malonylbisdiamidinomethane; succinylbisdiamidinomethane; glutarylbisdiamidinomethane; phthalylbisdiamidinomethane; 2-amidinomethylthiazole; 2-amidinomethyloxazole; 2-amidinomethylimidazole; 3-amidinomethylpyrazole; 3-amidinomethyl-1,2,4-triazole; and 5-amidinomethyltetrazole.

N Valence Stabilizer #21: Examples of imidoylguanidines, amidinoguanidines, bis(imidoylguanidines), bis(amidinoguanidines), poly(imidoylguanidines), and poly(amidinoguanidines) (N—N bidentates, N—N tridentates, N—N tetradentates, and N—N hexadentates) that meet the requirements for use as “wide band” valence stabilizers for Ce⁺⁴ include, but are not limited to: acetimidoylguanidine; amidinoguanidine, benzimidoylguanidine; cyclohexylimidoylguanidine; pentafluorobenzimidoylguanidine; 2-N-imidoylaminothiazole; 2-N-imidoylaminooxazole; 2-N-imidoylaminoimidazole; 3-N-imidoylaminopyrazole; 3-N-imidoylamino-1,2,4-triazole; and 5-N-imidoylaminotetrazole.

N Valence Stabilizer #22: Examples of diformamidine oxides (dicarbonimidic diamides), tricarbonimidic diamides, tetracarbonimidic diamides, bis(diformamidine oxides), and poly(diformamidine oxides) (N—N bidentates, N—N tridentates, or N—N tetradentates) that meet the requirements for use as “wide band” valence stabilizers for Ce⁺⁴ include, but are not limited to: diformamidine oxide; methyldiformamidine oxide; ethyldiformamidine oxide; isopropyldiformamidine oxide; butyldiformamidine oxide; benzyldiformamidine oxide; phenyldiformamidine oxide; tolyldiformamidine oxide; naphthyldiformamidine oxide; cyclohexyldiformamidine oxide; norbornyldiformamidine oxide; adamantyldiformamidine oxide; dimethyldiformamidine oxide; diethyldiformamidine oxide; diisopropyldiformamidine oxide; dibutyldiformamidine oxide; dibenzyldiformamidine oxide; diphenyldiformamidine oxide; ditolyldiformamidine oxide; dinaphthyldiformamidine oxide; dicyclohexyldiformamidine oxide; dinorbornyldiformamidine oxide; diadamantyldiformamidine oxide; 2-O-amidinohydroxythiazole; 2-O-amidinohydroxyoxazole; 2-O-amidinohydroxyimidazole; 3-O-amidinohydroxypyrazole; 3-O-amidinohydroxy-1,2,4-triazole; and 5-O-amidinohydroxytetrazole.

N Valence Stabilizer #23: Examples of diformamidine sulfides (thiodicarbonimidic diamides), thiotricarbonimidic diamides, thiotetracarbonimidic diamides, bis(diformamidine sulfides), and poly(diformamidine sulfides) (N—N bidentates, N—N tridentates, or N—N tetradentates) that meet the requirements for use as “wide band” valence stabilizers for Ce⁺⁴ include, but are not limited to: diformamidine sulfide; methyldiformamidine sulfide; ethyldiformamidine sulfide; isopropyldiformamidine sulfide; butyldiformamidine sulfide; benzyldiformamidine sulfide; phenyldiformamidine sulfide; tolyldiformamidine sulfide; naphthyldiformamidine sulfide; cyclohexyldiformamidine sulfide; norbornyldiformamidine sulfide; adamantyldiformamidine sulfide; dimethyldiformamidine sulfide; diethyldiformamidine sulfide; diisopropyldiformamidine sulfide; dibutyldiformamidine sulfide; dibenzyldiformamidine sulfide; diphenyldiformamidine sulfide; ditolyldiformamidine sulfide; dinaphthyldiformamidine sulfide; dicyclohexyldiformamidine sulfide; dinorbornyldiformamidine sulfide; diadamantyldiformamidine sulfide; phenylthiobisformamidine; 2-S-amidinomercaptothiazole; 2-S-amidinomercaptooxazole; 2-S-amidinomercaptoimidazole; 3-S-amidinomercaptopyrazole; 3-S-amidinomercapto-1,2,4-triazole; and 5-S-amidinomercaptotetrazole.

N Valence Stabilizer #24: Examples of imidodicarbonimidic acids, diimidodicarbonimidic acids, imidotricarbonimidic acids, imidotetracarbonimidic acids, and derivatives thereof (N—N Bidentates, N—N Tridentates, N—N Tetradentates, and N—N Hexadentates) that meet the requirements for use as “wide band” valence stabilizers for Ce⁺⁴ include, but are not limited to: imidodicarbonimidic acid, diimidodicarbonimidic acid, imidotricarbonimidic acid, imidotetracarbonimidic acid; O-methylimidodicarbonimidic acid; O-ethylimidodicarbonimidic acid; O-isopropylimidodicarbonimidic acid; O-phenylimidodicarbonimidic acid; O-benzylimidodicarbonimidic acid; O-cyclohexylimidodicarbonimidic acid; O-naphthylimidodicarbonimidic acid; O-norbornylimidodicarbonimidic acid; O-adamantylimidodicarbonimidic acid; O,O′-dimethylimidodicarbonimidic acid; O,O′-diethylimidodicarbonimidic acid; O,O′-diisopropylimidodicarbonimidic acid; O,O′-diphenylimidodicarbonimidic acid; O,O′-dibenzylimidodicarbonimidic acid; O,O′-dicyclohexylimidodicarbonimidic acid; O,O′-dinaphthylimidodicarbonimidic acid; O,O′-dinorbornylimidodicarbonimidic acid; and O,O′-diadamantylimidodicarbonimidic acid.

N Valence Stabilizer #25: Examples of thioimidodicarbonimidic acids, thiodiimidodicarbonimidic acids, thioimidotricarbonimidic acids, thioimidotetracarbonimidic acids, and derivatives thereof (N—N Bidentates, N—N Tridentates, N—N Tetradentates, and N—N Hexadentates) that meet the requirements for use as “wide band” valence stabilizers for Ce⁺⁴ include, but are not limited to: thioimidodicarbonimidic acid, thiodiimidodicarbonimidic acid, thioimidotricarbonimidic acid, thioimidotetracarbonimidic acid; O-methylthioimidodicarbonimidic acid; O-ethylthioimidodicarbonimidic acid; O-isopropylthioimidodicarbonimidic acid; O-phenylthioimidodicarbonimidic acid; O-benzylthioimidodicarbonimidic acid; O-cyclohexylthioimidodicarbonimidic acid; O-naphthylthioimidodicarbonimidic acid; O-norbornylthioimidodicarbonimidic acid; O-adamantylthioimidodicarbonimidic acid; O,O′-dimethylthioimidodicarbonimidic acid; O,O′-diethylthioimidodicarbonimidic acid; O,O′-diisopropylthioimidodicarbonimidic acid; O,O′-diphenylthioimidodicarbonimidic acid; O,O′-dibenzylthioimidodicarbonimidic acid; O,O′-dicyclohexylthioimidodicarbonimidic acid; O,O′-dinaphthylthioimidodicarbonimidic acid; O,O′-dinorbornylthioimidodicarbonimidic acid; and O,O′-diadamantylthioimidodicarbonimidic acid.

N Valence Stabilizer #26: Examples of diimidoylimines, diimidoylhydrazides, bis(diimidoylimines), bis(diimidoylhydrazides), poly(diimidoylimines), and poly(diimidoylhydrazides) (N—N Tridentates and N—N Hexadentates) that meet the requirements for use as “wide band” valence stabilizers for Ce⁺⁴ include, but are not limited to: diacetimidoylimine; dibenzimidoylimine; and dicyclohexylimidoylimine.

N Valence Stabilizer #27: Examples of imidosulfamides, diimidosulfamides, bis(imidosulfamides), bis(diimidosulfamides), poly(imidosulfamides), and poly(diimidosulfamides) (N—N Bidentates, N—N Tridentates, N—N Tetradentates, and N—N Hexadentates) that meet the requirements for use as “wide band” valence stabilizers for Ce⁺⁴ include, but are not limited to: imidosulfamidic acid, diimidosulfamidic acid; O-phenylimidosulfamide; O-benzylimidosulfamide; N-phenylimidosulfamide; N-benzylimidosulfamide; O-phenyldiimidosulfamide; O-benzyldiimidosulfamide; N-phenyldiimidosulfamide; and N-benzyldiimidosulfamide.

N Valence Stabilizer #28: Examples of phosphoramidimidic triamides, bis(phosphoramidimidic triamides), and poly(phosphoramidimidic triamides) and derivatives thereof (N—N Bidentates, N—N Tridentates, N—N Tetradentates, and N—N Hexadentates) that meet the requirements for use as “wide band” valence stabilizers for Ce⁺⁴ include, but are not limited to: phosphoramidimidic triamide; N-phenylphosphoramidimidic triamide; N-benzylphosphoramidimidic triamide; N-naphthylphosphoramidimidic triamide; N-cyclohexylphosphoramidimidic triamide; N-norbornylphosphoramidimidic triamide; N,N′-diphenylphosphoramidimidic triamide; N,N′-dibenzylphosphoramidimidic triamide; N,N′-dinaphthylphosphoramidimidic triamide; N,N′-dicyclohexylphosphoramidimidic triamide; and N,N′-dinorbornylphosphoramidimidic triamide.

N Valence Stabilizer #29: Examples of phosphoramidimidic acid, phosphorodiamidimidic acid, bis(phosphoramidimidic acid), bis(phosphorodiamidimidic acid), poly(phosphoramidimidic acid), poly(phosphorodiamidimidic acid), and derivatives thereof (N—N Bidentates, N—N Tridentates, N—N Tetradentates, and N—N Hexadentates) that meet the requirements for use as “wide band” valence stabilizers for Ce⁺⁴ include, but are not limited to: phosphoramidimidic acid, phosphorodiamidimidic acid, O-phenylphosphoramidimidic acid; O-benzylphosphoramidimidic acid; O-naphthylphosphoramidimidic acid; O-cyclohexylphosphoramidimidic acid; O-norbornylphosphoramidimidic acid; O,O′-diphenylphosphoramidimidic acid; O,O′-dibenzylphosphoramidimidic acid; O,O′-dinaphthylphosphoramidimidic acid; O,O′-dicyclohexylphosphoramidimidic acid; and O,O′-dinorbornylphosphoramidimidic acid.

N Valence Stabilizer #30: Examples of phosphoramidimidodithioic acid, phosphorodiamidimidothioic acid, bis(phosphoramidimidodithioic acid), bis(phosphorodiamidimidothioic acid), poly(phosphoramidimidodithioic acid), poly(phosphorodiamidimidothioic acid), and derivatives thereof (N—N Bidentates, N—N Tridentates, N—N Tetradentates, and N—N Hexadentates) that meet the requirements for use as “wide band” valence stabilizers for Ce⁺⁴ include, but are not limited to: phosphoramidimidodithioic acid, phosphorodiamidimidothioic acid, S-phenylphosphoramidimidodithioic acid; S-benzylphosphoramidimidodithoic acid; S-naphthylphosphoramidimidodithioic acid; S-cyclohexylphosphoramidimidodithioic acid; S-norbornylphosphoramidimidodithioic acid; S,S′-diphenylphosphoramidimidodithioic acid; S,S′-dibenzylphosphoramidimidodithioic acid; S,S′-dinaphthylphosphoramidimidodithioic acid; S,S′-dicyclohexylphosphoramidimidodithioic acid; and S,S′-dinorbornylphosphoramidimidodithioic acid.

N Valence Stabilizer #31: Examples of azo compounds with amino, imino, oximo, diazeno, or hydrazido substitution at the ortho- (for aryl) or alpha- or beta- (for alkyl) positions, bis[o-(H₂N—) or alpha- or beta-(H₂N—)azo compounds], or poly[o-(H₂N—) or alpha- or beta-(H₂N—)azo compounds) (N—N Bidentates, N—N Tridentates, N—N Tetradentates, or N—N Hexadentates) that meet the requirements for use as “wide band” valence stabilizers for Ce⁺⁴ include, but are not limited to: o-aminoazobenzene; o,o′-diaminoazobenzene; (2-pyridine)azobenzene; 1-phenylazo-2-naphthylamine; pyridineazo-2-naphthol (PAN); pyridineazoresorcinol (PAR); o-hydroxy-o′-(beta-aminoethylamino)azobenzene; Benzopurpurin 4B; Congo Red; Fat Brown RR; benzopurpurin; Congo Red; Direct Red 75; Mordant Brown 48; Nitro Red; 2-imidazolylazobenzene; 2-benzimidazolylazobenzene; 3-pyrazolylazobenzene; 3-(1,2,4-triazolyl)azobenzene; 2-pyridylazobenzene; 2-pyrazinylazobenzene; and 2-pyrimidinylazobenzene.

N Valence Stabilizer #32: Examples of diazeneformimidamides (diazeneamidines), diazeneacetimidamides (diazene-alpha-amidinoalkanes(alkenes)), bis(diazeneformimidamides), bis(diazeneacetimidamides), poly(diazeneformimidamides), and poly(diazeneacetimidamides) (N—N Bidentates, N—N Tetradentates, and N—N Hexadentates) that meet the requirements for use as “wide band” valence stabilizers for Ce⁺⁴ include, but are not limited to: diazeneformimidamide (diazeneamidine); diazeneacetimidamide (diazene-alpha-amidinomethane); phenyldiazeneformimidamide; triphenyldiazeneformimidamide; phenyldiazeneacetimidamide; and triphenyldiazeneacetimidamide.

N Valence Stabilizer #33: Examples of diazeneformimidic acid, diazeneacetimidic acid, bis(diazeneformimidic acid), bis(diazeneacetimidic acid), poly(diazeneformimidic acid), poly(diazeneacetimidic acid), and derivatives thereof (N—N Bidentates, N—N Tetradentates, and N—N Hexadentates) that meet the requirements for use as “wide band” valence stabilizers for Ce⁺⁴ include, but are not limited to: diazeneformimidic acid, diazeneacetimidic acid, phenyldiazeneformimidic acid, diphenyldiazeneformimidic acid, phenyldiazeneacetimidic acid, and diphenyldiazeneacetimidic acid.

N Valence Stabilizer #34: Examples of diazeneformimidothioic acid, diazeneacetimidothioic acid, bis(diazeneformimidothioic acid), bis(diazeneacetimidothioic acid), poly(diazeneformimidothioic acid), poly(diazeneacetimidothioic acid), and derivatives thereof (N—N Bidentates, N—N Tetradentates, and N—N Hexadentates) that meet the requirements for use as “wide band” valence stabilizers for Ce⁺⁴ include, but are not limited to: diazeneformimidothioic acid, diazeneacetimidothioic acid, phenyldiazeneformimidothioic acid, diphenyldiazeneformimidothioic acid, phenyldiazeneacetimidothioic acid, and diphenyldiazeneacetimidothioic acid.

N Valence Stabilizer #35: Examples of imidoyldiazenes, bis(imidoyldiazenes), and poly(imidoyldiazenes), (N—N Tridentates and N—N Hexadentates) that meet the requirements for use as “wide band” valence stabilizers for Ce⁺⁴ include, but are not limited to: acetimidoyldiazene; benzimidoyldiazene; and cyclohexylimidoyldiazene.

N Valence Stabilizer #36: Examples of diazenediformimidamides (1,2-diazenediamidines), diazenediacetimidamides (1,2-diazene-di-alpha-amidinoalkanes(alkenes)), bis(diazenediformimidamides), bis(diazenediacetimidamides), poly(diazenediformimidamides), and poly(diazenediacetimidamides) (N—N Tridentates and N—N Hexadentates) that meet the requirements for use as “wide band” valence stabilizers for Ce⁺⁴ include, but are not limited to: diazenediformimidamide (1,2-diazenediamidine), diazenediacetimidamide (1,2-diazene-di-alpha-amidinomethane); diphenyldiazenediformimidamide; tetraphenyldiazenediformimidamide; diphenyldiazenediacetimidamide; and tetraphenyldiazenediacetimidamide.

N Valence Stabilizer #37: Examples of diazenediformimidic acid, diazenediacetimidic acid, bis(diazenediformimidic acid), bis(diazenediacetimidic acid), poly(diazenediformimidic acid), and poly(diazenediacetimidic acid), and derivatives thereof (N—N Tridentates and N—N Hexadentates) that meet the requirements for use as “wide band” valence stabilizers for Ce⁺⁴ include, but are not limited to: diazenediformimidic acid, diazenediacetimidic acid, diphenyldiazenediformimidic acid, and diphenyldiazenediacetimidic acid.

N Valence Stabilizer #38: Examples of diazenediformimidothioic acid, diazenediacetimidothioic acid, bis(diazenediformimidothioic acid), bis(diazenediacetimidothioic acid), poly(diazenediformimidothioic acid), and poly(diazenediacetimidothioic acid), and derivatives thereof (N—N Tridentates and N—N Hexadentates) that meet the requirements for use as “wide band” valence stabilizers for Ce⁺⁴ include, but are not limited to: diazenediformimidothioic acid, diazenediacetimidothioic acid, diphenyldiazenediformimidothioic acid, and diphenyldiazenediacetimidothioic acid.

N Valence Stabilizer #39: Examples of diimidoyldiazenes, bis(diimidoyldiazenes), and poly(diimidoyldiazenes), (N—N Tridentates and N—N Hexadentates) that meet the requirements for use as “wide band” valence stabilizers for Ce⁺⁴ include, but are not limited to: diacetimidoyldiazene; dibenzimidoyldiazene; and dicyclohexylimidoyldiazene.

N Valence Stabilizer #40: Examples of ortho-amino (or -hydrazido) substituted formazans, bis(o-amino or -hydrazido substituted formazans), and poly(o-amino or -hydrazido substituted formazans) (N—N Bidentates, N—N Tridentates, N—N Tetradentates, and N—N Hexadentates) that meet the requirements for use as “wide band” valence stabilizers for Ce⁺⁴ include, but are not limited to: 1-(2-aminophenyl)-3,5-diphenylformazan; and 1,5-bis(2-aminophenyl)-3-phenylformazan.

N Valence Stabilizer #41: Examples of ortho-amino (or -hydrazido) substituted azines (including ketazines), bis(o-amino or hydrazido substituted azines), and poly(o-amino or hydrazido substituted azines) (N—N Bidentates, N—N Tridentates, N—N Tetradentates, and N—N Hexadentates) that meet the requirements for use as “wide band” valence stabilizers for Ce⁺⁴ include, but are not limited to: 2-amino-1-benzalazine; 2-amino-1-naphthalazine; and 2-amino-1-cyclohexanonazine.

N Valence Stabilizer #42: Examples of Schiff Bases with one Imine (C═N) Group and with ortho- or alpha- or beta-amino or imino or oximo or diazeno or hydrazido substitution (N—N Bidentates, N—N Tridentates, N—N Tetradentates, N—N Pentadentates, or N—N Hexadentates) that meet the requirements for use as “wide band” valence stabilizers for Ce⁺⁴ include, but are not limited to: N-(2-Aminobenzaldehydo)isopropylamine; N-(2-Pyridinecarboxaldehydo)isopropylamine; N-(2-Pyrrolecarboxaldehydo)isopropylamine; N-(2-Acetylpyridino)isopropylamine; N-(2-Acetylpyrrolo)isopropylamine; N-(2-Aminoacetophenono)isopropylamine; N-(2-Aminobenzaldehydo)cyclohexylamine; N-(2-Pyridinecarboxaldehydo)cyclohexylamine; N-(2-Pyrrolecarboxaldehydo)cyclohexylamine; N-(2-Acetylpyridino)cyclohexylamine; N-(2-Acetylpyrrolo)cyclohexylamine; N-(2-Aminoacetophenono)cyclohexylamine; N-(2-Aminobenzaldehydo)aniline; N-(2-Pyridinecarboxaldehydo)aniline; N-(2-Pyrrolecarboxaldehydo)aniline; N-(2-Acetylpyridino)aniline; N-(2-Acetylpyrrolo)aniline; N-(2-Aminoacetophenono)aniline; N-(2-Aminobenzaldehydo)aminonorbornane; N-(2-Pyridinecarboxaldehydo)aminonorbornane; N-(2-Pyrrolecarboxaldehydo)aminonorbornane; N-(2-Acetylpyridino)aminonorbornane; N-(2-Acetylpyrrolo)aminonorbornane; N-(2-Aminoacetophenono)aminonorbornane; 2-pyrrolecarboxaldehyde phenylhydrazone; 2-pyrrolecarboxaldehyde 2-pyridyl hydrazone; 2-aminobenzaldehyde phenylhydrazone (nitrin); and 2-aminobenzaldehyde 2-pyridyl hydrazone. Also includes hydrazones with ortho-N substitution.

N Valence Stabilizer #43: Examples of Schiff Bases with two Imine (C═N) Groups and without ortho- (for aryl constituents) or alpha- or beta- (for alkyl constituents) hydroxy, carboxy, carbonyl, thiol, mercapto, thiocarbonyl, amino, imino, oximo, diazeno, or hydrazido substitution (N—N Bidentates) that meet the requirements for use as “wide band” valence stabilizers for Ce⁺⁴ include, but are not limited to: N,N′-(Glyoxalo)diisopropylamine; N,N′-(Glyoxalo)dicyclohexylamine; N,N′-(Glyoxalo)dianiline; N,N′-(Glyoxalo)di-aminonorbornane; N,N′-(Malondialdehydo)diisopropylamine; N,N′-(Malondialdehydo)dicyclohexylamine; N,N′-(Malondialdehydo)dianiline; N,N′-(Malondialdehydo)di-aminonorbornane; N,N′-(Phthalicdialdehydo)diisopropylamine; N,N′-(Phthalicdialdehydo)dicyclohexylamine; N,N′-(Phthalicdialdehydo)dianiline; N,N′-(Phthalicdialdehydo)di-aminonorbornane; N,N′-(Formylcamphoro)diisopropylamine; N,N′-(Formylcamphoro)dicyclohexylamine; N,N′-(Formylcamphoro)dianiline; N,N′-(Formylcamphoro)di-aminonorbornane; N,N′-(Acetylacetonato)diisopropylamine; N,N′-(Acetylacetonato)dicyclohexylamine; N,N′-(Acetylacetonato)dianiline; N,N′-(Acetylacetonato)di-aminonorbornane; N,N′-(Diacetylbenzeno)diisopropylamine; N,N′-(Diacetylbenzeno)dicyclohexylamine; N,N′-(Diacetylbenzeno)dianiline; N,N′-(Diacetylbenzeno)di-aminonorbornane; N,N′-(1,2-Cyclohexanono)diisopropylamine; N,N′-(1,2-Cyclohexanono)dicyclohexylamine; N,N′-(1,2-Cyclohexanono)dianiline; N,N′-(1,2-Cyclohexanono)di-aminonorbornane; N,N′-(Camphorquinono)diisopropylamine; N,N′-(Camphorquinono)dicyclohexylamine; N,N′-(Camphorquinono)dianiline; N,N′-(Camphorquinono)di-aminonorbornane; N,N′-(Benzaldehydo)ethylenediamine; N,N′-(Naphthaldehydo)ethylenediamine; N,N′-(Acetophenono)ethylenediamine; N,N′-(Benzaldehydo)trimethylenediamine; N,N′-(Naphthaldehydo)trimethylenediamine; N,N′-(Acetophenono)trimethylenediamine; N,N′-(Benzaldehydo)cyclohexane-1,2-diamine; N,N′-(Naphthaldehydo)cyclohexane-1,2-diamine; N,N′-(Acetophenono)cyclohexane-1,2-diamine; N,N′-(Benzaldehydo)-1,2-diaminobenzene; N,N′-(Naphthaldehydo)-1,2-diaminobenzene; N,N′-(Acetophenono)-1,2-diaminobenzene; N,N′-(Acetylacetonato)ethylenediamine; N,N′-(Acetylacetonato)-1,2-cyclohexylenediamine; N,N′-(Acetylacetonato)-1,2-propylenediamine; N,N′-(Glyoxalo)-o-phenylenediamine; and N,N′-(Glyoxalo)ethylenediamine. Also includes dihydrazones.

N Valence Stabilizer #44: Examples of Schiff Bases with two Imine (C═N) Groups and with ortho- or alpha- or beta-amino or imino or oximo or diazeno or hydrazido substitution (N—N Bidentates, N—N Tridentates, N—N Tetradentates, N—N Pentadentates, or N—N Hexadentates) that meet the requirements for use as “wide band” valence stabilizers for Ce⁺⁴ include, but are not limited to: N,N′-(2,6-Pyridinedicarboxaldehydo)diisopropylamine; N,N′-(2,6-Pyridinedicarboxaldehydo)dicyclohexylamine; N,N′-(2,6-Pyridinedicarboxaldehydo)dianiline; N,N′-(2,6-Pyridinedicarboxaldehydo)di-aminonorbornane; N,N′-(2,5-Pyrroledicarboxaldehydo)diisopropylamine; N,N′-(2,5-Pyrroledicarboxaldehydo)dicyclohexylamine; N,N′-(2,5-Pyrroledicarboxaldehydo)dianiline; N,N′-(2,5-Pyrroledicarboxaldehydo)di-aminonorbornane; N,N′-(o-Aminophthalicdialdehydo)diisopropylamine; N,N′-(o-Aminophthalicdialdehydo)dicyclohexylamine; N,N′-(o-Aminophthalicdialdehydo)dianiline; N,N′-(o-Aminophthalicdialdehydo)di-aminonorbornane; N,N′-(o-Aminoformylcamphoro)diisopropylamine; N,N′-(o-Aminoformylcamphoro)dicyclohexylamine; N,N′-(o-Aminoformylcamphoro)dianiline; N,N′-(o-Aminoformylcamphoro)di-aminonorbornane; N,N′-(2,6-Diacetylpyridino)diisopropylamine; N,N′-(2,6-Diacetylpyridino)dicyclohexylamine; N,N′-(2,6-Diacetylpyridino)dianiline; N,N′-(2,6-Diacetylpyridino)di-aminonorbornane; N,N′-(o-Aminodiacetylbenzeno)diisopropylamine; N,N′-(o-Aminodiacetylbenzeno)dicyclohexylamine; N,N′-(o-Aminodiacetylbenzeno)dianiline; N,N′-(o-Aminodiacetylbenzeno)di-aminonorbornane; N,N′-(3,6-Diamino-1,2-cyclohexanono)diisopropylamine; N,N′-(3,6-Diamino-1,2-cyclohexanono)dicyclohexylamine; N,N′-(3,6-Diamino-1,2-cyclohexanono)dianiline; N,N′-(3,6-Diamino-1,2-cyclohexanono)di-aminonorbornane; N,N′-(2,5-Diacetylpyrrolo)diisopropylamine; N,N′-(2,5-Diacetylpyrrolo)dicyclohexylamine; N,N′-(2,5-Diacetylpyrrolo)dianiline; N,N′-(2,5-Diacetylpyrrolo)di-aminonorbornane; N,N′-(o-Aminobenzaldehydo)ethylenediamine; N,N′-(o-Aminonaphthaldehydo)ethylenediamine; N,N′-(o-Aminoacetophenono)ethylenediamine; N,N′-(o-Aminobenzaldehydo)trimethylenediamine; N,N′-(o-Aminonaphthaldehydo)trimethylenediamine; N,N′-(o-Aminoacetophenono)trimethylenediamine; N,N′-(o-Aminobenzaldehydo)cyclohexane-1,2-diamine; N,N′-(o-Aminonaphthaldehydo)cyclohexane-1,2-diamine; N,N′-(o-Aminoacetophenono)cyclohexane-1,2-diamine; N,N′-(o-Aminobenzaldehydo)-1,2-diaminobenzene; N,N′-(o-Aminonaphthaldehydo)-1,2-diaminobenzene; and N,N′-(o-Aminoacetophenono)-1,2-diaminobenzene. Also includes hydrazones with ortho-N substitution.

N Valence Stabilizer #45: Examples of Schiff Bases with three Imine (C═N) Groups and without ortho- (for aryl constituents) or alpha- or beta- (for alkyl constituents) hydroxy, carboxy, carbonyl, thiol, mercapto, thiocarbonyl, amino, imino, oximo, diazeno, or hydrazido substitution (N—N Tridentates) that meet the requirements for use as “wide band” valence stabilizers for Ce⁺⁴ include, but are not limited to: N,N′,N″-(Benzaldehydo)tris(2-aminoethyl)amine; N,N′,N″-(Naphthaldehydo)tris(2-aminoethyl)amine; and N,N′,N″-(Acetophenono)tris(2-aminoethyl)amine. Also includes trihydrazones.

N Valence Stabilizer #46: Examples of Schiff Bases with three Imine (C═N) Groups and with ortho- or alpha- or beta-amino or imino or oximo or diazeno or hydrazido substitution (N—N Tridentates, N—N Tetradentates, N—N Pentadentates, or N—N Hexadentates) that meet the requirements for use as “wide band” valence stabilizers for Ce⁺⁴ include, but are not limited to: N,N′,N″-(o-Aminobenzaldehydo)tris(2-aminoethyl)amine; N,N′,N″-(o-Aminonaphthaldehydo)tris(2-aminoethyl)amine; and N,N′,N″-(o-Aminoacetophenono)tris(2-aminoethyl)amine.

S Valence Stabilizer #1: Examples of macrocyclic, macrobicyclic, and macropolycyclic oligothioketones (including catapinands, cryptands, cyclidenes, and sepulchrates) wherein all binding sites are composed of thioketones (especially in the beta position) (S—S Bidentates, S—S Tetradentates, and S—S Hexadentates) that meet the requirements for use as “wide band” valence stabilizers for Ce⁺⁴ include, but are not limited to: hexathioketocyclotetracosane ([24]ane(═S)₆); hexathioketocycloheneicosane ([21]ane(═S)₆); hexathioketocyclooctadecane ([18]ane(═S)₆); hexathioketocyclopentadecane ([15]ane(═S)₆); tetrathioketocycloeicosane ([20]ane(═S)₄); tetrathioketocyclooctadecane ([18]ane(═S)₄); tetrathioketocyclohexadecane ([16]ane(═S)₄); tetrathioketocyclotetradecane ([14]ane(═S)₄); tetrathioketocyclododecane ([12]ane(═S)₄); dithioketocyclohexadecane ([16]ane(═S)₂); dithioketocyclotetraadecane ([14]ane(═S)₂); dithioketocyclododecane ([12]ane(═S)₂); dithioketocyclodecane ([10]ane(═S)₂); and dithioketocyclooctane ([8]ane(═S)₂).

S Valence Stabilizer #2: Examples of macrocyclic, macrobicyclic, and macropolycyclic dithiolenes (including catapinands, cryptands, cyclidenes, and sepulchrates) wherein all binding sites are composed of alpha-, alpha-dithiolenes (meaning two thiol groups on a single carbon atom in the ring) (S—S Bidentates, S—S Tetradentates, and S—S Hexadentates) that meet the requirements for use as “wide band” valence stabilizers for Ce⁺⁴ include, but are not limited to: hexathiolocyclotetracosane ([24]ane(—SH)₆); hexathiolocycloheneicosane ([21]ane(—SH)₆); hexathiolocyclooctadecane ([18]ane(—SH)₆); hexathiolocyclopentadecane ([15]ane(—SH)₆); tetrathiolocycloeicosane ([20]ane(—SH)₄); tetrathiolocyclooctadecane ([18]ane(—SH)₄); tetrathiolocyclohexadecane ([16]ane(—SH)₄); tetrathiolocyclotetradecane ([14]ane(—SH)₄); tetrathiolocyclododecane ([12]ane(—SH)₄); dithiolocyclohexadecane ([16]ane(—SH)₂); dithiolocyclotetraadecane ([14]ane(—SH)₂); dithiolocyclododecane ([12]ane(—SH)₂); dithiolocyclodecane ([10]ane(—SH)₂); and dithiolocyclooctane ([8]ane(—SH)₂).

S Valence Stabilizer #3: Examples of dithioimidodialdehydes, dithiohydrazidodialdehydes (thioacyl thiohydrazides), bis(dithioimidodialdehydes), bis(dithiohydrazidodialdehydes), poly(dithioimidodialdehydes), and poly(dithiohydrazidodialdehydes) (S—S Bidentates, S—S Tridentates, S—S Tetradentates) that meet the requirements for use as “wide band” valence stabilizers for Ce⁺⁴ include, but are not limited to: dithiodiacetamide, dithiodipropanamide, dithiodibutanamide, dithiodibenzamide, and dithiodicyclohexamide.

S Valence Stabilizer #4: Examples of dithioimidodicarbonic acids, dithiohydrazidodicarbonic acids, bis(dithioimidodicarbonic acids), bis(dithiohydrazidodicarbonic acids), poly(dithioimidodicarbonic acids), poly(dithiohydrazidodicarbonic acids) and derivatives thereof (S—S Bidentates, S—S Tridentates, S—S Tetradentates) that meet the requirements for use as “wide band” valence stabilizers for Ce⁺⁴ include, but are not limited to: dithioimidodicarbonic acid, dithiohydrazidodicarbonic acid, O-phenyldithioimidodicarbonic acid, O-benzyldithioimidodicarbonic acid, O-cyclohexyldithioimidodicarbonic acid, O-norbornyldithioimidodicarbonic acid, O,O′-diphenyldithioimidodicarbonic acid, O,O′-dibenzyldithioimidodicarbonic acid, O,O′-dicyclohexyldithioimidodicarbonic acid, and O,O′-norbornyldithioimidodicarbonic acid.

S Valence Stabilizer #5: Examples of 1,3-dithioketones (dithio-beta-ketonates), 1,3,5-trithioketones, bis(1,3-dithioketones), and poly(1,3-dithioketones) (S—S Bidentates, S—S Tridentates, S—S Tetradentates) that meet the requirements for use as “wide band” valence stabilizers for Ce⁺⁴ include, but are not limited to: hexafluoropentanedithione; 1,3-diphenyl-1,3-propanedithione; thiobenzoylthiopinacolone; dithiocyclohexoylmethane; diphenylpentanetrithionate; tetramethylnonanetrithionate; hexafluoroheptanetrithionate; trifluoroheptanetrithionate; 1-(2-thienyl)-1,3-butanedithione, 1-(2-naphthyl)-1,3-butanedithione, trifluorothioacetylthiocamphor; and 1,3-indandithione.

S Valence Stabilizer #6: Examples of 1,2-dithioketones (dithiolenes, dithio-alpha-ketonates), 1,2,3-trithioketones, dithiotropolonates, o-dithioquinones, bis(1,2-dithioketones), and poly(1,2-dithioketones) (S—S Bidentates, S—S Tridentates, S—S Tetradentates) that meet the requirements for use as “wide band” valence stabilizers for Ce⁺⁴ include, but are not limited to: dithiotropolone; 1,2-dithiobenzoquinone (o-dithioquinone)(o-benzenedithiolate)(bdt); di-tert-butyl-1,2-dithiobenzoquinone; hexafluoro-1,2-dithiobenzoquinone; 1,2-dithionaphthoquinone; 9,10-dithiophenanthroquinone; ethylenedithiolene (edt); maleonitriledithiolene (mnt); trifluoromethyldithiolene (tfd); carbomethoxydithiolene (cmt); trithionedithiolene (dmit); toluenedithiolate (tdt); dithiomanaldehyde (propenethionethiolate)(ptt); dithioacetylacetonate (SacSac); dijulolidinedithiolene; 2,3-piperazinedithiolate; di(4-aminophenyl)dithiolene; dimercaptoisotrithione (dmit); (4-octylphenyl)dithiolene; benzenetetrathiol; tetrathiosquaric acid; trithiodeltic acid; pentathiocroconic acid; dithiocroconic acid; hexathiorbodizonic acid; dithiorhodizonic acid; ethylenetetrathiol; trans-butadienetetrathiolate; tetrathiooxalic acid; 1,2-indandithione; naphthothioquinone; acenapthenethioquinone; aceanthrenethioquinone; and indole-2,3-dithione (thioisatin).

S Valence Stabilizer #7: Examples of dithiomalonamides (dithiomalonodiamides), bis(dithiomalonamides), and polydithiomalonamides (S—S Bidentates, S—S Tridentates, S—S Tetradentates) that meet the requirements for use as “wide band” valence stabilizers for Ce⁺⁴ include, but are not limited to: dithiomalonamide, N-phenyldithiomalonamide, N-benzyldithiomalonamide, N-pentafluorophenyldithiomalonamide, N-cyclohexyldithiomalonamide, N-norbornyldithiomalonamide, N,N′-diphenyldithiomalonamide, N,N′-dibenzyldithiomalonamide, N,N′-dipentafluorophenyldithiomalonamide, N,N′-dicyclohexyldithiomalonamide, and N,N′-norbornyldithiomalonamide.

S Valence Stabilizer #8: Examples of 2-thioacylthioacetamides, bis(2-thioacylthioacetamides), and poly(2-thioacylthioacetamides) (S—S Bidentates, S—S Tridentates, S—S Tetradentates) that meet the requirements for use as “wide band” valence stabilizers for Ce⁺⁴ include, but are not limited to: 2-thioacetothioacetamide, N-phenyl-2-thioacetothioacetamide, N-pentafluorophenyl-2-thioacetothioacetamide, N-benzyl-2-thioacetothioacetamide, N-cyclohexyl-2-thioacetothioacetamide, N-norbornyl-2-thioacetothioacetamide, N-phenyl-2-thiobenzothioacetamide, N-pentafluorophenyl-2-pentafluorothiobenzothioacetamide, and N-cyclohexyl-2-thiocyclohexothioacetamide.

S Valence Stabilizer #9: Examples of dithioacyl sulfides, bis(dithioacyl sulfides), and poly(dithioacyl sulfides), (S—S Bidentates, S—S Tridentates, S—S Tetradentates) that meet the requirements for use as “wide band” valence stabilizers for Ce⁺⁴ include, but are not limited to: dithioacetyl sulfide; dithiopropanoyl sulfide; dithiobenzoyl sulfide; and dithiopentafluorobenzoyl sulfide.

S Valence Stabilizer #10: Examples of trithiodicarbonic diamides, bis(trithiodicarbonic diamides), and poly(trithiodicarbonic diamides) (S—S Bidentates, S—S Tridentates, S—S Tetradentates) that meet the requirements for use as “wide band” valence stabilizers for Ce⁺⁴ include, but are not limited to: trithiodicarbonic diamide; N-phenyltrithiodicarbonic diamide; N-pentafluorophenyltrithiodicarbonic diamide; N-benzyltrithiodicarbonic diamide; N-cyclohexyltrithiodicarbonic diamide; N-norbornyltrithiodicarbonic diamide; N,N′-diphenyltrithiodicarbonic diamide; N,N′-dipentafluorophenyltrithiodicarbonic diamide; N,N′-dibenzyltrithiodicarbonic diamide; N,N′-dicyclohexyltrithiodicarbonic diamide; and N,N′-dinorbornyltrithiodicarbonic diamide.

S Valence Stabilizer #11: Examples of pentathio-, tetrathio-, or trithiodicarbonic acids, bis(pentathio-, tetrathio-, or trithiodicarbonic acids), poly(pentathio-, tetrathio-, or trithiodicarbonic acids), and derivatives thereof (S—S Bidentates, S—S Tridentates, S—S Tetradentates) that meet the requirements for use as “wide band” valence stabilizers for Ce⁺⁴ include, but are not limited to: pentathiodicarbonic acid, tetrathiodicarbonic acid, trithiodicarbonic acid, O-phenyltrithiodicarbonic acid, O-benzyltrithiodicarbonic acid, O-cyclohexyltrithiodicarbonic acid, O-norbornyltrithiodicarbonic acid, O,O′-diphenyltrithiodicarbonic acid, O,O′-dibenzyltrithiodicarbonic acid, O,O′-dicyclohexyltrithiodicarbonic acid, and O,O′-dinorbornyltrithiodicarbonic acid.

S Valence Stabilizer #12: Examples of dithiohypophosphoric acids, bis(dithiohypophosphoric acids), poly(dithiohypophosphoric acids), and derivatives thereof (S—S Bidentates, S—S Tridentates, S—S Tetradentates) that meet the requirements for use as “wide band” valence stabilizers for Ce⁺⁴ include, but are not limited to: dithiohypophosphoric acid, methyldithiohypophosphoric acid, isopropyldithiohypophosphoric acid, tert-butyldithiohypophosphoric acid, phenyldithiohypophosphoric acid, pentafluorophenyldithiohypophosphoric acid, benzyldithiohypophosphoric acid, cyclohexyldithiohypophosphoric acid, norbornyldithiohypophosphoric acid, dimethyldithiohypophosphoric acid, diisopropyldiothiohypophosphoric acid, di-tert-butyldithiohypophosphoric acid, diphenyldithiohypophosphoric acid, di-pentafluorophenyldithiohypophosphoric acid, dibenzyldithiohypophosphoric acid, dicyclohexyldithiohypophosphoric acid, and dinorbornyldithiohypophosphoric acid.

S Valence Stabilizer #13: Examples of dithiohypophosphoramides, bis(dithiohypophosphoramides), and poly(dithiohypophosphoramides) (S—S Bidentates, S—S Tridentates, S—S Tetradentates) that meet the requirements for use as “wide band” valence stabilizers for Ce⁺⁴ include, but are not limited to: dithiohypophosphoramide, N-methyldithiohypophosphoramide, N-isopropyldithiohypophosphoramide, N-tert-butyldithiohypophosphoramide, N-phenyldithiohypophosphoramide, N-pentafluorophenyldithiohypophosphoramide, N-benzyldithiohypophosphoramide, N-cyclohexyldithiohypophosphoramide, N-norbornyldithiohypophosphoramide, N,N′″-dimethyldithiohypophosphoramide, N,N′″-diisopropyldithiohypophosphoramide, N,N′″-di-tert-butyldithiohypophosphoramide, N,N′″-diphenyldithiohypophosphoramide, N,N′″-di-pentafluorophenyldithiohypophosphoramide, N,N′″-dibenzyldithiohypophosphoramide, N,N′″-dicyclohexyldithiohypophosphoramide, and N,N′″-dinorbornyldithiohypophosphoramide.

S Valence Stabilizer #14: Examples of dithioimidodiphosphoric acids, dithiohydrazidodiphosphoric acids, bis(dithioimidodiphosphoric acids), bis(dithiohydrazidodiphosphoric acids), poly(dithioimidodiphosphoric acids), poly(dithiohydrazidodiphosphoric acids), and derivatives thereof (S—S Bidentates, S—S Tridentates, S—S Tetradentates) that meet the requirements for use as “wide band” valence stabilizers for Ce⁺⁴ include, but are not limited to: dithioimidodiphosphoric acid, methyldithioimidodiphosphoric acid, isopropyldithioimidodiphosphoric acid, tert-butyldithioimidodiphosphoric acid, phenyldithioimidodiphosphoric acid, pentafluorophenyldithioimidodiphosphoric acid, benzyldithioimidodiphosphoric acid, cyclohexyldithioimidodiphosphoric acid, norbornyldithioimidodiphosphoric acid, dimethyldithioimidodiphosphoric acid, diisopropyldiothioimidodiphosphoric acid, di-tert-butyldithioimidodiphosphoric acid, diphenyldithioimidodiphosphoric acid, di-pentafluorophenyldithioimidodiphosphoric acid, dibenzyldithioimidodiphosphoric acid, dicyclohexyldithioimidodiphosphoric acid, and dinorbornyldithioimidodiphosphoric acid.

S Valence Stabilizer #15: Examples of dithioimidodiphosphoramides, dithiohydrazidodiphosphoramides, bis(dithioimidodiphosphoramides), bis(dithiohydrazidodiphosphoramides), poly(dithioimidodiphosphoramides), and poly(dithiohydrazidodiphosphoramides) (S—S Bidentates, S—S Tridentates, S—S Tetradentates) that meet the requirements for use as “wide band” valence stabilizers for Ce⁺⁴ include, but are not limited to: dithioimidodiphosphoramide, N-methyldithioimidodiphosphoramide, N-isopropyldithioimidodiphosphoramide, N-tert-butyldithioimidodiphosphoramide, N-phenyldithioimidodiphosphoramide, N-pentafluorophenyldithioimidodiphosphoramide, N-benzyldithioimidodiphosphoramide, N-cyclohexyldithioimidodiphosphoramide, N-norbornyldithioimidodiphosphoramide, N,N′″-dimethyldithioimidodiphosphoramide, N,N′″-diisopropyldithioimidodiphosphoramide, N,N′″-di-tert-butyldithioimidodiphosphoramide, N,N′″-diphenyldithioimidodiphosphoramide, N,N′″-di-pentafluorophenyldithioimidodiphosphoramide, N,N′″-dibenzyldithioimidodiphosphoramide, N,N′″-dicyclohexyldithioimidodiphosphoramide, and N,N′″-dinorbornyldithioimidodiphosphoramide.

S Valence Stabilizer #16: Examples of dithiodiphosphoramides, bis(dithiodiphosphoramides), and poly(dithiodiphosphoramides) (S—S Bidentates, S—S Tridentates, S—S Tetradentates) that meet the requirements for use as “wide band” valence stabilizers for Ce⁺⁴ include, but are not limited to: dithiodiphosphoramide, N-methyldithiodiphosphoramide, N-isopropyldithiodiphosphoramide, N-tert-butyldithiodiphosphoramide, N-phenyldithiodiphosphoramide, N-pentafluorophenyldithiodiphosphoramide, N-benzyldithiodiphosphoramide, N-cyclohexyldithiodiphosphoramide, N-norbornyldithiodiphosphoramide, N,N′″-dimethyldithiodiphosphoramide, N,N′″-diisopropyldithiodiphosphoramide, N,N′″-di-tert-butyldithiodiphosphoramide, N,N′″-diphenyldithiodiphosphoramide, N,N′″-di-pentafluorophenyldithiodiphosphoramide, N,N′″-dibenzyldithiodiphosphoramide, N,N′″-dicyclohexyldithiodiphosphoramide, and N,N′″-dinorbornyldithiodiphosphoramide.

S Valence Stabilizer #17: Examples of dithiodiphosphoric acids, bis(dithiodiphosphoric acids), poly(dithiodiphosphoric acids), and derivatives thereof (S—S Bidentates, S—S Tridentates, S—S Tetradentates) that meet the requirements for use as “wide band” valence stabilizers for Ce⁺⁴ include, but are not limited to: dithiodiphosphoric acid, methyldithiodiphosphoric acid, isopropyldithiodiphosphoric acid, tert-butyldithiodiphosphoric acid, phenyldithiodiphosphoric acid, pentafluorophenyldithiodiphosphoric acid, benzyldithiodiphosphoric acid, cyclohexyldithiodiphosphoric acid, norbornyldithiodiphosphoric acid, dimethyldithiodiphosphoric acid, diisopropyldiothiodiphosphoric acid, di-tert-butyldithiodiphosphoric acid, diphenyldithiodiphosphoric acid, di-pentafluorophenyldithiodiphosphoric acid, dibenzyldithiodiphosphoric acid, dicyclohexyldithiodiphosphoric acid, and dinorbornyldithiodiphosphoric acid.

S Valence Stabilizer #18: Examples of trithiophosphoric acids (phosphorotrithioic acids), bis(trithiophosphoric acids), poly(trithiophosphoric acids), and derivatives thereof (S—S Bidentates, S—S Tridentates, S—S Tetradentates) that meet the requirements for use as “wide band” valence stabilizers for Ce⁺⁴ include, but are not limited to: trithiophosphoric acid, O-phenyltrithiophosphoric acid, O-benzyltrithiophosphoric acid, O-cyclohexyltrithiophosphoric acid, O-norbornyltrithiophosphoric acid, O,S-diphenyltrithiophosphoric acid, O,S-dibenzyltrithiophosphoric acid, O,S-dicyclohexyltrithiophosphoric acid, and O,S-dinorbornyltrithiophosphoric acid.

S Valence Stabilizer #19: Examples of dithiophosphoric acids (phosphorodithioic acids), bis(dithiophosphoric acids), poly(dithiophosphoric acids), and derivatives thereof (S—S Bidentates, S—S Tridentates, S—S Tetradentates) that meet the requirements for use as “wide band” valence stabilizers for Ce⁺⁴ include, but are not limited to: dithiophosphoric acid, O-phenyldithiophosphoric acid, O-benzyldithiophosphoric acid, O-cyclohexyldithiophosphoric acid, O-norbornyldithiophosphoric acid, O,O-diphenyldithiophosphoric acid, O,O-dibenzyldithiophosphoric acid, O,O-dicyclohexyldithiophosphoric acid, and O,O-dinorbornyldithiophosphoric acid.

S Valence Stabilizer #20: Examples of tetrathiophosphoric acids (phosphorotetrathioic acids), bis(tetrathiophosphoric acids), poly(tetrathiophosphoric acids), and derivatives thereof (S—S Bidentates, S—S Tridentates, S—S Tetradentates) that meet the requirements for use as “wide band” valence stabilizers for Ce⁺⁴ include, but are not limited to: tetrathiophosphoric acid, S-phenyltetrathiophosphoric acid, S-benzyltetrathiophosphoric acid, S-cyclohexyltetrathiophosphoric acid, S-norbornyltetrathiophosphoric acid, S,S-diphenyltetrathiophosphoric acid, S,S-dibenzyltetrathiophosphoric acid, S,S-dicyclohexyltetrathiophosphoric acid, and S,S-dinorbornyltetrathiophosphoric acid.

S Valence Stabilizer #21: Examples of phosphoro(dithioperoxo)dithioic acids, bis[phosphoro(dithioperoxo)dithioic acids], poly[phosphoro(dithioperoxo)dithioic acids], and derivatives thereof (S—S Bidentates, S—S Tridentates, S—S Tetradentates) that meet the requirements for use as “wide band” valence stabilizers for Ce⁺⁴ include, but are not limited to: phosphoro(dithioperoxo)dithioic acid, O-phenylphosphoro(dithioperoxo)dithioic acid, O-benzylphosphoro(dithioperoxo)dithioic acid, O-cyclohexylphosphoro(dithioperoxo)dithioic acid, O-norbornylphosphoro(dithioperoxo)dithioic acid, O,S-diphenylphosphoro(dithioperoxo)dithioic acid, O,S-dibenzylphosphoro(dithioperoxo)dithioic acid, O,S-dicyclohexylphosphoro(dithioperoxo)dithioic acid, and O,S-dinorbornylphosphoro(dithioperoxo)dithioic acid.

S Valence Stabilizer #22: Examples of phosphoro(dithioperoxo)thioic acids, bis[phosphoro(dithioperoxo)thioic acids], poly[phosphoro(dithioperoxo)thioic acids], and derivatives thereof (S—S Bidentates, S—S Tridentates, S—S Tetradentates) that meet the requirements for use as “wide band” valence stabilizers for Ce⁺⁴ include, but are not limited to: phosphoro(dithioperoxo)thioic acid, O-phenylphosphoro(dithioperoxo)thioic acid, O-benzylphosphoro(dithioperoxo)thioic acid, O-cyclohexylphosphoro(dithioperoxo)thioic acid, O-norbornylphosphoro(dithioperoxo)thioic acid, O,S-diphenylphosphoro(dithioperoxo)thioic acid, O,S-dibenzylphosphoro(dithioperoxo)thioic acid, O,S-dicyclohexylphosphoro(dithioperoxo)thioic acid, and O,S-dinorbornylphosphoro(dithioperoxo)thioic acid.

S Valence Stabilizer #23: Examples of phosphoro(dithioperoxo)trithioic acids, bis[phosphoro(dithioperoxo)trithioic acids], poly[phosphoro(dithioperoxo)trithioic acids], and derivatives thereof (S—S Bidentates, S—S Tridentates, S—S Tetradentates) that meet the requirements for use as “wide band” valence stabilizers for Ce⁺⁴ include, but are not limited to: phosphoro(dithioperoxo)trithioic acid, O-phenylphosphoro(dithioperoxo)trithioic acid, O-benzylphosphoro(dithioperoxo)trithioic acid, O-cyclohexylphosphoro(dithioperoxo)trithioic acid, O-norbornylphosphoro(dithioperoxo)trithioic acid, O,S-diphenylphosphoro(dithioperoxo)trithioic acid, O,S-dibenzylphosphoro(dithioperoxo)trithioic acid, O,S-dicyclohexylphosphoro(dithioperoxo)trithioic acid, and O,S-dinorbornylphosphoro(dithioperoxo)trithioic acid.

S Valence Stabilizer #24: Examples of beta-mercaptothioketones, beta-mercaptothioaldehydes, bis(beta-mercaptothioketones), bis(beta-mercaptothioaldehydes), poly(beta-mercaptothioketones), and poly(beta-mercaptothioaldehydes) (S—S Bidentates, S—S Tridentates, S—S Tetradentates) that meet the requirements for use as “wide band” valence stabilizers for Ce⁺⁴ include, but are not limited to: 4-mercaptopentan-2-thione; 1,3-diphenyl-3-mercaptopropanethioaldehyde; 1,3-dibenzyl-3-mercaptopropanethioaldehyde; 1,3-dicyclohexyl-3-mercaptopropanethioaldehyde; 1,3-dinorbornyl-3-mercaptopropanethioaldehyde; 1,3-di(2-thienyl)-3-mercaptopropanethioaldehyde; 1,3-di(2-furyl)-3-mercaptopropanethioaldehyde; o-mercaptothioacetophenone; 5-mercapto-1,4-dithionaphthoquinone; 1-mercaptothioacridone; 1-mercaptodithioanthraquinone; 1,8-dimercaptodithioanthraquinone; and beta-mercaptothiobenzophenone.

S Valence Stabilizer #25: Examples of N-(aminomethylthiol)thioureas [N-(aminomercaptomethyl)thioureas], bis[N-(aminomethylthiol)thioureas], and poly[N-(aminomethylthiol)thioureas] (S—S Bidentates, S—S Tridentates, S—S Tetradentates) that meet the requirements for use as “wide band” valence stabilizers for Ce⁺⁴ include, but are not limited to: N′-(aminomercaptomethyl)thiourea; N,N″-dimethyl-N′-(aminomercaptomethyl)thiourea; N,N′-diethyl-N′-(aminomercaptomethyl)thiourea; N,N″-isopropyl-N′-(aminomercaptomethyl)thiourea; N,N″-diphenyl-N′-(aminomercaptomethyl)thiourea; N,N″-dibenzyl-N′-(aminomercaptomethyl)thiourea; N,N″-dicyclohexyl-N′-(aminomercaptomethyl)thiourea; and N,N″-dinorbornyl-N′-(aminomercaptomethyl)thiourea.

S Valence Stabilizer #26: Examples of dithiooxamides, bis(dithiooxamides), and poly(dithiooxamides) (S—S Bidentates, S—S Tridentates, S—S Tetradentates) that meet the requirements for use as “wide band” valence stabilizers for Ce⁺⁴ include, but are not limited to: dithiooxamide (rubeanic acid), N-methyldithiooxamide; N-ethyldithiooxamide; N-isopropyldithiooxamide; N-phenyldithiooxamide; N-benzyldithiooxamide; N-cyclohexyldithiooxamide; N-norbornyldithiooxamide; N,N′-dimethyldithiooxamide; N,N′-diethyldithiooxamide; N,N′-diisopropyldithiooxamide; N,N′-diphenyldithiooxamide; N,N′-dibenzyldithiooxamide; N,N′-dicyclohexyldithiooxamide; and N,N′-dinorbornyldithiooxamide.

S Valence Stabilizer #27: Examples of 1,1-dithiolates, bis(1,1-dithiolates), and poly(1,1-dithiolates) (S—S Bidentates and S—S Tetradentates) that meet the requirements for use as “wide band” valence stabilizers for Ce⁺⁴ include, but are not limited to: 1,1-dicyano-2,2-ethylene dithiolate (i-mnt); 1,1-dicarboalkoxy-2,2-ethylene dithiolate (DED); 1,1-di(trifluoromethyl)-2,2-ethylene dithiolate; 1,1-di(pentafluorophenyl)-2,2-ethylene dithiolate; 1-pentamethylene-2,2-ethylene dithiolate; and 1-nitroethylene dithiolate.

S Valence Stabilizer #28: Examples of dithiomonocarboxylic acids, tri- and tetrathiodicarboxylic Acids, bis(dithiomonocarboxylic acids), bis(tri- and tetrathiodicarboxylic acids), poly(dithiomonocarboxylic acids), poly(tri- and tetrathiodicarboxylic acids), and derivatives thereof (S—S Bidentates and S—S Tetradentates) that meet the requirements for use as “wide band”valence stabilizers for Ce⁺⁴ include, but are not limited to: dithioacetic acid; dithiopropionic acid; dithiobenzoic acid (dtb); dithiophenylacetic acid (dtpa); dithiocyclohexanoic acid; dithiofuroic acid; dithionaphthoic acid; phenyl dithioacetate; phenyl dithiopropionate; phenyl dithiobenzoate; phenyl dithiocyclohexanoate; phenyl dithiofuroate; phenyl dithionaphthoate; tetrathiooxalic acid; tetrathiomalonic acid; tetrathiosuccinic acid; trithiooxalic acid; trithiomalonic acid; trithiosuccinic acid; diphenyl tetrathiooxalate; diphenyl tetrathiomalonate; diphenyl tetrathiosuccinate; diphenyl trithiooxalate; diphenyl trithiomalonate; diphenyl trithiosuccinate; pyridine dithiocarboxylic acid; pyrrole dithiocarboxylic acid; thiophene dithiocarboxylic acid; dithionaphthoic acid; and tetrathiocamphonic acid.

S Valence Stabilizer #29: Examples of perthiomonocarboxylic acids, perthiodicarboxylic acids, bis(perthiomonocarboxylic acids), bis(perthiodicarboxylic acids), poly(perthiomonocarboxylic acids), poly(perthiodicarboxylic acids), and derivatives thereof (S—S Bidentates and S—S Tetradentates) that meet the requirements for use as “wide band” valence stabilizers for Ce⁺⁴ include, but are not limited to: perthioacetic acid; perthiopropionic acid; perthiobenzoic acid; perthiophenylacetic acid; perthiocyclohexanoic acid; perthiofuroic acid; perthionaphthoic acid; phenyl perthioacetate; phenyl perthiopropionate; phenyl perthiobenzoate; phenyl perthiocyclohexanoate; phenyl perthiofuroate; phenyl perthionaphthoate; perthiooxalic acid; perthiomalonic acid; perthiosuccinic acid; diphenyl perthiooxalate; diphenyl perthiomalonate; diphenyl perthiosuccinate; dithiole-3-thione (dithione-3-thione); and benzodithiole-3-thione (benzodithione-3-thione).

S Valence Stabilizer #30: Examples of dithiocarbonates, trithiocarbonates, perthiocarbonates, bis(dithiocarbonates), bis(trithiocarbonates), and bis(perthiocarbonates) (S—S Bidentates and S—S Tetradentates) that meet the requirements for use as “wide band” valence stabilizers for Ce⁺⁴ include, but are not limited to: S,S-diethyldithiocarbonate; S,S-diisopropyldithiocarbonate; S,S-diphenyldithiocarbonate; S,S-dibenzyldithiocarbonate; S,S-dicyclohexyldithiocarbonate; S,S-dinorbornyldithiocarbonate; diethyltrithiocarbonate; diisopropyltrithiocarbonate; diphenyltrithiocarbonate; dibenzyltrithiocarbonate; dicyclohexyltrithiocarbonate; and dinorbornyltrithiocarbonate.

S Valence Stabilizer #31: Examples of dithiocarbamates, bis(dithiocarbamates), and poly(dithiocarbamates) (including N-hydroxydithiocarbamates and N-mercaptodithiocarbamates) (S—S Bidentates, S—S Tridentates, and S—S Tetradentates) that meet the requirements for use as “wide band” valence stabilizers for Ce⁺⁴ include, but are not limited to: dimethyldithiocarbamate (dmdtc); di(trifluorodimethyl)dithiocarbamate; diethyldithiocarbamate (dedtc); dipropyldithiocarbamate; diisopropyldithiocarbamate; dibutyldithiocarbamate; ditertbutyldithiocarbamate; dicyanamidodithiocarbamate; azidothioformates; diphenyldithiocarbamate; di(pentafluorophenyl)dithiocarbamate; dibenzyldithiocarbamate; dinaphthyldithiocarbamate; dicyclohexyldithiocarbamate; dinorbornyldithiocarbamate; diadamantyldithiocarbamate; pyrrolidinodithiocarbamate (pyrdtc); piperidinodithiocarbamate (pipdtc); morpholinodithiocarbamate (mordtc); thiamorpholinodithiocarbamate; 3-pyrrolinodithiocarbamate; pyrrolodithiocarbamate; oxazolodithiocarbamate; isoxazolodithiocarbamate; thiazolodithiocarbamate; isothiazolodithiocarbamate; indolodithiocarbamate; carbazolodithiocarbamate; pyrazolinodithiocarbamate; imidazolinodithiocarbamate; pyrazolodithiocarbamate; imidazolodithiocarbamate; indazolodithiocarbamate; and triazolodithiocarbamate.

S Valence Stabilizer #32: Examples of dithiocarbazates (dithiocarbazides), bis(dithiocarbazates), and poly(dithiocarbazates) (S—S Bidentates, S—S Tridentates, and S—S Tetradentates; or possibly N—S Bidentates, N—S Tridentates, and N—S Tetradentates) that meet the requirements for use as “wide band” valence stabilizers for Ce⁺⁴ include, but are not limited to: N,N′-dimethyldithiocarbazate; N,N′-di(trifluoromethyl)dithiocarbazate; N,N′-diethyldithiocarbazate; N,N′-diphenyldithiocarbazate; N,N′-dibenzyldithiocarbazate; N,N′-di(pentafluorophenyl)dithiocarbazate; N,N′-dicyclohexyldithiocarbazate; and N,N′-dinorbornyldithiocarbazate.

S Valence Stabilizer #33: Examples of thiocyanate ligands (S monodentates) that meet the requirements for use as “wide band” valence stabilizers for Ce⁺⁴ include, but are not limited to: thiocyanate (—SCN).

O Valence Stabilizer #1: Examples of biurets (imidodicarbonic diamides), isobiurets, biureas, triurets, triureas, bis(biurets), bis(isobiurets), bis(biureas), poly(biurets), poly(isobiurets), and poly(biureas) (O—O Bidentates, O—O Tridentates, O—O Tetradentates) that meet the requirements for use as “wide band” valence stabilizers for Ce⁺⁴ include, but are not limited to: biuret, isobiuret, biurea, triuret, triurea, nitrobiuret, dinitrobiuret, aminobiuret, diaminobiuret, oxybiuret, dioxybiuret, cyanobiuret, methylbiuret, ethylbiuret, isopropylbiuret, phenylbiuret, benzylbiuret, cyclohexylbiuret, norbornylbiuret, adamantylbiuret, dimethylbiuret, diethylbiuret, diisopropylbiuret, diphenylbiuret, dibenzylbiuret, dicyclohexylbiuret, dinorbornylbiuret, and diadamantylbiuret.

O Valence Stabilizer #2: Examples of acylureas, aroylureas, bis(acylureas), bis(aroylureas), poly(acylureas), and poly(aroylureas) (O—O Bidentates, O—O Tridentates, O—O Tetradentates) that meet the requirements for use as “wide band” valence stabilizers for Ce⁺⁴ include, but are not limited to: formylurea, acetylurea, benzoylurea, cyclohexoylurea, pentafluorobenzoylurea, N-methylacetylurea, N-phenylbenzoylurea, and N-cyclohexylcyclohexoylurea.

O Valence Stabilizer #3: Examples of imidodialdehydes, hydrazidodialdehydes (acyl hydrazides), bis(imidodialdehydes), bis(hydrazidodialdehydes), poly(imidodialdehydes), and poly(hydrazidodialdehydes) (O—O Bidentates, O—O Tridentates, O—O Tetradentates) that meet the requirements for use as “wide band” valence stabilizers for Ce⁺⁴ include, but are not limited to: diacetamide, dipropanamide, dibutanamide, dibenzamide, and dicyclohexamide.

O Valence Stabilizer #4: Examples of imidodicarbonic acids, hydrazidodicarbonic acids, bis(imidodicarbonic acids), bis(hydrazidodicarbonic acids), poly(imidodicarbonic acids), poly(hydrazidodicarbonic acids) and derivatives thereof (O—O Bidentates, O—O Tridentates, O—O Tetradentates) that meet the requirements for use as “wide band” valence stabilizers for Ce⁺⁴ include, but are not limited to: imidodicarbonic acid, hydrazidodicarbonic acid, O-phenylimidodicarbonic acid, O-benzylimidodicarbonic acid, O-cyclohexylimidodicarbonic acid, O-norbornylimidodicarbonic acid, O,O′-diphenylimidodicarbonic acid, O,O′-dibenzylimidodicarbonic acid, O,O′-dicyclohexylimidodicarbonic acid, and O,O′-dinorbornylimidodicarbonic acid.

O Valence Stabilizer #5: Examples of imidodisulfamic acid, imidodisulfuric acid, bis(imidodisulfamic acid), bis(imidodisulfuric acid), poly(imidodisulfamic acid), and poly(imidodisulfuric acid) and derivatives thereof (O—O Bidentates, O—O Tridentates, O—O Tetradentates) that meet the requirements for use as “wide band” valence stabilizers for Ce⁺⁴ include, but are not limited to: imidodisulfamic acid, imidodisulfuric acid, N-phenylimidodisulfamic acid, N-benzylimidodisulfamic acid, N-cyclohexylimidodisulfamic acid, N-norbornylimidodisulfamic acid, N,N′-diphenylimidodisulfamic acid, N,N′-dibenzylimidodisulfamic acid, N,N′-dicyclohexylimidodisulfamic acid, and N,N′-norbornylimidodisulfamic acid.

O Valence Stabilizer #6: Examples of 1,3-diketones (beta-diketonates), 1,3,5-triketones, bis(1,3-diketones), and poly(1,3-diketones), all with a molecular weight greater than 125 (O—O Bidentates, O—O Tridentates, O—O Tetradentates) that meet the requirements for use as “wide band” valence stabilizers for Ce⁺⁴ include, but are not limited to: hexafluoropentanedione; dibenzoylmethane (1,3-diphenyl-1,3-propanedione); benzoylpinacolone; dicyclohexoylmethane; diphenylpentanetrionate; dibenzoylacetone; benzoylacetylacetone; dibenzoylacetylacetone; tetramethylnonanetrionate; hexafluoroheptanetrionate; trifluoroheptanetrionate; trifluoroacetylcamphor (facam); and 1,3-indandione.

O Valence Stabilizer #7: Examples of 1,2-diketones (alpha-diketonates), 1,2,3-triketones, tropolonates, o-quinones, bis(1,2-diketones), and poly(1,2-diketones), all with a molecular weight greater than 100 (O—O Bidentates, O—O Tridentates, O—O Tetradentates) that meet the requirements for use as “wide band” valence stabilizers for Ce⁺⁴ include, but are not limited to: tropolone; 1,2-benzoquinone (o-quinone); di-tert-butyl-1,2-benzoquinone; hexafluoro-1,2-benzoquinone; 1,2-naphthoquinone; 9,10-phenanthroquinone; and 1,2-indandione.

O Valence Stabilizer #8: Examples of malonamides (malonodiamides), bis(malonamides), and polymalonamides (O—O Bidentates, O—O Tridentates, O—O Tetradentates) that meet the requirements for use as “wide band” valence stabilizers for Ce⁺⁴ include, but are not limited to: malonamide, N-phenylmalonamide, N-benzylmalonamide, N-pentafluorophenylmalonamide, N-cyclohexylmalonamide, N-norbornylmalonamide, N,N′-diphenylmalonamide, N,N′-dibenzylmalonamide, N,N′-dipentafluorophenylmalonamide, N,N′-dicyclohexylmalonamide, and N,N′-norbornylmalonamide.

O Valence Stabilizer #9: Examples of 2-acylacetamides, bis(2-acylacetamides), and poly(2-acylacetamides) (O—O Bidentates, O—O Tridentates, O—O Tetradentates) that meet the requirements for use as “wide band” valence stabilizers for Ce⁺⁴ include, but are not limited to: 2-acetoacetamide, N-phenyl-2-acetoacetamide, N-pentafluorophenyl-2-acetoacetamide, N-benzyl-2-acetoacetamide, N-cyclohexyl-2-acetoacetamide, N-norbornyl-2-acetoacetamide, N-phenyl-2-benzoacetamide, N-pentafluorophenyl-2-pentafluorobenzoacetamide, and N-cyclohexyl-2-cyclohexoacetamide.

O Valence Stabilizer #10: Examples of monothiodicarbonic diamides, bis(monothiodicarbonic diamides), and poly(monothiodicarbonic diamides) (O—O Bidentates, O—O Tridentates, O—O Tetradentates) that meet the requirements for use as “wide band” valence stabilizers for Ce⁺⁴ include, but are not limited to: monothiodicarbonic diamide; N-phenylmonothiodicarbonic diamide; N-pentafluorophenylmonothiodicarbonic diamide; N-benzylmonothiodicarbonic diamide; N-cyclohexylmonothiodicarbonic diamide; N-norbornylmonothiodicarbonic diamide; N,N′-diphenylmonothiodicarbonic diamide; N,N′-dipentafluorophenylmonothiodicarbonic diamide; N,N′-dibenzylmonothiodicarbonic diamide; N,N′-dicyclohexylmonothiodicarbonic diamide; and N,N′-dinorbornylmonothiodicarbonic diamide.

O Valence Stabilizer #11: Examples of monothiodicarbonic acids, bis(monothiodicarbonic acids), poly(monothiodicarbonic acids), and derivatives thereof (O—O Bidentates, O—O Tridentates, O—O Tetradentates) that meet the requirements for use as “wide band” valence stabilizers for Ce⁺⁴ include, but are not limited to: monothiodicarbonic acid, O-phenylmonothiodicarbonic acid, O-benzylmonothiodicarbonic acid, O-cyclohexylmonothiodicarbonic acid, O-norbornylmonothiodicarbonic acid, O,O′-diphenylmonothiodicarbonic acid, O,O′-dibenzylmonothiodicarbonic acid, O,O′-dicyclohexylmonothiodicarbonic acid, and O,O′-dinorbornylmonothiodicarbonic acid.

O Valence Stabilizer #12: Examples of trithionic acid, bis(trithionic acid), poly(trithionic acid), and derivatives thereof (O—O Bidentates, O—O Tridentates, O—O Tetradentates) that meet the requirements for use as “wide band” valence stabilizers for Ce⁺⁴ include, but are not limited to: diphenyl trithionate, dipentafluorodiphenyl trithionate, dicyclohexyl trithionate, and dinorbornyl trithionate.

O Valence Stabilizer #13: Examples of hypophosphoric acids, bis(hypophosphoric acids), and poly(hypophosphoric acids), and derivatives thereof (O—O Bidentates, O—O Tridentates, O—O Tetradentates) that meet the requirements for use as “wide band” valence stabilizers for Ce⁺⁴ include, but are not limited to: hypophosphoric acid, O-methylhypophosphoric acid, O-isopropylhypophosphoric acid, O-tert-butylhypophosphoric acid, O-phenylhypophosphoric acid, O-pentafluorophenylhypophosphoric acid, O-benzylhypophosphoric acid, O-cyclohexylhypophosphoric acid, O-norbornylhypophosphoric acid, O,O″-dimethylhypophosphoric acid, O,O″-diisopropylhypophosphoric acid, O,O″-di-tert-butylhypophosphoric acid, O,O″-diphenylhypophosphoric acid, O,O″-di-pentafluorophenylhypophosphoric acid, O,O″-dibenzylhypophosphoric acid, O,O″-dicyclohexylhypophosphoric acid, and O,O″-dinorbornylhypophosphoric acid.

O Valence Stabilizer #14: Examples of hypophosphoramides, bis(hypophosphoramides), and poly(hypophosphoramides) (O—O Bidentates, O—O Tridentates, O—O Tetradentates) that meet the requirements for use as “wide band” valence stabilizers for Ce⁺⁴ include, but are not limited to: hypophosphoramide, N-methylhypophosphoramide, N-isopropylhypophosphoramide, N-tert-butylhypophosphoramide, N-phenylhypophosphoramide, N-pentafluorophenylhypophosphoramide, N-benzylhypophosphoramide, N-cyclohexylhypophosphoramide, N-norbornylhypophosphoramide, N,N′″-dimethylhypophosphoramide, N,N′″-diisopropylhypophosphoramide, N,N′″-di-tert-butylhypophosphoramide, N,N′″-diphenylhypophosphoramide, N,N′″-di-pentafluorophenylhypophosphoramide, N,N′″-dibenzylhypophosphoramide, N,N′″-dicyclohexylhypophosphoramide, and N,N′″-dinorbornylhypophosphoramide.

O Valence Stabilizer #15: Examples of imidodiphosphoric acids, hydrazidodiphosphoric acids, bis(imidodiphosphoric acids), bis(hydrazidodiphosphoric acids), poly(imidodiphosphoric acids), poly(hydrazidodiphosphoric acids), and derivatives thereof (O—O Bidentates, O—O Tridentates, O—O Tetradentates) that meet the requirements for use as “wide band” valence stabilizers for Ce⁺⁴ include, but are not limited to: imidodiphosphoric acid, methylimidodiphosphoric acid, isopropylimidodiphosphoric acid, tert-butylimidodiphosphoric acid, phenylimidodiphosphoric acid, pentafluorophenylimidodiphosphoric acid, benzylimidodiphosphoric acid, cyclohexylimidodiphosphoric acid, norbornylimidodiphosphoric acid, dimethylimidodiphosphoric acid, diisopropylimidodiphosphoric acid, di-tert-butylimidodiphosphoric acid, diphenylimidodiphosphoric acid, di-pentafluorophenylimidodiphosphoric acid, dibenzylimidodiphosphoric acid, dicyclohexylimidodiphosphoric acid, and dinorbornylimidodiphosphoric acid.

O Valence Stabilizer #16: Examples of imidodiphosphoramides, hydrazidodiphosphoramides, bis(imidodiphosphoramides), bis(hydrazidodiphosphoramides), poly(imidodiphosphoramides), and poly(hydrazidodiphosphoramides) (O—O Bidentates, O—O Tridentates, O—O Tetradentates) that meet the requirements for use as “wide band” valence stabilizers for Ce⁺⁴ include, but are not limited to: imidodiphosphoramide, N-methylimidodiphosphoramide, N-isopropylimidodiphosphoramide, N-tert-butylimidodiphosphoramide, N-phenylimidodiphosphoramide, N-pentafluorophenylimidodiphosphoramide, N-benzylimidodiphosphoramide, N-cyclohexylimidodiphosphoramide, N-norbornylimidodiphosphoramide, N,N′″-dimethylimidodiphosphoramide, N,N′″-diisopropylimidodiphosphoramide, N,N′″-di-tert-butylimidodiphosphoramide, N,N′″-diphenylimidodiphosphoramide, N,N′″-di-pentafluorophenylimidodiphosphoramide, N,N′″-dibenzylimidodiphosphoramide, N,N′″-dicyclohexylimidodiphosphoramide, and N,N′″-dinorbornylimidodiphosphoramide.

O Valence Stabilizer #17: Examples of diphosphoramides, bis(diphosphoramides), and poly(diphosphoramides) (O—O Bidentates, O—O Tridentates, O—O Tetradentates) that meet the requirements for use as “wide band” valence stabilizers for Ce⁺⁴ include, but are not limited to: diphosphoramide, N-methyldiphosphoramide, N-isopropyldiphosphoramide, N-tert-butyldiphosphoramide, N-phenyldiphosphoramide, N-pentafluorophenyldiphosphoramide, N-benzyldiphosphoramide, N-cyclohexyldiphosphoramide, N-norbornyldiphosphoramide, N,N′″-dimethyldiphosphoramide, N,N′″-diisopropyldiphosphoramide, N,N′″-di-tert-butyldiphosphoramide, N,N′″-diphenyldiphosphoramide, N,N′″-di-pentafluorophenyldiphosphoramide, N,N′″-dibenzyldiphosphoramide, N,N′″-dicyclohexyldiphosphoramide, and N,N′″-dinorbornyldiphosphoramide.

O Valence Stabilizer #18: Examples of beta-hydroxyketones, beta-hydroxyaldehydes, bis(beta-hydroxyketones), bis(beta-hydroxyaldehydes), poly(beta-hydroxyketones), and poly(beta-hydroxyaldehydes) (O—O Bidentates, O—O Tridentates, O—O Tetradentates) that meet the requirements for use as “wide band” valence stabilizers for Ce⁺⁴ include, but are not limited to: 4-hydroxypentan-2-one; 1,3-diphenyl-3-hydroxypropanal; 1,3-dibenzyl-3-hydroxypropanal; 1,3-dicyclohexyl-3-hydroxypropanal; 1,3-dinorbornyl-3-hydroxypropanal; 1,3-di(2-thienyl)-3-hydroxypropanal; 1,3-di(2-furyl)-3-hydroxypropanal; o-hydroxyacetophenone; juglone; alizarin; 1-hydroxyanthraquinone; 1,8-hydroxyanthraquinone; 1-hydroxyacridone; and beta-hydroxybenzophenone.

O Valence Stabilizer #19: Examples of oxamides, bis(oxamides), and poly(oxamides) (O—O Bidentates, O—O Tridentates, O—O Tetradentates) that meet the requirements for use as “wide band” valence stabilizers for Ce⁺⁴ include, but are not limited to: oxamide, N-methyloxamide; N-ethyloxamide; N-isopropyloxamide; N-phenyloxamide; N-benzyloxamide; N-cyclohexyloxamide; N-norbornyloxamide; N,N′-dimethyloxamide; N,N′-diethyloxamide; N,N′-diisopropyloxamide; N,N′-diphenyloxamide; N,N′-dibenzyloxamide; N,N′-dicyclohexyloxamide; and N,N′-dinorbornyloxamide.

O Valence Stabilizer #20: Examples of squaric acids and derivatives thereof (O—O Bidentates) that meet the requirements for use as “wide band” valence stabilizers for Ce⁺⁴ include, but are not limited to: deltic acid; squaric acid; croconic acid; and rhodizonic acid.

O Valence Stabilizer #21: Examples of dicarboxylic acids, bis(dicarboxylic acids), poly(dicarboxylic acids), and derivatives thereof (O—O Bidentates and O—O Tetradentates) that meet the requirements for use as “wide band” valence stabilizers for Ce⁺⁴ include, but are not limited to: oxalic acid; malonic acid; succinic acid; diphenyl oxalate; diphenyl malonate; and diphenyl succinate.

O Valence Stabilizer #22: Examples of carbonates and bis(carbonates) (O—O Bidentates and O—O Tetradentates) that meet the requirements for use as “wide band” valence stabilizers for Ce⁺⁴ include, but are not limited to: carbonate; bicarbonate; O,O-diethylcarbonate; diisopropylcarbonate; diphenylcarbonate; dibenzylcarbonate; dicyclohexylcarbonate; and dinorbornylcarbonate.

O Valence Stabilizer #23: Examples of carbamates, bis(carbamates), and poly(carbamates) (including N-hydroxycarbamates and N-mercaptocarbamates) (O—O Bidentates, O—O Tridentates, and O—O Tetradentates) that meet the requirements for use as “wide band” valence stabilizers for Ce⁺⁴ include, but are not limited to: dimethylcarbamate (dmc); di(trifluorodimethyl)carbamate; ethyl carbamate; diethylcarbamate (dec); dipropylcarbamate; diisopropylcarbamate; dibutylcarbamate; ditertbutylcarbamate; dicyanamidocarbamate; diphenylcarbamate; di(pentafluorophenyl)carbamate; dibenzylcarbamate; dinaphthylcarbamate; dicyclohexylcarbamate; dinorbornylcarbamate; diadamantylcarbamate; pyrrolidinocarbamate (pyrc); piperidinocarbamate (pipc); morpholinocarbamate (morc); thiamorpholinocarbamate; 3-pyrrolinocarbamate; pyrrolocarbamate; oxazolocarbamate; isoxazolocarbamate; thiazolocarbamate; isothiazolocarbamate; indolocarbamate; carbazolocarbamate; pyrazolinocarbamate; imidazolinocarbamate; pyrazolocarbamate; imidazolocarbamate; indazolocarbamate; and triazolocarbamate.

O Valence Stabilizer #24: Examples of carbimates, bis(carbimates), and poly(carbimates) (O—O Bidentates, O—O Tridentates, and O—O Tetradentates) that meet the requirements for use as “wide band” valence stabilizers for Ce⁺⁴ include, but are not limited to: methylcarbimate; trifluoromethylcarbimate; ethylcarbimate; propylcarbimate; isopropylcarbimate; butylcarbimate; tertbutylcarbimate; cyanocarbimate; cyanamidocarbimate; azidocarbimate; phenylcarbimate; pentafluorophenylcarbimate; benzylcarbimate; naphthylcarbimate; cyclohexylcarbimate; norbornylcarbimate; and adamantylcarbimate. [Note: carbimates tend to stabilize lower oxidation states in metal ions.]

O Valence Stabilizer #25: Examples of N-(aminomethylol)ureas [N-(aminohydroxymethyl)ureas], bis[N-(aminomethylol)ureas], and poly[N-(aminomethylol)ureas] (O—O Bidentates, O—O Tridentates, O—O Tetradentates) that meet the requirements for use as “wide band” valence stabilizers for Ce⁺⁴ include, but are not limited to: N′-(aminohydroxymethyl)urea; N,N″-dimethyl-N′-(aminohydroxymethyl)urea; N,N′-diethyl-N′-(aminohydroxymethyl)urea; N,N″-isopropyl-N′-(aminohydroxymethyl)urea; N,N″-diphenyl-N′-(aminohydroxymethyl)urea; N,N″-dibenzyl-N′-(aminohydroxymethyl)urea; N,N″-dicyclohexyl-N′-(aminohydroxymethyl)urea; and N,N″-dinorbornyl-N′-(aminohydroxymethyl)urea.

O Valence Stabilizer #26: Examples of cyanate ligands (O monodentates) that meet the requirements for use as “wide band” valence stabilizers for Ce⁺⁴ include, but are not limited to: cyanate (—OCN).

N—S Valence Stabilizer #1: Examples of diformamidine disulfides (thioperoxydicarbonimidic diamides), thioperoxytricarbonimidic diamides, thioperoxytetracarbonimidic diamides, bis(diformamidine disulfides), and poly(diformamidine disulfides) (N—S bidentates, N—N—S tridentates, or N—S tetradentates) that meet the requirements for use as “wide band” valence stabilizers for Ce⁺⁴ include, but are not limited to: diformamidine disulfide; methyldiformamidine disulfide; ethyldiformamidine disulfide; isopropyldiformamidine disulfide; butyldiformamidine disulfide; benzyldiformamidine disulfide; phenyldiformamidine disulfide; tolyldiformamidine disulfide; naphthyldiformamidine disulfide; cyclohexyldiformamidine disulfide; norbornyldiformamidine disulfide; adamantyldiformamidine disulfide; dimethyldiformamidine disulfide; diethyldiformamidine disulfide; diisopropyldiformamidine disulfide; dibutyldiformamidine disulfide; dibenzyldiformamidine disulfide; diphenyldiformamidine disulfide; ditolyldiformamidine disulfide; dinaphthyldiformamidine disulfide; dicyclohexyldiformamidine disulfide; dinorbornyldiformamidine disulfide; diadamantyldiformamidine disulfide; 2-S-amidinodisulfidothiazole; 2-S-amidinodisulfidooxazole; 2-S-amidinodisulfidoimidazole; 3-S-amidinodisulfidopyrazole; 3-S-amidinodisulfido-1,2,4-triazole; and 5-S-amidinodisulfidotetrazole.

N—S Valence Stabilizer #2: Examples of S-amidinodithiocarbamates, bis(S-amidinodithiocarbamates), and poly(S-amidinodithiocarbamates) (N—S Bidentates and N—S Tetradentates) that meet the requirements for use as “wide band” valence stabilizers for Ce⁺⁴ include, but are not limited to: S-amidinodithiocarbamate; N-methyl-S-amidinodithiocarbamate; N-ethyl-S-amidinodithiocarbamate; N-isopropyl-S-amidinodithiocarbamate; N-butyl-S-amidinodithiocarbamate; N-benzyl-S-amidinodithiocarbamate; N-phenyl-S-amidinodithiocarbamate; N-tolyl-S-amidinodithiocarbamate; N-naphthyl-S-amidinodithiocarbamate; N-cyclohexyl-S-amidinodithiocarbamate; N-norbornyl-S-amidinodithiocarbamate; N-adamantyl-S-amidinodithiocarbamate; N,N′-dimethyl-S-amidinodithiocarbamate; N,N′-diethyl-S-amidinodithiocarbamate; N,N′-diisopropyl-S-amidinodithiocarbamate; N,N′-dibutyl-S-amidinodithiocarbamate; N,N′-dibenzyl-S-amidinodithiocarbamate; N,N′-diphenyl-S-amidinodithiocarbamate; N,N′-ditolyl-S-amidinodithiocarbamate; N,N′-dinaphthyl-S-amidinodithiocarbamate; N,N′-dicyclohexyl-S-amidinodithiocarbamate; N,N′-dinorbornyl-S-amidinodithiocarbamate; N,N′-diadamantyl-S-amidinodithiocarbamate; ethylenebis(S-amidinodithiocarbamate); propylenebis(S-amidinodithiocarbamate); phenylenebis(S-amidinodithiocarbamate); piperazinebis(S-amidinodithiocarbamate); oxalylbis(S-amidinodithiocarbamate); malonylbis(S-amidinodithiocarbamate); succinylbis(S-amidinodithiocarbamate); phthalylbis(S-amidinodithiocarbamate); 2-S-dithiocarbamatothiazole; 2-S-dithiocarbamatooxazole; 2-S-dithiocarbamatoimidazole; 3-S-dithiocarbamatopyrazole; 3-S-dithiocarbamato-1,2,4-triazole; and 5-S-dithiocarbamatotetrazole.

N—S Valence Stabilizer #3: Examples of O-amidinothiocarbamates, bis(O-amidinothiocarbamates), and poly(O-amidinothiocarbamates) (N—S Bidentates and N—S Tetradentates) that meet the requirements for use as “wide band” valence stabilizers for Ce⁺⁴ include, but are not limited to: O-amidinothiocarbamate; N-methyl-O-amidinothiocarbamate; N-ethyl-O-amidinothiocarbamate; N-isopropyl-O-amidinothiocarbamate; N-butyl-O-amidinothiocarbamate; N-benzyl-O-amidinothiocarbamate; N-phenyl-O-amidinothiocarbamate; N-tolyl-O-amidinothiocarbamate; N-naphthyl-O-amidinothiocarbamate; N-cyclohexyl-O-amidinothiocarbamate; N-norbornyl-O-amidinothiocarbamate; N-adamantyl-O-amidinothiocarbamate; N,N′-dimethyl-O-amidinothiocarbamate; N,N′-diethyl-O-amidinothiocarbamate; N,N′-diisopropyl-O-amidinothiocarbamate; N,N′-dibutyl-O-amidinothiocarbamate; N,N′-dibenzyl-O-amidinothiocarbamate; N,N′-diphenyl-O-amidinothiocarbamate; N,N′-ditolyl-O-amidinothiocarbamate; N,N′-dinaphthyl-O-amidinothiocarbamate; N,N′-dicyclohexyl-O-amidinothiocarbamate; N,N′-dinorbornyl-O-amidinothiocarbamate; N,N′-diadamantyl-O-amidinothiocarbamate; ethylenebis(O-amidinothiocarbamate); propylenebis(O-amidinothiocarbamate); phenylenebis(O-amidinothiocarbamate); piperazinebis(O-amidinothiocarbamate); oxalylbis(O-amidinothiocarbamate); malonylbis(O-amidinothiocarbamate); succinylbis(O-amidinothiocarbamate); phthalylbis(O-amidinothiocarbamate); 2-O-monothiocarbamatothiazole; 2-O-monothiocarbamatooxazole; 2-O-monothiocarbamatoimidazole; 3-O-monothiocarbamatopyrazole; 3-O-monothiocarbamato-1,2,4-triazole; 5-O-monothiocarbamatotetrazole.

N—S Valence Stabilizer #4: Examples of S-amidinoperoxythiocarbamates, bis(S-amidinoperoxythiocarbamates), and poly(S-amidinoperoxythiocarbamates) (N—S Bidentates and N—S Tetradentates) that meet the requirements for use as “wide band” valence stabilizers for Ce⁺⁴ include, but are not limited to: S-amidinoperoxythiocarbamate; N-methyl-S-amidinoperoxythiocarbamate; N-ethyl-S-amidinoperoxythiocarbamate; N-isopropyl-S-amidinoperoxythiocarbamate; N-butyl-S-amidinoperoxythiocarbamate; N-benzyl-S-amidinoperoxythiocarbamate; N-phenyl-S-amidinoperoxythiocarbamate; N-tolyl-S-amidinoperoxythiocarbamate; N-naphthyl-S-amidinoperoxythiocarbamate; N-cyclohexyl-S-amidinoperoxythiocarbamate; N-norbornyl-S-amidinoperoxythiocarbamate; N-adamantyl-S-amidinoperoxythiocarbamate; N,N′-dimethyl-S-amidinoperoxythiocarbamate; N,N′-diethyl-S-amidinoperoxythiocarbamate; N,N′-diisopropyl-S-amidinoperoxythiocarbamate; N,N′-dibutyl-S-amidinoperoxythiocarbamate; N,N′-dibenzyl-S-amidinoperoxythiocarbamate; N,N′-diphenyl-S-amidinoperoxythiocarbamate; N,N′-ditolyl-S-amidinoperoxythiocarbamate; N,N′-dinaphthyl-S-amidinoperoxythiocarbamate; N,N′-dicyclohexyl-S-amidinoperoxythiocarbamate; N,N′-dinorbornyl-S-amidinoperoxythiocarbamate; N,N′-diadamantyl-S-amidinoperoxythiocarbamate; ethylenebis(S-amidinoperoxythiocarbamate); propylenebis(S-amidinoperoxythiocarbamate); phenylenebis(S-amidinoperoxythiocarbamate); piperazinebis(S-amidinoperoxythiocarbamate); oxalylbis(S-amidinoperoxythiocarbamate); malonylbis(S-amidinoperoxythiocarbamate); succinylbis(S-amidinoperoxythiocarbamate); and phthalylbis(S-amidinoperoxythiocarbamate).

N—S Valence Stabilizer #5: Examples of phosphorimidothioic acid; phosphorimidodithioic acid; phosphorimidotrithioic acid; bis(phosphorimidothioic acid); bis(phosphorimidodithioic acid); bis(phosphorimidotrithioic acid); poly(phosphorimidothioic acid); poly(phosphorimidodithioic acid); poly(phosphorimidotrithioic acid); and derivatives thereof (N—S Bidentates and N—S Tetradentates) that meet the requirements for use as “wide band” valence stabilizers for Ce⁺⁴ include, but are not limited to: phosphorimidothioic acid; phosphorimidodithioic acid; phosphorimidotrithioic acid; O-phenylphosphorimidothioic acid; O-benzylphosphorimidothioic acid; O-cyclohexylphosphorimidothioic acid; O-norbornylphosphorimidothioic acid; O,O′-diphenylphosphorimidothioic acid; O,O′-dibenzylphosphorimidothioic acid; O,O′-dicyclohexylphosphorimidothioic acid; and O,O′-dinorbornylphosphorimidothioic acid.

N—S Valence Stabilizer #6: Examples of phosphorothioic triamides, bis(phosphorothioic triamides), and poly(phosphorothioic triamides) (N—S Bidentates and N—S Tetradentates) that meet the requirements for use as “wide band” valence stabilizers for Ce⁺⁴ include, but are not limited to: phosphorothioic triamide; phosphorothioic trihydrazide; phosphoramidothioic dihydrazide; N-phenylphosphorothioic triamide; N-benzylphosphorothioic triamide; N-cyclohexylphosphorothioic triamide; N-norbornylphosphorothioic triamide; N,N′-diphenylphosphorothioic triamide; N,N′-dibenzylphosphorothioic triamide; N,N′-dicyclohexylphosphorothioic triamide; and N,N′-dinorbornylphosphorothioic triamide.

N—S Valence Stabilizer #7: Examples of phosphoramidotrithioic acid, phosphorodiamidodithioic acid, bis(phosphoramidotrithioic acid), bis(phosphorodiamidodithioic acid), poly(phosphoramidotrithioic acid), poly(phosphorodiamidodithioic acid), and derivatives thereof (N—S Bidentates and N—S Tetradentates) that meet the requirements for use as “wide band” valence stabilizers for Ce⁺⁴ include, but are not limited to: phosphoramidotrithioic acid, phosphorodiamidodithioic acid, S-phenylphosphoramidotrithioic acid, S-benzylphosphoramidotrithioic acid, S-cyclohexylphosphoramidotrithioic acid, S-norbornylphosphoramidotrithioic acid, S,S′-diphenylphosphoramidotrithioic acid, S,S′-dibenzylphosphoramidotrithioic acid, S,S′-dicyclohexylphosphoramidotrithioic acid, and S,S′-dinorbornylphosphoramidotrithioic acid.

N—S Valence Stabilizer #8: Examples of phosphoramidothioic acid, phosphoramidodithioic acid, phosphorodiamidothioic acid, bis(phosphoramidothioic acid), bis(phosphoramidodithioic acid), bis(phosphorodiamidothioic acid), poly(phosphoramidothioic acid), poly(phosphoramidodithioic acid), and poly(phosphorodiamidothioic acid) (N—S Bidentates and N—S Tetradentates) that meet the requirements for use as “wide band” valence stabilizers for Ce⁺⁴ include, but are not limited to: phosphoramidothioic acid, phosphoramidodithioic acid, phosphorodiamidothioic acid, phosphorohydrazidothioic acid, phosphorohydrazidodithioic acid, phosphorodihydrazidothioic acid, phosphoramidohydrazidothioic acid, O-phenylphosphoramidothioic acid, O-benzylphosphoramidothioic acid, O-cyclohexylphosphoramidothioic acid, O-norbornylphosphoramidothioic acid, S-phenylphosphoramidodithioic acid, S-benzylphosphoramidodithioic acid, S-cyclohexylphosphoramidodithioic acid, and S-norbornylphosphoramidodithioic acid.

N—S Valence Stabilizer #9: Examples of N-thioacyl 7-aminobenzylidenimines (N—S Bidentates or N—S Tetradentates) that meet the requirements for use as “wide band” valence stabilizers for Ce⁺⁴ include, but are not limited to: N-thioacetyl 7-methylaminobenzylidenimine; N-thioacetyl 7-phenylaminobenzylidenimine; N-thiobenzoyl 7-methylaminobenzylidenimine; and N-thiobenzoyl 7-phenylaminobenzylidenimine.

N—S Valence Stabilizer #10: Examples of thiohydroxamates (thiohydroxylamines), bis(thiohydroxamates), and poly(thiohydroxamates) (N—S Bidentates, N—S Tetradentates, and N—S Hexadentates) that meet the requirements for use as “wide band” valence stabilizers for Ce⁺⁴ include, but are not limited to: acetothiohydroxamic acid; propianothiohydroxamic acid; butyrothiohydroxamic acid; crotonothiohydroxamic acid; sorbothiohydroxamic acid; benzothiohydroxamic acid; toluicthiohydroxamic acid; salicylthiohydroxamic acid; phenylacetothiohydroxamic acid; anthranilthiohydroxamic acid; nicotinethiohydroxamic acid; picolinethiohydroxamic acid; cyclohexanethiohydroxamic acid; quinoline 8-thiohydroxamic acid; cinnamylthiohydroxamic acid; oxaldithiohydroxamic acid; succinylbis-N-phenylthiohydroxamic acid; adipylbis-N-phenylthiohydroxamic acid; glyoxalthiohydroxamic acid; 2-thiophenethiocarbohydroxamic acid; thenoylthiohydroxamic acid; N-phenylbenzothiohydroxamic acid; N-tolylbenzothiohydroxamic acid; N-phenylacetothiohydroxamic acid; N-phenyl-2-thenoylthiohydroxamic acid; and N-tolyl-2-thenoylthiohydroxamic acid.

N—S Valence Stabilizer #11: Examples of alpha- or ortho-aminothiocarboxylic acids, and alpha- or ortho-aminothiodicarboxylic acids, and derivatives thereof (N—S Bidentates, N—S Tridentates, and N—S Tetradentates) that meet the requirements for use as “wide band” valence stabilizers for Ce⁺⁴ include, but are not limited to: 2-pyridinethiocarboxylic acid (thiopicolinic acid); 2-pyrazinethiocarboxylic acid; o-aminothiobenzoic acid; o-aminothionaphthoic acid; and 3,6-diaminothiophthalic acid.

N—S Valence Stabilizer #12: Examples of thiosemicarbazones, bis(thiosemicarbazones), and poly(thiosemicarbazones) (N—S Bidentates, N—S Tetradentates, and N—S Hexadentates) that meet the requirements for use as “wide band” valence stabilizers for Ce⁺⁴ include, but are not limited to: acetaldehyde thiosemicarbazone; acetone thiosemicarbazone; pinacolone thiosemicarbazone; benzaldehyde thiosemicarbazone; naphthaldehyde thiosemicarbazone; norbornanone thiosemicarbazone; camphor thiosemicarbazone; nopinone thiosemicarbazone; 2-pyridinaldehyde thiosemicarbazone; salicylaldehyde thiosemicarbazone; quinolinaldehyde thiosemicarbazone; isatin dithiosemicarbazone; camphorquinone dithiosemicarbazone; camphorquinone dithiosemicarbazone; picolinaldehyde thiosemicarbazone; dipyridyl glyoxal dithiosemicarbazone; di-2-pyridyl ketone thiosemicarbazone; methyl-2-pyridyl ketone thiosemicarbazone; glyoxal dithiosemicarbazone; acetophenone thiosemicarbazone; biacetyl monoxime thiosemicarbazone; acetamidobenzaldehyde thiosemicarbazone; thymolaldothiosemicarbazone; thiophene-2-aldehyde thiosemicarbazone; phthalaldehyde dithiosemicarbazone; phthalimide dithiosemicarbazone; furaldehyde thiosemicarbazone; naphthoquinone thiosemicarbazone; phenanthrequinone thiosemicarbazone; cyclohexanedione dithiosemicarbazone; ionone thiosemicarbazone; bisthiosemicarbazone of diethyl-3,4-dioxadioate; pyridoxal alkylthiosemicarbazones; benzylidene phenylthiosemicarbazones; lawsone thiosemicarbazone; and 1-benzoin-4-phenylthiosemicarbazone (bps).

N—S Valence Stabilizer #13: Examples of thioacyl hydrazones, bis(thioacyl hydrazones), and poly(thioacyl hydrazones) (N—S Bidentates, N—S Tetradentates, and N—S Hexadentates) that meet the requirements for use as “wide band” valence stabilizers for Ce⁺⁴ include, but are not limited to: acetaldehyde N-thioformylhydrazone; acetaldehyde N-thiobenzoylhydrazone; acetone N-thioformylhydrazone; acetone N-thiobenzoylhydrazone; pinacolone N-thioformylhydrazone; pinacolone N-thiobenzoylhydrazone; benzaldehyde N-thioformylhydrazone; benzaldehyde N-thiobenzoylhydrazone; naphthaldehyde N-thioformylhydrazone; naphthaldehyde N-thiobenzoylhydrazone; norbornanone N-thioformylhydrazone; norbornanone N-thiobenzoylhydrazone; camphor N-thioformylhydrazone; camphor N-thiobenzoylhydrazone; nopinone N-thioformylhydrazone; nopinone N-thiobenzoylhydrazone; 2-pyridinaldehyde N-thioformylhydrazone; 2-pyridinaldehyde N-thiobenzoylhydrazone; salicylaldehyde N-thioformylhydrazone; salicylaldehyde N-thiobenzoylhydrazone; quinolinaldehyde N-thioformylhydrazone; quinolinaldehyde N-thiobenzoylhydrazone; thiophene-2-aldehyde N-thioformylhydrazone; thiophene-2-aldehyde N-thiobenzoylhydrazone; naphthoquinone N-thioformylhydrazone; naphthoquinone N-thiobenzoylhydrazone; ionone N-thioformylhydrazone; ionone N-thiobenzoylhydrazone; benzaldehyde benzothiazolehydrazone; lawsone N-thioformylhydrazone; and lawsone N-thiobenzoylhydrazone.

N—S Valence Stabilizer #14: Examples of thiocarbazones (diazenecarbothioic hydrazides), bis(thiocarbazones), and poly(thiocarbazones) (N—S Bidentates, N—S Tetradentates, and N—S Hexadentates) that meet the requirements for use as “wide band” valence stabilizers for Ce⁺⁴ include, but are not limited to: diphenylthiocarbazone (dithizone); 2-phenylthiocarbazone; dinaphthylthiocarbazone; 2-naphthylthiocarbazone; and ambazone.

N—S Valence Stabilizer #15: Examples of azo compounds with thiol or mercapto or thiocarbonyl substitution at the ortho- (for aryl) or alpha- or beta- (for alkyl) positions, Bis[o-(HS—) or alpha- or beta-(HS—)azo compounds], or Poly[o-(HS—) or alpha- or beta-(HS—)azo compounds) (N—S Bidentates, N—S Tridentates, N—S Tetradentates, or N—S Hexadentates) that meet the requirements for use as “wide band” valence stabilizers for Ce⁺⁴ include, but are not limited to: 2-thiolazobenzene [1-(phenylazo)-2-thiophenol]; 2,2′-dithioazobenzene; (2-thiophene)azobenzene; 1-(4-nitrophenylazo)-2-thionaphthol; 2-thiazolylazobenzene; and 2-benzothiazolylazobenzene.

N—S Valence Stabilizer #16: Examples of diazeneformothioamides, diazeneacetothioamides, bis(diazeneformothioamides), bis(diazeneacetothioamides), poly(diazeneformothioamides), and poly(diazeneacetothioamides) (N—S Bidentates, N—S Tetradentates, and N—S Hexadentates) that meet the requirements for use as “wide band” valence stabilizers for Ce⁺⁴ include, but are not limited to: diazeneformothioamide, diazeneacetothioamide, phenyldiazeneformothioamide, diphenyldiazeneformothioamide, phenyldiazeneacetothioamide, and diphenyldiazeneacetothioamide.

N—S Valence Stabilizer #17: Examples of diazenecarbothioic acids, diazenecarbodithioic acids, bis(diazenecarbothioic acids), bis(diazenecarbodithioic acids), poly(diazenecarbothioic acids), poly(diazenecarbodithioic acids) and derivatives thereof (N—S Bidentates, N—S Tetradentates, N—S Hexadentates) that meet the requirements for use as “wide band” valence stabilizers for Ce⁺⁴ include, but are not limited to: diazeneformothioic acid, diazeneacetothioic acid, phenyldiazeneformothioic acid, diphenyldiazeneformothioic acid, phenyldiazeneacetothioic acid, and diphenyldiazeneacetothioic acid.

N—S Valence Stabilizer #18: Examples of diazeneformothioaldehydes, diazeneacetothioaldehydes, bis(diazeneformothioaldehydes), bis(diazeneacetothioaldehydes), poly(diazeneformothioaldehydes), and poly(diazeneacetothioaldehydes) (N—S Bidentates, N—S Tetradentates and N—S Hexadentates) that meet the requirements for use as “wide band” valence stabilizers for Ce⁺⁴ include, but are not limited to: diazeneformothioaldehyde, diazeneacetothioaldehyde, phenyldiazeneformothioaldehyde, diphenyldiazeneformothioaldehyde, phenyldiazeneacetothioaldehyde, and diphenyldiazeneacetothioaldehyde.

N—S Valence Stabilizer #19: Examples of diazenediformothioamides, diazenediacetothioamides, bis(diazenediformothioamides), bis(diazenediacetothioamides), poly(diazenediformothioamides), and poly(diazenediacetothioamides) (N—S Tridentates and N—S Hexadentates) that meet the requirements for use as “wide band” valence stabilizers for Ce⁺⁴ include, but are not limited to: diazenediformodithioamide, diazenediacetodithioamide, diphenydiazenediformodithioamide, tetraphenyldiazenediformodithioamide, diphenyldiazenediacetodithioamide, and tetraphenyldiazenediacetodithioamide.

N—S Valence Stabilizer #20: Examples of diazenedicarbothioic acids, diazenedicarbodithioic acids, bis(diazenedicarbothioic acids), bis(diazenedicarbodithioic acids), poly(diazenedicarbothioic acids), poly(diazenedicarbodithioic acids) and derivatives thereof (N—S Tridentates and N—S Hexadentates) that meet the requirements for use as “wide band” valence stabilizers for Ce⁺⁴ include, but are not limited to: diazenediformothioic acid, diazenediacetodithioic acid, phenyldiazenediformothioic acid, diphenyldiazenediformothioic acid, phenyldiazenediacetodithioic acid, and diphenyldiazenediacetodithioic acid.

N—S Valence Stabilizer #21: Examples of diazenediformothioaldehydes, diazenediacetothioaldehydes, bis(diazenediformothioaldehydes), bis(diazenediacetothioaldehydes), poly(diazenediformothioaldehydes), and poly(diazenediacetothioaldehydes) (N—S Tridentates and N—S Hexadentates) that meet the requirements for use as “wide band” valence stabilizers for Ce⁺⁴ include, but are not limited to: diazenediformothioaldehyde, diazenediacetothioaldehyde, diphenyldiazenediformothioaldehyde, and diphenyldiazenediacetothioaldehyde.

N—S Valence Stabilizer #22: Examples of ortho-thio (or -mercapto) substituted formazans, bis(o-thio or -mercapto substituted formazans), and poly(o-thio or -mercapto substituted formazans) (N—S Bidentates, N—S Tridentates, N—S Tetradentates, and N—S Hexadentates) that meet the requirements for use as “wide band” valence stabilizers for Ce⁺⁴ include, but are not limited to: 1-(2-thiophenyl)-3,5-diphenylformazan; 1-(2-methylmercaptophenyl)-3,5-diphenylformazan; 1,5-bis(2-thiophenyl)-3-phenylformazan; and 5-bis(2-methylmercaptophenyl)-3-phenylformazan.

N—S Valence Stabilizer #23: Examples of ortho-thio (or -mercapto) substituted azines (including ketazines), bis(o-thio or mercapto substituted azines), and poly(o-thio or mercapto substituted azines) (N—S Bidentates, N—S Tridentates, N—S Tetradentates, and N—S Hexadentates) that meet the requirements for use as “wide band” valence stabilizers for Ce⁺⁴ include, but are not limited to: 2-mercapto-1-benzalazine; 2-mercapto-1-naphthalazine; and 2-mercapto-1-cyclohexanonazine.

N—S Valence Stabilizer #24: Examples of Schiff Bases with one Imine (C═N) Group and with ortho- or alpha- or beta-thio or mercapto or thiocarbonyl substitution (N—S Bidentates, N—S Tridentates, N—S Tetradentates, N—S Pentadentates, or N—S Hexadentates) that meet the requirements for use as “wide band” valence stabilizers for Ce⁺⁴ include, but are not limited to: N-(Thiosalicylaldehydo)isopropylamine; N-(2-thiophenecarboxaldehydo)isopropylamine; N-(2-Acetylthiopheno)isopropylamine; N-(2-Thioacetophenono)isopropylamine; N-(Thiosalicylaldehydo)cyclohexylamine; N-(2-Thiophenecarboxaldehydo)cyclohexylamine; N-(2-Acetylthiopheno)cyclohexylamine; N-(2-Thioacetophenono)cyclohexylamine; N-(Thiosalicylaldehydo)aniline; N-(2-Thiophenecarboxaldehydo)aniline; N-(2-Acetylthiopheno)aniline; N-(2-Thioacetophenono)aniline; N-(Thiosalicylaldehydo)aminonorbornane; N-(2-Thiocarboxaldehydo)aminonorbornane; N-(2-Acetylthiopheno)aminonorbornane; N-(2-Thioacetophenono)aminonorbornane; 4-aminobenzylidene-3-propyl-5-mercapto-1,2,4-triazole; 4-aminocinnamalidene-3-propyl-5-mercapto-1,2,4-triazole (acpmt); 4-aminosalicylidene-3-propyl-5-mercapto-1,2,4-triazole (aspmt); 4-aminovanillidene-3-propyl-5-mercapto-1,2,4-triazole; 4-aminodimethylaminobenzylidene-3-propyl-5-mercapto-1,2,4-triazole (adpmt); cinnamylideneaminophenylthiazole; N-(2-mercaptophenyl)salicylidenimine; 2-thiophenecarboxaldehyde phenylhydrazone; 2-thiophenecarboxaldehyde 2-pyridyl hydrazone; 2-mercaptobenzaldehyde phenylhydrazone; and 2-mercaptobenzaldehyde 2-pyridyl hydrazone. Also includes Schiff Bases derived from the reaction of carbonyl compounds with dithiocarbazates, and hydrazones with ortho-S substitution.

N—S Valence Stabilizer #25: Examples of Schiff Bases with two Imine (C═N) Groups and with ortho- or alpha- or beta-thio or mercapto or thiocarbonyl substitution (N—S Tridentates, N—S Tetradentates, N—S Pentadentates, or N—S Hexadentates) that meet the requirements for use as “wide band” valence stabilizers for Ce⁺⁴ include, but are not limited to: N,N′-(2,5-Thiophenedicarboxaldehydo)diisopropylamine; N,N′-(2,5-Thiophenedicarboxaldehydo)dicyclohexylamine; N,N′-(2,5-Thiophenedicarboxaldehydo)dianiline; N,N′-(2,5-Thiophenedicarboxaldehydo)di-aminonorbornane; N,N′-(o-Thiophthalicdialdehydo)diisopropylamine; N,N′-(o-Thiophthalicdialdehydo)dicyclohexylamine; N,N′-(o-Thiophthalicdialdehydo)dianiline; N,N′-(o-Thiophthalicdialdehydo)di-aminonorbornane; N,N′-(o-Thioformylcamphoro)diisopropylamine; N,N′-(o-Thioformylcamphoro)dicyclohexylamine; N,N′-(o-Thioformylcamphoro)dianiline; N,N′-(o-Thioformylcamphoro)di-aminonorbornane; N,N′-(o-Thiodiacetylbenzeno)diisopropylamine; N,N′-(o-Thiodiacetylbenzeno)dicyclohexylamine; N,N′-(o-Thiodiacetylbenzeno)dianiline; N,N′-(o-Thiodiacetylbenzeno)di-aminonorbornane; N,N′-(3,6-Dithio-1,2-cyclohexanono)diisopropylamine; N,N′-(3,6-Dithio-1,2-cyclohexanono)dicyclohexylamine; N,N′-(3,6-Dithio-1,2-cyclohexanono)dianiline; N,N′-(3,6-Dithio-1,2-cyclohexanono)di-aminonorbornane; N,N′-(2,5-Diacetylthiopheno)diisopropylamine; N,N′-(2,5-Diacetylthiopheno)dicyclohexylamine; N,N′-(2,5-Diacetylthiopheno)dianiline; N,N′-(2,5-Diacetylthiopheno)di-aminonorbornane; N,N′-(Thiosalicylaldehydo)ethylenediamine; N,N′-(o-Thionaphthaldehydo)ethylenediamine; N,N′-(o-Thioacetophenono)ethylenediamine;; N,N′-(Thiosalicylaldehydo)trimethylenediamine; N,N′-(o-Thionaphthaldehydo)trimethylenediamine; N,N′-(o-Thioacetophenono)trimethylenediamine;; N,N′-(Thiosalicylaldehydo)cyclohexane-1,2-diamine; N,N′-(o-Thionaphthaldehydo)cyclohexane-1,2-diamine; N,N′-(o-Thioacetophenono)cyclohexane-1,2-diamine; N,N′-(Thiosalicylaldehydo)-1,2-diaminobenzene; N,N′-(o-Thionaphthaldehydo)-1,2-diaminobenzene; and N,N′-(o-Thioacetophenono)-1,2-diaminobenzene. Also includes Schiff Bases derived from the reaction of carbonyl compounds with dithiocarbazates, and hydrazones with ortho-S substitution.

N—S Valence Stabilizer #26: Examples of Schiff Bases with three Imine (C═N) Groups and with ortho- or alpha- or beta-thio or mercapto or thiocarbonyl substitution (N—S Tetradentates, N—S Pentadentates, or N—S Hexadentates) that meet the requirements for use as “wide band” valence stabilizers for Ce⁺⁴ include, but are not limited to: N,N′,N″-(Thiosalicylaldehydo)tris(2-aminoethyl)amine; N,N′,N″-(o-Thionaphthaldehydo)tris(2-aminoethyl)amine; and N,N′,N″-(o-Thioacetophenono)tris(2-aminoethyl)amine. Also includes Schiff Bases derived from the reaction of carbonyl compounds with dithiocarbazates, and hydrazones with ortho-S substitution.

N—S Valence Stabilizer #27: Examples of thioalkyl amines (aminothiols or aminodisulfides) and thioalkyl imines (iminothiols or iminodisulfides) (N—S Bidentates, N—S Tridentates, N—S Tetradentates, and N—S Hexadentates) that meet the requirements for use as “wide band” valence stabilizers for Ce⁺⁴ include, but are not limited to: 2-mercapto-1-aminoethane; 2-methylmercapto-1-aminoethane; 3-mercapto-1-aminopropane; 1-mercapto-2-amino-2-methylpropane; 2-mercaptocyclohexylamine; 3-mercapto-2-aminonorbornane; 1,3-dimercapto-2-aminopropane; 1,5-dimercapto-3-aminopentane; 2,2′-diaminodiethyl sulfide; 3,3′-diaminodipropyl sulfide; 2,2′-diaminodicyclohexyl sulfide; 1,6-dimercapto-3,4-diaminohexane; 1,7-dimercapto-3,5-diaminoheptane; 1,6-diamino-3,4-dimercaptohexane; 1,7-diamino-3,5-dimercaptoheptane; tri(mercaptomethyl)amine; tri(2-mercaptoethyl)amine; dithiooxamide (rubeanic acid); 2,2′-diaminodiethyl disulfide; 3,3′-diaminodipropyl disulfide; 2,2′-diaminodicyclohexyl disulfide; 3-amino-1,5-pentanedithiodialdehyde; 3,4-diamino-1,6-hexanedithiodialdehyde; 3,5-diamino-1,7-heptanedithiodialdehyde; iminobisacetic acid; iminobispropionic acid; and bis(hydroxyethyl)aminoalkyl sulfide.

N—S Valence Stabilizer #28: Examples of thioaryl amines and thioaryl imines (N—S Bidentates, N—S Tridentates, N—S Tetradentates, and N—S Hexadentates) that meet the requirements for use as “wide band” valence stabilizers for Ce⁺⁴ include, but are not limited to: 2-aminothiophenol (2-aminobenzenethiol); 2-aminothiobenzoic acid (thioanthranilic acid); 2-aminothioanisole; 2-(methanamine)benzyl mercaptan [(2-aminomethyl)-alpha-toluenethiol] [(2-mercaptomethyl)-alpha-aminotoluene]; 1-amino-2-naphthalenethiol; 2-amino-1-naphthalenethiol; 2-amino-1-(methyldisulfido)benzene; 2,2′-di(aminomethyl)diphenylthioketone; di(2-amino)phenyl sulfide; di(2-amino)phenyl disulfide (di-ortho-aminophenyl disulfide (doapd)); 1,3-di(2-amino)phenyl-2-mercaptopropane; 1,3-di(3-amino)phenyl-2-mercaptopropane; 1,3-di(2-mercapto)phenyl-2-aminopropane; 1,3-di(3-mercapto)phenyl-2-aminopropane; 2,2′-dimercaptoiminodibenzyl; 2,2′-iminodibenzothioic acid; 2,2′-dimercaptoiminostilbene; and poly(o-aminothiophenol).

N—S Valence Stabilizer #29: Examples of five-membered heterocyclic rings containing one, two, three, or four nitrogen atoms and having at least one additional sulfur atom binding site not in a ring (N—S Bidentates, N—S Tridentates, N—S Tetradentates, or N—S Hexadentates) that meet the requirements for use as “wide band” valence stabilizers for Ce⁺⁴ include, but are not limited to: 2-mercaptopyrrole; 2-(methylthio)methylpyrrole; 2,5-(thiomethyl)pyrrole; 2,5-(methylthiomethyl)pyrrole; 2,6-(methyldisulfidomethyl)pyrrole; imidazoline-2-thione (2-mercaptoimidazole); 2-mercaptothiazoline; 2-mercaptobenzimidazole; 2-mercaptobenzothiazole; 2-mercaptobenzoxazole; 2-thiohydantoin; di-2-pyridylthioglyoxal (2,2′-thiopyridil); bis((1-pyrazolyl)methane)sulfide; bis((1-pyrazolyl)methane)disulfide; bis(2-(1-pyrazolyl)ethane)sulfide; bis(2-(1-pyrazolyl)ethane)disulfide; bis(benzimidazolylmethane)sulfide; bis(benzimidazolylethane)sulfide; bis(benzimidazolylmethane)disulfide; bis(benzimidazolylethane)disulfide; tris(imidazolyl)methanethiol; tris(imidazolylmethane)methanethiol; N-thiomethyl-N,N-(benzimidazolylmethane)amine; N-(2-thioethyl)-N,N-(benzimidazolylmethane)amine; N,N′-di(benzimidazolylmethane)-1,3-diamino-2-mercaptopropane; N,N,N′,N′-tetrakis(benzimidazolylmethane)-1,3-diamino-2-mercaptopropane; bis(N,N-((4-imidazolyl)methane)-2-aminoethane)sulfide; bis(N,N-((4-imidazolyl)methane)-2-aminoethane)disulfide; 2-aminobenzothiazole (abt); 2-phenylaminothiazole; thiohydantoin; thioxohydropyrazole; 2-mercaptobenzothiazole (mbt); 2-mercapto-1,3,4-thiadiazole; 2,5-dimercapto-1,3,4-thiadiazole (bismuthiol); 2,5-bis(alkylthio)-1,3,4-thiadiazole; 2-amino-5-mercapto-1,3,4-thiadiazole (amt); 5-mercaptotetrazole; 1-phenyl-5-mercaptotetrazole (pmt)(5-mptt); 5-mercaptotriazole; 3-mercaptotriazole; (2-benzothiazolyl)thioacetic acid; (2-benzothiazolyl)thiopropionic acid; (alkylthio)benzotriazoles; (arylthio)benzotriazoles; 2-mercaptopyrimidine; bis(5-mercapto-1,2,4-triazol-3-yl); bis(5-mercapto-1,2,4-triazol-3-yl)alkanes; 2-aminothiazolidine; thiazolidine-2-thione; 2-mercaptothiazolidine; 1-(2-mercaptoethyl)imidazoline; imidazolidine-2-thione; 4,5-dihydroxyimidazolidine-2-thione; 4-amino-5-mercapto-1,2,4-triazole; (2-benzimidazolylthio)carboxylic acids; (2-benzoxazolylthio)carboxylic acids; (2-benzothiazolylthio)carboxylic acids; (2-benzimidazolylthio)hydroxyalkyl(aryl)s; (2-benzoxazolylthio)hydroxyalkyl(aryl)s; (2-benzothiazolylthio)hydroxyalkyl(aryl)s; 2-(phenylmethylthio)benzothiazole; 2,5-bis(hydrocarbyldithio 1,3,4-thiadiazoles; 2-(hydrocarbyldithio)-5-mercapto-1,3,4-thiadiazoles; bis(dithiobisthiadiazole); benzothiazolethione; 3-hydrazino-5-thio-1,2,4-triazole; imidazolidine-2,4-dithione; dimercaptobenzothiazole; 2-aminothiazole (atz); thiadiazole-2-thione; 5-mercaptothiadiazole-2-thione; 1,1-thiocarbonyldiimidazole; phosphosphonomethylenethio-1,3-benzothiazole (pmtbt); 4,5-dihydroxyimidazolidine-2-thione; imidazolidine-2-thione; 1,1′-thiocarbonyldiimidazole; 2,2′-dithiobis(benzothiazole); and 5,5′-dithiobis(tetrazole).

N—S Valence Stabilizer #30: Examples of six-membered heterocyclic rings containing one, two, three, or four nitrogen atoms and having at least one additional sulfur atom binding site not in a ring (N—S Bidentates, N—S Tridentates, N—S Tetradentates, or N—S Hexadentates) that meet the requirements for use as “wide band” valence stabilizers for Ce⁺⁴ include, but are not limited to: 4-aminomethyl-3-pyridinemethanethiol (including thiopyridoxamine); 2-mercaptopyridine; 2-(methylthio)methylpyridine; 2-(2-(methylthio)ethyl)pyridine; 2,6-(thiomethyl)pyridine; 2,6-(methylthiomethyl)pyridine; 2,6-(methyldisulfidomethyl)pyridine; 2-mercaptopyrimidine; 2-dithiomethylpyrimidine; 2-mercaptoquinoline; 8-mercaptoquinoline (thioxine); 8-methylthioquinoline; 2-mercaptoquinazoline; thioorotic acid (1,2,3,6-tetrahydro-2,6-dithiono-4-pyrimidinecarboxylic acid) (6-thiouracilcarboxylic acid); 1-methylpyrimidine-2-thione; 2-thiouracil; 2,4-dithiouracil; 6-mercaptopurine; bis(N,N,N′,N′-tetra(2-(2-pyridyl)ethane)aminomethane)sulfide; bis(N,N,N′,N′-tetra(2-(2-pyridyl)ethane)aminomethane)disulfide; bis(N,N,N′,N′-tetra(2-(2-pyridyl)ethane)aminoethane)sulfide; bis(N,N,N′,N′-tetra(2-(2-pyridyl)ethane)aminoethane)disulfide; 1,3,5-triazine-6-thione; 2-benzylmercapto-1,3,5-triazine; triazine dithiols [i.e., 6-(phenylamino)-1,3,5-triazine-2,4-dithiol (ptd); 6-aniline-1,3,5-triazine-2,4-dithiol (atd); and 2-(N,N-dialkylamino)-1,3,5-triazine-4,6-dithiol]; 2-thioquinazoline; 2-thioquinazolin-4-one; thiomorpholin-3-thione; [2-(aminomethyl)thio]pyridine; 6-mercaptopurine; dithiouracil; and 2,2′-dithiodipyridine (2,2′-dipyridyl disulfide).

N—S Valence Stabilizer #31: Examples of five-membered heterocyclic rings containing one or two sulfur atoms and having at least one additional nitrogen atom binding site not in a ring (N—S Bidentates, N—S Tridentates, N—S Tetradentates, or N—S Hexadentates) that meet the requirements for use as “wide band” valence stabilizers for Ce⁺⁴ include, but are not limited to: 2-aminothiophene; 2,5-diaminothiophene; 2-aminomethylthiophene; 2,5-di(aminomethyl)thiophene; 2-aminobenzothiophene; and 2-iminothiolane.

N—S Valence Stabilizer #32: Examples of six-membered heterocyclic rings containing one or two sulfur atoms and having at least one additional nitrogen atom binding site not in a ring (N—S Bidentates, N—S Tridentates, N—S Tetradentates, or N—S Hexadentates) that meet the requirements for use as “wide band” valence stabilizers for Ce⁺⁴ include, but are not limited to: 2-aminothiopyran; 2,6-diaminothiopyran; 2-aminomethylthiopyran; 2,6-di(aminomethyl)thiopyran; and 2-aminobenzothiopyran.

N—S Valence Stabilizer #33: Examples of five-membered heterocyclic rings containing one, two, three, or four nitrogen atoms and having at least one additional sulfur atom binding site in a separate ring (N—S Bidentates, N—S Tridentates, N—S Tetradentates) that meet the requirements for use as “wide band” valence stabilizers for Ce⁺⁴ include, but are not limited to: 2-(2-thiophene)pyrrole; 2,5-di(2-thiophene)pyrrole; 2-(2-thiopyran)pyrrole; 2,5-di(2-thiopyran)pyrrole; 2,5-di(2-pyrrole)thiophene; 2,6-di(2-pyrrole)thiopyran; and 3,5-bis(2-thienyl)-4-amino-1,2,4-triazole (2-tat).

N—S Valence Stabilizer #34: Examples of six-membered heterocyclic rings containing one, two, three, or four nitrogen atoms and having at least one additional sulfur atom binding site in a separate ring (N—S Bidentates, N—S Tridentates, N—S Tetradentates) that meet the requirements for use as “wide band” valence stabilizers for Ce⁺⁴ include, but are not limited to: 2-(2-thiadiazolyl)benzimidazole; 2-(2-thiophene)pyridine; 2,6-di(2-thiophene)pyridine; 2-(2-thiopyran)pyridine; 2,6-di(2-thiopyran)pyridine; 2,5-di(2-pyridyl)thiophene; 2,6-di(2-pyridyl)thiopyran; and 2-(4-thiazolyl)benzimidazole.

N—S Valence Stabilizer #35: Examples of two-, three-, four-, six-, eight-, and ten-membered macrocyclics, macrobicyclics, and macropolycyclics (including catapinands, cryptands, cyclidenes, and sepulchrates) wherein all binding sites are composed of nitrogen (usually amine or imine groups) or sulfur (usually thiols, mercaptans, or thiocarbonyls) and are not contained in component heterocyclic rings (N—S Bidentates, N—S Tridentates, N—S Tetradentates, and N—S Hexadentates) that meet the requirements for use as “wide band” valence stabilizers for Ce⁺⁴ include, but are not limited to: azathiacyclobutane ([4]aneNS); azathiacyclopentane ([5]aneNS); azathiacyclohexane ([6]aneNS); azathiacycloheptane ([7]aneNS); azathiacyclooctane ([8]aneNS); azathiacyclobutene ([4]eneNS); azathiacyclopentene ([5]eneNS); azathiacyclohexene ([6]eneNS); azathiacycloheptene ([7]eneNS); azathiacyclooctene ([8]eneNS); azathiacyclobutadiene ([4]dieneNS); azathiacyclopentadiene ([5]dieneNS); azathiacyclohexadiene ([6]dieneNS); azathiacycloheptadiene ([7]dieneNS); azathiacyclooctadiene ([8]dieneNS); diazathiacyclohexane ([6]aneSN₂); diazathiacycloheptane ([7]aneSN₂); diazathiacyclooctane ([8]aneSN₂); diazathiacyclononane ([9]aneSN₂); diazathiacyclodecane ([10]aneSN₂); diazathiacycloundecane ([11]aneSN₂); diazathiacyclododecane ([12]aneSN₂); diazathiacyclohexene ([6]eneSN₂); diazathiacycloheptene ([7]eneSN₂); diazathiacyclooctene ([8]eneSN₂); diazathiacyclononene ([9]eneSN₂); diazathiacyclodecene ([10]eneSN₂); diazathiacycloundecene ([11]eneSN₂); diazathiacyclododecene ([12]eneSN₂); diazadithiacyclooctane ([8]aneS₂N₂); diazadithiacyclononane ([9]aneS₂N₂); diazadithiacyclodecane ([10]aneS₂N₂); diazadithiacycloundecane ([11]aneS₂N₂); diazadithiacyclododecane ([12]aneS₂N₂); diazadithiacyclotridecane ([13]aneS₂N₂); diazadithiacyclotetradecane ([14]aneS₂N₂); diazadithiacyclopentadecane ([15]aneS₂N₂); diazadithiacyclohexadecane ([16]aneS₂N₂); diazadithiacycloheptadecane ([17]aneS₂N₂); diazadithiacyclooctadecane ([18]aneS₂N₂); diazadithiacyclononadecane ([19]aneS₂N₂); diazadithiacycloeicosane ([20]aneS₂N₂); diazadithiacyclooctadiene ([8]dieneS₂N₂); diazadithiacyclononadiene ([9]dieneS₂N₂); diazadithiacyclodecadiene ([10]dieneS₂N₂); diazadithiacycloundecadiene ([11]dieneS₂N₂); diazadithiacyclododecadiene ([12]dieneS₂N₂); diazadithiacyclotridecadiene ([13]dieneS₂N₂); diazadithiacyclotetradecadiene ([14]dieneS₂N₂); diazadithiacyclopentadecadiene ([15]dieneS₂N₂); diazadithiacyclohexadecadiene ([16]dieneS₂N₂); diazadithiacycloheptadecadiene ([17]dieneS₂N₂); diazadithiacyclooctadecadiene ([18]dieneS₂N₂); diazadithiacyclononadecadiene ([19]dieneS₂N₂); diazadithiacycloeicosadiene ([20]dieneS₂N₂); and tetramethyldithiahexaazacyclobidecanehexaene (mtab).

N—S Valence Stabilizer #36: Examples of four-, six-, eight-, or ten-membered macrocyclics, macrobicyclics, and macropolycyclics (including catapinands, cryptands, cyclidenes, and sepulchrates) wherein all binding sites are composed of nitrogen or sulfur and are contained in component heterocyclic rings (N—S Bidentates, N—S Tridentates, N—S Tetradentates, or N—S Hexadentates) that meet the requirements for use as “wide band” valence stabilizers for Ce⁺⁴ include, but are not limited to: dithiopyrandipyridines; dithiophenedipyrroles; trithiopyrantripyridines; trithiophenetripyrroles; tetrathiopyrantetrapyridines; and tetrathiophenetetrapyrroles.

N—S Valence Stabilizer #37: Examples of four-, six-, eight-, or ten-membered macrocyclics, macrobicyclics, and macropolycydics (including catapinands, cryptands, cyclidenes, and sepulchrates) wherein all binding sites are composed of nitrogen or sulfur and are contained in a combination of heterocyclic rings and amine, imine, thiol, mercapto, or thiocarbonyl groups (N—S Bidentates, N—S Tridentates, N—S Tetradentates, or N—S Hexadentates) that meet the requirements for use as “wide band” valence stabilizers for Ce⁺⁴ include, but are not limited to: azathiatetraphyrins; diazadithiatetraphyrins; azathiahexaphyrins; diazadithiahexaphyrins; and triazatrithiahexaphyrins.

N—O Valence Stabilizer #1: Examples of N-hydroxy(or N,N′-dihydroxy)amidines and N-hydroxy(or N,N′-dihydroxy)diamidines (N—O bidentates, N—O tridentates, or N—O tetradentates) that meet the requirements for use as “wide band” valence stabilizers for Ce⁺⁴ include, but are not limited to: N-hydroxy-N,N′-dimethylformamidine; N-hydroxy-N,N′-diethylformamidine; N-hydroxy-N,N′-diisopropylformamidine; N-hydroxy-N,N′-dibutylformamidine; N-hydroxy-N,N′-diphenylformamidine; N-hydroxy-N,N′-dibenzylformamidine; N-hydroxy-N,N′-dinaphthylformamidine; N-hydroxy-N,N′-dicyclohexylformamidine; N-hydroxy-N,N′-dinorbornylformamidine; N-hydroxy-N,N′-diadamantylformamidine; N-hydroxy-N,N′-dianthraquinonylformamidine; N-hydroxy-N,N′-dimethylacetamidine; N-hydroxy-N,N′-diethylacetamidine; N-hydroxy-N,N′-diisopropylacetamidine; N-hydroxy-N,N′-dibutylacetamidine; N-hydroxy-N,N′-diphenylacetamidine; N-hydroxy-N,N′-dibenzylacetamidine; N-hydroxy-N,N′-dinaphthylacetamidine; N-hydroxy-N,N′-dicyclohexylacetamidine; N-hydroxy-N,N′-dinorbornylacetamidine; N-hydroxy-N,N′-diadamantylacetamidine; N-hydroxy-N,N′-dimethylbenzamidine; N-hydroxy-N,N′-diethylbenzamidine; N-hydroxy-N,N′-diisopropylbenzamidine; N-hydroxy-N,N′-dibutylbenzamidine; N-hydroxy-N,N′-diphenylbenzamidine; N-hydroxy-N,N′-dibenzylbenzamidine; N-hydroxy-N,N′-dinaphthylbenzamidine; N-hydroxy-N,N′-dicyclohexylbenzamidine; N-hydroxy-N,N′-dinorbornylbenzamidine; N-hydroxy-N,N′-diadamantylbenzamidine; N-hydroxy-N,N′-dimethyltoluamidine; N-hydroxy-N,N′-diethyltoluamidine; N-hydroxy-N,N′-diisopropyltoluamidine; N-hydroxy-N,N′-dibutyltoluamidine; N-hydroxy-N,N′-diphenyltoluamidine; N-hydroxy-N,N′-dibenzyltoluamidine; N-hydroxy-N,N′-dinaphthyltoluamidine; N-hydroxy-N,N′-dicyclohexyltoluamidine; N-hydroxy-N,N′-dinorbornyltoluamidine; N-hydroxy-N,N′-diadamantyltoluamidine; N,N-dihydroxyoxalic diamidine; N,N′-dihydroxymalonic diamidine; N,N′-dihydroxysuccinic diamidine; N,N′-dihydroxyglutaric diamidine; N,N′-dihydroxyadipic diamidine; N,N′-dihydroxypimelic diamidine; N,N′-dihydroxysuberic diamidine; N,N′-dihydroxyphthalic diamidine; N,N′-dihydroxyterephthalic diamidine; N,N′-dihydroxyisophthalic diamidine; N,N′-dihydroxypiperazine diamidine.

N—O Valence Stabilizer #2: Examples of guanylureas, guanidinoureas, bis(guanylureas), bis(guanidinoureas), poly(guanylureas), and poly(guanidinoureas) (N—O Bidentates and N—O Tetradentates) that meet the requirements for use as “wide band” valence stabilizers for Ce⁺⁴ include, but are not limited to: guanylurea (amidinourea)(dicyandiamidine); guanidinourea; methylguanylurea; ethylguanylurea; isopropylguanylurea; butylguanylurea; benzylguanylurea; phenylguanylurea; tolylguanylurea; naphthylguanylurea; cyclohexylguanylurea; norbornylguanylurea; adamantylguanylurea; dimethylguanylurea; diethylguanylurea; diisopropylguanylurea; dibutylguanylurea; dibenzylguanylurea; diphenylguanylurea; ditolylguanylurea; dinaphthylguanylurea; dicyclohexylguanylurea; dinorbornylguanylurea; diadamantylguanylurea; ethylenebis(guanylurea); propylenebis(guanylurea); phenylenebis(guanylurea); piperazinebis(guanylurea); oxalylbis(guanylurea); malonylbis(guanylurea); succinylbis(guanylurea); phthalylbis(guanylurea); 2-ureidothiazole; 2-ureidooxazole; 2-ureidoimidazole; 3-ureidopyrazole; 3-ureido-1,2,4-triazole; and 5-ureidotetrazole.

N—O Valence Stabilizer #3: Examples of amidinoamides, guanidinoamides, bis(amidinoamides), bis(guanidinoamides), poly(amidinoamides), and poly(guanidinoamides) (including both N-amidinoamides and 2-amidinoacetamides) (N—O Bidentates, N—O Tridentates, and N—O Tetradentates) that meet the requirements for use as “wide band” valence stabilizers for Ce⁺⁴ include, but are not limited to: amidinoacetamide (1-acetylguanidine); guanidinoacetamide; amidinopropanamide; amidinobutanamide; amidinobenzamide; amidinotoluamide; amidinocyclohexamide; N-methylamidinoacetamide; N-ethylamidinopropanamide; N-propylamidinobutanamide; N-phenylamidinobenzamide; N-tolylamidinotoluamide; N-cyclohexylamidinocyclohexamide; bis(amidinooxamide); bis(amidinomalonamide); bis(amidinosuccinamide); bis(amidinophthalamide); 2-amidinoacetamide (malonamamidine); N-methyl-2-amidinoacetamide; N-ethyl-2-amidinoacetamide; N-phenyl-2-amidinoacetamide; N-benzyl-2-amidinoacetamide; N-cyclohexyl-2-amidinoacetamide; N,N′-dimethyl-2-amidinoacetamide; N,N′-diethyl-2-amidinoacetamide; N,N′-diphenyl-2-amidinoacetamide; N,N′-dibenzyl-2-amidinoacetamide; N,N′-dicyclohexyl-2-amidinoacetamide; 2-N-acylaminothiazole; 2-N-acylaminooxazole; 2-N-acylaminoimidazole; 3-N-acylaminopyrazole; 3-N-acylamino-1,2,4-triazole; and 5-N-acylaminotetrazole.

N—O Valence Stabilizer #4: Examples of imidoylamides, bis(imidoylamides), and poly(imidoylamides) (N—O Bidentates, N—O Tridentates, and N—O Tetradentates) that meet the requirements for use as “wide band” valence stabilizers for Ce⁺⁴ include, but are not limited to: acetimidoylacetamide; acetimidoylpropanamide; acetimidoylbutanamide; acetimidoylbenzamide; acetimidolytoluamide; acetimidoylcyclohexamide; propimidoylpropanamide; butimidoylbutanamide; benzimidoylbenzamide; ethylenebis(acetimidoylacetamide); propylenebis(acetimidoylacetamide); and phenylenebis(acetimidoylacetamide).

N—O Valence Stabilizer #5: Examples of O-amidinocarbamates, bis(O-amidinocarbamates), and poly(O-amidinocarbamates) (N—O Bidentates and N—O Tetradentates) that meet the requirements for use as “wide band” valence stabilizers for Ce⁺⁴ include, but are not limited to: O-amidinocarbamate; N-methyl-O-amidinocarbamate; N-ethyl-O-amidinocarbamate; N-isopropyl-O-amidinocarbamate; N-butyl-O-amidinocarbamate; N-benzyl-O-amidinocarbamate; N-phenyl-O-amidinocarbamate; N-tolyl-O-amidinocarbam ate; N-naphthyl-O-amidinocarbamate; N-cyclohexyl-O-amidinocarbamate; N-norbornyl-O-amidinocarbamate; N-adamantyl-O-amidinocarbamate; N,N′-dimethyl-O-amidinocarbamate; N,N′-diethyl-O-amidinocarbamate; N,N′-diisopropyl-O-amidinocarbamate; N,N′-dibutyl-O-amidinocarbamate; N,N′-dibenzyl-O-amidinocarbamate; N,N′-diphenyl-O-amidinocarbamate; N,N′-ditolyl-O-amidinocarbamate; N,N′-dinaphthyl-O-amidinocarbamate; N,N′-dicyclohexyl-O-amidinocarbamate; N,N′-dinorbornyl-O-amidinocarbamate; N,N′-diadamantyl-O-amidinocarbamate; ethylenebis(O-amidinocarbamate); propylenebis(O-amidinocarbamate); phenylenebis(O-amidinocarbamate); piperazinebis(O-amidinocarbamate); oxalylbis(O-amidinocarbamate); malonylbis(O-amidinocarbamate); succinylbis(O-amidinocarbamate); phthalylbis(O-amidinocarbamate); 2-O-carbamatothiazole; 2-O-carbamatooxazole; 2-O-carbamatoimidazole; 3-O-carbamatopyrazole; 3-O-carbamato-1,2,4-triazole; and 5-carbamatotetrazole.

N—O Valence Stabilizer #6: Examples of S-amidinothiocarbamates, bis(S-amidinothiocarbamates), and poly(S-amidinothiocarbamates) (N—O Bidentates and N—O Tetradentates) that meet the requirements for use as “wide band” valence stabilizers for Ce⁺⁴ include, but are not limited to: S-amidinothiocarbamate; N-methyl-S-amidinothiocarbamate; N-ethyl-S-amidinothiocarbamate; N-isopropyl-S-amidinothiocarbamate; N-butyl-S-amidinothiocarbamate; N-benzyl-S-amidinothiocarbamate; N-phenyl-S-amidinothiocarbamate; N-tolyl-S-amidinothiocarbamate; N-naphthyl-S-amidinothiocarbamate; N-cyclohexyl-S-amidinothiocarbamate; N-norbornyl-S-amidinothiocarbamate; N-adamantyl-S-amidinothiocarbamate; N,N′-dimethyl-S-amidinothiocarbamate; N,N′-diethyl-S-amidinothiocarbamate; N,N′-diisopropyl-S-amidinothiocarbamate; N,N′-dibutyl-S-amidinothiocarbamate; N,N′-dibenzyl-S-amidinothiocarbamate; N,N′-diphenyl-S-amidinothiocarbamate; N,N′-ditolyl-S-amidinothiocarbamate; N,N′-dinaphthyl-S-amidinothiocarbamate; N,N′-dicyclohexyl-S-amidinothiocarbamate; N,N′-dinorbornyl-S-amidinothiocarbamate; N,N′-diadamantyl-S-amidinothiocarbamate; ethylenebis(S-amidinothiocarbamate); propylenebis(S-amidinothiocarbamate); phenylenebis(S-amidinothiocarbamate); piperazinebis(S-amidinothiocarbamate); oxalylbis(S-amidinothiocarbamate); malonylbis(S-amidinothiocarbamate); succinylbis(S-amidinothiocarbamate); phthalylbis(S-amidinothiocarbamate); 2-O-monothiocarbamatothiazole; 2-O-monothiocarbamatooxazole; 2-O-monothiocarbamatoimidazole; 3-O-monothiocarbamatopyrazole; 3-O-monothiocarbamato-1,2,4-triazole; and 5-O-monothiocarbamatotetrazole.

N—O Valence Stabilizer #7: Examples of diimidosulfuric acid, bis(diimidosulfuric acid), and derivatives thereof (N—O Bidentates and N—O Tetradentates) that meet the requirements for use as “wide band” valence stabilizers for Ce⁺⁴ include, but are not limited to: diimidosulfuric acid; O-phenyldiimidosulfuric acid; O-benzyldiimidosulfuric acid, O-cyclohexyldiimidosulfuric acid, O-norbornyldiimidosulfuric acid, O,O′-diphenyldiimidosulfuric acid; O,O′-dibenzyldiimidosulfuric acid, O,O′-dicyclohexyldiimidosulfuric acid, and O,O′-dinorbornyldiimidosulfuric acid.

N—O Valence Stabilizer #8: Examples of phosphorimidic acid, bis(phosphorimidic acid); and poly(phosphorimidic acid), and derivatives thereof (N—O Bidentates, N—O Tetradentates) that meet the requirements for use as “wide band” valence stabilizers for Ce⁺⁴ include, but are not limited to: phosphorimidic acid; O-phenylphosphorimidic acid; O-benzylphosphorimidic acid; O-cyclohexylphosphorimidic acid; O-norbornylphosphorimidic acid; O,O′-diphenylphosphorimidic acid; O,O′-dibenzylphosphorimidic acid; O,O′-dicyclohexylphosphorimidic acid; and O,O′-dinorbornylphosphorimidic acid.

N—O Valence Stabilizer #9: Examples of phosphoric triamides, bis(phosphoric triamides), and poly(phosphoric triamides) (N—O Bidentates and N—O Tetradentates) that meet the requirements for use as “wide band” valence stabilizers for Ce⁺⁴ include, but are not limited to: phosphoric triamide; phosphoramidic dihydrazide; N-phenylphosphoric triamide, N-benzylphosphoric triamide; N-cyclohexylphosphoric triamide; N-norbornylphosphoric triamide; N,N′-diphenylphosphoric triamide, N,N′-dibenzylphosphoric triamide; N,N′-dicyclohexylphosphoric triamide; and N,N′-dinorbornylphosphoric triamide.

N—O Valence Stabilizer #10: Examples of phosphoramidic acid, phosphorodiamidic acid, bis(phosphoramidic acid), bis(phosphorodiamidic acid), poly(phosphoramidic acid), poly(phosphorodiamidic acid), and derivatives thereof (N—O Bidentates and N—O Tetradentates) that meet the requirements for use as “wide band” valence stabilizers for Ce⁺⁴ include, but are not limited to: phosphoramidic acid, phosphorodiamidic acid, phosphoramidohydrazidic acid; phosphorohydrazidic acid; phosphorodihydrazidic acid; O-phenylphosphoramidic acid; O-benzylphosphoramidic acid; O-cyclohexylphosphoramidic acid; O-norbornylphosphoramidic acid; O,O′-diphenylphosphoramidic acid; O,O′-dibenzylphosphoramidic acid; O,O′-dicyclohexylphosphoramidic acid; and O,O′-dinorbornylphosphoramidic acid.

N—O Valence Stabilizer #11: Examples of N-acyl 7-aminobenzylidenimines (N—O Bidentates or N—O Tetradentates) that meet the requirements for use as “wide band” valence stabilizers for Ce⁺⁴ include, but are not limited to: N-acetyl 7-methylaminobenzylidenimine; N-acetyl 7-phenylaminobenzylidenimine; N-benzoyl 7-methylaminobenzylidenimine; and N-benzoyl 7-phenylaminobenzylidenimine.

N—O Valence Stabilizer #12: Examples of oximes, dioximes, and poly(oximes) (N—O Bidentates, N—O Tridentates, and N—O Tetradentates) that meet the requirements for use as “wide band” valence stabilizers for Ce⁺⁴ include, but are not limited to: acetaldoxime (Hado); acetoxime (acetone oxime)(Hato); butanone oxime; pentanone oxime; hexanone oxime; pinacolone oxime; heptanone oxime; octanone oxime; cyclopentanone oxime; cyclohexanone oxime; cycloheptanone oxime; cyclooctanone oxime; cyclopentanedione dioxime; cyclohexanedione dioxime; cycloheptanedione dioxime; cyclooctanedione dioxime; isatin dioxime; benzaldehyde oxime; naphthaldehyde oxime; norbornanone oxime; camphor oxime; dimethylglyoxime (H₂DMG); diethylglyoxime; diisopropylglyoxime; ditertbutylglyoxime; dicyanoglyoxime; dicyanamidoglyoxime; diphenylglyoxime (Hdfg); dibenzylglyoxime; dicyclohexylglyoxime; dinorbornylglyoxime; camphorquinone dioxime (Hcqd); nopinoquinone dioxime (Hnqd); butyraldoxime; propionaldoxime; furildioxime; and thienyldioxime.

N—O Valence Stabilizer #13: Examples of carbonyl oximes, bis(carbonyl oximes), and poly(carbonyl oximes) (N—O Bidentates, N—O Tridentates, and N—O Tetradentates) that meet the requirements for use as “wide band” valence stabilizers for Ce⁺⁴ include, but are not limited to: diacetyl monoxime (2,3-butanedione monoxime); benzil monoxime (1,2-diphenylethanedione monoxime); 1,2-dicyclohexylethanedione monoxime; 1,2-(trifluoromethyl)ethanedione monoxime; 1,2-dinorbornylethanedione monoxime; cyclopentanedione monoxime; cyclohexanedione monoxime; cycloheptanedione monoxime; cyclooctanedione monoxime; camphorquinone oxime; 3-hydroxyiminopentane-2,4-dione; and 4-isonitrosopyralozone.

N—O Valence Stabilizer #14: Examples of imine oximes, bis(imine oximes), and poly(imine oximes) (including 2-nitrogen heterocyclic oximes) (N—O Bidentates, N—O Tridentates, N—O Tetradentates, and N—O Hexadentates) that meet the requirements for use as “wide band” valence stabilizers for Ce⁺⁴ include, but are not limited to: 3-(methylimino)butan-2-one oxime; 4-(methylimino)hexan-3-one oxime; 1,2-diphenyl-2-(methylimino)ethan-1-one oxime; 1,2-diphenyl-2-(phenylimino)ethan-1-one oxime; 1,2-dicyclohexyl-2-(methylimino)ethan-1-one oxime; 1,2-dicyclohexyl-2-(cyclohexylimino)ethan-1-one oxime; 1,2-dinorbornyl-2-(methylimino)ethan-1-one oxime; N,N′-methylenebis-(3-iminobutan-2-one oxime); N,N′-methylenebis-(4-iminohexan-3-one oxime); N,N′-methylenebis-(1,2-diphenyl-2-iminoethan-1-one oxime); N,N′-methylenebis-(1,2-dicyclohexyl-2-iminoethan-1-one oxime); N,N′-methylenebis-(1,2-dinorbornyl-2-iminoethan-1-one oxime); N,N′-ethylenebis-(3-iminobutan-2-one oxime); N,N′-ethylenebis-(4-iminohexan-3-one oxime); N,N′-ethylenebis-(1,2-diphenyl-2-iminoethan-1-one oxime); N,N′-ethylenebis-(1,2-dicyclohexyl-2-iminoethan-1-one oxime); N,N′-ethylenebis-(1,2-dinorbornyl-2-iminoethan-1-one oxime); N,N′-propylenebis-(3-iminobutan-2-one oxime); N,N′-propylenebis-(4-iminohexan-3-one oxime); N,N′-propylenebis-(1,2-diphenyl-2-iminoethan-1-one oxime); N,N′-propylenebis-(1,2-dicyclohexyl-2-iminoethan-1-one oxime); N,N′-propylenebis-(1,2-dinorbornyl-2-iminoethan-1-one oxime); diacetylazine oxime (Hazio); 2-pyridinaldoxime (Hpao); methyl 2-pyridyl ketone oxime; ethyl 2-pyridyl ketoxime; phenyl 2-pyridyl ketone oxime (Hppk); benzyl 2-pyridyl ketoxime; di(2-pyridyl) ketone oxime; methyl 2-pyrrolyl ketone oxime; ethyl 2-pyrrolyl ketone oxime; phenyl 2-pyrrolyl ketone oxime; di(2-pyrrolyl) ketone oxime; and tris(2-aldoximo-6-pyridyl)phosphine.

N—O Valence Stabilizer #15: Examples of hydroxy oximes, bis(hydroxy oximes), and poly(hydroxy oximes) (including 2-oxygen heterocyclic oximes) (N—O Bidentates, N—O Tridentates, N—O Tetradentates, and N—O Hexadentates) that meet the requirements for use as “wide band” valence stabilizers for Ce⁺⁴ include, but are not limited to: 3-hydroxybutan-2-one oxime; 4-hydroxyhexan-3-one oxime; benzoin oxime (bo)(1,2-diphenyl-2-hydroxyethanone oxime); 1,2-di(trifluoromethyl)-2-hydroxyethanone oxime; 1,2-dicyclohexyl-2-hydroxyethanone oxime; 1,2-dinorbornyl-2-hydroxyethanone oxime; salicylaldoxime (so)(saldox); 2-hydroxy-1-naphthaldehyde oxime; 2-furanaldoxime; furildioxime; methyl 2-furanyl ketone oxime; ethyl 2-furanyl ketoxime; phenyl 2-furanyl ketone oxime; benzyl 2-furanyl ketoxime; di(2-furanyl) ketone oxime; and 2,5-(oximinomethyl)phenol.

N—O Valence Stabilizer #16: Examples of amino oximes, bis(amino oximes), and poly(amino oximes) (N—O Bidentates, N—O Tridentates, N—O Tetradentates, and N—O Hexadentates) that meet the requirements for use as “wide band” valence stabilizers for Ce⁺⁴ include, but are not limited to: 3-(methylamino)butan-2-one oxime (HMeabo); 4-(methylamino)hexan-3-one oxime (HEtabo); 1,2-diphenyl-2-(methylamino)ethanone oxime (HPhabo); 1,2-diphenyl-2-(phenylamino)ethanone oxime; 1,2-dicyclohexyl-2-(methylamino)ethanone oxime (HcyHxabo); 1,2-dicyclohexyl-2-(cyclohexylamino)ethanone oxime; 1,2-di(trifluoromethyl)-2-(methylamino)ethanone oxime; 1,2-dinorbornyl-2-(methylamino)ethanone oxime (HNorbabo); N,N′-ethylenebis-(3-aminobutan-2-one oxime)(Haboen); N,N′-ethylenebis-(4-aminohexan-3-one oxime); N,N′-ethylenebis-(1,2-diphenyl-2-aminoethanone oxime); N,N′-ethylenebis-(1,2-dicyclohexyl-2-aminoethanone oxime); N,N′-ethylenebis-(1,2-di(trifluoromethyl)-2-aminoethanone oxime); N,N′-ethylenebis-(1,2-dinorbornyl-2-aminoethanone oxime); N,N′-propylenebis-(3-aminobutan-2-one oxime)(Habopn); N,N′-propylenebis-(4-aminohexan-3-one oxime); N,N′-propylenebis-(1,2-diphenyl-2-aminoethanone oxime); N,N′-propylenebis-(1,2-dicyclohexyl-2-aminoethanone oxime); N,N′-propylenebis-(1,2-di(trifluoromethyl)-2-aminoethanone oxime); N,N′-propylenebis-(1,2-dinorbornyl-2-aminoethanone oxime); 2,2′-iminobis(acetamidoxime); 1-diethylamino-3-butanoxime; and di-2-pyridyl ketone oxime.

N—O Valence Stabilizer #17: Examples of amido oximes, bis(amido oximes), and poly(amido oximes) (N—O Bidentates, N—O Tridentates, N—O Tetradentates, and N—O Hexadentates) that meet the requirements for use as “wide band” valence stabilizers for Ce⁺⁴ include, but are not limited to: formamide oxime; acetamide oxime; propanamide oxime; butanamide oxime; benzamide oxime (Hbamox); naphthamide oxime; diformamide dioxime; salicylamide oxime; and 4-imidazolamide oxime.

N—O Valence Stabilizer #18: Examples of azo oximes, bis(azo oximes), and poly(azo oximes) (N—O Bidentates, N—O Tridentates, N—O Tetradentates, and N—O Hexadentates) that meet the requirements for use as “wide band” valence stabilizers for Ce⁺⁴ include, but are not limited to: acetaldehyde phenylhydrazone oxime; propionaldehyde phenylhydrazone oxime; and benzaldehyde phenylhydrazone oxime. Also includes hydrazone oximes.

N—O Valence Stabilizer #19: Examples of 2-nitrosophenols (o-quinone monoximes) (N—O Bidentates) that meet the requirements for use as “wide band” valence stabilizers for Ce⁺⁴ include, but are not limited to: 2-nitrosophenol; 1-nitroso-2-naphthol (Honn); 2-nitroso-1-naphthol (Htnn); 3-nitrosopyrocatechol; 3,6-dinitrosopyrocatechol; 2-nitrosoresorcinol; 2,4-dinitrosoresorcinol; 2,4,6-trinitrosoresorcinol; 2-nitrosohydroquinone; 2,6-dinitrosohydroquinone; 2,3,5,6-tetranitrosohydroquinone; 4-nitrosopyrogallol; 4,6-dinitrosopyrogallol; 2-nitrosophloroglucinol; 2,4,6-trinitrosophloroglucinol; 7-nitroso-6-hydroxyindazole; Pigment Green 12 (C.I. 10020); Naphthol Green; and nitroso-R-salt.

N—O Valence Stabilizer #20: Examples of 2-nitrophenols (N—O Bidentates) that meet the requirements for use as “wide band” valence stabilizers for Ce⁺⁴ include, but are not limited to: 2-nitrophenol; 2,3-dinitrophenol; 2,4-dinitrophenol; 2,5-dinitrophenol; 2,6-dinitrophenol; 2,4,6-trinitrophenol (picric acid); 2-amino-4,6-dinitrophenol (picramic acid); 1-nitro-2-naphthol; 2-nitro-1-naphthol; 3-nitropyrocatechol; 3,6-dinitropyrocatechol; 2-nitroresorcinol; 2,4-dinitroresorcinol; 2,4,6-trinitroresorcinol (styphnic acid); 2-nitrohydroquinone; 2,6-dinitrohydroquinone; 2,3,5,6-tetranitrohydroquinone; 4-nitropyrogallol; 4,6-dinitropyrogallol; 2-nitrophloroglucinol; 2,4,6-trinitrophloroglucinol; dinitrocresol; 7-nitro-6-hydroxyindazole; Dinoseb; Eosin; Naphthol Yellow; and Martius Yellow.

N—O Valence Stabilizer #21: Examples of hydroxamates (hydroxylamines), bis(hydroxamates), and poly(hydroxamates) (N—O Bidentates, N—O Tetradentates, and N—O Hexadentates) that meet the requirements for use as “wide band” valence stabilizers for Ce⁺⁴ include, but are not limited to: acetohydroxamic acid; propianohydroxamic acid; butyrohydroxamic acid; crotonohydroxamic acid; sorbohydroxamic acid; benzohydroxamic acid (BH₂); toluichydroxamic acid; salicylhydroxamic acid (SH₂); phenylacetohydroxamic acid (PhH₂); anthranilhydroxamic acid (AnH₂); nicotinehydroxamic acid (NicH₂); picolinehydroxamic acid; cyclohexanehydroxamic acid (CH₂); quinoline 8-hydroxamic acid (QH₂); cinnamylhydroxamic acid (CnH₂); oxaldihydroxamic acid (OxalH₂); succinylbis-N-phenylhydroxamic acid (SuH₂); adipylbis-N-phenylhydroxamic acid (AdH₂); glyoxalhydroxamic acid (GH₂); 2-thiophenecarbohydroxamic acid; thenoylhydroxamic acid; N-phenylbenzohydroxamic acid; N-tolylbenzohydroxamic acid; N-phenylacetohydroxamic acid; N-phenyl-2-thenoylhydroxamic acid; N-tolyl-2-thenoylhydroxamic acid; and polyhydroxamic acids.

N—O Valence Stabilizer #22: Examples of N-nitrosohydroxylamines, bis(N-nitrosohydroxylamines), and poly(N-nitrosohydroxylamines) (N—O Bidentates, N—O Tetradentates, and N—O Hexadentates) that meet the requirements for use as “wide band” valence stabilizers for Ce⁺⁴ include, but are not limited to: N-nitrosophenylhydroxylamine (cupferron); N-nitrosonaphthylhydroxylamine (neocupferron); N-nitrosoanthracylhydroxylamine; N-nitroso(2-pyridyl)hydroxylamine; and N-nitroso(2-thiophenyl)hydroxylamine.

N—O Valence Stabilizer #23: Examples of amino acids, ortho-aminocarboxylic acids, peptides, polypeptides, and proteins [N—O Bidentates, N—O Tridentates, and N—O Tetradentates; possibly S—O dentates for sulfur-contg. examples such as penicillamine and cystine] that meet the requirements for use as “wide band” valence stabilizers for Ce⁺⁴ include, but are not limited to: alanine (Ala); arginine (Arg); asparagine (Asn); aspartic acid (Asp); cysteine (Cys); cystine (Cys or Cys.Cys); dihydroxyphenylalanine Dopa); glutamic acid (Glu); glutamine (Gln); glycine (Gly); histidine (His); isoleucine (Ile); leucine (Leu); lysine (Lys); methionine (Met); penicillamine (Pen); phenylalanine (Phe); tolylalanine (tala); proline (Pro); sarcosine; serine (Ser); threonine (Thr); tryptophan (Trp); tyrosine (Tyr); and valine (Val) as amino acid examples; 2-pyridinecarboxylic acid (picolinic acid), 2-pyrazinecarboxylic acid, 2,3-dicarboxypyrazine, and anthranilic acid as ortho-aminocarboxylic acid examples; Gly-GluO; Hgly-Gly; Gly-MetO; Met-GlyO; Gly-TyrO; Ala-HisO; Gly-His-GlyO; Gly-Gly-His; Gly-Leu-TyrO; penta-GlyO; His-His; triaminoisobutyrate; tetra-GlyO; Pro-Gly; and Gly-Met as peptide examples; and azurin, carbonic anhydrase C; carboxypeptidase; concanavalin A; cytochrome b; cytochrome c; erythrocruorin; ferredoxin; haemerythrin; haemoglobin; myoglobin; parvalbumin; albumin; plastocyanin; rubredoxin; superoxide dismutase; thermolysin; and trysin as protein examples; N-acylamino acids; aminocaproic acid; and 3,5-diiodotyrosine.

N—O Valence Stabilizer #24: Examples of amides, bis(amides), and poly(amides), including lactams (N—O bidentates, N—O tridentates, and N—O tetradentates) that meet the requirements for use as “wide band” valence stabilizers for Ce⁺⁴ include, but are not limited to: acetamide; propionamide; butanamide; benzamide (benzoylamide)(1-phenylformamide); 1-naphthylformamide; toluamide; 1-cyclohexylformamide); 1-norbornylformamide; 1-adamantylformamide; N,N-dimethylformamide (DMF)(DMFA); N,N-dimethylacetamide (DMAC); N,N-dimethylbenzamide; N,N-diethylformamide; N,N-diethylacetamide; decanamide; dodecanamide; tetradecanamide; hexadecanamide; octadecanamide; lactobionic acid amide; (hydroxyalkylthio)succinamides; (mercaptoalkoxy)succinamides; bis(1,1′-benzotriazolyl)dicarboxamide; nicotinamide; acetanilide (N-phenylacetamide); formanilide (N-phenylformamide); benzanilide (N-phenylbenzamide); polycaproamides; glycinamide; aminoalkylanilides; amidopolyamines (apa); bis(1-phenylethylamide); oxalic semiamide; malonic semiamide; succinic semiamide; N-methylformanilide; acetanilide; nicotinanilide; 4′-hydroxyacetanilide (acetaminophen); 2-pyrrolidone; methyl-2-pyrrolidone (NMP); 2-piperidone (valerolactam); caprolactam; polymethylenepolyamine dipropionamide; polyacrylamides; polypyrrolidones [including polyvinylpyrrolidone (povidone)(PVP)]; pyrazolidinones; pyrazolones; diazepinones; N-alkylazaalkene lactams; and N-(2-hydroxyalkyl)azaalkene lactams.

N—O Valence Stabilizer #25: Examples of semicarbazones, bis(semicarbazones), and poly(semicarbazones) (N—O Bidentates, N—O Tetradentates, and N—O Hexadentates) that meet the requirements for use as “wide band” valence stabilizers for Ce⁺⁴ include, but are not limited to: acetaldehyde semicarbazone; acetone semicarbazone; pinacolone semicarbazone; benzaldehyde semicarbazone; naphthaldehyde semicarbazone; norbornanone semicarbazone; camphor semicarbazone; nopinone semicarbazone; 2-pyridinaldehyde semicarbazone; salicylaldehyde semicarbazone; quinolinaldehyde semicarbazone; isatin disemicarbazone; camphorquinone disemicarbazone; camphorquinone disemicarbazone; picolinaldehyde semicarbazone; dipyridyl glyoxal disemicarbazone; di-2-pyridyl ketone semicarbazone; methyl-2-pyridyl ketone semicarbazone; glyoxal disemicarbazone; acetophenone semicarbazone; biacetyl monoxime semicarbazone; acetamidobenzaldehyde semicarbazone; thymolaldosemicarbazone; thiophene-2-aldehyde semicarbazone; phthalaldehyde disemicarbazone; phthalimide disemicarbazone; furaldehyde semicarbazone; naphthoquinone semicarbazone; phenanthrequinone semicarbazone; cyclohexanedione disemicarbazone; ionone semicarbazone; bissemicarbazone of diethyl-3,4-dioxadioate; and lawsone semicarbazone.

N—O Valence Stabilizer #26: Examples of acyl hydrazones, bis(acyl hydrazones), and poly(acyl hydrazones) (N—O Bidentates, N—O Tetradentates, and N—O Hexadentates) that meet the requirements for use as “wide band” valence stabilizers for Ce⁺⁴ include, but are not limited to: acetaldehyde N-formylhydrazone; acetaldehyde N-benzoylhydrazone; acetone N-formylhydrazone; acetone N-benzoylhydrazone; pinacolone N-formylhydrazone; pinacolone N-benzoylhydrazone; benzaldehyde N-formylhydrazone; benzaldehyde N-benzoylhydrazone; naphthaldehyde N-formylhydrazone; naphthaldehyde N-benzoylhydrazone; norbomanone N-formylhydrazone; norbornanone N-benzoylhydrazone; camphor N-formylhydrazone; camphor N-benzoylhydrazone; nopinone N-formylhydrazone; nopinone N-benzoylhydrazone; 2-pyridinaldehyde N-formylhydrazone; 2-pyridinaldehyde N-benzoylhydrazone; salicylaldehyde N-formylhydrazone; salicylaldehyde N-benzoylhydrazone; quinolinaldehyde N-formylhydrazone; quinolinaldehyde N-benzoylhydrazone; furan-2-aldehyde N-formylhydrazone; furan-2-aldehyde N-benzoylhydrazone; naphthoquinone N-formylhydrazone; naphthoquinone N-benzoylhydrazone; ionone N-formylhydrazone; ionone N-benzoylhydrazone; lawsone N-formylhydrazone; and lawsone N-benzoylhydrazone.

N—O Valence Stabilizer #27: Examples of carbazones (diazenecarboxylic hydrazides), bis(carbazones), and poly(carbazones) (N—O Bidentates, N—O Tetradentates, and N—O Hexadentates) that meet the requirements for use as “wide band” valence stabilizers for Ce⁺⁴ include, but are not limited to: diphenylcarbazone; 2-phenylcarbazone; dinaphthylcarbazone; and 2-naphthylcarbazone.

N—O Valence Stabilizer #28: Examples of azo compounds with hydroxyl or carboxy or carbonyl substitution at the ortho- (for aryl) or alpha- or beta- (for alkyl) positions, Bis[o-(HO—) or alpha- or beta-(HO—)azo compounds], or Poly[o-(HO—) or alpha- or beta-(HO—)azo compounds) (N—O Bidentates, N—O Tridentates, N—O Tetradentates, or N—O Hexadentates) that meet the requirements for use as “wide band” valence stabilizers for Ce⁺⁴ include, but are not limited to: 2-hydroxyazobenzene [1-(phenylazo)-2-phenol]; 2,2′-dihydroxyazobenzene (o,o′-dihydroxyazobenzene); (2-furan)azobenzene; Direct Blue 2B; 1-(4-nitrophenylazo)-2-naphthol; 1-(2-hydroxyphenylazo)-2-naphthol; 1-(2-methoxyphenylazo)-2-naphthol; pyridineazo-2-naphthol (PAN); pyridineazoresorcinol (PAR); 1-phenyl-4-(2-hydroxyphenylazo)-5-pyrazolone; 1-phenyl-4-(2-methoxyphenylazo)-5-pyrazolone; o-hydroxy-o′-(beta-aminoethylamino)azobenzene; 2-hydroxy-2′-methoxymethyleneoxyazobenzene; methyl red; turquoise blue (reactive blue); sunset yellow; amaranth; tartrazine; Eriochrome Black T; tropeolins; Allura Red; amaranth; Acid Alizarin Violet N; Acid Blue 29; Acid Orange 8, 63, and 74; Acid Red 1, 4, 8, 37, 88, 97, 114, 151, and 183; Acid Violet 7; Acid Yellow 25, 29, 34, 42, 76, and 99; Brilliant Black BN; Brilliant Crocein; Bordeaux R; Calcion; Chicago Sky Blue; Chromotrope; Cibacron Brilliant Red; Cibacron Brilliant Yellow; Crocein Orange; Crystal Scarlet; Calmagite; Direct Blue 71; Direct Red 23, 80, and 81; Direct Violet 51; Direct Yellow 8 and 27; Fast Black; Flavazin; Mordant Blue 9; Mordant Brown 1 and 33; Napthol Blue Black; New Coccine; Nitrazine Yellow; Nitrosulfonazo III; Orange II; Orange G, OT, and B; Ponceau 3R and SX; Polar Yellow; 2-oxazolylazobenzene; and 2-benzoxazolylazobenzene.

N—O Valence Stabilizer #29: Examples of diazeneformamides, diazeneacetamides, bis(diazeneformamides), bis(diazeneacetamides), poly(diazeneformamides), and poly(diazeneacetamides) (N—O Bidentates, N—O Tetradentates, and N—O Hexadentates) that meet the requirements for use as “wide band” valence stabilizers for Ce⁺⁴ include, but are not limited to: diazeneformamide, diazeneacetamide, phenyldiazeneformamide, diphenyldiazeneformamide, phenyldiazeneacetamide, and diphenyldiazeneacetamide.

N—O Valence Stabilizer #30: Examples of diazeneformic acids, diazeneacetic acids, bis(diazeneformic acids), bis(diazeneacetic acids), poly(diazeneformic acids), poly(diazeneacetic acids) and derivatives thereof (N—O Bidentates, N—O Tetradentates, N—O Hexadentates) that meet the requirements for use as “wide band” valence stabilizers for Ce⁺⁴ include, but are not limited to: diazeneformic acid, diazeneacetic acid, phenyldiazeneformic acid, diphenyldiazeneformic acid, phenyldiazeneacetic acid, and diphenyldiazeneacetic acid.

N—O Valence Stabilizer #31: Examples of diazeneformaldehydes, diazeneacetaldehydes, bis(diazeneformaldehydes), bis(diazeneacetaldehydes), poly(diazeneformaldehydes), and poly(diazeneacetaldehydes) (N—O Bidentates, N—O Tetradentates and N—O Hexadentates) that meet the requirements for use as “wide band” valence stabilizers for Ce⁺⁴ include, but are not limited to: diazeneformaldehyde, diazeneacetaldehyde, phenyldiazeneformaldehyde, diphenyldiazeneformaldehyde, phenyldiazeneacetaldehyde, and diphenyldiazeneacetaldehyde.

N—O Valence Stabilizer #32: Examples of diazenediformamides, diazenediacetamides, bis(diazenediformamides), bis(diazenediacetamides), poly(diazenediformamides), and poly(diazenediacetamides) (N—O Tridentates and N—O Hexadentates) that meet the requirements for use as “wide band” valence stabilizers for Ce⁺⁴ include, but are not limited to: diazenediformamide, diazenediacetamide, diphenydiazenediformamide, tetraphenyldiazenediformamide, diphenyldiazenediacetamide, and tetraphenyldiazenediacetamide.

N—O Valence Stabilizer #33: Examples of diazenediformic acids, diazenediacetic acids, bis(diazenediformic acids), bis(diazenediacetic acids), poly(diazenediformic acids), poly(diazenediacetic acids) and derivatives thereof (N—O Tridentates and N—O Hexadentates) that meet the requirements for use as “wide band” valence stabilizers for Ce⁺⁴ include, but are not limited to: diazenediformic acid, diazenediacetic acid, phenyldiazenediformic acid, diphenyldiazenediformic acid, phenyldiazenediacetic acid, and diphenyldiazenediacetic acid.

N—O Valence Stabilizer #34: Examples of diazenediformaldehydes, diazenediacetaldehydes, bis(diazenediformaldehydes), bis(diazenediacetaldehydes), poly(diazenediformaldehydes), and poly(diazenediacetaldehydes) (N—O Tridentates and N—O Hexadentates) that meet the requirements for use as “wide band” valence stabilizers for Ce⁺⁴ include, but are not limited to: diazenediformaldehyde, diazenediacetaldehyde, diphenyldiazenediformaldehyde, and diphenyldiazenediacetaldehyde.

N—O Valence Stabilizer #35: Examples of ortho-hydroxy (or -carboxy) substituted formazans, bis(o-hydroxy or -carboxy substituted formazans), and poly(o-hydroxy or -carboxy substituted formazans) (N—O Bidentates, N—O Tridentates, N—O Tetradentates, and N—O Hexadentates) that meet the requirements for use as “wide band” valence stabilizers for Ce⁺⁴ include, but are not limited to: 1-(2-hydroxyphenyl)-3,5-diphenylformazan; 1-(2-methoxyphenyl)-3,5-diphenylformazan; 1,5-bis(2-hydroxyphenyl)-3-phenylformazan; and 5-bis(2-methoxyphenyl)-3-phenylformazan.

N—O Valence Stabilizer #36: Examples of ortho-hydroxy (or -carboxy) substituted azines (including ketazines), bis(o-hydroxy or carboxy substituted azines), and poly(o-hydroxy or carboxy substituted azines) (N—O Bidentates, N—O Tridentates, N—O Tetradentates, and N—O Hexadentates) that meet the requirements for use as “wide band” valence stabilizers for Ce⁺⁴ include, but are not limited to: 2-hydroxy-1-benzalazine; 2-hydroxy-1-naphthalazine; and 2-hydroxy-1-cyclohexanonazine.

N—O Valence Stabilizer #37: Examples of Schiff Bases with one Imine (C═N) Group and with ortho- or alpha- or beta-hydroxy or carboxy or carbonyl substitution (N—O Bidentates, N—O Tridentates, N—O Tetradentates, N—O Pentadentates, or N—O Hexadentates) that meet the requirements for use as “wide band” valence stabilizers for Ce⁺⁴ include, but are not limited to: N-(Salicylaldehydo)isopropylamine; N-(2-Furfuralo)isopropylamine; N-(2-Acetylfurano)isopropylamine; N-(2-Hydroxyacetophenono)isopropylamine; N-(Pyridoxalo)isopropylamine; N-(Salicylaldehydo)cyclohexylamine; N-(2-Furfuralo)cyclohexylamine; N-(2-Acetylfurano)cyclohexylamine; N-(2-Hydroxyacetophenono)cyclohexylamine; N-(Pyridoxalo)cyclohexylamine; N-(Salicylaldehydo)aniline; N-(2-Furfuralo)aniline (Stenhauz salt); N-(2-Acetylfurano)aniline; N-(2-Hydroxyacetophenono)aniline; N-(Pyridoxalo)aniline; N-(Salicylaldehydo)aminonorbornane; N-(2-Furfuralo)aminonorbornane; N-(2-Acetylfurano)aminonorbornane; N-(2-Hydroxyacetophenono)aminonorbornane; N-(Pyridoxalo)aminonorbornane; (Salicylaldehydo)anisidine; 2-salicylideneiminobenzothiazole; (Salicylaldehydo)sulfamethazine; N′-histidine-3-methoxysalicylidenimine (V-his); N-(o-carboxybenzaldehydo)-2-aminophenol; N-(salicylaldehydo)isatin; N-(2-furfuralo)isatin; N-(2-acetylfurano)isatin; N-(pyridoxalo)isatin; N-(2-hydroxyacetophenono)isatin; hydrofuramide; 2-furancarboxaldehyde phenylhydrazone; 2-furancarboxaldehyde 2-pyridyl hydrazone; salicylaldehyde phenylhydrazone; and salicylaldehyde 2-pyridyl hydrazone. Also includes hydrazones with ortho-O substitution.

N—O Valence Stabilizer #38: Examples of Schiff Bases with two Imine (C═N) Groups and with ortho- or alpha- or beta-hydroxy or carboxy or carbonyl substitution (N—O Tridentates, N—O Tetradentates, N—O Pentadentates, or N—O Hexadentates) that meet the requirements for use as “wide band” valence stabilizers for Ce⁺⁴ include, but are not limited to: N,N′-(2,5-Furandicarboxaldehydo)diisopropylamine; N,N′-(2,5-Furandicarboxaldehydo)dicyclohexylamine; N,N′-(2,5-Furandicarboxaldehydo)dianiline; N,N′-(2,5-Furandicarboxaldehydo)di-aminonorbornane; N,N′-(o-Hydroxyphthalicdialdehydo)diisopropylamine; N,N′-(o-Hydroxyphthalicdialdehydo)dicyclohexylamine; N,N′-(o-Hydroxyphthalicdialdehydo)dianiline; N,N′-(o-Hydroxyphthalicdialdehydo)di-aminonorbornane; N,N′-(o-Hydroxyformylcamphoro)diisopropylamine; N,N′-(o-Hydroxyformylcamphoro)dicyclohexylamine; N,N′-(o-Hydroxyformylcamphoro)dianiline; N,N′-(o-Hydroxyformylcamphoro)di-aminonorbornane; N,N′-(o-Hydroxydiacetylbenzeno)diisopropylamine; N,N′-(o-Hydroxydiacetylbenzeno)dicyclohexylamine; N,N′-(o-Hydroxydiacetylbenzeno)dianiline; N,N′-(o-Hydroxydiacetylbenzeno)di-aminonorbornane; N,N′-(3,6-Dihydroxy-1,2-cyclohexanono)diisopropylamine; N,N′-(3,6-Dihydroxy-1,2-cyclohexanono)dicyclohexylamine; N,N′-(3,6-Dihydroxy-1,2-cyclohexanono)dianiline; N,N′-(3,6-Dihydroxy-1,2-cyclohexanono) di-aminonorbornane; N,N′-(2,5-Diacetylfurano)diisopropylamine; N,N′-(2,5-Diacetylfurano)dicyclohexylamine; N,N′-(2,5-Diacetylfurano)dianiline; N,N′-(2,5-Diacetylfurano)di-aminonorbornane; N,N′-(Salicylaldehydo)ethylenediamine; N,N′-(o-Hydroxynaphthaldehydo)ethylenediamine; N,N′-(o-Hydroxyacetophenono)ethylenediamine; N,N′-(Salicylaldehydo)trimethylenediamine; N,N′-(o-Hydroxynaphthaldehydo)trimethylenediamine; N,N′-(o-Hydroxyacetophenono)trimethylenediamine; N,N′-(Salicylaldehydo)cyclohexane-1,2-diamine; N,N′-(o-Hydroxynaphthaldehydo)cyclohexane-1,2-diamine; N,N′-(o-Hydroxyacetophenono)cyclohexane-1,2-diamine; N,N′-(Salicylaldehydo)-1,2-diaminobenzene; N,N′-(o-Hydroxynaphthaldehydo)-1,2-diaminobenzene; N,N′-(o-Hydroxyacetophenono)-1,2-diaminobenzene; N,N′-bis(salicylaldehydo)-1,12-diaminododecane (Saldn); N,N′-bis(3-methoxysalicylaldehydo)-o-phenyldiamine; N,N′-bis(3,4-difluorobenzaldehydo)-4,4′-benzidine; and N,N′-phenylenebis(3-methoxysalicylidenimine) (V-ph-V). Also includes hydrazones with ortho-O substitution.

N—O Valence Stabilizer #39: Examples of Schiff Bases with three Imine (C═N) Groups and with ortho- or alpha- or beta-hydroxy or carboxy or carbonyl substitution (N—O Tetradentates, N—O Pentadentates, or N—O Hexadentates) that meet the requirements for use as “wide band” valence stabilizers for Ce⁺⁴ include, but are not limited to: N,N′,N″-(Salicylaldehydo)tris(2-aminoethyl)amine; N,N′,N″-(o-Hydroxynaphthaldehydo)tris(2-aminoethyl)amine; and N,N′,N″-(o-Hydroxyacetophenono)tris(2-aminoethyl)amine. Also includes hydrazones with ortho-O substitution.

N—O Valence Stabilizer #40: Examples of silylaminoalcohols (N—O Bidentates, N—O Tridentates, N—O Tetradentates, and N—O Hexadentates) that meet the requirements for use as “wide band” valence stabilizers for Ce⁺⁴ include, but are not limited to: silatranes.

N—O Valence Stabilizer #41: Examples of hydroxyalkyl imines (imino alcohols) (N—O Bidentates, N—O Tridentates, N—O Tetradentates, and N—O Hexadentates) that meet the requirements for use as “wide band” valence stabilizers for Ce⁺⁴ include, but are not limited to: 2-hydroxycyclohexylimine; 3-hydroxy-2-iminonorbornane; 2,2′-diiminodicyclohexyl ether; oxamide; 3-imino-1,5-pentanedialdehyde; iminodiacetic acid; and iminodipropionic acid.

N—O Valence Stabilizer #42: Examples of hydroxyaryl amines and hydroxyaryl imines (N—O Bidentates, N—O Tridentates, N—O Tetradentates, and N—O Hexadentates) that meet the requirements for use as “wide band” valence stabilizers for Ce⁺⁴ include, but are not limited to: 2-aminophenol; 2-aminobenzoic acid (anthranilic acid); 2-aminoanisole; o-phenetidine; o-anisidine; 2-hydroxymethylpalpha-aminotoluene; 1-amino-2-naphthol; 2-amino-1-naphthol; 2,2′-di(aminomethyl)diphenylketone; isophoronediamine; tris-2,4,6-dimethylaminomethyl phenol; di(2-amino)phenyl ether; 1,3-di(2-amino)phenyl-2-hydroxypropane; 1,3-di(3-amino)phenyl-2-hydroxypropane; 1,3-di(2-hydroxy)phenyl-2-aminopropane; 1,3-di(3-hydroxy)phenyl-2-aminopropane; 2,2′-dihydroxyiminodibenzyl; 2,2′-iminodibenzoic acid; 2,2′-dihydroxyiminostilbene; poly(o-phenetidine); poly(o-aminophenol); poly(o-anisidine); and 3-(anilino)propionamide.

N—O Valence Stabilizer #43: Examples of five-membered heterocyclic rings containing one, two, three, or four nitrogen atoms and having at least one additional oxygen atom binding site not in a ring (N—O Bidentates, N—O Tridentates, N—O Tetradentates, or N—O Hexadentates) that meet the requirements for use as “wide band” valence stabilizers for Ce⁺⁴ include, but are not limited to: 2-hydroxypyrrole; 2-(methylhydroxy)methylpyrrole; 2,5-(hydroxymethyl)pyrrole; 2,5-(methylhydroxymethyl)pyrrole; imidazoline-2-one (2-hydroxyimidazole); 2-hydroxythiazoline; 2-hydroxybenzimidazole; 2-hydroxybenzothiazole; 2-hydroxybenzoxazole; 2-hydantoin; di-2-pyridylglyoxal (2,2′-pyridil); bis((1-pyrazolyl)methane)ether; bis(2-(1-pyrazolyl)ethane)ether; bis(benzimidazolylmethane)ether; bis(benzimidazolylethane)ether; tris(imidazolyl)methanol; tris(imidazolylmethane)methanol; N-hydroxymethyl-N,N-(benzimidazolylmethane)amine; N-(2-hydroxyethyly)-N,N-(benzimidazolylmethane)amine; N,N′-di(benzimidazolylmethane)-1,3-diamino-2-hydroxypropane; N,N,N′,N′-tetrakis(benzimidazolylmethane)-1,3-diamino-2-hydroxypropane; bis(N,N-((4-imidazolyl)methane)-2-aminoethane)ether; 4-carboxybenzotriazole; antipyrine; 4-aminoantipyrine (aap); hydantoin; aminoalkylhydantoins; 2,5-oxazolidinedione; benzyldibenzoyltriazole (bdbt); 5-hydroxymethylimidazole; dicarboxyalkylbenzotriazoles; bis(hydroxyphenyl)aminotriazoles; pyrrole-2-carboxaldehyde; (oxopyrrolidinylalkyl)triazoles; alkoxybenzotriazoles; aryloxybenzotriazoles; 3-salicylamido-4,5-dihydro-1,2,4-triazole; 5-(alkoxy)benzotriazole; (polyoxyalkylene)oxazolidines; 1-(dialkylaminomethyl)-5-carboxyalkylbenzotriazole; 1-(2-hydroxyethyl)imidazoline; 1-acetoxyimidazole; 1-acetylimidazole; benzotriazolecarboxylic acid; poly(oxyalkylated)pyrazoles; poly(oxyalkylated)thiadiazoles; 1,2,4-triazole-3-carboxylic acid; 5-hydroxypyrazole; 3-phenyl-1,2,4-triazol-5-one (ptr); 1-acetylbenzimidazole; 1-[(acetoxy)ethyl]benzimidazole; creatinine; indole-2-carboxylic acid; pyrrole-2-carboxylic acid; imidazole-2-carboxylic acid; pyrazole-2-carboxylic acid; and 1,1′-oxalyldiimidazole.

N—O Valence Stabilizer #44: Examples of six-membered heterocyclic rings containing one, two, three, or four nitrogen atoms and having at least one additional oxygen atom binding site not in a ring (N—O Bidentates, N—O Tridentates, N—O Tetradentates, or N—O Hexadentates) that meet the requirements for use as “wide band” valence stabilizers for Ce⁺⁴ include, but are not limited to: 4-aminomethyl-3-pyridinemethanol (including pyridoxamine); 2-hydroxypyridine; 2-(methylhydroxy)methylpyridine; 2-(2-(methylhydroxy)ethyl)pyridine; 2,6-(hydroxymethyl)pyridine; 2,6-(methylhydroxymethyl)pyridine; 2-hydroxypyrimidine; 2-dihydroxymethylpyrimidine; 2-hydroxyquinoline; 8-hydroxyquinoline (oxine); 8-methylhydroxyquinoline; 2-hydroxyquinazoline; orotic acid (1,2,3,6-tetrahydro-2,6-dioxo-4-pyrimidinecarboxylic acid) (6-uracilcarboxylic acid); 1-methylpyrimidine-2-one; uracil; 6-hydroxypurine; bis(N,N,N′,N′-tetra(2-(2-pyridyl)ethane)aminomethane)ether; bis(N,N,N′,N′-tetra(2-(2-pyridyl)ethane)aminoethane)ether; quinazol-4-one; quinazol-2-one; 5-azathymine; 2-hydroxybenzimidazole (2-hbz); guanine; 1,3,5-triazin-6-one; 6-hydroxy-1,3,5-triazine; 4,6-dihydroxy-1,3,5-triazine; triazine carboxylic acids; 2,3-dihydroxypyridine; thiomorpholin-3-one; hydroxytetrahydropyrimidines; 2-piperazinones; 2-piperidinones; dilituric acid; actinoquinol; caffeine; citrazinic acid; picolinic acid; 2-quinolol; 2,6-dimethoxypyridine; quinoxaline-2-carboxylic acid; flucytosine; hypoxanthine; hexamethylolmelamine; hydroorotic acid; isoorotic acid; xanthine; leucopterin; nitroorotic acid; 8-azaguanine; and cyanuric acid.

N—O Valence Stabilizer #45: Examples of five-membered heterocyclic rings containing one or two oxygen atoms and having at least one additional nitrogen atom binding site not in a ring (N—O Bidentates, N—O Tridentates, N—O Tetradentates, or N—O Hexadentates) that meet the requirements for use as “wide band” valence stabilizers for Ce⁺⁴ include, but are not limited to: 2-aminofuran; 2,5-diaminofuran; 2-aminomethylfuran; 2,5-di(aminomethyl)furan; 2-aminobenzofuran; and 2-amino-1,3-dioxolane.

N—O Valence Stabilizer #46: Examples of six-membered heterocyclic rings containing one or two oxygen atoms and having at least one additional nitrogen atom binding site not in a ring (N—O Bidentates, N—O Tridentates, N—O Tetradentates, or N—O Hexadentates) that meet the requirements for use as “wide band” valence stabilizers for Ce⁺⁴ include, but are not limited to: 2-aminopyran; 2,6-diaminopyran; 2-aminomethylpyran; 2,6-di(aminomethyl)pyran; and 2-aminobenzopyran.

N—O Valence Stabilizer #47: Examples of five-membered heterocyclic rings containing one, two, three, or four nitrogen atoms and having at least one additional oxygen atom binding site in a separate ring (N—O Bidentates, N—O Tridentates, N—O Tetradentates) that meet the requirements for use as “wide band” valence stabilizers for Ce⁺⁴ include, but are not limited to: 2-(2-furan)pyrrole; 2,5-di(2-furan)pyrrole; 2-(2-pyran)pyrrole; 2,5-di(2-pyran)pyrrole; 2,5-di(2-pyrrole)furan; and 2,6-di(2-pyrrole)pyran.

N—O Valence Stabilizer #48: Examples of six-membered heterocyclic rings containing one, two, three, or four nitrogen atoms and having at least one additional oxygen atom binding site in a separate ring (N—O Bidentates, N—O Tridentates, N—O Tetradentates) that meet the requirements for use as “wide band” valence stabilizers for Ce⁺⁴ include, but are not limited to: 2-(2-furan)pyridine; 2,6-di(2-furan)pyridine; 2-(2-pyran)pyridine; 2,6-di(2-pyran)pyridine; 2,5-di(2-pyridyl)furan; 2,6-di(2-pyridyl)pyran; and drometrizole.

N—O Valence Stabilizer #49: Examples of two-, three-, four-, six-, eight-, and ten-membered macrocyclics, macrobicyclics, and macropolycyclics (including catapinands, cryptands, cyclidenes, and sepulchrates) wherein all binding sites are composed of nitrogen (usually amine or imine groups) or oxygen (usually hydroxy, carboxy, or carbonyl groups) and are not contained in component heterocyclic rings (N—O Bidentates, N—O Tridentates, N—O Tetradentates, and N—O Hexadentates) that meet the requirements for use as “wide band” valence stabilizers for Ce⁺⁴ include, but are not limited to: azaoxacyclobutane ([4]aneNO); azaoxacyclopentane ([5]aneNO); azaoxacyclohexane ([6]aneNO); azaoxacycloheptane ([7]aneNO); azaoxacyclooctane ([8]aneNO); azaoxacyclobutene ([4]eneNO); azaoxacyclopentene ([5]eneNO); azaoxacyclohexene ([6]eneNO); azaoxacycloheptene ([7]eneNO); azaoxacyclooctene ([8]eneNO); azaoxacyclobutadiene ([4]dieneNO); azaoxacyclopentadiene ([5]dieneNO); azaoxacyclohexadiene ([6]dieneNO); azaoxacycloheptadiene ([7]dieneNO); azaoxacyclooctadiene ([8]dieneNO); diazaoxacyclohexane ([6]aneON₂); diazaoxacycloheptane ([7]aneON₂); diazaoxacyclooctane ([8]aneON₂); diazaoxacyclononane ([9]aneON₂); diazaoxacyclodecane ([10]aneON₂); diazaoxacycloundecane ([11]aneON₂); diazaoxacyclododecane ([12]aneON₂); diazaoxacyclohexene ([6]eneON₂); diazaoxacycloheptene ([7]eneON₂); diazaoxacyclooctene ([8]eneON₂); diazaoxacyclononene ([9]eneON₂); diazaoxacyclodecene ([10]eneON₂); diazaoxacycloundecene ([11]eneON₂); diazaoxacyclododecene ([12]eneON₂); diazadioxacyclooctane ([8]aneO₂N₂); diazadioxacyclononane ([9]aneO₂N₂); diazadioxacyclodecane ([10]aneO₂N₂); diazadioxacycloundecane ([11]aneO₂N₂); diazadioxacyclododecane ([12]aneO₂N₂); diazadioxacyclotridecane ([13]aneO₂N₂); diazadioxacyclotetradecane ([14]aneO₂N₂); diazadioxacyclopentadecane ([15]aneO₂N₂); diazadioxacyclohexadecane ([16]aneO₂N₂); diazadioxacycloheptadecane ([17]aneO₂N₂); diazadioxacyclooctadecane ([18]aneO₂N₂); diazadioxacyclononadecane ([19]aneO₂N₂); diazadioxacycloeicosane ([20]aneO₂N₂); diazadioxacyclooctadiene ([8]dieneO₂N₂); diazadioxacyclononadiene ([9]dieneO₂N₂); diazadioxacyclodecadiene ([10]dieneO₂N₂); diazadioxacycloundecadiene ([11]dieneO₂N₂); diazadioxacyclododecadiene ([12]dieneO₂N₂); diazadioxacyclotridecadiene ([13]dieneO₂N₂); diazadioxacyclotetradecadiene ([14]dieneO₂N₂); diazadioxacyclopentadecadiene ([15]dieneO₂N₂); diazadioxacyclohexadecadiene ([16]dieneO₂N₂); diazadioxacycloheptadecadiene ([17]dieneO₂N₂); diazadioxacyclooctadecadiene ([18]dieneO₂N₂); diazadioxacyclononadecadiene ([19]dieneO₂N₂); and diazadioxacycloeicosadiene ([20]dieneO₂N₂).

N—O Valence Stabilizer #50: Examples of four-, six-, eight-, or ten-membered macrocyclics, macrobicyclics, and macropolycyclics (including catapinands, cryptands, cyclidenes, and sepulchrates) wherein all binding sites are composed of nitrogen or oxygen and are contained in component heterocyclic rings (N—O Bidentates, N—O Tridentates, N—O Tetradentates, or N—O Hexadentates) that meet the requirements for use as “wide band” valence stabilizers for Ce⁺⁴ include, but are not limited to: dipyrandipyridines; difurandipyrroles; tripyrantripyridines; trifurantripyrroles; tetrapyrantetrapyridines; and tetrafurantetrapyrroles.

N—O Valence Stabilizer #51: Examples of four-, six-, eight-, or ten-membered macrocyclics, macrobicyclics, and macropolycyclics (including catapinands, cryptands, cyclidenes, and sepulchrates) wherein all binding sites are composed of nitrogen or oxygen and are contained in a combination of heterocyclic rings and amine, imine, hydroxy, carboxy, or carbonyl groups (N—O Bidentates, N—O Tridentates, N—O Tetradentates, or N—O Hexadentates) that meet the requirements for use as “wide band” valence stabilizers for Ce⁺⁴ include, but are not limited to: azaoxatetraphyrins; diazadioxatetraphyrins; azaoxahexaphyrins; diazadioxahexaphyrins; and triazatrioxahexaphyrins.

S—O Valence Stabilizer #1: Examples of 1,3-monothioketones (monothio-beta-ketonates), 1,3,5-monothioketones, 1,3,5-dithioketones, bis(1,3-monothioketones), and poly(1,3-monothioketones) (S—O Bidentates, S—O Tridentates, S—O Tetradentates) that meet the requirements for use as “wide band” valence stabilizers for Ce⁺⁴ include, but are not limited to: hexafluoropenta-2-thione-4-ketone; 1,3-diphenyl-1,3-propana-1-thione-3-ketone; benzoylthiopinacolone; cyclohexoylthiocyclohexoylmethane; diphenylpentanedithionate; tetramethylnonanedithionate; hexafluoroheptanedithionate; trifluoroheptanedithionate; 1-(2-thienyl)-butan-1-thione-3-ketone, 1-(2-naphthyl)-butan-1-thione-3-ketone, and trifluoroacetylthiocamphor.

S—O Valence Stabilizer #2: Examples of thiomalonamides (thiomalonodiamides), bis(thiomalonamides), and polythiomalonamides (S—O Bidentates, S—O Tridentates, S—O Tetradentates) that meet the requirements for use as “wide band” valence stabilizers for Ce⁺⁴ include, but are not limited to: thiomalonamide, N-phenylthiomalonamide, N-benzylthiomalonamide, N-pentafluorophenylthiomalonamide, N-cyclohexylthiomalonamide, N-norbomylthiomalonamide, N,N′-diphenylthiomalonamide, N,N′-dibenzylthiomalonamide, N,N′-dipentafluorophenylthiomalonamide, N,N′-dicyclohexylthiomalonamide, and N,N′-norbomylthiomalonamide.

S—O Valence Stabilizer #3: Examples of 2-thioacylacetamides, 2-acylthioacetamides, bis(2-thioacylacetamides), bis(2acylthioacetamides), poly(2-thioacylacetamides), and poly(2-Acylthioacetamides) (S—O Bidentates, S—O Tridentates, S—O Tetradentates) that meet the requirements for use as “wide band” valence stabilizers for Ce⁺⁴ include, but are not limited to: 2-acetothioacetamide, 2-thioacetoacetamide, N-phenyl-2-acetothioacetamide, N-pentafluorophenyl-2-acetothioacetamide, N-benzyl-2-acetothioacetamide, N-cyclohexyl-2-acetothioacetamide, N-norbornyl-2-acetothioacetamide, N-phenyl-2-benzothioacetamide, N-pentafluorophenyl-2-pentafluorobenzothioacetamide, and N-cyclohexyl-2-cyclohexothioacetamide.

S—O Valence Stabilizer #4: Examples of dithiodicarbonic diamides, bis(dithiodicarbonic diamides), and poly(dithiodicarbonic diamides) (S—O Bidentates, S—O Tridentates, S—O Tetradentates) that meet the requirements for use as “wide band” valence stabilizers for Ce⁺⁴ include, but are not limited to: dithiodicarbonic diamide; N-phenyldithiodicarbonic diamide; N-pentafluorophenyldithiodicarbonic diamide; N-benzyldithiodicarbonic diamide; N-cyclohexyldithiodicarbonic diamide; N-norbornyldithiodicarbonic diamide; N,N′-diphenyldithiodicarbonic diamide; N,N′-dipentafluorophenyldithiodicarbonic diamide; N,N′-dibenzyldithiodicarbonic diamide; N,N′-dicyclohexyldithiodicarbonic diamide; and N,N′-dinorbornyldithiodicarbonic diamide.

S—O Valence Stabilizer #5: Examples of monothiohypophosphoric acids, bis(monothiohypophosphoric acids), poly(monothiohypophosphoric acids), and derivatives thereof (S—O Bidentates, S—O Tridentates, S—O Tetradentates) that meet the requirements for use as “wide band” valence stabilizers for Ce⁺⁴ include, but are not limited to: monothiohypophosphoric acid, methylmonothiohypophosphoric acid, isopropylmonothiohypophosphoric acid, tert-butylmonothiohypophosphoric acid, phenylmonothiohypophosphoric acid, pentafluorophenylmonothiohypophosphoric acid, benzylmonothiohypophosphoric acid, cyclohexylmonothiohypophosphoric acid, norbornylmonothiohypophosphoric acid, dimethylmonothiohypophosphoric acid, diisopropylmonothiohypophosphoric acid, di-tert-butylmonothiohypophosphoric acid, diphenylmonothiohypophosphoric acid, di-pentafluorophenylmonothiohypophosphoric acid, dibenzylmonothiohypophosphoric acid, dicyclohexylmonothiohypophosphoric acid, and dinorbornylmonothiohypophosphoric acid.

S—O Valence Stabilizer #6: Examples of monothiohypophosphoramides, bis(monothiohypophosphoramides), and poly(monothiohypophosphoramides) (S—O Bidentates, S—O Tridentates, S—O Tetradentates) that meet the requirements for use as “wide band” valence stabilizers for Ce⁺⁴ include, but are not limited to: monothiohypophosphoramide, N-methylmonothiohypophosphoramide, N-isopropylmonothiohypophosphoramide, N-tert-butylmonothiohypophosphoramide, N-phenylmonothiohypophosphoramide, N-pentafluorophenylmonothiohypophosphoramide, N-benzylmonothiohypophosphoramide, N-cyclohexylmonothiohypophosphoramide, N-norbornylmonothiohypophosphoramide, N,N′″-dimethylmonothiohypophosphoramide, N,N′″-diisopropylmonothiohypophosphoramide, N,N′″-di-tert-butylmonothiohypophosphoramide, N,N′″-diphenylmonothiohypophosphoramide, N,N′″-di-pentafluorophenylmonothiohypophosphoramide, N,N′″-dibenzylmonothiohypophosphoramide, N,N′″-dicyclohexylmonothiohypophosphoramide, and N,N′″-dinorbornylmonothiohypophosphoramide.

S—O Valence Stabilizer #7: Examples of monothioimidodiphosphoric acids, monothiohydrazidodiphosphoric acids, bis(monothioimidodiphosphoric acids), bis(monothiohydrazidodiphosphoric acids), poly(monothioimidodiphosphoric acids), poly(monothiohydrazidodiphosphoric acids), and derivatives thereof (S—O Bidentates, S—O Tridentates, S—O Tetradentates) that meet the requirements for use as “wide band” valence stabilizers for Ce⁺⁴ include, but are not limited to: monothioimidodiphosphoric acid, methylmonothioimidodiphosphoric acid, isopropylmonothioimidodiphosphoric acid, tert-butylmonothioimidodiphosphoric acid, phenylmonothioimidodiphosphoric acid, pentafluorophenylmonothioimidodiphosphoric acid, benzylmonothioimidodiphosphoric acid, cyclohexylmonothioimidodiphosphoric acid, norbornylmonothioimidodiphosphoric acid, dimethylmonothioimidodiphosphoric acid, diisopropylmonothioimidodiphosphoric acid, di-tert-butylmonothioimidodiphosphoric acid, diphenylmonothioimidodiphosphoric acid, di-pentafluorophenylmonothioimidodiphosphoric acid, dibenzylmonothioimidodiphosphoric acid, dicyclohexylmonothioimidodiphosphoric acid, and dinorbornylmonothioimidodiphosphoric acid.

S—O Valence Stabilizer #8: Examples of monothioimidodiphosphoramides, monothiohydrazidodiphosphoramides, bis(monothioimidodiphosphoramides), bis(monothiohydrazidodiphosphoramides), poly(monothioimidodiphosphoramides), and poly(monothiohydrazidodiphosphoramides) (S—O Bidentates, S—O Tridentates, S—O Tetradentates) that meet the requirements for use as “wide band” valence stabilizers for Ce⁺⁴ include, but are not limited to: monothioimidodiphosphoramide, N-methylmonothioimidodiphosphoramide, N-isopropylmonothioimidodiphosphoramide, N-tert-butylmonothioimidodiphosphoramide, N-phenylmonothioimidodiphosphoramide, N-pentafluorophenylmonothioimidodiphosphoramide, N-benzylmonothioimidodiphosphoramide, N-cyclohexylmonothioimidodiphosphoramide, N-norbornylmonothioimidodiphosphoramide, N,N′″-dimethylmonothioimidodiphosphoramide, N,N′″-diisopropylmonothioimidodiphosphoramide, N,N′″-di-tert-butylmonothioimidodiphosphoramide, N,N′″-diphenylmonothioimidodiphosphoramide, N,N′″-di-pentafluorophenylmonothioimidodiphosphoramide, N,N′″-dibenzylmonothioimidodiphosphoramide, N,N′″-dicyclohexylmonothioimidodiphosphoramide, and N,N′″-dinorbornylmonothioimidodiphosphoramide.

S—O Valence Stabilizer #9: Examples of monothiodiphosphoramides, bis(monothiodiphosphoramides), and poly(monothiodiphosphoramides) (S—O Bidentates, S—O Tridentates, S—O Tetradentates) that meet the requirements for use as “wide band” valence stabilizers for Ce⁺⁴ include, but are not limited to: monothiodiphosphoramide, N-methylmonothiodiphosphoramide, N-isopropylmonothiodiphosphoramide, N-tert-butylmonothiodiphosphoramide, N-phenylmonothiodiphosphoramide, N-pentafluorophenylmonothiodiphosphoramide, N-benzylmonothiodiphosphoramide, N-cyclohexylmonothiodiphosphoramide, N-norbornylmonothiodiphosphoramide, N,N′″-dimethylmonothiodiphosphoramide, N,N′″-diisopropylmonothiodiphosphoramide, N,N′″-di-tert-butylmonothiodiphosphoramide, N,N′″-diphenylmonothiodiphosphoramide, N,N′″-di-pentafluorophenylmonothiodiphosphoramide, N,N′″-dibenzylmonothiodiphosphoramide, N,N′″-dicyclohexylmonothiodiphosphoramide, and N,N′″-dinorbornylmonothiodiphosphoramide.

S—O Valence Stabilizer #10: Examples of monothiodiphosphoric acids, bis(monothiodiphosphoric acids), poly(monothiodiphosphoric acids), and derivatives thereof (S—O Bidentates, S—O Tridentates, S—O Tetradentates) that meet the requirements for use as “wide band” valence stabilizers for Ce⁺⁴ include, but are not limited to: monothiodiphosphoric acid, methylmonothiodiphosphoric acid, isopropylmonothiodiphosphoric acid, tert-butylmonothiodiphosphoric acid, phenylmonothiodiphosphoric acid, pentafluorophenylmonothiodiphosphoric acid, benzylmonothiodiphosphoric acid, cyclohexylmonothiodiphosphoric acid, norbornylmonothiodiphosphoric acid, dimethylmonothiodiphosphoric acid, diisopropylmonothiodiphosphoric acid, di-tert-butylmonothiodiphosphoric acid, diphenylmonothiodiphosphoric acid, di-pentafluorophenylmonothiodiphosphoric acid, dibenzylmonothiodiphosphoric acid, dicyclohexylmonothiodiphosphoric acid, and dinorbornylmonothiodiphosphoric acid.

S—O Valence Stabilizer #11: Examples of monothiocarbamates, bis(monothiocarbamates), and poly(monothiocarbamates) (including N-hydroxymonothiocarbamates and N-mercaptomonothiocarbamates) (S—O Bidentates, S—O Tridentates, and S—O Tetradentates) that meet the requirements for use as “wide band” valence stabilizers for Ce⁺⁴ include, but are not limited to: dimethylmonothiocarbamate (dmmtc); di(trifluorodimethyl)monothiocarbamate; diethylmonothiocarbamate (demtc); dipropylmonothiocarbamate; diisopropylmonothiocarbamate; dibutylmonothiocarbamate; ditertbutylmonothiocarbamate; dicyanamidomonothiocarbamate; diphenylmonothiocarbamate; di(pentafluorophenyl)monothiocarbamate; dibenzylmonothiocarbamate; dinaphthylmonothiocarbaamate; dicyclohexylmonothiocarbamate; dinorbornylmonothiocarbamate; diadamantylmonothiocarbamate; pyrrolidinomonothiocarbamate (pyrmtc); piperidinomonothiocarbamate (pipmtc); morpholinomonothiocarbamate (mormtc); thiamorpholinomonothiocarbamate; 3-pyrrolinomonothiocarbamate; pyrrolomonothiocarbamate; oxazolomonothiocarbamate; isoxazolomonothiocarbamate; thiazolomonothiocarbamate; isothiazolomonothiocarbamate; indolomonothiocarbamate; carbazolomonothiocarbamate; pyrazolinomonothiocarbamate; imidazolinomonothiocarbamate; pyrazolomonothiocarbamate; imidazolomonothiocarbamate; indazolomonothiocarbamate; and triazolomonothiocarbamate.

Water-soluble precursors for the organic valence stabilizers are typically used to ensure that sufficient material is available for deposition from aqueous solutions. Identification of suitable water soluble precursors can be difficult because many of these organics do not form a wide range of water-soluble compounds.

As with the inorganic valence stabilizers, crosses between two or more organic valence stabilizers can be used to stabilize Ce⁺⁴ for corrosion protection. For example, in some instances it may be desirable to form a valence stabilizer out of a beta-diketone and an amine ligand. Both of these materials can complex to form a mixed beta-diketone/amine valence stabilizer out of the rinsing or sealing solution during the coating process.

2c) Narrow Band Inorganic Valence Stabilizers for Tetravalent Cerium

Narrow band valence stabilizers can be used to stabilize Ce⁺⁴ for corrosion protection, but they are less typical. Narrow band valence stabilizers exhibit some limitation in their use when compared to wide band stabilizers. They may be toxic or may complex Ce⁺⁴ only with difficulty. These narrow band stabilizers include, but are not limited to, bismuthates, germanates, arsenates, titanates, zirconates, and selenates. For example, valence stabilizers using arsenate are less desirable because their inherent toxicity is very large (greater than Cr⁺⁶), although they may be very effective at inhibiting corrosion when used with Ce⁺⁴. Arsenates can be used as valence stabilizers for Ce⁺⁴ when the toxicity of the rinse or sealing solution is not a factor in its use.

Other narrow band stabilizers may result in Ce⁺⁴-stabilizer complexes with limited stability, an undesirable solubility range, or limited electrostatic characteristics, and they would be useful only in limited applications. Formation of a protective shell of octahedra or icosahedra with borates (B⁺³), aluminates (Al⁺³), and silicates (Si⁺⁴) around the Ce⁺⁴ ion is difficult but possible. These compounds are known to form octahedra or icosahedra, but tend to polymerize in chain-like structures when precipitated from aqueous solution under ambient conditions. These and other narrow band stabilizers can provide some degree of corrosion protection when complexed with Ce⁺⁴, but will not necessarily perform with the same efficiency as the wide band stabilizers by themselves. Combinations of these materials, such as phosphosilicates, aluminosilicates, or borosilicates may also function as narrow band inorganic valence stabilizers.

Narrow band inorganic stabilizers used in combination with wide band inorganic stabilizers described above can be used to provide significant corrosion protection. Conversely, modifications of wide band inorganic valence stabilizers can result in a complex with reduced corrosion inhibition. For example, heteropolymetallates can contain ions in addition to the desired Ce⁺⁴ ion.

The central cavity of the heteropolymetallates can contain ions in addition to the desired Ce⁺⁴ ion. For example, the use of silicomolybdates, phosphomolybdates, silicotungstates, and phosphotungstates is possible. In these Ce⁺⁴-valence stabilizer complexes, Si⁺⁴ or P⁺⁵ ions also occupy the central cavity of the complex with the Ce⁺⁴ ion. The inclusion of additional ions in the central cavity reduces the stability of the complex, and thereby leads to lower corrosion protection. Nonetheless, these complexes also demonstrated some corrosion-inhibiting activity.

The additional ions that can be included within the central cavity of the heteropolymetallates described above depend upon the size of the central cavity, which in turn depends upon the specific chemistry exhibited by an inorganic valence stabilizer (e.g., molybdate, tungstate, periodate, carbonate, etc.). In general, these additional ions must also be small so as to ensure the stability of the formed Ce⁺⁴-valence stabilized complex. Examples of small additional ions include, but are not limited to: B⁺³, Al⁺³, Si⁺⁴, P⁺⁵, Ti⁺⁴, V⁺⁵, V⁺⁴, Cr⁺⁶, Cr⁺⁴, Cr⁺³, Mn⁺⁴, Mn⁺³, Mn⁺², Co⁺², Co⁺³, Fe⁺³, Fe⁺², Ni⁺², Ni⁺³, Ni⁺⁴, Cu⁺², Cu⁺³, Zn⁺², Ga⁺³, Ge⁺⁴, As⁺⁵, As⁺³, and Zr⁺⁴.

Water-soluble precursors for these materials are desirable. Typically, the free acids (e.g., silicomolybdic acid, phosphotungstic acid, borotungstic acid, etc.) offer the most water-soluble precursors for these materials.

2d) Narrow Band Organic Valence Stabilizers for Tetravalent Cerium

Narrow band organic valence stabilizers include those general classes of chemical compounds that result in Ce⁺⁴-valence stabilizer complexes that are either less stable, more soluble in water, or more toxic than the wide band organic stabilizers. As discussed above, the properties of a particular Ce⁺⁴-containing complex can be altered by changing the substituent groups on these general classes of valence stabilizers. This can influence the effectiveness of corrosion inhibition normally achieved using that specific complex.

TABLE 3
Narrow Band Organic Valence Stabilizers for the Ce⁺⁴ Ion

| General Structural Name | |
|---|---|
| (Type of Organic) | Structural Representation |
| N Valence Stabilizer #1: | Macrocyclic ligands containing five, seven, or |
| Five-, Seven-, or Nine-Membered | nine nitrogen binding sites to valence stabilize |
| Macrocyclics, Macrobicyclics, and | the central metal ion. Can include other |
| Macropolycyclics (including Catapinands, | hydrocarbon or ring systems bound to this |
| Cryptands, Cyclidenes, and Sepulchrates) | macrocyclic ligand, but they do not coordinate |
| wherein all Binding Sites are composed of | with the stabilized, high valence metal ion. This |
| Nitrogen (usually amine or imine groups) | ligand and/or attached, uncoordinating |
| and are not contained in Component | hydrocarbons/rings may or may not have |
| Heterocyclic Rings (N—N Tridentates, N—N | halogen or polarizing or water- |
| Tetradentates, and N—N Hexadentates) | insolubilizing/solubilizing groups attached. |
| N Valence Stabilizer #2: | Macrocyclic ligands containing a total of five or |
| Five-, or Seven-Membered Macrocyclics, | seven five-membered heterocyclic rings |
| Macrobicyclics, and Macropolycyclics | containing nitrogen binding sites. Can include |
| (including Catapinands, Cryptands, | other hydrocarbon/ring systems bound to this |
| Cyclidenes, and Sepulchrates) wherein all | macrocyclic ligand, but they do not coordinate |
| Binding Sites are composed of Nitrogen | with the stabilized, high valence metal ion. This |
| and are contained in Component 5- | ligand and/or attached, uncoordinating |
| Membered Heterocyclic Rings (N—N | hydrocarbon/rings may or may not have halogen |
| Tridentates, N—N Tetradentates, or N—N | or polarizing or water-insolubilizing groups |
| Hexadentates) | attached. |
| N Valence Stabilizer #3: | Macrocyclic ligands containing at least one 5- |
| Five-, Seven-, or Nine-Membered | membered heterocyclic ring. These |
| Macrocyclics, Macrobicyclics, and | heterocyclic rings provide nitrogen binding sites |
| Macropolycyclics (including Catapinands, | to valence stabilize the central metal ion. Other |
| Cryptands, Cyclidenes, and Sepulchrates) | amine or imine binding sites can also be |
| wherein all Binding Sites are composed of | included in the macrocyclic ligand, so long as |
| Nitrogen and are contained in a | the total number of binding sites is five, seven, |
| Combination of 5-Membered Heterocyclic | or nine. Can include other hydrocarbon/ring |
| Rings and Amine or Imine Groups (N—N | systems bound to this macrocyclic ligand, but |
| Tridentates, N—N Tetradentates, or N—N | they do not coordinate with the stabilized, high |
| Hexadentates) | valence metal ion. This ligand and/or attached, |
| | uncoordinating hydrocarbon/rings may or may |
| | not have halogen or polarizing or water- |
| | insolubilizing groups attached. |
| N Valence Stabilizer #4: | Macrocyclic ligands containing a total of five or |
| Five- or Seven-Membered Macrocyclics, | seven six-membered heterocyclic rings |
| Macrobicyclics, and Macropolycyclics | containing nitrogen binding sites. Can include |
| (including Catapinands, Cryptands, | other hydrocarbon/ring systems bound to this |
| Cyclidenes, and Sepulchrates) wherein all | macrocyclic ligand, but they do not coordinate |
| Binding Sites are composed of Nitrogen | with the stabilized, high valence metal ion. This |
| and are contained in Component 6- | ligand and/or attached, uncoordinating |
| Membered Heterocyclic Rings (N—N | hydrocarbon/rings may or may not have halogen |
| Tridentates, N—N Tetradentates, or N—N | or polarizing or water-insolubilizing groups |
| Hexadentates) | attached. |
| N Valence Stabilizer #5: | Macrocyclic ligands containing at least one 6- |
| Five-, Seven-, or Nine-Membered | membered heterocyclic ring. These |
| Macrocyclics, Macrobicyclics, and | heterocyclic rings provide nitrogen binding sites |
| Macropolycyclics (including Catapinands, | to valence stabilize the central metal ion. Other |
| Cryptands, Cyclidenes, and Sepulchrates) | amine or imine binding sites can also be |
| wherein all Binding Sites are composed of | included in the macrocyclic ligand, so long as |
| Nitrogen and are contained in a | the total number of binding sites is five, seven, |
| Combination of 6-Membered Heterocyclic | or nine. Can include other hydrocarbon/ring |
| Rings and Amine or Imine Groups (N—N | systems bound to this macrocyclic ligand, but |
| Tridentates, N—N Tetradentates, or N—N | they do not coordinate with the stabilized, high |
| Hexadentates) | valence metal ion. This ligand and/or attached, |
| | uncoordinating hydrocarbon/rings may or may |
| | not have halogen or polarizing or water- |
| | insolubilizing groups attached. |
| N Valence Stabilizer #6: | N(SiR₃)₃, R′N(SiR₃)₂, or R′R″(SiR₃) for |
| Silylamines and Silazanes, including | silylamines; and [RR″Si—NR′]ₓ (x = 1-10) for |
| Macrocyclic Derivatives, wherein at least | silazanes where R, R′, and R″ represents H or |
| one Nitrogen Atom is a Binding Site (N | any organic functional group wherein the |
| Monodentates, N—N Bidentates, N—N | number of carbon atoms ranges from 0 to 35, |
| Tridentates, N—N Tetradentates, and N—N | optionally having halogen or polarizing or |
| Hexadentates) | water-insolubilizing/solubilizing groups |
| | attached. Ligand can also contain nonbinding |
| | N, P, As, O, S, or Se atoms. |
| N Valence Stabilizer #7: | RR′—N—C(═NH)NR″R″′, where R, R′, R″, and |
| Guanidines, Diguanidines, and | R″′ represent H or any organic functional group |
| Polyguanidines (N—N Bidentates, N—N | wherein the number of carbon atoms ranges |
| Tridentates, N—N Tetradentates, and N—N | from 0 to 40, optionally having halogen or |
| Hexadentates) | polarizing or water-insolubilizing/solubilizing |
| | groups attached. Ligand can also contain |
| | nonbinding N, O, S, or P atoms. |
| N Valence Stabilizer #8: | RR′—N—P(≡N)—N—R″R″′, where R, R′, R″, and |
| Phosphonitrile Amides, and | R″′ represent H or any organic functional group |
| Bis(phosphonitnle amides) (N—N | wherein the number of carbon atoms ranges |
| Bidentates, N—N Tetradentates) | from 0 to 40, optionally having halogen or |
| | polarizing or water-insolubilizing/solubilizing |
| | groups attached. Ligand can also contain |
| | nonbinding N, O, S, or P atoms. |
| N Valence Stabilizer #9: | (NH═)PR″″(—NRR′)(—NR″R″′), where R, R′, |
| Phosphonimidic Diamides, | R″, R″′, and R″″ represent H or any organic |
| Bis(Phosphonimidic Diamides), and | functional group wherein the number of carbon |
| Poly(Phosphonimidic Diamides) (N—N | atoms ranges from 0 to 40, optionally having |
| Bidentates, N—N Tetradentates) | halogen or polarizing or water- |
| | insolubilizing/solubilizing groups attached. |
| | Ligand can also contain nonbinding N, O, S, or |
| | P atoms. |
| N Valence Stabilizer #10: | (NH═)PR″′(—NRR′)(—OR″) for |
| Phosphonamidimidic Acid, | phosphonamidimidic acid and (NH═)PR″′(— |
| Phosphonamidimidothioic Acid, | NRR′)(—SR″) for phosphonamidimidothioic |
| Bis(Phosphonamidimidic Acid), | acid, where R, R′, R″, and R″′ represent H or |
| Bis(Phosphonamidimidothioic Acid), | any organic functional group wherein the |
| Poly(Phosphonamidimidic Acid), | number of carbon atoms ranges from 0 to 40, |
| Poly(Phosphonamidimidothioic Acid), and | optionally having halogen or polarizing or |
| derivatives thereof (N—N Bidentates, and N— | water-insolubilizing/solubilizing groups |
| N Tetradentates) | attached. Ligand can also contain nonbinding N, |
| | O, S, or P atoms. |
| N Valence Stabilizer #11: | C₅H₅N—CR═NR′, where C₅H₅N is a pyridine |
| Pyridinaldimines, Bis(pyridinaldimines), | derivative, R is typically an aromatic constituent |
| and Poly(pyridinaldimines) (N—N | (i.e., —C₆H₅), and R′ represents H or any organic |
| Bidentates, N—N Tridentates, and N—N | functional group wherein the number of carbon |
| Tetradentates) | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| N Valence Stabilizer #12: | R—NH—N═R′, where R and R′ represent H or |
| Hydrazones, Bis(hydrazones), and | any organic functional group wherein the |
| Poly(hydrazones) (N Monodentates, N—N | number of carbon atoms ranges from 0 to 40, |
| Bidentates, N—N Tridentates, and N—N | optionally having halogen or polarizing or |
| Tetradentates) | water-insolubilizing/solubilizing groups |
| | attached. (Either R or R′ is typically an aryl |
| | group.) Ligand can also contain nonbinding N, |
| | O, S, or P atoms. |
| N Valence Stabilizer #13: | R—N═N—R′ for azo compounds, R—N═N—NH—R′ |
| Azo compounds including triazenes without | for triazenes, where R, and R′ represent H or |
| chelate substitution at the ortho- (for aryl) | any organic functional group wherein the |
| or alpha- or beta- (for alkyl) positions, | number of carbon atoms ranges from 0 to 40, |
| Bis(azo compounds), or Poly(azo | optionally having halogen or polarizing or |
| compounds) (N Monodentates, N—N | water-insolubilizing/solubilizing groups |
| Bidentates, or N—N—N Tridentates) | attached. (Not including ortho- chelate |
| | substituted aryl azo compounds, and alpha- or |
| | beta-substituted alkyl azo compounds.) Ligand |
| | can also contain nonbinding N, O, S, or P |
| | atoms. |
| N Valence Stabilizer #14: | R—N═N—CR′═N—NR″R″′, where R, R′, R″, and |
| Formazans, Bis(formazans), and | R″′ represent H, or any organic functional |
| Poly(formazans) without ortho- hydroxy, | group wherein the number of carbon atoms |
| carboxy, thiol, mercapto, amino, or | ranges from 0 to 40, optionally having halogen |
| hydrazido substitution (N—N Bidentates, N—N | or polarizing or water- |
| Tetradentates, and N—N Hexadentates) | insolubilizing/solubilizing groups attached. (Not |
| | including ortho- hydroxy, carboxy, thiol, |
| | mercapto, amino, or hydrazido substitution.) |
| | Ligand can also contain nonbinding N, O, S, or |
| | P atoms. |
| N Valence Stabilizer #15: | R—CH═N—CHR′—N═CHR″, where R, R′, and R″ |
| Hydramides (N—N Bidentates) | represent H, or any organic functional group |
| | wherein the number of carbon atoms ranges |
| | from 0 to 40, optionally having halogen or |
| | polarizing or water-insolubilizing/solubilizing |
| | groups attached. (R, R′, and R″ are typically |
| | aryl derivatives.) Ligand can also contain |
| | nonbinding N, O, S, or P atoms. |
| N Valence Stabilizer #16: | RR′C═N—N═CR″R″′ or RR′C═N—NR″R″′ (for |
| Azines (including ketazines), Bis(azines), | ketazines), where R, R′, R″, and R″′ represent |
| and Poly(azines) without ortho- hydroxy, | H, or any organic functional group wherein the |
| carboxy, thiol, mercapto, amino, or | number of carbon atoms ranges from 0 to 40, |
| hydrazido substitution (N—N Bidentates, N—N | optionally having halogen or polarizing or |
| Tetradentates, and N—N Hexadentates) | water-insolubilizing/solubilizing groups |
| | attached. (Not including ortho- hydroxy, |
| | carboxy, thiol, mercapto, amino, or hydrazido |
| | substitution.) Ligand can also contain |
| | nonbinding N, O, S, or P atoms. |
| N Valence Stabilizer #17: | RR′C═N—R″, where R, R′, and R″ represent H, |
| Schiff Bases with one Imine (C═N) Group | or any organic functional group wherein the |
| and without ortho- (for aryl constituents) or | number of carbon atoms ranges from 0 to 40, |
| alpha- or beta- (for alkyl constituents) | optionally having halogen or polarizing or |
| hydroxy, carboxy, carbonyl, thiol, | water-insolubilizing/solubilizing groups |
| mercapto, thiocarbonyl, amino, imino, | attached. (Not including ortho-, alpha-, or beta- |
| oximo, diazeno, or hydrazido substitution | hydroxy, carboxy, carbonyl, thiol, mercapto, |
| (N Monodentates) | thiocarbonyl, amino, imino, oximo, diazeno, or |
| | hydrazido substitution.) Ligand can also |
| | contain nonbinding N, O, S, or P atoms. |
| N Valence Stabilizer #18: | Isocyanides, cyanamides, and related ligands |
| Isocyanide and Cyanamide and related | where the nitrogen atom is directly complexed |
| ligands (N Monodentates) | to the high valence metal ion. |
| N Valence Stabilizer #19: | Nitrosyl, nitrite, and related ligands where the |
| Nitrosyl and Nitrite and related ligands (N | nitrogen atom is bound directly to the high |
| Monodentates) | valence metal ion. |
| N Valence Stabilizer #20: | R—CN, R—(CN)₂, R—(CN)ₓ, etc. where R |
| Nitriles, Dinitriles, and Polynitriles (N | represents H or any organic functional group |
| Monodentates, N—N Bidentates, and N—N—N | wherein the number of carbon atoms ranges |
| Tridentates) | from 0 to 40, optionally having halogen or |
| | polarizing or water-insolubilizing/solubilizing |
| | groups attached. |
| N Valence Stabilizer #21: | Azide (—N₃) ligands bound directly to the high |
| Azide ligands (N Monodentates, or N—N | valence metal ion. Also includes organoazide |
| Bidentates) | derivatives (R—N₃), triazenido compounds (R— |
| | N₃—R′), phosphonyl azides (R—PO₂H—N₃), |
| | phosphoryl azides (O—PO₂H—N₃), and sulfonyl |
| | azides (R—SO₂—N₃) where R and R′ represent H |
| | or any organic functional group wherein the |
| | number of carbon atoms ranges from 0 to 35, |
| | optionally having halogen or polarizing or |
| | water-insolubilizing/solubilizing groups |
| | attached |
| S Valence Stabilizer #1: | SH₂, SHR, SR₂, where R represents H or any |
| Monothioethers (S Monodentates) wherein | organic functional group wherein the number of |
| at least one Sulfur Atom is a Binding Site | carbon atoms ranges from 0 to 35, optionally |
| | having halogen or polarizing or water- |
| | insolubilizing/solubilizing groups attached. |
| | Ligand can also contain nonbinding N, P, O, S, |
| | or Se atoms. |
| S Valence Stabilizer #2: | R—S—S—R′, where R and R′ represents H or any |
| Disulfides (S Monodentates) wherein at | organic functional group wherein the number of |
| least one Sulfur Atom is a Binding Site | carbon atoms ranges from 0 to 35, optionally |
| | having halogen or polarizing or water- |
| | insolubilizing/solubilizing groups attached. |
| | Ligand can also contain nonbinding N, P, O, S, |
| | or Se atoms. |
| S Valence Stabilizer #3: | R—S—R′—S—R″, where R, R′, and R″ represents H |
| Dithioethers (S—S Bidentates) wherein at | or any organic functional group wherein the |
| least one Sulfur Atom is a Binding Site | number of carbon atoms ranges from 0 to 35, |
| | optionally having halogen or polarizing or |
| | water-insolubilizing/solubilizing groups |
| | attached. Ligand can also contain nonbinding N, |
| | P, O, S, or Se atoms. |
| S Valence Stabilizer #4: | R—S—R′—S—R″—S—R″′, where R, R′, R″, and R″′ |
| Trithioethers (S—S Bidentates or S—S | represents H or any organic functional group |
| Tridentates) wherein at least one Sulfur | wherein the number of carbon atoms ranges |
| Atom is a Binding Site | from 0 to 35, optionally having halogen or |
| | polarizing or water-insolubilizing/solubilizing |
| | groups attached. Ligand can also contain |
| | nonbinding N, P, O, S, or Se atoms. |
| S Valence Stabilizer #5: | R—S—R′—S—R″—S—R″′—S—R″″, where R, R′, R″, |
| Tetrathioethers (S—S Bidentates, S—S | R″′, and R″″ represents H or any organic |
| Tridentates, or S—S Bidentates) wherein at | functional group wherein the number of carbon |
| least one Sulfur Atom is a Binding Site | atoms ranges from 0 to 35, optionally having |
| | halogen or polarizing or water- |
| | insolubilizing/solubilizing groups attached. |
| | Ligand can also contain nonbinding N, P, O, S, |
| | or Se atoms. |
| S Valence Stabilizer #6: | R—S—R′—S—R″—S—R″′—S—R″″—S—R″″′—S—R″″″, |
| Hexathioethers (S—S Bidentates, S—S | where R, R′, R″, R″′, R″″, R″″′, and R″″″ |
| Tridentates, S—S Tetradentates, or S—S | represents H or any organic functional group |
| Hexadentates) wherein at least one Sulfur | wherein the number of carbon atoms ranges |
| Atom is a Binding Site | from 0 to 35, optionally having halogen or |
| | polarizing or water-insolubilizing/solubilizing |
| | groups attached. Ligand can also contain |
| | nonbinding N, P, O, S, or Se atoms. |
| S Valence Stabilizer #7: | Five membered heterocyclic ring containing one |
| Five-Membered Heterocyclic Rings | or two sulfur atoms, both of which may function |
| containing One or Two Sulfur Atoms | as binding sites. Can include other ring systems |
| wherein at least one Sulfur Atom is a | bound to this heterocyclic ring, but they do not |
| Binding Site (S Monodentates or S—S | coordinate with the stabilized, high valence |
| Bidentates) | metal ion. Ring can also contain O, N, P, As, or |
| | Se atoms. This 5-membered ring and/or |
| | attached, uncoordinating rings may or may not |
| | have halogen or polarizing or water- |
| | insolubilizing/solubilizing groups attached. |
| S Valence Stabilizer #8: | Six membered heterocyclic ring containing just |
| Six-Membered Heterocyclic Rings | one or two sulfur atoms, both of which may |
| containing One or Two Sulfur Atoms | function as binding sites. Can include other |
| wherein at least one Sulfur Atom is a | ring systems bound to this heterocyclic ring, but |
| Binding Site (S Monodentates or S—S | they do not coordinate with the stabilized, high |
| Bidentates) | valence metal ion. Ring can also contain O, N, |
| | P, As, or Se atoms. This 5-membered ring |
| | and/or attached, uncoordinating rings may or |
| | may not have halogen or polarizing or water- |
| | insolubilizing/solubilizing groups attached. |
| S Valence Stabilizer #9: | Five membered heterocyclic ring(s) containing |
| Five-Membered Heterocyclic Rings | one or two sulfur atoms. In addition, ligand |
| containing One or Two Sulfur Atoms and | contains additional sulfur-containing |
| having at least one additional Sulfur Atom | substituents (usually thiols or thioethers) that |
| Binding Site not in a Ring (S | constitute S binding sites. Can include other |
| Monodentates, S—S Bidentates, S—S | ring systems bound to the heterocyclic ring or to |
| Tridentates, S—S Tetradentates, or S—S | the S-containing substituent, but they do not |
| Hexadentates) | coordinate with the stabilized, high valence |
| | metal ion. Ring(s) can also contain O, N, P, As |
| | or Se atoms. This 5-membered ring(s) and/or |
| | attached, uncoordinating rings and/or S- |
| | containing substituent(s) may or may not have |
| | halogen or polarizing or water- |
| | insolubilizing/solubilizing groups attached. |
| S Valence Stabilizer #10: | Six membered heterocyclic ring(s) containing |
| Six-Membered Heterocyclic Rings | one or two sulfur atoms. In addition, ligand |
| containing One or Two Sulfur Atoms and | contains additional sulfur-containing |
| having at least one additional Sulfur Atom | substituents (usually thiols or thioethers) that |
| Binding Site not in a Ring (S | constitute S binding sites. Can include other |
| Monodentates, S—S Bidentates, S—S | ring systems bound to the heterocyclic ring or to |
| Tridentates, S—S Tetradentates, or S—S | the S-containing substituent, but they do not |
| Hexadentates) | coordinate with the stabilized, high valence |
| | metal ion. Ring(s) can also contain O, N, P, As |
| | or Se atoms. This 6-membered ring(s) and/or |
| | attached, uncoordinating rings and/or S- |
| | containing substituent(s) may or may not have |
| | halogen or polarizing or water- |
| | insolubilizing/solubilizing groups attached. |
| S Valence Stabilizer #11: | Five membered heterocyclic ring(s) containing |
| Five-Membered Heterocyclic Rings | one or two sulfur atoms. In addition, ligand |
| containing One or Two Sulfur Atoms and | contains additional sulfur-containing rings that |
| having at least one additional Sulfur Atom | constitute S binding sites. Can include other |
| Binding Site in a separate Ring (S | ring systems bound to the S-containing |
| Monodentates, S—S Bidentates, S—S | heterocyclic rings, but they do not coordinate |
| Tridentates, S—S Tetradentates, or S—S | with the stabilized, high valence metal ion. |
| Hexadentates) | Ring(s) can also contain O, N, P, As, or Se |
| | atoms. This 5-membered ring(s) and/or |
| | additional S-containing ring(s) and/or attached, |
| | uncoordinating rings may or may not have |
| | halogen or polarizing or water- |
| | insolubilizing/solubilizing groups attached. |
| S Valence Stabilizer #12: | Six membered heterocyclic ring(s) containing |
| Six-Membered Heterocyclic Rings | one or two sulfur atoms. In addition, ligand |
| containing One or Two Sulfur Atoms and | contains additional sulfur-containing rings that |
| having at least one additional Sulfur Atom | constitute S binding sites. Can include other |
| Binding Site in a separate Ring (S | ring systems bound to the S-containing |
| Monodentates, S—S Bidentates, S—S | heterocyclic rings, but they do not coordinate |
| Tridentates, S—S Tetradentates, or S—S | with the stabilized, high valence metal ion. |
| Hexadentates) | Ring(s) can also contain O, N, P, As, or Se |
| | atoms. This 6-membered ring(s) and/or |
| | additional S-containing ring(s) and/or attached, |
| | uncoordinating rings may or may not have |
| | halogen or polarizing or water- |
| | insolubilizing/solubilizing groups attached. |
| S Valence Stabilizer #13: | Macrocyclic ligands containing two to ten sulfur |
| Two-, Three-, Four-, Five-, Six-, Seven-, | binding sites to valence stabilize the central |
| Eight-, Nine-, and Ten-Membered | metal ion. Can include other hydrocarbon or |
| Macrocyclics, Macrobicyclics, and | ring systems bound to this macrocyclic ligand, |
| Macropolycyclics (including Catapinands, | but they do not coordinate with the stabilized, |
| Cryptands, Cyclidenes, and Sepulchrates) | high valence metal ion. This ligand and/or |
| wherein all Binding Sites are composed of | attached, uncoordinating hydrocarbons/rings |
| Sulfur (usually thiol or thioether groups) | may or may not have halogen or polarizing or |
| and are not contained in Component | water-insolubilizing/solubilizing groups |
| Heterocyclic Rings (S—S Bidentates, S—S | attached. |
| Tridentates, S—S Tetradentates, and S—S | |
| Hexadentates) | |
| S Valence Stabilizer #14: | Macrocyclic ligands containing a total of four to |
| Four-, Five-, Six-, Seven-, Eight-, Nine-, or | ten five-membered heterocyclic rings containing |
| Ten-Membered Macrocyclics, | sulfur binding sites. Can include other |
| Macrobicyclics, and Macropolycyclics | hydrocarbon/ring systems bound to this |
| (including Catapinands, Cryptands, | macrocyclic ligand, but they do not coordinate |
| Cyclidenes, and Sepulchrates) wherein all | with the stabilized, high valence metal ion. This |
| Binding Sites are composed of Sulfur and | ligand and/or attached, uncoordinating |
| are contained in Component 5-Membered | hydrocarbon/rings may or may not have halogen |
| Heterocyclic Rings (S—S Tridentates, S—S | or polarizing or water-insolubilizing groups |
| Tetradentates or S—S Hexadentates) | attached. |
| S Valence Stabilizer #15: | Macrocyclic ligands containing at least one 5- |
| Four-, Five-, Six-, Seven-, Eight-, Nine-, or | membered heterocyclic ring. These |
| Ten-Membered Macrocyclics, | heterocyclic rings provide sulfur binding sites to |
| Macrobicyclics, and Macropolycyclics | valence stabilize the central metal ion. Other |
| (including Catapinands, Cryptands, | thiol, thioether, or thioketo binding sites can |
| Cyclidenes, and Sepulchrates) wherein all | also be included in the macrocyclic ligand, so |
| Binding Sites are composed of Sulfur and | long as the total number of binding sites is four |
| are contained in a Combination of 5- | to ten. Can include other hydrocarbon/ring |
| Membered Heterocyclic Rings and Thiol, | systems bound to this macrocyclic ligand, but |
| Thioether, or Thioketo Groups (S—S | they do not coordinate with the stabilized, high |
| Tridentates, S—S Tetradentates, or S—S | valence metal ion. This ligand and/or attached, |
| Hexadentates) | uncoordinating hydrocarbon/rings may or may |
| | not have halogen or polarizing or water- |
| | insolubilizing groups attached. |
| S Valence Stabilizer #16: | Macrocyclic ligands containing a total of four to |
| Four-, Five-, Six-, Seven-, Eight-, Nine-, or | ten six-membered heterocyclic rings containing |
| Ten-Membered Macrocyclics, | sulfur binding sites. Can include other |
| Macrobicyclics, and Macropolycyclics | hydrocarbon/ring systems bound to this |
| (including Catapinands, Cryptands, | macrocyclic ligand, but they do not coordinate |
| Cyclidenes, and Sepulchrates) wherein all | with the stabilized, high valence metal ion. This |
| Binding Sites are composed of Sulfur and | ligand and/or attached, uncoordinating |
| are contained in Component 6-Membered | hydrocarbon/rings may or may not have halogen |
| Heterocyclic Rings (S—S Tridentates, S—S | or polarizing or water-insolubilizing groups |
| Tetradentates, or S—S Hexadentates) | attached. |
| S Valence Stabilizer #17: | Macrocyclic ligands containing at least one 6- |
| Four-, Five-, Six-, Seven-, Eight-, Nine-, or | membered heterocyclic ring. These |
| Ten-Membered Macrocyclics, | heterocyclic rings provide sulfur binding sites to |
| Macrobicyclics, and Macropolycyclics | valence stabilize the central metal ion. Other |
| (including Catapinands, Cryptands, | thiol, thioether, or thioketo binding sites can |
| Cyclidenes, and Sepulchrates) wherein all | also be included in the macrocyclic ligand, so |
| Binding Sites are composed of Sulfur and | long as the total number of binding sites is four |
| are contained in a Combination of 6- | to ten. Can include other hydrocarbon/ring |
| Membered Heterocyclic Rings and Thiol, | systems bound to this macrocyclic ligand, but |
| Thioether, or Thioketo Groups (S—S | they do not coordinate with the stabilized, high |
| Tridentates, S—S Tetradentates, or S—S | valence metal ion. This ligand and/or attached, |
| Hexadentates) | uncoordinating hydrocarbon/rings may or may |
| | not have halogen or polarizing or water- |
| | insolubilizing groups attached. |
| S Valence Stabilizer #18: | RR′—N—C(═S)—NR″—C(═S)—NR″′R″″ for |
| Dithiobiurets (Dithioimidodicarbonic | dithiobiurets, and RR′—N—C(═S)—NR″—NH— |
| Diamides), Dithioisobiurets, Dithiobiureas, | C(═S)—NR″′R″″ for dithiobiureas, where R, R′, |
| Trithiotriurets, Trithiotriureas, | R″, R″′, and R″″ represent H, NH₂, or any |
| Bis(dithiobiurets), Bis(dithioisobiurets), | organic functional group wherein the number of |
| Bis(dithiobiureas), Poly(dithiobiurets), | carbon atoms ranges from 0 to 40, optionally |
| Poly(dithioisobiurets), and | having halogen or polarizing or water- |
| Poly(dithiobiureas) (S—S Bidentates, S—S | insolubilizing/solubilizing groups attached. |
| Tridentates, S—S Tetradentates) | Ligand can also contain nonbinding N, O, S, or |
| | P atoms. |
| S Valence Stabilizer #19: | RR′—N—C(═S)—NR″—C(═S)—R″′ where R, R′, R″, |
| Thioacylthioureas, Thioaroylthioureas, | and R″′ represent H, NH₂, or any organic |
| Bis(thioacylthioureas), | functional group wherein the number of carbon |
| Bis(thioaroylthioureas), | atoms ranges from 0 to 40, optionally having |
| Poly(thioacylthioureas), and | halogen or polarizing or water- |
| Poly(thioaroylthioureas) (S—S Bidentates, S—S | insolubilizing/solubilizing groups attached. |
| Tridentates, S—S Tetradentates) | Ligand can also contain nonbinding N, O, S, or |
| | P atoms. |
| S Valence Stabilizer #20: | R—C(═S)—S—S—C(═S)—R′ where R, and R′ |
| Dithioacyl disulfides, Bis(dithioacyl | represent H or any organic functional group |
| disulfides), and Poly(dithioacyl disulfides) | wherein the number of carbon atoms ranges |
| (S—S Bidentates, S—S Tridentates, S—S | from 0 to 40, optionally having halogen or |
| Tetradentates) | polarizing or water-insolubilizing/solubilizing |
| | groups attached. Ligand can also contain |
| | nonbinding N, O, S, or P atoms. |
| S Valence Stabilizer #21: | RR′—N—C(═S)—S—S—C(═S)—N—R″R″′ where R, R′, |
| Tetrathioperoxydicarbonic Diamides, | R″, R″′ represent H or any organic functional |
| Bis(tetrathioperoxydicarbonic diamides), | group wherein the number of carbon atoms |
| and poly(tetrathioperoxydicarbonic | ranges from 0 to 40, optionally having halogen |
| diamides) (S—S Bidentates, S—S Tridentates, | or polarizing or water- |
| S—S Tetradentates) | insolubilizing/solubilizing groups attached. |
| | Ligand can also contain nonbinding N, O, S, or |
| | P atoms. |
| S Valence Stabilizer #22: | R—S—C(═S)—S—S—C(═S)—S—R′ for |
| Hexathio-, Pentathio-, and | hexathioperoxydicarbonic acids, R—O—C(═S)—S— |
| Tetrathioperoxydicarbonic Acids, | S—C(═S)—S—R′ for pentathioperoxydicarbonic |
| Bis(hexathio-, pentathio-, and | acids, and R—O—C(═S)—S—S—C(═S)—O—R′ for |
| tetrathioperoxydicarbonic acids), | tetrathioperoxydicarbonic acids, where R and R′ |
| poly(hexathio-, pentathio-, and | represent H, NH₂ or any organic functional |
| tetrathioperoxydicarbonic acids), and | group wherein the number of carbon atoms |
| derivatives thereof (S—S Bidentates, S—S | ranges from 0 to 40, optionally having halogen |
| Tridentates, S—S Tetradentates) | or polarizing or water- |
| | insolubilizing/solubilizing groups attached. |
| | Ligand can also contain nonbinding N, O, S, or |
| | P atoms. |
| S Valence Stabilizer #23: | (RR′—N—)(R″R″′—N—)P(═S)—S—S—P(═S)(—N— |
| Dithioperoxydiphosphoramide, | R″″R″″′)(—N—R″″″R″″″′), where R, R′, R″, R″′, |
| Bis(dithioperoxyphosphoramide), and | R″″, R″″′, R″″″, and R″″″′ represent H, NH₂ or |
| Poly(dithioperoxydiphosphoramide) (S—S | any organic functional group wherein the |
| Bidentates, S—S Tridentates, S—S | number of carbon atoms ranges from 0 to 40, |
| Tetradentates) | optionally having halogen or polarizing or |
| | water-insolubilizing/solubilizing groups |
| | attached. Ligand can also contain nonbinding N, |
| | O, S, or P atoms. |
| S Valence Stabilizer #24: | (R—O—)(R′—O—)P(═S)—S—S—P(═S)(—O—R″)(—O— |
| Dithioperoxydiphosphoric Acids, | R″′); (R—O—)(R′—S—)P(═S)—S—S—P(═S)(—S—R″)(—O— |
| Bis(dithioperoxyphosphoric Acids), | R″′); or (R—S—)(R′—S—)P(═S)—S—S—P(═S)(—S—R″)(— |
| Poly(dithioperoxydiphosphoric Acids), and | S—R″′), where R, R′, R″, R″′, R″″, R″″′, R″″″, |
| derivatives thereof (S—S Bidentates, S—S | and R″″″′ represent H, NH₂ or any organic |
| Tridentates, S—S Tetradentates) | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S Valence Stabilizer #25: | (R—O—)(R′—)P(═S)—NH—P(═S)(—R″)(—O—R″′); (R— |
| Dithioimidodiphosphonic Acids, | S—)(R′—)P(═S)—NH—P(═S)(—R″)(—O—R″′); or (R—S—) |
| Dithiohydrazidodiphosphonic Acids, | (R′—)P(═S)—NH—P(═S)(—R″)(—S—R″′) for |
| Bis(dithioimidodiphosphonic acids), | dithioimidodiphosphonic acids, and —NH—NH— |
| Bis(dithiohydrazidodiphosphonic acids), | derivatives for dithiohydrazidodiphosphonic |
| Poly(dithioimidodiphosphonic acids), | acids, where R, R′, R″, and R″′ represent H, |
| Poly(dithiohydrazidodiphosphonic acids), | NH₂ or any organic functional group wherein |
| and derivatives thereof (S—S Bidentates, S—S | the number of carbon atoms ranges from 0 to |
| Tridentates, and S—S Tetradentates) | 40, optionally having halogen or polarizing or |
| | water-insolubilizing/solubilizing groups |
| | attached. Ligand can also contain nonbinding N, |
| | O, S, or P atoms. |
| S Valence Stabilizer #26: | (RR′—N—)(R″—)P(═S)—NH—P(═S)(—R″′)(—N— |
| Dithioimidodiphosphonamides, | R″″R″″′) for dithioimidophosphonamides, and |
| Dithiohydrazidodiphosphonamides, | (RR′—N—)(R″—)P(═S)—NH—NH—P(═S)(—R″′)(—N— |
| Bis(dithioimidodiphosphonamides), | R″″R″″′) for |
| Bis(dithiohydrazidodiphosphonamides), | dithiohydrazidodiphosphonamides, where R, R′, |
| Poly(dithioimidodiphosphonamides), and | R″, R″′, R″″, and R″″′ represent H, NH₂ or any |
| Poly(dithiohydrazidodiphosphonamides) | organic functional group wherein the number of |
| (S—S Bidentates, S—S Tridentates, S—S | carbon atoms ranges from 0 to 40, optionally |
| Tetradentates) | having halogen or polarizing or water- |
| | insolubilizing/solubilizing groups attached. |
| | Ligand can also contain nonbinding N, O, S, or |
| | P atoms. |
| S Valence Stabilizer #27: | (RR′—N—)(R″—)P(═S)—S—P(═S)(—R″′)(—N— |
| Dithiodiphosphonamides, | R″″R″″′), or (RR′—N—)(R″—)P(═S)—O—P(═S)(— |
| Bis(dithiophosphonamides), and | R″′)(—N—R″″R″″′), where R, R′, R″, R″′, R″″, |
| Poly(dithiodiphosphonamides) (S—S | and R″″′ represent H, NH₂ or any organic |
| Bidentates, S—S Tridentates, S—S | functional group wherein the number of carbon |
| Tetradentates) | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S Valence Stabilizer #28: | (R—O—)(R′—)P(═S)—O—P(═S)(—R″)(—O—R″′); (R—O—) |
| Dithiodiphosphonic Acids, | (R′—)P(═S)—S—P(═S)(—R″)(—O—R″′); (R—S—)(R′—) |
| Bis(dithioiphosphonic Acids), | P(═S)—O—P(═S)(—R″)(—S—R″′); or (R—S—)(R′—) |
| Poly(dithiodiphosphonic Acids), and | P(═S)—S—P(═S)(—R″)(—S—R″′); where R, R′, R″, |
| derivatives thereof (S—S Bidentates, S—S | and R″′ represent H, NH₂ or any organic |
| Tridentates, S—S Tetradentates) | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S Valence Stabilizer #29: | (RR′—N—)(R″—)P(═S)—S—S—P(═S)(—R″′)(—N—) |
| Dithioperoxydiphosphonamide, | R″″R″″′), where R, R′, R″, R″′, R″″, and R″″′ |
| Bis(dithioperoxyphosphonamide), and | represent H, NH₂ or any organic functional |
| Poly(dithioperoxydiphosphonamide) (S—S | group wherein the number of carbon atoms |
| Bidentates, S—S Tridentates, S—S | ranges from 0 to 40, optionally having halogen |
| Tetradentates) | or polarizing or water- |
| | insolubilizing/solubilizing groups attached. |
| | Ligand can also contain nonbinding N, O, S, or |
| | P atoms. |
| S Valence Stabilizer #30: | (R—O—)(R′—)P(═S)—S—S—P(═S)(—R″)(—O—R″′); or |
| Dithioperoxydiphosphonic Acids, | (R—S—)(R′—)P(═S)—S—S—P(═S)(—R″)(—S—R″′), |
| Bis(dithioperoxyphosphonic Acids), | where R, R′, R″, and R″′ represent H, NH₂ or |
| Poly(dithioperoxydiphosphonic Acids), and | any organic functional group wherein the |
| derivatives thereof (S—S Bidentates, S—S | number of carbon atoms ranges from 0 to 40, |
| Tridentates, S—S Tetradentates) | optionally having halogen or polarizing or |
| | water-insolubilizing/solubilizing groups |
| | attached. Ligand can also contain nonbinding N, |
| | O, S, or P atoms. |
| S Valence Stabilizer #31: | (O═)PR(—S—R′)(—S—R″) or (S═)PR(—S—R′)(—O— |
| Dithiophosphonic Acids | R″), where R, R′, and R″ represent H, NH₂ or |
| (Phosphonodithioic Acids), | any organic functional group wherein the |
| Bis(dithiophosphonic Acids), | number of carbon atoms ranges from 0 to 40, |
| Poly(dithiophosphonic Acids), and | optionally having halogen or polarizing or |
| derivatives thereof (S—S Bidentates, S—S | water-insolubilizing/solubilizing groups |
| Tridentates, S—S Tetradentates) | attached. Ligand can also contain nonbinding N, |
| | O, S, or P atoms. |
| S Valence Stabilizer #32: | (S═)PR(—S—R′)(—S—R″), where R, R′, and R″ |
| Trithiophosphonic Acids | represent H, NH₂ or any organic functional |
| (Phosphonotrithioic Acids), | group wherein the number of carbon atoms |
| Bis(trithiophosphonic Acids), | ranges from 0 to 40, optionally having halogen |
| Poly(trithiophosphonic Acids), and | or polarizing or water- |
| derivatives thereof (S—S Bidentates, S—S | insolubilizing/solubilizing groups attached. |
| Tridentates, S—S Tetradentates) | Ligand can also contain nonbinding N, O, S, or |
| | P atoms. |
| S Valence Stabilizer #33: | (O═)PR(—S—S—R′)(—S—R″) or (S═)PR(—S—S—R′)(— |
| Phosphono(dithioperoxo)thioic Acids), | O—R″), where R, R′, and R″ represent H, NH₂ or |
| Bis[phosphono(dithioperoxo)thioic Acids], | any organic functional group wherein the |
| Poly[phosphono(dithioperoxo)thioic | number of carbon atoms ranges from 0 to 40, |
| Acids], and derivatives thereof (S—S | optionally having halogen or polarizing or |
| Bidentates, S—S Tridentates, S—S | water-insolubilizing/solubilizing groups |
| Tetradentates) | attached. Ligand can also contain nonbinding N, |
| | O, S, or P atoms. |
| S Valence Stabilizer #34: | (S═)PR(—S—S—R′)(—S—R″), where R, R′, and R″ |
| Phosphono(dithioperoxo)dithioic Acids), | represent H, NH₂ or any organic functional |
| Bis[phosphono(dithioperoxo)dithioic | group wherein the number of carbon atoms |
| Acids], | ranges from 0 to 40, optionally having halogen |
| Poly[phosphono(dithioperoxo)dithioic | or polarizing or water- |
| Acids], and derivatives thereof (S—S | insolubilizing/solubilizing groups attached. |
| Bidentates, S—S Tridentates, S—S | Ligand can also contain nonbinding N, O, S, or |
| Tetradentates) | P atoms. |
| S Valence Stabilizer #35: | R—S—R′CSOH or R—S—R′CSSH for S— |
| S—(Alkylthio)thiocarboxylic Acids, S— | (alkylthio)thiocarboxylic and S— |
| (Arylthio)thiocarboxylic Acids, and S,S— | (arylthio)thiocarboxylic acids, and HSOCR—S— |
| thiobisthiocarboxylic Acids (S—S Bidentates | R′COSH or HSSCR—S—R′CSSH for S,S— |
| and S—S Tridentates) | thiobisthiocarboxylic acids, where R and R′ |
| | represent H or any organic functional group |
| | wherein the number of carbon atoms ranges |
| | from 0 to 40, optionally having halogen or |
| | polarizing or water-insolubilizing/solubilizing |
| | groups attached. Ligand can also contain |
| | nonbinding N, O, S, or P atoms. |
| S Valence Stabilizer #36: | R—S—S—R′CSOH or R—S—S—R′CSSH for S— |
| S—(Alkyldisulfido)thiocarboxylic Acids, S— | (alkyldisulfido)thiocarboxylic and S— |
| (Aryldisulfido)thiocarboxylic Acids, and | (aryldisulfido)thiocarboxylic acids, and |
| S,S′—Disulfidobisthiocarboxylic Acids (S—S | HSOCR—S—S—R′COSH or HSSCR—S—S—R′CSSH |
| Bidentates and S—S Tridentates) | for S,S′—disulfidobisthiocarboxylic acids, where |
| | R and R′ represent H or any organic functional |
| | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| S Valence Stabilizer #37: | R—CH(—SR″)—CH(—SR″′)—R′, and R—C(— |
| 1,2-Dithiolates, Bis(1,2-dithiolates), and | SR″)═C(—SR″′)—R′, where R, R′, R″, and R″′ |
| Poly(1,2-dithiolates) (S—S Bidentates, S—S | represent H, NH₂ or any organic functional |
| Tridentates, S—S Tetradentates) | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| S Valence Stabilizer #38: | RN—C(═O)—CHR′—S—C(═S) for rhodanines, and |
| Rhodanines and Bis(rhodanines) (S—S | R—[N—C(═O)—CHR′—S—C(═S)]₂ for |
| Bidentates and S—S Tetradentates) | bis(rhodanines), where R and R′ represent H, |
| | NH₂ or any organic functional group wherein |
| | the number of carbon atoms ranges from 0 to |
| | 40, optionally having halogen or polarizing or |
| | water-insolubilizing/solubilizing groups |
| | attached. Ligand can also contain nonbinding N, |
| | O, S, or P atoms. |
| S Valence Stabilizer #39: | RN═C(SH)(SH), where R represents H, NH₂ or |
| Dithiocarbimates, Bis(dithiocarbimates), | any organic functional group wherein the |
| and Poly(dithiocarbimates) (S—S Bidentates, | number of carbon atoms ranges from 0 to 40, |
| S—S Tridentates, and S—S Tetradentates) | optionally having halogen or polarizing or |
| | water-insolubilizing/solubilizing groups |
| | attached. Ligand can also contain nonbinding N, |
| | O, S, or P atoms. |
| S Valence Stabilizer #40: | RS⁺═C(SH)(SH) or RS—C(═S)(SH), where R |
| Thioxanthates, Bis(thioxanthates), and | represents H, NH₂ or any organic functional |
| Poly(thioxanthates) (S—S Bidentates and S—S | group wherein the number of carbon atoms |
| Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| S Valence Stabilizer #41: | RO⁺═C(SH)(SH) or RO—C(═S)(SH), where R |
| Xanthates, Bis(xanthates), and | represents H, NH₂ or any organic functional |
| Poly(xanthates) (S—S Bidentates and S—S | group wherein the number of carbon atoms |
| Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| S Valence Stabilizer #42: | Typically RR′R″P═C(SH)(SH) [pentavalent P], |
| Phosphinodithioformates (S—S Bidentates) | although RR′P—C(═S)(SH) [trivalent P] may be |
| | acceptable in some situations, where R, R′, and |
| | R″ represent H, NH₂ or any organic functional |
| | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| S Valence Stabilizer #43: | R—S—C(—S—R″)—O—R′ for dithioborates, R—S—C(—S— |
| Alkyl- and Aryl- Dithioborates, | R″)—S—R′ for trithioborates, and R—S—S—C(—S— |
| Trithioborates, Perthioborates, | R″)—S—R′ for perthioborates, where R, R′, and |
| Bis(dithioborates), Bis(trithioborates), and | R″ represent H, NH₂ or any organic functional |
| Bis(perthioborates) (S—S Bidentates and S—S | group wherein the number of carbon atoms |
| Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| S Valence Stabilizer #44: | R—C(—S—R″)—S—R′, where R, R′, and R″ |
| Alkyl- and Aryl- Dithioboronates, and | represent H, NH₂ or any organic functional |
| Bis(dithioboronates) (S—S Bidentates and S—S | group wherein the number of carbon atoms |
| Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| S Valence Stabilizer #45: | (O═)As(—S—R)(—S—R′)(—S—R″) or (S═)As(—S—R)(— |
| Trithioarsonic Acids (Arsonotrithioic | S—R′)(—O—R″) for trithioarsonic acid; (O═)As(— |
| Acids), Dithioarsonic Acids | O—R)(—S—R′)(—S—R″) or (S═)As(—S—R)(—O—R′)(— |
| (Arsonodithioic Acids), Tetrathioarsonic | O—R″) for dithioarsonic acid, or (S═)As(—S—R)(— |
| Acids (Arsonotetrathioic Acids), and | S—R′)(—S—R″) for tetrathioarsonic acid, where R, |
| derivatives thereof (S—S Bidentates, S—S | R′, and R″ represent H, NH₂ or any organic |
| Tridentates, S—S Tetradentates) | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S Valence Stabilizer #46: | (O═)Sb(—S—R)(—S—R′)(—S—R″) or (S═)Sb(—S—R)(— |
| Trithioantimonic Acids (Stibonotrithioic | S—R′)(—O—R″) for trithioantimonic acid; |
| Acids), Dithioantimonic Acids | (O═)Sb(—O—R)(—S—R′)(—S—R″) or (S═)Sb(—S—R)(— |
| (Stibonodithioic Acids), Tetrathioantimonic | O—R′)(—O—R″) for dithioantimonic acid, or |
| Acids (Stibonotetrathioic Acids), and | (S═)Sb(—S—R)(—S—R′)(—S—R″) for |
| derivatives thereof (S—S Bidentates, S—S | tetrathioantimonic acid, where R, R′, and R″ |
| Tridentates, S—S Tetradentates) | represent H, NH₂ or any organic functional |
| | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| S Valence Stabilizer #47: | RR′R″P═S for phosphine P-sulfides, and |
| Phosphine P-sulfides and Amino- | (RR′N)(R″R″′N)(R″″R″″′N)P═S for amino- |
| substituted Phosphine sulfides (S | substituted phosphine sulfides, where R, R′, R″, |
| Monodentates) | R″′, R″″, and R″″′ represent H, Cl, Br, NH₂ or |
| | any organic functional group wherein the |
| | number of carbon atoms ranges from 0 to 40, |
| | optionally having halogen or polarizing or |
| | water-insolubilizing/solubilizing groups |
| | attached. (Rs are typically aromatic or |
| | heterocyclic for phosphine P-sulfides.) Ligand |
| | can also contain nonbinding N, O, S, or P |
| | atoms. |
| S Valence Stabilizer #48: | RR′R″As═S for arsine As-sulfides, and |
| Arsine As-sulfides and Amino-substituted | (RR′N)(R″R″′N)(R″″R″″′N)As═S for amino- |
| Arsine sulfides (S Monodentates) | substituted arsine sulfides, where R, R′, R″, |
| | R″′, R″″, and R″″′ represent H, Cl, Br, NH₂ or |
| | any organic functional group wherein the |
| | number of carbon atoms ranges from 0 to 40, |
| | optionally having halogen or polarizing or |
| | water-insolubilizing/solubilizing groups |
| | attached. (Rs are typically aromatic or |
| | heterocyclic for arsine As-sulfides.) Ligand can |
| | also contain nonbinding N, O, S, or P atoms. |
| S Valence Stabilizer #49: | Thiols (HS—R, HS—R—SH, etc.), where R and R′ |
| Thiolates (S Monodentates) | represent H or any organic functional group |
| | wherein the number of carbon atoms ranges |
| | from 0 to 35, optionally having halogen or |
| | polarizing or water-insolubilizing/solubilizing |
| | groups attached. |
| S Valence Stabilizer #50: | Sulfide (—S²⁻) ligands bound directly to the high |
| Sulfide ligands (S Monodentates) | valence metal ion. |
| P Valence Stabilizer #1: | PH₃, PH₂R, PHR₂, and PR₃ where R represents |
| Monophosphines (P Monodentates) | H or any organic functional group wherein the |
| wherein at least one Phosphorus Atom is a | number of carbon atoms ranges from 0 to 35, |
| Binding Site | optionally having halogen or polarizing or |
| | water-insolubilizing/solubilizing groups |
| | attached. Ligand can also contain nonbinding N, |
| | P, As, O, S, or Se atoms. |
| P Valence Stabilizer #2: | R′—P—R—P—R″, where R, R′, and R″ represent H |
| Diphosphines (a P—P Bidentate) wherein at | or any organic functional group wherein the |
| least one Phosphorus Atom is a Binding | number of carbon atoms ranges from 0 to 35, |
| Site | optionally having halogen or polarizing or |
| | water-insolubilizing/solubilizing groups |
| | attached. Ligand can also contain nonbinding N, |
| | P, As, O, S, or Se atoms. |
| P Valence Stabilizer #3: | R—P—R′—P—R″—P—R″′, where R, R′, R″, and R″′ |
| Triphosphines (either P—P Bidentates or P— | represent H or any organic functional group |
| P—P Tridentates) wherein at least one | wherein the number of carbon atoms ranges |
| Phosphorus Atom is a Binding Site | from 0 to 35, optionally having halogen or |
| | polarizing or water-insolubilizing/solubilizing |
| | groups attached. Ligand can also contain |
| | nonbinding N, P, As, O, S, or Se atoms. |
| P Valence Stabilizer #4: | R—P—R′—P—R″—P—R″′—P—R″″, where R, R′, R″, |
| Tetraphosphines (P—P Bidentates, P—P | R″′, and R″″ represent H or any organic |
| Tridentates, or P—P Tetradentates) wherein | functional group wherein the number of carbon |
| at least one Phosphorus Atom is a Binding | atoms ranges from 0 to 35, optionally having |
| Site | halogen or polarizing or water- |
| | insolubilizing/solubilizing groups attached. |
| | Ligand can also contain nonbinding N, P, As, O, |
| | S, or Se atoms. |
| P Valence Stabilizer #5: | R—P—R′—P—R″—P—R″′—P—R″″—P—R″″′, where R, R′, |
| Pentaphosphines (P—P Bidentates, P—P | R″, R″′, R″″, and R″″′ represent H or any |
| Tridentates, or P—P Tetradentates) wherein | organic functional group wherein the number of |
| at least one Phosphorus Atom is a Binding | carbon atoms ranges from 0 to 35, optionally |
| Site | having halogen or polarizing or water- |
| | insolubilizing/solubilizing groups attached. |
| | Ligand can also contain nonbinding N, P, As, O, |
| | S, or Se atoms. |
| P Valence Stabilizer #6: | R—P—R′—P—R″—P—R″′—P—R″″—P—R″″′—P—R″″″, |
| Hexaphosphines (P—P Bidentates, P—P | where R, R′, R″, R″′, R″″, R″″′, and R″″″ |
| Tridentates, P—P Tetradentates, or P—P | represent H or any organic functional group |
| Hexadentates) wherein at least one | wherein the number of carbon atoms ranges |
| Phosphorus Atom is a Binding Site | from 0 to 35, optionally having halogen or |
| | polarizing or water-insolubilizing/solubilizing |
| | groups attached. Ligand can also contain |
| | nonbinding N, P, As, O, S, or Se atoms. |
| P Valence Stabilizer #7: | Five membered heterocyclic ring containing |
| Five—Membered Heterocyclic Rings | one, two, or three phosphorus atoms, all of |
| containing One, Two, or Three Phosphorus | which may or may not function as binding sites. |
| Atoms wherein at least one Phosphorus | Can include other ring systems bound to this |
| Atom is a Binding Site (P Monodentates or | heterocyclic ring, but they do not coordinate |
| P—P Bidentates) | with the stabilized, high valence metal ion. |
| | Ring can also contain O, S, N, As, or Se atoms. |
| | This 5-membered ring and/or attached, |
| | uncoordinating rings may or may not have |
| | halogen or polarizing or water- |
| | insolubilizing/solubilizing groups attached. |
| P Valence Stabilizer #8: | Six membered heterocyclic ring containing one, |
| Six-Membered Heterocyclic Rings | two, or three phosphorus atoms, all of which |
| containing One, Two, or Three Phosphorus | may or may not function as binding sites. Can |
| Atoms wherein at least one Phosphorus | include other ring systems bound to this |
| Atom is a Binding Site (P Monodentates or | heterocyclic ring, but they do not coordinate |
| P—P Bidentates) | with the stabilized, high valence metal ion. |
| | Ring can also contain O, S, N, As, or Se atoms. |
| | This 6-membered ring and/or attached, |
| | uncoordinating rings may or may not have |
| | halogen or polarizing or water- |
| | insolubilizing/solubilizing groups attached. |
| P Valence Stabilizer #9: | Five membered heterocyclic ring(s) containing |
| Five-Membered Heterocyclic Rings | one, two, or three phosphorus atoms. In |
| containing One, Two, or Three Phosphorus | addition, ligand contains additional phosphorus- |
| Atoms at least one additional Phosphorus | containing substituents (usually phosphines) |
| Atom Binding Site not in a Ring (P | that constitute P binding sites. Can include |
| Monodentates, P—P Bidentates, P—P | other ring systems bound to the heterocyclic |
| Tridentates, P—P Tetradentates, or P—P | ring or to the P-containing substituent, but they |
| Hexadentates) | do not coordinate with the stabilized, high |
| | valence metal ion. Ring(s) can also contain O, |
| | N, S, As or Se atoms. This 5-membered ring(s) |
| | and/or attached, uncoordinating rings and/or P- |
| | containing substituent(s) may or may not have |
| | halogen or polarizing or water- |
| | insolubilizing/solubilizing groups attached. |
| P Valence Stabilizer #10: | Six membered heterocyclic ring(s) containing |
| Six-Membered Heterocyclic Rings | one, two, or three phosphorus atoms. In |
| containing One, Two, or Three Phosphorus | addition, ligand contains additional phosphorus- |
| Atoms at least one additional Phosphorus | containing substituents (usually phosphines) |
| Atom Binding Site not in a Ring (P | that constitute P binding sites. Can include |
| Monodentates, P—P Bidentates, P—P | other ring systems bound to the heterocyclic |
| Tridentates, P—P Tetradentates, or P—P | ring or to the P-containing substituent, but they |
| Hexadentates) | do not coordinate with the stabilized, high |
| | valence metal ion. Ring(s) can also contain O, |
| | N, S, As or Se atoms. This 6-membered ring(s) |
| | and/or attached, uncoordinating rings and/or P- |
| | containing substituent(s) may or may not have |
| | halogen or polarizing or water- |
| | insolubilizing/solubilizing groups attached. |
| P Valence Stabilizer #11: | Five membered heterocyclic ring(s) containing |
| Five-Membered Heterocyclic Rings | one, two, or three phosphorus atoms. In |
| containing One, Two, or Three Phosphorus | addition, ligand contains additional phosphorus- |
| Atoms at least one additional Phosphorus | containing rings that constitute P binding sites. |
| Atom Binding Site in a separate Ring (P | Can include other ring systems bound to the P- |
| Monodentates, P—P Bidentates, P—P | containing heterocyclic rings, but they do not |
| Tridentates, P—P Tetradentates, or P—P | coordinate with the stabilized, high valence |
| Hexadentates) | metal ion. Ring(s) can also contain O, N, S, As, |
| | or Se atoms. This 5-membered ring(s) and/or |
| | additional P-containing ring(s) and/or attached, |
| | uncoordinating rings may or may not have |
| | halogen or polarizing or water- |
| | insolubilizing/solubilizing groups attached. |
| P Valence Stabilizer #12: | Six membered heterocyclic ring(s) containing |
| Six-Membered Heterocyclic Rings | one, two, or three phosphorus atoms. In |
| containing One, Two, or Three Phosphorus | addition, ligand contains additional phosphorus- |
| Atoms at least one additional Phosphorus | containing rings that constitute P binding sites. |
| Atom Binding Site in a separate Ring (P | Can include other ring systems bound to the P- |
| Monodentates, P—P Bidentates, P—P | containing heterocyclic rings, but they do not |
| Tridentates, P—P Tetradentates, or P—P | coordinate with the stabilized, high valence |
| Hexadentates) | metal ion. Ring(s) can also contain O, N, S, As, |
| | or Se atoms. This 6-membered ring(s) and/or |
| | additional P-containing ring(s) and/or attached, |
| | uncoordinating rings may or may not have |
| | halogen or polarizing or water- |
| | insolubilizing/solubilizing groups attached. |
| P Valence Stabilizer #13: | Macrocyclic ligands containing two, three, four, |
| Two-, Three-, Four-, Five-, Six-, and Eight- | five, six, or eight phosphorus binding sites to |
| Membered Macrocyclics, Macrobicyclics, | valence stabilize the central metal ion. Can |
| and Macropolycyclics (including | include other hydrocarbon or ring systems |
| Catapinands, Cryptands, Cyclidenes, and | bound to this macrocyclic ligand, but they do |
| Sepulchrates) wherein all Binding Sites are | not coordinate with the stabilized, high valence |
| composed of Phosphorus and are not | metal ion. This ligand and/or attached, |
| contained in Component Heterocyclic | uncoordinating hydrocarbons/rings may or may |
| Rings (P—P Bidentates, P—P Tridentates, P—P | not have halogen or polarizing or water- |
| Tetradentates, and P—P Hexadentates) | insolubilizing/solubilizing groups attached. |
| P Valence Stabilizer #14: | Macrocyclic ligands containing a total of four, |
| Four-, Six-, or Eight-Membered | six, or eight five-membered heterocyclic rings |
| Macrocyclics, Macrobicyclics, and | containing phosphorus binding sites. Can |
| Macropolycyclics (including Catapinands, | include other hydrocarbon/ring systems bound |
| Cryptands, Cyclidenes, and Sepulchrates) | to this macrocyclic ligand, but they do not |
| wherein all Binding Sites are composed of | coordinate with the stabilized, high valence |
| Phosphorus and are contained in | metal ion. This ligand and/or attached, |
| Component 5-Membered Heterocyclic | uncoordinating hydrocarbon/rings may or may |
| Rings (P—P Tridentates, P—P Tetradentates, | not have halogen or polarizing or water- |
| or P—P Hexadentates) | insolubilizing groups attached. |
| P Valence Stabilizer #15: | Macrocyclic ligands containing at least one 5- |
| Four-, Six-, or Eight-Membered | membered heterocyclic ring. These |
| Macrocyclics, Macrobicyclics, and | heterocyclic rings provide phosphorus binding |
| Macropolycyclics (including Catapinands, | sites to valence stabilize the central metal ion. |
| Cryptands, Cyclidenes, and Sepulchrates) | Other phosphine binding sites can also be |
| wherein all Binding Sites are composed of | included in the macrocyclic ligand, so long as |
| Phosphorus and are contained in a | the total number of binding sites is four, six, or |
| Combination of 5-Membered Heterocyclic | eight. Can include other hydrocarbon/ring |
| Rings and Phosphine Groups (P—P | systems bound to this macrocyclic ligand, but |
| Tridentates, P—P Tetradentates, or P—P | they do not coordinate with the stabilized, high |
| Hexadentates) | valence metal ion. This ligand and/or attached, |
| | uncoordinating hydrocarbon/rings may or may |
| | not have halogen or polarizing or water- |
| | insolubilizing groups attached. |
| P Valence Stabilizer #16: | Macrocyclic ligands containing a total of four, |
| Four-, Six-, or Eight-Membered | six, or eight six-membered heterocyclic rings |
| Macrocyclics, Macrobicyclics, and | containing phosphorus binding sites. Can |
| Macropolycyclics (including Catapinands, | include other hydrocarbon/ring systems bound |
| Cryptands, Cyclidenes, and Sepulchrates) | to this macrocyclic ligand, but they do not |
| wherein all Binding Sites are composed of | coordinate with the stabilized, high valence |
| Phosphorus and are contained in | metal ion. This ligand and/or attached, |
| Component 6-Membered Heterocyclic | uncoordinating hydrocarbon/rings may or may |
| Rings (P—P Tridentates, P—P Tetradentates, | not have halogen or polarizing or water- |
| or P—P Hexadentates) | insolubilizing groups attached. |
| P Valence Stabilizer #17: | Macrocyclic ligands containing at least one 6- |
| Four-, Six-, or Eight-Membered | membered heterocyclic ring. These |
| Macrocyclics, Macrobicyclics, and | heterocyclic rings provide phosphorus binding |
| Macropolycyclics (including Catapinands, | sites to valence stabilize the central metal ion. |
| Cryptands, Cyclidenes, and Sepulchrates) | Other phosphine binding sites can also be |
| wherein all Binding Sites are composed of | included in the macrocyclic ligand, so long as |
| Phosphorus and are contained in a | the total number of binding sites is four, six, or |
| Combination of 6-Membered Heterocyclic | eight. Can include other hydrocarbon/ring |
| Rings and Phosphine Groups (P—P | systems bound to this macrocyclic ligand, but |
| Tridentates, P—P Tetradentates, or P—P | they do not coordinate with the stabilized, high |
| Hexadentates) | valence metal ion. This ligand and/or attached, |
| | uncoordinating hydrocarbon/rings may or may |
| | not have halogen or polarizing or water- |
| | insolubilizing groups attached. |
| O Valence Stabilizer #1: | R—O—C(═O)—S—S—C(═O)—O—R′, where R and R′ |
| Dithioperoxydicarbonic Acids, | represent H, NH₂ or any organic functional |
| Bis(dithioperoxydicarbonic acids), | group wherein the number of carbon atoms |
| poly(dithioperoxydicarbonic acids), and | ranges from 0 to 40, optionally having halogen |
| derivatives thereof (O—O Bidentates, O—O | or polarizing or water- |
| Tridentates, O—O Tetradentates) | insolubilizing/solubilizing groups attached. |
| | Ligand can also contain nonbinding N, O, S, or |
| | P atoms. |
| O Valence Stabilizer #2: | (R—O—)(R′—)P(═O)—NH—P(═O)(—R″)(—O—R″′) for |
| Imidodiphosphonic Acids, | imidodiphosphonic acids, and (R—O—)(R′—) |
| Hydrazidodiphosphonic Acids, | P(═O)—NH—NH—P(═O)(—R″)(—O—R″′) for |
| Bis(imidodiphosphonic Acids), | hydrazidodiphosphonic acids; where R, R′, R″, |
| Bis(hydrazidodiphosphonic Acids), | and R″′ represent H, NH₂ or any organic |
| Poly(imidodiphosphonic Acids), | functional group wherein the number of carbon |
| Poly(hydrazidodiphosphonic Acids), and | atoms ranges from 0 to 40, optionally having |
| derivatives thereof (O—O Bidentates, O—O | halogen or polarizing or water- |
| Tridentates, O—O Tetradentates) | insolubilizing/solubilizing groups attached. |
| | Ligand can also contain nonbinding N, O, S, or |
| | P atoms. |
| O Valence Stabilizer #3: | (RR′—N—)(R″—)P(═O)—NH—P(═O)(—R″′)(—N— |
| Imidodiphosphonamides, | R″″R″″′) for imidodiphosphonamides, and — |
| Hydrazidodiphosphonamides, | NH—NH— derivatives for |
| Bis(imidodiphosphonamides), | hydrazidodiphosphonamides, where R, R′, R″, |
| Bis(hydrazidodiphosphonamides), | R″′, R″″, and R″″′ represent H, NH₂ or any |
| Poly(imidodiphosphonamides), and | organic functional group wherein the number of |
| Poly(hydrazidodiphosphonamides) (O—O | carbon atoms ranges from 0 to 40, optionally |
| Bidentates, O—O Tridentates, O—O | having halogen or polarizing or water- |
| Tetradentates) | insolubilizing/solubilizing groups attached. |
| | Ligand can also contain nonbinding N, O, S, or |
| | P atoms. |
| O Valence Stabilizer #4: | (RR′—N—)(R″—)P(═O)—O—P(═O)(—R″′)(—N— |
| Diphosphonamides, | R″″R″″′), where R, R′, R″, R″′, R″″, and R″″′ |
| Bis(diphosphonamides), and | represent H, NH₂ or any organic functional |
| Poly(diphosphonamides) (O—O Bidentates, | group wherein the number of carbon atoms |
| O—O Tridentates, O—O Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| O Valence Stabilizer #5: | RR′N—NR″—C(═O)(OH), where R and R′ |
| Carbazates (carbazides), Bis(carbazates), | represent H, NH₂ or any organic functional |
| and Poly(carbazates) (O—O Bidentates, O—O | group wherein the number of carbon atoms |
| Tridentates, and O—O Tetradentates; or | ranges from 0 to 40, optionally having halogen |
| possibly N—O Bidentates, N—O Tridentates, | or polarizing or water- |
| and N—O Tetradentates) | insolubilizing/solubilizing groups attached. |
| | Ligand can also contain nonbinding N, O, S, or |
| | P atoms. |
| O Valence Stabilizer #6: | (O═)As(—O—R)(—O—R′)(—O—R″), where R, R′, and |
| Arsonic Acids, Bis(arsonic acids), | R″ represent H, NH₂ or any organic functional |
| Poly(arsonic acids), and derivatives thereof | group wherein the number of carbon atoms |
| (O—O Bidentates, O—O Tridentates, O—O | ranges from 0 to 40, optionally having halogen |
| Tetradentates) | or polarizing or water- |
| | insolubilizing/solubilizing groups attached. |
| | Ligand can also contain nonbinding N, O, S, or |
| | P atoms. |
| O Valence Stabilizer #7: | R—O—C(—O—R″)—O—R′, where R, R′, and R″ |
| Alkyl- and Aryl-Borates and Bis(borates) | represent H, NH₂ or any organic functional |
| (O—O Bidentates and O—O Tetradentates) | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| O Valence Stabilizer #8: | R—C(—O—R″)—O—R′, where R, R′, and R″ |
| Alkyl- and Aryl- Boronates and | represent H, NH₂ or any organic functional |
| Bis(boronates) (O—O Bidentates and O—O | group wherein the number of carbon atoms |
| Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| O Valence Stabilizer #9: | RR′R″P═O for phosphine P-oxides, and |
| Phosphine P-oxides and Amino-substituted | (RR′N)(R″R″′N)(R″″R″″′N)P═O for amino- |
| Phosphine oxides (O Monodentates) | substituted phosphine oxides, where R, R′, R″, |
| | R″′, R″″, and R″″′ represent H, Cl, Br, NH₂ or |
| | any organic functional group wherein the |
| | number of carbon atoms ranges from 0 to 40, |
| | optionally having halogen or polarizing or |
| | water-insolubilizing/solubilizing groups |
| | attached. (Rs are typically aromatic or |
| | heterocyclic for phosphine P-oxides.) Ligand |
| | can also contain nonbinding N, O, S, or P |
| | atoms. |
| O Valence Stabilizer #10: | RR′R″As═O for arsine As-oxides, and |
| Arsine As-oxides and Amino-substituted | (RR′N)(R″R″′N)(R″″R″″′N)As═O for amino- |
| Arsine oxides (O Monodentates) | substituted arsine oxides, where R, R′, R″, R″′, |
| | R″″, and R″″′ represent H, Cl, Br, NH₂ or any |
| | organic functional group wherein the number of |
| | carbon atoms ranges from 0 to 40, optionally |
| | having halogen or polarizing or water- |
| | insolubilizing/solubilizing groups attached. (Rs |
| | are typically aromatic or heterocyclic for arsine |
| | As-oxides.) Ligand can also contain nonbinding |
| | N, O, S, or P atoms. |
| O Valence Stabilizer #11: | Five membered heterocyclic ring containing one |
| Five-Membered Heterocyclic Rings | or two oxygen atoms, both of which may or |
| containing One or Two Oxygen Atoms | may not function as binding sites. Can include |
| wherein at least one Oxygen Atom is a | other ring systems bound to this heterocyclic |
| Binding Site (O Monodentates or O—O | ring, but they do not coordinate with the |
| Bidentates) | stabilized, high valence metal ion. Ring can |
| | also contain O, S, or P atoms. This 5-membered |
| | ring and/or attached, uncoordinating rings may |
| | or may not have halogen or polarizing or water- |
| | insolubilizing/solubilizing groups attached. |
| O Valence Stabilizer #12: | Six membered heterocyclic ring containing one |
| Six-Membered Heterocyclic Rings | or two oxygen atoms, both of which may or |
| containing One or Two Oxygen Atoms | may not function as binding sites. Can include |
| wherein at least one Oxygen Atom is a | other ring systems bound to this heterocyclic |
| Binding Site (O Monodentates or O—O | ring, but they do not coordinate with the |
| Bidentates) | stabilized, high valence metal ion. Ring can |
| | also contain O, S, or P atoms. This 6-membered |
| | ring and/or attached, uncoordinating rings may |
| | or may not have halogen or polarizing or water- |
| | insolubilizing/solubilizing groups attached. |
| O Valence Stabilizer #13: | Five membered heterocyclic ring(s) containing |
| Five-Membered Heterocyclic Rings | one or two oxygen atoms. In addition, ligand |
| containing One or Two Oxygen Atoms and | contains additional oxygen-containing |
| having at least one additional Oxygen Atom | substituents (usually hydroxyl or ester groups) |
| Binding Site not in a Ring (O | that constitute O binding sites. Can include |
| Monodentates, O—O Bidentates, O | other ring systems bound to the heterocyclic |
| Tridentates, O Tetradentates, or O | ring or to the O-containing substituent, but they |
| Hexadentates) | do not coordinate with the stabilized, high |
| | valence metal ion. Ring(s) can also contain O, |
| | S, or P atoms. This 5-membered ring(s) and/or |
| | attached, uncoordinating rings and/or O- |
| | containing substituent(s) may or may not have |
| | halogen or polarizing or water- |
| | insolubilizing/solubilizing groups attached. |
| O Valence Stabilizer #14: | Six membered heterocyclic ring(s) containing |
| Six-Membered Heterocyclic Rings | one or two oxygen atoms. In addition, ligand |
| containing One or Two Oxygen Atoms and | contains additional oxygen-containing |
| having at least one additional Oxygen Atom | substituents (usually hydroxyl or ester groups) |
| Binding Site not in a Ring (O | that constitute O binding sites. Can include |
| Monodentates, O—O Bidentates, O | other ring systems bound to the heterocyclic |
| Tridentates, O Tetradentates, or O | ring or to the O-containing substituent, but they |
| Hexadentates) | do not coordinate with the stabilized, high |
| | valence metal ion. Ring(s) can also contain O, |
| | S, or P atoms. This 6-membered ring(s) and/or |
| | attached, uncoordinating rings and/or O- |
| | containing substituent(s) may or may not have |
| | halogen or polarizing or water- |
| | insolubilizing/solubilizing groups attached. |
| O Valence Stabilizer #15: | Five membered heterocyclic ring(s) containing |
| Five-Membered Heterocyclic Rings | one or two oxygen atoms. In addition, ligand |
| containing One or Two Oxygen Atoms and | contains additional oxygen-containing rings that |
| having at least one additional Oxygen Atom | constitute O binding sites. Can include other |
| Binding Site in a Separate Ring (O | ring systems bound to the O-containing |
| Monodentates, O—O Bidentates, O | heterocyclic rings, but they do not coordinate |
| Tridentates, O Tetradentates, or O | with the stabilized, high valence metal ion. |
| Hexadentates) | Ring(s) can also contain O, S, or P atoms. This |
| | 5-membered ring(s) and/or additional O- |
| | containing ring(s) and/or attached, |
| | uncoordinating rings may or may not have |
| | halogen or polarizing or water- |
| | insolubilizing/solubilizing groups attached. |
| O Valence Stabilizer #16: | Six membered heterocyclic ring(s) containing |
| Six-Membered Heterocyclic Rings | one or two oxygen atoms. In addition, ligand |
| containing One or Two Oxygen Atoms and | contains additional oxygen-containing rings that |
| having at least one additional Oxygen Atom | constitute O binding sites. Can include other |
| Binding Site in a Separate Ring (O | ring systems bound to the O-containing |
| Monodentates, O—O Bidentates, O | heterocyclic rings, but they do not coordinate |
| Tridentates, O Tetradentates, or O | with the stabilized, high valence metal ion. |
| Hexadentates) | Ring(s) can also contain O, S, or P atoms. This |
| | 6-membered ring(s) and/or additional O- |
| | containing ring(s) and/or attached, |
| | uncoordinating rings may or may not have |
| | halogen or polarizing or water- |
| | insolubilizing/solubilizing groups attached. |
| O Valence Stabilizer #17: | Macrocyclic ligands containing four, five, six, |
| Four-, Five-, Six-, Seven-, Eight-, and Ten- | seven, eight, or ten oxygen binding sites to |
| Membered Macrocyclics, Macrobicyclics, | valence stabilize the central metal ion. Can |
| and Macropolycyclics (including | include other hydrocarbon or ring systems |
| Catapinands, Cryptands, Cyclidenes, and | bound to this macrocyclic ligand, but they do |
| Sepulchrates) wherein all Binding Sites are | not coordinate with the stabilized, high valence |
| composed of Oxygen (usually ester or | metal ion. This ligand and/or attached, |
| hydroxyl groups) and are not contained in | uncoordinating hydrocarbons/rings may or may |
| Component Heterocyclic Rings (O—O | not have halogen or polarizing or water- |
| Bidentates, O—O Tridentates, O—O | insolubilizing/solubilizing groups attached. |
| Tetradentates, and O—O Hexadentates) | |
| O Valence Stabilizer #18: | Macrocyclic ligands containing a total of four, |
| Four-, Five-, Six-, Seven-, Eight-, and Ten- | five, six, seven, eight, or ten five-membered |
| Membered Macrocyclics, Macrobicyclics, | heterocyclic rings containing oxygen binding |
| and Macropolycyclics (including | sites. Can include other hydrocarbon or ring |
| Catapinands, Cryptands, Cyclidenes, and | systems bound to this macrocyclic ligand, but |
| Sepulchrates) wherein all Binding Sites are | they do not coordinate with the stabilized, high |
| composed of Oxygen and are contained in | valence metal ion. This ligand and/or attached, |
| Component 5-Membered Heterocyclic | uncoordinating hydrocarbons/rings may or may |
| Rings (O—O Bidentates, O—O Tridentates, | not have halogen or polarizing or water- |
| O—O Tetradentates, and O—O Hexadentates) | insolubilizing/solubilizing groups attached. |
| O Valence Stabilizer #19: | Macrocyclic ligands containing a total of four, |
| Four-, Five-, Six-, Seven-, Eight-, and Ten- | five, six, seven, eight, or ten six-membered |
| Membered Macrocyclics, Macrobicyclics, | heterocyclic rings containing oxygen binding |
| and Macropolycyclics (including | sites. Can include other hydrocarbon or ring |
| Catapinands, Cryptands, Cyclidenes, and | systems bound to this macrocyclic ligand, but |
| Sepulchrates) wherein all Binding Sites are | they do not coordinate with the stabilized, high |
| composed of Oxygen and are contained in | valence metal ion. This ligand and/or attached, |
| Component 6-Membered Heterocyclic | uncoordinating hydrocarbons/rings may or may |
| Rings (O—O Bidentates, O—O Tridentates, | not have halogen or polarizing or water- |
| O—O Tetradentates, and O—O Hexadentates) | insolubilizing/solubilizing groups attached. |
| N—S Valence Stabilizer #1: | RC(═NH)SR′, where R and R′ represent H or |
| Thioimidates, Dithioimidates, | any organic functional group wherein the |
| Polythioimidates, and Derivatives of | number of carbon atoms ranges from 0 to 40, |
| Thioimidic Acid (N—S Bidentates and N—S | optionally having halogen or polarizing or |
| Tetradentates) | water-insolubilizing/solubilizing groups |
| | attached. Ligand can also contain nonbinding N, |
| | O, S, or P atoms. |
| N—S Valence Stabilizer #2: | RR′—N—C(═NH)—NR″—CS—NR″′R″″ for |
| Thioguanylureas, Guanidinothioureas, | thioguanylureas, and RR′—N—C(═NH)—NR″—NH— |
| Bis(thioguanylureas), | CS—NR″′R″″ for guanidinothioureas, where R, |
| Bis(guanidinothioureas), | R′, R″, R″′, and R″″ represent H, NH₂, or any |
| Poly(thioguanylureas), and | organic functional group wherein the number of |
| Poly(guanidinothioureas) (N—S Bidentates | carbon atoms ranges from 0 to 40, optionally |
| and N—S Tetradentates) | having halogen or polarizing or water- |
| | insolubilizing/solubilizing groups attached. |
| | Ligand can also contain nonbinding N, O, S, or |
| | P atoms. |
| N—S Valence Stabilizer #3: | RR′—N—C(═NH)—NR″—CS—R″′ for N- |
| Amidinothioamides, Guanidinothioamides, | amidinothioamides, or RR′—N—C(═NH)— |
| Bis(amidinothioamides), | CR″R″′—CS—N—R″″R″″′ for 2- |
| Bis(guanidinothioamides), | amidinothioacetamides, and RR′—N—C(═NH)— |
| Poly(amidinothioamides), and | NR″—NH—CS—R″′ for guanidinothioamides, |
| Poly(guanidinothioamides) (including both | where R, R′, R″, R″′, R″″, and R″″′ represent |
| N-amidinothioamides and 2- | H, NH₂, or any organic functional group |
| amidinothioacetamides) (N—S Bidentates | wherein the number of carbon atoms ranges |
| and N—S Tetradentates) | from 0 to 40, optionally having halogen or |
| | polarizing or water-insolubilizing/solubilizing |
| | groups attached. Ligand can also contain |
| | nonbinding N, O, S, or P atoms. |
| N—S Valence Stabilizer #4: | R—C(═NH)—NR′—CS—R″, where R, R′, and R″, |
| Imidoylthioamides, | represent H or any organic functional group |
| Bis(imidoylthioamides), and | wherein the number of carbon atoms ranges |
| Poly(imidoylthioamides) (N—S Bidentates | from 0 to 40, optionally having halogen or |
| and N—S Tetradentates) | polarizing or water-insolubilizing/solubilizing |
| | groups attached. Ligand can also contain |
| | nonbinding N, O, S, or P atoms. |
| N—S Valence Stabilizer #5: | RR′NCSNR″R″′, where R, R′, R″, and R″′ |
| Thioureas, Bis(thioureas), and | represent H, NH₂, or any organic functional |
| Poly(thioureas), including Thiourylene | group wherein the number of carbon atoms |
| Complexes (N—S Bidentates, N—S | ranges from 0 to 40, optionally having halogen |
| Tridentates, and N—S Tetradentates) | or polarizing or water- |
| | insolubilizing/solubilizing groups attached. |
| | Ligand can also contain nonbinding N, O, S, or |
| | P atoms. |
| N—S Valence Stabilizer #6: | RCSNR′R″, where R, R′, and R″ represent H, |
| Thiocarboxamides, Bis(thiocarboxamides), | NH₂, or any organic functional group wherein |
| and Poly(thiocarboxamides) (N—S | the number of carbon atoms ranges from 0 to |
| Bidentates, N—S Tridentates, and N—S | 40, optionally having halogen or polarizing or |
| Tetradentates) | water-insolubilizing/solubilizing groups |
| | attached. Ligand can also contain nonbinding N, |
| | O, S, or P atoms. |
| N—S Valence Stabilizer #7: | RR′—N—S(═NH)—N—R″R″′, where R, R′, R″, and |
| Imidosulfurous Diamides and | R″′ represent H or any organic functional group |
| Bis(imidosulfurous diamides) (N—S | wherein the number of carbon atoms ranges |
| Bidentates, N—S Tridentates, and N—S | from 0 to 40, optionally having halogen or |
| Tetradentates) | polarizing or water-insolubilizing/solubilizing |
| | groups attached. Ligand can also contain |
| | nonbinding N, O, S, or P atoms. |
| N—S Valence Stabilizer #8: | R—N═S═N—R′, where R and R′ represent H or |
| Sulfurdiimines, Bis(sulfurdiimines), and | any organic functional group wherein the |
| Poly(sulfurdiimines) (N—S Bidentates, N—S | number of carbon atoms ranges from 0 to 40, |
| Tridentates, and N—S Tetradentates) | optionally having halogen or polarizing or |
| | water-insolubilizing/solubilizing groups |
| | attached. Ligand can also contain nonbinding N, |
| | O, S, or P atoms. |
| N—S Valence Stabilizer #9: | (NH═)PR(OR′)(SR″) for phosphonimidothioic |
| Phosphonimidothioic Acid, | acid and (NH═)PR(SR′)(SR″) for |
| Phosphonimidodithioic Acid, | phosphonimidodithioic acid, where R, R′, and |
| Bis(Phosphonimidothioic acid); | R″ represent H or any organic functional group |
| Bis(Phosphonimidodithioic acid), and | wherein the number of carbon atoms ranges |
| derivatives thereof (N—S Bidentates, N—S | from 0 to 40, optionally having halogen or |
| Tetradentates) | polarizing or water-insolubilizing/solubilizing |
| | groups attached. Ligand can also contain |
| | nonbinding N, O, S, or P atoms. |
| N—S Valence Stabilizer #10: | (S═)PR(—NR′R″)(—NR″′R″″), where R, R′, R″, |
| Phosphonothioic Diamides, | R″′, and R″″ represent H or any organic |
| Bis(phosphonothioic diamides), and | functional group wherein the number of carbon |
| Poly(phosphonothioic diamides) (N—S | atoms ranges from 0 to 40, optionally having |
| Bidentates and N—S Tetradentates) | halogen or polarizing or water- |
| | insolubilizing/solubilizing groups attached. |
| | Ligand can also contain nonbinding N, O, S, or |
| | P atoms. |
| N—S Valence Stabilizer #11: | (S═)PR(—NR′R″)(—OR″′) or (O═)PR(—NR′R″)(— |
| Phosphonamidothioic Acid, | SR″′) for phosphonamidothioic acid, (S═)PR(— |
| Phosphonamidimidodithioic Acid, | NR′R″)(—SR″′) for phosphonamidimidodithioic |
| Bis(phosphonamidothioic acid), | acid, where R, R′, R″, and R″′ represent H or |
| Bis(phosphonamidimidodithioic acid), | any organic functional group wherein the |
| poly(phosphonamidothioic acid), and | number of carbon atoms ranges from 0 to 40, |
| poly(phosphonamidimidodithioic acid), and | optionally having halogen or polarizing or |
| derivatives thereof (N—S Bidentates and N—S | water-insolubilizing/solubilizing groups |
| Tetradentates) | attached. Ligand can also contain nonbinding N, |
| | O, S, or P atoms. |
| N—S Valence Stabilizer #12: | R—C(═S)—CR′═CR″—NHR″′, where R, R′, R″, |
| Beta-Aminothiones (N-Substituted 3- | and R″′ represent H, or any organic functional |
| amino-2-propenethioaldehydes), Bis(beta- | group wherein the number of carbon atoms |
| aminothiones), and Poly(beta- | ranges from 0 to 40, optionally having halogen |
| aminothiones) (N—S Bidentates and N—S | or polarizing or water- |
| Tetradentates) | insolubilizing/solubilizing groups attached. |
| | Ligand can also contain nonbinding N, O, S, or |
| | P atoms. |
| N—S Valence Stabilizer #13: | RR′—N—C(═S)—CR″═C(—NHR″′)R″″ for 3- |
| 3-Aminothioacrylamides (3-Amino-2- | aminothioacrylamides, and RR′—N—C(═S)— |
| thiopropenamides), 3,3- | CR″═C(—NHR″′)(—NR″″R″″′) for 3,3- |
| Diaminothioacrylamides, Bis(3- | diaminothioacrylamides, where R, R′, R″, R″′, |
| aminothioacrylamides), Bis(3,3- | R″″, R″″′ represent H, NH₂, or any organic |
| diaminoacrylamides), Poly(3- | functional group wherein the number of carbon |
| aminothioacrylamides), and Poly(3,3- | atoms ranges from 0 to 40, optionally having |
| diaminothioacrylamides) (N—S Bidentates | halogen or polarizing or water- |
| and N—S Tetradentates) | insolubilizing/solubilizing groups attached. |
| | Ligand can also contain nonbinding N, O, S, or |
| | P atoms. |
| N—S Valence Stabilizer #14: | R—O—C(═S)—CR′═C(—NHR″)R″′ or R—S—C(═S)— |
| 3-Aminothioacrylic Acids (3-Amino-2- | CR′═C(—NHR″)R″′ for 3-aminothioacrylic |
| thiopropenoic acids), 3-Mercapto-3- | acids, and R—O—C(═S)—CR′═C(—NHR″)(—S—R″′) |
| aminothioacrylic acids, Bis(3- | or R—S—C(═S)—CR′═C(—NHR″)(—S—R″′) for 3- |
| aminothioacrylic acids), Bis(3-Hydroxy-3- | mercapto-3-aminothioacrylic acids, where R, |
| aminothioacrylic acids), Poly(3- | R′, R″, and R″′ represent H, NH₂, or any |
| aminothioacrylic acids), and Poly(3- | organic functional group wherein the number of |
| Hydroxy-3-aminothioacrylic acids), and | carbon atoms ranges from 0 to 40, optionally |
| derivatives thereof (N—S Bidentates and N—S | having halogen or polarizing or water- |
| Tetradentates) | insolubilizing/solubilizing groups attached. |
| | Ligand can also contain nonbinding N, O, S, or |
| | P atoms. |
| N—S Valence Stabilizer #15: | R—C(═S)—N═CHR′, where R′ represents an |
| N-Thioacyl Benzylidenimines, Bis(N- | aromatic derivative (i.e., —C₆H₅), and R |
| thioacyl benzylidenimines), and Poly(N- | represent H, NH₂, or any organic functional |
| thioacyl benzylidenimines) (N—S Bidentates | group wherein the number of carbon atoms |
| and N—S Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| N—S Valence Stabilizer #16: | R—C(═S)—C(═NOH)—R′, where R and R′ |
| Thiocarbonyl oximes, Bis(thiocarbonyl | represent H, NH₂, or any organic functional |
| oximes), and Poly(thiocarbonyl oximes) | group wherein the number of carbon atoms |
| (N—S Bidentates, N—S Tridentates, and N—S | ranges from 0 to 40, optionally having halogen |
| Tetradentates) | or polarizing or water- |
| | insolubilizing/solubilizing groups attached. |
| | Ligand can also contain nonbinding N, O, S, or |
| | P atoms. |
| N—S Valence Stabilizer #17: | R—CH(—SH)—C(═NOH)—R′, where R, R′, and R″ |
| Mercapto oximes, Bis(mercapto oximes), | represent H, NH₂, or any organic functional |
| and Poly(mercapto oximes) (including 2- | group wherein the number of carbon atoms |
| sulfur heterocyclic oximes) (N—S | ranges from 0 to 40, optionally having halogen |
| Bidentates, N—S Tridentates, N—S | or polarizing or water- |
| Tetradentates, and N—S Hexadentates) | insolubilizing/solubilizing groups attached. |
| | Ligand can also contain nonbinding N, O, S, or |
| | P atoms. |
| N—S Valence Stabilizer #18: | o-(O₂N—)(HS—)Ar, where Ar represents an |
| 2-Nitrothiophenols (2-nitrobenzenethiols) | aromatic group or heterocyclic wherein the |
| (N—S Bidentates) | number of carbon atoms ranges from 6 to 40, |
| | optionally having halogen or polarizing or |
| | water-insolubilizing/solubilizing groups |
| | attached. Ligand can also contain nonbinding N, |
| | O, S, or P atoms. |
| N—S Valence Stabilizer #19: | o-(NC—(CH₂)₀₋₁)(HS—)Ar, where Ar represents |
| 2-Nitrilothiophenols (N—S Bidentates) | an aromatic group or heterocyclic wherein the |
| | number of carbon atoms ranges from 6 to 40, |
| | optionally having halogen or polarizing or |
| | water-insolubilizing/solubilizing groups |
| | attached. Ligand can also contain nonbinding N, |
| | O, S, or P atoms. |
| N—S Valence Stabilizer #20: | R—C(═S)—NHNR′R″, where R, R′, and R″ |
| Thiohydrazides, Bis(thiohydrazides), and | represent H or any organic functional group |
| Poly(thiohydrazides) (N—S Bidentates and | wherein the number of carbon atoms ranges |
| N—S Tetradentates) | from 0 to 40, optionally having halogen or |
| | polarizing or water-insolubilizing/solubilizing |
| | groups attached. Ligand can also contain |
| | nonbinding N, O, S, or P atoms. |
| N—S Valence Stabilizer #21: | RR′—N—C(═S)—NHNR″R″′, where R, R′, and R″ |
| Thiosemicarbazides, | represent H or any organic functional group |
| Bis(thiosemicarbazides), and | wherein the number of carbon atoms ranges |
| Poly(thiosemicarbazides) (N—S Bidentates, | from 0 to 40, optionally having halogen or |
| N—S Tetradentates, and N—S Hexadentates) | polarizing or water-insolubilizing/solubilizing |
| | groups attached. Ligand can also contain |
| | nonbinding N, O, S, or P atoms. |
| N—S Valence Stabilizer #22: | Macrocyclic ligands containing five, seven, or |
| Five-, Seven-, or Nine-Membered | nine binding sites composed of nitrogen and |
| Macrocyclics, Macrobicyclics, and | sulfur to valence stabilize the central metal ion. |
| Macropolycyclics (including Catapinands, | Can include other hydrocarbon or ring systems |
| Cryptands, Cyclidenes, and Sepulchrates) | bound to this macrocyclic ligand, but they do |
| wherein all Binding Sites are composed of | not coordinate with the stabilized, high valence |
| Nitrogen (usually amine or imine groups) or | metal ion. This ligand and/or attached, |
| Sulfur (usually thiols, mercaptans, or | uncoordinating hydrocarbons/rings may or may |
| thiocarbonyls) and are not contained in | not have halogen or polarizing or water- |
| Component Heterocyclic Rings (N—S | insolubilizing/solubilizing groups attached. |
| Tridentates, N—S Tetradentates, and N—S | |
| Hexadentates) | |
| N—S Valence Stabilizer #23: | Macrocyclic ligands containing a total of five or |
| Five-, or Seven-Membered Macrocyclics, | seven heterocyclic rings containing nitrogen or |
| Macrobicyclics, and Macropolycyclics | sulfur binding sites. Can include other |
| (including Catapinands, Cryptands, | hydrocarbon/ring systems bound to this |
| Cyclidenes, and Sepulchrates) wherein all | macrocyclic ligand, but they do not coordinate |
| Binding Sites are composed of Nitrogen or | with the stabilized, high valence metal ion. This |
| Sulfur and are contained in Component | ligand and/or attached, uncoordinating |
| Heterocyclic Rings (N—S Tridentates, N—S | hydrocarbon/rings may or may not have halogen |
| Tetradentates, or N—S Hexadentates) | or polarizing or water-insolubilizing groups |
| | attached. |
| N—S Valence Stabilizer #24: | Macrocyclic ligands containing at least one |
| Five-, Seven-, or Nine-Membered | heterocyclic ring. These heterocyclic rings |
| Macrocyclics, Macrobicyclics, and | provide nitrogen or sulfur binding sites to |
| Macropolycyclics (including Catapinands, | valence stabilize the central metal ion. Other |
| Cryptands, Cyclidenes, and Sepulchrates) | amine, imine, thiol, mercapto, or thiocarbonyl |
| wherein all Binding Sites are composed of | binding sites can also be included in the |
| Nitrogen or Sulfur and are contained in a | macrocyclic ligand, so long as the total number |
| Combination of Heterocyclic Rings and | of binding sites is five, seven, or nine. Can |
| Amine, Imine, Thiol, Mercapto, or | include other hydrocarbon/ring systems bound |
| Thiocarbonyl Groups (N—S Tridentates, N—S | to this macrocyclic ligand, but they do not |
| Tetradentates, or N—S Hexadentates) | coordinate with the stabilized, high valence |
| | metal ion. This ligand and/or attached, |
| | uncoordinating hydrocarbon/rings may or may |
| | not have halogen or polarizing or water- |
| | insolubilizing groups attached. |
| N—O Valence Stabilizer #1: | RC(═NH)OR′, where R and R′ represent H or |
| Imidates, Diimidates, Polyimidates, and | any organic functional group wherein the |
| Derivatives of Imidic Acid (N—O Bidentates | number of carbon atoms ranges from 0 to 40, |
| and N—O Tetradentates) | optionally having halogen or polarizing or |
| | water-insolubilizing/solubilizing groups |
| | attached. Ligand can also contain nonbinding N, |
| | O, S, or P atoms. |
| N—O Valence Stabilizer #2: | RR′NC(═NH)OR″, where R, R′, and R″ |
| Pseudoureas, bis(pseudoureas), and | represent H, NH₂, or any organic functional |
| poly(pseudoureas) (N—O Bidentates and N—O | group wherein the number of carbon atoms |
| Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| N—O Valence Stabilizer #3: | RR′NC(═NH)CR″R″′(CO)OR″″, where R, R′, |
| 2-Amidinoacetates, Bis(2-amidinoacetates), | R″, R″′, and R″″ represent H, NH₂, or any |
| and Poly(2-amidinoacetates) (N—O | organic functional group wherein the number of |
| Bidentates and N—O Tetradentates) | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. |
| N—O Valence Stabilizer #4: | RR′NCONR″R″′, where R, R′, R″, and R″′ |
| Ureas, Bis(ureas), and Poly(ureas), | represent H, NH₂, or any organic functional |
| including Urylene Complexes (N—O | group wherein the number of carbon atoms |
| Bidentates, N—O Tridentates, and N—O | ranges from 0 to 40, optionally having halogen |
| Tetradentates) | or polarizing or water- |
| | insolubilizing/solubilizing groups attached. |
| | Ligand can also contain nonbinding N, O, S, or |
| | P atoms. |
| N—O Valence Stabilizer #5: | (NH═)PR(OR′)(OR″), where R, R′, and R″ |
| Phosphonimidic Acid, Bis(phosphonimidic | represent H, NH₂, or any organic functional |
| acid), Poly(phosphonimidic acid), and | group wherein the number of carbon atoms |
| derivatives thereof (N—O Bidentates and N—O | ranges from 0 to 40, optionally having halogen |
| Tetradentates) | or polarizing or water- |
| | insolubilizing/solubilizing groups attached. |
| | Ligand can also contain nonbinding N, O, S, or |
| | P atoms. |
| N—O Valence Stabilizer #6: | (O═)PR(—NR′R″)(—OR″′) for phosphonamidic |
| Phosphonamidic Acid, Phosphonic | acid and (O═)PR(—NR′R″)(—NR″′R″″) for |
| Diamide, Bis(Phosphonamidic Acid), | phosphonic diamide, where R, R′, R″, R″′, and |
| Bis(Phosphonic Diamide), | R″″ represent H, NH₂, or any organic functional |
| Poly(phosphonamidic acid), | group wherein the number of carbon atoms |
| poly(phosphonic diamide), and derivatives | ranges from 0 to 40, optionally having halogen |
| thereof (N—O Bidentates and N—O | or polarizing or water- |
| Tetradentates) | insolubilizing/solubilizing groups attached. |
| | Ligand can also contain nonbinding N, O, S, or |
| | P atoms. |
| N—O Valence Stabilizer #7: | R—C(═O)—CR′═C(—NHR″)R″′, where R, R′, R″, |
| Beta-Ketoamines (N—Substituted 3-amino- | and R″′ represent H, or any organic functional |
| 2-propenals), Bis(beta-ketoamines), and | group wherein the number of carbon atoms |
| Poly(beta-ketoamines) (N—O Bidentates and | ranges from 0 to 40, optionally having halogen |
| N—O Tetradentates) | or polarizing or water- |
| | insolubilizing/solubilizing groups attached. |
| | Ligand can also contain nonbinding N, O, S, or |
| | P atoms. |
| N—O Valence Stabilizer #8: | RR′—N—C(═O)—CR″═C(—NHR″′)R″″ for 3- |
| 3-Aminoacrylamides (3-Amino-2- | aminoacrylamides, and RR′—N—C(═O)—CR″═C(— |
| propenamides), 3,3-Diaminoacrylamides, | NHR″′)(—NR″″R″″′) for 3,3- |
| Bis(3-aminoacrylamides), Bis(3,3- | diaminoacrylamides, where R, R′, R″, R″′, R″″, |
| diaminoacrylamides), Poly(3- | and R″″′ represent H, NH₂, or any organic |
| aminoacrylamides), and Poly(3,3- | functional group wherein the number of carbon |
| diaminoacrylamides) (N—O Bidentates and | atoms ranges from 0 to 40, optionally having |
| N—O Tetradentates) | halogen or polarizing or water- |
| | insolubilizing/solubilizing groups attached. |
| | Ligand can also contain nonbinding N, O, S, or |
| | P atoms. |
| N—O Valence Stabilizer #9: | R—O—C(═O)—CR′═C(—NHR″)R″′ for 3- |
| 3-Aminoacrylic Acids (3-Amino-2- | aminoacrylic acids, and R—O—C(═O)—CR′═C(— |
| propenoic acids), 3-Hydroxy-3- | NHR″)(—O—R″′) for 3-hydroxy-3-aminoacrylic |
| aminoacrylic acids, Bis(3-aminoacrylic | acids, where R, R′, R″, and R″′ represent H, |
| acids), Bis(3-Hydroxy-3-aminoacrylic | NH₂, or any organic functional group wherein |
| acids), Poly(3-aminoacrylic acids), and | the number of carbon atoms ranges from 0 to |
| Poly(3-Hydroxy-3-aminoacrylic acids), and | 40, optionally having halogen or polarizing or |
| derivatives thereof (N—O Bidentates and N—O | water-insolubilizing/solubilizing groups |
| Tetradentates) | attached. Ligand can also contain nonbinding N, |
| | O, S, or P atoms. |
| N—O Valence Stabilizer #10: | R—C(═O)—N═CHR′, where R′ represents an |
| N-Acyl Benzylidenimines, Bis(N-acyl | aromatic derivative (i.e., —C₆H₅), and R |
| benzylidenimines), and Poly(N-acyl | represent H, NH₂, or any organic functional |
| benzylidenimines) (N—O Bidentates and N—O | group wherein the number of carbon atoms |
| Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| N—O Valence Stabilizer #11: | o-(O₂N—)(RR′N—)Ar, where Ar represents an |
| 2-Nitroanilines (N—O Bidentates) | aromatic group or heterocyclic wherein the |
| | number of carbon atoms ranges from 6 to 40, |
| | and R and R′ represent H, NH₂, or alkyl or aryl |
| | hydrocarbon groups wherein the number of |
| | carbon atoms range from 0 to 25, optionally |
| | having halogen or polarizing or water- |
| | insolubilizing/solubilizing groups attached. |
| | Ligand can also contain nonbinding N, O, S, or |
| | P atoms. |
| N—O Valence Stabilizer #12: | o-(NC—(CH₂)₀₋₁)(HO—)Ar, where Ar represents |
| 2-Nitrilophenols (N—O Bidentates). Also | an aromatic group or heterocyclic wherein the |
| includes acylcyanamides. | number of carbon atoms ranges from 6 to 40, |
| | optionally having halogen or polarizing or |
| | water-insolubilizing/solubilizing groups |
| | attached. Ligand can also contain nonbinding N, |
| | O, S, or P atoms. |
| N—O Valence Stabilizer #13: | HetN⁺—O⁻ for amine N-oxides, and R—N═N⁺(—O⁻)—R′ |
| Amine N-Oxides and Diazine N-Oxides | for diazine N-oxides (azoxy compounds), |
| (Azoxy componds) (N—O Bidentates, N—O | where Het represents a nitrogen-containing |
| Tridentates, and N—O Tetradentates) | heterocyclic derivative wherein the number of |
| | carbon atoms ranges from 4 to 40, and R and R′ |
| | represent separate or the same aromatic |
| | functionalities, both Het and R,R′ optionally |
| | having halogen or polarizing or water- |
| | insolubilizing/solubilizing groups attached. |
| | Ligand can also contain nonbinding N, O, S, or |
| | P atoms. |
| N—O Valence Stabilizer #14: | R—C(═O)—NHNR′R″, where R, R′, and R″ |
| Hydrazides, Bis(hydrazides), and | represent H or any organic functional group |
| Poly(hydrazides) (N—O Bidentates and N—O | wherein the number of carbon atoms ranges |
| Tetradentates) | from 0 to 40, optionally having halogen or |
| | polarizing or water-insolubilizing/solubilizing |
| | groups attached. Ligand can also contain |
| | nonbinding N, O, S, or P atoms. |
| N—O Valence Stabilizer #15: | RR′—N—C(═O)—NHNR″R″′, where R, R′, and R″ |
| Semicarbazides, Bis(semicarbazides), and | represent H or any organic functional group |
| Poly(semicarbazides) (N—O Bidentates, N—O | wherein the number of carbon atoms ranges |
| Tetradentates, and N—O Hexadentates) | from 0 to 40, optionally having halogen or |
| | polarizing or water-insolubilizing/solubilizing |
| | groups attached. Ligand can also contain |
| | nonbinding N, O, S, or P atoms. |
| N—O Valence Stabilizer #16: | Macrocyclic ligands containing five, seven, or |
| Five-, Seven-, or Nine-Membered | nine binding sites composed of nitrogen and |
| Macrocyclics, Macrobicyclics, and | oxygen to valence stabilize the central metal |
| Macropolycyclics (including Catapinands, | ion. Can include other hydrocarbon or ring |
| Cryptands, Cyclidenes, and Sepulchrates) | systems bound to this macrocyclic ligand, but |
| wherein all Binding Sites are composed of | they do not coordinate with the stabilized, high |
| Nitrogen (usually amine or imine groups) or | valence metal ion. This ligand and/or attached, |
| Oxygen (usually hydroxy, carboxy, or | uncoordinating hydrocarbons/rings may or may |
| carbonyl groups) and are not contained in | not have halogen or polarizing or water- |
| Component Heterocyclic Rings (N—O | insolubilizing/solubilizing groups attached. |
| Tridentates, N—O Tetradentates, and N—O | |
| Hexadentates) | |
| N—O Valence Stabilizer #17: | Macrocyclic ligands containing a total of five or |
| Five-, or Seven-Membered Macrocyclics, | seven heterocyclic rings containing nitrogen or |
| Macrobicyclics, and Macropolycyclics | oxygen binding sites. Can include other |
| (including Catapinands, Cryptands, | hydrocarbon/ring systems bound to this |
| Cyclidenes, and Sepulchrates) wherein all | macrocyclic ligand, but they do not coordinate |
| Binding Sites are composed of Nitrogen or | with the stabilized, high valence metal ion. This |
| Oxygen and are contained in Component | ligand and/or attached, uncoordinating |
| Heterocyclic Rings (N—O Tridentates, N—O | hydrocarbon/rings may or may not have halogen |
| Tetradentates, or N—O Hexadentates) | or polarizing or water-insolubilizing groups |
| | attached. |
| N—O Valence Stabilizer #18: | Macrocyclic ligands containing at least one |
| Five-, Seven-, or Nine-Membered | heterocyclic ring. These heterocyclic rings |
| Macrocyclics, Macrobicyclics, and | provide nitrogen or oxygen binding sites to |
| Macropolycyclics (including Catapinands, | valence stabilize the central metal ion. Other |
| Cryptands, Cyclidenes, and Sepulchrates) | amine, imine, hydroxy, carboxy, or carbonyl |
| wherein all Binding Sites are composed of | binding sites can also be included in the |
| Nitrogen or Oxygen and are contained in a | macrocyclic ligand, so long as the total number |
| Combination of Heterocyclic Rings and | of binding sites is five, seven, or nine. Can |
| Amine, Imine, Hydroxy, Carboxy, or | include other hydrocarbon/ring systems bound |
| Carbonyl Groups (N—O Tridentates, N—O | to this macrocyclic ligand, but they do not |
| Tetradentates, or N—O Hexadentates) | coordinate with the stabilized, high valence |
| | metal ion. This ligand and/or attached, |
| | uncoordinating hydrocarbon/rings may or may |
| | not have halogen or polarizing or water- |
| | insolubilizing groups attached. |
| S—O Valence Stabilizer #1: | RR′—N—C(═S)—NR″—C(═O)—NR″′R″″ for |
| Thiobiurets (Thioimidodicarbonic | thiobiurets, and RR′—N—C(═S)—NR″—NH—C(═O)— |
| Diamides), Thioisobiurets, Thiobiureas, | NR″′R″″ for thiobiureas, where R, R′, R″, R″′, |
| Thiotriurets, Thiotriureas, Bis(thiobiurets), | and R″″ represent H, NH₂, or any organic |
| Bis(thioisobiurets), Bis(thiobiureas), | functional group wherein the number of carbon |
| Poly(thiobiurets), Poly(thioisobiurets), | atoms ranges from 0 to 40, optionally having |
| Poly(thiobiureas) (S—O Bidentates, S—O | halogen or polarizing or water- |
| Tridentates, S—O Tetradentates), and(3- | insolubilizing/solubilizing groups attached. |
| formamidino thiocarbamides). | Ligand can also contain nonbinding N, O, S, or |
| | P atoms. |
| S—O Valence Stabilizer #2: | RR′—N—C(═S)—NR″—C(═O)—R″′ for acyl- and |
| Acylthioureas, Aroylthioureas, | aroylthioureas, and RR′—N—C(═O)—NR″—C(═S)— |
| Thioacylureas, Thioaroylureas, | R″′ for thioacyl- and thioaroylureas, where R, |
| Bis(acylthioureas), Bis(aroylthioureas), | R′, R″, and R″′ represent H, NH₂, or any |
| Bis(thioacylureas), Bis(thioaroylureas), | organic functional group wherein the number of |
| Poly(thioacylthioureas), | carbon atoms ranges from 0 to 40, optionally |
| Poly(thioaroylthioureas), | having halogen or polarizing or water- |
| Poly(thioacylureas), and | insolubilizing/solubilizing groups attached. |
| Poly(thioaroylureas) (S—O Bidentates, S—O | Ligand can also contain nonbinding N, O, S, or |
| Tridentates, S—O Tetradentates) | P atoms. |
| S—O Valence Stabilizer #3: | RC(═S)—NR′—C(═O)—R″ for |
| Thioimidodialdehydes, | thioimidodialdehydes, and RC(═S)—NR′—NH— |
| Thiohydrazidodialdehydes (thioacyl | C(═O)—R″ for thiohydrazidodialdehydes |
| hydrazides), Bis(thioimidodialdehydes), | (thioacyl hydrazides), where R, R′, and R″ |
| Bis(thiohydrazidodialdehydes), | represent H, NH₂, or any organic functional |
| Poly(thioimidodialdehydes), and | group wherein the number of carbon atoms |
| Poly(thiohydrazidodialdehydes) (S—O | ranges from 0 to 40, optionally having halogen |
| Bidentates, S—O Tridentates, S—O | or polarizing or water- |
| Tetradentates) | insolubilizing/solubilizing groups attached. |
| | Ligand can also contain nonbinding N, O, S, or |
| | P atoms. |
| S—O Valence Stabilizer #4: | R—O—C(═S)—NR′—C(═O)—O—R″ or R—S—C(═S)— |
| Thioimidodicarbonic acids, | NR′—C(═O)—S—R″ for thioimidodicarbonic acids, |
| Thiohydrazidodicarbonic acids, | and R—O—C(═S)—NR′—NH—C(═O)—O—R″ or R—S— |
| Bis(thioimidodicarbonic acids), | C(═S)—NR′—NH—C(═O)—S—R″ for |
| Bis(thiohydrazidodicarbonic acids), | thiohydrazidodicarbonic acids, where R, R′, and |
| Poly(thioimidodicarbonic acids), | R″ represent H, NH₂, or any organic functional |
| Poly(thiohydrazidodicarbonic acids) and | group wherein the number of carbon atoms |
| derivatives thereof (S—O Bidentates, S—O | ranges from 0 to 40, optionally having halogen |
| Tridentates, S—O Tetradentates) | or polarizing or water- |
| | insolubilizing/solubilizing groups attached. |
| | Ligand can also contain nonbinding N, O, S, or |
| | P atoms. |
| S—O Valence Stabilizer #5: | R—C(═S)—C(═O)—R′ where R and R′ represent H, |
| 1,2-Monothioketones (Monothiolenes, | NH₂, or any organic functional group wherein |
| Monothio-alpha-ketonates), 1,2,3- | the number of carbon atoms ranges from 0 to |
| Monothioketones, 1,2,3-Dithioketones, | 40, optionally having halogen or polarizing or |
| Monothiotropolonates, ortho- | water-insolubilizing/solubilizing groups |
| Monothioquinones, Bis(1,2- | attached. Ligand can also contain nonbinding N, |
| Monothioketones), and Poly(1,2- | O, S, or P atoms. |
| Monothioketones) (S—O Bidentates, S—O | |
| Tridentates, S—O Tetradentates) | |
| S—O Valence Stabilizer #6: | RR′—N—C(═S)—S—S—C(═O)—N—R″R″′ for |
| Trithioperoxydicarbonic Diamides, | trithioperoxydicarbonic diamides, and RR′—N— |
| Dithioperoxydicarbonic Diamides, | C(═O)—S—S—C(═O)—N—R″R″′ for |
| Bis(trithioperoxydicarbonic diamides), | dithioperoxydicarbonic diamides, where R, R′, |
| Bis(dithioperoxydicarbonic diamides), | R″, R″′ represent H or any organic functional |
| poly(trithioperoxydicarbonic diamides) and | group wherein the number of carbon atoms |
| poly(dithioperoxydicarbonic diamides) (S—O | ranges from 0 to 40, optionally having halogen |
| Bidentates, S—O Tridentates, S—O | or polarizing or water- |
| Tetradentates) | insolubilizing/solubilizing groups attached. |
| | Ligand can also contain nonbinding N, O, S, or |
| | P atoms. |
| S—O Valence Stabilizer #7: | R—O—C(═S)—S—C(═O)—O—R′, where R and R′ |
| Diithiodicarbonic Acids, | represent H, NH₂ or any organic functional |
| Bis(dithiodicarbonic acids), | group wherein the number of carbon atoms |
| Poly(dithiodicarbonic acids), and | ranges from 0 to 40, optionally having halogen |
| derivatives thereof (S—O Bidentates, S—O | or polarizing or water- |
| Tridentates, S—O Tetradentates) | insolubilizing/solubilizing groups attached. |
| | Ligand can also contain nonbinding N, O, S, or |
| | P atoms. |
| S—O Valence Stabilizer #8: | R—O—C(═S)—S—S—C(═O)—O—R′, where R and R′ |
| Trithioperoxydicarbonic Acids, | represent H, NH₂ or any organic functional |
| Bis(trithioperoxydicarbonic acids), | group wherein the number of carbon atoms |
| poly(trithioperoxydicarbonic acids), and | ranges from 0 to 40, optionally having halogen |
| derivatives thereof (S—O Bidentates, S—O | or polarizing or water- |
| Tridentates, S—O Tetradentates) | insolubilizing/solubilizing groups attached. |
| | Ligand can also contain nonbinding N, O, S, or |
| | P atoms. |
| S—O Valence Stabilizer #9: | (RR′—N—)(R″R″′—N—)P(═S)—S—S—P(═O)(—N— |
| Monothioperoxydiphosphoramide, | R″″R″″′)(—N—R″″″R″″″′), where R, R′, R″, R″′, |
| Bis(monothioperoxyphosphoramide), and | R″″, R″″′, R″″″, and R″″″′ represent H, NH₂ or |
| Poly(monothioperoxydiphosphoramide) (S—O | any organic functional group wherein the |
| Bidentates, S—O Tridentates, S—O | number of carbon atoms ranges from 0 to 40, |
| Tetradentates) | optionally having halogen or polarizing or |
| | water-insolubilizing/solubilizing groups |
| | attached. Ligand can also contain nonbinding N, |
| | O, S, or P atoms. |
| S—O Valence Stabilizer #10: | (R—O—)(R′—O—)P(═S)—S—S—P(═O)(—O—R″)(—O— |
| Monothioperoxydiphosphoric Acids, | R″′); (R—O—)(R′—S—)P(═S)—S—S—P(═O)(—S—R″)(— |
| Bis(monothioperoxyphosphoric Acids), | O—R″′); or (R—S—)(R′—S—)P(═S)—S—S—P(═O)(—S— |
| Poly(monothioperoxydiphosphoric Acids), | R″)(—S—R″′), where R, R′, R″, R″′, R″″, R″″′, |
| and derivatives thereof (S—O Bidentates, S—O | R″″″, and R″″″′ represent H, NH₂ or any |
| Tridentates, S—O Tetradentates) | organic functional group wherein the number of |
| | carbon atoms ranges from 0 to 40, optionally |
| | having halogen or polarizing or water- |
| | insolubilizing/solubilizing groups attached. |
| | Ligand can also contain nonbinding N, O, S, or |
| | P atoms. |
| S—O Valence Stabilizer #11: | (R—O—)(R′—)P(═S)—NH—P(═O)(—R″)(—O—R″′); (R— |
| Monothioimidodiphosphonic Acids, | S—)(R′—)P(═S)—NH—P(═O)(—R″)(—O—R″′); or (R— |
| Monothiohydrazidodiphosphonic Acids, | S—)(R′—)P(═S)—NH—P(═O)(—R″)(—S—R″′) for |
| Bis(monothioimidodiphosphonic Acids), | monothioimidodiphosphonic acids, and —NH— |
| Bis(monothiohydrazidodiphosphonic | NH—derivatives for |
| Acids), Poly(monothioimidodiphosphonic | monothiohydrazidodiphosphonic acids, where |
| Acid), | R, R′, R″, and R″′ represent H, NH₂ or any |
| Poly(monothiohydrazidodiphosphonic | organic functional group wherein the number of |
| Acids), and derivatives thereof (S—O | carbon atoms ranges from 0 to 40, optionally |
| Bidentates, S—O Tridentates, S—O | having halogen or polarizing or water- |
| Tetradentates) | insolubilizing/solubilizing groups attached. |
| | Ligand can also contain nonbinding N, O, S, or |
| | P atoms. |
| S—O Valence Stabilizer #12: | (RR′—N—)(R″—)P(═S)—NH—P(═O)(—R″′)(—N— |
| Monothioimidodiphosphonamides, | R″″R″″′) for monothioimidodiphosphonamides, |
| Monothiohydrazidodiphosphonamides, | and —NH—NH—derivatives for |
| Bis(monothioimidodiphosphonamides), | monothiohydrazidodiphosphonamides, where R, |
| Bis(monothiohydrazidodiphosphonamides) | R′, R″, R″′, R″″, and R″″′, represent H, NH₂ or |
| Poly(monothioimidodiphosphonamides), | any organic functional group wherein the |
| and | number of carbon atoms ranges from 0 to 40, |
| Poly(monothiohydrazidodiphosphonamides) | optionally having halogen or polarizing or |
| (S—O Bidentates, S—O Tridentates, S—O | water-insolubilizing/solubilizing groups |
| Tetradentates) | attached. Ligand can also contain nonbinding N, |
| | O, S, or P atoms. |
| S—O Valence Stabilizer #13: | (RR′—N—)(R″—)P(═S)—S—P(═O)(—R″′)(—N— |
| Monothiodiphosphonamides, | R″″R″″′), or (RR′—N-13 )(R″—)P(═S)—O—P(═O)(— |
| Bis(monothioiphosphonamides), and | R″′)(—N—R″″R″″′), where R, R′, R″, R″′, R″″, |
| Poly(monothiodiphosphonamides) (S—O | and R″″′ represent H, NH₂ or any organic |
| Bidentates, S—O Tridentates, S—O | functional group wherein the number of carbon |
| Tetradentates) | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S—O Valence Stabilizer #14: | (R—O—)(R′—)P(═S)—O—P(═O)(—R″)(—O—R″′); (R— |
| Monothiodiphosphonic Acids, | O—)(R′—)P(═S)—S—P(═O)(—R″)(—O—R″′); (R—S—) |
| Bis(monothioiphosphonic Acids), | (R′—)P(═S)—O—P(═O)(—R″)(—S—R″′); or (R—S— |
| Poly(monothiodiphosphonic Acids), and | (R′—)P(═S)—S—P(═O)(—R″)(—S—R″′), where R, R′, |
| derivatives thereof (S—O Bidentates, S—O | R″, and R″′ represent H, NH₂ or any organic |
| Tridentates, S—O Tetradentates) | functional group wherein the number of carbon |
| | atoms ranges from 0 to 40, optionally having |
| | halogen or polarizing or water- |
| | insolubilizing/solubilizing groups attached. |
| | Ligand can also contain nonbinding N, O, S, or |
| | P atoms. |
| S—O Valence Stabilizer #15: | (RR′—N—)(R″—)P(═S)—S—S—P(═O)(—R″′)—N— |
| Monothioperoxydiphosphonamide, | R″″R″″′), where R, R′, R″, R″′, R″″, and R″″′ |
| Bis(monothioperoxyphosphonamide), and | represent H, NH₂ or any organic functional |
| Poly(monothioperoxydiphosphonamide) (S—O | group wherein the number of carbon atoms |
| Bidentates, S—O Tridentates, S—O | ranges from 0 to 40, optionally having halogen |
| Tetradentates) | or polarizing or water- |
| | insolubilizing/solubilizing groups attached. |
| | Ligand can also contain nonbinding N, O, S, or |
| | P atoms. |
| S—O Valence Stabilizer #16: | (R—O—)(R′—)P(═S)—S—S—P(═O)(—R″)(—O—R″′); or |
| Monothioperoxydiphosphonic Acids, | (R—S—)(R′—)P(═S)—S—S—P(═O)(—R″)(—S—R″′). |
| Bis(monothioperoxyphosphonic Acids), | where R, R′, R″, and R″′ represent H, NH₂ or |
| Poly(monothioperoxydiphosphonic Acids), | any organic functional group wherein the |
| and derivatives thereof (S—O Bidentates, S—O | number of carbon atoms ranges from 0 to 40, |
| Tridentates, S—O Tetradentates) | optionally having halogen or polarizing or |
| | water-insolubilizing/solubilizing groups |
| | attached. Ligand can also contain nonbinding N, |
| | O, S, or P atoms. |
| S—O Valence Stabilizer #17: | (O═)P(—S—R)(—O—R′)(—O—R″) or (S═)P(—O—R)(—O— |
| Monothiophosphoric Acids | R′)(—O—R″), where R, R′, and R″ represent H, |
| (Phosphorothioic Acids), | NH₂ or any organic functional group wherein |
| Bis(monothiophosphoric acids), | the number of carbon atoms ranges from 0 to |
| Poly(monothiophosphoric acids), and | 40, optionally having halogen or polarizing or |
| derivatives thereof (S—O Bidentates, S—O | water-insolubilizing/solubilizing groups |
| Tridentates, S—O Tetradentates) | attached. Ligand can also contain nonbinding N, |
| | O, S, or P atoms. |
| S—O Valence Stabilizer #18: | (O═)P(—S—S—R)(—O—R′)(—O—R″), where R, R′, |
| Phosphoro(dithioperoxoic) Acids, | and R″ represent H, NH₂ or any organic |
| Bis[phosphoro(dithioperoxoic) acids], | functional group wherein the number of carbon |
| Poly[phosphoro(dithioperoxoic) acids], and | atoms ranges from 0 to 40, optionally having |
| derivatives thereof (S—O Bidentates, S—O | halogen or polarizing or water- |
| Tridentates, S—O Tetradentates) | insolubilizing/solubilizing groups attached. |
| | Ligand can also contain nonbinding N, O, S, or |
| | P atoms. |
| S—O Valence Stabilizer #19: | (O═)PR(—S—R′)(—O—R″) or (S═)PR(—O—R′)(—O— |
| Monothiophosphonic Acids | R″), where R, R′, and R″ represent H, NH₂ or |
| (Phosphonothioic Acids), | any organic functional group wherein the |
| Bis(monothiophosphonic Acids), | number of carbon atoms ranges from 0 to 40, |
| Poly(monothiophosphonic Acids), and | optionally having halogen or polarizing or |
| derivatives thereof (S—O Bidentates, S—O | water-insolubilizing/solubilizing groups |
| Tridentates, S—O Tetradentates) | attached. Ligand can also contain nonbinding N, |
| | O, S, or P atoms. |
| S—O Valence Stabilizer #20: | (O═)PR(—S—S—R′)(—O—R″), where R, R′, and R″ |
| Phosphono(dithioperoxoic) Acids, | represent H, NH₂ or any organic functional |
| Bis[phosphono(dithioperoxoic) Acids], | group wherein the number of carbon atoms |
| Poly[phosphono(dithioperoxoic) Acids], | ranges from 0 to 40, optionally having halogen |
| and derivatives thereof (S—O Bidentates, S—O | or polarizing or water- |
| Tridentates, S—O Tetradentates) | insolubilizing/solubilizing groups attached. |
| | Ligand can also contain nonbinding N, O, S, or |
| | P atoms. |
| S—O Valence Stabilizer #21: | R—CR′(—OH)—CH₂—C(═S)—R″, where R, R′, and |
| Beta-Hydroxythioketones, Beta- | R″ represent H, NH₂ or any organic functional |
| Hydroxythioaldehydes, Bis(beta- | group wherein the number of carbon atoms |
| hydroxythioketones), Bis(beta- | ranges from 0 to 40, optionally having halogen |
| hydroxythioaldehydes), Poly(beta- | or polarizing or water- |
| hydroxythioketones), and Poly(beta- | insolubilizing/solubilizing groups attached. |
| hydroxythioaldehydes) (S—O Bidentates, S—O | Ligand can also contain nonbinding N, O, S, or |
| Tridentates, S—O Tetradentates) | P atoms. |
| S—O Valence Stabilizer #22: | R—CR′(—SH)—CH₂—C(═O)—R″, where R, R′, and |
| Beta-Mercaptoketones, Beta- | R″ represent H, NH₂ or any organic functional |
| Mercaptoaldehydes, Bis(beta- | group wherein the number of carbon atoms |
| mercaptoketones), Bis(beta- | ranges from 0 to 40, optionally having halogen |
| mercaptoaldehydes), Poly(beta- | or polarizing or water- |
| mercaptoketones), and Poly(beta- | insolubilizing/solubilizing groups attached. |
| mercaptoaldehydes) (S—O Bidentates, S—O | Ligand can also contain nonbinding N, O, S, or |
| Tridentates, S—O Tetradentates) | P atoms. |
| S—O Valence Stabilizer #23: | RR′—N—CH(—OH)—NR″—C(═S)—NR″′R″″, where |
| N-(Aminomethylol)thioureas [N- | R, R′, R″, R″′, and R″″ represent H, NH₂ or any |
| (Aminohydroxymethyl)thioureas], Bis[N- | organic functional group wherein the number of |
| (aminomethylol)thioureas], and Poly[N- | carbon atoms ranges from 0 to 40, optionally |
| (aminomethylol)thioureas](S—O Bidentates, | having halogen or polarizing or water- |
| S—O Tridentates, S—O Tetradentates) | insolubilizing/solubilizing groups attached. |
| | Ligand can also contain nonbinding N, O, S, or |
| | P atoms. |
| S—O Valence Stabilizer #24: | RR′—N—CH(—SH)—NR″—C(═O)—NR″′R″″, where |
| N-(Aminomethylthiol)ureas [N- | R, R′, R″, R″′, and R″″ represent H, NH₂ or any |
| (Aminomercaptomethyl)ureas], Bis[N- | organic functional group wherein the number of |
| (aminomethylthiol)ureas], and Poly[N- | carbon atoms ranges from 0 to 40, optionally |
| (aminomethylthiol)ureas](S—O Bidentates, | having halogen or polarizing or water- |
| S—O Tridentates, S—O Tetradentates) | insolubilizing/solubilizing groups attached. |
| | Ligand can also contain nonbinding N, O, S, or |
| | P atoms. |
| S—O Valence Stabilizer #25: | RR′—N—C(═S)—C(═O)—N—R″R″′, where R, R′, |
| Monothiooxamides, | R″, and R″′ represent H, NH₂ or any organic |
| Bis(monothiooxamides), and | functional group wherein the number of carbon |
| Poly(monothiooxamides) (S—O Bidentates, | atoms ranges from 0 to 40, optionally having |
| S—O Tridentates, S—O Tetradentates) | halogen or polarizing or water- |
| | insolubilizing/solubilizing groups attached. |
| | Ligand can also contain nonbinding N, O, S, or |
| | P atoms. |
| S—O Valence Stabilizer #26: | R—CR′(—SH)—CR″R″′—C(═O)(—O—R″″), where R, |
| Beta-Mercapto Carboxylic Acids, Bis(Beta- | R′, R″, R″′, and R″″ represent H, NH₂ or any |
| Mercapto Carboxylic Acids), Poly(Beta- | organic functional group wherein the number of |
| Mercapto Carboxylic Acids), and | carbon atoms ranges from 0 to 40, optionally |
| derivatives thereof (S—O Bidentates, S—O | having halogen or polarizing or water- |
| Tridentates, S—O Tetradentates) | insolubilizing/solubilizing groups attached. |
| | Ligand can also contain nonbinding N, O, S, or |
| | P atoms. |
| S—O Valence Stabilizer #27: | R—CR′(—SH)—CR″R″′—C(═O)(—S—R″″), where R, |
| Beta-Mercapto Thiocarboxylic Acids, | R′, R″, R″′, and R″″ represent H, NH₂ or any |
| Bis(Beta-Mercapto Thiocarboxylic Acids), | organic functional group wherein the number of |
| Poly(Beta-Mercapto Thiocarboxylic Acids), | carbon atoms ranges from 0 to 40, optionally |
| and derivatives thereof (S—O Bidentates, S—O | having halogen or polarizing or water- |
| Tridentates, S—O Tetradentates) | insolubilizing/solubilizing groups attached. |
| | Ligand can also contain nonbinding N, O, S, or |
| | P atoms. |
| S—O Valence Stabilizer #28: | R—CR′(—OH)—CR″R″′—C(═O)(—S—R″″), where R, |
| Beta-Hydroxy Thiocarboxylic Acids, | R′, R″, R″′, and R″″ represent H, NH₂ or any |
| Bis(Beta-Hydroxy Thiocarboxylic Acids), | organic functional group wherein the number of |
| Poly(Beta-Hydroxy Thiocarboxylic Acids), | carbon atoms ranges from 0 to 40, optionally |
| and derivatives thereof (S—O Bidentates, S—O | having halogen or polarizing or water- |
| Tridentates, S—O Tetradentates) | insolubilizing/solubilizing groups attached. |
| | Ligand can also contain nonbinding N, O, S, or |
| | P atoms. |
| S—O Valence Stabilizer #29: | R—CR′(—SH)—CR″R″′—C(═O)(—NH—R″″), where |
| Beta-Mercapto Carboxamides, Bis(Beta- | R, R′, R″, R″′, and R″″ represent H, NH₂ or any |
| Mercapto Carboxamides), Poly(Beta- | organic functional group wherein the number of |
| Mercapto Carboxamides), and derivatives | carbon atoms ranges from 0 to 40, optionally |
| thereof (S—O Bidentates, S—O Tridentates, | having halogen or polarizing or water- |
| S—O Tetradentates) | insolubilizing/solubilizing groups attached. |
| | Ligand can also contain nonbinding N, O, S, or |
| | P atoms. |
| S—O Valence Stabilizer #30: | R—S—R′COOH for S-alkylthiocarboxylic and S- |
| S-Alkylthiocarboxylic Acids, S- | arylthiocarboxylic acids, and HOOCR—S— |
| Arylthiocarboxylic Acids, and S,S- | R′COOH for S,S-thiobiscarboxylic acids, where |
| thiobiscarboxylic Acids (S—O Bidentates | R and R′ represent H or any organic functional |
| and S—O Tridentates) | group wherein the number of carbon atoms |
| | ranges from 0 to 40, optionally having halogen |
| | or polarizing or water- |
| | insolubilizing/solubilizing groups attached. |
| | Ligand can also contain nonbinding N, O, S, or |
| | P atoms. |
| S—O Valence Stabilizer #31: | R—S—S—R′COOH for S-alkyldisulfidocarboxylic |
| S-Alkyldisulfidocarboxylic Acids, S- | and S-aryldisulfidocarboxylic acids, and |
| Aryldisulfidocarboxylic Acids, and S,S′— | HOOCR—S—S—R′COOH for S,S′— |
| Disulfidobiscarboxylic Acids (S—O | disulfidobiscarboxylic acids, where R and R′ |
| Bidentates and S—O Tridentates) | represent H or any organic functional group |
| | wherein the number of carbon atoms ranges |
| | from 0 to 40, optionally having halogen or |
| | polarizing or water-insolubilizing/solubilizing |
| | groups attached. Ligand can also contain |
| | nonbinding N, O, S, or P atoms. |
| S—O Valence Stabilizer #32: | R—C(═O)(—S—R′) for monothiomonocarboxylic |
| Monothiomonocarboxylic Acids, | acids, and (R—S—)(O═)C—R′—C(═O)(—S—R″) or (R— |
| Dithiodicarboxylic Acids, | S—)(O═)C—R′—C(═O)(—O—R″) for |
| Bis(monothiomonocarboxylic Acids), | dithiodicarboxylic acids, where R, R′, and R″ |
| Bis(dithiodicarboxylic acids), | represent H, NH₂ or any organic functional |
| Poly(monothiomonocarboxylic acids), | group wherein the number of carbon atoms |
| Poly(dithiodicarboxylic acids), and | ranges from 0 to 40, optionally having halogen |
| derivatives thereof (S—O Bidentates and S—O | or polarizing or water- |
| Tetradentates) | insolubilizing/solubilizing groups attached. |
| | Ligand can also contain nonbinding N, O, S, or |
| | P atoms. |
| S—O Valence Stabilizer #33: | R—O—C(═S)—O—R′, where R, and R′ represent H, |
| Monothiocarbonates and | NH₂ or any organic functional group wherein |
| Bis(monothiocarbonates) (S—O Bidentates | the number of carbon atoms ranges from 0 to |
| and S—O Tetradentates) | 40, optionally having halogen or polarizing or |
| | water-insolubilizing/solubilizing groups |
| | attached. Ligand can also contain nonbinding N, |
| | O, S, or P atoms. |
| S—O Valence Stabilizer #34: | RR′N—NR″—C(═O)(SH), where R and R′ |
| Monothiocarbazates (Monothiocarbazides), | represent H, NH₂ or any organic functional |
| Bis(monothiocarbazates), and | group wherein the number of carbon atoms |
| Poly(monothiocarbazates) (S—O Bidentates, | ranges from 0 to 40, optionally having halogen |
| S—O Tridentates, and S—O Tetradentates; or | or polarizing or water- |
| possibly N—S Bidentates, N—S Tridentates, | insolubilizing/solubilizing groups attached. |
| and N—S Tetradentates) | Ligand can also contain nonbinding N, O, S, or |
| | P atoms. |
| S—O Valence Stabilizer #35: | R—CH(—SH)—CH(—OH)—R′ for alpha-mercapto |
| Mercapto Alcohols and | alcohols, R—CH(—SH)—Si(—OR′)ₓ—R″₃₋ₓ for alpha- |
| Silylmercaptoalcohols, Bis(mercapto | silylmercaptoalcohols, R—CH(—SH)—R′—CH(— |
| alcohols and silylmercaptoalcohols), and | OH)—R″ for beta-mercapto alcohols, and R—CH(— |
| Poly(mercapto alcohols and | SH)—R′—Si(—OR″)ₓ—R″′₃₋ₓ for beta- |
| silylmercaptoalcohols) (S—O Bidentates, S—O | silylmercaptoalcohols, etc., where R, R′, R″, |
| Tridentates, S—O Tetradentates) | and R″′ represent H, NH₂ or any organic |
| | functional group wherein the number of carbon |
| | atoms ranges from 0 to 40, optionally having |
| | halogen or polarizing or water- |
| | insolubilizing/solubilizing groups attached. x = 1-3. |
| | Ligand can also contain nonbinding N, O, |
| | S, or P atoms. |
| S—O Valence Stabilizer #36: | RN═C(OH)(SH), where R represents H, NH₂ or |
| Monothiocarbimates, | any organic functional group wherein the |
| Bis(monothiocarbimates), and | number of carbon atoms ranges from 0 to 40, |
| Poly(monothiocarbimates) (S—O Bidentates, | optionally having halogen or polarizing or |
| S—O Tridentates, and S—O Tetradentates) | water-insolubilizing/solubilizing groups |
| | attached. Ligand can also contain nonbinding N, |
| | O, S, or P atoms. |
| S—O Valence Stabilizer #37: | R—O—C(—S—R″)—O—R′, where R, R′, and R″ |
| Alkyl-and Aryl-Monothioborates and | represent H, NH₂ or any organic functional |
| Bis(monothioborates) (S—O Bidentates and | group wherein the number of carbon atoms |
| S—O Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| S—O Valence Stabilizer #38: | R—C(—S—R″)—O—R′, where R, R′, and R″ |
| Alkyl-and Aryl-Monothioboronates and | represent H, NH₂ or any organic functional |
| Bis(monothioboronates) (S—O Bidentates | group wherein the number of carbon atoms |
| and S—O Tetradentates) | ranges from 0 to 40, optionally having halogen |
| | or polarizing or water- |
| | insolubilizing/solubilizing groups attached. |
| | Ligand can also contain nonbinding N, O, S, or |
| | P atoms. |
| S—O Valence Stabilizer #39: | (O═)As(—S—R)(—O—R′)(—O—R″) or (S═)As(—O—R)(— |
| Monothioarsonic Acids (Arsonothioic | O—R′)(—O—R″), where R, R′, and R″ represent H, |
| Acids), Bis(monothioarsonic acids), | NH₂ or any organic functional group wherein |
| Poly(monothioarsonic acids), and | the number of carbon atoms ranges from 0 to |
| derivatives thereof (S—O Bidentates, S—O | 40, optionally having halogen or polarizing or |
| Tridentates, S—O Tetradentates) | water-insolubilizing/solubilizing groups |
| | attached. Ligand can also contain nonbinding N, |
| | O, S, or P atoms. |
| S—O Valence Stabilizer #40: | Heterocyclic ring(s) containing one or two |
| Heterocyclic Rings containing One or Two | sulfur atoms. In addition, ligand contains |
| Sulfur Atoms at least one additional | additional oxygen-containing substituents |
| Oxygen Atom Binding Site not in a Ring | (usually hydroxy, carboxy, or carbonyl groups) |
| (S—O Bidentates, S—O Tridentates, S—O | that constitute O binding sites. Can include |
| Tetradentates, or S—O Hexadentates) | other ring systems bound to the heterocyclic |
| | ring or to the O—containing substituent, but they |
| | do not coordinate with the stabilized, high |
| | valence metal ion. Ring(s) can also contain O, |
| | N, P, As or Se atoms. This 5-membered ring(s) |
| | and/or attached, uncoordinating rings and/or O- |
| | containing substituent(s) may or may not have |
| | halogen or polarizing or water- |
| | insolubilizing/solubilizing groups attached. |
| S—O Valence Stabilizer #41: | Heterocyclic ring(s) containing one or two |
| Heterocyclic Rings containing One or Two | oxygen atoms. In addition, ligand contains |
| Oxygen Atoms at least one additional | additional sulfur-containing substituents |
| Sulfur Atom Binding Site not in a Ring (S— | (usually thio, mercapto, or thiocarbonyl groups) |
| O Bidentates, S—O Tridentates, S—O | that constitute S binding sites. Can include |
| Tetradentates, or S—O Hexadentates) | other ring systems bound to the heterocyclic |
| | ring or to the S-containing substituent, but they |
| | do not coordinate with the stabilized, high |
| | valence metal ion. Ring(s) can also contain O, |
| | N, P, As or Se atoms. This 5-membered ring(s) |
| | and/or attached, uncoordinating rings and/or S- |
| | containing substituent(s) may or may not have |
| | halogen or polarizing or water- |
| | insolubilizing/solubilizing groups attached. |
| S—O Valence Stabilizer #42: | Heterocyclic ring(s) containing one or two |
| Heterocyclic Rings containing One or Two | sulfur atoms. In addition, ligand contains |
| Sulfur Atoms at least one additional | additional oxygen-containing rings that |
| Oxygen Atom Binding Site in a separate | constitute O binding sites. Can include other |
| Ring (S—O Bidentates, S—O Tridentates, S—O | ring systems bound to the O-containing |
| Tetradentates, or S—O Hexadentates) | heterocyclic rings, but they do not coordinate |
| | with the stabilized, high valence metal ion. |
| | Ring(s) can also contain O, N, P, As, or Se |
| | atoms. This 5-membered ring(s) and/or |
| | additional O-containing ring(s) and/or attached, |
| | uncoordinating rings may or may not have |
| | halogen or polarizing or water- |
| | insolubilizing/solubilizing groups attached. |
| S—O Valence Stabilizer #43: | Macrocyclic ligands containing two to ten sulfur |
| Two-, Three-, Four-, Five-, Six-, Seven-, | or oxygen binding sites to valence stabilize the |
| Eight-, Nine-, and Ten-Membered | central metal ion. Can include other |
| Macrocyclics, Macrobicyclics, and | hydrocarbon or ring systems bound to this |
| Macropolycyclics (including Catapinands, | macrocyclic ligand, but they do not coordinate |
| Cryptands, Cyclidenes, and Sepulchrates) | with the stabilized, high valence metal ion. This |
| wherein all Binding Sites are composed of | ligand and/or attached, uncoordinating |
| Sulfur (usually thiol, mercapto, or | hydrocarbons/rings may or may not have |
| thiocarbonyl groups) or Oxygen (hydroxy, | halogen or polarizing or water- |
| carboxy, or carbonyl groups) and are not | insolubilizing/solubilizing groups attached. |
| contained in Component Heterocyclic | |
| Rings (S—O Bidentates, S—O Tridentates, S—O | |
| Tetradentates, and S—O Hexadentates) | |
| S—O Valence Stabilizer #44: | Macrocyclic ligands containing a total of four to |
| Four-, Five-, Six-, Seven-, Eight-, Nine-, or | ten five-membered heterocyclic rings containing |
| Ten-Membered Macrocyclics, | sulfur or oxygen binding sites. Can include |
| Macrobicyclics, and Macropolycyclics | other hydrocarbon/ring systems bound to this |
| (including Catapinands, Cryptands, | macrocyclic ligand, but they do not coordinate |
| Cyclidenes, and Sepulchrates) wherein all | with the stabilized, high valence metal ion. This |
| Binding Sites are composed of Sulfur or | ligand and/or attached, uncoordinating |
| Oxygen and are contained in Component 5- | hydrocarbon/rings may or may not have halogen |
| Membered Heterocyclic Rings (S—O | or polarizing or water-insolubilizing groups |
| Tridentates, S—O Tetradentates or S—O | attached. |
| Hexadentates) | |
| S—O Valence Stabilizer #45: | Macrocyclic ligands containing at least one |
| Four-, Five-, Six-, Seven-, Eight-, Nine-, or | heterocyclic ring. These heterocyclic rings |
| Ten-Membered Macrocyclics, | provide sulfur or oxygen binding sites to |
| Macrobicyclics, and Macropolycyclics | valence stabilize the central metal ion. Other |
| (including Catapinands, Cryptands, | thiol, mercapto, thiocarbonyl, hydroxy, carboxy, |
| Cyclidenes, and Sepulchrates) wherein all | or carbonyl binding sites can also be included in |
| Binding Sites are composed of Sulfur or | the macrocyclic ligand, so long as the total |
| Oxygen and are contained in a Combination | number of binding sites is four to ten. Can |
| of Heterocyclic Rings and Thiol, Mercapto, | include other hydrocarbon/ring systems bound |
| Thiocarbonyl, Hydroxy, Carboxy, and | to this macrocyclic ligand, but they do not |
| Carbonyl Groups (S—O Tridentates, S—O | coordinate with the stabilized, high valence |
| Tetradentates, or S—O Hexadentates) | metal ion. This ligand and/or attached, |
| | uncoordinating hydrocarbon/rings may or may |
| | not have halogen or polarizing or water- |
| | insolubilizing groups attached. |
| S—O Valence Stabilizer #46: | Sulfoxides (R—SO—R′), where R and R′ |
| Sulfoxides (S—O Bidentates) | represent H or any organic functional group |
| | wherein the number of carbon atoms ranges |
| | from 0 to 35, optionally having halogen or |
| | polarizing or water-insolubilizing/solubilizing |
| | groups attached. |
| S—O Valence Stabilizer #47: | Sulfones (R—SO₂—R′), where R and R′ represent |
| Sulfones (S—O Bidentates) | H or any organic functional group wherein the |
| | number of carbon atoms ranges from 0 to 35, |
| | optionally having halogen or polarizing or |
| | water-insolubilizing/solubilizing groups |
| | attached. |
| S—O Valence Stabilizer #48: | Sulfur dioxide ligands (—SO₂) bound directly to |
| Sulfur dioxide (SO₂) ligands (S—O | the high valence metal ion. |
| Bidentates) | |
| N—P Valence Stabilizer #1: | [R(—NR′R″)(—PR″′R″″)], [R(—NR′R″)ₓ]₁₋₃P, [R(— |
| Aminoaryl Phosphines and Iminoaryl | NR′R″)ₓ]₁₋₃PX, or [R(—PR′R″)ₓ]₁₋₃N, where X = O |
| Phosphines (N—P Bidentates, N—P | or S and R, R′, R″, R″′, and R″″ represents |
| Tridentates, and N—P Tetradentates) | H, NH₂ or any organic functional group wherein |
| | the number of carbon atoms ranges from 0 to |
| | 35, optionally having halogen or polarizing or |
| | water-insolubilizing/solubilizing groups |
| | attached. Ligand can also contain nonbinding N, |
| | P, O, S, or Se atoms. |
| N—P Valence Stabilizer #2: | Five membered heterocyclic ring(s) containing |
| Heterocyclic Rings containing One, Two, | one, two, three, or four nitrogen atoms. In |
| Three, or Four Nitrogen Atoms and having | addition, ligand contains additional phosphorus- |
| at least one additional Phosphorus Atom | containing substituents that constitute P binding |
| Binding Site not in a Ring (N—P Bidentates, | sites. Can include other ring systems bound to |
| N—P Tridentates, N—P Tetradentates, or N—P | the heterocyclic ring or to the P-containing |
| Hexadentates) | substituent, but they do not coordinate with the |
| | stabilized, high valence metal ion. Ring(s) can |
| | also contain O, S, or P atoms. This ring(s) |
| | and/or attached, uncoordinating rings and/or P- |
| | containing substituent(s) may or may not have |
| | halogen or polarizing or water- |
| | insolubilizing/solubilizing groups attached. |
| N—P Valence Stabilizer #3: | Five membered heterocyclic ring(s) containing |
| Heterocyclic Rings containing One, Two, | one, two, or three phosphorus atoms. In |
| or Three Phosphorus Atoms and having at | addition, ligand contains additional nitrogen- |
| least one additional Nitrogen Atom Binding | containing substituents (usually amines, imines, |
| Site not in a Ring (N—P Bidentates, N—P | or hydrazides) that constitute N binding sites. |
| Tridentates, N—P Tetradentates, or N—P | Can include other ring systems bound to the |
| Hexadentates) | heterocyclic ring or to the N-containing |
| | substituent, but they do not coordinate with the |
| | stabilized, high valence metal ion. Ring(s) can |
| | also contain O, S, or P atoms. This ring(s) |
| | and/or attached, uncoordinating rings and/or N- |
| | containing substituent(s) may or may not have |
| | halogen or polarizing or water- |
| | insolubilizing/solubilizing groups attached. |
| N—P Valence Stabilizer #4: | Heterocyclic ring(s) containing one, two, three, |
| Heterocyclic Rings containing One, Two, | or four nitrogen atoms. In addition, ligand |
| Three, or Four Nitrogen Atoms and having | contains additional phosphorus-containing rings |
| at least one additional Phosphorus Atom | that constitute P binding sites. Can include |
| Binding Site in a Separate Ring (N—P | other ring systems bound to the N- or P- |
| Bidentates, N—P Tridentates, N—P | containing heterocyclic rings, but they do not |
| Tetradentates) | coordinate with the stabilized, high valence |
| | metal ion. Ring(s) can also contain O, S, or P |
| | atoms. This ring(s) and/or additional P- |
| | containing ring(s) and/or attached, |
| | uncoordinating rings may or may not have |
| | halogen or polarizing or water- |
| | insolubilizing/solubilizing groups attached. |
| N—P Valence Stabilizer #5: | Macrocyclic ligands containing two, three, four, |
| Two-, Three-, Four-, Five-, Six-, Seven-, | five, six, seven, eight, nine, or ten binding sites |
| Eight-, Nine-, and Ten-Membered | composed of nitrogen and phosphorus to |
| Macrocyclics, Macrobicyclics, and | valence stabilize the central metal ion. Can |
| Macropolycyclics (including Catapinands, | include other hydrocarbon or ring systems |
| Cryptands, Cyclidenes, and Sepulchrates) | bound to this macrocyclic ligand, but they do |
| wherein all Binding Sites are composed of | not coordinate with the stabilized, high valence |
| Nitrogen (usually amine or imine groups) or | metal ion. This ligand and/or attached, |
| Phosphorus and are not contained in | uncoordinating hydrocarbons/rings may or may |
| Component Heterocyclic Rings (N—P | not have halogen or polarizing or water- |
| Bidentates, N—P Tridentates, N—P | insolubilizing/solubilizing groups attached. |
| Tetradentates, and N—P Hexadentates) | |
| N—P Valence Stabilizer #6: | Macrocyclic ligands containing a total of four, |
| Four-, Five-, Six-, Seven-, Eight-, Nine-, or | five, six, seven, eight, nine, or ten heterocyclic |
| Ten-Membered Macrocyclics, | rings containing nitrogen or phosphorus binding |
| Macrobicyclics, and Macropolycyclics | sites. Can include other hydrocarbon/ring |
| (including Catapinands, Cryptands, | systems bound to this macrocyclic ligand, but |
| Cyclidenes, and Sepulchrates) wherein all | they do not coordinate with the stabilized, high |
| Binding Sites are composed of Nitrogen or | valence metal ion. This ligand and/or attached, |
| Phosphorus and are contained in | uncoordinating hydrocarbon/rings may or may |
| Component Heterocyclic Rings (N—P | not have halogen or polarizing or water- |
| Bidentates, N—P Tridentates, N—P | insolubilizing groups attached. |
| Tetradentates, or N—P Hexadentates) | |
| N—P Valence Stabilizer #7: | Macrocyclic ligands containing at least one |
| Four-, Five-, Six-, Seven-, Eight-, Nine-, or | heterocyclic ring. These heterocyclic rings |
| Ten-Membered Macrocyclics, | provide nitrogen or phosphorus binding sites to |
| Macrobicyclics, and Macropolycyclics | valence stabilize the central metal ion. Other |
| (including Catapinands, Cryptands, | amine, imine, or phosphine binding sites can |
| Cyclidenes, and Sepulchrates) wherein all | also be included in the macrocyclic ligand, so |
| Binding Sites are composed of Nitrogen or | long as the total number of binding sites is four, |
| Phosphorus and are contained in a | five, six, seven, eight, nine, or ten. Can include |
| Combination of Heterocyclic Rings and | other hydrocarbon/ring systems bound to this |
| Amine, Imine, and Phosphine Groups (N—P | macrocyclic ligand, but they do not coordinate |
| Bidentates, N—P Tridentates, N—P | with the stabilized, high valence metal ion. This |
| Tetradentates, or N—P Hexadentates) | ligand and/or attached, uncoordinating |
| | hydrocarbon/rings may or may not have halogen |
| | or polarizing or water-insolubilizing groups |
| | attached. |
| S—P Valence Stabilizer #1: | [R(—SR′)ₓ]₁₋₃P, [R(—SR′)ₓ]₁₋₃PX, [R(—PR′R″)(— |
| Thioaryl Phosphines (S—P Bidentates, S—P | SR″′)], [R(—PR′R″)(—S—S—R″′)], [R(—PR′R″)(— |
| Tridentates, and S—P Tetradentates) | C(═S)R″′], [R(—PR′R″)ₓ]₂S, [R(—PR′R″)ₓ]₂₋₃ |
| | R″′(—SR″″)_{y}, [R(—SR′)ₓ]₂₋₃R″(—PR″′R″″)_{y}, [R(— |
| | PR′R″)ₓ]₂S₂, and [R(—PR′R″)ₓ]₂R″′(C(═S))_{y}R″″, |
| | where X = O or S, and R, R′, R″, R″′, and R″″ |
| | represent H, NH₂, or any organic functional |
| | group wherein the number of carbon atoms |
| | ranges from 0 to 40, optionally having halogen |
| | or polarizing or water- |
| | insolubilizing/solubilizing groups attached, and |
| | x = 1-2 and y = 1-4. Ligand can also contain |
| | nonbinding N, O, S, or P atoms. |
| S—P Valence Stabilizer #2: | Heterocyclic ring(s) containing one or two |
| Heterocyclic Rings containing One or Two | sulfur atoms. In addition, ligand contains |
| Sulfur Atoms and having at least one | additional phosphorus-containing substituents |
| additional Phosphorus Atom Binding Site | that constitute P binding sites. Can include |
| not in a Ring (P—S Bidentates, P—S | other ring systems bound to the heterocyclic |
| Tridentates, P—S Tetradentates, or P—S | ring or to the P-containing substituent, but they |
| Hexadentates) | do not coordinate with the stabilized, high |
| | valence metal ion. Ring(s) can also contain O, |
| | S, or P atoms. This ring(s) and/or attached, |
| | uncoordinating rings and/or P-containing |
| | substituent(s) may or may not have halogen or |
| | polarizing or water-insolubilizing/solubilizing |
| | groups attached. |
| S—P Valence Stabilizer #3: | Heterocyclic ring(s) containing one, two, or |
| Heterocyclic Rings containing One, Two, | three phosphorus atoms. In addition, ligand |
| or Three Phosphorus Atoms and having at | contains additional sulfur-containing |
| least one additional Sulfur Atom Binding | substituents (usually thiol, mercapto, or |
| Site not in a Ring (S—P Bidentates, S—P | thiocarbonyl groups) that constitute S binding |
| Tridentates, S—P Tetradentates, or S—P | sites. Can include other ring systems bound to |
| Hexadentates) | the heterocyclic ring or to the S-containing |
| | substituent, but they do not coordinate with the |
| | stabilized, high valence metal ion. Ring(s) can |
| | also contain O, S, or P atoms. This ring(s) |
| | and/or attached, uncoordinating rings and/or S- |
| | containing substituent(s) may or may not have |
| | halogen or polarizing or water- |
| | insolubilizing/solubilizing groups attached. |
| S—P Valence Stabilizer #4: | Heterocyclic ring(s) containing one or two |
| Heterocyclic Rings containing One or Two | sulfur atoms. In addition, ligand contains |
| Sulfur Atoms and having at least one | additional phosphorus-containing rings that |
| additional Phosphorus Atom Binding Site | constitute P binding sites. Can include other |
| in a Separate Ring (S—P Bidentates, S—P | ring systems bound to the S- or P-containing |
| Tridentates, S—P Tetradentates) | heterocyclic rings, but they do not coordinate |
| | with the stabilized, high valence metal ion. |
| | Ring(s) can also contain O, S, or P atoms. This |
| | ring(s) and/or additional P-containing ring(s) |
| | and/or attached, uncoordinating rings may or |
| | may not have halogen or polarizing or water- |
| | insolubilizing/solubilizing groups attached. |
| S—P Valence Stabilizer #5: | Macrocyclic ligands containing two, three, four, |
| Two-, Three-, Four-, Five-, Six-, Seven-, | five, six, seven, eight, nine, or ten binding sites |
| Eight-, Nine-, and Ten-Membered | composed of sulfur and phosphorus to valence |
| Macrocyclics, Macrobicyclics, and | stabilize the central metal ion. Can include other |
| Macropolycyclics (including Catapinands, | hydrocarbon or ring systems bound to this |
| Cryptands, Cyclidenes, and Sepulchrates) | macrocyclic ligand, but they do not coordinate |
| wherein all Binding Sites are composed of | with the stabilized, high valence metal ion. This |
| Sulfur (usually thiol, mercapto, or | ligand and/or attached, uncoordinating |
| thiocarbonyl groups) or Phosphorus and are | hydrocarbons/rings may or may not have |
| not contained in Component Heterocyclic | halogen or polarizing or water- |
| Rings (S—P Bidentates, S—P Tridentates, S—P | insolubilizing/solubilizing groups attached. |
| Tetradentates, and S—P Hexadentates) | |
| S—P Valence Stabilizer #6: | Macrocyclic ligands containing a total of four, |
| Four-, Five-, Six-, Seven-, Eight-, Nine-, or | five, six, seven, eight, nine, or ten heterocyclic |
| Ten-Membered Macrocyclics, | rings containing sulfur or phosphorus binding |
| Macrobicyclics, and Macropolycyclics | sites. Can include other hydrocarbon/ring |
| (including Catapinands, Cryptands, | systems bound to this macrocyclic ligand, but |
| Cyclidenes, and Sepulchrates) wherein all | they do not coordinate with the stabilized, high |
| Binding Sites are composed of Sulfur or | valence metal ion. This ligand and/or attached, |
| Phosphorus and are contained in | uncoordinating hydrocarbon/rings may or may |
| Component Heterocyclic Rings (S—P | not have halogen or polarizing or water- |
| Bidentates, S—P Tridentates, S—P | insolubilizing groups attached. |
| Tetradentates, or S—P Hexadentates) | |
| S—P Valence Stabilizer #7: | Macrocyclic ligands containing at least one |
| Four-, Five-, Six-, Seven-, Eight-, Nine-, or | heterocyclic ring. These heterocyclic rings |
| Ten-Membered Macrocyclics, | provide sulfur or phosphorus binding sites to |
| Macrobicyclics, and Macropolycyclics | valence stabilize the central metal ion. Other |
| (including Catapinands, Cryptands, | thiol, mercapto, or thiocarbonyl, or phosphine |
| Cyclidenes, and Sepulchrates) wherein all | binding sites can also be included in the |
| Binding Sites are composed of Sulfur or | macrocyclic ligand, so long as the total number |
| Phosphorus and are contained in a | of binding sites is four, five, six, seven, eight, |
| Combination of Heterocyclic Rings and | nine, or ten. Can include other |
| Thiol, Mercapto, Thiocarbonyl or | hydrocarbon/ring systems bound to this |
| Phosphine Groups (S—P Bidentates, S—P | macrocyclic ligand, but they do not coordinate |
| Tridentates, S—P Tetradentates, or S—P | with the stabilized, high valence metal ion. This |
| Hexadentates) | ligand and/or attached, uncoordinating |
| | hydrocarbon/rings may or may not have halogen |
| | or polarizing or water-insolubilizing groups |
| | attached. |
| P—O Valence Stabilizer #1: | [R(—OR′)ₓ]₁₋₃P, [R(—OR′)ₓ]₁₋₃PX, [R(—PR′R″)(— |
| Hydroxyaryl Phosphines (P—O Bidentates, | OR″′)], [R(—PR′R″)(—C(═O)R″′], [R(— |
| P—O Tridentates, and P—O Tetradentates) | PR′R″)ₓ]₂O, [R(—PR′R″)ₓ]₂₋₃R″′(—OR″″)_{y}, [R(— |
| | OR′)ₓ]₂₋₃R″(—PR″′R″″)_{y}, and [R(— |
| | PR′R″)ₓ]₂R″′(C(═O))_{y}R″″, where X = O or S, |
| | and R, R′, R″, R″′, and R″″ represent H, NH₂, |
| | or any organic functional group wherein the |
| | number of carbon atoms ranges from 0 to 40, |
| | optionally having halogen or polarizing or |
| | water-insolubilizing/solubilizing groups |
| | attached, and x = 1-2 and y = 1-4. Ligand can |
| | also contain nonbinding N, O, S, or P atoms. |
| P—O Valence Stabilizer #2: | Heterocyclic ring(s) containing one or two |
| Heterocyclic Rings containing One or Two | oxygen atoms. In addition, ligand contains |
| Oxygen Atoms and having at least one | additional phosphorus-containing substituents |
| additional Phosphorus Atom Binding Site | that constitute P binding sites. Can include |
| not in a Ring (P—O Bidentates, P—O | other ring systems bound to the heterocyclic |
| Tridentates, P—O Tetradentates, or P—O | ring or to the P-containing substituent, but they |
| Hexadentates) | do not coordinate with the stabilized, high |
| | valence metal ion. Ring(s) can also contain O, |
| | S, or P atoms. This ring(s) and/or attached, |
| | uncoordinating rings and/or P-containing |
| | substituent(s) may or may not have halogen or |
| | polarizing or water-insolubilizing/solubilizing |
| | groups attached. |
| P—O Valence Stabilizer #3: | Heterocyclic ring(s) containing one, two, or |
| Heterocyclic Rings containing One, Two, | three phosphorus atoms. In addition, ligand |
| or Three Phosphorus Atoms and having at | contains additional oxygen-containing |
| least one additional Oxygen Atom Binding | substituents (usually hydroxy, carboxy, or |
| Site not in a Ring (P—O Bidentates, P—O | carbonyl groups) that constitute O binding sites. |
| Tridentates, P—O Tetradentates, or P—O | Can include other ring systems bound to the |
| Hexadentates) | heterocyclic ring or to the O-containing |
| | substituent, but they do not coordinate with the |
| | stabilized, high valence metal ion. Ring(s) can |
| | also contain O, S, or P atoms. This ring(s) |
| | and/or attached, uncoordinating rings and/or O- |
| | containing substituent(s) may or may not have |
| | halogen or polarizing or water- |
| | insolubilizing/solubilizing groups attached. |
| P—O Valence Stabilizer #4: | Heterocyclic ring(s) containing one or two |
| Heterocyclic Rings containing One or Two | oxygen atoms. In addition, ligand contains |
| Oxygen Atoms at least one additional | additional phosphorus-containing rings that |
| Phosphorus Atom Binding Site in a | constitute P binding sites. Can include other |
| Separate Ring (P—O Bidentates, P—O | ring systems bound to the O- or P-containing |
| Tridentates, P—O Tetradentates) | heterocyclic rings, but they do not coordinate |
| | with the stabilized, high valence metal ion. |
| | Ring(s) can also contain O, S, or P atoms. This |
| | ring(s) and/or additional P-containing ring(s) |
| | and/or attached, uncoordinating rings may or |
| | may not have halogen or polarizing or water- |
| | insolubilizing/solubilizing groups attached. |
| P—O Valence Stabilizer #5: | Macrocyclic ligands containing two, three, four, |
| Two-, Three-, Four-, Five-, Six-, Seven-, | five, six, seven, eight, nine, or ten binding sites |
| Eight-, Nine-, and Ten-Membered | composed of oxygen and phosphorus to valence |
| Macrocyclics, Macrobicyclics, and | stabilize the central metal ion. Can include other |
| Macropolycyclics (including Catapinands, | hydrocarbon or ring systems bound to this |
| Cryptands, Cyclidenes, and Sepulchrates) | macrocyclic ligand, but they do not coordinate |
| wherein all Binding Sites are composed of | with the stabilized, high valence metal ion. This |
| Oxygen (usually hydroxy, carboxy, or | ligand and/or attached, uncoordinating |
| carbonyl groups) or Phosphorus and are not | hydrocarbons/rings may or may not have |
| contained in Component Heterocyclic | halogen or polarizing or water- |
| Rings (P—O Bidentates, P—O Tridentates, P—O | insolubilizing/solubilizing groups attached. |
| Tetradentates, and P—O Hexadentates) | |
| P—O Valence Stabilizer #6: | Macrocyclic ligands containing a total of four, |
| Four-, Five-, Six-, Seven-, Eight-, Nine-, or | five, six, seven, eight, nine, or ten heterocyclic |
| Ten-Membered Macrocyclics, | rings containing oxygen or phosphorus binding |
| Macrobicyclics, and Macropolycyclics | sites. Can include other hydrocarbon/ring |
| (including Catapinands, Cryptands, | systems bound to this macrocyclic ligand, but |
| Cyclidenes, and Sepulchrates) wherein all | they do not coordinate with the stabilized, high |
| Binding Sites are composed of Oxygen or | valence metal ion. This ligand and/or attached, |
| Phosphorus and are contained in | uncoordinating hydrocarbon/rings may or may |
| Component Heterocyclic Rings (P—O | not have halogen or polarizing or water- |
| Bidentates, P—O Tridentates, P—O | insolubilizing groups attached. |
| Tetradentates, or P—O Hexadentates) | |
| P—O Valence Stabilizer #7: | Macrocyclic ligands containing at least one |
| Four-, Five-, Six-, Seven-, Eight-, Nine-, or | heterocyclic ring. These heterocyclic rings |
| Ten-Membered Macrocyclics, | provide oxygen or phosphorus binding sites to |
| Macrobicyclics, and Macropolycyclics | valence stabilize the central metal ion. Other |
| (including Catapinands, Cryptands, | hydroxy, carboxy, carbonyl, or phosphine |
| Cyclidenes, and Sepulchrates) wherein all | binding sites can also be included in the |
| Binding Sites are composed of Oxygen or | macrocyclic ligand, so long as the total number |
| Phosphorus and are contained in a | of binding sites is four, five, six, seven, eight, |
| Combination of Heterocyclic Rings and | nine, or ten. Can include other |
| Hydroxy, Carboxy, Carbonyl or Phosphine | hydrocarbon/ring systems bound to this |
| Groups (P—O Bidentates, P—O Tridentates, | macrocyclic ligand, but they do not coordinate |
| P—O Tetradentates, or P—O Hexadentates) | with the stabilized, high valence metal ion. This |
| | ligand and/or attached, uncoordinating |
| | hydrocarbon/rings may or may not have halogen |
| | or polarizing or water-insolubilizing groups |
| | attached. |
| As Valence Stabilizer #1: | AsH₃, AsH₂R, AsHR₂, where R represents H or |
| Monoarsines (As Monodentates) wherein at | any organic functional group wherein the |
| least one Arsenic Atom is a Binding Site | number of carbon atoms ranges from 0 to 25, |
| | optionally having halogen or polarizing or |
| | water-insolubilizing/solubilizing groups |
| | attached. Ligand can also contain nonbinding N, |
| | P, As, O, S, or Se atoms. |
| As Valence Stabilizer #2: | R′—As—R—As—R″, where R, R′, and R″ represent |
| Diarsines (an As—As Bidentate) wherein at | H or any organic functional group wherein the |
| least one Arsenic Atom is a Binding Site | number of carbon atoms ranges from 0 to 25, |
| | optionally having halogen or polarizing or |
| | water-insolubilizing/solubilizing groups |
| | attached. Ligand can also contain nonbinding N, |
| | P, As, O, S, or Se atoms. |
| As Valence Stabilizer #3: | R—As—R′—As—R″—As—R″′, where R, R′, R″, and |
| Triarsines (either As—As Bidentates or As— | R″′ represent H or any organic functional group |
| As Tridentates) wherein at least one | wherein the number of carbon atoms ranges |
| Arsenic Atom is a Binding Site | from 0 to 25, optionally having halogen or |
| | polarizing or water-insolubilizing/solubilizing |
| | groups attached. Ligand can also contain |
| | nonbinding N, P, As, O, S, or Se atoms. |
| As Valence Stabilizer #4: | R—As—R′—As—R″—As—R″′—As—R″″, where R, R′, |
| Tetraarsines (As—As Bidentates, As—As | R″, R″′, and R″″ represent H or any organic |
| Tridentates, or As—As Tetradentates) | functional group wherein the number of carbon |
| wherein at least one Arsenic Atom is a | atoms ranges from 0 to 25, optionally having |
| Binding Site | halogen or polarizing or water- |
| | insolubilizing/solubilizing groups attached. |
| | Ligand can also contain nonbinding N, P, As, O, |
| | S, or Se atoms. |
| As Valence Stabilizer #5: | R—As—R′—As—R″—As—R″′—As—R″″—As—R″″′, |
| Pentaarsines (As—As Bidentates, As—As | where R, R′, R″, R″′, R″″, and R″″′ represent H |
| Tridentates, or As—As Tetradentates) | or any organic functional group wherein the |
| wherein at least one Arsenic Atom is a | number of carbon atoms ranges from 0 to 25, |
| Binding Site | optionally having halogen or polarizing or |
| | water-insolubilizing/solubilizing groups |
| | attached. Ligand can also contain nonbinding N, |
| | P, As, O, S, or Se atoms. |
| As Valence Stabilizer #6: | R—As—R′—As—R″—As—R″′—As—R″″—As—R″″′—As— |
| Hexaarsines (As—As Bidentates, As—As | R″″″, where R, R′, R″, R″′, R″″, R″″′, and |
| Tridentates, As—As Tetradentates, or As—As | R″″″ represent H or any organic functional |
| Hexadentates) wherein at least one Arsenic | group wherein the number of carbon atoms |
| Atom is a Binding Site | ranges from 0 to 25, optionally having halogen |
| | or polarizing or water- |
| | insolubilizing/solubilizing groups attached. |
| | Ligand can also contain nonbinding N, P, As, O, |
| | S, or Se atoms. |
| As Valence Stabilizer #7: | Five membered heterocyclic ring containing just |
| Five-Membered Heterocyclic Rings | one arsenic binding site. Can include other ring |
| containing One Arsenic Atom wherein the | systems bound to this heterocyclic ring, but they |
| Arsenic Atom is the Binding Site (As | do not coordinate with the stabilized, high |
| Monodentates) | valence metal ion. Ring can also contain O, S, |
| | N, P, or Se atoms. This 5-membered ring |
| | and/or attached, uncoordinating rings may or |
| | may not have halogen or polarizing or water- |
| | insolubilizing/solubilizing groups attached. |
| As Valence Stabilizer #8: | Six membered heterocyclic ring containing just |
| Six-Membered Heterocyclic Rings | one arsenic binding site. Can include other ring |
| containing One Arsenic Atom wherein the | systems bound to this heterocyclic ring, but they |
| Arsenic Atom is the Binding Site (As | do not coordinate with the stabilized, high |
| Monodentates) | valence metal ion. Ring can also contain O, S, |
| | N, P, or Se atoms. This 6-membered ring |
| | and/or attached, uncoordinating rings may or |
| | may not have halogen or polarizing or water- |
| | insolubilizing/solubilizing groups attached. |
| As Valence Stabilizer #9: | Five membered heterocyclic ring(s) containing |
| Five-Membered Heterocyclic Rings | one arsenic atom. In addition, ligand contains |
| containing One Arsenic Atom and having at | additional arsenic-containing substituents |
| least one additional Arsenic Atom Binding | (usually arsines) that constitute As binding sites. |
| Site not in a Ring (As Monodentates, As—As | Can include other ring systems bound to the |
| Bidentates, As—As Tridentates, As—As | heterocyclic ring or to the As-containing |
| Tetradentates, or As—As Hexadentates) | substituent, but they do not coordinate with the |
| | stabilized, high valence metal ion. Ring(s) can |
| | also contain O, N, S, P or Se atoms. This 5- |
| | membered ring(s) and/or attached, |
| | uncoordinating rings and/or As-containing |
| | substituent(s) may or may not have halogen or |
| | polarizing or water-insolubilizing/solubilizing |
| | groups attached. |
| As Valence Stabilizer #10: | Six membered heterocyclic ring(s) containing |
| Six-Membered Heterocyclic Rings | one arsenic atom. In addition, ligand contains |
| containing One Arsenic Atom and having at | additional arsenic-containing substituents |
| least one additional Arsenic Atom Binding | (usually arsines) that constitute As binding sites. |
| Site not in a Ring (As Monodentates, As—As | Can include other ring systems bound to the |
| Bidentates, As—As Tridentates, As—As | heterocyclic ring or to the As-containing |
| Tetradentates, or As—As Hexadentates) | substituent, but they do not coordinate with the |
| | stabilized, high valence metal ion. Ring(s) can |
| | also contain O, N, S, P or Se atoms. This 6- |
| | membered ring(s) and/or attached, |
| | uncoordinating rings and/or As-containing |
| | substituent(s) may or may not have halogen or |
| | polarizing or water-insolubilizing/solubilizing |
| | groups attached. |
| As Valence Stabilizer #11: | Five membered heterocyclic ring(s) containing |
| Five-Membered Heterocyclic Rings | one arsenic atom. In addition, ligand contains |
| containing One Arsenic Atom and having at | additional arsenic-containing rings that |
| least one additional Arsenic Atom Binding | constitute As binding sites. Can include other |
| Site in a separate Ring (As Monodentates, | ring systems bound to the As-containing |
| As—As Bidentates, As—As Tridentates, As— | heterocyclic rings, but they do not coordinate |
| As Tetradentates, or As—As Hexadentates) | with the stabilized, high valence metal ion. |
| | Ring(s) can also contain O, N, S, P, or Se |
| | atoms. This 5-membered ring(s) and/or |
| | additional As-containing ring(s) and/or |
| | attached, uncoordinating rings may or may not |
| | have halogen or polarizing or water- |
| | insolubilizing/solubilizing groups attached. |
| As Valence Stabilizer #12: | Six membered heterocyclic ring(s) containing |
| Six-Membered Heterocyclic Rings | one arsenic atom. In addition, ligand contains |
| containing One Arsenic Atom and having at | additional arsenic-containing rings that |
| least one additional Arsenic Atom Binding | constitute As binding sites. Can include other |
| Site in a separate Ring (As Monodentates, | ring systems bound to the As-containing |
| As—As Bidentates, As—As Tridentates, As— | heterocyclic rings, but they do not coordinate |
| As Tetradentates, or As—As Hexadentates) | with the stabilized, high valence metal ion. |
| | Ring(s) can also contain O, N, S, P, or Se |
| | atoms. This 6-membered ring(s) and/or |
| | additional As-containing ring(s) and/or |
| | attached, uncoordinating rings may or may not |
| | have halogen or polarizing or water- |
| | insolubilizing/solubilizing groups attached. |
| As Valence Stabilizer #13: | Macrocyclic ligands containing two, three, four, |
| Two-, Three-, Four-, and Six-Membered | or six arsenic binding sites to valence stabilize |
| Macrocyclics, Macrobicyclics, and | the central metal ion. Can include other |
| Macropolycyclics (including Catapinands, | hydrocarbon or ring systems bound to this |
| Cryptands, Cyclidenes, and Sepulchrates) | macrocyclic ligand, but they do not coordinate |
| wherein all Binding Sites are composed of | with the stabilized, high valence metal ion. This |
| Arsenic and are not contained in | ligand and/or attached, uncoordinating |
| Component Heterocyclic Rings (As—As | hydrocarbons/rings may or may not have |
| Bidentates, As—As Tridentates, As—As | halogen or polarizing or water- |
| Tetradentates, and As—As Hexadentates) | insolubilizing/solubilizing groups attached. |
| As Valence Stabilizer #14: | Macrocyclic ligands containing a total of four or |
| Four-, or Six-Membered Macrocyclics, | six five-membered heterocyclic rings containing |
| Macrobicyclics, and Macropolycyclics | arsenic binding sites. Can include other |
| (including Catapinands, Cryptands, | hydrocarbon/ring systems bound to this |
| Cyclidenes, and Sepulchrates) wherein all | macrocyclic ligand, but they do not coordinate |
| Binding Sites are composed of Arsenic and | with the stabilized, high valence metal ion. This |
| are contained in Component 5-Membered | ligand and/or attached, uncoordinating |
| Heterocyclic Rings (As—As Tridentates, As— | hydrocarbon/rings may or may not have halogen |
| As Tetradentates, or As—As Hexadentates) | or polarizing or water-insolubilizing groups |
| | attached. |
| As Valence Stabilizer #15: | Macrocyclic ligands containing at least one 5- |
| Four-, or Six-Membered Macrocyclics, | membered heterocyclic ring. These |
| Macrobicyclics, and Macropolycyclics | heterocyclic rings provide arsenic binding sites |
| (including Catapinands, Cryptands, | to valence stabilize the central metal ion. Other |
| Cyclidenes, and Sepulchrates) wherein all | arsine binding sites can also be included in the |
| Binding Sites are composed of Arsenic and | macrocyclic ligand, so long as the total number |
| are contained in a Combination of 5- | of binding sites is four or eight. Can include |
| Membered Heterocyclic Rings and Arsine | other hydrocarbon/ring systems bound to this |
| Groups (As—As Tridentates, As—As | macrocyclic ligand, but they do not coordinate |
| Tetradentates, or As—As Hexadentates) | with the stabilized, high valence metal ion. This |
| | ligand and/or attached, uncoordinating |
| | hydrocarbon/rings may or may not have halogen |
| | or polarizing or water-insolubilizing groups |
| | attached. |
| As Valence Stabilizer #16: | Macrocyclic ligands containing a total of four or |
| Four-, or Six-Membered Macrocyclics, | six six-membered heterocyclic rings containing |
| Macrobicyclics, and Macropolycyclics | arsenic binding sites. Can include other |
| (including Catapinands, Cryptands, | hydrocarbon/ring systems bound to this |
| Cyclidenes, and Sepulchrates) wherein all | macrocyclic ligand, but they do not coordinate |
| Binding Sites are composed of Arsenic and | with the stabilized, high valence metal ion. This |
| are contained in Component 6-Membered | ligand and/or attached, uncoordinating |
| Heterocyclic Rings (As—As Tridentates, As— | hydrocarbon/rings may or may not have halogen |
| As Tetradentates, or As—As Hexadentates) | or polarizing or water-insolubilizing groups |
| | attached. |
| As Valence Stabilizer #17: | Macrocyclic ligands containing at least one 6- |
| Four-, or Six-Membered Macrocyclics, | membered heterocyclic ring. These |
| Macrobicyclics, and Macropolycyclics | heterocyclic rings provide arsenic binding sites |
| (including Catapinands, Cryptands, | to valence stabilize the central metal ion. Other |
| Cyclidenes, and Sepulchrates) wherein all | arsine binding sites can also be included in the |
| Binding Sites are composed of Arsenic and | macrocyclic ligand, so long as the total number |
| are contained in a Combination of 6- | of binding sites is four or six. Can include other |
| Membered Heterocyclic Rings and Arsine | hydrocarbon/ring systems bound to this |
| Groups (As—As Tridentates, As—As | macrocyclic ligand, but they do not coordinate |
| Tetradentates, or As-As Hexadentates) | with the stabilized, high valence metal ion. This |
| | ligand and/or attached, uncoordinating |
| | hydrocarbon/rings may or may not have halogen |
| | or polarizing or water-insolubilizing groups |
| | attached. |
| Se Valence Stabilizer #1: | SeH₂, SeHR, SeR₂, where R represents H or any |
| Monoselenoethers (Se Monodentates) | organic functional group wherein the number of |
| wherein at least one Selenium Atom is a | carbon atoms ranges from 0 to 25, optionally |
| Binding Site | having halogen or polarizing or water- |
| | insolubilizing/solubilizing groups attached. |
| | Ligand can also contain nonbinding N, P, O, S, |
| | or Se atoms. |
| Se Valence Stabilizer #2: | R—Se—R′—Se—R″, where R, R′, and R″ represents |
| Diselenoethers (Se—Se Bidentates) wherein | H or any organic functional group wherein the |
| at least one Selenium Atom is a Binding | number of carbon atoms ranges from 0 to 25, |
| Site | optionally having halogen or polarizing or |
| | water-insolubilizing/solubilizing groups |
| | attached. Ligand can also contain nonbinding N, |
| | P, O, S, or Se atoms. |
| Se Valence Stabilizer #3: | R—Se—R′—Se—R″—Se—R″′, where R, R′, R″, and |
| Triselenoethers (Se—Se Bidentates or Se—Se | R″′ represents H or any organic functional |
| Tridentates) wherein at least one Selenium | group wherein the number of carbon atoms |
| Atom is a Binding Site | ranges from 0 to 25, optionally having halogen |
| | or polarizing or water- |
| | insolubilizing/solubilizing groups attached. |
| | Ligand can also contain nonbinding N, P, O, S, |
| | or Se atoms. |
| Se Valence Stabilizer #4: | R—Se—R′—Se—R″—Se—R″′—Se—R″″, where R, R′, |
| Tetraselenoethers (Se—Se Bidentates, Se—Se | R″, R″′, and R″″ represents H or any organic |
| Tridentates, or Se—Se Tetradentates) | functional group wherein the number of carbon |
| wherein at least one Selenium Atom is a | atoms ranges from 0 to 25, optionally having |
| Binding Site | halogen or polarizing or water- |
| | insolubilizing/solubilizing groups attached. |
| | Ligand can also contain nonbinding N, P, O, S, |
| | or Se atoms. |
| Se Valence Stabilizer #5: | Five membered heterocyclic ring containing one |
| Five-Membered Heterocyclic Rings | or two selenium atoms, both of which may |
| containing One or Two Selenium Atoms | function as binding sites. Can include other |
| wherein at least one Selenium Atom is a | ring systems bound to this heterocyclic ring, but |
| Binding Site (Se Monodentates or Se—Se | they do not coordinate with the stabilized, high |
| Bidentates) | valence metal ion. Ring can also contain O, N, |
| | P, As, or S atoms. This 5-membered ring and/or |
| | attached, uncoordinating rings may or may not |
| | have halogen or polarizing or water- |
| | insolubilizing/solubilizing groups attached. |
| Se Valence Stabilizer #6: | Six membered heterocyclic ring containing one |
| Six-Membered Heterocyclic Rings | or two selenium atoms, both of which may |
| containing One or Two Selenium Atoms | function as binding sites. Can include other |
| wherein at least one Selenium Atom is a | ring systems bound to this heterocyclic ring, but |
| Binding Site (Se Monodentates or Se—Se | they do not coordinate with the stabilized, high |
| Bidentates) | valence metal ion. Ring can also contain O, N, |
| | P, As, or S atoms. This 5-membered ring and/or |
| | attached, uncoordinating rings may or may not |
| | have halogen or polarizing or water- |
| | insolubilizing/solubilizing groups attached. |
| Se Valence Stabilizer #7: | Five membered heterocyclic ring(s) containing |
| Five-Membered Heterocyclic Rings | one selenium atom. In addition, ligand contains |
| containing One Selenium Atom and having | additional selenium-containing substituents |
| at least one additional Selenium Atom | (usually selenols or selenoethers) that constitute |
| Binding Site not in a Ring (Se | Se binding sites. Can include other ring |
| Monodentates, Se—Se Bidentates, Se—Se | systems bound to the heterocyclic ring or to the |
| Tridentates, Se—Se Tetradentates, or Se—Se | Se-containing substituent, but they do not |
| Hexadentates) | coordinate with the stabilized, high valence |
| | metal ion. Ring(s) can also contain O, N, P, As |
| | or S atoms. This 5-membered ring(s) and/or |
| | attached, uncoordinating rings and/or Se- |
| | containing substituent(s) may or may not have |
| | halogen or polarizing or water- |
| | insolubilizing/solubilizing groups attached. |
| Se Valence Stabilizer #8: | Six membered heterocyclic ring(s) containing |
| Six-Membered Heterocyclic Rings | one selenium atom. In addition, ligand contains |
| containing One Selenium Atom and having | additional selenium-containing substituents |
| at least one additional Selenium Atom | (usually selenols or selenoethers) that constitute |
| Binding Site not in a Ring (Se | Se binding sites. Can include other ring |
| Monodentates, Se—Se Bidentates, Se—Se | systems bound to the heterocyclic ring or to the |
| Tridentates, Se—Se Tetradentates, or Se—Se | Se-containing substituent, but they do not |
| Hexadentates) | coordinate with the stabilized, high valence |
| | metal ion. Ring(s) can also contain O, N, P, As |
| | or S atoms. This 6-membered ring(s) and/or |
| | attached, uncoordinating rings and/or Se- |
| | containing substituent(s) may or may not have |
| | halogen or polarizing or water- |
| | insolubilizing/solubilizing groups attached. |
| Se Valence Stabilizer #9: | Five membered heterocyclic ring(s) containing |
| Five-Membered Heterocyclic Rings | one selenium atom. In addition, ligand contains |
| containing One Selenium Atom and having | additional selenium-containing rings that |
| at least one additional Selenium Atom | constitute Se binding sites. Can include other |
| Binding Site in a separate Ring (Se | ring systems bound to the Se-containing |
| Monodentates, Se—Se Bidentates, Se—Se | heterocyclic rings, but they do not coordinate |
| Tridentates, Se—Se Tetradentates, or Se—Se | with the stabilized, high valence metal ion. |
| Hexadentates) | Ring(s) can also contain O, N, P, As, or S |
| | atoms. This 5-membered ring(s) and/or |
| | additional Se-containing ring(s) and/or attached, |
| | uncoordinating rings may or may not have |
| | halogen or polarizing or water- |
| | insolubilizing/solubilizing groups attached. |
| Se Valence Stabilizer #10: | Six membered heterocyclic ring(s) containing |
| Six-Membered Heterocyclic Rings | one selenium atom. In addition, ligand contains |
| containing One Selenium Atom and having | additional selenium-containing rings that |
| at least one additional Selenium Atom | constitute Se binding sites. Can include other |
| Binding Site in a separate Ring (Se | ring systems bound to the Se-containing |
| Monodentates, Se—Se Bidentates, Se—Se | heterocyclic rings, but they do not coordinate |
| Tridentates, Se—Se Tetradentates, or Se—Se | with the stabilized, high valence metal ion. |
| Hexadentates) | Ring(s) can also contain O, N, P, As, or S |
| | atoms. This 6-membered ring(s) and/or |
| | additional Se-containing ring(s) and/or attached, |
| | uncoordinating rings may or may not have |
| | halogen or polarizing or water- |
| | insolubilizing/solubilizing groups attached. |
| Se Valence Stabilizer #11: | Macrocyclic ligands containing two, three, four, |
| Two-, Three-, Four-, or Six-Membered | or six selenium binding sites to valence stabilize |
| Macrocyclics, Macrobicyclics, and | the central metal ion. Can include other |
| Macropolycyclics (including Catapinands, | hydrocarbon or ring systems bound to this |
| Cryptands, Cyclidenes, and Sepulchrates) | macrocyclic ligand, but they do not coordinate |
| wherein all Binding Sites are composed of | with the stabilized, high valence metal ion. This |
| Selenium (usually selenol or selenoether | ligand and/or attached, uncoordinating |
| groups) and are not contained in | hydrocarbons/rings may or may not have |
| Component Heterocyclic Rings (Se—Se | halogen or polarizing or water- |
| Bidentates, Se—Se Tridentates, Se—Se | insolubilizing/solubilizing groups attached. |
| Tetradentates, or Se—Se Hexadentates) | |
| Se Valence Stabilizer #12: | Macrocyclic ligands containing a total of four or |
| Four-, or Six-Membered Macrocyclics, | six five-membered heterocyclic rings containing |
| Macrobicyclics, and Macropolycyclics | selenium binding sites. Can include other |
| (including Catapinands, Cryptands, | hydrocarbon/ring systems bound to this |
| Cyclidenes, and Sepulchrates) wherein all | macrocyclic ligand, but they do not coordinate |
| Binding Sites are composed of Selenium | with the stabilized, high valence metal ion. This |
| and are contained in Component 5- | ligand and/or attached, uncoordinating |
| Membered Heterocyclic Rings (Se—Se | hydrocarbon/rings may or may not have halogen |
| Tridentates, Se—Se Tetradentates or Se—Se | or polarizing or water-insolubilizing groups |
| Hexadentates) | attached. |
| Se Valence Stabilizer #13: | Macrocyclic ligands containing at least one 5- |
| Four-, or Six-Membered Macrocyclics, | membered heterocyclic ring. These |
| Macrobicyclics, and Macropolycyclics | heterocyclic rings provide selenium binding |
| (including Catapinands, Cryptands, | sites to valence stabilize the central metal ion. |
| Cyclidenes, and Sepulchrates) wherein all | Other selenol or selenoether binding sites can |
| Binding Sites are composed of Selenium | also be included in the macrocyclic ligand, so |
| and are contained in a Combination of 5- | long as the total number of binding sites is four |
| Membered Heterocyclic Rings and Selenol | or six. Can include other hydrocarbon/ring |
| or Selenoether Groups (Se—Se Tridentates, | systems bound to this macrocyclic ligand, but |
| Se—Se Tetradentates, or Se—Se | they do not coordinate with the stabilized, high |
| Hexadentates) | valence metal ion. This ligand and/or attached, |
| | uncoordinating hydrocarbon/rings may or may |
| | not have halogen or polarizing or water- |
| | insolubilizing groups attached. |
| Se Valence Stabilizer #14: | Macrocyclic ligands containing a total of four or |
| Four-, or Six-Membered Macrocyclics, | six six-membered heterocyclic rings containing |
| Macrobicyclics, and Macropolycyclics | selenium binding sites. Can include other |
| (including Catapinands, Cryptands, | hydrocarbon/ring systems bound to this |
| Cyclidenes, and Sepulchrates) wherein all | macrocyclic ligand, but they do not coordinate |
| Binding Sites are composed of Selenium | with the stabilized, high valence metal ion. This |
| and are contained in Component 6- | ligand and/or attached, uncoordinating |
| Membered Heterocyclic Rings (Se—Se | hydrocarbon/rings may or may not have halogen |
| Tridentates, Se—Se Tetradentates, or Se—Se | or polarizing or water-insolubilizing groups |
| Hexadentates) | attached. |
| Se Valence Stabilizer #15: | Macrocyclic ligands containing at least one 6- |
| Four-, or Six-Membered Macrocyclics, | membered heterocyclic ring. These |
| Macrobicyclics, and Macropolycyclics | heterocyclic rings provide selenium binding |
| (including Catapinands, Cryptands, | sites to valence stabilize the central metal ion. |
| Cyclidenes, and Sepulchrates) wherein all | Other selenol or selenoether binding sites can |
| Binding Sites are composed of Selenium | also be included in the macrocyclic ligand, so |
| and are contained in a Combination of 6- | long as the total number of binding sites is four |
| Membered Heterocyclic Rings and Selenol | or six. Can include other hydrocarbon/ring |
| or Selenoether Groups (Se—Se Tridentates, | systems bound to this macrocyclic ligand, but |
| Se—Se Tetradentates, or Se—Se | they do not coordinate with the stabilized, high |
| Hexadentates) | valence metal ion. This ligand and/or attached, |
| | uncoordinating hydrocarbon/rings may or may |
| | not have halogen or polarizing or water- |
| | insolubilizing groups attached. |
| Se Valence Stabilizer #16: | R—C(═Se)—CR′R″—C(═Se)—R″′ where R, R′, R″, |
| 1,3-Diselenoketones (Diseleno-beta- | and R″′ represent H, NH₂, or any organic |
| ketonates), 1,3,5-Triselenoketones, Bis(1,3- | functional group wherein the number of carbon |
| Diselenoketones), and Poly(1,3- | atoms ranges from 0 to 40, optionally having |
| Diselenoketones) (S—S Bidentates, S—S | halogen or polarizing or water- |
| Tridentates, S—S Tetradentates) | insolubilizing/solubilizing groups attached. |
| | Ligand can also contain nonbinding N, O, S, or |
| | P atoms. |
| Se Valence Stabilizer #17: | RR′—C═C(—Se⁻)(—Se⁻), where R and R′ represent |
| 1,1-Diselenolates, Bis(1,1-diselenolates), | H, NH₂ or any organic functional group wherein |
| and Poly(1,1-diselenolates) (Se—Se | the number of carbon atoms ranges from 0 to |
| Bidentates and Se—Se Tetradentates) | 40, optionally having halogen or polarizing or |
| | water-insolubilizing/solubilizing groups |
| | attached. Ligand can also contain nonbinding |
| | N, O, S, or P atoms. |
| Se Valence Stabilizer #18: | RR′N⁺═C(SeH)(SeH), where R and R′ |
| Diselenocarbamates, | represent H, OH, SH, OR″ (R″ = C₁-C₃₀ alkyl or |
| Bis(diselenocarbamates), and | aryl), SR″ (R″ = C₁-C₃₀ alkyl or aryl), NH₂ or |
| Poly(diselenocarbamates) (including N- | any organic functional group wherein the |
| hydroxydiselenocarbamates and N- | number of carbon atoms ranges from 0 to 40, |
| mercaptodiselenocarbamates) (Se—Se | optionally having halogen or polarizing or |
| Bidentates, Se—Se Tridentates, and Se—Se | water-insolubilizing/solubilizing groups |
| Tetradentates) | attached. Ligand can also contain nonbinding |
| | N, O, S, or P atoms. |
| Se Valence Stabilizer #19: | (O═)P(—Se—R)(—Se—R′)(—Se—R″) or (Se═)P(—Se— |
| Triselenophosphoric Acids | R)(—Se—R′)(—O—R″), where R, R′, and R″ |
| (Phosphorotriselenoic Acids), | represent H, NH₂ or any organic functional |
| Bis(triselenophosphoric acids), | group wherein the number of carbon atoms |
| Poly(triselenophosphoric acids), and | ranges from 0 to 40, optionally having halogen |
| derivatives thereof (Se—Se Bidentates, Se—Se | or polarizing or water- |
| Tridentates, Se—Se Tetradentates) | insolubilizing/solubilizing groups attached. |
| | Ligand can also contain nonbinding N, O, S, or |
| | P atoms. |
| Se Valence Stabilizer #20: | (O═)P(—Se—R)(—Se—R′)(—O—R″) or (Se═)P(—Se— |
| Diselenophosphoric Acids | R)(—O—R′)(—O—R″), where R, R′, and R″ |
| (Phosphorodiselenoic Acids), | represent H, NH₂ or any organic functional |
| Bis(diselenophosphoric acids), | group wherein the number of carbon atoms |
| Poly(diselenophosphoric acids), and | ranges from 0 to 40, optionally having halogen |
| derivatives thereof (Se—Se Bidentates, Se—Se | or polarizing or water- |
| Tridentates, Se—Se Tetradentates) | insolubilizing/solubilizing groups attached. |
| | Ligand can also contain nonbinding N, O, S, or |
| | P atoms. |
| Se Valence Stabilizer #21: | (Se═)P(—Se—R)(—Se—R′)(—Se—R″), where R, R′, |
| Tetraselenophosphoric Acids | and R″ represent H, NH₂ or any organic |
| (Phosphorotetraselenoic Acids), | functional group wherein the number of carbon |
| Bis(tetraselenophosphoric acids), | atoms ranges from 0 to 40, optionally having |
| Poly(tetraselenophosphoric acids), and | halogen or polarizing or water- |
| derivatives thereof (Se—Se Bidentates, Se—Se | insolubilizing/solubilizing groups attached. |
| Tridentates, Se—Se Tetradentates) | Ligand can also contain nonbinding N, O, S, or |
| | P atoms. |
| Se Valence Stabilizer #22: | R—Se—C(═Se)—O—R′ or R—Se—C(═O)—Se—R′ for |
| Diselenocarbonates, Triselenocarbonates, | diselenocarbonates, and R—Se—C(═Se)—Se—R′ for |
| Bis(diselenocarbonates), and | triselenocarbonates, where R, and R′ represent |
| Bis(triselenocarbonates), (Se—Se Bidentates | H, NH₂ or any organic functional group wherein |
| and Se—Se Tetradentates) | the number of carbon atoms ranges from 0 to |
| | 40, optionally having halogen or polarizing or |
| | water-insolubilizing/solubilizing groups |
| | attached. Ligand can also contain nonbinding N, |
| | O, S, or P atoms. |
| Se Valence Stabilizer #23: | Selenocyanates bound directly to the high |
| Selenocyanates (Se Monodentates) | valence metal ion. |
| Se Valence Stabilizer #24: | Selenolates (HSe—R, HSe—R—SeH, etc.), where R |
| Selenolates (Se Monodentates) | and R′ represent H or any organic functional |
| | group wherein the number of carbon atoms |
| | ranges from 0 to 35, optionally having halogen |
| | or polarizing or water- |
| | insolubilizing/solubilizing groups attached. |
| Miscellaneous Valence Stabilizer #1: | Dialkenes or bicyclic or tricyclic hydrocarbons |
| Diene or bicyclic or tricyclic hydrocarbon | bound directly to the high valence metal ion. |
| ligands | |
| Miscellaneous Valence Stabilizer #2: | Cyanide and cyanate and related ligands bound |
| Cyanide and related ligands | directly to the high valence metal ion. |
| Miscellaneous Valence Stabilizer #3: | Carbonyl (—CO) ligands bound directly to the |
| Carbonyl ligands | high valence metal ion. |
| Miscellaneous Valence Stabilizer #4: | Halogen (X) atoms bound directly to the high |
| Halogen ligands | valence metal ion. |
| Miscellaneous Valence Stabilizer #5: | Hydroxo and oxo ligands bound directly to the |
| Hydroxo and Oxo Ligands | high valence metal ion. |

N Valence Stabilizer #1a: Examples of five-membered macrocyclics, macrobicyclics, and macropolycyclics (including catapinands, cryptands, cyclidenes, and sepulchrates) wherein all binding sites are composed of nitrogen (usually amine or imine groups) and are not contained in component heterocyclic rings (N—N Tridentates or N—N Tetradentates) that meet the requirements for use as “narrow band” valence stabilizers for Ce⁺⁴ include, but are not limited to: pentaazacyclodecane ([10]aneN₅); pentaazacycloundecane ([11]aneN₅); pentaazacyclododecane ([12]aneN₅); pentaazacyclotridecane ([13]aneN₅); pentazaacyclotetradecane ([14]aneN₅); pentaazacyclopentadecane ([15]aneN₅); pentaazacyclodecatriene ([10]trieneN₅); pentaazacycloundecatriene ([11]trieneN₅); pentaazacyclododecatriene ([12]trieneN₅); pentaazacyclotridecatriene ([13]trieneN₅); pentazaacyclotetradecatriene ([14]trieneN₅); and pentaazacyclopentadecatriene ([15]trieneN₅).

N Valence Stabilizer #1b: Examples of seven-membered macrocyclics, macrobicyclics, and macropolycyclics (including catapinands, cryptands, cyclidenes, and sepulchrates) wherein all binding sites are composed of nitrogen (usually amine or imine groups) and are not contained in component heterocyclic rings (N—N Tridentates, N—N Tetradentates, or N—N Hexadentates) that meet the requirements for use as “narrow band” valence stabilizers for Ce⁺⁴ include, but are not limited to: heptaazacyclotetradecane ([14]aneN₇); heptaazacyclopentadecane ([15]aneN₇); heptaazacyclohexadecane ([16]aneN₇); heptaazacycloheptadecane ([17]aneN₇); heptaazacyclooctadecane ([18]aneN₇); heptaazacyclononadecane ([19]aneN₇); heptaazacycloeicosane ([20]aneN₇); heptaazacycloheneicosane ([21]aneN₇); heptaazacyclotetradecatriene ([14]trieneN₇); heptaazacyclopentadecatriene ([15]trieneN₇); heptaazacyclohexadecatriene ([16]trieneN₇); heptaazacycloheptadecatriene ([17]trieneN₇); heptaazacyclooctadecatriene ([18]trieneN₇); heptaazacyclononadecatriene ([19]trieneN₇); heptaazacycloeicosatriene ([20]trieneN₇); and heptaazacycloheneicosatriene ([21]trieneN₇).

N Valence Stabilizer #1c: Examples of nine-membered macrocyclics, macrobicyclics, and macropolycyclics (including catapinands, cryptands, cyclidenes, and sepulchrates) wherein all binding sites are composed of nitrogen (usually amine or imine groups) and are not contained in component heterocyclic rings (N—N Tridentates, N—N Tetradentates, or N—N Hexadentates) that meet the requirements for use as “narrow band” valence stabilizers for Ce⁺⁴ include, but are not limited to: nonaazacyclooctadecane ([18]aneNg); nonaazacyclononadecane ([19]aneN₉); nonaazacycloeicosane ([20]aneN₉); nonaazacycloheneicosane ([21]aneN₉); nonaazacyclodocosane ([22]aneN₉); nonaazacyclotricosane ([23]aneN₉); nonaazacyclotetracosane ([24]aneN₉); nonaazacyclopentacosane ([25]aneN₉); nonaazacyclohexacosane ([26]aneN₉); nonaazacycloheptacosane ([27]aneN₉); nonaazacyclooctadecatetradiene ([18]tetradieneN₉); nonaazacyclononadecatetradiene ([19]tetradieneN₉); nonaazacycloeicosatetradiene ([20]tetradieneN₉); nonaazacycloheneicosatetradiene ([21]tetradieneN₉); nonaazacyclodocosatetradiene ([22]tetradieneN₉); nonaazacyclotricosatetradiene ([23]tetradieneN₉); nonaazacyclotetracosatetradiene ([24]tetradieneN₉); nonaazacyclopentacosatetradiene ([25]tetradieneN₉); nonaazacyclohexacosatetradiene ([26]tetradieneN₉); and nonaazacycloheptacosatetradiene ([27]tetradieneN₉).

N Valence Stabilizer #2a: Examples of five-membered macrocyclics, macrobicyclics, and macropolycyclics (including catapinands, cryptands, cyclidenes, and sepulchrates) wherein all five binding sites are composed of nitrogen and are contained in component 5-membered heterocyclic rings (N—N Tetradentates) that meet the requirements for use as “narrow band” valence stabilizers for Ce⁺⁴ include, but are not limited to: pentaphyrins (pentapyrroles); sapphyrins; smaragdyrins; pentaoxazoles; pentaisooxazoles; pentathiazoles; pentaisothiazoles; pentaazaphospholes; pentaimidazoles; pentapyrazoles; pentaoxadiazoles; pentathiadiazoles; pentadiazaphospholes; pentatriazoles; pentaoxatriazoles; and pentathiatriazoles.

N Valence Stabilizer #2b: Examples of seven-membered macrocyclics, macrobicyclics, and macropolycyclics (including catapinands, cryptands, cyclidenes, and sepulchrates) wherein all seven binding sites are composed of nitrogen and are contained in component 5-membered heterocyclic rings (N—N Tetradentates) that meet the requirements for use as “narrow band” valence stabilizers for Ce⁺⁴ include, but are not limited to: heptaphyrins (heptapyrroles); heptaoxazoles; heptaisooxazoles; heptathiazoles; heptaisothiazoles; heptaazaphospholes; heptaimidazoles; heptapyrazoles; heptaoxadiazoles; heptathiadiazoles; heptadiazaphospholes; heptatriazoles; heptaoxatriazoles; and heptathiatriazoles.

N Valence Stabilizer #3a: Examples of five-membered macrocyclics, macrobicyclics, and macropolycyclics (including catapinands, cryptands, cyclidenes, and sepulchrates) wherein all five binding sites are composed of nitrogen and are contained in a combination of 5-membered heterocyclic rings and amine or imine groups (N—N Tridentates or N—N Tetradentates) that meet the requirements for use as “narrow band” valence stabilizers for Ce⁺⁴ include, but are not limited to: superphthalocyanine; supernaphthalocyanine; diazapentaphyrins; tetraazapentaphyrins; pentaazapentaphyrins; diazapentapyrazoles; tetraazapentapyrazoles; pentaazapentapyrazoles; diazapentaimidazoles; tetraazapentaimidazoles; and pentaazapentaimidazoles.

N Valence Stabilizer #3b: Examples of seven-membered macrocyclics, macrobicyclics, and macropolycyclics (including catapinands, cryptands, cyclidenes, and sepulchrates) wherein all seven binding sites are composed of nitrogen and are contained in a combination of 5-membered heterocyclic rings and amine or imine groups (N—N Tridentates, N—N Tetradentates, or N—N Hexadentates) that meet the requirements for use as “narrow band” valence stabilizers for Ce⁺⁴ include, but are not limited to: diazaheptaphyrins; tetraazaheptaphyrins; hexaazaheptaphyrins; diazaheptapyrazoles; tetraazaheptapyrazoles; hexaazaheptapyrazoles; diazaheptaimidazoles; tetraazaheptaimidazoles; and hexaazaheptaimidazoles.

N Valence Stabilizer #3c: Examples of nine-membered macrocyclics, macrobicyclics, and macropolycyclics (including catapinands, cryptands, cyclidenes, and sepulchrates) wherein all nine binding sites are composed of nitrogen and are contained in a combination of 5-membered heterocyclic rings and amine or imine groups (N—N Tridentates, N—N Tetradentates, or N—N Hexadentates) that meet the requirements for use as “narrow band” valence stabilizers for Ce⁺⁴ include, but are not limited to: diazanonaphyrins; tetraazanonaphyrins; hexaazanonaphyrins; diazanonapyrazoles; tetraazanonapyrazoles; hexaazanonapyrazoles; diazanonaimidazoles; tetraazanonaimidazoles; and hexaazanonaimidazoles.

N Valence Stabilizer #4a: Examples of five-membered macrocyclics, macrobicyclics, and macropolycyclics (including catapinands, cryptands, cyclidenes, and sepulchrates) wherein all five binding sites are composed of nitrogen and are contained in component 6-membered heterocyclic rings (N—N Tetradentates) that meet the requirements for use as “narrow band” valence stabilizers for Ce⁺⁴ include, but are not limited to: cyclopentapyridines; cyclopentaoxazines; cyclopentathiazines; cyclopentaphosphorins; cyclopentaquinolines; cyclopentapyrazines; cyclopentapyridazines; cyclopentapyrimidines; cyclopentaoxadiazines; cyclopentathiadiazines; cyclopentadiazaphosphorins cyclopentaquinoxalines; cyclopentatriazines; cyclopentathiatriazines; and cyclopentaoxatriazines.

N Valence Stabilizer #4b: Examples of seven-membered macrocyclics, macrobicyclics, and macropolycyclics (including catapinands, cryptands, cyclidenes, and sepulchrates) wherein all seven binding sites are composed of nitrogen and are contained in component 6-membered heterocyclic rings (N—N Tetradentates) that meet the requirements for use as “narrow band” valence stabilizers for Ce⁺⁴ include, but are not limited to: cycloheptapyridines; cycloheptaoxazines; cycloheptathiazines; cycloheptaphosphorins; cycloheptaquinolines; cycloheptapyrazines; cycloheptapyridazines; cycloheptapyrimidines; cycloheptaoxadiazines; cycloheptathiadiazines; cycloheptadiazaphosphorins cycloheptaquinoxalines; cycloheptatriazines; cycloheptathiatriazines; and cycloheptaoxatriazines.

N Valence Stabilizer #5a: Examples of five-membered macrocyclics, macrobicyclics, and macropolycyclics (including catapinands, cryptands, cyclidenes, and sepulchrates) wherein all five binding sites are composed of nitrogen and are contained in a combination of 6-membered heterocyclic rings and amine or imine groups (N—N Tridentates or N—N Tetradentates) that meet the requirements for use as “narrow band” valence stabilizers for Ce⁺⁴ include, but are not limited to: diazacyclopentapyridines; tetraazacyclopentapyridines; diazacyclopentaquinolines; tetraazacyclopentaquinolines; diazacyclopentapyrazines; tetraazacyclopentapyrazines; diazacyclopentapyridazines; tetraazacyclopentapyridazines; diazacyclopentapyrimidines; tetraazacyclopentapyrimidines; diazacyclopentatriazines; and tetraazacyclopentatriazines.

N Valence Stabilizer #5b: Examples of seven-membered macrocyclics, macrobicyclics, and macropolycyclics (including catapinands, cryptands, cyclidenes, and sepulchrates) wherein all seven binding sites are composed of nitrogen and are contained in a combination of 6-membered heterocyclic rings and amine or imine groups (N—N Tridentates, N—N Tetradentates, or N—N Hexadentates) that meet the requirements for use as “narrow band” valence stabilizers for Ce⁺⁴ include, but are not limited to: diazacycloheptapyridines; tetraazacycloheptapyridines; diazacycloheptaquinolines; tetraazacycloheptaquinolines; diazacycloheptapyrazines; tetraazacycloheptapyrazines; diazacycloheptapyridazines; tetraazacycloheptapyridazines; diazacycloheptapyrimidines; tetraazacycloheptapyrimidines; diazacycloheptatriazines; and tetraazacycloheptatriazines.

N Valence Stabilizer #5c: Examples of nine-membered macrocyclics, macrobicyclics, and macropolycyclics (including catapinands, cryptands, cyclidenes, and sepulchrates) wherein all nine binding sites are composed of nitrogen and are contained in a combination of 6-membered heterocyclic rings and amine or imine groups (N—N Tridentates, N—N Tetradentates, or N—N Hexadentates) that meet the requirements for use as “narrow band” valence stabilizers for Ce⁺⁴ include, but are not limited to: diazacyclononapyridines; tetraazacyclononapyridines; diazacyclononaquinolines; tetraazacyclononaquinolines; diazacyclononapyrazines; tetraazacyclononapyrazines; diazacyclononapyridazines; tetraazacyclononapyridazines; diazacyclononapyrimidines; tetraazacyclononapyrimidines; diazacyclononatriazines; and tetraazacyclononatriazines.

N Valence Stabilizer #6: Examples of silylamines and silazanes (N Monodentates, N—N Bidentates, N—N Tridentates, N—N Tetradentates, and N—N Hexadentates) that meet the requirements for use as “narrow band” valence stabilizers for Ce⁺⁴ include, but are not limited to: trisilylamine; N-methyldisilazane (disilylmethylamine); N,N-dimethylsilylamine; (silyldimethylamine); tris(trimethylsilyl)amine; triethylsilylamine (triethylaminosilane) (triethylsilazane); N-ethyltriethylsilylamine (triethyl-N-ethylaminosilane); di-tert-butylsilanediamine (di-tert-butyldiaminosilane); bis(methylamino)diethylsilane; tris(dimethylamino)ethylsilane; hexamethyldisilazane; N-methylhexaphenyldisilazane; hexamethylcyclotrisilazane; and octaphenylcyclotetrasilazane. [Note: silylamines and silazanes are notably weaker ligands than their carbonaceous derivatives, although replacement of one or two SiR₃ groups with CR₃ will enhance the donor power of the ligand. Thus, N(CR₃)₂(SiR₃) is a better ligand than N(CR₃)(SiR₃)₂, etc.]

N Valence Stabilizer #7: Examples of guanidines, diguanidines, and polyguanidines (N—N bidentates, N—N tridentates, N—N tetradentates, and N—N hexadentates) that meet the requirements for use as “narrow band” valence stabilizers for Ce⁺⁴ include, but are not limited to: guanidine; methylguanidine; ethylguanidine; isopropylguanidine; butylguanidine; benzylguanidine; phenylguanidine; tolylguanidine; naphthylguanidine; cyclohexylguanidine; norbornylguanidine; adamantylguanidine; dimethylguanidine; diethylguanidine; diisopropylguanidine; dibutylguanidine; dibenzylguanidine; diphenylguanidine; ditolylguanidine; dinaphthylguanidine; dicyclohexylguanidine; dinorbornylguanidine; diadamantylguanidine; ethylenediguanidine; propylenediguanidine; tetramethylenediguanidine; pentamethylenediguanidine; hexamethylenediguanidine; heptamethylenediguanidine; octamethylenediguanidine; phenylenediguanidine; piperazinediguanidine; oxalyldiguanidine; malonyldiguanidine; succinyldiguanidine; glutaryldiguanidine; adipyldiguanidine; pimelyldiguanidine; suberyldiguanidine; phthalyldiguanidine; benzimidazoleguanidine; aminoguanidine; nitroaminoguanidine; dicyandiamide (cyanoguanidine); dodecylguanidine; and nitrovin.

N Valence Stabilizer #8: Examples of phosphonitrile amides and bis(phosphonitrile amides) (N—N Bidentates and N—N Tetradentates) that meet the requirements for use as “narrow band” valence stabilizers for Ce⁺⁴ include, but are not limited to: phosphononitrile amide; N-phenylphosphonitrile amide; N-benzylphosphonitrile amide; N-cyclohexylphosphonitrile amide; N-norbornylphosphonitrile amide; N,N′-diphenylphosphonitrile amide; N,N′-dibenzylphosphonitrile amide; N,N′-dicyclohexylphosphonitrile amide; and N,N′-dinorbornylphosphonitrile amide. [Note: the phosphite (P⁺³) valence of the phosphorus atom makes stabilizization of high valence metal ions much more difficult, though still possible.]

N Valence Stabilizer #9: Examples of phosphonimidic diamides, bis(phosphonimidic diamides), and poly(phosphonimidic diamides) (N—N bidentates and N—N tetradentates) that meet the requirements for use as “narrow band” valence stabilizers for Ce⁺⁴ include, but are not limited to: phosphonimidic diamide; N-benzylphosphonimidic diamide; N-phenylphosphonimidic diamide; N-cyclohexylphosphonimidic diamide; N-norbornylphosphonimidic diamide; N,N-dibenzylphosphonimidic diamide; N,N-diphenylphosphonimidic diamide; N,N-dicyclohexylphosphonimidic diamide; and N,N-dinorbornylphosphonimidic diamide. [Note: the phosphite (P⁺³) valence of the phosphorus atom makes stabilizization of high valence metal ions much more difficult, though still possible.]

N Valence Stabilizer #10: Examples of phosphonamidimidic acid, phosphonamidimidothioic acid, bis(phosphonamidimidic acid), bis(phosphonamidimidothioic acid), poly(phosphonamidimidic acid), poly(phosphonamidimidothioic acid), and derivatives thereof (N—N Bidentates, and N—N Tetradentates) that meet the requirements for use as “narrow band” valence stabilizers for Ce⁺⁴ include, but are not limited to: phosphonamidimidic acid, phosphonamidimidothioic acid; O-phenylphosphonamidimidic acid; O-benzylphosphonamidimidic acid; O-cyclohexylphosphonamidimidic acid; O-norbornylphosphonamidimidic acid; S-phenylphosphonamidimidothioic acid; S-benzylphosphonamidimidothioic acid; S-cyclohexylphosphonamidimidothioic acid; and S-norbornylphosphonamidimidothioic acid. [Note: the phosphite (P⁺³) valence of the phosphorus atom makes stabilizization of high valence metal ions much more difficult, though still possible.]

N Valence Stabilizer #11: Examples of pyridinaldimines, bis(pyridinaldimines), and poly(pyridinaldimines) (N—N Bidentates, N—N Tridentates, and N—N Tetradentates) that meet the requirements for use as “narrow band” valence stabilizers for Ce⁺⁴ include, but are not limited to: pyridylideneaniline [N-(pyridylmethylene)benzenamine]; and (2-pyridyl)benzylideneaniline.

N Valence Stabilizer #12: Examples of hydrazones, bis(hydrazones), and poly(hydrazones) (N Monodentates, N—N Bidentates, N—N Tridentates, and N—N Tetradentates) that meet the requirements for use as “narrow band” valence stabilizers for Ce⁺⁴ include, but are not limited to: acetaldehyde hydrazone; acetaldehyde phenylhydrazone; acetone hydrazone; acetone phenylhydrazone; pinacolone hydrazone; pinacolone phenylhydrazone; benzaldehyde hydrazone; benzaldehyde phenylhydrazone; naphthaldehyde hydrazone; naphthaldehyde phenylhydrazone; norbornanone hydrazone; norbornanone phenylhydrazone; camphor hydrazone; camphor phenylhydrazone; nopinone hydrazone; nopinone phenylhydrazine; 2-pyridinaldehyde hydrazone; 2-pyridinealdehyde phenylhydrazone; salicylaldehyde hydrazone; salicylaldehyde phenylhydrazone; quinolinaldehyde hydrazone; quinolinaldehyde phenylhydrazone; isatin dihydrazone; isatin di(phenylhydrazone); camphorquinone dihydrazone; camphorquinone di(phenylhydrazone); and 2-hydrazinobenzimidazole hydrazone.

N Valence Stabilizer #13: Examples of azo compounds without chelate substitution at the ortho- (for aryl) or alpha- or beta- (for alkyl) positions, bis(azo compounds), or poly(azo compounds) (N Monodentates, N—N Bidentates, or N—N Tridentates) that meet the requirements for use as “narrow band” valence stabilizers for Ce⁺⁴ include, but are not limited to: azobenzene (diphenyldiazene); p-diaminoazobenzene; p-dimethylaminoazobenzene (butter yellow); methyl orange; Fast Garnet GBC (4′-amino-2,3′-dimethylazobenzene)[Note: non-bonding methyl group in the o-position.]; and Alizarin Yellow R. [Note: azo compounds without chelate substitution at the ortho- (for aryl) or beta- (for alkyl) positions tend to stabilize lower oxidation states in metal ions.]

N Valence Stabilizer #14: Examples of formazans, bis(formazans), and poly(formazans) without ortho-hydroxy, carboxy, thiol, mercapto, amino, or hydrazido substitution (N—N Bidentates, N—N Tetradentates, and N—N Hexadentates) that meet the requirements for use as “narrow band” valence stabilizers for Ce⁺⁴ include, but are not limited to: 1,3,5-triphenylformazan; and 1,3,5-naphthylformazan.

N Valence Stabilizer #15: Examples of hydramides (N—N Bidentates) that meet the requirements for use as “narrow band” valence stabilizers for Ce⁺⁴ include, but are not limited to: hydrobenzamide; hydronaphthamide; and hydrosalicylamide.

N Valence Stabilizer #16: Examples of azines (including ketazines), bis(azines), and poly(azines) without ortho-hydroxy, carboxy, thiol, mercapto, amino, or hydrazido substitution (N—N Bidentates, N—N Tetradentates, and N—N Hexadentates) that meet the requirements for use as “narrow band” valence stabilizers for Ce⁺⁴ include, but are not limited to: benzalazine; naphthalazine; cyclohexanonazine; and norbornonazine.

N Valence Stabilizer #17: Examples of Schiff Bases with one Imine (C═N) Group and without ortho- (for aryl constituents) or alpha- or beta- (for alkyl constituents) hydroxy, carboxy, carbonyl, thiol, mercapto, thiocarbonyl, amino, imino, oximo, diazeno, or hydrazido substitution (N Monodentates) that meet the requirements for use as “narrow band” valence stabilizers for Ce⁺⁴ include, but are not limited to: N-(Benzaldehydo)isopropylamine; N-(Naphthaldehydo)isopropylamine; N-(Acetophenono)isopropylamine; N-(Propiophenono)isopropylamine; N-(Benzaldehydo)cyclohexylamine; N-(Naphthaldehydo)cyclohexylamine; N-(Acetophenono)cyclohexylamine; N-(Propiophenono)cyclohexylamine; N-(Benzaldehydo)aniline (BAAN); N-(Naphthaldehydo)aniline; N-(Acetophenono)aniline; N-(Propiophenono)aniline; N-(Benzaldehydo)aminonorbomane; N-(Naphthaldehydo)aminonorbomane; N-(Acetophenono)aminonorbomane; N-(Propiophenono)aminonorbomane; (Vanillino)anisidine; (Cinnamaldehydo)anisidine; N-(o-carboxycinnamaldehydo)aniline; N-(cinnamaldehydo)aniline; N-(cinnamaldehydo)m- or p-anisidine; and N-(o-carboxycinnamaldehydo)m- or p-anisidine.

N Valence Stabilizer #18: Examples of isocyanide and cyanamide and related ligands (N Monodentates) that meet the requirements for use as “narrow band” valence stabilizers for Ce⁺⁴ include, but are not limited to: isocyanate (—NCO); isothiocyanate (—NCS); isoselenocyanate (—NCSe); and cyanamide (—NCN). [Note: the nitrogen atom is directly complexed to the high valence metal ion.]

N Valence Stabilizer #19: Examples of nitrosyls and nitrites and related ligands (N Monodentates) that meet the requirements for use as “narrow band” valence stabilizers for Ce⁺⁴ include, but are not limited to: nitrosyl (—NO); thionitrosyl (—NS); nitrite (—NO₂); thionitrite (sulfinylamide)(thiazate)(—NSO); nitrosamine (═NN═O); thionitrosamine (═NN═S); nitramine (═NNO₂); and thionitramine (═NNS₂) ligands.

N Valence Stabilizer #20: Examples of nitriles, dinitriles, and polynitriles (N Monodentates, N—N Bidentates, N—N Tridentates) that meet the requirements for use as “narrow band” valence stabilizers for Ce⁺⁴ include, but are not limited to: benzonitrile; naphthonitrile; cyanonaphthalene; cyclohexyl nitrile; cyanopyridine; cyanopurine; cyanophenol; cyanothiophenol; adamantane nitrile; norbomyl nitrile; cinnamonitrile; dicyanobenzene; dicyanobutene; dicyanoimidazole; dicyanopyridine; cyanotolunitrile; tetracyanoethyne tetracyanoethylene (TCNE); tetracyanoquinodimethane (TCNQ); diethylaminopropionitrile (deapn), and polyacrylonitriles.

N Valence Stabilizer #21: Examples of azide ligands (N monodentates) that meet the requirements for use as “narrow band” valence stabilizers for Ce⁺⁴ include, but are not limited to: azide (—N₃) ions; methyl azide; ethyl azide; phenyl azide; diphenyltriazene; and phenyl sulfonyl azide.

S Valence Stabilizer #1: Examples of monothioethers (S monodentates) that meet the requirements for use as “narrow band” valence stabilizers for Ce⁺⁴ include, but are not limited to: hydrogen sulfide, dimethyl sulfide, diethyl sulfide, dioctyl sulfide, diphenyl sulfide, dicyclohexyl sulfide, tetramethylene sulfide (tetrahydrothiophene, tht), trimethylene sulfide, dimethylene sulfide (ethylene sulfide), pentamethylene sulfide, 1,4-thioxane, oxathiolane, cyclohexene sulfide, cyclooctene sulfide, benzotetrahydrothiophene, dibenzothiophene, naphthotetrahydrothiophene, and thiabicycloheptane.

S Valence Stabilizer #2: Examples of disulfides (S monodentates) that meet the requirements for use as “narrow band” valence stabilizers for Ce⁺⁴ include, but are not limited to: methyl disulfide, ethyl disulfide, phenyl disulfide, nitrophenide, and 1,2-dithiacyclohexane.

S Valence Stabilizer #3: Examples of dithioethers (S monodentates or S—S bidentates) that meet the requirements for use as “narrow band” valence stabilizers for Ce⁺⁴ include, but are not limited to: 1,3-dithiane, 1,4-dithiane, benzodithiane, dibenzodithiane, naphthodithiane, 2,5-dithiahexane (dth); 3,6-dithiaoctane (dto); 2,5-dimethyl-3,6-dithiaoctane; 3,7-dithianonane; 2,6-dithiaheptane; 1,6-diphenyl-2,5-dithiahexane; 1,4-diphenyl-1,4-dithiabutane; 1,3-dithiolane; 1,4-dithiane (1,4-dithiacyclohexane); 1,4-dithiacycloheptane (dtch); 1,5-dithiacyclooctane (dtco); o-phenylenebis(2-thiapropane); o-phenylenebis(2-thiabutane); 2,2′-(thiamethyl)biphenyl, and 2,2′-(thiaethyl)biphenyl.

S Valence Stabilizer #4: Examples of trithioethers (S monodentates, S—S bidentates, or S—S tridentates) that meet the requirements for use as “narrow band” valence stabilizers for Ce⁺⁴ include, but are not limited to: 1,3,5-trithiane; 1,3,5-tris(methylthia)cyclohexane; 1,3,5-tris(ethylthia)cyclohexane; 1,3,5-tris(phenylthia)cyclohexane; 2,5,8-trithianonane; 3,6,9-trithiaundecane; and 2,6,10-trithiaundecane.

S Valence Stabilizer #5: Examples of tetrathioethers (S monodentates, S—S bidentates, S—S tridentates, or S—S tetradentates) that meet the requirements for use as “narrow band” valence stabilizers for Ce⁺⁴ include, but are not limited to: 1,4,10,13-tetrathiatridecane; 2,6,10,14-tetrathiapentadecane; 2,5,8,11-tetrathiadodecane; 2,5,9,12-ttetrathiatridecane; 2,6,9,13-tetrathiatetradecane; 1,4-(o-thiomethyl)phenyl-1,4-dithiabutane; 1,5-(o-thiomethyl)phenyl-1,5-dithiapentane; 1,6-(o-thiomethyl)phenyl-1,6-dithiahexane; 1,4-(o-thiomethyl)phenyl-1,4-dithiabut-2-ene; and polythioethers.

S Valence Stabilizer #6: Examples of hexathioethers (S monodentates, S—S bidentates, S—S tridentates, S—S tetradentates, or S—S hexadentates) that meet the requirements for use as “narrow band” valence stabilizers for Ce⁺⁴ include, but are not limited to: tri(2-((o-thiomethyl)phenyl)ethyl)amine; and tri((o-thiomethyl)phenyl)methylamine.

S Valence Stabilizer #7a: Examples of 5-membered heterocyclic rings containing one sulfur atom (S monodentates) that meet the requirements for use as “narrow band” valence stabilizers for Ce⁺⁴ include, but are not limited to: dihydrothiophene, thiophene, thiazole, thiapyrroline, thiaphospholene, thiaphosphole, oxathiole, thiadiazole, thiatriazole, benzodihydrothiophene, benzothiophene, benzothiazole, benzothiaphosphole, dibenzothiophene, and naphthothiophene.

S Valence Stabilizer #7b: Examples of 5-membered heterocyclic rings containing two sulfur atoms (S monodentates or S—S bidentates) that meet the requirements for use as “narrow band” valence stabilizers for Ce⁺⁴ include, but are not limited to: dithiole, benzodithiole, and naphthodithiole.

S Valence Stabilizer #8a: Examples of 6-membered heterocyclic rings containing one sulfur atom (S monodentates) that meet the requirements for use as “narrow band” valence stabilizers for Ce⁺⁴ include, but are not limited to: dihydrothiopyran, thiopyran, thiazine, thiadiazine, thiaphosphorin, thiadiphosphorin, oxathiin, benzothiopyran, dibenzothiopyran, and naphthothiopyran.

S Valence Stabilizer #8b: Examples of 6-membered heterocyclic rings containing two sulfur atoms (S monodentates or S—S bidentates) that meet the requirements for use as “narrow band” valence stabilizers for Ce⁺⁴ include, but are not limited to: dihydrodithiin, dithiin, benzodithiin, dibenzodithiin (thianthrene), and naphthodithiin.

S Valence Stabilizer #9a: Examples of 5-membered heterocyclic rings containing one sulfur atom and having at least one additional sulfur atom binding site not contained in a ring (S Monodentates, S—S Bidentates, S—S Tridentates, S—S Tetradentates, or S—S Hexadentates) that meet the requirements for use as “narrow band” valence stabilizers for Ce⁺⁴ include, but are not limited to: 2,5-dimercapto-2,5-dihydrothiophene; 2,5-bis(thiomethyl)-2,5-dihydrothiophene; 2,5-bis(2-thiophenyl)-2,5-dihydrothiophene; 2,5-dimercaptothiophene; 2,5-bis(thiomethyl)thiophene; 2,5-bis(2-thiophenyl)thiophene; 2,5-dimercatothiazole; 2,5-bis(thiomethyl)thiazole; 2,5-bis(2-thiophenyl)thiazole; 2,5-dimercapto-1,3,4-thiadiazole [bismuththiol]; 2-mercaptothianaphthene; 7-(thiomethyl)thianaphthene; 1,8-dimercaptodibenzothiophene; 2-mercaptobenzothiazole; 2-mercapro-1,3,4-thiadiazole; 2-amino-5-mercapto-1,3,4-thiadiazole; 2,5-bis(alkylthio)-1,3,4-thiadiazole; and 7-(thiomethyl)benzothiazole.

S Valence Stabilizer #9b: Examples of 5-membered heterocyclic rings containing two sulfur atoms and having at least one additional sulfur atom binding site not contained in a ring (S Monodentates, S—S Bidentates, S—S Tridentates, S—S Tetradentates, or S—S Hexadentates) that meet the requirements for use as “narrow band” valence stabilizers for Ce⁺⁴ include, but are not limited to: 2-mercapto-1,3-dithiole; 2-(dimercaptomethyl)-1,3-dithiole; 4,5-dimercapto-1,3-dithiole; 4,5-bis(2-thiophenyl)-1,3-dithiole; 2-mercaptobenzodithiole; and 7-mercaptobenzodithiole.

S Valence Stabilizer #10a: Examples of 6-membered heterocyclic rings containing one sulfur atom and having at least one additional sulfur atom binding site not contained in a ring (S Monodentates, S—S Bidentates, S—S Tridentates, S—S Tetradentates, or S—S Hexadentates) that meet the requirements for use as “narrow band” valence stabilizers for Ce⁺⁴ include, but are not limited to: 2,6-dimercapto-2,5-dihydrothiopyran; 2,6-bis(thiomethyl)-2,5-dihydrothiopyran; 2,6-bis(2-thiophenyl)-2,5-dihydrothiopyran; 2,6-dimercaptothiopyran; 2,6-bis(thiomethyl)thiopyran; 2,6-bis(2-thiophenyl)thiopyran; 2,6-dimercaptothiazine; 2,6-bis(thiomethyl)thiazine; 2,6-bis(2-thiophenyl)thiazine; 2,6-dimercapto-1,3,5-thiadiazine; 2-mercapto-1-benzothiopyran; 8-mercapto-1-benzothiopyran; and 1,9-dimercaptodibenzothiopyran.

S Valence Stabilizer #10b: Examples of 6-membered heterocyclic rings containing two sulfur atoms and having at least one additional sulfur atom binding site not contained in a ring (S Monodentates, S—S Bidentates, S—S Tridentates, S—S Tetradentates, or S—S Hexadentates) that meet the requirements for use as “narrow band” valence stabilizers for Ce⁺⁴ include, but are not limited to: 2-mercapto-1,4-dithiin; 2,6-dimercapto-1,4-dithiin; 2,6-bis(2-thiophenyl)-1,4-dithiin; 2,3-dimercapto-1,4-benzodithiin; 5,8-dimercapto-1,4-benzodithiin; 1,8-dimercaptothianthrene; and 1,4,5,8-tetramercaptothianthrene.

S Valence Stabilizer #11a: Examples of 5-membered heterocyclic rings containing one sulfur atom and having at least one additional sulfur atom binding site contained in a ring (S Monodentates, S—S Bidentates, S—S Tridentates, S—S Tetradentates) that meet the requirements for use as “narrow band” valence stabilizers for Ce⁺⁴ include, but are not limited to: 2,2′-bi-2,5-dihydrothiophene; 2,2′,2″-tri-2,5-dihydrothiophene; 2,2′-bithiophene; 2,2′,2″-trithiophene; 2,2′-bithiazole; 5,5′-bithiazole; 2,2′-bioxathiole; 2,2′-bi-1,3,4-thiadiazole; 2,2′-bithianaphthene; 2,2′-bibenzothiazole; 1,1′-bis(dibenzothiophene); and polythiophenes.

S Valence Stabilizer #11b: Examples of 5-membered heterocyclic rings containing two sulfur atoms and having at least one additional sulfur atom binding site contained in a ring (S Monodentates, S—S Bidentates, S—S Tridentates, S—S Tetradentates) that meet the requirements for use as “narrow band” valence stabilizers for Ce⁺⁴ include, but are not limited to: 2,2′-bi-1,3-dithiole; 4,4′-bi-1,3-dithiole; 7,7′-bi-1,2-benzodithiole; 3,3′-bi-1,2-benzodithiole; and tetrathiofulvalene.

S Valence Stabilizer #12a: Examples of 6-membered heterocyclic rings containing one sulfur atom and having at least one additional sulfur atom binding site contained in a ring (S Monodentates, S—S Bidentates, S—S Tridehtates, S—S Tetradentates) that meet the requirements for use as “narrow band” valence stabilizers for Ce⁺⁴ include, but are not limited to: 2,2′-bi-2,5-dihydrothiopyran; 2,2′,2″-tri-2,5-dihydrothiopyran; 2,2′-bithiopyran; 2,2′,2″-trithiopyran; 2,2′-bi-1,4-thiazine; 2,2′-bi-1,3,5-thiadiazine; 2,2′-bi-1-benzothiopyran; and 1,1′-bis(dibenzothiopyran)

S Valence Stabilizer #12b: Examples of 6-membered heterocyclic rings containing two sulfur atoms and having at least one additional sulfur atom binding site contained in a ring (S Monodentates, S—S Bidentates, S—S Tridentates, S—S Tetradentates) that meet the requirements for use as “narrow band” valence stabilizers for Ce⁺⁴ include, but are not limited to: 2,2′-bi-1,4-dithiin; 2,2′-bi-1,3-dithiin; 5,5′-bi-1,4-benzodithiin; 2,2′-bi-1,3-benzodithiin; and 1,1′-bithianthrene.

S Valence Stabilizer #13a: Examples of two-membered macrocyclics, macrobicyclics, and macropolycyclics (including catapinands, cryptands, cyclidenes, and sepulchrates) wherein both binding sites are composed of sulfur (usually thiol or thioether groups) and are not contained in component heterocyclic rings (S—S Bidentates) that meet the requirements for use as “narrow band” valence stabilizers for Ce⁺⁴ include, but are not limited to: dithiacyclobutane ([4]aneS₂); dithiacyclopentane ([5]aneS₂); dithiacyclohexane ([6]aneS₂); dithiacycloheptane ([7]aneS₂); dithiacyclooctane ([8]aneS₂); dithiacyclobutene ([4]eneS₂); dithiacyclopentene ([5]eneS₂); dithiacyclohexene ([6]eneS₂); dithiacycloheptene ([7]eneS₂); dithiacyclooctene ([8]eneS₂); dithiacyclobutadiene ([4]dieneS₂); dithiacyclopentadiene ([5]dieneS₂); dithiacyclohexadiene ([6]dieneS₂); dithiacycloheptadiene ([7]dieneS₂); and dithiacyclooctadiene ([8]dieneS₂).

S Valence Stabilizer #13b: Examples of three-membered macrocyclics, macrobicyclics, and macropolycyclics (including catapinands, cryptands, cyclidenes, and sepulchrates) wherein all binding sites are composed of sulfur (usually thiol or thioether groups) and are not contained in component heterocyclic rings (S—S Tridentates) that meet the requirements for use as “narrow band” valence stabilizers for Ce⁺⁴ include, but are not limited to: trithiacyclohexane ([6]aneS₃); trithiacycloheptane ([7]aneS₃); trithiacyclooctane ([8]aneS₃); trithiacyclononane ([9]aneS₃) trithiacyclodecane ([10]aneS₃); trithiacycloundecane ([11]aneS₃); trithiacyclododecane ([12]aneS₃); trithiacyclohexene ([6]eneS₃); trithiacycloheptene ([7]eneS₃); trithiacyclooct ([8]eneS₃); trithiacyclononene ([9]eneS₃); trithiacyclodecene ([10]eneS₃); trithiacycloundec ([11]eneS₃); trithiacyclododecene ([12]eneS₃); trithiacyclohexatriene ([6]trieneS₃); trithiacycloheptatriene ([7]trieneS₃); trithiacyclooctatriene ([8]trieneS₃); trithiacyclononatriene ([9]trieneS₃); trithiacyclodecatriene ([10]trieneS₃); trithiacycloundecatriene ([11]trieneS₃); and trithiacyclododecatriene ([12]trieneS₃).

S Valence Stabilizer #13c: Examples of four-membered macrocyclics, macrobicyclics, and macropolycyclics (including catapinands, cryptands, cyclidenes, and sepulchrates) wherein all binding sites are composed of sulfur (usually thiol or thioether groups) and are not contained in component heterocyclic rings (S—S Tetradentates) that meet the requirements for use as “narrow band” valence stabilizers for Ce⁺⁴ include, but are not limited to: tetrathiacyclooctane ([8]aneS₄); tetrathiacyclononane ([9]aneS₄); tetrathiacyclodecane ([10]aneS₄); tetrathiacycloundecane ([11]aneS₄); tetrathiacyclododecane ([12]aneS₄); tetrathiacyclotridecane ([13]aneS₄); tetrathiacyclotetradecane ([14]aneS₄); tetrathiacyclopentadecane ([15]aneS₄); tetrathiacyclohexadecane ([16]aneS₄); tetrathiacycloheptadecane ([17]aneS₄); tetrathiacyclooctadecane ([18]aneS₄); tetrathiacyclononadecane ([19]aneS₄); tetrathiacycloeicosane ([20]aneS₄); tetrathiacyclooctadiene ([8]dieneS₄); tetrathiacyclononadiene ([9]dieneS₄); tetrathiacyclodecadiene ([10]dieneS₄); tetrathiacycloundecadiene ([11]dieneS₄); tetrathiacyclododecadiene ([12]dieneS₄); tetrathiacyclotridecadiene ([13]dieneS₄); tetrathiacyclotetradecadiene ([14]dieneS₄); tetrathiacyclopentadecadiene ([15]dieneS₄); tetrathiacyclohexadecadiene ([16]dieneS₄); tetrathiacycloheptadecadiene ([17]dieneS₄); tetrathiacyclooctadecadiene ([18]dieneS₄); tetrathiacyclononadecadiene ([19]dieneS₄); tetrathiacycloeicosadiene ([20]dieneS₄); tetrathiacyclooctatetradiene ([8]tetradieneS₄); tetrathiacyclononatetradiene ([9]tetradieneS₄); tetrathiacyclodecatetradiene ([10]tetradieneS₄); tetrathiacycloundecatetradiene ([11]tetradieneS₄); tetrathiacyclododecatetradiene ([12]tetradieneS₄); tetrathiacyclotridecatetradiene ([13]tetradieneS₄); tetrathiacyclotetradecatetradiene ([14]tetradieneS₄); tetrathiacyclopentadecatetradiene ([15]tetradieneS₄); tetrathiacyclohexadecatetradiene ([16]tetradieneS₄); tetrathiacycloheptadecatetradiene ([17]tetradieneS₄); tetrathiacyclooctadecatetradiene ([18]tetradieneS₄); tetrathiacyclononadecatetradiene ([19]tetradieneS₄); and tetrathiacycloeicosatetradiene ([20]tetradieneS₄).

S Valence Stabilizer #13d: Examples of five-membered macrocyclics, macrobicyclics, and macropolycyclics (including catapinands, cryptands, cyclidenes, and sepulchrates) wherein all binding sites are composed of sulfur (usually thiol or thioether groups) and are not contained in component heterocyclic rings (S—S Tridentates or S—S Tetradentates) that meet the requirements for use as “narrow band” valence stabilizers for Ce⁺⁴ include, but are not limited to: pentathiacyclodecane ([10]aneS₅); pentathiacycloundecane ([11]aneS₅); pentathiacyclododecane ([12]aneS₅); pentathiacyclotridecane ([13]aneS₅); pentathiacyclotetradecane ([14]aneS₅); pentathiacyclopentadecane ([15]aneS₅); pentathiacyclodecatriene ([10]trieneS₅); pentathiacycloundecatriene ([11]trieneS₅); pentathiacyclododecatriene ([12]trieneS₅); pentathiacyclotridecatriene ([13]trieneS₅); pentathiacyclotetradecatriene ([14]trieneS₅); and pentathiacyclopentadecatriene ([15]trieneS₅).

S Valence Stabilizer #13e: Examples of six-membered macrocyclics, macrobicyclics, and macropolycyclics (including catapinands, cryptands, cyclidenes, and sepulchrates) wherein all binding sites are composed of sulfur (usually thiol or thioether groups) and are not contained in component heterocyclic rings (S—S Tridentates, S—S Tetradentates, or S—S Hexadentates) that meet the requirements for use as “narrow band” valence stabilizers for Ce⁺⁴ include, but are not limited to: hexathiacyclododecane ([12]aneS₆); hexathiacyclotridecane ([13]aneS₆); hexathiacyclotetradecane ([14]aneS₆); hexathiacyclopentadecane ([15]aneS₆); hexathiacyclohexadecane ([16]aneS₆); hexathiacycloheptadecane ([17]aneS₆); hexathiacyclooctadecane ([18]aneS₆); hexathiacyclononadecane ([19]aneS₆); hexathiacycloeicosane ([20]aneS₆); hexathiacycloheneicosane ([21]aneS₆); hexathiacyclodocosane ([22]aneS₆); hexathiacyclotricosane ([23]aneS₆); hexathiacyclotetracosane ([24]aneS₆); hexathiacyclododecatriene ([12]trieneS₆); hexathiacyclotridecatriene ([13]trieneS₆); hexathiacyclotetradecatriene ([14]trieneS₆); hexathiacyclopentadecatriene ([15]trieneS₆); hexathiacyclohexadecatriene ([16]trieneS₆); hexathiacycloheptadecatriene ([17]trieneS₆); hexathiacyclooctadecatriene ([18]trieneS₆); hexathiacyclononadecatriene ([19]trieneS₆); hexathiacycloeicosatriene ([20]trieneS₆); hexathiacycloheneicosatriene ([21]trieneS₆); hexathiacyclodocosatriene ([22]trieneS₆); hexathiacyclotricosatriene ([23]trieneS₆); and hexathiacyclotetracosatriene ([24]trieneS₆).

S Valence Stabilizer #13f: Examples of seven-membered macrocyclics, macrobicyclics, and macropolycyclics (including catapinands, cryptands, cyclidenes, and sepulchrates) wherein all binding sites are composed of sulfur (usually thiol or thioether groups) and are not contained in component heterocyclic rings (S—S Tridentates, S—S Tetradentates, or S—S Hexadentates) that meet the requirements for use as “narrow band” valence stabilizers for Ce⁺⁴ include, but are not limited to: heptathiacyclotetradecane ([14]aneS₇); heptathiacyclopentadecane ([15]aneS₇); heptathiacyclohexadecane ([16]aneS₇); heptathiacycloheptadecane ([17]aneS₇); heptathiacyclooctadecane ([18]aneS₇); heptathiacyclononadecane ([19]aneS₇); heptathiacycloeicosane ([20]aneS₇); heptathiacycloheneicosane ([21]aneS₇); heptathiacyclotetradecatriene ([14]trieneS₇); heptathiacyclopentadecatriene ([15]trieneS₇); heptathiacyclohexadecatriene ([16]trieneS₇); heptathiacycloheptadecatriene ([17]trieneS₇); heptathiacyclooctadecatriene ([18]trieneS₇); heptathiacyclononadecatriene ([19]trieneS₇); heptathiacycloeicosatriene ([20]trieneS₇); and heptathiacycloheneicosatriene ([21]trieneS₇).

S Valence Stabilizer #13g: Examples of eight-membered macrocyclics, macrobicyclics, and macropolycyclics (including catapinands, cryptands, cyclidenes, and sepulchrates) wherein all binding sites are composed of sulfur (usually thiol or thioether groups) and are not contained in component heterocyclic rings (S—S Tridentates, S—S Tetradentates, or S—S Hexadentates) that meet the requirements for use as “narrow band” valence stabilizers for Ce⁺⁴ include, but are not limited to: octathiacyclohexadecane ([16]aneS₈); octathiacycloheptadecane ([17]aneS₈); octathiacyclooctadecane ([18]aneS₈); octathiacyclononadecane ([19]aneS₈); octathiacycloeicosane ([20]aneS₈); octathiacycloheneicosane ([21]aneS₈); octathiacyclodocosane ([22]aneS₈); octathiacyclotricosane ([23]aneS₈); octathiacyclotetracosane ([24]aneS₈); octathiacyclohexadecatetradiene ([16]tetradieneS₈); octathiacycloheptadecatetradiene ([17]tetradieneS₈); octathiacyclooctadecatetradiene ([18]tetradieneS₈); octathiacyclononadecatetradiene ([19]tetradieneS₈); octathiacycloeicosatetradiene ([20]tetradieneS₈); octathiacycloheneicosatetradiene ([21]tetradieneS₈); octathiacyclodocosatetradiene ([22]tetradieneS₈); octathiacyclotricosatetradiene ([23]tetradieneS₈); and octathiacyclotetracosatetradiene ([24]tetradieneS₈).

S Valence Stabilizer #13h: Examples of nine-membered macrocyclics, macrobicyclics, and macropolycyclics (including catapinands, cryptands, cyclidenes, and sepulchrates) whrein all binding sites are composed of sulfur (usually thiol or thioether groups) and are not contained in component heterocyclic rings (S—S Tridentates, S—S Tetradentates, or S—S Hexadentates) that meet the requirements for use as “narrow band” valence stabilizers for Ce⁺⁴ include, but are not limited to: nonathiacyclooctadecane ([18]aneS₉); nonathiacyclononadecane ([19]aneS₉); nonathiacycloeicosane ([20]aneS₉); nonathiacycloheneicosane ([21]aneS₉); nonathiacyclodocosane ([22]aneS₉); nonathiacyclotricosane ([23]aneS₉); nonathiacyclotetracosane ([24]aneS₉); nonathiacyclopentacosane ([25]aneS₉); nonathiacyclohexacosane ([26]aneS₉); nonathiacycloheptacosane ([27]aneS₉); nonathiacyclooctadecatetradiene ([18]tetradieneS₉); nonathiacyclononadecatetradiene ([19]tetradieneS₉); nonathiacycloeicosatetradiene ([20]tetradieneS₉); nonathiacycloheneicosatetradiene ([21]tetradieneS₉); nonathiacyclodocosatetradiene ([22]tetradieneS₉); nonathiacyclotricosatetradiene ([23]tetradieneS₉); nonathiacyclotetracosatetradiene ([24]tetradieneS₉); nonathiacyclopentacosatetradiene ([25]tetradieneS₉); nonathiacyclohexacosatetradiene ([26]tetradieneS₉); and nonathiacycloheptacosatetradiene ([27]tetradieneS₉).

S Valence Stabilizer #13i: Examples of ten-membered macrocyclics, macrobicyclics, and macropolycyclics (including catapinands, cryptands, cyclidenes, and sepulchrates) wherein all binding sites are composed of sulfur (usually thiol or thioether groups) and are not contained in component heterocyclic rings (S—S Tridentates, S—S Tetradentates, or S—S Hexadentates) that meet the requirements for use as “narrow band” valence stabilizers for Ce⁺⁴ include, but are not limited to: decathiacycloeicosane ([20]aneS₁₀); decathiacycloheneicosane ([21]aneS₁₀); decathiacyclodocosane ([22]aneS₁₀); decathiacyclotricosane ([23]aneS₁₀); decathiacyclotetracosane ([24]aneS₁₀); decathiacyclopentacosane ([25]aneS₁₀); decathiacyclohexacosane ([26]aneS₁₀); decathiacycloheptacosane ([27]aneS₁₀); decathiacyclooctacosane ([28]aneS₁₀); decathiacyclononacosane ([29]aneS₁₀); decathiacyclotriacontane ([30]aneS₁₀); decathiacycloeicosapentadiene ([20]pentadieneS₁₀); decathiacycloheneicosapentadiene ([21]pentadieneS₁₀); decathiacyclodocosapentadiene ([22]pentadieneS₁₀); decathiacyclotricosapentadiene ([23]pentadieneS₁₀); decathiacyclotetracosapentadiene ([24]pentadieneS₁₀); decathiacyclopentacosapentadiene ([25]pentadieneS₁₀); decathiacyclohexacosapentadiene ([26]pentadieneS₁₀); decathiacycloheptacosapentadiene ([27]pentadieneS₁₀); decathiacyclooctacosapentadiene ([28]pentadieneS₁₀); decathiacyclononacosapentadiene ([29]pentadieneS₁₀); and decathiacyclotriacontapentadiene ([30]pentadieneS₁₀).

S Valence Stabilizer #14a: Examples of four-membered macrocyclics, macrobicyclics, and macropolycyclics (including catapinands, cryptands, cyclidenes, and sepulchrates) wherein all four binding sites are composed of sulfur and are contained in component 5-membered heterocyclic rings (S—S Tetradentates) that meet the requirements for use as “narrow band” valence stabilizers for Ce⁺⁴ include, but are not limited to: tetrathiophenes; tetrathiazoles; tetrathiaphospholes; tetraoxathioles; tetrathiadiazoles; tetrathiatriazoles; and tetradithioles.

S Valence Stabilizer #14b: Examples of five-membered macrocyclics, macrobicyclics, and macropolycyclics (including catapinands, cryptands, cyclidenes, and sepulchrates) wherein all five binding sites are composed of sulfur and are contained in component 5-membered heterocyclic rings (S—S Tridentates or S—S Tetradentates) that meet the requirements for use as “narrow band” valence stabilizers for Ce⁺⁴ include, but are not limited to: pentathiophenes; pentathiazoles; pentathiaphospholes; pentaoxathioles; pentathiadiazoles; pentathiatriazoles; and pentadithioles.

S Valence Stabilizer #14c: Examples of six-membered macrocyclics, macrobicyclics, and macropolycyclics (including catapinands, cryptands, cyclidenes, and sepulchrates) wherein all six binding sites are composed of sulfur and are contained in component 5-membered heterocyclic rings (S—S Tridentates, S—S Tetradentates, or S—S Hexadentates) that meet the requirements for use as “narrow band” valence stabilizers for Ce⁺⁴ include, but are not limited to: hexathiophenes; hexathiazoles; hexathiaphospholes; hexaoxathioles; hexathiadiazoles; hexathiatriazoles; and hexadithioles.

S Valence Stabilizer #14d: Examples of seven-membered macrocyclics, macrobicyclics, and macropolycyclics (including catapinands, cryptands, cyclidenes, and sepulchrates) wherein all seven binding sites are composed of sulfur and are contained in component 5-membered heterocyclic rings (S—S Tridentates, S—S Tetradentates, or S—S Hexadentates) that meet the requirements for use as “narrow band” valence stabilizers for Ce⁺⁴ include, but are not limited to: heptathiophenes; heptathiazoles; heptathiaphospholes; heptaoxathioles; heptathiadiazoles; heptathiatriazoles; and heptadithioles.

S Valence Stabilizer #14e: Examples of eight-membered macrocyclics, macrobicyclics, and macropolycyclics (including catapinands, cryptands, cyclidenes, and sepulchrates) wherein all eight binding sites are composed of sulfur and are contained in component 5-membered heterocyclic rings (S—S Tridentates, S—S Tetradentates, or S—S Hexadentates) that meet the requirements for use as “narrow band” valence stabilizers for Ce⁺⁴ include, but are not limited to: octathiophenes; octathiazoles; octathiaphospholes; octaoxathioles; octathiadiazoles; octathiatriazoles; and octadithioles.

S Valence Stabilizer #14f: Examples of nine-membered macrocyclics, macrobicyclics, and macropolycyclics (including catapinands, cryptands, cyclidenes, and sepulchrates) wherein all nine binding sites are composed of sulfur and are contained in component 5-membered heterocyclic rings (S—S Tridentates, S—S Tetradentates, or S—S Hexadentates) that meet the requirements for use as “narrow band” valence stabilizers for Ce⁺⁴ include, but are not limited to: nonathiophenes; nonathiazoles; nonathiaphospholes; nonaoxathioles; nonathiadiazoles; nonathiatriazoles; and nonadithioles.

S Valence Stabilizer #14g: Examples of ten-membered macrocyclics, macrobicyclics, and macropolycyclics (including catapinands, cryptands, cyclidenes, and sepulchrates) wherein all ten binding sites are composed of sulfur and are contained in component 5-membered heterocyclic rings (S—S Tridentates, S—S Tetradentates, or S—S Hexadentates) that meet the requirements for use as “narrow band” valence stabilizers for Ce⁺⁴ include, but are not limited to: decathiophenes; decathiazoles; decathiaphospholes; decaoxathioles; decathiadiazoles; decathiatriazoles; and decadithioles.

S Valence Stabilizer #15a: Examples of four-membered macrocyclics, macrobicyclics, and macropolycyclics (including catapinands, cryptands, cyclidenes, and sepulchrates) wherein all four binding sites are composed of sulfur and are contained in a combination of 5-membered heterocyclic rings and thiol, thioether, or thioketo groups (S—S Tetradentates) that meet the requirements for use as “narrow band” valence stabilizers for Ce⁺⁴ include, but are not limited to: dithiatetrathiophenes; tetrathiatetrathiophenes; dithiatetradithioles; and tetrathiatetradithioles.

S Valence Stabilizer #15b: Examples of five-membered macrocyclics, macrobicyclics, and macropolycyclics (including catapinands, cryptands, cydidenes, and sepulchrates) wherein all five binding sites are composed of sulfur and are contained in a combination of 5-membered heterocyclic rings and thiol, thioether, or thioketo groups (S—S Tridentates or S—S Tetradentates) that meet the requirements for use as “narrow band” valence stabilizers for Ce⁺⁴ include, but are not limited to: dithiapentathiophenes; tetrathiapentathiophenes; dithiapentadithioles; and tetrathiapentadithioles.

S Valence Stabilizer #15c: Examples of six-membered macrocyclics, macrobicyclics, and macropolycyclics (including catapinands, cryptands, cyclidenes, and sepulchrates) wherein all six binding sites are composed of sulfur and are contained in a combination of 5-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: dithiahexaathiophenes; trithiahexathiophenes; dithiahexadithioles; and trithiahexadithioles.

S Valence Stabilizer #15d: Examples of seven-membered macrocyclics, macrobicyclics, and macropolycyclics (including catapinands, cryptands, cyclidenes, and sepulchrates) wherein all seven binding sites are composed of sulfur and are contained in a combination of 5-membered heterocyclic rings and thiol, thioetber, or thioketo groups (S—S Tridentates, S—S Tetradentates, or S—S Hexadentates) that meet the requirements for use as “narrow band” valence stabilizers for Ce⁺⁴ include, but are not limited to: dithiaheptathiophenes; tetrathiaheptathiophenes; dithiaheptadithioles; and tetrathiaheptadithioles.

S Valence Stabilizer #15e: Examples of eight-membered macrocyclics, macrobicyclics, and macropolycyclics (including catapinands, cryptands, cyclidenes, and sepulchrates) wherein all eight binding sites are composed of sulfur and are contained in a combination of 5-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: dithiaoctathiophenes; tetrathiaoctathiophenes; dithiaoctadithioles; and tetrathiaoctadithioles.

S Valence Stabilizer #15f: Examples of nine-membered macrocyclics, macrobicyclics, and macropolycyclics (including catapinands, cryptands, cyclidenes, and sepulchrates) wherein all nine binding sites are composed of sulfur and are contained in a combination of 5-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: trithianonathiophenes; hexathianonathiophenes; trithianonadithioles; and hexathianonadithioles.

S Valence Stabilizer #15g: Examples of ten-membered macrocyclics, macrobicyclics, and macropolycyclics (including catapinands, cryptands, cyclidenes, and sepulchrates) wherein all ten binding sites are composed of sulfur and are contained in a combination of 5-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: dithiadecathiophenes; pentathiadecathiophenes; dithiadecadithioles; and pentathiadecadithioles.

S Valence Stabilizer #16a: Examples of four-membered macrocyclics, macrobicyclics, and macropolycyclics (including catapinands, cryptands, cyclidenes, and sepulchrates) wherein all four binding sites are composed of sulfur and are contained in component 6-membered heterocyclic rings (S—S Tetradentates) that meet the requirements for use as “narrow band” valence stabilizers for Ce⁺⁴ include, but are not limited to: tetrathiopyrans; tetrathiazines; tetrathiaphosphorins; tetrathiadiphosphorins; tetraoxathiins; and tetradithiins.

S Valence Stabilizer #16b: Examples of five-membered macrocyclics, macrobicyclics, and macropolycyclics (including catapinands, cryptands, cyclidenes, and sepulchrates) wherein all five binding sites are composed of sulfur and are contained in component 6-membered heterocyclic rings (S—S Tridentates or S—S Tetradentates) that meet the requirements for use as “narrow band” valence stabilizers for Ce⁺⁴ include, but are not limited to: pentathiopyrans; pentathiazines; pentathiaphosphorins; pentathiadiphosphorins; pentaoxathiins; and pentadithiins.

S Valence Stabilizer #16c: Examples of six-membered macrocyclics, macrobicyclics, and macropolycyclics (including catapinands, cryptands, cyclidenes, and sepulchrates) wherein all six binding sites are composed of sulfur and are contained in component 6-membered heterocyclic rings (S—S Tridentates, S—S Tetradentates, or S—S Hexadentates) that meet the requirements for use as “narrow band” valence stabilizers for Ce⁺⁴ include, but are not limited to: hexathiopyrans; hexathiazines; hexathiaphosphorins; hexathiadiphosphorins; hexaoxathiins; and hexadithiins.

S Valence Stabilizer #16d: Examples of seven-membered macrocyclics, macrobicyclics, and macropolycyclics (including catapinands, cryptands, cyclidenes, and sepulchrates) wherein all seven binding sites are composed of sulfur and are contained in component 6-membered heterocyclic rings (S—S Tridentates, S—S Tetradentates, or S—S Hexadentates) that meet the requirements for use as “narrow band” valence stabilizers for Ce⁺⁴ include, but are not limited to: heptathiopyrans; heptathiazines; heptathiaphosphorins; heptathiadiphosphorins; heptaoxathiins; and heptadithiins.

S Valence Stabilizer #16e: Examples of eight-membered macrocyclics, macrobicyclics, and macropolycyclics (including catapinands, cryptands, cyclidenes, and sepulchrates) wherein all eight binding sites are composed of sulfur and are contained in component 6-membered heterocyclic rings (S—S Tridentates, S—S Tetradentates, or S—S Hexadentates) that meet the requirements for use as “narrow band” valence stabilizers for Ce⁺⁴ include, but are not limited to: octathiopyrans; octathiazines; octathiaphosphorins; octathiadiphosphorins; octaoxathiins; and octadithiins.

S Valence Stabilizer #16f: Examples of nine-membered macrocyclics, macrobicyclics, and macropolycyclics (including catapinands, cryptands, cyclidenes, and sepulchrates) wherein all nine binding sites are composed of sulfur and are contained in component 6-membered heterocyclic rings (S—S Tridentates, S—S Tetradentates, or S—S Hexadentates) that meet the requirements for use as “narrow band” valence stabilizers for Ce⁺⁴ include, but are not limited to: nonathiopyrans; nonathiazines; nonathiaphosphorins; nonathiadiphosphorins; nonaoxathiins; and nonadithiins.

S Valence Stabilizer #16g: Examples of ten-membered macrocyclics, macrobicyclics, and macropolycyclics (including catapinands, cryptands, cyclidenes, and sepulchrates) wherein all ten binding sites are composed of sulfur and are contained in component 6-membered heterocyclic rings (S—S Tridentates, S—S Tetradentates, or S—S Hexadentates) that meet the requirements for use as “narrow band” valence stabilizers for Ce⁺⁴ include, but are not limited to: decathiopyrans; decathiazines; decathiaphosphorins; decathiadiphosphorins; decaoxathiins; and decadithiins.

S Valence Stabilizer #17a: Examples of four-membered macrocyclics, macrobicyclics, and macropolycyclics (including catapinands, cryptands, cyclidenes, and sepulchrates) wherein all four binding sites are composed of sulfur and are contained in a combination of 6-membered heterocyclic rings and thiol, thioether, or thioketo groups (S—S Tetradentates) that meet the requirements for use as “narrow band” valence stabilizers for Ce⁺⁴ include, but are not limited to: dithiatetrathiopyrans; tetrathiatetrathiopyrans; dithiatetrathiazines; tetrathiatetrathiazines; dithiatetrathiaphosphorins; tetrathiatetrathiaphosphorins; dithiatetraoxathiins; tetrathiatetraoxathiins; dithiatetradithiins; and tetrathiatetradithiins.

S Valence Stabilizer #17b: Examples of five-membered macrocyclics, macrobicyclics, and macropolycyclics (including catapinands, cryptands, cyclidenes, and sepulchrates) wherein all five binding sites are composed of sulfur and are contained in a combination of 6-membered heterocyclic rings and thiol, thioether, or thioketo groups (S—S Tridentates or S—S Tetradentates) that meet the requirements for use as “narrow band” valence stabilizers for Ce⁺⁴ include, but are not limited to: dithiapentathiopyrans; tetrathiapentathiopyrans; dithiapentathiazines; tetrathiapentathiazines; dithiapentathiaphosphorins; tetrathiapentathiaphosphorins; dithiapentaoxathiins; tetrathiapentaoxathiins; dithiapentadithiins; and tetrathiapentadithiins.

S Valence Stabilizer #17c: Examples of six-membered macrocyclics, macrobicyclics, and macropolycyclics (including catapinands, cryptands, cyclidenes, and sepulchrates) wherein all six binding sites are composed of sulfur and are contained in a combination of 6-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: dithiahexathiopyrans; trithiahexathiopyrans; dithiahexathiazines; trithiahexathiazines; dithiahexathiaphosphorins; trithiahexathiaphosphorins; dithiahexaoxathiins; trithiahexaoxathiins; dithiahexadithiins; and trithiahexadithiins.

S Valence Stabilizer #17d: Examples of seven-membered macrocyclics, macrobicyclics, and macropolycyclics (including catapinands, cryptands, cyclidenes, and sepulchrates) wherein all seven binding sites are composed of sulfur and are contained in a combination of 6-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: dithiaheptathiopyrans; tetrathiaheptathiopyrans; dithiaheptathiazines; tetrathiabeptathiazines; dithiaheptathiaphosphorins; tetrathiaheptathiaphosphorins; dithiaheptaoxathiins; tetrathiaheptaoxathiins; dithiaheptadithiins; and tetrathiaheptadithiins.

S Valence Stabilizer #17e: Examples of eight-membered macrocyclics, macrobicyclics, and macropolycyclics (including catapinands, cryptands, cyclidenes, and sepulchrates) wherein all eight binding sites are composed of sulfur and are contained in a combination of 6-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: dithiaoctathiopyrans; tetrathiaoctathiopyrans; dithiaoctathiazines; tetrathiaoctathiazines; dithiaoctathiaphosphorins; tetrathiaoctathiaphosphorins; dithiaoctaoxathiins; tetrathiaoctaoxathiins; dithiaoctadithiins; and tetrathiaoctadithiins.

S Valence Stabilizer #17f: Examples of nine-membered macrocyclics, macrobicyclics, and macropolycyclics (including catapinands, cryptands, cyclidenes, and sepulchrates) wherein all nine binding sites are composed of sulfur and are contained in a combination of 6-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: trithianonathiopyrans; hexathianonathiopyrans; trithianonathiazines; hexathianonathiazines; trithianonathiaphosphorins; hexathianonathiaphosphorins; trithianonaoxathiins; hexathianonaoxathiins; trithianonadithiins; and hexathianonadithiins.

S Valence Stabilizer #17g: Examples of ten-membered macrocyclics, macrobicyclics, and macropolycyclics (including catapinands, cryptands, cyclidenes, and sepulchrates) wherein all ten binding sites are composed of sulfur and are contained in a combination of 6-membered heterocyclic rings and thiol, thioether, or thioketo groups (S—S Tridentates, S—S Tetradentates, or S—S Hexadentates) that meet the requirements for use as “narrow band” valence stabilizers for Ce⁺⁴ include, but are not limited to: dithiadecathiopyrans; pentathiadecathiopyrans; dithiadecathiazines; pentathiadecathiazines; dithiadecathiaphosphorins; pentathiadecathiaphosphorins; dithiadecaoxathiins; pentathiadecaoxathiins; dithiadecadithiins; and pentathiadecadithiins.

S Valence Stabilizer #18: Examples of dithiobiurets (dithioimidodicarbonic diamides), dithioisobiurets, dithiobiureas, trithiotriurets, trithiotriureas, bis(dithiobiurets), bis(dithioisobiurets), bis(dithiobiureas), poly(dithiobiurets), poly(dithioisobiurets), and poly(dithiobiureas) (S—S Bidentates, S—S Tridentates, S—S Tetradentates) that meet the requirements for use as “narrow band” valence stabilizers for Ce⁺⁴ include, but are not limited to: dithiobiuret, dithioisobiuret, dithiobiurea, trithiotriuret, trithiotriurea, nitrodithiobiuret, dinitrodithiobiuret, aminodithiobiuret, diaminodithiobiuret, oxydithiobiuret, dioxydithiobiuret, cyanodithiobiuret, methyldithiobiuret, ethyldithiobiuret, isopropyldithiobiuret, phenyldithiobiuret, benzyldithiobiuret, cyclohexyldithiobiuret, norbornyldithiobiuret, adamantyldithiobiuret, dimethyldithiobiuret, diethyldithiobiuret, diisopropyldithiobiuret, diphenyldithiobiuret, dibenzyldithiobiuret, dicyclohexyldithiobiuret, dinorbornyldithiobiuret, and diadamantyldithiobiuret.

S Valence Stabilizer #19: Examples of thioacylthioureas, thioaroylthioureas, bis(thioacylthioureas), bis(thioaroylthioureas), poly(thioacylthioureas), and poly(thioaroylthioureas) (S—S Bidentates, S—S Tridentates, S—S Tetradentates) that meet the requirements for use as “narrow band” valence stabilizers for Ce⁺⁴ include, but are not limited to: thioformylthiourea, thioacetylthiourea, thiobenzoylthiourea, thiocyclohexoylthiourea, pentafluorothiobenzoylthiourea, N-methylthioacetylthiourea, N-phenylthiobenzoylthiourea, and N-cyclohexylthiocyclohexoylthiourea.

S Valence Stabilizer #20: Examples of dithioacyl disulfides, bis(dithioacyl disulfides), and poly(dithioacyl disulfides), (S—S Bidentates, S—S Tridentates, S—S Tetradentates) that meet the requirements for use as “narrow band” valence stabilizers for Ce⁺⁴ include, but are not limited to: dithioacetyl disulfide; dithiopropanoyl disulfide; dithiobenzoyl disulfide; and dithiopentafluorobenzoyl disulfide.

S Valence Stabilizer #21: Examples of tetrathioperoxydicarbonic diamides, bis(tetrathioperoxydicarbonic diamides), and poly(tetrathioperoxydicarbonic diamides) (S—S Bidentates, S—S Tridentates, S—S Tetradentates) that meet the requirements for use as “narrow band” valence stabilizers for Ce⁺⁴ include, but are not limited to: tetrathioperoxydicarbonic diamide; N-phenyltetrathioperoxydicarbonic diamide; N-benzyltetrathioperoxydicarbonic diamide; N-cyclohexyltetrathioperoxydicarbonic diamide; N-norbornyltetrathioperoxydicarbonic diamide; N,N′-diphenyltetrathioperoxydicarbonic diamide; N,N′-dibenzyltetrathioperoxydicarbonic diamide; N,N′-dicyclohexyltetrathioperoxydicarbonic diamide; and N,N′-dinorbornyltetrathioperoxydicarbonic diamide.

S Valence Stabilizer #22: Examples of hexathio-, pentathio-, and tetrathioperoxydicarbonic acids, bis(hexathio-, pentathio-, and tetrathioperoxydicarbonic acids), poly(hexathio-, pentathio-, and tetrathioperoxydicarbonic acids), and derivatives thereof (S—S Bidentates, S—S Tridentates, S—S Tetradentates) that meet the requirements for use as “narrow band” valence stabilizers for Ce⁺⁴ include, but are not limited to: hexathioperoxydicarbonic acid, pentathioperoxydicarbonic acid, tetrathioperoxydicarbonic acid, S-phenylhexathioperoxydicarbonic acid; S-benzylhexathioperoxydicarbonic acid; S-cyclohexylhexathioperoxydicarbonic acid; S-norbornylhexathioperoxydicarbonic acid; S,S′-diphenylhexathioperoxydicarbonic acid; S,S′-dibenzylhexathioperoxydicarbonic acid; S,S′-dicyclohexylhexathioperoxydicarbonic acid; and S,S′-dinorbornylhexathioperoxydicarbonic acid.

S Valence Stabilizer #23: Examples of dithioperoxydiphosphoramides, bis(dithioperoxydiphosphoramides), and poly(dithioperoxydiphosphoramides) (S—S Bidentates, S—S Tridentates, S—S Tetradentates) that meet the requirements for use as “narrow band” valence stabilizers for Ce⁺⁴ include, but are not limited to: dithioperoxydiphosphoramide, N-methyldithioperoxydiphosphoramide, N-isopropyldithioperoxydiphosphoramide, N-tert-butyldithioperoxydiphosphoramide, N-phenyldithioperoxydiphosphoramide, N-pentafluorophenyldithioperoxydiphosphoramide, N-benzyldithioperoxydiphosphoramide, N-cyclohexyldithioperoxydiphosphoramide, N-norbornyldithioperoxydiphosphoramide, N,N′″-dimethyldithioperoxydiphosphoramide, N,N′″-diisopropyldithioperoxydiphosphoramide, N,N′″-di-tert-butyldithioperoxydiphosphoramide, N,N′″-diphenyldithioperoxydiphosphoramide, N,N′″-di-pentafluorophenyldithioperoxydiphosphoramide, N,N′″-dibenzyldithioperoxydiphosphoramide, N,N′″-dicyclohexyldithioperoxydiphosphoramide, and N,N′″-dinorbornyldithioperoxydiphosphoramide.

S Valence Stabilizer #24: Examples of dithioperoxydiphosphoric acids, bis(dithioperoxydiphosphoric acids), poly(dithioperoxydiphosphoric acids), and derivatives thereof (S—S Bidentates, S—S Tridentates, S—S Tetradentates) that meet the requirements for use as “narrow band” valence stabilizers for Ce⁺⁴ include, but are not limited to: dithioperoxydiphosphoric acid, methyldithioperoxydiphosphoric acid, isopropyldithioperoxydiphosphoric acid, tert-butyldithioperoxydiphosphoric acid, phenyldithioperoxydiphosphoric acid, pentafluorophenyldithioperoxydiphosphoric acid, benzyldithioperoxydiphosphoric acid, cyclohexyldithioperoxydiphosphoric acid, norbornyldithioperoxydiphosphoric acid, dimethyldithioperoxydiphosphoric acid, diisopropyldithioperoxydiphosphoric acid, di-tert-butyldithioperoxydiphosphoric acid, diphenyldithioperoxydiphosphoric acid, di-pentafluorophenyldithioperoxydiphosphoric acid, dibenzyldithioperoxydiphosphoric acid, dicyclohexyldithioperoxydiphosphoric acid, and dinorbornyldithioperoxydiphosphoric acid.

S Valence Stabilizer #25: Examples of dithioimidodiphosphonic acids, dithiohydrazidodiphosphonic acids, bis(dithioimidodiphosphonic acids), bis(dithiohydrazidodiphosphonic acids), poly(dithioimidodiphosphonic acids), poly(dithiohydrazidodiphosphonic acids), and derivatives thereof (S—S Bidentates, S—S Tridentates, S—S Tetradentates) that meet the requirements for use as “narrow band” valence stabilizers for Ce⁺⁴ include, but are not limited to: dithioimidodiphosphonic acid, methyldithioimidodiphosphonic acid, isopropyldithioimidodiphosphonic acid, tert-butyldithioimidodiphosphonic acid, phenyldithioimidodiphosphonic acid, pentafluorophenyldithioimidodiphosphonic acid, benzyldithioimidodiphosphonic acid, cyclohexyldithioimidodiphosphonic acid, norbornyldithioimidodiphosphonic acid, dimethyldithioimidodiphosphonic acid, diisopropyldiothioimidodiphosphonic acid, di-tert-butyldithioimidodiphosphonic acid, diphenyldithioimidodiphosphonic acid, di-pentafluorophenyldithioimidodiphosphonic acid, dibenzyldithioimidodiphosphonic acid, dicyclohexyldithioimidodiphosphonic acid, and dinorbornyldithioimidodiphosphonic acid. [Note: the phosphite (P⁺³) valence of the phosphorus atom makes stabilizization of high valence metal ions much more difficult, though still possible.]

S Valence Stabilizer #26: Examples of dithioimidodiphosphonamides, dithiohydrazidodiphosphonamides, bis(dithioimidodiphosphonamides), bis(dithiohydrazidodiphosphonamides), poly(dithioimidodiphosphonamides), and poly(dithiohydrazidodiphosphonamides) (S—S Bidentates, S—S Tridentates, S—S Tetradentates) that meet the requirements for use as “narrow band” valence stabilizers for Ce⁺⁴ include, but are not limited to: dithioimidodiphosphonamide, N-methyldithioimidodiphosphonamide, N-isopropyldithioimidodiphosphonamide, N-tert-butyldithioimidodiphosphonamide, N-phenyldithioimidodiphosphonamide, N-pentafluorophenyldithioimidodiphosphonamide, N-benzyldithioimidodiphosphonamide, N-cyclohexyldithioimidodiphosphonamide, N-norbornyldithioimidodiphosphonamide, N,N′″-dimethyldithioimidodiphosphonamide, N,N′″-diisopropyldithioimidodiphosphonamide, N,N′″-di-tert-butyldithioimidodiphosphonamide, N,N′″-diphenyldithioimidodiphosphonamide, N,N′″-di-pentafluorophenyldithioimidodiphosphonamide, N,N′″-dibenzyldithioimidodiphosphonamide, N,N′″-dicyclohexyldithioimidodiphosphonamide, and N,N′″-dinorbornyldithioimidodiphosphonamide. [Note: the phosphite (P⁺³) valence of the phosphorus atom makes stabilizization of high valence metal ions much more difficult, though still possible.]

S Valence Stabilizer #27: Examples of dithiodiphosphonamides, bis(dithiodiphosphonamides), and poly(dithiodiphosphonamides) (S—S Bidentates, S—S Tridentates, S—S Tetradentates) that meet the requirements for use as “narrow band” valence stabilizers for Ce⁺⁴ include, but are not limited to: dithiodiphosphonamide, N-methyldithiodiphosphonamide, N-isopropyldithiodiphosphonamide, N-tert-butyldithiodiphosphonamide, N-phenyldithiodiphosphonamide, N-pentafluorophenyldithiodiphosphonamide, N-benzyldithiodiphosphonamide, N-cyclohexyldithiodiphosphonamide, N-norbornyldithiodiphosphonamide, N,N′″-dimethyldithiodiphosphonamide, N,N′″-diisopropyldithiodiphosphonamide, N,N′″-di-tert-butyldithiodiphosphonamide, N,N′″-diphenyldithiodiphosphonamide, N,N′″-di-pentafluorophenyldithiodiphosphonamide, N,N′″-dibenzyldithiodiphosphonamide, N,N′″-dicyclohexyldithiodiphosphonamide, and N,N′″-dinorbornyldithiodiphosphonamide. [Note: the phosphite (P⁺³) valence of the phosphorus atom makes stabilizization of high valence metal ions much more difficult, though still possible.]

S Valence Stabilizer #28: Examples of dithiodiphosphonic acids, bis(dithiodiphosphonic acids), poly(dithiodiphosphonic acids), and derivatives thereof (S—S Bidentates, S—S Tridentates, S—S Tetradentates) that meet the requirements for use as “narrow band” valence stabilizers for Ce⁺⁴ include, but are not limited to: dithiodiphosphonic acid, methyldithiodiphosphonic acid, isopropyldithiodiphosphonic acid, tert-butyldithiodiphosphonic acid, phenyldithiodiphosphonic acid, pentafluorophenyldithiodiphosphonic acid, benzyldithiodiphosphonic acid, cyclohexyldithiodiphosphonic acid, norbornyldithiodiphosphonic acid, dimethyldithiodiphosphonic acid, diisopropyldiothiodiphosphonic acid, di-tert-butyldithiodiphosphonic acid, diphenyldithiodiphosphonic acid, di-pentafluorophenyldithiodiphosphonic acid, dibenzyldithiodiphosphonic acid, dicyclohexyldithiodiphosphonic acid, and dinorbornyldithiodiphosphonic acid. [Note: the phosphite (P⁺³) valence of the phosphorus atom makes stabilizization of high valence metal ions much more difficult, though still possible.]

S Valence Stabilizer #29: Examples of dithioperoxydiphosphonamides, bis(dithioperoxydiphosphonamides), and poly(dithioperoxydiphosphonamides) (S—S Bidentates, S—S Tridentates, S—S Tetradentates) that meet the requirements for use as “narrow band” valence stabilizers for Ce⁺⁴ include, but are not limited to: dithioperoxydiphosphonamide, N-methyldithioperoxydiphosphonamide, N-isopropyldithioperoxydiphosphonamide, N-tert-butyldithioperoxydiphosphonamide, N-phenyldithioperoxydiphosphonamide, N-pentafluorophenyldithioperoxydiphosphonamide, N-benzyldithioperoxydiphosphonamide, N-cyclohexyldithioperoxydiphosphonamide, N-norbornyldithioperoxydiphosphonamide, N,N′″-dimethyldithioperoxydiphosphonamide, N,N′″-diisopropyldithioperoxydiphosphonamide, N,N′″-di-tert-butyldithioperoxydiphosphonamide, N,N′″-diphenyldithioperoxydiphosphonamide, N,N′″-di-pentafluorophenyldithioperoxydiphosphonamide, N,N′″-dibenzyldithioperoxydiphosphonamide, N,N′″-dicyclohexyldithioperoxydiphosphonamide, and N,N′″-dinorbornyldithioperoxydiphosphonamide. [Note: the phosphite (P⁺³) valence of the phosphorus atom makes stabilizization of high valence metal ions much more difficult, though still possible.]

S Valence Stabilizer #30: Examples of dithioperoxydiphosphonic acids, bis(dithioperoxydiphosphonic acids), poly(dithioperoxydiphosphonic acids), and derivatives thereof (S—S Bidentates, S—S Tridentates, S—S Tetradentates) that meet the requirements for use as “narrow band” valence stabilizers for Ce⁺⁴ include, but are not limited to: dithioperoxydiphosphonic acid, methyldithioperoxydiphosphonic acid, isopropyldithioperoxydiphosphonic acid, tert-butyldithioperoxydiphosphonic acid, phenyldithioperoxydiphosphonic acid, pentafluorophenyldithioperoxydiphosphonic acid, benzyldithioperoxydiphosphonic acid, cyclohexyldithioperoxydiphosphonic acid, norbornyldithioperoxydiphosphonic acid, dimethyldithioperoxydiphosphonic acid, diisopropyldithioperoxydiphosphonic acid, di-tert-butyldithioperoxydiphosphonic acid, diphenyldithioperoxydiphosphonic acid, di-pentafluorophenyldithioperoxydiphosphonic acid, dibenzyldithioperoxydiphosphonic acid, dicyclohexyldithioperoxydiphosphonic acid, and dinorbornyldithioperoxydiphosphonic acid. [Note: the phosphite (P⁺³) valence of the phosphorus atom makes stabilizization of high valence metal ions much more difficult, though still possible.]

S Valence Stabilizer #31: Examples of dithiophosphonic acids (phosphonodithioic acids), bis(dithiophosphonic acids), poly(dithiophosphonic acids), and derivatives thereof (S—S Bidentates, S—S Tridentates, S—S Tetradentates) that meet the requirements for use as “narrow band” valence stabilizers for Ce⁺⁴ include, but are not limited to: dithiophosphonic acid, O-phenyldithiophosphonic acid, O-benzyldithiophosphonic acid, O-cyclohexyldithiophosphonic acid, O-norbornyldithiophosphonic acid, O,P-diphenyldithiophosphonic acid, O,P-dibenzyldithiophosphonic acid, O,P-dicyclohexyldithiophosphonic acid, and O,P-dinorbornyldithiophosphonic acid. [Note: the phosphite (P⁺³) valence of the phosphorus atom makes stabilizization of high valence metal ions much more difficult, though still possible.]

S Valence Stabilizer #32: Examples of trithiophosphonic acids (phosphonotrithioic acids), bis(trithiophosphonic acids), poly(trithiophosphonic acids), and derivatives thereof (S—S Bidentates, S—S Tridentates, S—S Tetradentates) that meet the requirements for use as “narrow band” valence stabilizers for Ce⁺⁴ include, but are not limited to: trithiophosphonic acid, S-phenyltrithiophosphonic acid, S-benzyltrithiophosphonic acid, S-cyclohexyltrithiophosphonic acid, S-norbornyltrithiophosphonic acid, S,P-diphenyltrithiophosphonic acid, S,P-dibenzyltrithiophosphonic acid, S,P-dicyclohexyltrithiophosphonic acid, and S,P-dinorbornyltrithiophosphonic acid. [Note: the phosphite (P⁺³) valence of the phosphorus atom makes stabilizization of high valence metal ions much more difficult, though still possible.]

S Valence Stabilizer #33: Examples of phosphono(dithioperoxo)thioic acids, bis[phosphono(dithioperoxo)thioic acids], poly[phosphono(dithioperoxo)thioic acids], and derivatives thereof (S—S Bidentates, S—S Tridentates, S—S Tetradentates) that meet the requirements for use as “narrow band” valence stabilizers for Ce⁺⁴ include, but are not limited to: phosphono(dithioperoxo)thioic acid, O-phenylphosphono(dithioperoxo)thioic acid, O-benzylphosphono(dithioperoxo)thioic acid, O-cyclohexylphosphono(dithioperoxo)thioic acid, O-norbornylphosphono(dithioperoxo)thioic acid, O,P-diphenylphosphono(dithioperoxo)thioic acid, O,P-dibenzylphosphono(dithioperoxo)thioic acid, O,P-dicyclohexylphosphono(dithioperoxo)thioic acid, and O,P-dinorbornylphosphono(dithioperoxo)thioic acid. [Note: the phosphite (P⁺³) valence of the phosphorus atom makes stabilizization of high valence metal ions much more difficult, though still possible.]

S Valence Stabilizer #34: Examples of phosphono(dithioperoxo)dithioic acids, bis[phosphono(dithioperoxo)dithioic acids], poly[phosphono(dithioperoxo)dithioic acids], and derivatives thereof (S—S Bidentates, S—S Tridentates, S—S Tetradentates) that meet the requirements for use as “narrow band” valence stabilizers for Ce⁺⁴ include, but are not limited to: phosphono(dithioperoxo)dithioic acid, S-phenylphosphono(dithioperoxo)dithioic acid, S-benzylphosphono(dithioperoxo)dithioic acid, S-cyclohexylphosphono(dithioperoxo)dithioic acid, S-norbornylphosphono(dithioperoxo)dithioic acid, S,P-diphenylphosphono(dithioperoxo)dithioic acid, S,P-dibenzylphosphono(dithioperoxo)dithioic acid, S,P-dicyclohexylphosphono(dithioperoxo)dithioic acid, and S,P-dinorbornylphosphono(dithioperoxo)dithioic acid. [Note: the phosphite (P⁺³) valence of the phosphorus atom makes stabilizization of high valence metal ions much more difficult, though still possible.]

S Valence Stabilizer #35: Examples of S-(alkylthio)thiocarboxylic acids, S-(arylthio)thiocarboxylic acids, and S,S-thiobisthiocarboxylic Acids (S—S Bidentates and S—S Tridentates) that meet the requirements for use as “narrow band” valence stabilizers for Ce⁺⁴ include, but are not limited to: (methylthio)thioacetic acid; (methylthio)thiobenzoic acid; (methylthio)thionicotinic acid; (methylthio)thionapthoic acid; (phenylthio)thioacetic acid; (phenylthio)thiobenzoic acid; (phenylthio)thionaphthoic acid; (norbornylthio)thioacetic acid; (norbornylthio)thiobenzoic acid; (norbornylthio)thionapthoic acid; thiobisthioacetic acid; thiobisthiobenzoic acid; and thiobisthionapthoic acid.

S Valence Stabilizer #36: Examples of S-(alkyldisulfido)thiocarboxylic acids, S-(aryldisulfido)thiocarboxylic acids, and S,S′-disulfidobisthiocarboxylic acids (S—S Bidentates and S—S Tridentates) that meet the requirements for use as “narrow band” valence stabilizers for Ce⁺⁴ include, but are not limited to: (methyldisulfido)thioacetic acid; (methyldisulfido)thiobenzoic acid; (methyldisulfido)thionicotinic acid; (methyldisulfido)thionapthoic acid; (phenyldisulfido)thioacetic acid; (phenyldisulfido)thiobenzoic acid; (phenyldisulfido)thionaphthoic acid; (norbornyldisulfido)thioacetic acid; (norbornyldisulfido)thiobenzoic acid; (norbornyldisulfido)thionapthoic acid; S,S′-disulfidobisthioacetic acid; S,S′-disulfidobisthiobenzoic acid; and S,S′-disulfidobisthionapthoic acid.

S Valence Stabilizer #37: Examples of 1,2-dithiolates, bis(1,2-dithiolates), and poly(1,2-dithiolates) (S—S Bidentates, S—S Tridentates, S—S Tetradentates) that meet the requirements for use as “narrow band” valence stabilizers for Ce⁺⁴ include, but are not limited to: 2,3-butanedithiol; 1,2-diphenyl-1,2-ethanedithiol; 1,2-di(pentafluorophenyl)-1,2-ethanedithio; 1,2-dicyclohexyl-1,2-ethanedithiol; 1,2-dinorbornyl-1,2-ethanedithiol; 2,3-dimercaptopropanol; 2,3-dimercaptosuccinic acid; poly[bis(arylthio)acetylene]s; and poly[bis(alkylylthio)acetylene]s.

S Valence Stabilizer #38: Examples of rhodanines and bis(rhodanines) (S—S Bidentates and S—S Tetradentates) that meet the requirements for use as “narrow band” valence stabilizers for Ce⁺⁴ include, but are not limited to: 3-methylrhodanine; 3-ethylrhodanine; 3-isopropylrhodanine; 3-phenylrhodanine; 3-benzylrhodanine; 3-cyclohexylrhodanine; 3-norbornylrhodanine; 5-methylrhodanine; 5-ethylrhodanine; 5-isopropylrhodanine; 5-phenylrhodanine; 5-benzylrhodanine; 5-cyclohexylrhodanine; 5-norbornylrhodanine; 3,3′-ethylenebisrhodanine; 3,3′-propylenerhodanine; 3,3′-butylenerhodanine; 5,5′-ethylenebisrhodanine; 5,5′-propylenerhodanine; and 5,5′-butylenerhodanine. [Note: rhodanines and bis(rhodanines) tend to stabilize lower oxidation states in metal ions.]

S Valence Stabilizer #39: Examples of dithiocarbimates, bis(dithiocarbimates), and poly(dithiocarbimates) (S—S Bidentates, S—S Tridentates, and S—S Tetradentates) that meet the requirements for use as “narrow band” valence stabilizers for Ce⁺⁴ include, but are not limited to: methyldithiocarbimate; trifluoromethyldithiocarbimate; ethyldithiocarbimate; propyldithiocarbimate; isopropyldithiocarbimate; butyldithiocarbimate; tertbutyldithiocarbimate; cyanodithiocarbimate (CDC); cyanamidodithiocarbimate; azidodithiocarbimate; phenyldithiocarbimate; pentafluorophenyldithiocarbimate; benzyldithiocarbimate; naphthyldithiocarbimate; cyclohexyldithiocarbimate; norbomyldithiocarbimate; and adamantyldithiocarbimate. [Note: carbimates tend to stabilize lower oxidation states in metal ions.]

S Valence Stabilizer #40: Examples of thioxanthates, bis(thioxanthates), and poly(thioxanthates) (S—S Bidentates and S—S Tetradentates) that meet the requirements for use as “narrow band” valence stabilizers for Ce⁺⁴ include, but are not limited to: methyl thioxanthate (MeSxan); ethyl thioxanthate (EtSxan); isopropyl thioxanthate (iPrSxan); trifluoromethyl thioxanthate (CF₃Sxan); cyanothioxanthate; cyanamidothioxanthate; phenyl thioxanthate (PhSxan); benzyl thioxanthate (BzSxan); pentafluorophenyl thioxanthate; cyclohexyl thioxanthate (cHxSxan); and norbornyl thioxanthate. [Note: thioxanthates tend to stabilize lower oxidation states in metal ions.]

S Valence Stabilizer #41: Examples of xanthates, bis(xanthates), and poly(xanthates) (S—S Bidentates and S—S Tetradentates) that meet the requirements for use as “narrow band” valence stabilizers for Ce⁺⁴ include, but are not limited to: methyl xanthate (Mexan); ethyl xanthate (Etxan); isopropyl xanthate (iPrxan); trifluoromethyl xanthate (CF₃xan); cyanoxanthate; cyanamidoxanthate; phenyl xanthate (Phxan); benzyl xanthate (Bzxan); pentafluorophenyl xanthate; cyclohexyl xanthate (cHxxan); and norbornyl xanthate. [Note: xanthates tend to stabilize lower oxidation states in metal ions.]

S Valence Stabilizer #42: Examples of phosphinodithioformates (S—S Bidentates) that meet the requirements for use as “narrow band” valence stabilizers for Ce⁺⁴ include, but are not limited to: trimethylphosphinodithioformate; triethylphosphinodithioformate; triphenylphosphinodithioformate; tricyclohexylphosphinodithioformate; dimethylphosphinodithioformate; diethylphosphinodithioformate; diphenylphosphinodithiofonnate; and dicyclohexylphosphinodithioformate.

S Valence Stabilizer #43: Examples of alkyl- and aryl-dithioborates, trithioborates, perthioborates, bis(dithioborates), bis(trithioborates), and bis(perthioborates) (S—S Bidentates and S—S Tetradentates) that meet the requirements for use as “narrow band” valence stabilizers for Ce⁺⁴ include, but are not limited to: S,O-diethyl dithioborate; S,O-diisopropyl dithioborate; S,O-diphenyl dithioborate; S,O-dibenzyl dithioborate; S,O-dicyclohexyl dithioborate; S,O-dinorbornyl dithioborate; diethyl trithioborate; diisopropyl trithioborate; diphenyl trithioborate; dibenzyl trithioborate; dicyclohexyl trithioborate; and dinorbornyl trithioborate.

S Valence Stabilizer #44: Examples of alkyl- and aryl-dithioboronates and bis(dithioboronates) (S—S Bidentates and S—S Tetradentates) that meet the requirements for use as “narrow band” valence stabilizers for Ce⁺⁴ include, but are not limited to: diethyl dithioboronate; diisopropyl dithioboronate; diphenyl dithioboronate; dibenzyl dithioboronate; dicyclohexyl dithioboronate; and dinorbornyl dithioboronate. [Note: boronates tend to stabilize lower oxidation states in metal ions.]

S Valence Stabilizer #45: Examples of trithioarsonic acids (arsonotrithioic acids), dithioarsonic acids (arsonodithioic acids), tetrathioarsonic acids (arsonotetrathioic acids), and derivatives thereof (S—S Bidentates, S—S Tridentates, S—S Tetradentates) that meet the requirements for use as “narrow band” valence stabilizers for Ce⁺⁴ include, but are not limited to: trithioarsonic acid, O-phenyltrithioarsonic acid, O-benzyltrithioarsonic acid, O-cyclohexyltrithioarsonic acid, O-norbornyltrithioarsonic acid, O,S-diphenyltrithioarsonic acid, O,S-dibenzyltrithioarsonic acid, O,S-dicyclohexyltrithioarsonic acid, O,S-dinorbornyltrithioarsonic acid; dithioarsonic acid, O-phenyldithioarsonic acid, O-benzyldithioarsonic acid, O-cyclohexyldithioarsonic acid, O-norbornyldithioarsonic acid, O,O-diphenyldithioarsonic acid, O,O-dibenzyldithioarsonic acid, O,O-dicyclohexyldithioarsonic acid, and O,O-dinorbornyldithioarsonic acid.

S Valence Stabilizer #46: Examples of trithioantimonic acids (stibonotrithioic acids), dithioantimonic acids (stibonodithioic acids), tetrathioantimonic acids (stibonotetrathioic acids), and derivatives thereof (S—S Bidentates, S—S Tridentates, S—S Tetradentates) that meet the requirements for use as “narrow band” valence stabilizers for Ce⁺⁴ include, but are not limited to: trimethyltrithioantimonate; triethyltrithioantimonate; and triphenyltrithioantimonate.

S Valence Stabilizer #47: Examples of phosphine P-sulfides and amino-substituted phosphine sulfides (S Monodentates) that meet the requirements for use as “narrow band” valence stabilizers for Ce⁺⁴ include, but are not limited to: trimethylphosphine sulfide (TMPS); triethylphosphine sulfide (TEPS); triphenylphosphine sulfide (TPhPS); tribenzylphosphine sulfide (TBzPS); tricyclohexylphosphine sulfide (TcHxPS); and trinorbornylphosphine sulfide for phosphine P-sulfides; and tris(dimethylamino)phosphine sulfide; trimorpholinophosphine sulfide; tripiperidinophosphine sulfide; tripyrrolidinophosphine sulfide; and tri(cyclohexylamino)phosphine sulfide for amino-substituted phosphine sulfides.

S Valence Stabilizer #48: Examples of arsine As-sulfides and amino-substituted arsine sulfides (S Monodentates) that meet the requirements for use as “narrow band” valence stabilizers for Ce⁺⁴ include, but are not limited to: trimethylarsine sulfide; triethylarsine sulfide; triphenylarsine sulfide; tribenzylarsine sulfide; tricyclohexylarsine sulfide; and trinorbornylarsine sulfide for arsine As-sulfides; and tris(dimethylamino)arsine sulfide; trimorpholinoarsine sulfide; tripiperidinoarsine sulfide; tripyrrolidinoarsine sulfide; and tri(cyclohexylamino)arsine sulfide for amino-substituted arsine sulfides.

S Valence Stabilizer #49: Examples of thiolates that meet the requirements for use as “narrow band” valence stabilizers for Ce⁺⁴ include, but are not limited to: thiophenol; naphthalenethiol; 1-dodecanethion; hexadecyl mercaptan; benzenethiol (bt); polybenzenethiols; and polythioarylenes.

S Valence Stabilizer #50: Examples of sulfide that meet the requirements for use as “narrow band” valence stabilizers for Ce⁺⁴ include, but are not limited to: sulfides (—S²⁻); disulfides (—S₂²⁻); and polysulfides (—Sₓ²⁻).

P Valence Stabilizer #1: Examples of monophosphines (P monodentates) that meet the requirements for use as “narrow band” valence stabilizers for Ce⁺⁴ include, but are not limited to: phosphine, phenylphosphine, diphenylphosphine, triphenylphosphine, tricyclohexylphosphine, phenyldimethylphosphine, phenyldiethylphosphine, methyldiphenylphosphine, ethyldiphenylphosphine, phosphirane, phosphetane, phospholane, phosphorinane, benzophospholane, benzophosphorinane, dibenzophospholane, dibenzophosphorinane, naphthophospholane, naphthophosphorinane, phosphinonorbornane, and phosphinoadamantane.

P Valence Stabilizer #2: Examples of diphosphines (P monodentates or P—P bidentates) that meet the requirements for use as “narrow band” valence stabilizers for Ce⁺⁴ include, but are not limited to: diphospholane, benzodiphospholane, naphthodiphospholane, diphosphorinane, benzodiphosphorinane, dibenzodiphosphorinane, naphthodiphosphorinane, bis(diphenylphosphino)methane, bis(diphenylphosphino)ethane, bis(diphenylphosphino)propane, bis(diphenylphosphino)butane, bis(diphenylphosphino)pentane, 1,2-bis(diphenylphosphino)ethylene, and o-phenylenebis(diphenylphosphine). [Note: the aryl derivatives are air-stable, whereas the alkyl derivatives are air-sensitive and therefore unsuitable for these applications.]

P Valence Stabilizer #3: Examples of triphosphines (P monodentates, P—P bidentates, or P—P tridentates) that meet the requirements for use as “narrow band” valence stabilizers for Ce⁺⁴ include, but are not limited to: triphosphorinane, P,P′-tetraphenyl-2-methyl-2-(P-diphenyl)phosphinomethyl-1,3-propanediphosphine; P,P-[2-(P-diphenyl)phosphinoethyl]diethyl-P-phenylphosphine; P,P-[2-(P-diphenyl)phosphino]diphenyl-P-phenylphosphine; and hexahydro-2,4,6-trimethyl-1,3,5-triphosphazine. [Note: the aryl derivatives are air-stable, whereas the alkyl derivatives are air-sensitive and therefore unsuitable for these applications.]

P Valence Stabilizer #4: Examples of tetraphosphines (P monodentates, P—P bidentates, P—P tridentates, and P—P tetradentates) that meet the requirements for use as “narrow band” valence stabilizers for Ce⁺⁴ include, but are not limited to: P,P′-tetraphenyl-2,2-[(P-diphenyl)phosphinomethyl]-1,3-propanediphosphine; tri[o-(P-diphenyl)phosphinophenyl]phosphine; and 1,1,4,7,10,10-hexaphenyl-1,4,7,10-tetraphosphadecane. [Note: the aryl derivatives are air-stable, whereas the alkyl derivatives are air-sensitive and therefore unsuitable for these applications.]

P Valence Stabilizer #5: Examples of pentaphosphines (P monodentates, P—P bidentates, P—P tridentates, and P—P tetradentates) that meet the requirements for use as “narrow band” valence stabilizers for Ce⁺⁴ include, but are not limited to: 4-[2-(P-diphenyl)phosphinoethyl]-1,1,7,10,10-pentaphenyl-1,4,7,10-tetraphosphadecane. [Note: the aryl derivatives are air-stable, whereas the alkyl derivatives are air-sensitive and therefore unsuitable for these applications.]

P Valence Stabilizer #6: Examples of hexaphosphines (P—P bidentates, P—P tridentates, P—P tetradentates, and P—P hexadentates) that meet the requirements for use as “narrow band” valence stabilizers for Ce⁺⁴ include, but are not limited to: 1,1,10,10-tetraphenyl-4,7-[2-(P,P-diphenyl)phosphinoethyl]-1,4,7,10-tetraphosphadecane. [Note: the aryl derivatives are air-stable, whereas the alkyl derivatives are air-sensitive and therefore unsuitable for these applications.]

P Valence Stabilizer #7a: Examples of 5-membered heterocyclic rings containing one phosphorus atom (P monodentates) that meet the requirements for use as “narrow band” valence stabilizers for Ce⁺⁴ include, but are not limited to: 1-phospholene, 2-phospholene, 3-phospholene, phosphole, oxaphosphole, thiaphosphole, benzophospholene, benzophosphole, benzoxaphosphole, benzothiaphosphole, dibenzophospholene, dibenzophosphole, naphthophospholene, naphthophosphole, naphthoxaphosphole, naphthothiaphosphole.

P Valence Stabilizer #7b: Examples of 5-membered heterocyclic rings containing two phosphorus atoms (P monodentates or P—P bidentates) that meet the requirements for use as “narrow band” valence stabilizers for Ce⁺⁴ include, but are not limited to: diphospholene, diphosphole, oxadiphospholene, thiadiphospholene, benzodiphospholene, benzodiphosphole, naphthodiphospholene, and naphthodiphosphole.

P Valence Stabilizer #7c: Examples of 5-membered heterocyclic rings containing three phosphorus atoms (P monodentates or P—P bidentates) that meet the requirements for use as “narrow band” valence stabilizers for Ce⁺⁴ include, but are not limited to: triphosphole.

P Valence Stabilizer #8a: Examples of 6-membered heterocyclic rings containing one phosphorus atom (P monodentates) that meet the requirements for use as “narrow band” valence stabilizers for Ce⁺⁴ include, but are not limited to: phosphorin, oxaphosphorin, thiaphosphorin, benzophosphorin, benzoxaphosphorin, benzothiaphosphorin, acridophosphine, phosphanthridine, dibenzoxaphosphorin, dibenzothiaphosphorin, naphthophosphorin, naphthoxaphosphorin, and naphthothiaphosphorin.

P Valence Stabilizer #8b: Examples of 6-membered heterocyclic rings containing two phosphorus atoms (P monodentates or P—P bidentates) that meet the requirements for use as “narrow band” valence stabilizers for Ce⁺⁴ include, but are not limited to: o-diphosphorin, m-diphosphorin, p-diphosphorin, oxadiphosphorin, thiadiphosphorin, benzodiphosphorin, benzoxadiphosphorin, benzothiadiphosphorin, dibenzodiphosphorin, dibenzoxadiphosphorin, dibenzothiadiphosphorin, naphthodiphosphorin, naphthoxadiphosphorin, and naphthothiadiphosphorin.

P Valence Stabilizer #8c: Examples of 6-membered heterocyclic rings containing three phosphorus atoms (P monodentates or P—P bidentates) that meet the requirements for use as “narrow band” valence stabilizers for Ce⁺⁴ include, but are not limited to: 1,3,5-triphosphorin, 1,2,3-triphosphorin, benzo-1,2,3-triphosphorin, and naphtho-1,2,3-triphosphorin.

P Valence Stabilizer #9a: Examples of 5-membered heterocyclic rings containing one phosphorus atom and having at least one additional phosphorus atom binding site not contained in a ring (P Monodentates, P—P Bidentates, P—P Tridentates, P—P Tetradentates, or P—P Hexadentates) that meet the requirements for use as “narrow band” valence stabilizers for Ce⁺⁴ include, but are not limited to: 2-(P-phenylphosphino)-1-phospholene; 2,5-(P-phenylphosphino)-1-phospholene; 2-(P-phenylphosphino)-3-phospholene; 2,5-(P-phenylphosphino)-3-phospholene; 2-(P-phenylphosphino)phosphole; 2,5-(P-phenylphosphino)phosphole; 2-(P-phenylphosphino)benzophosphole; 7-(P-phenylphosphino)benzophosphole; and 1,8-(P-phenylphosphino)dibenzophosphole.

P Valence Stabilizer #9b: Examples of 5-membered heterocyclic rings containing two phosphorus atoms and having at least one additional phosphorus atom binding site not contained in a ring (P Monodentates, P—P Bidentates, P—P Tridentates, P—P Tetradentates, or P—P Hexadentates) that meet the requirements for use as “narrow band” valence stabilizers for Ce⁺⁴ include, but are not limited to: 2-(P-phenylphosphino)-1,3-diphospholene; 2,5-(P-phenylphosphino)-1,3-diphospholene; 2-(P-phenylphosphino)-1,3-diphosphole; 2,5-(P-phenylphosphino)-1,3-diphosphole; 2-(P-phenylphosphino)benzodiphosphole; and 7-(P-phenylphosphino)benzodiphosphole.

P Valence Stabilizer #9c: Examples of 5-membered heterocyclic rings containing three phosphorus atoms and having at least one additional phosphorus atom binding site not contained in a ring (P Monodentates, P—P Bidentates, P—P Tridentates, P—P Tetradentates, or P—P Hexadentates) that meet the requirements for use as “narrow band” valence stabilizers for Ce⁺⁴ include, but are not limited to: 2-(P-phenylphosphino)-1,3,4-triphosphole; and 2,5-(P-phenylphosphino)-1,3,4-triphosphole.

P Valence Stabilizer #10a: Examples of 6-membered heterocyclic rings containing one phosphorus atom and having at least one additional phosphorus atom binding site not contained in a ring (P Monodentates, P—P Bidentates, P—P Tridentates, P—P Tetradentates, or P—P Hexadentates) that meet the requirements for use as “narrow band” valence stabilizers for Ce⁺⁴ include, but are not limited to: 2-(P-phenylphosphino)phosphorin; 2,5-(P-phenylphosphino)phosphorin; 2-(P-phenylphosphino)benzophosphorin; 7-(P-phenylphosphino)benzophosphorin; and 1,9-(P-phenylphosphino)acridophosphine.

P Valence Stabilizer #10b: Examples of 6-membered heterocyclic rings containing two phosphorus atoms and having at least one additional phosphorus atom binding site not contained in a ring (P Monodentates, P—P Bidentates, P—P Tridentates, P—P Tetradentates, or P—P Hexadentates) that meet the requirements for use as “narrow band” valence stabilizers for Ce⁺⁴ include, but are not limited to: 2-(P-phenylphosphino)-4-diphosphorin; 2,6-(P-phenylphosphino)-4-diphosphorin; 2,3,5,6-(P-phenylphosphino)-4-diphosphorin; 2-(P-phenylphosphino)benzo-1,4-diphosphorin; 2,3-(P-phenylphosphino)benzo-1,4-diphosphorin; 2,8-(P-phenylphosphino)benzo-1,4-diphosphorin; 2,3,5,8-(P-phenylphosphino)benzo-1,4-diphosphorin; 1,9-(P-phenylphosphino)dibenzodiphosphorin; and 1,4,6,9-(P-phenylphosphino)dibenzodiphosphorin.

P Valence Stabilizer #10c: Examples of 6-membered heterocyclic rings containing three phosphorus atoms and having at least one additional phosphorus atom binding site not contained in a ring (P Monodentates, P—P Bidentates, P—P Tridentates, P—P Tetradentates, or P—P Hexadentates) that meet the requirements for use as “narrow band” valence stabilizers for Ce⁺⁴ include, but are not limited to: 2-(P-phenylphosphino)-1,3,5-triphosphorin; 2,6-(P-phenylphosphino)-1,3,5-triphosphorin; 4-(P-phenylphosphino)-1,2,3-triphosphorin; and 8-(P-phenylphosphino)benzo-1,2,3-triphosphorin.

P Valence Stabilizer #11a: Examples of 5-membered heterocyclic rings containing one phosphorus atom and having at least one additional phosphorus atom binding site contained in a ring (P Monodentates, P—P Bidentates, P—P Tridentates, P—P Tetradentates) that meet the requirements for use as “narrow band” valence stabilizers for Ce⁺⁴ include, but are not limited to: 2,2′-bi-1-phospholene; 2,2′,2″-tri-1-phospholene; 2,2′-bi-3-phospholene; 2,2′,2″-tri-3-phospholene; 2,2′-biphosphole; 2,2′,2″-triphosphole; and 2,2′-bibenzophosphole.

P Valence Stabilizer #11b: Examples of 5-membered heterocyclic rings containing two phosphorus atoms and having at least one additional phosphorus atom binding site contained in a ring (P Monodentates, P—P Bidentates, P—P Tridentates, P—P Tetradentates) that meet the requirements for use as “narrow band” valence stabilizers for Ce⁺⁴ include, but are not limited to: 2,2′-bi-1,3-diphospholene; 2,2′-bi-1,3-diphosphole; and 2,2′-bibenzo-1,3-diphosphole.

P Valence Stabilizer #11c: Examples of 5-membered heterocyclic rings containing three phosphorus atoms and having at least one additional phosphorus atom binding site contained in a ring (P Monodentates, P—P Bidentates, P—P Tridentates, P—P Tetradentates) that meet the requirements for use as “narrow band” valence stabilizers for Ce⁺⁴ include, but are not limited to: 2,2′-bi-1,3,4-triphosphole; and 2,2′,2″-tri-1,3,4-triphosphole.

P Valence Stabilizer #12a: Examples of 6-membered heterocyclic rings containing one phosphorus atom and having at least one additional phosphorus atom binding site contained in a ring (P Monodentates, P—P Bidentates, P—P Tridentates, P—P Tetradentates) that meet the requirements for use as “narrow band” valence stabilizers for Ce⁺⁴ include, but are not limited to: 2,2′-biphosphorin; 2,2′,2″-triphosphorin; 2,2′,2″,2′″-tetraphosphorin; 2,2′-bibenzophosphorin; and 8,8′-bibenzophosphorin.

P Valence Stabilizer #12b: Examples of 6-membered heterocyclic rings containing two phosphorus atoms and having at least one additional phosphorus atom binding site contained in a ring (P Monodentates, P—P Bidentates, P—P Tridentates, P—P Tetradentates) that meet the requirements for use as “narrow band” valence stabilizers for Ce⁺⁴ include, but are not limited to: 3,3′-bi-1,2-diphosphorin; 3,3′,3″-tri-1,2-diphosphorin; 2,2′-bi-1,4-diphosphorin; 2,2′,″-tri-1,4-diphosphorin; 3,3′-bibenzo-1,2-diphosphorin; 8,8′-bibenzo-1,2-diphosphorin; 2,2′-bibenzo-1,4-diphosphorin; and 8,8′-bibenzo-1,4-diphosphorin.

P Valence Stabilizer #12c: Examples of 6-membered heterocyclic rings containing three phosphorus atoms and having at least one additional phosphorus atom binding site contained in a ring (P Monodentates, P—P Bidentates, P—P Tridentates, P—P Tetradentates) that meet the requirements for use as “narrow band” valence stabilizers for Ce⁺⁴ include, but are not limited to: 2,2′-bi-1,3,5-triphosphorin; 2,2′,2″-tri-1,3,5-triphosphorin; 4,4′-bi-1,2,3-triphosphorin; 4,4′-bibenzo-1,2,3-triphosphorin; and 8,8′-bibenzo-1,2,3-triphosphorin.

P Valence Stabilizer #13a: Examples of two-membered macrocyclics, macrobicyclics, and macropolycyclics (including catapinands, cryptands, cyclidenes, and sepulchrates) wherein both binding sites are composed of phosphorus and are not contained in component heterocyclic rings (P—P Bidentates) that meet the requirements for use as “narrow band” valence stabilizers for Ce⁺⁴ include, but are not limited to: P,P-diphenyldiphosphacyclobutane ([4]aneP₂); P,P-diphenyldiphosphacyclopentane ([5]aneP₂); P,P-diphenyldiphosphacyclohexane ([6]aneP₂); P,P-diphenyldiphosphacycloheptane ([7]aneP₂); P,P-diphenyldiphosphacyclooctane ([8]aneP₂); P,P-diphenyldiphosphacyclobutene ([4]eneP₂); P,P-diphenyldiphosphacyclopentene ([5]eneP₂); P,P-diphenyldiphosphacyclohexene ([6]eneP₂); P,P-diphenyldiphosphacycloheptene ([7]eneP₂); and P,P-diphenyldiphosphacyclooctene ([8]eneP₂).

P Valence Stabilizer #13b: Examples of three-membered macrocyclics, macrobicyclics, and macropolycyclics (including catapinands, cryptands, cyclidenes, and sepulchrates) wherein all binding sites are composed of phosphorus and are not contained in component heterocyclic rings (P—P Tridentates) that meet the requirements for use as “narrow band” valence stabilizers for Ce⁺⁴ include, but are not limited to: P,P,P-tripbenyltriphosphacyclohexane ([6]aneP₃); P,P,P-triphenyltriphosphacycloheptane ([7]aneP₃); P,P,P-triphenyltriphosphacyclooctane ([8]aneP₃); P,P,P-triphenyltriphosphacyclononane ([9]aneP₃); P,P,P-triphenyltriphosphacyclodecane ([10]aneP₃); P,P,P-triphenyltriphosphacycloundecane ([11]aneP₃); P,P,P-triphenyltriphosphacyclododecane ([12]aneP₃); P,P,P-triphenyltriphosphacyclohexatriene ([6]trieneP₃); P,P,P-triphenyltriphosphacycloheptatriene ([7]trieneP₃); P,P,P-triphenyltriphosphacyclooctatriene ([8]trieneP₃); P,P,P-triphenyltriphosphacyclononatriene ([9]trieneP₃); P,P,P-triphenyltriphosphacyclodecatriene ([10]trieneP₃); P,P,P-triphenyltriphosphacycloundecatriene ([11]trieneP₃); and P,P,P-triphenyltriphosphacyclododecatriene ([12]trieneP₃).

P Valence Stabilizer #13c: Examples of four-membered macrocyclics, macrobicyclics, and macropolycyclics (including catapinands, cryptands, cydidenes, and sepulchrates) wherein all binding sites are composed of phosphorus and are not contained in component heterocyclic rings (P—P Tetradentates) that meet the requirements for use as “narrow band” valence stabilizers for Ce⁺⁴ include, but are not limited to: P,P,P,P-tetraphenyltetraphosphacyclooctane ([8]aneP₄); P,P,P,P-tetraphenyltetraphosphacyclononane ([9]aneP₄); P,P,P,P-tetraphenyltetraphosphacyclodecane ([10]aneP₄); P,P,P,P-tetraphenyltetraphosphacycloundecane ([11]aneP₄); P,P,P,P-tetraphenyltetraphosphacyclododecane ([12]aneP₄); P,P,P,P-tetraphenyltetraphosphacyclotridecane ([13]aneP₄); P,P,P,P-tetraphenyltetraphosphacyclotetradecane ([14]aneP₄); P,P,P,P-tetraphenyltetraphosphacyclopentadecane ([15]aneP₄); P,P,P,P-tetraphenyltetraphosphacyclohexadecane ([16]aneP₄); P,P,P,P-tetraphenyltetraphosphacycloheptadecane ([17]aneP₄); P,P,P,P-tetraphenyltetraphosphacyclooctadecane ([18]aneP₄); P,P,P,P-tetraphenyltetraphosphacyclononadecane ([19]aneP₄); and P,P,P,P-tetraphenyltetraphosphacycloeicosane ([20]aneP₄).

P Valence Stabilizer #13d: Examples of five-membered macrocyclics, macrobicyclics, and macropolycyclics (including catapinands, cryptands, cyclidenes, and sepulchrates) wherein all binding sites are composed of phosphorus and are not contained in component heterocyclic rings (P—P Tridentates, or P—P Tetradentates) that meet the requirements for use as “narrow band” valence stabilizers for Ce⁺⁴ include, but are not limited to: P,P,P,P,P-pentaphenylpentaphosphacyclodecane ([10]aneP₅); P,P,P,P,P-pentaphenylpentaphosphacycloundecane ([11]aneP₅); P,P,P,P,P-pentaphenylpentaphosphacyclododecane ([12]aneP₅); P,P,P,P,P-pentaphenylpentaphosphacyclotridecane ([13]aneP₅); P,P,P,P,P-pentaphenylpentaphosphacyclotetradecane ([14]aneP₅); and P,P,P,P,P-pentaphenylpentaphosphacyclopentadecane ([15]aneP₅).

P Valence Stabilizer #13e: Examples of six-membered macrocyclics, macrobicyclics, and macropolycyclics (including catapinands, cryptands, cyclidenes, and sepulchrates) wherein all binding sites are composed of phosphorus and are not contained in component heterocyclic rings (P—P—P Tridentates, P—P—P—P Tetradentates, or P—P—P—P—P—P Hexadentates) that meet the requirements for use as “narrow band” valence stabilizers for Ce⁺⁴ include, but are not limited to: P,P,P,P,P,P-hexaphenylhexaphosphacyclododecane ([12]aneP₆); P,P,P,P,P,P-hexaphenylhexaphosphacyclotridecane ([13]aneP₆); P,P,P,P,P,P-hexaphenylhexaphosphacyclotetradecane ([14]aneP₆); P,P,P,P,P,P-hexaphenylhexaphosphacyclopentadecane ([15]aneP₆); P,P,P,P,P,P-hexaphenylhexaphosphacyclohexadecane ([16]aneP₆); P,P,P,P,P,P-hexaphenylhexaphosphacycloheptadecane ([17]aneP₆); P,P,P,P,P,P-hexaphenylhexaphosphacyclooctadecane ([18]aneP₆); P,P,P,P,P,P-hexaphenylhexaphosphacyclononadecane ([19]aneP₆); P,P,P,P,P,P-hexaphenylhexaphosphacycloeicosane ([20]aneP₆); P,P,P,P,P,P-hexaphenylhexaphosphacycloheneicosane ([21]aneP₆); P,P,P,P,P,P-hexaphenylhexaphosphacyclodocosane ([22]aneP₆); P,P,P,P,P,P-hexaphenylhexaphosphacyclotricosane ([23]aneP₆); P,P,P,P,P,P-hexaphenylhexaphosphacyclotetracosane ([24]aneP₆).

P Valence Stabilizer #13f: Examples of eight-membered macrocyclics, macrobicyclics, and macropolycyclics (including catapinands, cryptands, cyclidenes, and sepulchrates) wherein all binding sites are composed of phosphorus and are not contained in component heterocyclic rings (P—P Tridentates, P—P Tetradentates, or P—P Hexadentates) that meet the requirements for use as “narrow band” valence stabilizers for Ce⁺⁴ include, but are not limited to: P,P,P,P,P,P,P,P-octaphenyloctaphosphacyclohexadecane ([16]aneP₈); P,P,P,P,P,P,P,P-octaphenyloctaphosphacycloheptadecane ([17]aneP₈); P,P,P,P,P,P,P,P-octaphenyloctaphosphacyclooctadecane ([18]aneP₈); P,P,P,P,P,P,P,P-octaphenyloctaphosphacyclononadecane ([19]aneP₈); P,P,P,P,P,P,P,P-octaphenyloctaphosphacycloeicosane ([20]aneP₈); P,P,P,P,P,P,P,P-octaphenyloctaphosphacycloheneicosane ([21]aneP₈); P,P,P,P,P,P,P,P-octaphenyloctaphosphacyclodocosane ([22]aneP₈); P,P,P,P,P,P,P,P-octaphenyloctaphosphacyclotricosane ([23]aneP₈); and P,P,P,P,P,P,P,P-octaphenyloctaphosphacyclotetracosane ([24]aneP₈).

P Valence Stabilizer #14a: Examples of four-membered macrocyclics, macrobicyclics, and macropolycyclics (including catapinands, cryptands, cyclidenes, and sepulchrates) wherein all four binding sites are composed of phosphorus and are contained in component 5-membered heterocyclic rings (P—P Tetradentates) that meet the requirements for use as “narrow band” valence stabilizers for Ce⁺⁴ include, but are not limited to: tetraphospholenes; tetraphospholes; tetraoxaphospholes; tetradiphospholenes; tetradiphospholes; and tetraoxadiphospholes.

P Valence Stabilizer #14b: Examples of six-membered macrocyclics, macrobicyclics, and macropolycyclics (including catapinands, cryptands, cyclidenes, and sepulchrates) wherein all six binding sites are composed of phosphorus and are contained in component 5-membered heterocyclic rings (P—P Tetradentates and P—P Hexadentates) that meet the requirements for use as “narrow band” valence stabilizers for Ce⁺⁴ include, but are not limited to: hexaphospholenes; hexaphospholes; hexaoxaphospholes; hexadiphospholenes; hexadiphospholes; and hexaoxadiphospholes.

P Valence Stabilizer #14c: Examples of eight-membered macrocyclics, macrobicyclics, and macropolycyclics (including catapinands, cryptands, cyclidenes, and sepulchrates) wherein all eight binding sites are composed of phosphorus and are contained in component 5-membered heterocyclic rings (P—P Tridentates; P—P Tetradentates; or P—P Hexadentates) that meet the requirements for use as “narrow band” valence stabilizers for Ce⁺⁴ include, but are not limited to: octaphospholenes; octaphospholes; octaoxaphospholes; octadiphospholenes; octadiphospholes; and octaoxadiphospholes.

P Valence Stabilizer #15a: Examples of four-membered macrocyclics, macrobicyclics, and macropolycyclics (including catapinands, cryptands, cyclidenes, and sepulchrates) wherein all four binding sites are composed of phosphorus and are contained in a combination of 5-membered heterocyclic rings and phosphine groups (P—P Tridentates, P—P Tetradentates) that meet the requirements for use as “narrow band” valence stabilizers for Ce⁺⁴ include, but are not limited to: diphosphatetraphospholenes; tetraphosphatetraphospholenes; diphosphatetraphospholes; tetraphosphatetraphospholes; diphoshatetradiphospholes; and tetraphosphatetradiphospholes.

P Valence Stabilizer #15b: Examples of six-membered macrocyclics, macrobicyclics, and macropolycyclics (including catapinands, cryptands, cyclidenes, and sepulchrates) wherein all six binding sites are composed of phosphorus and are contained in a combination of 5-membered heterocyclic rings and phosphine groups (P—P Tridentates, P—P Tetradentates, and P—P Hexadentates) that meet the requirements for use as “narrow band” valence stabilizers for Ce⁺⁴ include, but are not limited to: diphosphahexaphospholenes; triaphosphahexaphospholenes; diphosphahexaphospholes; triphosphahexaphospholes; diphoshahexadiphospholes; and triphosphahexadiphospholes.

P Valence Stabilizer #15c: Examples of eight-membered macrocyclics, macrobicyclics, and macropolycyclics (including catapinands, cryptands, cyclidenes, and sepulchrates) wherein all eight binding sites are composed of phosphorus and are contained in a combination of 5-membered heterocyclic rings and phosphine groups (P—P Tridentates, P—P Tetradentates, and P—P Hexadentates) that meet the requirements for use as “narrow band” valence stabilizers for Ce⁺⁴ include, but are not limited to: diphosphaoctaphospholenes; tetraphosphaoctaphospholenes; diphosphaoctaphospholes; tetraphosphaoctaphospholes; diphoshaoctadiphospholes; and tetraphosphaoctadiphospholes.

P Valence Stabilizer #16a: Examples of four-membered macrocyclics, macrobicyclics, and macropolycyclics (including catapinands, cryptands, cyclidenes, and sepulchrates) wherein all four binding sites are composed of phosphorus and are contained in component 6-membered heterocyclic rings (P—P Tetradentates) that meet the requirements for use as “narrow band” valence stabilizers for Ce⁺⁴ include, but are not limited to: cyclotetraphosphorins; cyclotetraaoxaphosphorins; cyclotetradiphosphorins; and cyclotetraoxadiphosphorins.

P Valence Stabilizer #16b: Examples of six-membered macrocyclics, macrobicyclics, and macropolycyclics (including catapinands, cryptands, cyclidenes, and sepulchrates) wherein all six binding sites are composed of phosphorus and are contained in component 6-membered heterocyclic rings (P—P Tridentates, P—P Tetradentates, and P—P Hexadentates) that meet the requirements for use as “narrow band” valence stabilizers for Ce⁺⁴ include, but are not limited to: cyclohexaphosphorins; cyclohexaoxaphosphorins; cyclohexadiphosphorins; and cyclohexaoxadiphosphorins.

P Valence Stabilizer #16c: Examples of eight-membered macrocyclics, macrobicyclics, and macropolycyclics (including catapinands, cryptands, cyclidenes, and sepulchrates) wherein all eight binding sites are composed of phosphorus and are contained in component 6-membered heterocyclic rings (P—P Tridentates, P—P Tetradentates, and P—P Hexadentates) that meet the requirements for use as “narrow band” valence stabilizers for Ce⁺⁴ include, but are not limited to: cyclooctaphosphorins; cyclooctaoxaphosphorins; cyclooctadiphosphorins; and cyclooctaoxadiphosphorins.

P Valence Stabilizer #17a: Examples of four-membered macrocyclics, macrobicyclics, and macropolycyclics (including catapinands, cryptands, cyclidenes, and sepulchrates) wherein all four binding sites are composed of phosphorus and are contained in a combination of 6-membered heterocyclic rings and phosphine groups (P—P Tridentates, P—P Tetradentates, or P—P Hexadentates) that meet the requirements for use as “narrow band” valence stabilizers for Ce⁺⁴ include, but are not limited to: diphosphacyclotetraphosphorins; tetraphosphacyclotetraphosphorins; diphosphacyclotetraoxaphosphorins; tetraphosphacyclotetraoxaphosphorins; diphosphacyclotetradiphosphorins; tetraphosphacyclotetradiphosphorins; diphosphacyclotetraoxadiphosphorins; and tetraphosphacyclotetraoxadiphosphorins.

P Valence Stabilizer #17b: Examples of six-membered macrocyclics, macrobicyclics, and macropolycyclics (including catapinands, cryptands, cyclidenes, and sepulchrates) wherein all six binding sites are composed of phosphorus and are contained in a combination of 6-membered heterocyclic rings and phosphine groups (P—P Tridentates, P—P Tetradentates, or P—P Hexadentates) that meet the requirements for use as “narrow band” valence stabilizers for Ce⁺⁴ include, but are not limited to: diphosphacyclohexaphosphorins; triphosphacyclohexaphosphorins; diphosphacyclohexaoxaphosphorins; triphosphacyclohexaoxaphosphorins; diphosphacyclohexadiphosphorins; triphosphacyclohexadiphosphorins; diphosphacyclohexaoxadiphosphorins; and triphosphacyclohexaoxadiphosphorins.

P Valence Stabilizer #17c: Examples of eight-membered macrocyclics, macrobicyclics, and macropolycyclics (including catapinands, cryptands, cyclidenes, and sepulchrates) wherein all eight binding sites are composed of phosphorus and are contained in a combination of 6-membered heterocyclic rings and phosphine groups (P—P Tridentates, P—P Tetradentates, or P—P Hexadentates) that meet the requirements for use as “narrow band” valence stabilizers for Ce⁺⁴ include, but are not limited to: diphosphacyclooctaphosphorins; tetraphosphacyclooctaphosphorins; diphosphacyclooctaoxaphosphorins; tetraphosphacyclooctaoxaphosphorins; diphosphacyclooctadiphosphorins; tetraphosphacyclooctadiphosphorins; diphosphacyclooctaoxadiphosphorins; and tetraphosphacyclooctaoxadiphosphorins.

O Valence Stabilizer #1: Examples of dithioperoxydicarbonic acids, bis(dithioperoxydicarbonic acids), poly(dithioperoxydicarbonic acids), and derivatives thereof (O—O Bidentates, O—O Tridentates, O—O Tetradentates) that meet the requirements for use as “narrow band” valence stabilizers for Ce⁺⁴ include, but are not limited to: dithioperoxydicarbonic acid, O-phenyldithioperoxydicarbonic acid; O-benzyldithioperoxydicarbonic acid; O-cyclohexyldithioperoxydicarbonic acid; O-norbornyldithioperoxydicarbonic acid; O,O′-diphenyldithioperoxydicarbonic acid; O,O′-dibenzyldithioperoxydicarbonic acid; O,O′-dicyclohexyldithioperoxydicarbonic acid; and O,O′-dinorbornyldithioperoxydicarbonic acid.

O Valence Stabilizer #2: Examples of imidodiphosphonic acids, hydrazidodiphosphonic acids, bis(imidodiphosphonic acids), bis(hydrazidodiphosphonic acids), poly(imidodiphosphonic acids), poly(hydrazidodiphosphonic acids), and derivatives thereof (O—O Bidentates, O—O Tridentates, O—O Tetradentates) that meet the requirements for use as “narrow band” valence stabilizers for Ce⁺⁴ include, but are not limited to: imidodiphosphonic acid, methylimidodiphosphonic acid, isopropylimidodiphosphonic acid, tert-butylimidodiphosphonic acid, phenylimidodiphosphonic acid, pentafluorophenylimidodiphosphonic acid, benzylimidodiphosphonic acid, cyclohexylimidodiphosphonic acid, norbornylimidodiphosphonic acid, dimethylimidodiphosphonic acid, diisopropylimidodiphosphonic acid, di-tert-butylimidodiphosphonic acid, diphenylimidodiphosphonic acid, di-pentafluorophenylimidodiphosphonic acid, dibenzylimidodiphosphonic acid, dicyclohexylimidodiphosphonic acid, and dinorbornylimidodiphosphonic acid. [Note: the phosphite (P⁺³) valence of the phosphorus atom makes stabilizization of high valence metal ions much more difficult, though still possible.]

O Valence Stabilizer #3: Examples of imidodiphosphonamides, hydrazidodiphosphonamides, bis(imidodiphosphonamides), bis(hydrazidodiphosphonamides), poly(imidodiphosphonamides), and poly(hydrazidodiphosphonamides) (O—O Bidentates, O—O Tridentates, O—O Tetradentates) that meet the requirements for use as “narrow band” valence stabilizers for Ce⁺⁴ include, but are not limited to: imidodiphosphonamide, N-methylimidodiphosphonamide, N-isopropylimidodiphosphonamide, N-tert-butylimidodiphosphonamide, N-phenylimidodiphosphonamide, N-pentafluorophenylimidodiphosphonamide, N-benzylimidodiphosphonamide, N-cyclohexylimidodiphosphonamide, N-norbornylimidodiphosphonamide, N,N′″-dimethylimidodiphosphonamide, N,N′″-diisopropylimidodiphosphonamide, N,N′″-di-tert-butylimidodiphosphonamide, N,N′″-diphenylimidodiphosphonamide, N,N′″-di-pentafluorophenylimidodiphosphonamide, N,N′″-dibenzylimidodiphosphonamide, N,N′″-dicyclohexylimidodiphosphonamide, and N,N′″-dinorbornylimidodiphosphonamide. [Note: the phosphite (P⁺³) valence of the phosphorus atom makes stabilizization of high valence metal ions much more difficult, though still possible.]

O Valence Stabilizer #4: Examples of diphosphonamides, bis(diphosphonamides), and poly(diphosphonamides) (O—O Bidentates, O—O Tridentates, O—O Tetradentates) that meet the requirements for use as “narrow band” valence stabilizers for Ce⁺⁴ include, but are not limited to: diphosphonamide, N-methyldiphosphonamide, N-isopropyldiphosphonamide, N-tert-butyldiphosphonamide, N-phenyldiphosphonamide, N-pentafluorophenyldiphosphonamide, N-benzyldiphosphonamide, N-cyclohexyldiphosphonamide, N-norbornyldiphosphonamide, N,N′″-dimethyldiphosphonamide, N,N′″-diisopropyldiphosphonamide, N,N′″-di-tert-butyldiphosphonamide, N,N′″-diphenyldiphosphonamide, N,N′″-di-pentafluorophenyldiphosphonamide, N,N′″-dibenzyldiphosphonamide, N,N′″-dicyclohexyldiphosphonamide, and N,N′″-dinorbornyldiphosphonamide. [Note: the phosphite (P⁺³) valence of the phosphorus atom makes stabilizization of high valence metal ions much more difficult, though still possible.]

O Valence Stabilizer #5: Examples of carbazates (carbazides), bis(carbazates), and poly(carbazates) (O—O Bidentates, O—O Tridentates, and O—O Tetradentates; or possibly N—O Bidentates, N—O Tridentates, and N—O Tetradentates) that meet the requirements for use as “narrow band” valence stabilizers for Ce⁺⁴ include, but are not limited to: N,N′-dimethylcarbazate; N,N′-di(trifluoromethyl)carbazate; N,N′-diethylcarbazate; N,N′-diphenylcarbazate; N,N′-dibenzylcarbazate; N,N′-di(pentafluorophenyl)carbazate; N,N′-dicyclohexylcarbazate; and N,N′-dinorbornylcarbazate.

O Valence Stabilizer #6: Examples of arsonic acids, bis(arsonic acids), poly(arsonic acids), and derivatives thereof (O—O Bidentates, O—O Tridentates, O—O Tetradentates) that meet the requirements for use as “narrow band” valence stabilizers for Ce⁺⁴ include, but are not limited to: arsonic acid, O-phenylarsonic acid, O-benzylarsonic acid, O-cyclohexylarsonic acid, O-norbornylarsonic acid, O,O-diphenylarsonic acid, O,O-dibenzylarsonic acid, O,O-dicyclohexylarsonic acid, O,O-dinorbornylarsonic acid, and aminophenylarsonic acids.

O Valence Stabilizer #7: Examples of alkyl- and aryl-borates and bis(borates) (O—O Bidentates and O—O Tetradentates) that meet the requirements for use as “narrow band” valence stabilizers for Ce⁺⁴ include, but are not limited to: triethyl borate; diisopropyl borate; diphenyl borate; dibenzyl borate; dicyclohexyl borate; and dinorbornyl borate.

O Valence Stabilizer #8: Examples of alkyl- and aryl-boronates and bis(boronates) (O—O Bidentates and O—O Tetradentates) that meet the requirements for use as “narrow band” valence stabilizers for Ce⁺⁴ include, but are not limited to: diethyl boronate; diisopropyl boronate; diphenyl boronate; dibenzyl boronate; dicyclohexyl boronate; and dinorbornyl boronate. [Note: boronates tend to stabilize lower oxidation states in metal ions.]

O Valence Stabilizer #9: Examples of phosphine P-oxides and amino-substituted phosphine oxides (O Monodentates) that meet the requirements for use as “narrow band” valence stabilizers for Ce⁺⁴ include, but are not limited to: trimethylphosphine oxide (TMPO); triethylphosphine oxide (TEPO); triphenylphosphine oxide (TPhPO); tribenzylphosphine oxide (TBzPO); tricyclohexylphosphine oxide (TcHxPO); and trinorbornylphosphine oxide for phosphine P-oxides; and hexamethylphosphoramide (HMPA); trimorpholinophosphine oxide (TMrPO); tripiperidinophosphine oxide; tripyrrolidinophosphine oxide; and tri(cyclohexylamino)phosphine oxide for amino-substituted phosphine oxides.

O Valence Stabilizer #10: Examples of arsine As-oxides and amino-substituted arsine oxides (O Monodentates) that meet the requirements for use as “narrow band” valence stabilizers for Ce⁺⁴ include, but are not limited to: trimethylarsine oxide (TMAsO); triethylarsine oxide (TEAsO); triphenylarsine oxide (TPhAsO); tribenzylarsine oxide (TBzAsO); tricyclohexylarsine oxide (TcHxAsO); and trinorbornylarsine oxide for arsine As-oxides; and hexamethylarsonamide; trimorpholinoarsine oxide; tripiperidinoarsine oxide; tripyrrolidinoarsine oxide; and tri(cyclohexylamino)arsine oxide for amino-substituted arsine oxides.

O Valence Stabilizer #11a: Examples of 5-membered heterocyclic rings containing one oxygen atom (O monodentate) that meet the requirements for use as “narrow band” valence stabilizers for Ce⁺⁴ include, but are not limited to: furan, dihydrofuran, oxazole, isoxazole, oxadiazole, oxatriazole, oxathiole, benzofuran, benzodihydrofuran, benzoxazole, benzisoxazole, benzoxadiazole (benzofurazan), dibenzofuran, dibenzoxazole, dibenzisoxazole, naphthofuran, naphthoxazole, naphthisoxazole, and naphthoxadiazole.

O Valence Stabilizer #11b: Examples of 5-membered heterocyclic rings containing two oxygen atoms (O monodentate or O—O bidentates) that meet the requirements for use as “narrow band” valence stabilizers for Ce⁺⁴ include, but are not limited to: dioxolane, benzodioxolane, and naphthodioxolane.

O Valence Stabilizer #12a: Examples of 6-membered heterocyclic rings containing one oxygen atom (O monodentate) that meet the requirements for use as “narrow band” valence stabilizers for Ce⁺⁴ include, but are not limited to: dihydropyran, pyran, oxazine, oxadiazine, oxatriazine, oxathiin, benzopyran, benzoxazine, benzoxadiazine, dibenzopyran, naphthopyran, naphthoxazine, and naphthoxadiazine.

O Valence Stabilizer #12b: Examples of 6-membered heterocyclic rings containing two oxygen atoms (O monodentate or O—O bidentates) that meet the requirements for use as “narrow band” valence stabilizers for Ce⁺⁴ include, but are not limited to: dihydrodioxane, dioxane, benzodioxane, dibenzodioxane, and naphthodioxane.

O Valence Stabilizer #13a: Examples of 5-membered heterocyclic rings containing one oxygen atom and having at least one additional oxygen atom binding site not contained in a ring (O monodentates, O—O bidentates, O—O tridentates, O—O tetradentates, or O—O hexadentates) that meet the requirements for use as “narrow band” valence stabilizers for Ce⁺⁴ include, but are not limited to: 2,5-dihydroxy-2,5-dihydrofuran; 2,5-bis(hydroxymethyl)-2,5-dihydrofuran; 2,5-bis(2-hydroxyphenyl)-2,5-dihydrofuran; 2,5-dihydroxyfuran; 2,5-bis(hydroxymethyl)furan; and 2,5-bis(2-hydroxyphenyl)furan.

O Valence Stabilizer #13b: Examples of 5-membered heterocyclic rings containing two oxygen atoms and having at least one additional oxygen atom binding site not contained in a ring (O monodentates, O—O bidentates, O—O tridentates, O—O tetradentates, or O—O hexadentates) that meet the requirements for use as “narrow band” valence stabilizers for Ce⁺⁴ include, but are not limited to: 2-hydroxy-1,3-dioxolane; 2-hydroxymethyl)-1,3-dioxolane; 4,5-dihydroxy-1,3-dioxolane; 4,5-bis(2-hydroxyphenyl-1,3-dioxolane; 2-hydroxybenzodioxolane; and 7-hydroxybenzodioxolane.

O Valence Stabilizer #14a: Examples of 6-membered heterocyclic rings containing one oxygen atom and having at least one additional oxygen atom binding site not contained in a ring (O monodentates, O—O bidentates, O—O tridentates, O—O tetradentates, or O—O hexadentates) that meet the requirements for use as “narrow band” valence stabilizers for Ce⁺⁴ include, but are not limited to: 2,6-dihydroxy-2,5-dihydropyran; 2,6-bis(hydroxymethyl)-2,5-dihydropyran; 2,6-bis(2-hydroxyphenyl)-2,5-dihydropyran; 2,6-dihydroxypyran; 2,6-bis(hydroxymethyl)pyran; 2,6-bis(2-hydroxyphenyl)pyran; 2-hydroxy-1-benzopyran; 8-hydroxy-1-benzopyran; and 1,9-dihydroxydibenzopyran.

O Valence Stabilizer #14b: Examples of 6-membered heterocyclic rings containing two oxygen atoms and having at least one additional oxygen atom binding site not contained in a ring (O monodentates, O—O bidentates, O—O tridentates, O—O tetradentates, or O—O hexadentates) that meet the requirements for use as “narrow band” valence stabilizers for Ce⁺⁴ include, but are not limited to: 2-hydroxy-1,4-dioxane; 2,6-dihydroxy-1,4-dioxane; 2,6-bis(2-hydroxyphenyl)-1,4-dioxane; 2,3-dihydroxy-1,4-benzodioxane; 5,8-dihydroxy-1,4-benzodioxane; 1,8-dihydroxydibenzodioxane; and 1,4,5,8-tetrahydroxydibenzodioxane.

O Valence Stabilizer #15a: Examples of 5-membered heterocyclic rings containing one oxygen atom and having at least one additional oxygen atom binding site contained in a ring (O monodentates, O—O bidentates, O—O tridentates, O—O tetradentates, or O—O hexadentates) that meet the requirements for use as “narrow band” valence stabilizers for Ce⁺⁴ include, but are not limited to: 2,2′-bi-2,5-dihydrofuran; 2,2′,2″-tri-2,5-dihydrofuran; 2,2′-bifuran; 2,2′,2″-trifuran; 1,1′-bis(dibenzofuran); and polyfurans.

O Valence Stabilizer #15b: Examples of 5-membered heterocyclic rings containing two oxygen atoms and having at least one additional oxygen atom binding site contained in a ring (O monodentates, O—O bidentates, O—O tridentates, O—O tetradentates, or O—O hexadentates) that meet the requirements for use as “narrow band” valence stabilizers for Ce⁺⁴ include, but are not limited to: 2,2′-bi-1,3-dioxolane; 4,4′-bi-1,3-dioxolane; 7,7′-bi-1,2-benzodioxolane; and 3,3′-bi-1,2-benzodioxolane.

O Valence Stabilizer #16a: Examples of 6-membered heterocyclic rings containing one oxygen atom and having at least one additional oxygen atom binding site contained in a ring (O monodentates, O—O bidentates, O—O tridentates, O—O tetradentates, or O—O hexadentates) that meet the requirements for use as “narrow band” valence stabilizers for Ce⁺⁴ include, but are not limited to: 2,2′-bi-2,5-dihydropyran; 2,2′,2″-tri-2,5-dihydropyran; 2,2′-bipyran; 2,2′,2″-tripyran; and 1,1′-bis(dibenzopyran).

O Valence Stabilizer #16b: Examples of 6-membered heterocyclic rings containing one oxygen atom and having at least one additional oxygen atom binding site contained in a ring (O monodentates, O—O bidentates, O—O tridentates, O—O tetradentates, or O—O hexadentates) that meet the requirements for use as “narrow band” valence stabilizers for Ce⁺⁴ include, but are not limited to: 2,2′-bi-1,4-dioxane; 2,2′-bi-1,3-dioxane; 5,5′-bi-1,4-benzodioxane; and 2,2′-bi-1,3-benzodioxane.

O Valence Stabilizer #17a: Examples of four-membered macrocyclics, macrobicyclics, and macropolycyclics (including catapinands, cryptands, cyclidenes, and sepulchrates) wherein all binding sites are composed of oxygen (usually ester or hydroxyl groups) and are not contained in component heterocyclic rings (O—O Bidentates, O—O Tridentates, O—O Tetradentates, and O—O Hexadentates) that meet the requirements for use as “narrow band” valence stabilizers for Ce⁺⁴ include, but are not limited to: 8-crown-4; 10-crown-4; 12-crown-4; 14-crown-4; 16-crown-4; 18-crown-4; 20-crown-4; dibenzo-8-crown-4; dibenzo-10-crown-4; dibenzo-12-crown-4; dibenzo-14-crown-4; dibenzo-16-crown-4; dibenzo-18-crown-4; dibenzo-20-crown-4; tetrabenzo-8-crown-4; tetrabenzo-10-crown-4; tetrabenzo-12-crown-4; tetrabenzo-14-crown-4; tetrabenzo-16-crown-4; tetrabenzo-18-crown-4; and tetrabenzo-20-crown-4.

O Valence Stabilizer #17b: Examples of five-membered macrocyclics, macrobicyclics, and macropolycyclics (including catapinands, cryptands, cyclidenes, and sepulchrates) wherein all binding sites are composed of oxygen (usually ester or hydroxyl groups) and are not contained in component heterocyclic rings (O—O Bidentates, O—O Tridentates, O—O Tetradentates, and O—O Hexadentates) that meet the requirements for use as “narrow band” valence stabilizers for Ce⁺⁴ include, but are not limited to: 10-crown-5; 15-crown-5; 20-crown-5; 25-crown-5; pentabenzo-10-crown-5; pentabenzo-15-crown-5; pentabenzo-20-crown-5; and pentabenzo-25-crown-5.

O Valence Stabilizer #17c: Examples of six-membered macrocyclics, macrobicyclics, and macropolycyclics (including catapinands, cryptands, cyclidenes, and sepulchrates) wherein all binding sites are composed of oxygen (usually ester or hydroxyl groups) and are not contained in component heterocyclic rings (O—O Bidentates, O—O Tridentates, O—O Tetradentates, and O—O Hexadentates) that meet the requirements for use as “narrow band” valence stabilizers for Ce⁺⁴ include, but are not limited to: 12-crown-6; 18-crown-6; 24-crown-6; 30-crown-6; 36-crown-6; tribenzo-12-crown-6; tribenzo-18-crown-6; tribenzo-24-crown-6; tribenzo-30-crown-6; tribenzo-36-crown-6; hexabenzo-12-crown-6; hexabenzo-18-crown-6; hexabenzo-24-crown-6; hexabenzo-30-crown-6; and hexabenzo-36-crown-6.

O Valence Stabilizer #17d: Examples of seven-membered macrocyclics, macrobicyclics, and macropolycyclics (including catapinands, cryptands, cyclidenes, and sepulchrates) wherein all binding sites are composed of oxygen (usually ester or hydroxyl groups) and are not contained in component heterocyclic rings (O—O Bidentates, O—O Tridentates, O—O Tetradentates, and O—O Hexadentates) that meet the requirements for use as “narrow band” valence stabilizers for Ce⁺⁴ include, but are not limited to: 14-crown-7; 21-crown-7; 28-crown-7; 35-crown-7; heptabenzo-14-crown-7; heptabenzo-21-crown-7; heptabenzo-28-crown-7; and heptabenzo-35-crown-7.

O Valence Stabilizer #17e: Examples of eight-membered macrocyclics, macrobicyclics, and macropolycyclics (including catapinands, cryptands, cyclidenes, and sepulchrates) wherein all binding sites are composed of oxygen (usually ester or hydroxyl groups) and are not contained in component heterocyclic rings (O—O Bidentates, O—O Tridentates, O—O Tetradentates, and O—O Hexadentates) that meet the requirements for use as “narrow band” valence stabilizers for Ce⁺⁴ include, but are not limited to: 16-crown-8; 24-crown-8; 32-crown-8; 40-crown-8; 48-crown-8; tetrabenzo-16-crown-8; tetrabenzo-24-crown-8; tetrabenzo-32-crown-8; tetrabenzo-40-crown-8; tetrabenzo-48-crown-8; octabenzo-16-crown-8; octabenzo-24-crown-8; octabenzo-32-crown-8; octabenzo-40-crown-8; and octabenzo-48-crown-8.

O Valence Stabilizer #17f: Examples of ten-membered macrocyclics, macrobicyclics, and macropolycyclics (including catapinands, cryptands, cyclidenes, and sepulchrates) wherein all binding sites are composed of oxygen (usually ester or hydroxyl groups) and are not contained in component heterocyclic rings (O—O Bidentates, O—O Tridentates, O—O Tetradentates, and O—O Hexadentates) that meet the requirements for use as “narrow band” valence stabilizers for Ce⁺⁴ include, but are not limited to: 20-crown-10; 30-crown-10; 40-crown-10; 50-crown-10; pentabenzo-20-crown-10; pentabenzo-30-crown-10; pentabenzo-40-crown-10; and pentabenzo-50-crown-10.

O Valence Stabilizer #18: Examples of four-, five-, six-, seven-, eight-, and ten-membered macrocyclics, macrobicyclics, and macropolycyclics (including catapinands, cryptands, cyclidenes, and sepulchrates) wherein all binding sites are composed of oxygen and are contained in component 5-membered heterocyclic rings (O—O Bidentates, O—O Tridentates, O—O Tetradentates, and O—O Hexadentates) that meet the requirements for use as “narrow band” valence stabilizers for Ce⁺⁴ include, but are not limited to: tetrafurans, tetrabenzofurans; pentafurans; pentabenzofurans; hexafurans; hexabenzofurans; heptafurans; heptabenzofurans; octafurans; octabenzofurans; decafurans; and decabenzofurans.

O Valence Stabilizer #19: Examples of four-, five-, six-, seven-, eight-, and ten-membered macrocyclics, macrobicyclics, and macropolycyclics (including catapinands, cryptands, cyclidenes, and sepulchrates) wherein all binding sites are composed of oxygen and are contained in component 6-membered heterocyclic rings (O—O Bidentates, O—O Tridentates, O—O Tetradentates, and O—O Hexadentates) that meet the requirements for use as “narrow band” valence stabilizers for Ce⁺⁴ include, but are not limited to: tetrapyrans, tetrabenzopyrans; pentapyrans; pentabenzopyans; hexapyans; hexabenzopyans; heptapyans; heptabenzopyans; octapyans; octabenzopyans; decapyans; and decabenzopyans.

N—S Valence Stabilizer #1: Examples of thioimidates, dithioimidates, polythioimidates, and derivatives of thioimidic acid (N—S bidentates and N—S tetradentates) that meet the requirements for use as “narrow band” valence stabilizers for Ce⁺⁴ include, but are not limited to: S-methyl formathioimidate; S-ethyl formathioimidate; S-methyl acetathioimidate; S-ethyl acetathioimidate; S-methyl benzthioimidate; S-ethyl benzthioimidate; S-methyl cyclohexylthioimidate; S-ethyl cyclohexylthioimidate; S-methyl pentafluorobenzthioimidate; S-ethyl pentafluorobenzthioimidate; S-methyl 2-pyridylthioimidate; S-ethyl 2-pyridylthioimidate; S,S′-dimethyl benzdithioimidate; S,S′-dimethyl tetrafluorobenzdithioimidate; 2-iminothiolane; and 2-iminotetrahydrothiopyran. [Note: many thioimidate complexes are decomposed by water, but their stability can be enhanced through the use of fluorinated solubility control anions (e.g., PF₆⁻).]

N—S Valence Stabilizer #2: Examples of thioguanylureas, guanidinothioureas, bis(thioguanylureas), bis(guanidinothioureas, poly(thioguanylureas), and poly(guanidinothioureas) (N—S Bidentates and N—S Tetradentates) that meet the requirements for use as “narrow band” valence stabilizers for Ce⁺⁴ include, but are not limited to: thioguanylurea (amidinothiourea); guanidinothiourea; methylthioguanylurea; ethylthioguanylurea; isopropylthioguanylurea; butylthioguanylurea; benzylthioguanylurea; phenylthioguanylurea; tolylthioguanylurea; naphthylthioguanylurea; cyclohexylthioguanylurea; norbornylthioguanylurea; adamantylthioguanylurea; dimethylthioguanylurea; diethylthioguanylurea; diisopropylthioguanylurea; dibutylthioguanylurea; dibenzylthioguanylurea; diphenylthioguanylurea; ditolylthioguanylurea; dinaphthylthioguanylurea; dicyclohexylthioguanylurea; dinorbornylthioguanylurea; diadamantylthioguanylurea; ethylenebis(thioguanylurea); propylenebis(thioguanylurea); phenylenebis(thioguanylurea); piperazinebis(thioguanylurea); oxalylbis(thioguanylurea); malonylbis(thioguanylurea); succinylbis(thioguanylurea); and phthalylbis(thioguanylurea). [Note: thioguanylureas generally tend to favor lower oxidation states in complexed metals.]

N—S Valence Stabilizer #3: Examples of amidinothioamides, guanidinothioamides, bis(amidinothioamides), bis(guanidinothioamides), poly(amidinothioamides), and poly(guanidinothioamides) (including both N-amidinothioamides and 2-amidinothioacetamides) (N—S Bidentates, N—S Tridentates, and N—S Tetradentates) that meet the requirements for use as “narrow band” valence stabilizers for Ce⁺⁴ include, but are not limited to: amidinothioacetamide; guanidinothioamide, amidinothiopropanamide; amidinothiobutanamide; amidinothiobenzamide; amidinothiotoluamide; amidinothiocyclohexamide; N-methylamidinothioacetamide; N-ethylamidinothiopropanamide; N-propylamidinothiobutanamide; N-phenylamidinothiobenzamide; N-tolylamidinothiotoluamide; N-cyclohexylamidinothiocyclohexamide; bis(amidinothiooxamide); bis(amidinothiomalonamide); bis(amidinothiosuccinamide); bis(amidinothiophthalamide); 2-amidinothioacetamide (thiomalonamamidine); N-methyl-2-amidinothioacetamide; N-ethyl-2-amidinothioacetamide; N-phenyl-2-amidinothioacetamide; N-benzyl-2-amidinothioacetamide; N-cyclohexyl-2-amidinothioacetamide; N,N′-dimethyl-2-amidinothioacetamide; N,N′-diethyl-2-amidinothioacetamide; N,N′-diphenyl-2-amidinothioacetamide; N,N′-dibenzyl-2-amidinothioacetamide; and N,N′-dicyclohexyl-2-amidinothioacetamide. [Note: amidinothioamides generally tend to favor lower oxidation states in complexed metals.]

N—S Valence Stabilizer #4: Examples of imidoylthioamides, bis(imidoylthioamides), and poly(imidoylthioamides) (N—S Bidentates, N—S Tridentates, and N—S Tetradentates) that meet the requirements for use as “narrow band” valence stabilizers for Ce⁺⁴ include, but are not limited to: acetimidoylthioacetamide; acetimidoylthiopropanamide; acetimidoylthiobutanamide; acetimidoylthiobenzamide; acetimidolylthiotoluamide; acetimidoylthiocyclohexamide; propimidoylthiopropanamide; butimidoylthiobutanamide; benzimidoylthiobenzamide; ethylenebis(acetimidoylthioacetamide); propylenebis(acetimidoylthioacetamide); and phenylenebis(acetimidoylthioacetamide). [Note: imidoylthioamides generally tend to favor lower oxidation states in complexed metals.]

N—S Valence Stabilizer #5: Examples of thioureas, bis(thioureas), and poly(thioureas), including thiourylene complexes (N—S bidentates and N—S tetradentates) that meet the requirements for use as “narrow band” valence stabilizers for Ce⁺⁴ include, but are not limited to: thiourea; methylthiourea; ethylthiourea; isopropylthiourea; benzylthiourea; phenylthiourea; cyclohexylthiourea; naphthylthiourea (ntu); biphenylthiourea; norbornylthiourea; adamantylthiourea; N,N′-dimethylthiourea; N,N′-diethylthiourea; N,N′-diisopropylthiourea; N,N′-dibenzylthiourea; N,N′-dicyclohexylthiourea; N,N′dinapthylthiourea; N,N′-dibiphenylthiourea; N,N′-dinorbornylthiourea; N,N′-diadamantylthiourea; tetramethylthiourea; ethylenethiourea (2-imidazolidinethione)(etu); 4,5-dihydroxy-2-imidazolinethione (dhetu); propylenethiourea; N-(thiazol-2-yl)thiourea; diphenylphosphinothioyl thioureas; allylthiourea; N-allyl-N′-pyridylthiourea; N-allyl-N′-anisylthiourea; N-allyl-N′-naphthylthiourea; N-allyl-N′-phenylthiourea; thioglycoluril (acetylenethiourea); and bis(pyridylmethyl)thiourea. [Note: thioureas generally tend to favor lower oxidation states in complexed metals.]

N—S Valence Stabilizer #6: Examples of thiocarboxamides, bis(thiocarboxamides), and poly(thiocarboxamides), (N—S bidentates, N—S tridentates, and N—S tetradentates) that meet the requirements for use as “narrow band” valence stabilizers for Ce⁺⁴ include, but are not limited to: thiocarbamide (tu); thioacetamide (taa); thiopropionamide; thiobutanamide; thiobenzamide (1-phenylthioformamide)(tba); 1-naphthylthioformamide; 1-cyclohexylthioformamide); 1-norbornylthioformamide; 1-adamantylthioformamide; N,N-dimethylthioformamide; N,N-dimethylthioacetamide; pyridine-2-thiocarboxamide (thiopicolinamide); pyrazine-2,3-dithiocarboxamide; thionicotinamide; 2-thiophenethiocarboxamide; N,N-dimethylthiobenzamide; N-ethylthiocarbamide (N-etu); tetramethylthiocarbamide (tmtu); 2-thioacetamidothiazole (tatz); and polythioacrylamides. [Note: thiocarboxamides generally tend to favor lower oxidation states in complexed metals.]

N—S Valence Stabilizer #7: Examples of imidosulfurous diamides and bis(imidosulfurous diamides) (N—S Bidentates, N—S Tridentates, and N—S Tetradentates) that meet the requirements for use as “narrow band” valence stabilizers for Ce⁺⁴ include, but are not limited to: N,N′-diphenylimidosulfurous diamide; N,N′-dibenzylimidosulfurous diamide; and phenylenebis(imidosulfurous diamide). [Note: these complexes tend to hydrolyze unless stabilized with a fluorinated anionic solubility control agent. The sulfite (S⁺⁴) valence of the sulfur atom makes stabilizization of high valence metal ions much more difficult, though still possible.]

N—S Valence Stabilizer #8: Examples of sulfurdiimines, bis(sulfurdiimines), and poly(sulfurdiimines) (N—S Bidentates, N—S Tridentates, and N—S Tetradentates) that meet the requirements for use as “narrow band” valence stabilizers for Ce⁺⁴ include, but are not limited to: N,N′-diphenylsulfurdiimine; N,N′-dibenzylsulfurdiimine; and phenylenebis(sulfurdiimine). [Note: these complexes tend to hydrolyze unless stabilized with a fluorinated anionic solubility control agent. The sulfite (S⁺⁴) valence of the sulfur atom makes stabilizization of high valence metal ions much more difficult, though still possible.]

N—S Valence Stabilizer #9: Examples of phosphonimidothioic acid, phosphonimidodithioic acid, bis(phosphonimidothioic acid); bis(phosphonimidodithioic acid), and derivatives thereof (N—S Bidentates, N—S Tetradentates) that meet the requirements for use as “narrow band” valence stabilizers for Ce⁺⁴ include, but are not limited to: phosphonimidothioic acid, phosphonimidodithioic acid; O-phenylphosphonimidothioic acid; O-benzylphosphonimidothioic acid; O-cyclohexylphosphonimidothioic acid; O-norbornylphosphonimidothioic acid; S-phenylphosphonimidodithioic acid; S-benzylphosphonimidodithioic acid; S-cyclohexylphosphonimidodithioic acid; and S-norbornylphosphonimidodithioic acid. [Note: the phosphite (P⁺³) valence of the phosphorus atom makes stabilizization of high valence metal ions much more difficult, though still possible.]

N—S Valence Stabilizer #10: Examples of phosphonothioic diamides, bis(phosphonothioic diamides), and poly(phosphonothioic diamides) (N—S Bidentates and N—S Tetradentates) that meet the requirements for use as “narrow band” valence stabilizers for Ce⁺⁴ include, but are not limited to: phosphonothioic diamide, phosphonothioic dihydrazide, phosphonamidothioic hydrazide, N-phenylphosphonothioic diamide, N-benzylphosphonothioic diamide, N-cyclohexylphosphonothioic diamide, and N-norbornylphosphonothioic diamide. [Note: the phosphite (P⁺³) valence of the phosphorus atom makes stabilizization of high valence metal ions much more difficult, though still possible.]

N—S Valence Stabilizer #11: Examples of phosphonamidothioic acid, phosphonamidimidodithioic acid, bis(phosphonamidothioic acid), bis(phosphonamidimidodithioic acid), poly(phosphonamidothioic acid), and poly(phosphonamidimidodithioic acid), and derivatives thereof (N—S Bidentates and N—S Tetradentates) that meet the requirements for use as “narrow band” valence stabilizers for Ce⁺⁴ include, but are not limited to: phosphonamidothioic acid, phosphonamidimidodithioic acid, phosphonohydrazidodithioic acid, phosphonohydrazidothioic acid, S-phenylphosphonamidimidodithioic acid, S-benzylphosphonamidimidodithioic acid, S-cyclohexylphosphonamidimidodithioic acid, and S-norbornylphosphonamidimidodithioic acid. [Note: the phosphite (P⁺³) valence of the phosphorus atom makes stabilizization of high valence metal ions much more difficult, though still possible.]

N—S Valence Stabilizer #12: Examples of beta-aminothiones (N-substituted 3-amino-2-propenethioaldehydes), bis(beta-aminothiones), and poly(beta-aminothiones) (N—S Bidentates and N—S Tetradentates) that meet the requirements for use as “narrow band” valence stabilizers for Ce⁺⁴ include, but are not limited to: 4-methylamino-3-penten-2-thione; 4-ethylamino-3-penten-2-thione; 4-isopropylamino-3-penten-2-thione; 4-phenylamino-3-penten-2-thione; 4-naphthylamino-3-penten-2-thione; 4-cyclohexylamino-3-penten-2-thione; 4-norbornylamino-3-penten-2-thione; 4-hydroxyamino-3-penten-2-thione; 3-methylamino-1-phenyl-2-butenethioaldehydel; 3-ethylamino-1-phenyl-2-butenethioaldehyde; 3-isopropylamino-1-phenyl-2-butenethioaldehyde; 3-phenylamino-1-phenyl-2-butenethioaldehyde; 3-naphthylamino-1-phenyl-2-butenethioaldehyde; 3-cyclohexylamino-1-phenyl-2-butenethioaldehyde; 3-norbornylamino-1-phenyl-2-butenethioaldehyde; 3-hydroxyamino-1-phenyl-2-butenethioaldehyde; 3-phenylamino-1,3-diphenyl-2-propenethioaldehyde; 3-cyclohexylamino-1,3-dicyclohexyl-2-propenethioaldehyde; and 3-norbornylamino-1,3-dinorbornyl-2-propenethioaldehyde.

N—S Valence Stabilizer #13: Examples of 3-aminothioacrylamides (3-amino-2-thiopropenamides), 3,3-diaminothioacrylamides, bis(3-aminothioacrylamides), bis(3,3-diaminothioacrylamides), poly(3-aminothioacrylamides), and poly(3,3-diaminothioacrylamides) (N—S Bidentates and N—S Tetradentates) that meet the requirements for use as “narrow band” valence stabilizers for Ce⁺⁴ include, but are not limited to: 3-methylaminothioacrylamide; 3-ethylaminothioacrylamide, 3-isopropylaminothioacrylamide, 3-phenylaminothioacrylamide; 3-naphthylaminothioacrylamide; 3-cyclohexylaminothioacrylamide; 3-norbornylaminothioacrylamide; 3-hydroxyaminothioacrylamide; N-methyl-3-methylaminothioacrylamide; N-ethyl-3-ethylaminothioacrylamide, N-isopropyl-3-isopropylaminothioacrylamide, N-phenyl-3-phenylaminothioacrylamide; N-naphthyl-3-naphthylaminothioacrylamide; N-cyclohexyl-3-cyclohexylaminothioacrylamide; N-norbornyl-3-norbornylaminothioacrylamide; 3-amino-3-methylaminothioacrylamide; 3-amino-3-ethylaminothioacrylamide, 3-amino-3-isopropylaminothioacrylamide, 3-amino-3-phenylaminothioacrylamide; 3-amino-3-naphthylaminothioacrylamide; 3-amino-3-cyclohexylaminothioacrylamide; 3-amino-3-norbornylaminothioacrylamide; and 3-amino-3-hydroxyaminothioacrylamide.

N—S Valence Stabilizer #14: Examples of 3-aminothioacrylic acids (3-amino-2-thiopropenoic acids), 3-mercapto-3-aminothioacrylic acids, bis(3-aminothioacrylic acids), bis(3-mercapto-3-aminothioacrylic acids), poly(3-aminothioacrylic acids), and poly(3-mercapto-3-aminothioacrylic acids), and derivatives thereof (N—S Bidentates and N—S Tetradentates) that meet the requirements for use as “narrow band” valence stabilizers for Ce⁺⁴ include, but are not limited to: 3-aminothioacrylic acid; 3-mercapto-3-aminothioacrylic acid; 3-methylaminothioacrylic acid; 3-ethylaminothioacrylic acid; 3-isopropylaminothioacrylic acid; 3-phenylaminothioacrylic acid; 3-naphthylaminothioacrylic acid; 3-cyclohexylaminothioacrylic acid; 3-norbornylaminothioacrylic acid; 3-hydroxyaminothioacrylic acid; methyl 3-methylaminothioacrylate; ethyl 3-ethylaminothioacrylate; isopropyl 3-isopropylaminothioacrylate; benzyl 3-phenylaminothioacrylate; naphthyl 3-naphthylaminothioacrylate; cyclohexyl 3-cyclohexylaminothioacrylate; and norbornyl 3-norbornylaminothioacrylate.

N—S Valence Stabilizer #15: Examples of N-thioacyl benzylidenimines, bis(N-thioacyl benzylidenimines), and poly(N-thioacyl benzylidenimines) (N—S Bidentates and N—S Tetradentates) that meet the requirements for use as “narrow band” valence stabilizers for Ce⁺⁴ include, but are not limited to: N-thioformyl benzylidenimine, N-thioacetyl benzylidenimine; N-thiobenzoyl benzylidenimine; and N-pentafluorothiobenzoyl benzylidenimine.

N—S Valence Stabilizer #16: Examples of thiocarbonyl oximes, bis(thiocarbonyl oximes), and poly(thiocarbonyl oximes) (N—S Bidentates, N—S Tridentates, and N—S Tetradentates) that meet the requirements for use as “narrow band” valence stabilizers for Ce⁺⁴ include, but are not limited to: butane-3-thione-2-one monoxime); and diphenylethane-2-thione-1-one monoxime.

N—S Valence Stabilizer #17: Examples of mercapto oximes, bis(mercapto oximes), and poly(mercapto oximes) (including 2-sulfur heterocyclic oximes) (N—S Bidentates, N—S Tridentates, N—S Tetradentates, and N—S Hexadentates) that meet the requirements for use as “narrow band” valence stabilizers for Ce⁺⁴ include, but are not limited to: 3-mercaptobutan-2-one oxime; 4-mercaptohexan-3-one oxime; (1,2-diphenyl-2-mercaptoethanone oxime); 1,2-di(trifluoromethyl)-2-mercaptoethanone oxime; 1,2-dicyclohexyl-2-mercaptoethanone oxime; 1,2-dinorbornyl-2-mercaptoethanone oxime; 2-mercaptobenzaldehyde oxime; 2-mercapto-1-naphthaldehyde oxime; thiophene-2-aldoxime; methyl 2-thiophenyl ketoxime; and phenyl 2-thiophenyl ketoxime.

N—S Valence Stabilizer #18: Examples of 2-nitrothiophenols (2-nitrobenzenethiols) (N—S Bidentates) that meet the requirements for use as “narrow band” valence stabilizers for Ce⁺⁴ include, but are not limited to: 2-nitrothiophenol; 2,3-dinitrothiophenol; 2,4-dinitrothiophenol; 2,5-dinitrothiophenol; 2,6-dinitrothiophenol; 1-nitro-2-naphthalenethiol; and 2-nitro-1-naphthalenethiol.

N—S Valence Stabilizer #19: Examples of 2-nitrilothiophenols (2-nitrilobenzenethiols) (N—S Bidentates) that meet the requirements for use as “narrow band” valence stabilizers for Ce⁺⁴ include, but are not limited to: 2-cyanothiophenol; 2,3-dicyanothiophenol; 2,4-dicyanothiophenol; 2,5-dicyanothiophenol; 2,6-dicyanothiophenol; 1-cyano-2-naphthalenethiol; and 2-cyano-1-naphthalenethiol.

N—S Valence Stabilizer #20: Examples of thiohydrazides, bis(thiohydrazides), and poly(thiohydrazides) (N—S Bidentates and N—S Tetradentates) that meet the requirements for use as “narrow band” valence stabilizers for Ce⁺⁴ include, but are not limited to: thioformic hydrazide; thioacetic hydrazide; thiopropionic hydrazide; thiobenzoic hydrazide; thiophthalhydrazide; thiosalicylic hydrazide; thionaphthoic hydrazides; thionorbornaneacetic hydrazide; thionicotinic hydrazide; and thioisonicotinic hydrazide. [Note: thiohydrazides prefer complexation with lower oxidation states in metal ions.]

N—S Valence Stabilizer #21: Examples of thiosemicarbazides, bis(thiosemicarbazides), and poly(thiosemicarbazides) (N—S Bidentates, N—S Tetradentates, and N—S Hexadentates) that meet the requirements for use as “narrow band” valence stabilizers for Ce⁺⁴ include, but are not limited to: thiosemicarbazide (tsc); thiosemicarbazide diacetic acid (tsda); 1-methylthiosemicarbazide (1 mts); 1-ethylthiosemicarbazide; 1-isopropylthiosemicarbazide; 1-phenylthiosemicarbazide (pts)(cryogenine); 1-benzylthiosemicarbazide; 1-cyclohexylthiosemicarbazide; 1-norbornylthiosemicarbazide; 4-methylthiosemicarbazide (4mts); 4-ethylthiosemicarbazide; 4-isopropylthiosemicarbazide; 4-phenylthiosemicarbazide (4-pts); 4-benzylthiosemicarbazide; 4-cyclohexylthiosemicarbazide; 4-norbornylthiosemicarbazide; nicotinic thiosemicarbazide; isonicotinic thiosemicarbazide; and 4-phenyl-1-benzenesulfonyl-3-thiosemicarbazide (pbst). [Note: thiosemicarbazides prefer complexation with lower oxidation states in metal ions.]

N—S Valence Stabilizer #22: Examples of five-, seven-, or nine-membered macrocyclics, macrobicyclics, and macropolycyclics (including catapinands, cryptands, cyclidenes, and sepulchrates) wherein all binding sites are composed of nitrogen (usually amine or imine groups) or sulfur (usually thiols, mercaptans, or thiocarbonyls) and are not contained in component heterocyclic rings (N—S Tridentates, N—S Tetradentates, and N—S Hexadentates) that meet the requirements for use as “narrow band” valence stabilizers for Ce⁺⁴ include, but are not limited to: triazadithiacyclodecane ([10]aneS₂N₃); triazadithiacycloundecane ([11]aneS₂N₃); triazadithiacyclododecane ([12]aneS₂N₃); triazadithiacyclotridecane ([13]aneS₂N₃); triazadithiacyclotetradecane ([14]aneS₂N₃); triazadithiacyclopentadecane ([15]aneS₂N₃); thiomorpholine; and thiazolidine.

N—S Valence Stabilizer #23: Examples of five- or seven-membered macrocyclics, macrobicyclics, and macropolycyclics (including catapinands, cryptands, cyclidenes, and sepulchrates) wherein all binding sites are composed of nitrogen or sulfur and are contained in component heterocyclic rings (N—S Bidentates, N—S Tridentates, N—S Tetradentates, or N—S Hexadentates) that meet the requirements for use as “narrow band” valence stabilizers for Ce⁺⁴ include, but are not limited to: dithiopyrantripyridines; dithiophenetripyrroles; trithiopyrantetrapyridines; and trithiophenetetrapyrroles.

N—S Valence Stabilizer #24: Examples of five-, seven-, or nine-membered macrocyclics, macrobicyclics, and macropolycyclics (including catapinands, cryptands, cyclidenes, and sepulchrates) wherein all binding sites are composed of nitrogen or sulfur and are contained in a combination of heterocyclic rings and amine, imine, thiol, mercapto, or thiocarbonyl groups (N—S Bidentates, N—S Tridentates, N—S Tetradentates, or N—S Hexadentates) that meet the requirements for use as “narrow band” valence stabilizers for Ce⁺⁴ include, but are not limited to: azathiapentaphyrins; diazadithiapentaphyrins; azathiapentaphyrins; and diazadithiapentaphyrins.

N—O Valence Stabilizer #1: Examples of imidates, diimidates, polyimidates, and derivatives of imidic acid (N—O bidentates and N—O tetradentates) that meet the requirements for use as “narrow band” valence stabilizers for Ce⁺⁴ include, but are not limited to: O-methyl formimidate; O-ethyl formimidate; O-methyl acetimidate; O-ethyl acetimidate; O-methyl benzimidate; O-ethyl benzimidate; O-methyl cyclohexylimidate; methyl cyclohexylimidate; O-methyl pentafluorobenzimidate; O-ethyl pentafluorobenzimidate; O-methyl 2-pyridylimidate; O-ethyl 2-pyridylimidate; O,O′-dimethyl benzdiimidate; O,O′-dimethyl tetrafluorobenzdiimidate; 2-iminotetrahydrofuran; and 2-iminotetrahydropyran. [Note: most imidate complexes are decomposed by water, but their stability can be enhanced through the use of fluorinated solubility control anions (e.g., PF₆⁻).]

N—O Valence Stabilizer #2: Examples of pseudoureas, bis(pseudoureas), and poly(pseudoureas) (N—O bidentates and N—O tetradentates) that meet the requirements for use as “narrow band” valence stabilizers for Ce⁺⁴ include, but are not limited to: O-methyl pseudourea; O-ethyl pseudourea; O-isopropyl pseudourea; O-benzyl pseudourea; O-cyclohexyl pseudourea; O-norbornyl pseudourea; O-pentafluorobenzyl pseudourea; N-methyl pseudourea; N-ethyl pseudourea; N-isopropyl pseudourea; N-benzyl pseudourea; N-cyclohexyl pseudourea; N-norbornyl pseudourea; and N-pentafluorobenzyl pseudourea.

N—O Valence Stabilizer #3: Examples of 2-amidinoacetates, bis(2-amidinoacetates), and poly(2-amidinoacetates) (N—O Bidentates and N—O Tetradentates) that meet the requirements for use as “narrow band” valence stabilizers for Ce⁺⁴ include, but are not limited to: N-methyl-2-amidinoacetate; O-methyl-2-amidinoacetate; N-benzyl-2-amidinoacetate; and O-benzyl-2-amidinoacetate. [Note: many 2-amidinoacetates tend to hydrolyze in water. This can be minimized through the use of fluorinated solubility control anions such as PF₆⁻.]

N—O Valence Stabilizer #4: Examples of ureas, bis(ureas), and poly(ureas), including urylene complexes (N—O bidentates and N—O tetradentates) that meet the requirements for use as “narrow band” valence stabilizers for Ce⁺⁴ include, but are not limited to: urea; methylurea; ethylurea; isopropylurea; benzylurea; cyclohexylurea; naphthylurea; biphenylurea; norbornylurea; adamantylurea; N,N′-dimethylurea; N,N′-diethylurea; N,N′-diisopropylurea; N,N′-dibenzylurea; N,N′-dicyclohexylurea; N,N′dinapthylurea; N,N′-dibiphenylurea; N,N′-dinorbornylurea; N,N′-diadamantylurea; ethyleneurea (2-imidazolidone); propyleneurea; glycoluril (acetyleneurea); and N,N ′-bis(4-nitrophenyl)urea.

N—O Valence Stabilizer #5: Examples of phosphonimidic acid, bis(phosphonimidic acid), poly(phosphonimidic acid), and derivatives thereof (N—O Bidentates and N—O Tetradentates) that meet the requirements for use as “narrow band” valence stabilizers for Ce⁺⁴ include, but are not limited to: phosphonimidic acid; O-phenylphosphonimidic acid; O-benzylphosphonimidic acid; O-cyclohexylphosphonimidic acid; and O-norbornylphosphonimidic acid. [Note: the phosphite (P⁺³) valence of the phosphorus atom makes stabilizization of high valence metal ions much more difficult, though still possible.]

N—O Valence Stabilizer #6: Examples of phosphonamidic acid, phosphonic diamide, bis(phosphonamidic acid), bis(phosphonic diamide), poly(phosphonamidic acid), poly(phosphonic diamide), and derivatives thereof (N—O Bidentates and N—O Tetradentates) that meet the requirements for use as “narrow band” valence stabilizers for Ce⁺⁴ include, but are not limited to: phosphonamidic acid, phosphonic diamide, phosphonamidic hydrazide, phosphonic dihydrazide, O-phenylphosphonamidic acid, O-benzylphosphonamidic acid, O-cyclohexylphosphonamidic acid, O-norbornylphosphonimidic acid, N-benzylphosphonic diamide, N-phenylphosphonic diamide, N-cyclohexylphosphonic diamide, and N-norbornylphosphonic diamide. [Note: the phosphite (P⁺³) valence of the phosphorus atom makes stabilizization of high valence metal ions much more difficult, though still possible.]

N—O Valence Stabilizer #7: Examples of beta-ketoamines (N-substituted 3-amino-2-propenals), bis(beta-ketoamines), and poly(beta-ketoamines) (N—O Bidentates and N—O Tetradentates) that meet the requirements for use as “narrow band” valence stabilizers for Ce⁺⁴ include, but are not limited to: 4-methylamino-3-penten-2-one; 4-ethylamino-3-penten-2-one; 4-isopropylamino-3-penten-2-one; 4-phenylamino-3-penten-2-one; 4-naphthylamino-3-penten-2-one; 4-cyclohexylamino-3-penten-2-one; 4-norbornylamino-3-penten-2-one; 4-hydroxyamino-3-penten-2-one; 3-methylamino-1-phenyl-2-butenal; 3-ethylamino-1-phenyl-2-butenal; 3-isopropylamino-1-phenyl-2-butenal; 3-phenylamino-1-phenyl-2-butenal; 3-naphthylamino-1-phenyl-2-butenal; 3-cyclohexylamino-1-phenyl-2-butenal; 3-norbornylamino-1-phenyl-2-butenal; 3-hydroxyamino-1-phenyl-2-butenal; 3-phenylamino-1,3-diphenyl-2-propenal; 3-cyclohexylamino-1,3-dicyclohexyl-2-propenal; 3-norbornylamino-1,3-dinorbornyl-2-propenal; 2,2′-pyridil; alpha-pyridoin; 4-aminoantipyrine (aap); beta-phenylaminopropiophenone; and polyaminoquinones (PAQs).

N—O Valence Stabilizer #8: Examples of 3-aminoacrylamides (3-amino-2-propenamides), 3,3-diaminoacrylamides, bis(3-aminoacrylamides), bis(3,3-diaminoacrylamides), poly(3-aminoacrylamides), and poly(3,3-diaminoacrylamides) (N—O Bidentates and N—O Tetradentates) that meet the requirements for use as “narrow band” valence stabilizers for Ce⁺⁴ include, but are not limited to: 3-methylaminoacrylamide; 3-ethylaminoacrylamide, 3-isopropylaminoacrylamide, 3-phenylaminoacrylamide; 3-naphthylaminoacrylamide; 3-cyclohexylaminoacrylamide; 3-norbornylaminoacrylamide; 3-hydroxyaminoacrylamide; N-methyl-3-methylaminoacrylamide; N-ethyl-3-ethylaminoacrylamide, N-isopropyl-3-isopropylaminoacrylamide, N-phenyl-3-phenylaminoacrylamide; N-naphthyl-3-naphthylaminoacrylamide; N-cyclohexyl-3-cyclohexylaminoacrylamide; N-norbornyl-3-norbornylaminoacrylamide; 3-amino-3-methylaminoacrylamide; 3-amino-3-ethylaminoacrylamide, 3-amino-3-isopropylaminoacrylamide, 3-amino-3-phenylaminoacrylamide; 3-amino-3-naphthylaminoacrylamide; 3-amino-3-cyclohexylaminoacrylamide; 3-amino-3-norbornylaminoacrylamide; and 3-amino-3-hydroxyaminoacrylamide.

N—O Valence Stabilizer #9: Examples of 3-aminoacrylic acids (3-amino-2-propenoic acids), 3-hydroxy-3-aminoacrylic acids, bis(3-aminoacrylic acids), bis(3-hydroxy-3-aminoacrylic acids), poly(3-aminoacrylic acids), and poly(3-hydroxy-3-aminoacrylic acids), and derivatives thereof (N—O Bidentates and N—O Tetradentates) that meet the requirements for use as “narrow band” valence stabilizers for Ce⁺⁴ include, but are not limited to: 3-aminoacrylic acid; 3-hydroxy-3-aminoacrylic acid; 3-methylaminoacrylic acid; 3-ethylaminoacrylic acid; 3-isopropylaminoacrylic acid; 3-phenylaminoacrylic acid; 3-naphthylaminoacrylic acid; 3-cyclohexylaminoacrylic acid; 3-norbornylaminoacrylic acid; 3-hydroxyaminoacrylic acid; methyl 3-methylaminoacrylate; ethyl 3-ethylaminoacrylate; isopropyl 3-isopropylaminoacrylate; benzyl 3-phenylaminoacrylate; naphthyl 3-naphthylaminoacrylate; cyclohexyl 3-cyclohexylaminoacrylate; and norbornyl 3-norbornylaminoacrylate.

N—O Valence Stabilizer #10: Examples of N-acyl benzylidenimines, bis(N-acyl benzylidenimines), and poly(N-acyl benzylidenimines) (N—O Bidentates and N—O Tetradentates) that meet the requirements for use as “narrow band” valence stabilizers for Ce⁺⁴ include, but are not limited to: N-formyl benzylidenimine, N-acetyl benzylidenimine; N-benzoyl benzylidenimine; and N-pentafluorobenzoyl benzylidenimine.

N—O Valence Stabilizer #11: Examples of 2-nitroanilines (N—O Bidentates) that meet the requirements for use as “narrow band” valence stabilizers for Ce⁺⁴ include, but are not limited to: 2-nitroaniline; 2,6-dintroaniline; 2-nitrophenylenediamine; 2-nitrophenylenetriamine; 2-nitro-1-aminonaphthalene; 1-nitro-2-aminonaphthalene; nitrodiaminonaphthalene; and dipicrylamine.

N—O Valence Stabilizer #12: Examples of 2-nitrilophenols (N—O Bidentates) that meet the requirements for use as “narrow band” valence stabilizers for Ce⁺⁴ include, but are not limited to: 2-cyanophenol; 2,3-dicyanophenol; 2,4dicyanophenol; 2,5-dicyanophenol; 2,6-dicyanophenol; 1-cyano-2-naphthol; and 2-cyano-1-naphthol. Also includes acylcyanamides.

N—O Valence Stabilizer #13: Examples of amine N-oxides and N-diazine oxides (azoxy compounds) (N—O Bidentates, N—O Tridentates, and N—O Tetradentates) that meet the requirements for use as “narrow band” valence stabilizers for Ce⁺⁴ include, but are not limited to: pyridine N-oxide (pyNO or PNO); picoline N-oxide (picNO); lutidine N-oxide (lutNO or LNO); collidine N-oxide (collNO or CNO); quinoline N-oxide (QuinNO or QNO); isoquinoline N-oxide (isoQuinNO or IQNO); acridine N-oxide (AcrNO or ANO); picolinic acid N-oxide (PicANO); pyridinethiolate N-oxide (PTNO); adenine N-oxide; adenosine N-oxide; 1,10-phenanthroline mono-N-oxide (phenNO); 1,10-phenanthroline N,N-dioxide (phen2NO); bipyridyl mono-N-oxide (bipyNO); bipyridyl N,N-dioxide (bipy2NO); pyrazine mono-N-oxide (pyzNO); pyrazine N,N-dioxide (pyz2NO); pyrimidine mono-N-oxide (pymNO); pyrimidine N,N-dioxide (pym2NO); pyridazine mono-N-oxide (pdzNO); pyridazine N,N-dioxide (pdz2NO); quinoxaline mono-N-oxide (qxNO); quinoxaline N,N-dioxide (qx2NO); phenazine mono-N-oxide (phzNO); phenazine N,N-dioxide (phz2NO); 2,3-di(pyridine N-oxide)quinoxaline (dpoq); inosine N-oxide; 4,4′-bipyridine N,N-dioxide; 1-hydroxypyrazole 2-oxide; 1-hydroxyimidazole 3-oxide; 2,2′-diimidazyl 3,3′-dioxide; imidazole N-oxides (i.e., 1-hydroxyimidazole-3-N-oxides); N-benzylidine aniline N-oxide; N-(naphthylidene) aniline N-oxide; N-(hydroxybenzylidene) aniline N-oxide; and 2,2′-dibenzimidazyl 3,3′-dioxide (indigo N,N-dioxide) for amine N-oxides; and azoxybenzene; phthalazine N-oxide; benzocinnoline N-oxide; and bipyrazinyl N-oxide as N-diazine oxide examples.

N—O Valence Stabilizer #14: Examples of hydrazides, bis(hydrazides), and poly(hydrazides) (N—O Bidentates and N—O Tetradentates) that meet the requirements for use as “narrow band” valence stabilizers for Ce⁺⁴ include, but are not limited to: formic hydrazide; acetic hydrazide; propionic hydrazide; benzoic hydrazide; phthalhydrazide; salicylic hydrazide; naphthoic hydrazides; norbornaneacetic hydrazide; nicotinic hydrazide; and isonicotinic hydrazide (isoniazid). [Note: hydrazides prefer complexation with lower oxidation states in metal ions.]

N—O Valence Stabilizer #15: Examples of semicarbazides, bis(semicarbazides), and poly(semicarbazides) (N—O Bidentates, N—O Tetradentates, and N—O Hexadentates) that meet the requirements for use as “narrow band” valence stabilizers for Ce⁺⁴ include, but are not limited to: semicarbazide (sc); semicarbazide diacetic acid (sda); 1-methylsemicarbazide; 1-ethylsemicarbazide; 1-isopropylsemicarbazide; 1-phenylsemicarbazide; 1-benzylsemicarbazide; 1-cyclohexylsemicarbazide; 1-norbornylsemicarbazide; 4-methylsemicarbazide; 4-ethylsemicarbazide; 4-isopropylsemicarbazide; 4-phenylsemicarbazide; 4-benzylsemicarbazide; 4-cyclohexylsemicarbazide; 4-norbornylsemicarbazide; nicotinic semicarbazide; and isonicotinic semicarbazide. [Note: semicarbazides prefer complexation with lower oxidation states in metal ions.]

N—O Valence Stabilizer #16: Examples of five-, seven-, or nine-membered macrocyclics, macrobicyclics, and macropolycyclics (including catapinands, cryptands, cyclidenes, and sepulchrates) wherein all binding sites are composed of nitrogen (usually amine or imine groups) or oxygen (usually hydroxy, carboxy, or carbonyl groups) and are not contained in component heterocyclic rings (N—O Tridentates, N—O Tetradentates, and N—O Hexadentates) that meet the requirements for use as “narrow band” valence stabilizers for Ce⁺⁴ include, but are not limited to: triazadioxacyclodecane ([10]aneO₂N₃); triazadioxacycloundecane ([11]aneO₂N₃); triazadioxacyclododecane ([12]aneO₂N₃); triazadioxacyclotridecane ([13]aneO₂N₃); triazadioxacyclotetradecane ([14]aneO₂N₃); and triazadioxacyclopentadecane ([15]aneO₂N₃).

N—O Valence Stabilizer #17: Examples of five- or seven-membered macrocyclics, macrobicyclics, and macropolycyclics (including catapinands, cryptands, cyclidenes, and sepulchrates) wherein all binding sites are composed of nitrogen or oxygen and are contained in component heterocyclic rings (N—O Bidentates, N—O Tridentates, N—O Tetradentates, or N—O Hexadentates) that meet the requirements for use as “narrow band” valence stabilizers for Ce⁺⁴ include, but are not limited to: dipyrantripyridines; difurantripyrroles; tripyrantetrapyridines; and trifurantetrapyrroles.

N—O Valence Stabilizer #18: Examples of five-, seven-, or nine-membered macrocyclics, macrobicyclics, and macropolycyclics (including catapinands, cryptands, cyclidenes, and sepulchrates) wherein all binding sites are composed of nitrogen or oxygen and are contained in a combination of heterocyclic rings and amine, imine, hydroxy, carboxy, or carbonyl groups (N—O Bidentates, N—O Tridentates, N—O Tetradentates, or N—O Hexadentates) that meet the requirements for use as “narrow band” valence stabilizers for Ce⁺⁴ include, but are not limited to: azaoxapentaphyrins; diazadioxapentaphyrins; azaoxapentaphyrins; and diazadioxapentaphyrins.

S—O Valence Stabilizer #1: Examples of thiobiurets (thioimidodicarbonic diamides), thioisobiurets, thiobiureas, thiotriurets, thiotriureas, bis(thiobiurets), bis(thioisobiurets), bis(thiobiureas), poly(thiobiurets), poly(thioisobiurets), and poly(thiobiureas) (S—O Bidentates, S—O Tridentates, S—O Tetradentates) that meet the requirements for use as “narrow band” valence stabilizers for Ce⁺⁴ include, but are not limited to: thiobiuret, thioisobiuret, thiobiurea, thiotriuret, thiotriurea, nitrothiobiuret, dinitrothiobiuret, aminothiobiuret, diaminothiobiuret, oxythiobiuret, dioxythiobiuret, cyanothiobiuret, methylthiobiuret, ethylthiobiuret, isopropylthiobiuret, phenylthiobiuret, benzylthiobiuret, cyclohexylthiobiuret, norbornylthiobiuret, adamantylthiobiuret, dimethylthiobiuret, diethylthiobiuret, diisopropylthiobiuret, diphenylthiobiuret, dibenzylthiobiuret, dicyclohexylthiobiuret, dinorbornylthiobiuret, diadamantylthiobiuret; and (3-formamidino thiocarbamides).

S—O Valence Stabilizer #2: Examples of acylthioureas, aroylthioureas, thioacylureas, thioaroylureas, bis(acylthioureas), bis(aroylthioureas), bis(thioacylureas), bis(thioaroylureas), poly(thioacylthioureas), poly(thioaroylthioureas), poly(thioacylureas), and poly(thioaroylureas) (S—O Bidentates, S—O Tridentates, S—O Tetradentates) that meet the requirements for use as “narrow band” valence stabilizers for Ce⁺⁴ include, but are not limited to: thioformylurea, thioacetylurea, thiobenzoylurea, thiocyclohexoylurea, pentafluorothiobenzoylurea, acetylthiourea, benzoylthiourea, and cyclohexoylthiourea.

S—O Valence Stabilizer #3: Examples of thioimidodialdehydes, thiohydrazidodialdehydes (thioacyl hydrazides), bis(thioimidodialdehydes), bis(thiohydrazidodialdehydes), poly(thioimidodialdehydes), and poly(thiohydrazidodialdehydes) (S—O Bidentates, S—O Tridentates, S—O Tetradentates) that meet the requirements for use as “narrow band” valence stabilizers for Ce⁺⁴ include, but are not limited to: thiodiacetamide, thiodipropanamide, thiodibutanamide, thiodibenzamide, and thiodicyclohexamide.

S—O Valence Stabilizer #4: Examples of thioimidodicarbonic acids, thiohydrazidodicarbonic acids, bis(thioimidodicarbonic acids), bis(thiohydrazidodicarbonic acids), poly(thioimidodicarbonic acids), poly(thiohydrazidodicarbonic acids) and derivatives thereof (S—O Bidentates, S—O Tridentates, S—O Tetradentates) that meet the requirements for use as “narrow band” valence stabilizers for Ce⁺⁴ include, but are not limited to: thioimidodicarbonic acid, thiohydrazidodicarbonic acid, O-phenylthioimidodicarbonic acid, O-benzylthioimidodicarbonic acid, O-cyclohexylthioimidodicarbonic acid, O-norbornylthioimidodicarbonic acid, O,O′-diphenylthioimidodicarbonic acid, O,O′-dibenzylthioimidodicarbonic acid, O,O′-dicyclohexylthioimidodicarbonic acid, O,O′-dinorbornylthioimidodicarbonic acid.

S—O Valence Stabilizer #5: Examples of 1,2-monothioketones (monothiolenes, monothio-alpha-ketonates), 1,2,3-monothioketones, 1,2,3-dithioketones, monothiotropolonates, ortho-monothioquinones, bis(1,2-monothioketones), and poly(1,2-monothioketones) (S—O Bidentates, S—O Tridentates, S—O Tetradentates) that meet the requirements for use as “narrow band” valence stabilizers for Ce⁺⁴ include, but are not limited to: monothiotropolone; 1,2-monothiobenzoquinone (o-monothioquinone); di-tert-butyl-1,2-monothiobenzoquinone; hexafluoro-1,2-monothiobenzoquinone; 1,2-monothionaphthoquinone; 9,10-monothiophenanthroquinone; monothiosquaric acid; monothiodeltic acid; monothiocroconic acid; and monothiorhodizonic acid.

S—O Valence Stabilizer #6: Examples of trithioperoxydicarbonic diamides, bis(trithioperoxydicarbonic diamides), and poly(trithioperoxydicarbonic diamides) (S—O Bidentates, S—O Tridentates, S—O Tetradentates) that meet the requirements for use as “narrow band” valence stabilizers for Ce⁺⁴ include, but are not limited to: trithioperoxydicarbonic diamide; N-phenyltrithioperoxydicarbonic diamide; N-benzyltrithioperoxydicarbonic diamide; N-cyclohexyltrithioperoxydicarbonic diamide; N-norbornyltrithioperoxydicarbonic diamide; N,N′-diphenyltrithioperoxydicarbonic diamide; N,N′-dibenzyltrithioperoxydicarbonic diamide; N,N′-dicyclohexyltrithioperoxydicarbonic diamide; and N,N′-dinorbornyltrithioperoxydicarbonic diamide.

S—O Valence Stabilizer #7: Examples of dithiodicarbonic acids, bis(dithiodicarbonic acids), poly(dithiodicarbonic acids), and derivatives thereof (S—O Bidentates, S—O Tridentates, S—O Tetradentates) that meet the requirements for use as “narrow band” valence stabilizers for Ce⁺⁴ include, but are not limited to: dithiodicarbonic acid, O-phenyldithiodicarbonic acid, O-benzyldithiodicarbonic acid, O-cyclohexyldithiodicarbonic acid, O-norbornyldithiodicarbonic acid, O,O′-diphenyldithiodicarbonic acid, O,O′-dibenzyldithiodicarbonic acid, O,O′-dicyclohexyldithiodicarbonic acid, and O,O′-dinorbornyldithiodicarbonic acid.

S—O Valence Stabilizer #8: Examples of trithioperoxydicarbonic acids, bis(trithioperoxydicarbonic acids), poly(trithioperoxydicarbonic acids), and derivatives thereof (S—O Bidentates, S—O Tridentates, S—O Tetradentates) that meet the requirements for use as “narrow band” valence stabilizers for Ce⁺⁴ include, but are not limited to: trithioperoxydicarbonic acid, O-phenyltrithioperoxydicarbonic acid; O-benzyltrithioperoxydicarbonic acid; O-cyclohexyltrithioperoxydicarbonic acid; O-norbornyltrithioperoxydicarbonic acid; O,O′-diphenyltrithioperoxydicarbonic acid; O,O′-dibenzyltrithioperoxydicarbonic acid; O,O′-dicyclohexyltrithioperoxydicarbonic acid; and O,O′-dinorbornyltrithioperoxydicarbonic acid.

S—O Valence Stabilizer #9: Examples of monothioperoxydiphosphoramides, bis(monothioperoxydiphosphoramides), and poly(monothioperoxydiphosphoramides) (S—O Bidentates, S—O Tridentates, S—O Tetradentates) that meet the requirements for use as “narrow band” valence stabilizers for Ce⁺⁴ include, but are not limited to: monothioperoxydiphosphoramide, N-methylmonothioperoxydiphosphoramide, N-isopropylmonothioperoxydiphosphoramide, N-tert-butylmonothioperoxydiphosphoramide, N-phenylmonothioperoxydiphosphoramide, N-pentafluorophenylmonothioperoxydiphosphoramide, N-benzylmonothioperoxydiphosphoramide, N-cyclohexylmonothioperoxydiphosphoramide, N-norbornylmonothioperoxydiphosphoramide, N,N′″-dimethylmonothioperoxydiphosphoramide, N,N′″-diisopropylmonothioperoxydiphosphoramide, N,N′″-di-tert-butylmonothioperoxydiphosphoramide, N,N′″-diphenylmonothioperoxydiphosphoramide, N,N′″-di-pentafluorophenylmonothioperoxydiphosphoramide, N,N″-dibenzylmonothioperoxydiphosphoramide, N,N′″-dicyclohexylmonothioperoxydiphosphoramide, and N,N′″-dinorbornylmonothioperoxydiphosphoramide.

S—O Valence Stabilizer #10: Examples of monothioperoxydiphosphoric acids, bis(monothioperoxydiphosphoric acids), poly(monothioperoxydiphosphoric acids), and derivatives thereof (S—O Bidentates, S—O Tridentates, S—O Tetradentates) that meet the requirements for use as “narrow band” valence stabilizers for Ce⁺⁴ include, but are not limited to: monothioperoxydiphosphoric acid, methylmonothioperoxydiphosphoric acid, isopropylmonothioperoxydiphosphoric acid, tert-butylmonothioperoxydiphosphoric acid, phenylmonothioperoxydiphosphoric acid, pentafluorophenylmonothioperoxydiphosphoric acid, benzylmonothioperoxydiphosphoric acid, cyclohexylmonothioperoxydiphosphoric acid, norbornylmonothioperoxydiphosphoric acid, dimethylmonothioperoxydiphosphoric acid, diisopropylmonothioperoxydiphosphoric acid, di-tert-butylmonothioperoxydiphosphoric acid, diphenylmonothioperoxydiphosphoric acid, di-pentafluorophenylmonothioperoxydiphosphoric acid, dibenzylmonothioperoxydiphosphoric acid, dicyclohexylmonothioperoxydiphosphoric acid, and dinorbornylmonothioperoxydiphosphoric acid.

S—O Valence Stabilizer #11: Examples of monothioimidodiphosphonic acids, monothiohydrazidodiphosphonic acids, bis(monothioimidodiphosphonic acids), bis(monothiohydrazidodiphosphonic acids), poly(monothioimidodiphosphonic acids), poly(monothiohydrazidodiphosphonic acids), and derivatives thereof (S—O Bidentates, S—O Tridentates, S—O Tetradentates) that meet the requirements for use as “narrow band” valence stabilizers for Ce⁺⁴ include, but are not limited to: monothioimidodiphosphonic acid, methylmonothioimidodiphosphonic acid, isopropylmonothioimidodiphosphonic acid, tert-butylmonothioimidodiphosphonic acid, phenylmonothioimidodiphosphonic acid, pentafluorophenylmonothioimidodiphosphonic acid, benzylmonothioimidodiphosphonic acid, cyclohexylmonothioimidodiphosphonic acid, norbornylmonothioimidodiphosphonic acid, dimethylmonothioimidodiphosphonic acid, diisopropylmonothioimidodiphosphonic acid, di-tert-butylmonothioimidodiphosphonic acid, diphenylmonothioimidodiphosphonic acid, di-pentafluorophenylmonothioimidodiphosphonic acid, dibenzylmonothioimidodiphosphonic acid, dicyclohexylmonothioimidodiphosphonic acid, and dinorbornylmonothioimidodiphosphonic acid. [Note: the phosphite (P⁺³) valence of the phosphorus atom makes stabilizization of high valence metal ions much more difficult, though still possible.]

S—O Valence Stabilizer #12: Examples of monothioimidodiphosphonamides, monothiohydrazidodiphosphonamides, bis(monothioimidodiphosphonamides), bis(monothiohydrazidodiphospbonamides), poly(monothioimidodiphosphonamides), and poly(monothiohydrazidodiphosphonamides) (S—O Bidentates, S—O Tridentates, S—O Tetradentates) that meet the requirements for use as “narrow band” valence stabilizers for Ce⁺⁴ include, but are not limited to: monothioimidodiphosphonamide, N-methylmonothioimidodiphosphonamide, N-isopropylmonothioimidodiphosphonamide, N-tert-butylmonothioimidodiphosphonamide, N-phenylmonothioimidodiphosphonamide, N-pentafluorophenylmonothioimidodiphosphonamide, N-benzylmonothioimidodiphosphonamide, N-cyclohexylmonothioimidodiphosphonamide, N-norbornylmonothioimidodiphosphonamide, N,N′″-dimethylmonothioimidodiphosphonamide, N,N′″-diisopropylmonothioimidodiphosphonamide, N,N′″-di-tert-butylmonothioimidodiphosphonamide, N,N′″-diphenylmonothioimidodiphosphonamide, N,N′″-di-pentafluorophenylmonothioimidodiphosphonamide, N,N′″-dibenzylmonothioimidodiphosphonamide, N,N′″-dicyclohexylmonothioimidodiphosphonamide, and N,N′″-dinorbornylmonothioimidodiphosphonamide. [Note: the phosphite (P⁺³) valence of the phosphorus atom makes stabilizization of high valence metal ions much more difficult, though still possible.]

S—O Valence Stabilizer #13: Examples of dithiodiphosphonamides, bis(dithiodiphosphonamides), and poly(dithiodiphosphonamides) (S—O Bidentates, S—O Tridentates, S—O Tetradentates) that meet the requirements for use as “narrow band” valence stabilizers for Ce⁺⁴ include, but are not limited to: dithiodiphosphonamide, N-methyldithiodiphosphonamide, N-isopropyldithiodiphosphonamide, N-tert-butyldithiodiphosphonamide, N-phenyldithiodiphosphonamide, N-pentafluorophenyldithiodiphosphonamide, N-benzyldithiodiphosphonamide, N-cyclohexyldithiodiphosphonamide, N-norbornyldithiodiphosphonamide, N,N′″-dimethyldithiodiphosphonamide, N,N′″-diisopropyldithiodiphosphonamide, N,N′″-di-tert-butyldithiodiphosphonamide, N,N′″-diphenyldithiodiphosphonamide, N,N′″-di-pentafluorophenyldithiodiphosphonamide, N,N′″-dibenzyldithiodiphosphonamide, N,N′″-dicyclohexyldithiodiphosphonamide, and N,N′″-dinorbornyldithiodiphosphonamide. [Note: the phosphite (P⁺³) valence of the phosphorus atom makes stabilizization of high valence metal ions much more difficult, though still possible.]

S—O Valence Stabilizer #14: Examples of dithiodiphosphonic acids, bis(dithiodiphosphonic acids), poly(dithiodiphosphonic acids), and derivatives thereof (S—O Bidentates, S—O Tridentates,

S—O Tetradentates) that meet the requirements for use as “narrow band” valence stabilizers for Ce⁺⁴ include, but are not limited to: dithiodiphosphonic acid, methyldithiodiphosphonic acid, isopropyldithiodiphosphonic acid, tert-butyldithiodiphosphonic acid, phenyldithiodiphosphonic acid, pentafluorophenyldithiodiphosphonic acid, benzyldithiodiphosphonic acid, cyclohexyldithiodiphosphonic acid, norbornyldithiodiphosphonic acid, dimethyldithiodiphosphonic acid, diisopropyldiothiodiphosphonic acid, di-tert-butyldithiodiphosphonic acid, diphenyldithiodiphosphonic acid, di-pentafluorophenyldithiodiphosphonic acid, dibenzyldithiodiphosphonic acid, dicyclohexyldithiodiphosphonic acid, and dinorbornyldithiodiphosphoric acid. [Note: the phosphite (P⁺³) valence of the phosphorus atom makes stabilizization of high valence metal ions much more difficult, though still possible.]

S—O Valence Stabilizer #15: Examples of monothioperoxydiphosphonamides, bis(monothioperoxydiphosphonamides), and poly(monothioperoxydiphosphonamides) (S—O Bidentates, S—O Tridentates, S—O Tetradentates) that meet the requirements for use as “narrow band” valence stabilizers for Ce⁺⁴ include, but are not limited to: monothioperoxydiphosphonamide, N-methylmonothioperoxydiphosphonamide, N-isopropylmonothioperoxydiphosphonamide, N-tert-butylmonothioperoxydiphosphonamide, N-phenylmonothioperoxydiphosphonamide, N-pentafluorophenylmonothioperoxydiphosphonamide, N-benzylmonothioperoxydiphosphonamide, N-cyclohexylmonothioperoxydiphosphonamide, N-norbornylmonothioperoxydiphosphonamide, N,N′″-dimethylmonothioperoxydiphosphonamide, N,N′″-diisopropylmonothioperoxydiphosphonamide, N,N′″-di-tert-butylmonothioperoxydiphosphonamide, N,N′″-diphenylmonothioperoxydiphosphonamide, N,N′″-di-pentafluorophenylmonothioperoxydiphosphonamide, N,N′″-dibenzylmonothioperoxydiphosphonamide, N,N′″-dicyclohexylmonothioperoxydiphosphonamide, and N,N′″-dinorbornylmonothioperoxydiphosphonamide. [Note: the phosphite (P⁺³) valence of the phosphorus atom makes stabilizization of high valence metal ions much more difficult, though still possible.]

S—O Valence Stabilizer #16: Examples of monothioperoxydiphosphonic acids, bis(monothioperoxydiphosphonic acids), poly(monothioperoxydiphosphonic acids), and derivatives thereof (S—O Bidentates, S—O Tridentates, S—O Tetradentates) that meet the requirements for use as “narrow band” valence stabilizers for Ce⁺⁴ include, but are not limited to: monothioperoxydiphosphonic acid, methylmonothioperoxydiphosphonic acid, isopropylmonothioperoxydiphosphonic acid, tert-butylmonothioperoxydiphosphonic acid, phenylmonothioperoxydiphosphonic acid, pentafluorophenylmonothioperoxydiphosphonic acid, benzylmonothioperoxydiphosphonic acid, cyclohexylmonothioperoxydiphosphonic acid, norbornylmonothioperoxydiphosphonic acid, dimethylmonothioperoxydiphosphonic acid, diisopropylmonothioperoxydiphosphonic acid, di-tert-butylmonothioperoxydiphosphonic acid, diphenylmonothioperoxydiphosphonic acid, di-pentafluorophenylmonothioperoxydiphosphonic acid, dibenzylmonothioperoxydiphosphonic acid, dicyclohexylmonothioperoxydiphosphonic acid, and dinorbornylmonothioperoxydiphosphonic acid. [Note: the phosphite (P⁺³) valence of the phosphorus atom makes stabilizization of high valence metal ions much more difficult, though still possible.]

S—O Valence Stabilizer #17: Examples of monothiophosphoric acids (phosphorothioic acids), bis(monothiophosphoric acids), poly(monothiophosphoric acids), and derivatives thereof (S—O Bidentates, S—O Tridentates, S—O Tetradentates) that meet the requirements for use as “narrow band” valence stabilizers for Ce⁺⁴ include, but are not limited to: monothiophosphoric acid, O-phenylmonothiophosphoric acid, O-benzylmonothiophosphoric acid, O-cyclohexylmonothiophosphoric acid, O-norbornylmonothiophosphoric acid, O,O-diphenylmonothiophosphoric acid, O,O-dibenzylmonothiophosphoric acid, O,O-dicyclohexylmonothiophosphoric acid, and O,O-dinorbornylmonothiophosphoric acid.

S—O Valence Stabilizer #18: Examples of phosphoro(dithioperoxoic) acids, bis[phosphoro(dithioperoxoic) acids], poly[phosphoro(dithioperoxoic) acids], and derivatives thereof (S—O Bidentates, S—O Tridentates, S—O Tetradentates) that meet the requirements for use as “narrow band” valence stabilizers for Ce⁺⁴ include, but are not limited to: phosphoro(dithioperoxoic) acid, O-phenylphosphoro(dithioperoxoic) acid, O-benzylphosphoro(dithioperoxoic) acid, O-cyclohexylphosphoro(dithioperoxoic) acid, O-norbornylphosphoro(dithioperoxoic) acid, O,O-diphenylphosphoro(dithioperoxoic) acid, O,O-dibenzylphosphoro(dithioperoxoic) acid, O,O-dicyclohexylphosphoro(dithioperoxoic) acid, and O,O-dinorbornylphosphoro(dithioperoxoic) acid.

S—O Valence Stabilizer #19: Examples of monothiophosphonic Acids (phosphonothioic acids), bis(monothiophosphonic acids), poly(monothiophosphonic acids), and derivatives thereof (S—O Bidentates, S—O Tridentates, S—O Tetradentates) that meet the requirements for use as “narrow band” valence stabilizers for Ce⁺⁴ include, but are not limited to: monothiophosphonic acid, O-phenylmonothiophosphonic acid, O-benzylmonothiophosphonic acid, O-cyclohexylmonothiophosphonic acid, O-norbornylmonothiophosphonic acid, O,P-diphenylmonothiophosphonic acid, O,P-dibenzylmonothiophosphonic acid, O,P-dicyclohexylmonothiophosphonic acid, and O,P-dinorbornylmonothiophosphonic acid. [Note: the phosphite (P⁺³) valence of the phosphorus atom makes stabilizization of high valence metal ions much more difficult, though still possible.]

S—O Valence Stabilizer #20: Examples of phosphono(dithioperoxoic) acids, bis[phosphono(dithioperoxoic) acids], poly[phosphono(dithioperoxoic) acids], and derivatives thereof (S—O Bidentates, S—O Tridentates, S—O Tetradentates) that meet the requirements for use as “narrow band” valence stabilizers for Ce⁺⁴ include, but are not limited to: phosphono(dithioperoxoic) acid, O-phenylphosphono(dithioperoxoic) acid, O-benzylphosphono(dithioperoxoic) acid, O-cyclohexylphosphono(dithioperoxoic) acid, O-norbornylphosphono(dithioperoxoic) acid, O,P-diphenylphosphono(dithioperoxoic) acid, O,P-dibenzylphosphono(dithioperoxoic) acid, O,P-dicyclohexylphosphono(dithioperoxoic) acid, and O,P-dinorbomylphosphono(dithioperoxoic) acid. [Note: the phosphite (P⁺³) valence of the phosphorus atom makes stabilizization of high valence metal ions much more difficult, though still possible.]

S—O Valence Stabilizer #21: Examples of beta-hydroxythioketones, beta-hydroxythioaldehydes, bis(beta-hydroxythioketones), bis(beta-hydroxythioaldehydes), poly(beta-hydroxythioketones), and poly(beta-hydroxythioaldehydes) (S—O Bidentates, S—O Tridentates, S—O Tetradentates) that meet the requirements for use as “narrow band” valence stabilizers for Ce⁺⁴ include, but are not limited to: 4-hydroxypentan-2-thione; 1,3-diphenyl-3-hydroxypropanethioaldehyde; 1,3-dibenzyl-3-hydroxypropanethioaldehyde; 1,3-dicyclohexyl-3-hydroxypropanethioaldehyde; 1,3-dinorbornyl-3-hydroxypropanethioaldehyde; 1,3-di(2-thienyl)-3-hydroxypropanethioaldehyde; 1,3-di(2-furyl)-3-hydroxypropanethioaldehyde; o-hydroxythioacetophenone; and beta-hydroxythiobenzophenone.

S—O Valence Stabilizer #22: Examples of beta-mercaptoketones, beta-mercaptoaldehydes, bis(beta-mercaptoketones), bis(beta-mercaptoaldehydes), poly(beta-mercaptoketones), and poly(beta-mercaptoaldehydes) (S—O Bidentates, S—O Tridentates, S—O Tetradentates) that meet the requirements for use as “narrow band” valence stabilizers for Ce⁺⁴ include, but are not limited to: 4-mercaptopentan-2-one; 1,3-diphenyl-3-mercaptopropanal; 1,3-dibenzyl-3-mercaptopropanal; 1,3-dicyclohexyl-3-mercaptopropanal; 1,3-dinorbornyl-3-mercaptopropanal; 1,3-di(2-thienyl)-3-mercaptopropanal; 1,3-di(2-furyl)-3-mercaptopropanal; 3-mercapto-1,5-pentanedialdehyde; o-mercaptoacetophenone; 5-mercapto-1,4-naphthoquinone; 1-mercaptoacridone; 1-mercaptoanthraquinone; 1,8-dimercaptoanthraquinone; and beta-mercaptobenzophenone.

S—O Valence Stabilizer #23: Examples of N-(aminomethylol)thioureas [N-(aminohydroxymethyl)thioureas], bis[N-(aminomethylol)thioureas], and poly[N-(aminomethylol)thioureas] (S—O Bidentates, S—O Tridentates, S—O Tetradentates) that meet the requirements for use as “narrow band” valence stabilizers for Ce⁺⁴ include, but are not limited to: N′-(aminohydroxymethyl)thiourea; N,N″-dimethyl-N′-(aminohydroxymethyl)thiourea; N,N′-diethyl-N′-(aminohydroxymethyl)thiourea; N,N″-isopropyl-N′-(aminohydroxymethyl)thiourea; N,N″-diphenyl-N′-(aminohydroxymethyl)thiourea; N,N″-dibenzyl-N′-(aminohydroxymethyl)thiourea; N,N″-dicyclohexyl-N′-(aminohydroxymethyl)thiourea; and N,N″-dinorbornyl-N′-(aminohydroxymethyl)thiourea.

S—O Valence Stabilizer #24: Examples of N-(aminomethylthiol)ureas [N-(aminomercaptomethyl)ureas], bis[N-(aminomethylthiol)ureas], and poly[N-(aminomethylthiol)ureas] (S—O Bidentates, S—O Tridentates, S—O Tetradentates) that meet the requirements for use as “narrow band” valence stabilizers for Ce⁺⁴ include, but are not limited to: N′-(aminomercaptomethyl)urea; N,N″-dimethyl-N′-(aminomercaptomethyl)urea; N,N′-diethyl-N′-(aminomercaptomethyl)urea; N,N″-isopropyl-N′-(aminomercaptomethyl)urea; N,N″-diphenyl-N′-(aminomercaptomethyl)urea; N,N″-dibenzyl-N′-(aminomercaptomethyl)urea; N,N″-dicyclohexyl-N′-(aminomercaptomethyl)urea; and N,N″-dinorbornyl-N′-(aminomercaptomethyl)urea.

S—O Valence Stabilizer #25: Examples of monothiooxamides, bis(monothiooxamides), and poly(monothiooxamides) (S—O Bidentates, S—O Tridentates, S—O Tetradentates) that meet the requirements for use as “narrow band” valence stabilizers for Ce⁺⁴ include, but are not limited to: monothiooxamide, N-methylthiooxamide; N-ethylthiooxamide; N-isopropylthiooxamide; N-phenylthiooxamide; N-benzylthiooxamide; N-cyclohexylthiooxamide; N-norbornylthiooxamide; N,N′-dimethylthiooxamide; N,N′-diethylthiooxamide; N,N′-diisopropylthiooxamide; N,N′-diphenylthiooxamide; N,N′-dibenzylthiooxamide; N,N′-dicyclohexylthiooxamide; and N,N′-dinorbornylthiooxamide.

S—O Valence Stabilizer #26: Examples of beta-mercapto carboxylic acids, bis(beta-mercapto carboxylic acids), poly(beta-mercapto carboxylic acids), and derivatives thereof (S—O Bidentates,

S—O Tridentates, S—O Tetradentates) that meet the requirements for use as “narrow band” valence stabilizers for Ce⁺⁴ include, but are not limited to: methyl 3-mercaptopropanoate; methyl 3-mercaptobutanoate; ethyl 3-mercaptobutanoate; phenyl 3-mercaptobutanoate; cyclohexyl 3-mercaptobutanoate; norbornyl 3-mercaptobutanoate; methyl beta-mercaptohydrocinnamate; ethyl beta-mercaptohydrocinnamate; phenyl beta-mercaptohydrocinnamate; methyl o-mercaptobenzoate; ethyl o-mercaptobenzoate; phenyl o-mercaptobenzoate; cyclohexyl o-mercaptobenzoate; (2-benzothiazolylthio) succinic acid (mtbs); norbornyl o-mercaptobenzoate; and 3-[(benzothiazol-2-yl)thio]propionic acid.

S—O Valence Stabilizer #27: Examples of beta-mercapto thiocarboxylic acids, bis(beta-mercapto thiocarboxylic acids), poly(beta-mercapto thiocarboxylic acids), and derivatives thereof (S—O Bidentates, S—O Tridentates, S—O Tetradentates) that meet the requirements for use as “narrow band” valence stabilizers for Ce⁺⁴ include, but are not limited to: methyl 3-mercaptothiobutanoate; ethyl 3-mercaptothiobutanoate; phenyl 3-mercaptothiobutanoate; cyclohexyl 3-mercaptothiobutanoate; norbornyl 3-mercaptothiobutanoate; methyl beta-mercaptothiocinnamate; ethyl beta-mercaptothiocinnamate; phenyl beta-mercaptothiocinnamate; methyl o-mercaptothiobenzoate; ethyl o-mercaptothiobenzoate; phenyl o-mercaptothiobenzoate; cyclohexyl o-mercaptothiobenzoate; norbornyl o-mercaptothiobenzoate; and (alkylthio)oxoethyl alkyl(aryl) disulfides

S—O Valence Stabilizer #28: Examples of beta-hydroxy thiocarboxylic acids, bis(beta-hydroxy thiocarboxylic acids), poly(beta-hydroxy thiocarboxylic acids), and derivatives thereof (S—O Bidentates, S—O Tridentates, S—O Tetradentates) that meet the requirements for use as “narrow band” valence stabilizers for Ce⁺⁴ include, but are not limited to: methyl 3-hydroxythiobutanoate; ethyl 3-hydroxythiobutanoate; phenyl 3-hydroxythiobutanoate; cyclohexyl 3-hydroxythiobutanoate; norbornyl 3-hydroxythiobutanoate; methyl beta-hydroxythiocinnamate; ethyl beta-hydroxythiocinnamate; phenyl beta-hydroxythiocinnamate; methyl o-hydroxythiobenzoate; ethyl o-hydroxythiobenzoate; phenyl o-hydroxythiobenzoate; cyclohexyl o-hydroxythiobenzoate; and norbornyl o-hydroxythiobenzoate.

S—O Valence Stabilizer #29: Examples of beta-mercapto carboxamides, bis(beta-mercapto carboxamides), poly(beta-mercapto carboxamides), and derivatives thereof (S—O Bidentates, S—O Tridentates, S—O Tetradentates) that meet the requirements for use as “narrow band” valence stabilizers for Ce⁺⁴ include, but are not limited to: N-methyl 3-mercaptobutanamide; N-ethyl 3-mercaptobutanamide; N-phenyl 3-mercaptobutanamide; N-cyclohexyl 3-mercaptobutanamide; N-norbornyl 3-mercaptobutanamide; N-methyl o-mercaptobenzamide; N-ethyl o-mercaptobenzamide; N-phenyl o-mercaptobenzamide; N-cyclohexyl o-mercaptobenzamide; and N-norbornyl o-mercaptobenzamide.

S—O Valence Stabilizer #30: Examples of S-alkylthiocarboxylic Acids, S-arylthiocarboxylic Acids, and S,S-thiobiscarboxylic Acids (S—O Bidentates and S—O Tridentates) that meet the requirements for use as “narrow band” valence stabilizers for Ce⁺⁴ include, but are not limited to: (methylthio)acetic acid; (methylthio)benzoic acid; (methylthio)nicotinic acid; (methylthio)napthoic acid; (phenylthio)acetic acid; (phenylthio)benzoic acid; (phenylthio)naphthoic acid; (norbornylthio)acetic acid; (norbornylthio)benzoic acid; (norbornylthio)napthoic acid; thiobisacetic acid; thiobisbenzoic acid; and thiobisnapthoic acid.

S—O Valence Stabilizer #31: Examples of S-alkyldisulfidocarboxylic acids, S-aryldisulfidocarboxylic acids, and S,S′-disulfidobiscarboxylic acids (S—O Bidentates and S—O Tridentates) that meet the requirements for use as “narrow band” valence stabilizers for Ce⁺⁴ include, but are not limited to: (methyldisulfido)acetic acid; (methyldisulfido)benzoic acid; (methyldisulfido)nicotinic acid; (methyldisulfido)napthoic acid; (phenyldisulfido)acetic acid; (phenyldisulfido)benzoic acid; (phenyldisulfido)naphthoic acid; (norbornyldisulfido)acetic acid; (norbornyldisulfido)benzoic acid; (norbornyldisulfido)napthoic acid; S,S′-disulfidobisacetic acid; S,S′-disulfidobisbenzoic acid; and S,S′-disulfidobisnapthoic acid.

S—O Valence Stabilizer #32: Examples of monothiomonocarboxylic acids, dithiodicarboxylic acids, bis(monothiomonocarboxylic acids), bis(dithiodicarboxylic acids), poly(monothiomonocarboxylic acids), poly(dithiodicarboxylic acids), and derivatives thereof (S—O Bidentates and S—O Tetradentates) that meet the requirements for use as “narrow band” valence stabilizers for Ce⁺⁴ include, but are not limited to: thioacetic acid; thiopropionic acid; thiobenzoic acid; thiophenylacetic acid; thiocyclohexanoic acid; thiofuroic acid; thionaphthoic acid; phenyl thioacetate; phenyl thiopropionate; phenyl thiobenzoate; phenyl thiocyclohexanoate; phenyl thiofuroate; phenyl thionaphthoate; dithiooxalic acid (dto); monothiooxalic acid (mtox); dithiomalonic acid; dithiosuccinic acid; diphenyl dithiooxalate; diphenyl dithiomalonate; and diphenyl dithiosuccinate.

S—O Valence Stabilizer #33: Examples of monothiocarbonates and bis(monothiocarbonates) (S—O Bidentates and S—O Tetradentates) that meet the requirements for use as “narrow band” valence stabilizers for Ce⁺⁴ include, but are not limited to: S,O-diethyldithiocarbonate; S,O-diisopropyldithiocarbonate; S,O-diphenyldithiocarbonate; S,O-dibenzyldithiocarbonate; S,O-dicyclohexyldithiocarbonate; and S,O-dinorbornyldithiocarbonate.

S—O Valence Stabilizer #34: Examples of monothiocarbazates (monothiocarbazides), bis(monothiocarbazates), and poly(monothiocarbazates) (S—O Bidentates, S—O Tridentates, and

S—O Tetradentates; or possibly N—S Bidentates, N—S Tridentates, and N—S Tetradentates) that meet the requirements for use as “narrow band” valence stabilizers for Ce⁺⁴ include, but are not limited to: N,N′-dimethylmonothiocarbazate; N,N′-di(trifluoromethyl)monothiocarbazate; N,N′-diethylmonothiocarbazate; N,N′-diphenylmonothiocarbazate; N,N′-dibenzylmonothiocarbazate; N,N′-di(pentafluorophenyl)monothiocarbazate; N,N′-dicyclohexylmonothiocarbazate; and N,N′-dinorbornylmonothiocarbazate.

S—O Valence Stabilizer #35: Examples of mercapto alcohols and silylmercaptoalcohols, bis(mercapto alcohols and silylmercaptoalcohols), and poly(mercapto alcohols and silylmercaptoalcohols) (S—O Bidentates, S—O Tridentates, S—O Tetradentates) that meet the requirements for use as “narrow band” valence stabilizers for Ce⁺⁴ include, but are not limited to: 2-mercaptoethanol (mel); 3-mercaptopropanol (mpl); 2-mercaptophenol; 2-mercaptocyclohexanol; 3-mercapto-2-norborneol; 2-mercaptopyridine 1-oxide; 1,4-thioxane; thiodialkanols; 2-(trimethoxysilyl)-1-ethanethiol (tmset); 3-(trimethoxysilyl)-1-propanethiol (tmspt); o-hydroxythiophenols; o-(O-hydroxyalkyl(aryl))thiophenols; and o-(S-thioalkyl(aryl))phenols.

S—O Valence Stabilizer #36: Examples of monothiocarbimates, bis(monothiocarbimates), and poly(monothiocarbimates) (S—O Bidentates, S—O Tridentates, and S—O Tetradentates) that meet the requirements for use as “narrow band” valence stabilizers for Ce⁺⁴ include, but are not limited to: methylmonothiocarbimate; trifluoromethylmonothiocarbimate; ethylmonothiocarbimate; propylmonothiocarbimate; isopropylmonothiocarbimate; butylmonothiocarbimate; tertbutylmonothiocarbimate; cyanomonothiocarbimate; cyanamidomonothiocarbimate; azidomonothiocarbimate; phenylmonothiocarbimate; pentafluorophenylmonothiocarbimate; benzylmonothiocarbimate; naphthylmonothiocarbimate; cyclohexylmonothiocarbimate; norbornylmonothiocarbimate; and adamantylmonothiocarbimate. [Note: carbimates tend to stabilize lower oxidation states in metal ions.]

S—O Valence Stabilizer #37: Examples of alkyl- and aryl-monothioborates and bis(monothioborates) (S—O Bidentates and S—O Tetradentates) that meet the requirements for use as “narrow band” valence stabilizers for Ce⁺⁴ include, but are not limited to: O,O′-diethyl monothioborate; O,O′-diisopropyl monothioborate; O,O′-diphenyl monothioborate; O,O′-dibenzyl monothioborate; O,O′-dicyclohexyl monothioborate; and O,O′-dinorbornyl monothioborate.

S—O Valence Stabilizer #38: Examples of alkyl- and aryl-monothioboronates and bis(monothioboronates) (S—O Bidentates and S—O Tetradentates) that meet the requirements for use as “narrow band” valence stabilizers for Ce⁺⁴ include, but are not limited to: diethyl monothioboronate; diisopropyl monothioboronate; diphenyl monothioboronate; dibenzyl monothioboronate; dicyclohexyl monothioboronate; and dinorbornyl monothioboronate. [Note: boronates tend to stabilize lower oxidation states in metal ions.]

S—O Valence Stabilizer #39: Examples of monothioarsonic acids (arsonothioic acids), bis(monothioarsonic acids), poly(monothioarsonic acids), and derivatives thereof (S—O Bidentates, S—O Tridentates, S—O Tetradentates) that meet the requirements for use as “narrow band” valence stabilizers for Ce⁺⁴ include, but are not limited to: monothioarsonic acid, O-phenylmonothioarsonic acid, O-benzylmonothioarsonic acid, O-cyclohexylmonothioarsonic acid, O-norbornylmonothioarsonic acid, O,O-diphenylmonothioarsonic acid, O,O-dibenzylmonothioarsonic acid, O,O-dicyclohexylmonothioarsonic acid, and O,O-dinorbornylmonothioarsonic acid.

S—O Valence Stabilizer #40: Examples of heterocyclic rings containing one or two sulfur atoms and having at least one additional oxygen atom binding site not in a ring (S—O Bidentates, S—O Tridentates, S—O Tetradentates, or S—O Hexadentates) that meet the requirements for use as “narrow band” valence stabilizers for Ce⁺⁴ include, but are not limited to: 2-thiopheneethanol (2-(2-thienyl)ethanol); 2-propionylthiophene (1-(2-thienyl)-1-propanone); N,N′-thiobisphthalimide; 1,1′-thiocarbonyldi-2-pyridone; 2-thiopheneacetic acid; 2-thiophenecarboxaldehyde; 2-thiophenecarboxamide; 2-thiophenecarboxylic acid; 2,5-thiophenedicarboxaldehyde; 2,5-thiophenedicarboxylic acid; 2-thiophenemethanol; 2-thiophenone; thiotetronic acid; alkyl(aryl) 2-thienyl ketones; dithienyl ketone; 1,3-dithiane-2-carboxylic acid; and 1,3-dithiolane-2-carboxylic acid.

S—O Valence Stabilizer #41: Examples of heterocyclic rings containing one or two oxygen atoms and having at least one additional sulfur atom binding site not in a ring (S—O Bidentates, S—O Tridentates, S—O Tetradentates, or S—O Hexadentates) that meet the requirements for use as “narrow band” valence stabilizers for Ce⁺⁴ include, but are not limited to: 2-furanethanethiol (2-(2-furyl)ethanethiol); 1-(2-furyl)-1-propanethione); 2-furanthioacetic acid; 2-furanthiocarboxaldehyde; 2-furanthiocarboxamide; 2-furanthiocarboxylic acid; 2,5-furandithiocarboxaldehyde; 2,5-furandithiocarboxylic acid; 2-furanmethanethiol; 2-furanthione; furfuryl disulfide; furfuryl mercaptan; furfuryl sulfide; and furfuryl methyl disulfide.

S—O Valence Stabilizer #42: Examples of heterocyclic rings containing one or two sulfur atoms and having at least one additional oxygen atom binding site in a separate ring (S—O Bidentates, S—O Tridentates, S—O Tetradentates, or S—O Hexadentates) that meet the requirements for use as “narrow band” valence stabilizers for Ce⁺⁴ include, but are not limited to: 2-(2-furyl)thiophene; 2,5-(2-furyl)thiophene; 2-(2-furyl)thiopyran; and 2,5-(2-furyl)thiopyran.

S—O Valence Stabilizer #43: Examples of two-, three-, four-, five-, six-, seven-, eight-, nine-, and ten-membered macrocyclics, macrobicyclics, and macropolycyclics (including catapinands, cryptands, cyclidenes, and sepulchrates) wherein all binding sites are composed of sulfur (usually thiol, mercapto, or thiocarbonyl groups) or oxygen (hydroxy, carboxy, or carbonyl groups) and are not contained in component heterocyclic rings (S—O Bidentates, S—O Tridentates, S—O Tetradentates, and S—O Hexadentates) that meet the requirements for use as “narrow band” valence stabilizers for Ce⁺⁴ include, but are not limited to: thiaoxacyclobutane ([4]aneOS); thiaoxacyclopentane ([5]aneOS); thiaoxacyclohexane ([6]aneOS); thiaoxacycloheptane ([7]aneOS); thiaoxacyclooctane ([8]aneOS); thiaoxacyclobutene ([4]eneOS); thiaoxacyclopentene ([5]eneOS); thiaoxacyclohexene ([6]eneOS); thiaoxacycloheptene ([7]eneOS); thiaoxacyclooctene ([8]eneOS); dithiaoxacyclohexane ([6]aneOS₂); dithiaoxacycloheptane ([7]aneOS₂); dithiaoxacyclooctane ([8]aneOS₂); dithiaoxacyclononane ([9]aneOS₂); dithiaoxacyclodecane ([10]aneOS₂); dithiaoxacycloundecane ([11]aneOS₂); dithiaoxacyclododecane ([12]aneOS₂); dithiaoxacyclohexene ([6]eneOS₂); dithiaoxacycloheptene ([7]eneOS₂); dithiaoxacyclooctene ([8]eneOS₂); dithiaoxacyclononene ([9]eneOS₂); dithiaoxacyclodecene ([10]eneOS₂); dithiaoxacycloundecene ([11]eneOS₂); dithiaoxacyclododecene ([12]eneOS₂); dithiadioxacyclooctane ([8]aneO₂S₂); dithiadioxacyclononane ([9]aneO₂S₂); dithiadioxacyclodecane ([10]aneO₂S₂); dithiadioxacycloundecane ([11]aneO₂S₂); dithiadioxacyclododecane ([12]aneO₂S₂); dithiadioxacyclotridecane ([13]aneO₂S₂); dithiadioxacyclotetradecane ([14]aneO₂S₂); dithiadioxacyclopentadecane ([15]aneO₂S₂); dithiadioxacyclohexadecane ([1 6]aneO₂S₂); dithiadioxacycloheptadecane ([17]aneO₂S₂); dithiadioxacyclooctadecane ([1 8]aneO₂S₂); dithiadioxacyclononadecane ([19]aneO₂S₂); dithiadioxacycloeicosane ([20]aneO₂S₂); dithiadioxacyclooctadiene ([8]dieneO₂S₂); dithiadioxacyclononadiene ([9]dieneO₂S₂); dithiadioxacyclodecadiene ([10]dieneO₂S₂); dithiadioxacycloundecadiene ([11]dieneO₂S₂); dithiadioxacyclododecadiene ([12]dieneO₂S₂); dithiadioxacyclotridecadiene ([13]dieneO₂S₂); dithiadioxacyclotetradecadiene ([14]dieneO₂S₂); dithiadioxacyclopentadecadiene ([15]dieneO₂S₂); dithiadioxacyclohexadecadiene ([16]dieneO₂S₂); dithiadioxacycloheptadecadiene ([17]dieneO₂S₂); dithiadioxacyclooctadecadiene ([18]dieneO₂S₂); dithiadioxacyclononadecadiene ([1 9]dieneO₂S₂); and dithiadioxacycloeicosadiene ([20]dieneO₂S₂).

S—O Valence Stabilizer #44: Examples of four-, five-, six-, seven-, eight-, nine-, or ten-membered macrocyclics, macrobicyclics, and macropolycyclics (including catapinands, cryptands, cyclidenes, and sepulchrates) wherein all binding sites are composed of sulfur or oxygen and are contained in component heterocyclic rings (S—O Tridentates, S—O Tetradentates, or S—O Hexadentates) that meet the requirements for use as “narrow band” valence stabilizers for Ce⁺⁴ include, but are not limited to: difurandithiophenes; difurantrithiophenes; trifurantrithiophenes; and tetrafurantetrathiophenes.

S—O Valence Stabilizer #45: Examples of four-, five-, six-, seven-, eight-, nine-, or ten-membered macrocyclics, macrobicyclics, and macropolycyclics (including catapinands, cryptands, cyclidenes, and sepulchrates) wherein all binding sites are composed of sulfur or oxygen and are contained in a combination of heterocyclic rings and thiol, mercapto, thiocarbonyl, hydroxy, carboxy, and carbonyl groups (S—O Tridentates, S—O Tetradentates, or S—O Hexadentates) that meet the requirements for use as “narrow band” valence stabilizers for Ce⁺⁴ include, but are not limited to: dithiadifurandithiophenes; tetrathiadifurandithiophenes; trithiatrifurantrithiophenes; trithiatrifurantrithiophenes; tetrathiatetrafurantetrathiophenes; and octathiatetrafurantetrathiophenes.

S—O Valence Stabilizer #46: Examples of sulfoxides that meet the requirements for use as “narrow band” valence stabilizers for Ce⁺⁴ include, but are not limited to: dimethylsulfoxide (DMSO); diethylsulfoxide; diphenylsulfoxide; and tetrahydrothiophene oxide.

S—O Valence Stabilizer #47: Examples of sulfones that meet the requirements for use as “narrow band” valence stabilizers for Ce⁺⁴ include, but are not limited to: dimethyl sulfone; diethyl sulfone; and diphenyl sulfone.

S—O Valence Stabilizer #48: Examples of sulfur dioxide ligands that meet the requirements for use as “narrow band” valence stabilizers for Ce⁺⁴ include, but are not limited to: sulfur dioxide (—SO₂) ligands. [Note: sulfur dioxide is a reducing agent, and complexed metal ions therefore tend to prefer lower oxidation states.]

N—P Valence Stabilizer #1: Examples of aminoaryl phosphines and iminoaryl phosphines (N—P Bidentates, N—P Tridentates, and N—P Tetradentates) that meet the requirements for use as “narrow band” valence stabilizers for Ce⁺⁴ include, but are not limited to: tri(2-aminophenyl)phosphine; tri(2-aminophenyl)phosphine oxide; and tri(2-aminophenyl)phosphine sulfide.

N—P Valence Stabilizer #2: Examples of heterocyclic rings containing one, two, three, or four nitrogen atoms and having at least one additional phosphorus atom binding site not in a ring (N—P Bidentates, N—P Tridentates, N—P Tetradentates, or N—P Hexadentates) that meet the requirements for use as “narrow band” valence stabilizers for Ce⁺⁴ include, but are not limited to: tri(2-imidazolyl)phosphine; tri(2-pyrrolyl)phosphine; tri(2-pyridyl)phosphine; tri(2-imidazolyl)phosphine oxide; tri(2-pyrrolyl)phosphine oxide; tri(2-pyridyl)phosphine oxide; tri(2-imidazolyl)phosphine sulfide; tri(2-pyrrolyl)phosphine sulfide; and tri(2-pyridyl)phosphine sulfide.

N—P Valence Stabilizer #3: Examples of heterocyclic rings containing one, two, or three phosphorus atoms and having at least one additional nitrogen atom binding site not in a ring (N—P Bidentates, N—P Tridentates, N—P Tetradentates, or N—P Hexadentates) that meet the requirements for use as “narrow band” valence stabilizers for Ce⁺⁴ include, but are not limited to: 2-aminophosphole; 2,5-diaminophosphole; 2-(aminomethyl)phosphole; 2,5-di(aminomethyl)phosphole; 2-aminophosphorin; 2,6-diaminophosphorin; 2-(aminomethyl)phosphorin; 2,6-di(aminomethyl)phosphorin; triaminocyclotriphosphazenes; and hexaminocyclotriphosphazenes.

N—P Valence Stabilizer #4: Examples of heterocyclic rings containing one, two, three, or four nitrogen atoms and having at least one additional phosphorus atom binding site in a separate ring (N—P Bidentates, N—P Tridentates, N—P Tetradentates) that meet the requirements for use as “narrow band” valence stabilizers for Ce⁺⁴ include, but are not limited to: 2-(2-pyrrolyl)phosphole; 2,5-di(2-pyrrolyl)phosphole; 2-(2-pyridyl)phosphorin; and 2,6-(2-pyridyl)phosphorin.

N—P Valence Stabilizer #5: Examples of two-, three-, four-, five-, six-, seven-, eight-, nine-, and ten-membered macrocyclics, macrobicyclics, and macropolycyclics (including catapinands, cryptands, cyclidenes, and sepulchrates) wherein all binding sites are composed of nitrogen (usually amine or imine groups) or phosphorus and are not contained in component heterocyclic rings (N—P Bidentates, N—P Tridentates, N—P Tetradentates, and N—P Hexadentates) that meet the requirements for use as “narrow band” valence stabilizers for Ce⁺⁴ include, but are not limited to: cyclobiphosphazenes; cyclotriphosphazenes; cyclotetraphosphazenes; cyclopentaphosphazenes; cyclohexaphosphazenes; diphosphatetraazacyclooctatetraenes; diphospha-s-triazines; and phospha-s-triazines.

N—P Valence Stabilizer #6: Examples of four-, five-, six-, seven-, eight-, nine-, or ten-membered macrocyclics, macrobicyclics, and macropolycyclics (including catapinands, cryptands, cyclidenes, and sepulchrates) wherein all binding sites are composed of nitrogen or phosphorus and are contained in component heterocyclic rings (N—P Bidentates, N—P Tridentates, N—P Tetradentates, or N—P Hexadentates) that meet the requirements for use as “narrow band” valence stabilizers for Ce⁺⁴ include, but are not limited to: diphospholedipyrroles; diphosphorindipyridines; triphospholetripyrroles; triphosphorintripyridines; tetraphospholetetrapyrroles; and tetraphosphorintetrapyridines.

N—P Valence Stabilizer #7: Examples of four-, five-, six-, seven-, eight-, nine-, or ten-membered macrocyclics, macrobicyclics, and macropolycyclics (including catapinands, cryptands, cyclidenes, and sepulchrates) wherein all binding sites are composed of nitrogen or phosphorus and are contained in a combination of heterocyclic rings and amine, imine, and phosphine groups (N—P Bidentates, N—P Tridentates, N—P Tetradentates, or N—P Hexadentates) that meet the requirements for use as “narrow band” valence stabilizers for Ce⁺⁴ include, but are not limited to: azaphosphatetraphyrins; diazadiphosphatetraphyrins; azaphosphahexaphyrins; diazadiphosphahexaphyrins; triazatriphosphahexaphyrins; and apholate.

S—P Valence Stabilizer #1: Examples of thioaryl phosphines (S—P Bidentates, S—P Tridentates, S—P Tetradentates, and S—P Hexadentates) that meet the requirements for use as “narrow band” valence stabilizers for Ce⁺⁴ include, but are not limited to: tri(2-mercaptophenyl)phosphine; tri(2-mercaptophenyl)phosphine oxide; and tri(2-mercaptophenyl)phosphine sulfide.

S—P Valence Stabilizer #2: Examples of heterocyclic rings containing one or two sulfur atoms and having at least one additional phosphorus atom binding site not in a ring (S—P Bidentates, S—P Tridentates, S—P Tetradentates, or S—P Hexadentates) that meet the requirements for use as “narrow band” valence stabilizers for Ce⁺⁴ include, but are not limited to: tri(2-thiophene)phosphine; tri(2-thiopyran)phosphine; tri(2-thiophene)phosphine oxide; tri(2-thiopyran)phosphine oxide; tri(2-thiophene)phosphine sulfide; and tri(2-thiopyran)phosphine sulfide.

S—P Valence Stabilizer #3: Examples of heterocyclic rings containing one, two, or three phosphorus atoms and having at least one additional sulfur atom binding site not in a ring (S—P Bidentates, S—P Tridentates, S—P Tetradentates, or S—P Hexadentates) that meet the requirements for use as “narrow band” valence stabilizers for Ce⁺⁴ include, but are not limited to: 2-mercaptophosphole; 2,5-dimercaptophosphole; 2-(mercaptomethyl)phosphole; 2,5-di(mercaptomethyl)phosphole; 2-mercaptophosphorin; 2,6-dimercaptophosphorin; 2-(mercaptomethyl)phosphorin; and 2,6-di(mercaptomethyl)phosphorin.

S—P Valence Stabilizer #4: Examples of heterocyclic rings containing one or two sulfur atoms and having at least one additional phosphorus atom binding site in a separate ring (S—P Bidentates, S—P Tridentates, S—P Tetradentates) that meet the requirements for use as “narrow band” valence stabilizers for Ce⁺⁴ include, but are not limited to: 2-(2-thienyl)phosphole; 2,5-di(2-thienyl)phosphole; 2-(2-thienyl)phosphorin; and 2,6-(2-thienyl)phosphorin.

S—P Valence Stabilizer #5: Examples of two-, three-, four-, five-, six-, seven-, eight-, nine-, and ten-membered macrocyclics, macrobicyclics, and macropolycyclics (including catapinands, cryptands, cyclidenes, and sepulchrates) wherein all binding sites are composed of sulfur (usually thiol, mercapto, or thiocarbonyl groups) or phosphorus and are not contained in component heterocyclic rings (S—P Bidentates, S—P Tridentates, S—P Tetradentates, and S—P Hexadentates) that meet the requirements for use as “narrow band” valence stabilizers for Ce⁺⁴ include, but are not limited to: phosphathiacyclobutane ([4]anePS); phosphathiacyclopentane ([5]anePS); phosphathiacyclohexane ([6]anePS); phosphathiacycloheptane ([7]anePS); phosphathiacyclooctane ([8]anePS); diphosphathiacyclohexane ([6]aneSP₂); diphosphathiacycloheptane ([7]aneSP₂); diphosphathiacyclooctane ([8]aneSP₂); diphosphathiacyclononane ([9]aneSP₂); diphosphathiacyclodecane ([10]aneSP₂); diphosphathiacycloundecane ([11]aneSP₂); diphosphathiacyclododecane ([12]aneSP₂); diphosphadithiacyclooctane ([8]aneS₂P₂); diphosphadithiacyclononane ([9]aneS₂P₂); diphosphadithiacyclodecane ([10]aneS₂P₂); diphosphadithiacycloundecane ([11]aneS₂P₂); diphosphadithiacyclododecane ([12]aneS₂P₂); diphosphadithiacyclotridecane ([13]aneS₂P₂); diphosphadithiacyclotetradecane ([14]aneS₂P₂); diphosphadithiacyclopentadecane ([15]aneS₂P₂); diphosphadithiacyclohexadecane ([16]aneS₂P₂); diphosphadithiacycloheptadecane ([17]aneS₂P₂); diphosphadithiacyclooctadecane ([18]aneS₂P₂); diphosphadithiacyclononadecane ([19]aneS₂P₂); diphosphadithiacycloeicosane ([20]aneS₂P₂).

S—P Valence Stabilizer #6: Examples of four-, five-, six-, seven-, eight-, nine-, or ten-membered macrocyclics, macrobicyclics, and macropolycyclics (including catapinands, cryptands, cyclidenes, and sepulchrates) wherein all binding sites are composed of sulfur or phosphorus and are contained in component heterocyclic rings (S—P Bidentates, S—P Tridentates, S—P Tetradentates, or S—P Hexadentates) that meet the requirements for use as “narrow band” valence stabilizers for Ce⁺⁴ include, but are not limited to: diphospholedithiophenes; diphosphorindithiopyrans; triphospholetrithiophenes; triphosphorintrithiopyrans; tetraphospholetetrathiophenes; and tetraphosphorintetrathiopyrans.

S—P Valence Stabilizer #7: Examples of four-, five-, six-, seven-, eight-, nine-, or ten-membered macrocyclics, macrobicyclics, and macropolycyclics (including catapinands, cryptands, cyclidenes, and sepulchrates) wherein all binding sites are composed of sulfur or phosphorus and are contained in a combination of heterocyclic rings and thiol, mercapto, thiocarbonyl, and phosphine groups (S—P Bidentates, S—P Tridentates, S—P Tetradentates, or S—P Hexadentates) that meet the requirements for use as “narrow band” valence stabilizers for Ce⁺⁴ include, but are not limited to: thiaphosphatetraphyrins; dithiadiphosphatetraphyrins; thiaphosphahexaphyrins; dithiadiphosphahexaphyrins; and trithiatriphosphahexaphyrins.

P—O Valence Stabilizer #1: Examples of hydroxyaryl phosphines (P—O Bidentates, P—O Tridentates, P—O Tetradentates, and P—O Hexadentates) that meet the requirements for use as “narrow band” valence stabilizers for Ce⁺⁴ include, but are not limited to: tri(2-hydroxyphenyl)phosphine; tri(2-hydroxyphenyl)phosphine oxide; and tri(2-hydroxyphenyl)phosphine sulfide. P—O Valence Stabilizer #2: Examples of heterocyclic rings containing one or two oxygen atoms and having at least one additional phosphorus atom binding site not in a ring (P—O Bidentates, P—O Tridentates, P—O Tetradentates, or P—O Hexadentates) that meet the requirements for use as “narrow band” valence stabilizers for Ce⁺⁴ include, but are not limited to: tri(2-furan)phosphine; tri(2-pyran)phosphine; tri(2-furan)phosphine oxide; tri(2-pyran)phosphine oxide; tri(2-furan)phosphine sulfide; and tri(2-pyran)phosphine sulfide.

P—O Valence Stabilizer #3: Examples of heterocyclic rings containing one, two, or three phosphorus atoms and having at least one additional oxygen atom binding site not in a ring (P—O Bidentates, P—O Tridentates, P—O Tetradentates, or P—O Hexadentates) that meet the requirements for use as “narrow band” valence stabilizers for Ce⁺⁴ include, but are not limited to: 2-hydroxyphosphole; 2,5-dihydroxyphosphole; 2-(hydroxymethyl)phosphole; 2,5-di(hydroxymethyl)phosphole; 2-hydroxyphosphorin; 2,6-dihydroxyphosphorin; 2-(hydroxymethyl)phosphorin; and 2,6-di(hydroxymethyl)phosphorin.

P—O Valence Stabilizer #4: Examples of heterocyclic rings containing one or two oxygen atoms and having at least one additional phosphorus atom binding site in a separate ring (P—O Bidentates, P—O Tridentates, P—O Tetradentates) that meet the requirements for use as “narrow band” valence stabilizers for Ce⁺⁴ include, but are not limited to: 2-(2-furyl)phosphole; 2,5-di(2-furyl)phosphole; 2-(2-furyl)phosphorin; and 2,6-(2-furyl)phosphorin.

P—O Valence Stabilizer #5: Examples of two-, three-, four-, five-, six-, seven-, eight-, nine-, and ten-membered macrocyclics, macrobicyclics, and macropolycyclics (including catapinands, cryptands, cyclidenes, and sepulchrates) wherein all binding sites are composed of oxygen (usually hydroxy, carboxy, or carbonyl groups) or phosphorus and are not contained in component heterocyclic rings (P—O Bidentates, P—O Tridentates, P—O Tetradentates, and P—O Hexadentates) that meet the requirements for use as “narrow band” valence stabilizers for Ce⁺⁴ include, but are not limited to: phosphaoxacyclobutane ([4]anePO); phosphaoxacyclopentane ([5]anePO); phosphaoxacyclohexane ([6]anePO); phosphaoxacycloheptane ([7]anePO); phosphaoxacyclooctane ([8]anePO); diphosphaoxacyclohexane ([6]aneOP₂); diphosphaoxacycloheptane ([7]aneOP₂); diphosphaoxacyclooctane ([8]aneOP₂); diphosphaoxacyclononane ([9]aneOP₂); diphosphaoxacyclodecane ([10]aneOP₂); diphosphaoxacycloundecane ([11]aneOP₂); diphosphaoxacyclododecane ([12]aneOP₂); diphosphadioxacyclooctane ([8]aneO₂P₂); diphosphadioxacyclononane ([9]aneO₂P₂); diphosphadioxacyclodecane ([10]aneO₂P₂); diphosphadioxacycloundecane ([11]aneO₂P₂); diphosphadioxacyclododecane ([12]aneO₂P₂); diphosphadioxacyclotridecane ([13]aneO₂P₂): diphosphadioxacyclotetradecane ([14]aneO₂P₂); diphosphadioxacyclopentadecane ([15]aneO₂P₂); diphosphadioxacyclohexadecane ([16]aneO₂P₂); diphosphadioxacycloheptadecane ([17]aneO₂P₂); diphosphadioxacyclooctadecane ([18]aneO₂P₂); diphosphadioxacyclononadecane ([19]aneO₂P₂); diphosphadioxacycloeicosane ([20]aneO₂P₂); and dioxaphospholane.

P—O Valence Stabilizer #6: Examples of four-, five-, six-, seven-, eight-, nine-, or ten-membered macrocyclics, macrobicyclics, and macropolycyclics (including catapinands, cryptands, cyclidenes, and sepulchrates) wherein all binding sites are composed of oxygen or phosphorus and are contained in component heterocyclic rings (P—O Bidentates, P—O Tridentates, P—O Tetradentates, or P—O Hexadentates) that meet the requirements for use as “narrow band” valence stabilizers for Ce⁺⁴ include, but are not limited to: diphospholedifurans; diphosphorindipyrans; triphospholetrifurans; triphosphorintripyrans; tetraphospholetetrafurans; and tetraphosphorintetrapyrans.

P—O Valence Stabilizer #7: Examples of four-, five-, six-, seven-, eight-, nine-, or ten-membered macrocyclics, macrobicyclics, and macropolycyclics (includingcatapinands, cryptands, cyclidenes, and sepulchrates) wherein all binding sites are composed of oxygen or phosphorus and are contained in a combination of heterocyclic rings and hydroxy, carboxy, carbonyl, and phosphine groups (P—O Bidentates, P—O Tridentates, P—O Tetradentates, or P—O Hexadentates) that meet the requirements for use as “narrow band” valence stabilizers for Ce⁺⁴ include, but are not limited to: oxaphosphatetraphyrins; dioxadiphosphatetraphyrins; oxaphosphahexaphyrins; dioxadiphosphahexaphyrins; and trioxatriphosphahexaphyrins.

As Valence Stabilizer #1: Examples of monoarsines (As Monodentates) that meet the requirements for use as “narrow band” valence stabilizers for Ce⁺⁴ include, but are not limited to: arsine, triphenylarsine, ticyclohexylarsine, methyldiphenylarsine, ethyldiphenylarsine, arsinonorbornane, and arsinoadamantane.

As Valence Stabilizer #2: Examples of diarsines (As Monodentates or As—As Bidentates) that meet the requirements for use as “narrow band” valence stabilizers for Ce⁺⁴ include, but are not limited to: bis(diphenylarsino)methane, bis(diphenylarsino)ethane, bis(diphenylarsino)propane, bis(diphenylarsino)butane, bis(diphenylarsino)pentane, 1,2-diarsinobenzene, cyclohexane-1,2-diarsine, 1,2-bis(phenylbutylarsino)ethane, o-phenylenebis(methylphenylarsine) and o-phenylenebis(dimethylarsine) (diars). [Note: the aryl derivatives are air-stable, whereas the alkyl derivatives are air-sensitive and therefore unsuitable for these applications.]

As Valence Stabilizer #3: Examples of triarsines (As—As Bidentates, or As—As Tridentates) that meet the requirements for use as “narrow band” valence stabilizers for Ce⁺⁴ include, but are not limited to: 1,1,5,9,9-pentaphenyl-1,5,9-triarsanonane, 3-methyl-3-(As,As-dimethyl)arsinomethyl-1,1,5,5-tetraphenyl-1,5-diarsapentane, As,As-[o-(As-dimethyl)arsinodiphenyl]-(As-phenyl)arsine, As,As-[o-(As-diphenyl)arsinodiphenyl]-(As-phenyl)arsine, hexahydro-2,4,6-trimethyl-1,3,5-triarsinazine. [Note: the aryl derivatives are air-stable, whereas the alkyl derivatives are air-sensitive and therefore unsuitable for these applications.]

As Valence Stabilizer #4: Examples of tetraarsines (As—As Bidentates, As—As Tridentates, or As—As Tetradentates) that meet the requirements for use as “narrow band” valence stabilizers for Ce⁺⁴ include, but are not limited to: 3,3-(As-diphenyl)arsinomethyl-1,1,5,5-tetraphenyl-1,5-diarsapentane. [Note: the aryl derivatives are air-stable, whereas the alkyl derivatives are air-sensitive and therefore unsuitable for these applications.]

As Valence Stabilizer #5: Examples of pentaarsines (As—As Bidentates, As—As Tridentates, or As—As Tetradentates) that meet the requirements for use as “narrow band” valence stabilizers for Ce⁺⁴ include, but are not limited to: 4-[2-(As-diphenyl)arsinoethyl]-1,1,7,10,10-pentaphenyl-1,4,7,10-tetraarsadecane. [Note: the aryl derivatives are air-stable, whereas the alkyl derivatives are air-sensitive and therefore unsuitable for these applications.]

As Valence Stabilizer #6: Examples of hexaarsines (As—As Bidentates, As—As Tridentates, As—As Tetradentates, or As—As Hexadentates) that meet the requirements for use as “narrow band” valence stabilizers for Ce⁺⁴ include, but are not limited to: o-phenylenebis[di-3-(As-diphenyl)arsinopropylarsine]. [Note: the aryl derivatives are air-stable, whereas the alkyl derivatives are air-sensitive and therefore unsuitable for these applications.]

As Valence Stabilizer #7: Examples of 5-membered heterocyclic rings containing one arsenic atom (As Monodentates) that meet the requirements for use as “narrow band” valence stabilizers for Ce⁺⁴ include, but are not limited to: arsole, azarsole, diazarsole, benzarsole, benzazarsole, dibenzarsole, naphtharsole, naphthazarsole.

As Valence Stabilizer #8: Examples of 6-membered heterocyclic rings containing one arsenic atom (As Monodentates) that meet the requirements for use as “narrow band” valence stabilizers for Ce⁺⁴ include, but are not limited to: arsenin, azarsenin, diazarsenin, benzarsenin, benzazarsenin, dibenzarsenin, naphtharsenin, and naphthazarsenin.

As Valence Stabilizer #9: Examples of 5-membered heterocyclic rings containing one arsenic atom and having at least one additional arsenic atom binding site not contained in a ring (As Monodentates, As—As Bidentates, As—As Tridentates, As—As Tetradentates, or As—As Hexadentates) that meet the requirements for use as “narrow band” valence stabilizers for Ce⁺⁴ include, but are not limited to: 2-(As-phenylarsino)arsole; 2,5-(As-phenylarsino)arsole; 2-(As-phenylarsino)benzarsole; 7-(As-phenylarsino)benzarsole; and 1,8-(As-phenylarsino)dibenzarsole.

As Valence Stabilizer #10: Examples of 6-membered heterocyclic rings containing one arsenic atom and having at least one additional arsenic atom binding site not contained in a ring (As Monodentates, As—As Bidentates, As—As Tridentates, As—As Tetradentates, or As—As Hexadentates) that meet the requirements for use as “narrow band” valence stabilizers for Ce⁺⁴ include, but are not limited to: 2-(As-phenylarsino)arsenin; 2,5-(As-phenylarsino)arsenin; 2-(As-phenylarsino)benzarsenin; 7-(As-phenylarsino)benzarsenin; and 1,9-(As-phenylarsino)dibenzarsenin.

As Valence Stabilizer #11: Examples of 5-membered heterocyclic rings containing one arsenic atom and having at least one additional arsenic atom binding site contained in a ring (As Monodentates, As—As Bidentates, As—As Tridentates, As—As Tetradentates) that meet the requirements for use as “narrow band” valence stabilizers for Ce⁺⁴ include, but are not limited to: 2,2′-biarsole; 2,2′,2″-triarsole; and 2,2′-bibenzarsole.

As Valence Stabilizer #12: Examples of 6-membered heterocyclic rings containing one arsenic atom and having at least one additional arsenic atom binding site contained in a ring (As Monodentates, As—As Bidentates, As—As Tridentates, As—As Tetradentates) that meet the requirements for use as “narrow band” valence stabilizers for Ce⁺⁴ include, but are not limited to: 2,2′-biarsenin; 2,2′,2″-triarsenin; 2,2′,2″,2′″-tetraarsenin; 2,2′-bibenzarsenin; and 8,8′-bibenzarsenin.

As Valence Stabilizer #13a: Examples of two-membered macrocyclics, macrobicyclics, and macropolycyclics (including catapinands, cryptands, cyclidenes, and sepulchrates) wherein both binding sites are composed of arsenic and are not contained in component heterocyclic rings (As—As Bidentates) that meet the requirements for use as “narrow band” valence stabilizers for Ce⁺⁴ include, but are not limited to: As,As-diphenyldiarsacyclobutane ([4]aneAs₂); As,As-diphenyldiarsacyclopentane ([5]aneAs₂); As,As-diphenyldiarsacyclohexane ([6]aneAs₂); As,As-diphenyldiarsacycloheptane ([7]aneAs₂); As,As-diphenyldiarsacyclooctane ([8]aneAs₂); As,As-diphenyldiarsacyclobutene ([4]eneAs₂); As,As-diphenyldiarsacyclopentene ([5]eneAs₂); As,As-diphenyldiarsacyclohexene ([6]eneAs₂); As,As-diphenyldiarsacycloheptene ([7]eneAs₂); and As,As-diphenyldiarsacyclooctene ([8]eneAs₂).

As Valence Stabilizer #13b: Examples of three-membered macrocyclics, macrobicyclics, and macropolycyclics (including catapinands, cryptands, cyclidenes, and sepulchrates) wherein all binding sites are composed of arsenic and are not contained in component heterocyclic rings (As—As Tridentates) that meet the requirements for use as “narrow band” valence stabilizers for Ce⁺⁴ include, but are not limited to: As,As,As-triphenyltriarsacyclohexane ([6]aneAs₃); As,As,As-triphenyltriarsacycloheptane ([7]aneAs₃); As,As,As-triphenyltriarsacyclooctane ([8]aneAs₃); As,As,As-triphenyltriarsacyclononane ([9]aneAs₃); As,As,As-triphenyltriarsacyclodecane ([10]aneAs₃); As,As,As-triphenyltriarsacycloundecane ([11]aneAs₃); As,As,As-triphenyltriarsacyclododecane ([12]aneAs₃); As,As,As-triphenyltriarsacyclohexatriene ([6]trieneAs₃); As,As,As-triphenyltriarsacycloheptatriene ([7]trieneAs₃); As,As,As-triphenyltriarsacyclooctatriene ([8]trieneAs₃); As,As,As-triphenyltriarsacyclononatriene ([9]trieneAs₃); As,As,As-triphenyltriarsacyclodecatriene ([10]trieneAs₃); As,As,As-triphenyltriarsacycloundecatriene ([11]trieneAs₃); and As,As,As-triphenyltriarsacyclododecatriene ([12]trieneAs₃).

As Valence Stabilizer #13c: Examples of four-membered macrocyclics, macrobicyclics, and macropolycyclics (including catapinands, cryptands, cyclidenes, and sepulchrates) wherein all binding sites are composed of arsenic and are not contained in component heterocyclic rings (As—As Tetradentates) that meet the requirements for use as “narrow band” valence stabilizers for Ce⁺⁴ include, but are not limited to: As,As,As,As-tetraphenyltetraarsacyclooctane ([8]aneAs₄); As,As,As,As-tetraphenyltetraarsacyclononane ([9]aneAs₄); As,As,As,As-tetraphenyltetraarsacyclodecane ([10]aneAs₄); As,As,As,As-tetraphenyltetraarsacycloundecane ([11]aneAs₄); As,As,As,As-tetraphenyltetraarsacyclododecane ([12]aneAs₄); As,As,As,As-tetraphenyltetraarsacyclotridecane ([13]aneAs₄); As,As,As,As-tetraphenyltetraarsacyclotetradecane ([14]aneAs₄); As,As,As,As-tetraphenyltetraarsacyclopentadecane ([15]aneAs₄); As,As,As,As-tetraphenyltetraarsacyclohexadecane ([16]aneAs₄); As,As,As,As,As-tetraphenyltetraarsacycloheptadecane ([17]aneAs₄); As,As,As,As-tetraphenyltetraarsacyclooctadecane ([18]aneAs₄); As,As,As,As-tetraphenyltetraarsacyclononadecane ([19]aneAs₄); and As,As,As,As-tetraphenyltetraarsacycloeicosane ([20]aneAs₄).

As Valence Stabilizer #13d: Examples of six-membered macrocyclics, macrobicyclics, and macropolycyclics (including catapinands, cryptands, cyclidenes, and sepulchrates) wherein all binding sites are composed of arsenic and are not contained in component heterocyclic rings (As—As Tridentates, As—As Tetradentates, or As—As Hexadentates) that meet the requirements for use as “narrow band” valence stabilizers for Ce⁺⁴ include, but are not limited to: As,As,As,As,As,As-hexaphenylhexaarsacyclododecane ([12]aneAs₆); As—As,As,As,As,As-hexaphenylhexaarsacyclotridecane ([13]aneAs₆); As,As,As,As,As,As-hexaphenylhexaarsacyclotetradecane ([14]aneAs₆); As,As,As,As,As,As-hexaphenylhexaarsacyclopentadecane ([15]aneAs₆); As,As,As,As,As,As-hexaphenylhexaarsacyclohexadecane ([16]aneAs₆); As,As,As,As,As,As-hexaphenylhexaarsacycloheptadecane ([17]aneAs₆); As,As,As,As,As,As-hexaphenylhexaarsacyclooctadecane ([18]aneAs₆); As,As,As,As,As,As-hexaphenylhexaarsacyclononadecane ([19]aneAs₆); As,As,As,As,As,As-hexaphenylhexaarsacycloeicosane ([20]aneAs₆); As,As,As,As,As,As-hexaphenylhexaarsacycloheneicosane ([21]aneAs₆); As,As,As,As,As,As-hexaphenylhexaarsacyclodocosane ([22]aneAs₆); As,As,As,As,As,As-hexaphenylhexaarsacyclotricosane ([23]aneAs₆); and As,As,As,As,As,As-hexaphenylhexaarsacyclotetracosane ([24]aneAs₆).

Valence Stabilizer #14a: Examples of four-membered macrocyclics, macrobicyclics, and macropolycyclics (including catapinands, cryptands, cyclidenes, and sepulchrates) wherein all four binding sites are composed of arsenic and are contained in component 5-membered heterocyclic rings (As—As Tetradentates) that meet the requirements for use as “narrow band” valence stabilizers for Ce⁺⁴ include, but are not limited to: tetraarsoles.

As Valence Stabilizer #14b: Examples of six-membered macrocyclics, macrobicyclics, and macropolycyclics (including catapinands, cryptands, cyclidenes, and sepulchrates) wherein all six binding sites are composed of arsenic and are contained in component 5-membered heterocyclic rings (As—As Tetradentates and As—As Hexadentates) that meet the requirements for use as “narrow band” valence stabilizers for Ce⁺⁴ include, but are not limited to: hexaarsoles.

As Valence Stabilizer #15a: Examples of four-membered macrocyclics, macrobicyclics, and macropolycyclics (including catapinands, cryptands, cyclidenes, and sepulchrates) wherein all four binding sites are composed of arsenic and are contained in a combination of 5-membered heterocyclic rings and arsine groups (As—As Tridentates, As—As Tetradentates) that meet the requirements for use as “narrow band” valence stabilizers for Ce⁺⁴ include, but are not limited to: diarsatetraarsoles; and tetraarsatetraarsoles.

As Valence Stabilizer #15b: Examples of six-membered macrocyclics, macrobicyclics, and macropolycyclics (including catapinands, cryptands, cyclidenes, and sepulchrates) wherein all six binding sites are composed of arsenic and are contained in a combination of 5-membered heterocyclic rings and phosphine groups (As—As Tridentates, As—As Tetradentates, and As—As Hexadentates) that meet the requirements for use as “narrow band” valence stabilizers for Ce⁺⁴ include, but are not limited to: diarsahexaarsoles; and triarsahexaarsoles.

As Valence Stabilizer #16a: Examples of four-membered macrocyclics, macrobicyclics, and macropolycyclics (including catapinands, cryptands, cyclidenes, and sepulchrates) wherein all four binding sites are composed of arsenic and are contained in component 6-membered heterocyclic rings (As—As Tetradentates) that meet the requirements for use as “narrow band” valence stabilizers for Ce⁺⁴ include, but are not limited to: cyclotetraarsenins.

As Valence Stabilizer #16b: Examples of six-membered macrocyclics, macrobicyclics, and macropolycyclics (including catapinands, cryptands, cyclidenes, and sepulchrates) wherein all six binding sites are composed of arsenic and are contained in component 6-membered heterocyclic rings (As—As Tridentates, As—As Tetradentates, and As—As Hexadentates) that meet the requirements for use as “narrow band” valence stabilizers for Ce⁺⁴ include, but are not limited to: cyclohexaarsenins.

As Valence Stabilizer #17a: Examples of four-membered macrocyclics, macrobicyclics, and macropolycyclics (including catapinands, cryptands, cyclidenes, and sepulchrates) wherein all four binding sites are composed of arsenic and are contained in a combination of 6-membered heterocyclic rings and arsine groups (As—As Tridentates, As—As Tetradentates, or As—As Hexadentates) that meet the requirements for use as “narrow band” valence stabilizers for Ce⁺⁴ include, but are not limited to: diarsacyclotetraarsenins; and tetraarsacyclotetraarsenins.

As Valence Stabilizer #17b: Examples of six-membered macrocyclics, macrobicyclics, and macropolycyclics (including catapinands, cryptands, cyclidenes, and sepulchrates) wherein all six binding sites are composed of arsenic and are contained in a combination of 6-membered heterocyclic rings and arsine groups (As—As Tridentates, As—As Tetradentates, or As—As Hexadentates) that meet the requirements for use as “narrow band” valence stabilizers for Ce⁺⁴ include, but are not limited to: diarsacyclohexaarsenins; and triarsacyclohexaarsenins.

Se Valence Stabilizer #1: Examples of monoselenoethers (Se Monodentates) that meet the requirements for use as “narrow band” valence stabilizers for Ce⁺⁴ include, but are not limited to: hydrogen selenide, dimethyl selenide, diethyl selenide, dioctyl selenide, diphenyl selenide, dicyclohexyl selenide, tetramethylene selenide, trimethylene selenide, dimethylene selenide, and selenobicycloheptane.

Se Valence Stabilizer #2: Examples of diselenoethers (Se Bidentates) that meet the requirements for use as “narrow band” valence stabilizers for Ce⁺⁴ include, but are not limited to: 2,5-dimethyl-3,6-diselenaoctane; 2,5-diselenahexane; 2,6-diselenaheptane; 3,7-diselenanonane; 3,6-diselenaoctane; 3-butenyl butyl selenoether (bbs); 4pentenyl butyl selenoether (pbs); 3-butenyl phenyl selenoether (bps); and 4-pentenyl phenyl selenoether (pps).

Se Valence Stabilizer #3: Examples of triselenoethers (Se Bidentates or Se Tridentates) that meet the requirements for use as “narrow band” valence stabilizers for Ce⁺⁴ include, but are not limited to: 1,3,5-triselenane; 2,5,8-triselenanonane; 3,6,9-triselenaundecane; and 2,6,10-triselenaundecane.

Se Valence Stabilizer #4: Examples of tetraselenoethers (Se Bidentates, Se Tridentates, or Se Tetradentates) that meet the requirements for use as “narrow band” valence stabilizers for Ce⁺⁴ include, but are not limited to: 2,6,10,14-tetraselenapentadecane and 2,5,8,11-tetraselenadodecane.

Se Valence Stabilizer #5a: Examples of 5-membered heterocyclic rings containing one selenium atom (Se Monodentates) that meet the requirements for use as “narrow band” valence stabilizers for Ce⁺⁴ include, but are not limited to: dihydroselenophene, selenophene, selenazole, selenapyrroline, selenaphospholene, selenaphosphole, oxaselenole, selenadiazole, selenatriazole, benzodihydroselenophene, benzoselenophene, benzoselenazole, benzoselenaphosphole, dibenzoselenophene, and naphthoselenophene.

Se Valence Stabilizer #5b: Examples of 5-membered heterocyclic rings containing two selenium atoms (Se Monodentates or Se Bidentates) that meet the requirements for use as “narrow band” valence stabilizers for Ce⁺⁴ include, but are not limited to: diselenole, benzodiselenole, and naphthodiselenole.

Se Valence Stabilizer #6a: Examples of 6-membered heterocyclic rings containing one selenium atom (Se Monodentates) that meet the requirements for use as “narrow band” valence stabilizers for Ce⁺⁴ include, but are not limited to: dihydroselenopyran, selenopyran, selenazine, selenadiazine, selenaphosphorin, selenadiphosphorin, oxaselenin, benzoselenopyran, dibenzoselenopyran, and naphthoselenopyran.

Se Valence Stabilizer #6b: Examples of 6-membered heterocyclic rings containing two selenium atoms (Se Monodentates or Se Bidentates)that meet the requirements for use as “narrow band” valence stabilizers for Ce⁺⁴ include, but are not limited to: dihydrodiselenin, diselenin, benzodiselenin, dibenzodiselenin, and naphthodiselenin.

Se Valence Stabilizer #7: Examples of 5-membered heterocyclic rings containing one selenium atom and having at least one additional selenium atom binding site not contained in a ring (Se Monodentates, Se—Se Bidentates, Se—Se Tridentates, Se—Se Tetradentates, or Se—Se Hexadentates) that meet the requirements for use as “narrow band” valence stabilizers for C⁺⁴ include, but are not limited to: 2,5-diseleno-2,5-dihydroselenophene; 2,5-bis(selenomethyl)-2,5-dihydroselenophene; 2,5-bis(2-selenophenyl)-2,5-dihydroselenophene; 2,5-diseleno(selenophene); 2,5-bis(selenomethyl)selenophene; 2,5-bis(2-selenophenyl)selenophene; 2,5-diseleno(selenazole); 2,5-bis(selenomethyl)selenazole; 2,5-bis(2-selenophenyl)selenazole; and 2,5-diseleno-1,3,4-selenadiazole [bismuthselenol].

Se Valence Stabilizer #8: Examples of 6-membered heterocyclic rings containing one selenium atom and having at least one additional selenium atom binding site not contained in a ring (Se Monodentates, Se—Se Bidentates, Se—Se Tridentates, Se—Se Tetradentates, or Se—Se Hexadentates) that meet the requirements for use as “narrow band” valence stabilizers for C⁺⁴ include, but are not limited to: 2,6-diseleno-2,5-dihydroselenopyran; 2,6-bis(selenomethyl)-2,5-dihydroselenopyran; 2,6-bis(2-selenophenyl)-2,5-dihydroselenopyran; 2,6-diseleno(selenopyran); 2,6-bis(selenomethyl)selenopyran; 2,6-bis(2-selenophenyl)selenopyran; 2,6-diseleno(selenazine); 2,6-bis(selenomethyl)selenazine; 2,6-bis(2-selenophenyl)selenazine; 2,6-diseleno-1,3,5-selenadiazine; 2-seleno-1-benzoselenopyran; 8-seleno-1-benzoselenopyran; and 1,9-diselenodibenzoselenopyran.

Se Valence Stabilizer #9: Examples of 5-membered heterocyclic rings containing one selenium atom and having at least one additional selenium atom binding site contained in a ring (Se Monodentates, Se—Se Bidentates, Se—Se Tridentates, Se—Se Tetradentates) that meet the requirements for use as “narrow band” valence stabilizers for Ce⁺⁴ include, but are not limited to: 2,2′-bi-2,5-dihydroselenophene; 2,2′,2″-tri-2,5-dihydroselenophene; 2,2′-biselenophene; 2,2′,2″-triselenophene; 2,2′-biselenazole; 5,5′-biselenazole; 2,2′-bi-1,3,4-selenadiazole; 2,2′-biselenanaphthene; 2,2′-bibenzoselenazole; and 1,1′-bis(dibenzoselenophene).

Se Valence Stabilizer #10: Examples of 6-membered heterocyclic rings containing one selenium atom and having at least one additional selenium atom binding site contained in a ring (Se Monodentates, Se—Se Bidentates, Se—Se Tridentates, Se—Se Tetradentates) that meet the requirements for use as “narrow band” valence stabilizers for Ce⁺⁴ include, but are not limited to: 2,2′-bi-2,5-dihydroselenopyran; 2,2′,2″-tri-2,5-dihydroselenopyran; 2,2′-biselenopyran; 2,2′,2″-triselenopyran; 2,2′-bi-1,4-selenazine; 2,2′-bi-1,3,5-selenadiazine; 2,2′-bi-1-benzoselenopyran; and 1,1′-bis(dibenzoselenopyran).

Se Valence Stabilizer #11a: Examples of two-membered macrocyclics, macrobicyclics, and macropolycyclics (including catapinands, cryptands, cyclidenes, and sepulchrates) wherein both binding sites are composed of selenium (usually selenol or selenoether groups) and are not contained in component heterocyclic rings (Se—Se Bidentates) that meet the requirements for use as “narrow band” valence stabilizers for Ce⁺⁴ include, but are not limited to: diselenacyclobutane ([4]aneSe₂); diselenacyclopentane ([5]aneSe₂); diselenacyclohexane ([6]aneSe₂); diselenacycloheptane ([7]aneSe₂); diselenacyclooctane ([8]aneSe₂); diselenacyclobutene ([4]eneSe₂); diselenacyclopentene ([5]eneSe₂); diselenacyclohexene ([6]eneSe₂); diselenacycloheptene ([7]eneSe₂); diselenacyclooctene ([8]eneSe₂); diselenacyclobutadiene ([4]dieneSe₂); diselenacyclopentadiene ([5]dieneSe₂); diselenacyclohexadiene ([6]dieneSe₂); diselenacycloheptadiene ([7]dieneSe₂); and diselenacyclooctadiene ([8]dieneSe₂).

Se Valence Stabilizer #11b: Examples of three-membered macrocyclics, macrobicyclics, and macropolycyclics (including catapinands, cryptands, cyclidenes, and sepulchrates) wherein all binding sites are composed of selenium (usually selenol or selenoether groups) and are not contained in component heterocyclic rings (Se—Se Tridentates) that meet the requirements for use as “narrow band” valence stabilizers for Ce⁺⁴ include, but are not limited to: triselenacyclohexane ([6]aneSe₃); triselenacycloheptane ([7]aneSe₃); triselenacyclooctane ([8]aneSe₃); triselenacyclononane ([9]aneSe₃); triselenacyclodecane ([10]aneSe₃); triselenacycloundecane ([11]aneSe₃); triselenacyclododecane ([12]aneSe₃); triselenacyclohexene ([6]eneSe₃); triselenacycloheptene ([7]eneSe₃); triselenacyclooctene ([8]eneSe₃); triselenacyclononene ([9]eneSe₃); triselenacyclodecene ([10]eneSe₃); triselenacycloundecene ([11]eneSe₃); triselenacyclododecene ([12]eneSe₃); triselenacyclohexatriene ([6]trieneSe₃). triselenacycloheptatriene ([7]trieneSe₃); triselenacyclooctatriene ([8]trieneSe₃); triselenacyclononatriene ([9]trieneSe₃); triselenacyclodecatriene ([10]trieneSe₃); triselenacycloundecatriene ([11]trieneSe₃); and triselenacyclododecatriene ([12]trieneSe₃).

Se Valence Stabilizer #11c: Examples of four-membered macrocyclics, macrobicyclics, and macropolycyclics (including catapinands, cryptands, cyclidenes, and sepulchrates) wherein all binding sites are composed of selenium (usually selenol or selenoether groups) and are not contained in component heterocyclic rings (Se—Se Tetradentates) that meet the requirements for use as “narrow band” valence stabilizers for Ce⁺⁴ include, but are not limited to: tetraselenacyclooctane ([8]aneSe₄); tetraselenacyclononane ([9]aneSe₄); tetraselenacyclodecane ([10]aneSe₄); tetraselenacycloundecane ([11]aneSe₄); tetraselenacyclododecane ([12]aneSe₄); tetraselenacyclotridecane ([13]aneSe₄); tetraselenacyclotetradecane ([14]aneSe₄); tetraselenacyclopentadecane ([15]aneSe₄); tetraselenacyclohexadecane ([16]aneSe₄); tetraselenacycloheptadecane ([17]aneSe₄); tetraselenacyclooctadecane ([18]aneSe₄); tetraselenacyclononadecane ([19]aneSe₄); tetraselenacycloeicosane ([20]aneSe₄); tetraselenacyclooctadiene ([8]dieneSe₄); tetraselenacyclononadiene ([9]dieneSe₄); tetraselenacyclodecadiene ([10]dieneSe₄); tetraselenacycloundecadiene ([11]dieneSe₄); tetraselenacyclododecadiene ([12]dieneSe₄); tetraselenacyclotridecadiene ([13]dieneSe₄); tetraselenacyclotetradecadiene ([14]dieneSe₄); tetraselenacyclopentadecadiene ([15]dieneSe₄); tetraselenacyclohexadecadiene ([16]dieneSe₄); tetraselenacycloheptadecadiene ([17]dieneSe₄); tetraselenacyclooctadecadiene ([18]dieneSe₄); tetraselenacyclononadecadiene ([19]dieneSe₄); tetraselenacycloeicosadiene ([20]dieneSe₄); tetraselenacyclooctatetradiene ([8]tetradieneSe₄); tetraselenacyclononatetradiene ([9]tetradieneSe₄); tetraselenacyclodecatetradiene ([10]tetradieneSe₄); and tetraselenacycloundecatetradiene ([11]tetradieneSe₄).

Se Valence Stabilizer #11d: Examples of six-membered macrocyclics, macrobicyclics, and macropolycyclics (including catapinands, cryptands, cyclidenes, and sepulchrates) wherein all binding sites are composed of selenium (usually selenol or selenoether groups) and are not contained in component heterocyclic rings (Se—Se Tridentates, Se—Se Tetradentates, or Se—Se Hexadentates) that meet the requirements for use as “narrow band” valence stabilizers for Ce⁺⁴ include, but are not limited to: hexaselenacyclododecane ([12]aneSe₆); hexaselenacyclotridecane ([13]aneSe₆); hexaselenacyclotetradecane ([14]aneSe₆); hexaselenacyclopentadecane ([15]aneSe₆); hexaselenacyclohexadecane ([16]aneSe₆); hexaselenacycloheptadecane ([17]aneSe₆); hexaselenacyclooctadecane ([18]aneSe₆); hexaselenacyclononadecane ([9]aneSe₆); hexaselenacycloeicosane ([20]aneSe₆); hexaselenacycloheneicosane ([21]aneSe₆); hexaselenacyclodocosane ([22]aneSe₆); hexaselenacyclotricosane ([23]aneSe₆); hexaselenacyclotetracosane ([24]aneSe₆); hexaselenacyclododecatriene ([12]trieneSe₆); hexaselenacyclotridecatriene ([13]trieneSe₆); hexaselenacyclotetradecatriene ([14]trieneSe₆); hexaselenacyclopentadecatriene ([15]trieneSe₆); hexaselenacyclohexadecatriene ([16]trieneSe₆); hexaselenacycloheptadecatriene ([17]trieneSe₆); and hexaselenacyclooctadecatriene ([18]trieneSe₆).

Se Valence Stabilizer #12a: Examples of four-membered macrocyclics, macrobicyclics, and macropolycyclics (including catapinands, cryptands, cyclidenes, and sepulchrates) wherein all four binding sites are composed of selenium and are contained in component 5-membered heterocyclic rings (Se—Se Tetradentates) that meet the requirements for use as “narrow band” valence stabilizers for Ce⁺⁴ include, but are not limited to: tetraselenophenes; tetraselenaphospholes; tetraoxaselenoles; and tetradiselenoles.

Se Valence Stabilizer #12b: Examples of six-membered macrocyclics, macrobicyclics, and macropolycyclics (including catapinands, cryptands, cyclidenes, and sepulchrates) wherein all six binding sites are composed of selenium and are contained in component 5-membered heterocyclic rings (Se—Se Tridentates or Se—Se Tetradentates) that meet the requirements for use as “narrow band” valence stabilizers for Ce⁺⁴ include, but are not limited to: hexaselenophenes; hexaselenaphospholes; hexaoxaselenoles; and hexadiselenoles.

Se Valence Stabilizer #13a: Examples of four-membered macrocyclics, macrobicyclics, and macropolycyclics (including catapinands, cryptands, cyclidenes, and sepulchrates) wherein all four binding sites are composed of selenium and are contained in a combination of 5-membered heterocyclic rings and selenol and selenoether groups (Se—Se Tetradentates) that meet the requirements for use as “narrow band” valence stabilizers for Ce⁺⁴ include, but are not limited to: diselenatetraselenophenes; tetraselenatetraselenophenes; diselenatetradiselenoles; and tetraselenatetradiselenoles.

Se Valence Stabilizer #13b: Examples of six-membered macrocyclics, macrobicyclics, and macropolycyclics (including catapinands, cryptands, cyclidenes, and sepulchrates) wherein all six binding sites are composed of selenium and are contained in a combination of 5-membered heterocyclic rings and selenol or selenoether groups (Se—Se Tridentates or Se—Se Hexadentates) that meet the requirements for use as “narrow band” valence stabilizers for C⁺⁴ include, but are not limited to: diselenahexaselenophenes; and triselenahexaselenophenes.

Se Valence Stabilizer #14a: Examples of four-membered macrocyclics, macrobicyclics, and macropolycyclics (including catapinands, cryptands, cyclidenes, and sepulchrates) wherein all four binding sites are composed of selenium and are contained in component 6-membered heterocyclic rings (Se—Se Tetradentates) that meet the requirements for use as “narrow band” valence stabilizers for Ce⁺⁴ include, but are not limited to: tetraselenopyrans; tetraselenaphosphorins; tetraselenadiphosphorins; tetraoxaselenins; and tetradiselenins.

Se Valence Stabilizer #14b: Examples of six-membered macrocyclics, macrobicyclics, and macropolycyclics (including catapinands, cryptands, cyclidenes, and sepulchrates) wherein all six binding sites are composed of selenium and are contained in component 6-membered heterocyclic rings (Se—Se Tridentates or Se—Se Hexadentates) that meet the requirements for use as “narrow band” valence stabilizers for Ce⁺⁴ include, but are not limited to: hexaselenopyrans; hexaselenaphosphorins; hexaselenadiphosphorins; hexaoxaselenins; and hexadiselenins.

Se Valence Stabilizer #15a: Examples of four-membered macrocyclics, macrobicyclics, and macropolycyclics (including catapinands, cryptands, cyclidenes, and sepulchrates) wherein all four binding sites are composed of selenium and are contained in a combination of 6-membered heterocyclic rings and selenol or selenoether groups (Se—Se Tetradentates) that meet the requirements for use as “narrow band” valence stabilizers for Ce⁺⁴ include, but are not limited to: diselenatetraselenopyrans; tetraselenatetraselenopyrans; diselenatetraselenaphosphorins; tetraselenatetraselenaphosphorins; diselenatetraoxaselenins; tetraselenatetraoxaselenins; diselenatetradiselenins; and tetraselenatetradiselenins.

Se Valence Stabilizer #15b: Examples of six-membered macrocyclics, macrobicyclics, and macropolycyclics (including catapinands, cryptands, cyclidenes, and sepulchrates) wherein all six binding sites are composed of selenium and are contained in a combination of 6-membered heterocyclic rings and selenol or selenoether groups (Se—Se Tridentates, Se—Se Tetradentates, or Se—Se Hexadentates) that meet the requirements for use as “narrow band” valence stabilizers for Ce⁺⁴ include, but are not limited to: diselenahexaselenopyrans; triselenahexaselenopyrans; diselenahexaselenaphosphorins; triselenahexaselenaphosphorins; diselenahexaoxaselenins; triselenahexaoxaselenins; diselenahexadiselenins; and triselenahexadiselenins.

Se Valence Stabilizer #16: Examples of 1,3-diselenoketones (diseleno-beta-ketonates), 1,3,5-triselenoketones, bis(1,3-diselenoketones), and poly(1,3-diselenoketones) (Se—Se Bidentates, Se—Se Tridentates, Se—Se Tetradentates) that meet the requirements for use as “narrow band” valence stabilizers for Ce⁺⁴ include, but are not limited to: hexafluoropentanediselenone; 1,3-diphenyl-1,3-propanediselenone; selenobenzoylselenopinacolone; diselenocyclohexoylmethane; diphenylpentanetriselenoate; tetramethylnonanetriselenoate; hexafluoroheptanetriselenoate; trifluoroheptanetriselenoate; 1-(2-thienyl)-1,3-butanediselenone, 1-(2-naphthyl)-1,3-butanediselenone, and trifluoroselenoacetylselenocamphor.

Se Valence Stabilizer #17: Examples of 1,1-diselenolates, bis(1,1-diselenolates), and poly(1,1-diselenolates) (Se—Se Bidentates and Se—Se Tetradentates) that meet the requirements for use as “narrow band” valence stabilizers for Ce⁺⁴ include, but are not limited to: 1,1-dicyano-2,2-ethylene diselenolate; 1,1-dicarboalkoxy-2,2-ethylenediselenolate; 1,1-di(trifluoromethyl)-2,2-ethylene diselenolate; 1,1-di(pentafluorophenyl)-2,2-ethylene diselenolate; 1-pentamethylene-2,2-ethylene diselenolate; and 1-nitroethylene diselenolate.

Se Valence Stabilizer #18: Examples of diselenocarbamates, bis(diselenocarbamates), and poly(diselenocarbamates) (including N-hydroxydiselenocarbamates and N-mercaptodiselenocarbamates) (Se—Se Bidentates, Se—Se Tridentates, and Se—Se Tetradentates) that meet the requirements for use as “narrow band” valence stabilizers for Ce⁺⁴ include, but are not limited to: dimethyldiselenocarbamate; di(trifluorodimethyl)diselenocarbamate; diethyldiselenocarbamate; dipropyldiselenocarbamate; diisopropyldiselenocarbamate; dibutyldiselenocarbamate; ditertbutyldiselenocarbamate; dicyanamidodiselenocarbamate; azidoselenoformates; diphenyldiselenocarbamate; di(pentafluorophenyl)diselenocarbamate; dibenzyldiselenocarbamate; dinaphthyldiselenocarbamate; dicyclohexyldiselenocarbamate; dinorbornyldiselenocarbamate; diadamantyldiselenocarbamate; pyrrolidinodiselenocarbamate; piperidinodiselenocarbamate; morpholinodiselenocarbamate; thiamorpholinodiselenocarbamate; 3-pyrrolinodiselenocarbamate; pyrrolodiselenocarbamate; oxazolodiselenocarbamate; isoxazolodiselenocarbamate; thiazolodiselenocarbamate; isothiazolodiselenocarbamate; indolodiselenocarbamate; carbazolodiselenocarbamate; pyrazolinodiselenocarbamate; imidazolinodiselenocarbamate; pyrazolodiselenocarbamate; imidazolodiselenocarbamate; indazolodiselenocarbamate; and triazolodiselenocarbamate.

Se Valence Stabilizer #19: Examples of triselenophosphoric acids (phosphorotriselenoic acids), bis(triselenophosphoric acids), poly(triselenophosphoric acids), and derivatives thereof (Se—Se Bidentates, Se—Se Tridentates, Se—Se Tetradentates) that meet the requirements for use as “narrow band” valence stabilizers for Ce⁺⁴ include, but are not limited to: triselenophosphoric acid, O-phenyltriselenophosphoric acid, O-benzyltriselenophosphoric acid, O-cyclohexyltriselenophosphoric acid, O-norbornyltriselenophosphoric acid, O,Se-diphenyltriselenophosphoric acid, O,Se-dibenzyltriselenophosphoric acid, O,Se-dicyclohexyltriselenophosphoric acid, and O,Se-dinorbornyltriselenophosphoric acid.

Se Valence Stabilizer #20: Examples of diselenophosphoric acids (phosphorodiselenoic acids), bis(diselenophosphoric acids), poly(diselenophosphoric acids), and derivatives thereof (Se—Se Bidentates, Se—Se Tridentates, Se—Se Tetradentates) that meet the requirements for use as “narrow band” valence stabilizers for Ce⁺⁴ include, but are not limited to: diselenophosphoric acid, O-phenyldiselenophosphoric acid, O-benzyldiselenophosphoric acid, O-cyclohexyldiselenophosphoric acid, O-norbornyldiselenophosphoric acid, O,O-diphenyldiselenophosphoric acid, O,O-dibenzyldiselenophosphoric acid, O,O-dicyclohexyldiselenophosphoric acid, and O,O-dinorbornyldiselenophosphoric acid.

Se Valence Stabilizer #21: Examples of tetraselenophosphoric acids (phosphorotetraselenoic acids), bis(tetraselenophosphoric acids), poly(tetraselenophosphoric acids), and derivatives thereof (Se—Se Bidentates, Se—Se Tridentates, Se—Se Tetradentates) that meet the requirements for use as “narrow band” valence stabilizers for Ce⁺⁴ include, but are not limited to: tetraselenophosphoric acid, Se-phenyltetraselenophosphoric acid, Se-benzyltetraselenophosphoric acid, Se-cyclohexyltetraselenophosphoric acid, Se-norbornyltetraselenophosphoric acid, Se,Se-diphenyltetraselenophosphoric acid, Se,Se-dibenzyltetraselenophosphoric acid, Se,Se-dicyclohexyltetraselenophosphoric acid, and Se,Se-dinorbornyltetraselenophosphoric acid.

Se Valence Stabilizer #22: Examples of diselenocarbonates, triselenocarbonates, bis(diselenocarbonates), and bis(triselenocarbonates), (Se—Se Bidentates and S—S Tetradentates) that meet the requirements for use as “narrow band” valence stabilizers for Ce⁺⁴ include, but are not limited to: Se,Se-diethyldiselenocarbonate; Se,Se-diisopropyldiselenocarbonate; Se,Se-diphenyldiselenocarbonate; Se,Se-dibenzyldiselenocarbonate; Se,Se-dicyclohexyldiselenocarbonate; Se,Se-dinorbornyldiselenocarbonate; diethyltriselenocarbonate; diisopropyltriselenocarbonate; diphenyltriselenocarbonate; dibenzyltriselenocarbonate; dicyclohexyltriselenocarbonate; and dinorbornyltriselenocarbonate.

Se Valence Stabilizer #23: Examples of selenocyanate ligands (Se monodentates) that meet the requirements for use as “narrow band” valence stabilizers for Ce⁺⁴ include, but are not limited to: selenocyanate (—SeCN).

Se Valence Stabilizer #24: Examples of selenolates (Se monodentates) that meet the requirements for use as “narrow band” valence stabilizers for Ce⁺⁴ include, but are not limited to: selenophenol; and naphthaleneselenol.

Miscellaneous Valence Stabilizer #1: Examples of diene, bicyclicand tricyclic hydrocarbon ligands that meet the requirements for use as “narrow band” valence stabilizers for Ce⁺⁴ include, but are not limited to: cyclopentadiene; azulene; carotene; norbornane; and adamantane.

Miscellaneous Valence Stabilizer #2: Examples of cyanide and related ligands that meet the requirements for use as “narrow band” valence stabilizers for Ce⁺⁴ include, but are not limited to: cyanide (—CN); and fulminate (—CNO).

Miscellaneous Valence Stabilizer #3: Examples of carbonyl ligands that meet the requirements for use as “narrow band” valence stabilizers for Ce⁺⁴ include, but are not limited to: carbonyl (—CO); and carbon dioxide (CO₂) ligands.

Miscellaneous Valence Stabilizer #4: Examples of halogens that meet the requirements for use as “narrow band” valence stabilizers for Ce⁺⁴ include, but are not limited to: fluorine; chlorine; bromine; and iodine.

Miscellaneous Valence Stabilizer #5: Examples of hydroxo and oxo functionalities that meet the requirements for use as “narrow band” valence stabilizers for Ce⁺⁴ include, but are not limited to: water (H₂O); dioxygen (O₂); oxide (O²⁻); hydroxide (OH⁻); peroxo groups (O₂²⁻); and superoxo groups (O₂⁻).

2e) Mixed Inorganic/Organic Valence Stabilizers

Mixing organic and inorganic valence stabilizers in a rinsing or sealing solution will often result in a coating with poor corrosion-inhibiting properties because of cross interference. Inorganic and organic valence stabilizers interact with the Ce⁺⁴ ion in different ways. For example, inorganic valence stabilizers perform their function by forming a shell of octahedrally or icosahedrally coordinated anionic species around the captured Ce⁺⁴ ion. Therefore, the net charge of these inorganic valence stabilizer/Ce⁺⁴ complexes is always negative. Organic species stabilize by the formation of a “hard bond” between the bonding atom in the stabilizer (e.g., nitrogen or oxygen) and the Ce⁺⁴ ion. The net charge of these complexes is often positive. If these two very different types of stabilization ligands are combined, then the magnitude of the charge on the stabilized complex can be reduced significantly. The performance of organic or inorganic stabilized corrosion inhibitor complexes has been found to be directly related to the ability of the complex to form and sustain a thick electrostatic barrier layer. Additionally, a mixed stabilizer can have a poorly developed electrostatic field and a non-optimal packing around the Ce⁺⁴ ion, resulting in a complex with less resistance to aqueous attack. Mixed organic/inorganic stabilized Ce⁺⁴ inhibitor species will usually perform more poorly than inhibitors that have exclusively organic or inorganic valence stabilizers for this reason.

2f) Valence Stabilizers for Tetravalent Praseodymium or Terbium

The PrIV and TbIV ions form very few stable complexes with inorganic or organic compounds. Examples of typical wide band inorganic ligands for PrIV or TbIV include periodates, tellurates, tungstates, molybdates, vanadates, carbonates, and phosphates. Under certain circumstances, narrow band inorganic ligands such as oxygen, fluorides, antimonates, iodates, and bromates may be acceptable. Examples of typical organic ligands for PrIV or TbIV include dithiocarbarnates, dithiolenes, dithiols, dithioketones, biguanides, oximes, Schiff bases, and some azo compounds. PrIV or TbIV may be used in the future with compounds not currently identified.

3) Oxidation Source

Oxidizers serve two important functions within the coatings enhanced through the use of the described rinses and seals: 1) they act in cooperation with the stabilizer to impede the flow of ionic species through the coating, therefore minimizing charge transport, and 2) if a scratch is formed in the coating, these oxidizing species act to repair the breach by oxidizing the metal in the presence of water, and quickly reforming an oxide barrier. The effectiveness of the oxidizing species is a function of its individual oxidation-reduction potential, with more highly oxidized species exhibiting greater corrosion protection.

In order to provide adequate oxidation potential in the rinse and seal solutions, especially if trivalent cerium, praseodymium, or terbium compounds are utilized as precursors, an oxidizing species is also included as a starting material. Additional amounts of oxidizer may be added to help control and maintain a desired amount of Ce⁺⁴, Pr⁺⁴, or Tb⁺⁴ in the rinse or seal solution by reoxidizing Ce⁺⁴, Pr⁺⁴, or Tb⁺⁴ that has been reduced. Because of the high potential of the redox reaction required to oxidize trivalent cerium, praseodymium, or terbium to tetravalent cerium, praseodymium, or terbium, strong oxidizers must be utilized for this purpose. These oxidizers may be gaseous, liquid, or solid in form. Solid oxidizers are preferable for this application in terms of handling and reagent measurement. Other starting materials (cerium, praseodymium, or terbium source, stabilizer source, fluoride source) will frequently also be solids. Liquid oxidizers may also be used, but handling and accurate process metering have proven difficult. Gaseous oxidizers may be the most effective and chemically efficient on a large scale, but are also the most problematic due to handling and venting concerns.

Examples of oxidizers suitable for the purpose of producing and maintaining the cerium, praseodymium, or terbium ion in the tetravalent charge state include, but are not restricted to: peroxides and peroxo compounds (including superoxides, persulfates, perborates, pemitrates, perphosphates, percarbonates, persilicates, peraluminates, pertitanates, perzirconates, permolybdates, pertungstates, pervanadates, and organic peroxyacid derivatives), ozone, hypochlorites, chlorates, perchlorates, hypobromites, chlorites, bromates, nitrates, nitrites, vanadates, iodates, permanganates, periodates, and dissolved oxygen. Both inorganic and organic derivatives of these compounds may be used. Typical oxidizers are peroxides, persulfates, perbenzoates, periodates, bromates, hypochlorites, and gaseous dissolved oxygen (including the oxygen content of air). In general, any inorganic, organic, or combination species that has an oxidation potential of +1.6 V or higher (at a pH of 1) will be capable of oxidizing trivalent cerium to the tetravalent oxidation state. The formation of tetravalent praseodymium or terbium requires higher oxidation potentials. In the presence of suitable valence stabilizer compounds, tetravalent praseodymium or terbium can be formed from praseodymium or terbium solutions with an oxidation potential of +2.0 V or higher (at a pH of 1).

It is also possible to deposit trivalent cerium, praseodymium, or terbium into the pore via the rinse or seal solution, and then apply a second solution containing an oxidizer to oxidize the cerium, praseodymium, or terbium to the tetravalent oxidation state. This, however, is less preferred because the percentage of deposited cerium, praseodymium, or terbium that will be in the tetravalent state will be less than if it were oxidized prior to or during deposition.

In the rinse and seal solutions based on hexavalent chromium, oxidation sources termed “accelerators” are often added to speed up the pore-filling process. Because the application of an acid (i.e., a rinse or seal solution) to an electronegative metal will result in the formation of hydrogen gas, cathodic areas on exposed metal will be partially blocked from further coating formation. Oxidizers (“accelerators”) act to eliminate hydrogen gas formation, thereby minimizing its barrier effect, and hence accelerating the overall deposition rate. It is for this reason that it is desirable to have oxidizers in the initial rinsing or sealing solution based on cerium, praseodymium, or terbium.

Oxidation of the cerium, praseodymium, or terbium to the tetravalent state may also be achieved in the rinse or seal solution or in deposited trivalent cerium, praseodymium, or terbium complexes through electrolytic means. In many instances, however, this approach will not be economically feasible due to the large energy costs associated with electrolytic oxidation. This is especially true of rinse and seal solutions to be used for phosphate or black oxide coatings. For these types of coatings, chemical oxidation, such as that described above, currently offers the lowest-cost means to achieve oxidation of the cerium, praseodymium, or terbium to the tetravalent state.

However, for anodic coatings and processes, this electrolytic alternative is a very viable option due to the electrolytic application of the first (oxide barrier layer) coating. In fact, electrolytic processes are often used for the coloring of anodic coatings. However, formation of tetravalent cerium, praseodymium, or terbium complexes in the pores of the anodic coating will differ significantly from the current state-of-the-art anodic coloring processes. In the current state-of-the-art anodic coloring processes achieved by electrolytic means, the bare uncoated work piece to be anodized is first connected to an electrolytic cell as the anode. Once a potential is applied, the metal associated with the work piece is oxidized on the surface, thereby forming an oxide/hydroxide barrier layer. In the second step (electrolytic coloring) of the state-of-the-art, the work piece is positioned so that it is the cathode of the electrolytic cell, resulting in reduction on the surface of the work piece. (Transfer of the work piece to a cathode is usually achieved by reversing the electric biases of the cell, although manual repositioning is also a possibility.) In this way, the metals associated with the second solution are reduced either to the elemental state or to sulfides within the pores of the anodic coating, resulting in coloring.

In order to oxidize trivalent cerium, praseodymium, or terbium to the tetravalent state in the solution or the coating, a similar procedure as the state-of-the-art is followed, except that in the application of the second solution, the work piece should remain as the anode. Therefore, following formation of the oxide barrier film in the anodization process, it is not necessary to reverse the bias or manually transfer the work piece so that it is the cathode in the electrolytic cell. Formation of tetravalent cerium, praseodymium, or terbium can be achieved with the work piece still connected as the anode. In this way, it is necessary only to change the solution from one used for anodization (e.g., sulfuric acid anodization) to a composition such as that described in this invention to achieve superior corrosion protection. Coloring of the anodic coating can also be achieved using this approach, because of the wide range of colors achievable with some tetravalent cerium, praseodymium, or terbium/valence stabilizer complexes.

4) Preparative Agent Source

The deposition of tetravalent cerium, praseodymium, or terbium/valence stabilizer complexes within the pores of anodic, phosphate, or “black oxide” coatings is enhanced if some of the existing barrier layer, particularly in the vicinity of the pores, is dissolved. Therefore it is optionally desirable to remove the existing barrier layer to achieve high-quality coatings resulting from rinsing and sealing. A preparative agent is any material that removes (dissolves and breaks up) preexisting coating materials. The hexavalent chromium formulations term these materials “activators” or “surface etchants.” Because the existing barrier layer material at the margins of the pores will be slightly more disordered than in the bulk of the existing film, the preparative agent will preferentially attack the pore wall material. This in turn locally raises the pH in the vicinity of the pore, thereby further facilitating precipitation of tetravalent cerium, praseodymium, or terbium/valence stabilizer inhibitor complexes.

Fluoride acids and salts work especially well as preparative agents in rinse and seal compositions. The complex fluoride anions hexafluorozirconate (ZrF₆⁻²) and hexafluorotitanate (TiF₆⁻²) are superior fluoride sources for this application. Hexafluorosilicates (SiF₆⁻²) can be used, but they result in a reduced level of subsequent corrosion protection. The potassium, lithium, sodium, or ammonium salts of these anions work especially well for this application, with potassium performing the best.

Other complex fluorides, including, but not restricted to, fluoroaluminates (e.g., AIF₆⁻³ or AIF₄⁻¹), fluoroborates (e.g., BF₄⁻¹), fluorogallates (e.g., GaF₄⁻¹), fluoroindates (e.g., InF₄⁻¹), fluorogermanates (e.g., GeF₆⁻²), fluorostannates (e.g., SnF₆⁻²), fluorophosphates (e.g., PF₆⁻¹), fluoroarsenates (e.g., AsF₆⁻¹), fluoroantimonates (e.g., SbF₆⁻¹), fluorobismuthates (e.g., BiF₆⁻¹), fluorosulfates (e.g., SF₆⁻²), fluoroselenates (e.g., SeF₆⁻²), fluorotellurates (e.g., TeF₆² or TeOF₅⁻¹), fluorocuprates (e.g., CuF₃⁻¹ or CuF₄⁻²), fluoroargentates (e.g., AgF₃⁻¹ or AgF₄⁻²), fluorozincates (e.g., ZnF₄⁻²), fluorohafnates (e.g., HfF₆⁻²), fluorovanadates (e.g., VF₇⁻²), fluoroniobates (e.g., NbF₇⁻²), fluorotantalates (e.g., TaF₇⁻²), fluoromolybdates (e.g., MoF₆⁻³), fluorotungstates (e.g., WF₆⁻¹), fluoroyttrates (e.g., YF₆⁻³), fluorolanthanates (e.g., LaF₆³), fluorocerates (e.g., CeF₆⁻³ or CeF₆⁻²), fluoromanganates (e.g., MnF₆⁻²), fluoroferrates (e.g., FeF₆⁻³), fluoronickelates (e.g., NiF₆⁻²), and fluorocobaltates (e.g., CoF₆⁻²) are also suitable fluoride sources, but these offer even less corrosion protection than hexafluorosilicates. Water-soluble potassium, sodium, lithium, or ammonium salts of these anions are typical.

Simple inorganic fluorides such as potassium fluoride (KF), potassium hydrogen fluoride (KHF₂), sodium fluoride (NaF), sodium hydrogen fluoride (NaHF₂), lithium fluoride (LiF), lithium hydrogen fluoride (LiHF₂), ammonium fluoride (NH₄F), ammonium hydrogen fluoride (NH₄HF₂), and hydrofluoric acid solutions (HF) can also be used as a fluoride source. By analogy, organic compounds that readily release fluoride ions will also serve as adequate fluoride sources.

Other halide species, such as chlorides (Cl⁻), bromides (Br⁻), and iodides (I⁻) can also function as preparative agents, although their efficiency in dissolving the existing barrier film will not be as great as the fluorides. Inorganic or organic compounds that release chloride, bromide, or iodide anions can function as preparative agents, as can a number of complex chlorides and bromides that are similar to those described above for the fluorides. By analogy, complex hexachlorozirconates (ZrCl₆⁻²), hexachlorotitanates (TiCl₆⁻²), and hexachlorosilicates (SiCl₆⁻²) should function better than other chloride sources, and analogous complex bromide and iodide sources will function better than other bromides and iodides.

Acidic species, such as nitric acid, sulfuric acid, phosphoric acid, pyrophosphoric acid, hydrochloric acid, perchloric acid, hydrobromic acid, hydriodic acid, iodic acid, periodic acid, disulfuric acid, selenic acid, telluric acid, polyphosphoric acid, cyclophosphoric acid, phytic acid, boric acid, carboxylic acids, phosphonic acids, and sulfonic acids can also function as preparative agents. Of these, nitric acid is the most useful as a preparative agent.

Acidic species based on metal salts that exhibit a pH below 7 when placed into solution can also be used as preparative agents. The advantage in the use of these species as preparative agents is that they can help eliminate the need for fluoride species, which are regulated in some locations. Metal salts of titanium, zirconium, niobium, tantalum, molybdenum, tungsten, vanadium, aluminum, silicon, tin, antimony, bismuth, tellurium, yttrium, and lanthanum are especially useful for this process. Halides, nitrates, sulfates, perchlorates, and carboxylates of these metals, including double salts with alkali metals or ammonium are most suited as acidic metal salts due to their water soulbility.

Although it is less desirable, hydroxides can also function as preparative agents. For example, under high pH conditions zinc and aluminum are known to dissolve in water, through the formation of zincate or aluminate anions. The use of hydroxides such as sodium, potassium, lithium, or ammonium derivatives will result in this pH rise.

If used, the concentration of fluoride preparative agent should not exceed a value wherein the majority of the existing barrier layer should begin to be dissolved in the rinse or seal composition. This will result in reduced corrosion protection of the barrier film-tetravalent cerium, praseodymium, or terbium/valence stabilizer system. A maximum recommended concentration of fluoride for these rinses and seals is typically 0.5 M F⁻. For some specialized applications, such as rinsing or sealing refractory metals such as titanium, zirconium, niobium, and tantalum, or for treating tenacious or thick oxides of magnesium or aluminum, fluoride concentrations as high as 5.0 M F⁻ may be allowable.

5) Additional Solubility Control Agents

One of the roles of the valence stabilizer is to allow for the formation of a tetravalent cerium, praseodymium, or terbium complex that has a specific solubility range. The anions or cations present in the rinse or sealing solution may be sufficient to form a Ce⁺⁴-, Pr⁺⁴-, or Tb⁺⁴-containing compound within the rinsed or sealed coating that exhibits the desired solubility characteristics. However, additional solubility control may be desirable to optimize the performance of the tetravalent cerium-, praseodymium-, or terbium-valence stabilizer complex. The use of an additional solubility control agent is optional, not required.

Both the organic and inorganic valence stabilizers described above may need some kind of additional solubility control that can be in the form of either inorganic or organic compounds. Solubility control agents should be selected to match the cationic or anionic modifiers with individual Ce⁺⁴-, Pr⁺⁴-, or Tb⁺⁴-valence stabilizer combinations. Some cations or anions may work to optimize one Ce⁺⁴-, Pr⁺⁴-, or Tb⁺⁴-valence stabilizer complex, but this does not necessarily mean they will optimize the solubility of a different complex.

The initial rinsing or sealing of a barrier film may produce C⁺⁴, Pr⁺⁴, or Th⁺⁴ compounds with solubilities greater than optimal. A post-deposition treatment can be applied to the coating as a remedial treatment or as a desired process step. Additional solubility control agents applied to a work piece can enhance the Ce⁺⁴, Pr⁺⁴, or Tb⁺⁴ content of the coating by forming more insoluble compounds in place. Application of a second solution after the initial rinse or seal process has been found to result in enhanced solubility control of Ce⁺⁴, Pr⁺⁴, or Tb⁺⁴ in many formulations.

Additional solubility control agents are typically applied as a second solution. Otherwise, these cations or anions would begin to precipitate cerium-, praseodymium-, or terbium-containing compounds in the rinse or seal solution, depleting it of cerium, praseodymium, or terbium prior to treating the work piece. In general, fine-tuning of solubility by cationic species is typical for Ce⁺⁴-, Pr⁺⁴-, or Tb⁺⁴-stabilizer combinations when an inorganic valence stabilizer is used, and by anionic species when an organic valence stabilizer is used.

The need for an additional solubility control agent may be illustrated for the situation where molybdate is used as a valence stabilizer for a Ce⁺⁴ seal solution. Cationic species are necessary to deposit a Ce⁺⁴/molybdate compound within the coating (the net charge on a Ce⁺⁴/heteropolymolybdate anion may either be −2, −4, or −8). The cationic species needed to balance the charge and form a compound is usually supplied from cations already present in the rinse solution and/or by cations being pulled into the solution from the work piece. However, if the Ce⁺⁴/molybdate complex composed of the available cations has a much greater solubility than desired, then additional solubility control agents can be employed. The differences in effectiveness of a specific rinse or seal formulation upon different substrate materials (e.g., zinc, iron, magnesium) is likely a reflection of the influence that the composition of the alloy itself has upon the solubility of the deposited inhibitor species. Similarly, anions present in a rinse or seal solution or source material will be incorporated in a Ce⁺⁴ compound that requires a negative charge balance. This is frequently observed with Ce⁺⁴/organic valence stabilizer combinations.

The use of solubility control agents to enhance corrosion protection has also been demonstrated in the state-of-the-art hexavalent chromium solutions. For example, the sealing of anodic coatings with hexavalent chromium (resulting in the formation of somewhat soluble hydrated aluminum chromate) followed by rinsing with a zinc solution (resulting in the deposition of less-soluble zinc chromate in the pores) has been shown to increase the corrosion resistance for this system. However, hexavalent chromium rinsing of phosphate coatings over electrogalvanized steel does not require additional solubility control because of the initial formation of zinc chromate in the pores.

Additional solubility control can be achieved through the use of nontoxic inorganic cations which include, but are not limited to: H⁺, Li⁺, Na⁺, K⁺, Rb⁺, Cs⁺, NH₄⁺, Mg⁺², Ca⁺², Sr⁺², Y⁺³, La⁺³, Ce⁺³, Ce⁺⁴, Nd⁺³, Pr⁺³, Sc⁺³, Sm⁺³, Eu⁺³, Eu₊₂, Gd⁺³, Tb⁺³, Dy⁺³, Ho⁺³, Er⁺³, Tm⁺³, Yb⁺³, Lu⁺³, Ti⁺⁴, Zr⁺⁴, Ti⁺³ Hf⁺⁴, Nb₊₅, Ta⁺⁵, Nb⁺⁴, Ta⁺⁴, Mo⁺⁶, W⁺⁶, Mo⁺⁵, W⁺⁵, Mo⁺⁴, W⁺⁴, Mn⁺², Mn⁺³, Mn⁺⁴, Fe⁺², Fe⁺³, Co⁺², Co⁺³, Ru⁺², Ru⁺³, R⁺⁴, Rh⁺³, Ir⁺³, Rh⁺², Ir⁺², Pd⁺⁴, Pt⁺⁴, Pd⁺², Pt⁺², Cu⁺, Cu⁺², Cu⁺³, Ag⁺, Ag⁺², Ag⁺³, Au⁺, Au⁺², Au⁺³, Zn⁺², Al⁺³, Ga⁺³, Ga⁺, In⁺³, In⁺, Ge⁺⁴, Ge⁺², Sn⁺², Sn⁺⁴, Sb⁺³, Sb⁺⁵, Bi⁺³, and Bi⁺⁵. Any water-soluble compound that contains these cations can be used for this purpose. Nitrates, chlorides, bromides, and perchlorates of these cations offer inexpensive water-soluble precursors, although many other water-soluble precursors exist.

Cationic solubility control may also be achieved through the use of non-toxic organic cations that include, but are not limited to: quaternary ammonium compounds (NR₄⁺, where R can be any combination of alkyl, aromatic, or acyclic organic substituents, such as the methyltriethylammonium ion); organics that contain at least one N⁺ site (such as pyridinium or thiazolium cations); organics that contain at least one phosphonium site (P⁺, such as the benzyltriphenylphosphonium ion); organics that contain at least one stibonium site (Sb⁺, such as the tetraphenylstibonium ion); organics that contain at least one oxonium site (O⁺, such as pyrylium cations); organics that contain at least one sulfonium site (S⁺, such as the triphenylsulfonium ion); and organics that contain at least one iodonium site (I⁺, such as the diphenyliodonium ion).

The quaternary ammonium compounds, organics containing at least one N⁺ site, and organics containing at least one oxonium site are the most important of these classifications because of the very large number of stable cations that are available. Water-soluble precursors for these organic cations are desirable in order to maximize the amount of material available in the appropriate rinse or seal solution. Fluorides, chlorides, and bromides offer the most water-soluble precursors for these organic cations, although lower molecular weight nitrates and perchlorates of these cations (e.g., tetramethylammonium) are also acceptable water-soluble precursors. Nitrates and perchlorates of larger (higher molecular weight) organic cations are not acceptable as precursors because of their low water solubility.

Although it is less desirable, toxic inorganic or organic cations can be used as additional solubility control agents. Examples of toxic inorganic cations that can be used include, but are not limited to: Be⁺², Ba⁺², V⁺⁵, V⁺⁴, V⁺³, Cr⁺³, Ni⁺², Ni⁺⁴, Os⁺⁴, Cd⁺², Hg⁺¹, Hg⁺², Tl⁺, Tl⁺³, As⁺³, As⁺⁵, Pb⁺², and Pb⁺⁴. Examples of toxic organic cations include, but are not limited to: organic compounds that contain at least one arsonium site (As⁺, an example being the tetraphenylarsonium ion) and organic compounds that contain at least one selenonium site (Se⁺, an example being the triphenylselenonium ion). Use of these materials for additional solubility control may be appropriate in some specific instances where the toxicity of the coating baths is of limited importance to the operator. Water-soluble precursors for these toxic cations are typically used in order to maximize the amount of available cation for solubility control. In general, the nitrates, fluorides, chlorides, bromides, and perchlorates of these cations offer the highest water solubility.

Additional solubility control can also be achieved through the use of nontoxic inorganic anions, especially for Ce⁺⁴/, Pr⁺⁴/, or Tb⁺⁴/organic valence stabilizer combinations. Water-soluble precursors for these inorganic anions are desirable in order to maximize the amount of material available in the appropriate rinse or seal solution. These include, but are not limited to: fluorotitanates, chlorotitanates, fluorozirconates, chlorozirconates, fluoroniobates, chloroniobates, fluorotantalates, chlorotantalates, molybdates, tungstates, permanganates, fluoromanganates, chloromanganates, fluoroferrates, chloroferrates, fluorocobaltates, chlorocobaltates, fluorozincates, chlorozincates, borates, fluoroborates, fluoroaluminates, chloroaluminates, carbonates, silicates, fluorosilicates, fluorostannates, nitrates, nitrites, azides, phosphates, phosphites, phosphonates, phosphinites, thiophosphates, thiophosphites, thiophosphonates, thiophosphinites, fluorophosphates, fluoroantimonates, chloroantimonates, sulfates, sulfites, sulfonates, thiosulfates, dithionites, dithionates, fluorosulfates, tellurates, fluorides, chlorides, chlorates, perchlorates, bromides, bromates, iodides, iodates, periodates, and heteropolyanions (e.g., heteropolymolybdates, silicomolybdates, etc.).

Additional solubility control can also be achieved through the use of an almost unlimited number of non-toxic organic anions (e.g., organics with different carboxylates or acid groups). Examples include, but are not limited to: ferricyanides; ferrocyanides; cyanocobaltates; cyanocuprates; cyanomanganates; cyanates; cyanatoferrates; cyanatocobaltates; cyanatocuprates; cyanatomanganates; thiocyanates; thiocyanatoferrates; thiocyanatocobaltates; thiocyanatocuprates; thiocyanatomanganates; cyanamides; cyanamidoferrates; cyanamidocobaltates; cyanamidocuprates; cyanamidomanganates; nitritoferrates; nitritocobaltates; azides; (thio)carboxylates, di(thio)carboxylates, tri(thio)carboxylates, or tetra(thio)carboxylates [useful representatives including, but not limited to, acetic acid, benzoic acid, succinic acid, fumaric acid, salicylic acid, lactic acid, tartaric acid, antimonyl tartrates, cinnamic acid, adipic acid, phthalic acid, terephthalic acid, citric acid, ascorbic acid, malic acid, malonic acid, oxalic acid, stearic acid, gallic acid, naphthenic acid, camphoric acid, nitrosalicylic acid, aminosalicylic acid, acetylsalicylic acid, sulfosalicylic acid, nitrobenzoic acid, perfluoroC₂₋₁₆carboxylic acids, trinitrobenzoic acid, chlorobenzoic acid, anisic acid, iodobenzoic acid, anthranilic acid, mandelic acid, toluic acid, nicotinic acid, isonicotinic acid, pyrazolecarboxylic acid, picrolonic acid, quinaldic acid, diphenic acid, benzoquinaldic acid, quinolinecarboxylic acid, isoquinolinecarboxylic acid, triazinecarboxylic acid, (thio)carbonic acids, (thio)carbamic acids, trimethylhexylic acid, tetrafluorophthalic acid, ethylenediaminetetraacetic acid, toluoylpropionic acid, lactobionic acid, octylthiopropionate, lipoic acid, methylbenzoylpropionic acid, anthracenesuccinic acid, benzothiazolecarboxylic acid, phenylacetic acid, glycolic acid, thioglycolic acid, benzothiazolylthiosuccinic acid, benzothiazolylthiopropionic acid, phenylanthranilic acid, furancarboxylic acid, nitrofuroic acid, phosphonobutanetricarboxylic acid, benzothiazolylthiosuccinic acid, N-phosphonomethylglycine, cresoxyacetic acid, aminobutyric acid, alanine, asparagine, cysteine, glutamine, glycine, leucine, methionine, phenylalanine, proline, serine, threonine, tryptophan, tyrosine, valine, glutamic acid, aspartic acid, arginine, histidine, lysine, trihydroxyglutaric acid, phenoxyacetic acid, hydroxynaphthoic acid, phenylbutyric acid, hydroxyphosphonoacetic acid, tropic acid, aminophenylpropionic acid, dihydrocinnamic acid, hydroxycinnamic acid, cinchomeronic acid, aurintricarboxylic acid, benzotriazolecarboxylic acid, hydroxyphosphonoacetic acid, cyanuric acid, barbituric acid, violuric acid, diphenylvioluric acid, dilituric acid, thiobarbituric acid, cresotic acid, trimethylhexylic acid, nitrilotriacetic acid, N,N′-terephthaloylbis(aminocaproic acid), ethyleneglycolbis(aminoethylether)tetraacetic acid, diethylenetriaminepentaacetic acid, 2-phosphonobutanetricarboxylic acid, N,N′-bis(2-hydroxysuccinyl)ethylenediamine, nicotinic acid, naptalam, nitrobenzoic acid, nonylphenoxyacetic acid, and olsalazine]; (thio)phenolates, di(thio)phenolates, tri(thio)phenolates, or tetra(thio)phenolates [useful representatives including, but not limited to, pyrocatechol, resorcinol, picric acid, styphnic acid, pyrogallol, purpurin, purpurogallin, benzopurpurin, gallein, thiophenol, rhodizonic acid, kojic acid, chromotropic acid, carminic acid, fluorescein, tannic acid, and humic acid]; (thio)phosphonates, di(thio)phosphonates, or tri(thio)phosphonates [useful representatives including, but not limited to, diethylphosphonic acid, diphenylphosphonic acid, nitrophenylphosphonic acid, perfluoroC₂₋₁₆phosphonic acids, benzenephosphonic acid, phytic acid, hydroxyethylidenebisphosphonic acid, nitrilotrimethylenephosphonic acid, aminomethylenephosphonic acid, etidronic acid, ethylphosphonic acid, chloroethylphosphonic acid, ethylenediaminotetramethylenephosphonic acid, laurylhydroxydiphosphonic acid, methylaminodimethylenephosphonic acid, alkyl(aryl)diphosphonic acids, N-cetylaminoethanediphosphonic acid, carboxyhydroxymethylphosphonic acid (hpa), oxyethylidenediphosphonic acid, polycaproamidophosphonates, phenylethanetriphosphonic acid, oxidronic acid, and pamidronic acid]; (thio)phosphonamides, di(thio)phosphonamides, or tri(thio)phosphonamides [useful representatives including, but not limited to, phosphoramidic acid, phosphordiamidic acid (diamidophosphonic acid), and phosphoramidothioic acid]; amino(thio)phosphonates, diamino(thio)phosphonates, or triamino(thio)phosphonates; imino(thio)phosphonates or diimino(thio)phosphonates; (thio)sulfonates, di(thio)sulfonates, or tri(thio)sulfonates [useful representatives including, but not limited to, methanesulfonic acid, benzenesulfonic acid, aminobenzenesulfonic acid (sulfanilic acid), nitrobenzenesulfonic acid, phenylsulfonic acid, naphthalenesulfonic acid, nitronaphthalenesulfonic acid, oxinesulfonic acid, alizarinsulfonic acid, benzidinesulfonic acid, flavianic acid, camphorsulfonic acid, diiodophenolsulfonic acid (sozoiodol), 8-hydroxyquinoline-5-sulfonic acid, 7-nitro-8-hydroxyquinoline-5-sulfonic acid, benzotriazolesulfonic acid, bis(trifluoromethyl)benzenesulfonic acid, diiododihydroxybenzophenonesulfonic acid, p-amino-p′-ethoxydiphenylamine-o-sulfonic acid, 1-amino-2-naphthol-4-sulfonic acid, 1,2-diaminoanthraquinone-3-sulfonic acid, 1,5-dinitro-2-naphthol-7-sulfonic acid, perfluoroC₂₋₁₆sulfonic acids, benzenedisulfonic acid, phenyldisulfonic acid, naphthalenedisulfonic acid, 3,6-naphtholdisulfonic acid, indigodisulfonic acid, benzidinedisulfonic acid, carboxyiodobenzenesulfonic acids, N-benzeneaminomethanesulfonic acid (ams), amido-G-acid, amido-R-acid, naphthalene(di)sulfonic acid (Armstrong's acid), amsonic acid, Badische acid, camphorsulfonic acid, chrysophenine, Cassella's acid, chromotropic acid, Cleve's acid, croceic acid, anthracenesulfonic acid, hydroxyquinolinesulfonic acid, hydrazinobenzenesulfonic acid, indigo carmine, indoxyl, isatinsulfonic acid, indican, lignosulfonic acid, metanil yellow, metanilic acid, naphthoquinonesulfonic acid, Nuclear Fast Red, naphthol(di)sulfonic acid, naphthylamine(di)sulfonic acid, Orange 1, orthanilic acid, phenol(di)sulfonic acid, methylenedinaphthalenesulfonic acid, methyl orange, and piperazinediethanesulfonic acid (pipes)]; (thio)sulfonamides, di(thio)sulfonamides, or tri(thio)sulfonamides; amino(thio)sulfonates, diamino(thio)sulfonates, or triamino(thio)sulfonates; imino(thio)sulfonates (including sulfamates) or diimino(thio)sulfonates (including disulfamates) [useful representatives including, but not limited to, methylsulfamic acid and phenylsulfamic acid]; (thio)borates, di(thio)borates, or (thio)boronates [useful representatives including, but not limited to, phenylboric acid and borotartaric acid]; organic silicates; and stibonates [useful representatives including, but not limited to, antimonyl tartrate and benzenestibonic acid]. Water-soluble precursors for these organic anions are desirable to maximize the amount available in the appropriate rinse or seal solution.

Finally, toxic inorganic or organic anions can be used as additional solubility control agents, although this is less desirable. Examples of toxic inorganic anions include, but are not limited to: arsenates, arsenites, fluoroarsenates, chloroarsenates, selenates, selenites, fluorothallates, chlorothallates, iodomercury anions (e.g., Nessler's reagent), thiocyanatomercury anions (Behren's reagent), chloromercurates, bromomercurates, osmates, fluoronickelates, chromates, Reinecke's salt, and vanadates. Examples of toxic organic anions include cyanides; cyanochromates; cyanonickelates; cyanatochromates; cyanatonickelates; thiocyanatochromates; thiocyanatonickelates; cyanamidochromates; cyanamidonickelates; nitritonickelates; arsonates, diarsonates, or triarsonates [useful representatives including, but not limited to, propylarsonic acid, phenylarsonic acid, hydroxyphenylarsonic acid, benzenearsonic acid, methylbenzenearsonic acid, hydroxybenzenearsonic acid, and nitrobenzenearsonic acid]; and selenates, diselenates, or triselenates. These materials may be used in some specific instances for additional solubility control where coating bath toxicity is of limited importance. Water-soluble precursors for these anions are helpful in maximizing the amount of available anion for solubility control. The alkali or ammonium species of these anions typically offer the greatest water solubility.

6) Agents to Increase Lubricious Character of Coating

Iron and manganese phosphate coatings, as well as black oxide coatings, are used predominantly to provide a solid lubricant between two (or more) wear surfaces. A chrome rinse of these coatings can affect the tribological (lubricious) characteristics of the coating. Specifically, materials that exhibit low coefficients of friction, or that result in the formation of materials with low coefficients of friction, can be added to the rinse solution to increase the lubriciousness of the rinsed coating. Examples of these include fine particulate or dissolved molybdenum disulfide, graphite, fluorinated hydrocarbons, polymers, or soft metals such as tin, indium, or silver.

7) Agents to Increase Color-Fastness of Coating

Rinsed or sealed coatings that are to be used for architectural or adornment applications will frequently be colored to improve the aesthetic nature of the work piece. Long-term exposure to high energy wavelengths (i.e., the ultraviolet wavelengths of sunlight) may fade or dim the color of the coated work piece. The rinse or seal solution may include agents that improve the color-fastness of the coating. Typically, these are termed “UV blockers” in the paint and coatings literature. Active UV blockers are typically dark in color and function by absorbing nearly all of the light energy. Passive UV blockers are light in color and function by reflecting back nearly all of the light energy. Examples of active UV blockers include, but are not limited to, carbon black, graphite, or phthalocyanines. Examples of passive UV blockers include, but are not limited to, titanium oxide, tin oxide, lead oxide, silicon oxide, silicates, or aluminosilicates, or combinations thereof.

The degree of color-fastness desired is strongly dependant upon the end use of the treated work piece. For example, metal pieces that have been phosphated or treated to obtain a black oxide coating often have lower ornamental requirements and, therefore, the requirements of the rinsing or sealing solutions are lower. Many anodized coatings, however, must meet very high ornamental requirements (especially for anodized aluminum), and the sealing solution must therefore meet these requirements. Even with anodized aluminum, the end use will dictate the degree of care required of the sealing solution. Thus, for parts that will only be exposed to interior light, a much wider selection of cerium, praseodymium, or terbium/valence stabilizer combinations will meet the ornamental requirements. For parts that will be exposed intermittently to UV light, as in automotive trim components, the choice of cerium, praseodymium, or terbium/valence stabilizer combinations is narrowed. Finally, work pieces that will be exposed to UV light on a continuous basis, such as architectural components, can only be treated with a limited number of cerium, praseodymium, or terbium/valence stabilizer combinations while still meeting the ornamental requirements.

The rinse or seal solution may also include wetting agents, such as nonionic surfactants at a concentration of, for example, 5 g/L, as well as agents that prevent smudging to improve the color-fastness of the coating. These agents are particularly useful on powdery coatings and can include, but are not limited to, phosphoric acid, metaphosphates, orthophosphates, pyrophosphates, polyphosphates, or combinations thereof.

The color fastness of the treated coating will also be dependent upon the valence stabilizer. For example, the stability of the valence stabilizer or cerium, praseodymium, or terbium/valence stabilizer complex to UV light; the concentration of the valence stabilizer in the sealing bath; and the degree of penetration into the coating all can affect color fastness.

8) Agents to Add Color to the Formed Coating

It is desirable that coatings placed directly onto metal work pieces be colored so as to provide a metric of coating thickness, to identify uncoated areas, or even for aesthetic purposes. Rare earth compounds often exhibit no color in the coating, or result in very pale colored coatings. For this reason, it may optionally be advantageous to add a solvent-soluble (typically water-soluble) colorant to the conversion coating solution. Dye chemicals such as vat dyes (i.e., indigo or anthraquinone), mordant and lake dyes (i.e., alizarin), direct dyes (i.e., mauve), disperse dyes (i.e., quinones), azo dyes, triazene dyes, triphenylmethane dyes (i.e., malachite green), azine dyes (i.e., methylene blue), formazan dyes, phthalocyanine dyes, Schiff Base dyes, or naturally-occurring dyes (such as anthocyanins, carotenoids, quinines, melanins, ommochromes, pterins, porphyrins, and indigoids), or combinations thereof, can be used for this purpose. Inorganic pigments are also acceptable.

### A) Solution Composition and Preparation

Additional important process considerations include chemical concentrations, pH of the rinse or seal solution, redox potential of the rinse or seal solution, application temperature, and contact time.

1) Solvents

Water is a typical solvent for these rinse or seal solutions due to its availability and low cost. Other solvents or combinations of water with other solvents (such as alcohols, ketones, etc.) may also be used if desired. However, these processes will be more costly than those using water exclusively. For sealing anodized aluminum, very high purity water is typically employed, and the concentrations of chloride, fluoride, sulfate, phosphate, and silicate should be minimized.

2) Cerium, Praseodymium, or Terbium Concentrations

The maximum concentration of the cerium, praseodymium, or terbium source depends upon the solubility of the specific cerium, praseodymium, or terbium source used. Any concentration exceeding this precursor solubility will result in undissolved solid material that will not be incorporated into the rinse or seal solution. Therefore, the solubility of the cerium, praseodymium, or terbium sources in water at or near ambient temperature (25° C.) can be used as representative maximum concentrations of the cerium, praseodymium, or terbium source that is added. Since the solubility of virtually all materials in water increases with temperature, more cerium, praseodymium, or terbium can be added to the rinse or seal solution if the temperature of the bath is increased from ambient. However, cooling of these rinse or seal solutions with higher cerium, praseodymium, or terbium precursor concentrations will result in the precipitation of solid cerium, praseodymium, or terbium compounds, with no guarantee that they could be resolubilized if the water is again heated (due to evaporation).

Acidic pHs will typically increase the solubility of many inorganic materials, thereby increasing the concentration of cerium, praseodymium, or terbium available in solution. A general estimate of the maximum concentration of cerium, praseodymium, or terbium in the rinse or seal solution at ambient temperature can be determined from the solubilities of some of the more desirable cerium or praseodymium sources listed in Table 4. The solubility of terbium sources is often comparable to praseodymium sources.

TABLE 4
Solubilities of Some Cerium and Praseodymium
Sources under Ambient Conditions [Maximum
Concentration of Cerium or Praseodymium in Solution]
(at or near 25° C. and at or near pH 7)

| Cerium or Praseodymium Source | Solubility in Water (mole/L) |
|---|---|
| Cerium (III) nitrate | 1.5 × 10⁰ |
| Cerium (III) sulfate | 1.2 × 10⁻¹ |
| Cerium (III) perchlorate | 2.0 × 10⁰ |
| Cerium (III) chloride | 4.1 × 10⁰ |
| Cerium (III) bromide | 1.0 × 10⁰ |
| Cerium (III) iodide | 1.0 × 10⁻¹ |
| Cerium (III) bromate | 1.0 × 10⁰ |
| Cerium (III) formate | 1.3 × 10⁻² |
| Cerium (III) acetate | 6.6 × 10⁻¹ |
| Cerium (III) propionate | 4.6 × 10⁻¹ |
| Cerium (III) butyrate | 7.7 × 10⁻² |
| Cerium (III) dimethylphosphate | 7.6 × 10⁻¹ |
| Ammonium cerium (III) nitrate | 5.7 × 10⁰ |
| Magnesium cerium (III) nitrate | 4.3 × 10⁻¹ |
| Ammonium cerium (III) sulfate | 7.0 × 10⁻² |
| Cerium (IV) chloride | 1.0 × 10⁰ |
| Cerium (IV) perchlorate | 1.0 × 10⁰ |
| Cerium (IV) sulfate | 5.0 × 10⁻¹ |
| Cerium (IV) nitrate | 1.0 × 10⁰ |
| Cerium (IV) acetate | 5.0 × 10⁻¹ |
| Ammonium cerium (IV) nitrate | 2.6 × 10⁰ |
| Ammonium cerium (IV) sulfate | 5.0 × 10⁻¹ |
| Praseodymium (III) nitrate | 1.4 × 10⁰ |
| Praseodymium (III) sulfate | 3.1 × 10⁻¹ |
| Praseodymium (III) perchlorate | 2.2 × 10⁰ |
| Praseodymium (III) chloride | 8.9 × 10⁰ |
| Praseodymium (III) bromide | 1.0 × 10⁻¹ |
| Praseodymium (III) iodide | 1.0 × 10⁰ |
| Praseodymium (III) bromate | 2.9 × 10⁰ |
| Praseodymium (III) acetate | 6.3 × 10⁻¹ |
| Magnesium praseodymium (III) nitrate | 4.1 × 10⁻¹ |

The depletion of cerium, praseodymium, or terbium from the coating solution below an acceptable level is a function of the amount of metal surface area being coated prior to regeneration of the bath. A coating applied to a very large surface area may deplete the solution to the point that subsequent solution applications no longer form effective coatings. Less cerium, praseodymium, or terbium will be removed from the rinse or seal solution when treating a smaller surface area of metal, so more work pieces can be treated from the same solution.

The corrosion-inhibiting cerium, praseodymium, or terbium compounds formed on the surface of the metal exhibit solubilities ranging from approximately 5×10⁻² to 5×10⁻⁵ moles/liter of cerium, praseodymium, or terbium in water. Coating solutions with cerium, praseodymium, or terbium concentrations much less than these concentrations may: 1) withdraw cerium or praseodymium from the formed coating in order to attempt to reach an equilibrium, or 2) may produce an incomplete, poorly formed oxide film. Intentionally exhausted (depleted) rinse or seal solutions have been observed to degrade a coated surface and return cerium, praseodymium, or terbium to the rinse or seal solution. The lowest concentration of cerium, praseodymium, or terbium in the precursor rinse or seal baths from which some resultant corrosion inhibition will be exhibited is probably in the range of 1×10⁻³ to 1×10⁻⁴ moles/liter of cerium, praseodymium, or terbium. We used cerium concentrations of approximately 1×10⁻¹ mole/liter of cerium with excellent results.

3) Valence Stabilizer Concentrations

The concentration of the valence stabilizer can be any concentration up to the maximum solubility of the specific valence stabilizer source used. Any concentration exceeding this solubility will result in undissolved solid material that will not be available for stabilizing the desired tetravalent cerium, praseodymium, or terbium ions. If the valence stabilizer is also used to color the coating (i.e., an anodized aluminum), high concentrations will result in darker shades. The concentration of valence stabilizer source should be restricted to its maximum solubility in water at or near ambient temperature (25° C.). Higher temperatures may allow more valence stabilizer to be added to the rinse or seal solutions, but this would result in precipitation if the solutions were allowed to cool. Table 5 shows the aqueous solubility of some of the more desirable sources for wide band inorganic valence stabilizers, and Table 6 shows the aqueous solubility of some sources of narrow band inorganic valence stabilizers.

TABLE 5
Solubilities of Wide Band Inorganic Valence Stabilizer
Precursors Under Ambient Conditions
[Maximum Allowable Concentrations in Solution]
(At or near 25° C. and at or near pH 7)

| Wide Band | | |
|---|---|---|
| Inorganic | | Solubility in |
| Valence | | Water |
| Stabilizer | Example Precursors | (mole/L) |
| Molybdates | Molybdenum trioxide | 7.4 × 10⁻³ |
| | Molybdic acid | 7.4 × 10⁻³ |
| | Ammonium molybdate | 5 × 10⁰ |
| | Lithium molybdate | 1 × 10¹ |
| | Sodium molybdate | 2.15 × 10² |
| | Potassium molybdate | 7.75 × 10² |
| | Rubidium molybdate | 6.4 × 10⁰ |
| | Cesium molybdate | 4.8 × 10⁰ |
| | Magnesium molybdate | 7.4 × 10⁻¹ |
| Tungstates | Tungstic acid | 8.0 × 10⁻¹ |
| | Ammonium tungstate | 1 × 10² |
| | Lithium tungstate | 5.8 × 10¹ |
| | Sodium tungstate | 2.49 × 10² |
| | Potassium tungstate | 1.42 × 10² |
| | Rubidium tungstate | 5 × 10¹ |
| | Cesium tungstate | 5 × 10⁰ |
| | Magnesium tungstate hydrate | 7.2 × 10⁻¹ |
| Vanadates | Vanadium pentoxide | 4.4 × 10⁻² |
| | Ammonium vanadate | 4.4 × 10⁻² |
| | Lithium vanadate | 1 × 10⁰ |
| | Sodium vanadate | 1.7 × 10⁰ |
| | Potassium vanadate | 1 × 10⁰ |
| | Rubidium vanadate | 5 × 10⁻¹ |
| | Cesium vanadate | 5 × 10⁻¹ |
| | Magnesium vanadate | 1 × 10⁰ |
| | Calcium vanadate | 5 × 10⁻¹ |
| Niobates | Ammonium niobate | 1 × 10⁻¹ |
| | Lithium niobate | 1 × 10⁻¹ |
| | Sodium niobate | 5.9 × 10⁻² |
| | Potassium niobate | 5 × 10⁻² |
| | Magnesium hexaniobate | 8.8 × 10⁻² |
| | Calcium hexaniobate | 4.7 × 10⁻² |
| Tantalates | Ammonium tantalate | 1 × 10⁻² |
| | Lithium tantalate | 1 × 10⁻² |
| | Sodium tantalate | 5.5 × 10⁻³ |
| | Potassium tantalate | 5 × 10⁻³ |
| Tellurates | Telluric acid | 5 × 10⁻¹ |
| | Ammonium tellurate | 5 × 10⁻¹ |
| | Lithium tellurate | 1 × 10⁰ |
| | Sodium tellurate | 2.8 × 10⁻² |
| | Potassium tellurate | 1 × 10⁻² |
| | Rubidium tellurate | 1 × 10⁻² |
| | Cesium tellurate | 1 × 10⁻² |
| Periodates | Periodic acid | 4.96 × 10¹ |
| | Ammonium periodate | 1.3 × 10⁻¹ |
| | Lithium periodate | 5 × 10¹ |
| | Sodium periodate | 6.7 × 10⁻¹ |
| | Potassium periodate | 2.9 × 10⁻² |
| | Rubidium periodate | 2.4 × 10⁻² |
| | Cesium periodate | 6.6 × 10⁻² |
| | Magnesium periodate | 5 × 10⁰ |
| Antimonates | Ammonium antimonate | 1 × 10⁰ |
| | Lithium antimonate | 1 × 10⁰ |
| | Sodium antimonate | 1.2 × 10⁻³ |
| | Potassium antimonate | 1.04 × 10⁻¹ |
| | Rubidium antimonate | 1 × 10⁻¹ |
| | Cesium antimonate | 5 × 10⁻² |
| Stannates | Ammonium stannate | 5 × 10⁰ |
| | Lithium stannate | 5 × 10⁰ |
| | Sodium stannate | 2.3 × 10⁰ |
| | Potassium stannate | 3.7 × 10⁰ |
| | Rubidium stannate | 5 × 10⁰ |
| | Cesium stannate | 1 × 10⁰ |
| Iodates | Iodic acid | 1.76 × 10¹ |
| | Iodine pentoxide | 5.6 × 10⁰ |
| | Ammonium iodate | 1.1 × 10¹ |
| | Lithium iodate | 4.4 × 10⁰ |
| | Sodium iodate | 4.5 × 10⁻¹ |
| | Potassium iodate | 2.2 × 10⁻¹ |
| | Rubidium iodate | 8.1 × 10⁻² |
| | Cesium iodate | 8.4 × 10⁻² |
| | Magnesium iodate | 2.29 × 10⁻¹ |
| Phosphates | Phosphoric acid | 5.6 × 10¹ |
| | Ammonium phosphate | 1.3 × 10⁰ |
| | Lithium phosphate | 3.4 × 10⁻³ |
| | Sodium phosphate | 2.6 × 10⁻¹ |
| | Potassium phosphate | 4.2 × 10⁰ |
| | Pyrophosphoric acid | 4.0 × 10¹ |
| | Sodium pyrophosphate | 1.2 × 10⁻¹ |
| Bromates | Ammonium bromate | 1 × 10¹ |
| | Lithium bromate | 4.85 × 10⁰ |
| | Sodium bromate | 1.82 × 10⁰ |
| | Potassium bromate | 8.0 × 10⁻¹ |
| | Rubidium bromate | 1.4 × 10⁻¹ |
| | Cesium bromate | 1.4 × 10⁻¹ |
| | Magnesium bromate | 1.0 × 10⁰ |
| | Calcium bromate | 1 × 10⁰ |
| | Strontium bromate | 9.1 × 10⁻¹ |
| | Zinc bromate | 1 × 10⁰ |
| | Ferric bromate | ˜1 × 10⁰ |
| Nitrates | Nitric acid | 75 wt. % |
| | Ammonium nitrate | 2.5 × 10¹ |
| | Lithium nitrate | 1.3 × 10¹ |
| | Sodium nitrate | 1.1 × 10¹ |
| | Potassium nitrate | 7.4 × 10⁰ |
| | Rubidium nitrate | 3.0 × 10⁰ |
| | Cesium nitrate | 2.1 × 10⁰ |
| | Magnesium nitrate | 4.9 × 10⁰ |
| | Calcium nitrate | 2.1 × 10¹ |
| | Strontium nitrate | 3.4 × 10⁰ |
| | Zinc nitrate | 6.2 × 10⁰ |
| | Barium nitrate | 3.3 × 10⁻¹ |
| | Aluminum nitrate | 1.7 × 10⁰ |
| | Ferric nitrate | 5.7 × 10⁰ |
| | Tetramethylammonium nitrate | ˜1 × 10¹ |
| | Tetraethylammonium nitrate | ˜5 × 10⁰ |
| | Tetrapropylammonium nitrate | ˜1 × 10⁰ |
| | Tetrabutylammonium nitrate | ˜5 × 10⁻¹ |
| Sulfates | Sulfuric acid | 75 wt. % |
| | Ammonium sulfate | 6.1 × 10⁰ |
| | Lithium sulfate | 2.7 × 10⁰ |
| | Sodium sulfate | 2.2 × 10⁰ |
| | Potassium sulfate | 1.0 × 10⁰ |
| | Rubidium sulfate | 1.7 × 10⁰ |
| | Cesium sulfate | 5.0 × 10⁰ |
| | Magnesium sulfate | 3.0 × 10⁰ |
| | Zinc sulfate | 3.4 × 10⁰ |
| | Aluminum sulfate | 3.0 × 10⁰ |
| | Ferric sulfate | 7.9 × 10⁰ |
| Carbonates | Ammonium carbonate | 8.8 × 10⁰ |
| | Ammonium bicarbonate | 1.5 × 10⁰ |
| | Lithium carbonate | 2.1 × 10⁻¹ |
| | Lithium bicarbonate | 8.1 × 10⁻¹ |
| | Sodium carbonate | 7.5 × 10⁻¹ |
| | Sodium bicarbonate | 8.2 × 10⁻¹ |
| | Potassium carbonate | 8.1 × 10⁰ |
| | Potassium bicarbonate | 3.9 × 10⁰ |
| | Rubidium carbonate | 1.95 × 10¹ |
| | Rubidium bicarbonate | 3.7 × 10⁰ |
| | Cesium carbonate | 8.0 × 10⁰ |
| | Cesium bicarbonate | 1.08 × 10¹ |

TABLE 6
Solubilities of Narrow Band Inorganic Valence Stabilizer
Precursors Under Ambient Conditions
[Maximum Allowable Concentrations in Solution]
(At or near 25° C. and at or near pH 7)

| Narrow Band Inorganic | | Solubility in |
|---|---|---|
| Valence Stabilizer | Example Precursors | Water (mole/L) |
| Germanates | Germanium dioxide hydrate | 4.3 × 10⁻² |
| | Ammonium germanate | 1 × 10⁰ |
| | Lithium germanate | 6.3 × 10⁻² |
| | Sodium germanate | 1.55 × 10⁰ |
| | Potassium germanate | 1 × 10⁰ |
| | Rubidium germanate | 5 × 10⁻¹ |
| | Cesium germanate | 5 × 10⁻¹ |
| Titanates | Titanium hydroxide | 1.36 × 10⁻⁴ |
| Zirconates | Zirconium hydroxide | 1.26 × 10⁻³ |
| Selenates | Selenic acid | 60 wt. % |
| | Ammonium selenate | 6.0 × 10⁰ |
| | Sodium selenate | 1.2 × 10⁰ |
| | Potassium selenate | 5.0 × 10⁰ |
| Bismuthates | Bismuth nitrate | 2.7 × 10⁻² |
| | Bismuthyl perchlorate | 1 × 10⁻¹ |
| Arsenates | Arsenic pentoxide | 6.5 × 10⁰ |
| | Ammonium arsenate | 2.1 × 10⁰ |
| | Sodium arsenate | 9.2 × 10⁻¹ |
| | Potassium arsenate | 7.4 × 10⁻¹ |
| Silicates | Sodium silicate | 1 × 10⁰ |
| | Potassium silicate | 1 × 10⁰ |
| Borates | Boric acid | 1.1 × 10⁰ |
| | Ammonium borate | 2.8 × 10⁻¹ |
| | Lithium borate | 5.2 × 10⁻¹ |
| | Sodium borate | 3.9 × 10⁰ |
| | Potassium borate | 8.7 × 10⁰ |
| Aluminates | Sodium aluminate | 1 × 10⁰ |
| | Potassium aluminate | 1 × 10⁰ |

The maximum concentration of organic valence stabilizers is also dependent upon precursor solubility. Because of the very large number of potential organic valence stabilizers, precursor solubilities are not shown.

The minimum concentration of valence stabilizer is dependent upon the specific Ce⁺⁴-, Pr⁺⁴-, or Tb⁺⁴-valence stabilizer complex being formed within the rinsed or sealed coating. The number of complexing octahedra or icosahedra around the central Ce⁺⁴ ion varies from species to species (e.g., molybdates vs. tungstates). Varying the concentration of the complexing agent while keeping the Ce⁺⁴ concentration constant resulted in clear differences in corrosion protection. The degree of corrosion protection was found to fall off dramatically below a valence stabilizer-to-cerium or valence stabilizer-to-praseodymium ratio of about 0.01. Therefore, the minimum valence stabilizer-to-cerium, valence stabilizer-to-praseodymium, or valence stabilizer-to-terbium ratio is about 0.010, with ratios higher than 0.015 being typical.

4) Oxidizer Concentrations

The concentration of the oxidizer source can range up to the maximum solubility of the specific oxidizer source used. Any concentration exceeding this solubility will result in undissolved solid material that will not be available to raise the redox potential of the rinse or seal solution. The maximum concentration of oxidizer source should be restricted to its maximum solubility in water at or near ambient temperature (25° C.). As discussed above, more oxidizer can be added to the solutions if the temperature is increased from ambient. Higher temperatures may lead to higher allowable concentrations of oxidizer precursors, but cooling of these solutions will result in reagent precipitation. Table 7 shows the solubilities in water of some of the more desirable oxidizer sources.

TABLE 7
Solubilities of Some Oxidizer Sources under
Ambient Conditions [Maximum Concentration
of Oxidizer in Solution]
(At or near 25° C. and at or near pH 7)

| | | Solubility in |
|---|---|---|
| Oxidizer Source | Example Precursor | Water (mole/L) |
| Peroxides and superoxides | Hydrogen peroxide | 60 wt. % |
| | Lithium peroxide | 1 × 10⁰ |
| | Sodium peroxide | 1 × 10⁰ |
| | Potassium superoxide | 1 × 10⁰ |
| Persulfates | Ammonium persulfate | 2.6 × 10⁰ |
| | Lithium persulfate | 3 × 10⁰ |
| | Sodium persulfate | 3.1 × 10⁰ |
| | Potassium persulfate | 2.0 × 10⁻¹ |
| | Magnesium persulfate | 1 × 10¹ |
| | Calcium persulfate | 1 × 10¹ |
| | Strontium persulfate | 5 × 10⁰ |
| | Barium persulfate | 1.3 × 10⁰ |
| Perborates | Ammonium perborate | 1.8 × 10⁻¹ |
| | Lithium perborate | 1 × 10⁻¹ |
| | Sodium perborate | 1.7 × 10⁻¹ |
| | Potassium perborate | 1.1 × 10⁻¹ |
| Peroxybenzoates | Monoperoxyphthalic acid | 1 × 10¹ |
| | Magnesium | 1 × 10¹ |
| | monoperoxyphthalate | |
| | Chloroperoxybenzoic acid | 1 × 10¹ |
| Chlorites | Lithium chlorite | 5 × 10⁰ |
| | Sodium chlorite | 4.3 × 10⁰ |
| | Calcium chlorite | 1 × 10⁰ |
| | Strontium chlorite | 5 × 10⁻¹ |
| | Barium chlorite | 1 × 10⁻¹ |
| Bromates | Ammonium bromate | 1 × 10¹ |
| | Lithium bromate | 4.85 × 10⁰ |
| | Sodium bromate | 1.82 × 10⁰ |
| | Potassium bromate | 8.0 × 10⁻¹ |
| | Rubidium bromate | 1.4 × 10⁻¹ |
| | Cesium bromate | 1.4 × 10⁻¹ |
| | Magnesium bromate | 1.1 × 10⁰ |
| | Calcium bromate | 1.2˜1 × 10⁰ |
| | Strontium bromate | 9.1 × 10⁻¹ |
| | Zinc bromate | 1 × 10⁰ |
| | Ferric bromate | 1 × 10⁰ |
| Hypochlorites | Lithium hypochlorite | 1 × 10¹ |
| | Sodium hypochlorite | 1 × 10¹ |
| | Magnesium hypochlorite | 1 × 10¹ |
| | Calcium hypochlorite | 1 × 10¹ |
| | Strontium hypochlorite | 5 × 10⁰ |
| | Barium hypochlorite | 5 × 10⁰ |
| Periodates | Periodic acid | 4.96 × 10¹ |
| | Ammonium periodate | 1.3 × 10⁻¹ |
| | Lithium periodate | 1 × 10⁰ |
| | Sodium periodate | 6.7 × 10⁻¹ |
| | Potassium periodate | 2.9 × 10⁻² |
| | Rubidium periodate | 2.4 × 10⁻² |
| | Cesium periodate | 6.6 × 10⁻² |
| | Magnesium periodate | 1 × 10⁻² |
| chlorates | Lithium chlorate | 5.5 × 10¹ |
| | Sodium chlorate | 7.5 × 10⁰ |
| | Potassium chlorate | 5.8 × 10⁻¹ |
| | Rubidium chlorate | 3.0 × 10⁻¹ |
| | Cesium chlorate | 2.9 × 10⁻¹ |
| | Magnesium chlorate | 4.3 × 10⁰ |
| | Calcium chlorate | 7.4 × 10⁰ |
| | Strontium chlorate | 6.9 × 10⁰ |
| | Zinc chlorate | 8.6 × 10⁰ |
| | Barium chlorate | 8.5 × 10⁻¹ |
| Perchlorates | Perchloric acid | 75 wt. % |
| | Ammonium perchlorate | 1.1 × 10⁰ |
| | Lithium perchlorate | 5.6 × 10⁰ |
| | Sodium perchlorate | 1.2 × 10¹ |
| | Potassium perchlorate | 3.6 × 10⁻¹ |
| | Rubidium perchlorate | 2.2 × 10⁻¹ |
| | Cesium perchlorate | 8.6 × 10⁻² |
| | Magnesium perchlorate | 4.4 × 10⁰ |
| | Calcium perchlorate | 7.9 × 10⁰ |
| | Strontium perchlorate | 1.3 × 10¹ |
| | Zinc perchlorate | 1 × 10⁰ |
| | Barium perchlorate | 5.1 × 10⁰ |
| | Aluminum perchlorate | 1 × 10⁰ |
| | Ferric perchlorate | 1 × 10⁰ |
| | Me₄N⁺ perchlorate | 1 × 10⁰ |
| | Et₄N⁺ perchlorate | 5 × 10⁻¹ |
| | Pr₄N⁺ perchlorate | 1 × 10⁻¹ |
| Nitrates | Nitric acid | 75 wt. % |
| | Ammonium nitrate | 2.5 × 10¹ |
| | Lithium nitrate | 1.35 × 10¹ |
| | Sodium nitrate | 1.15 × 10¹ |
| | Potassium nitrate | 7.4 × 10⁰ |
| | Rubidium nitrate | 3.0 × 10⁰ |
| | Cesium nitrate | 2.1 × 10⁰ |
| | Magnesium nitrate | 4.9 × 10⁰ |
| | Calcium nitrate | 2.15 × 10¹ |
| | Strontium nitrate | 3.4 × 10⁰ |
| | Zinc nitrate | 6.2 × 10⁰ |
| | Barium nitrate | 3.3 × 10⁻¹ |
| | Aluminum nitrate | 1.75 × 10⁰ |
| | Ferric nitrate | 5.7 × 10⁰ |
| | Me₄N⁺ nitrate | 1 × 10¹ |
| | Et₄N⁺ nitrate | 5 × 10⁰ |
| | Pr₄N⁺ nitrate | 1 × 10⁰ |
| | Bu₄N⁺ nitrate | 5 × 10⁻¹ |
| Nitrites | Lithium nitrite | 2.8 × 10¹ |
| | Sodium nitrite | 1.35 × 10¹ |
| | Potassium nitrite | 3.5 × 10¹ |
| | Magnesium nitrite | 1 × 10⁰ |
| | Calcium nitrite | 3.9 × 10⁰ |
| | Strontium nitrite | 3.8 × 10⁰ |
| | Zinc nitrite | 1 × 10⁰ |
| | Barium nitrite | 2.9 × 10⁰ |
| Vanadates | Vanadium pentoxide | 4.4 × 10⁻² |
| | Ammonium vanadate | 4.4 × 10⁻² |
| | Lithium vanadate | 1 × 10⁰ |
| | Sodium vanadate | 1.7 × 10⁰ |
| | Potassium vanadate | 1 × 10⁰ |
| | Rubidium vanadate | 5 × 10⁻¹ |
| | Cesium vanadate | 5 × 10⁻¹ |
| | Magnesium vanadate | 1 × 10⁰ |
| | Calcium vanadate | 5 × 10⁻¹ |
| Iodates | Iodic acid | 1.76 × 10¹ |
| | Iodine pentoxide | 5.6 × 10⁰ |
| | Ammonium iodate | 2.6 × 10⁻¹ |
| | Lithium iodate | 4.4 × 10⁰ |
| | Sodium iodate | 4.5 × 10⁻¹ |
| | Potassium iodate | 2.2 × 10⁻¹ |
| | Rubidium iodate | 8.1 × 10⁻² |
| | Cesium iodate | 8.4 × 10⁻² |
| | Magnesium iodate | 2.29 × 10⁻¹ |
| Permanganates | Ammonium permanganate | 5.77 × 10⁻¹ |
| | Lithium permanganate | 3.97 × 10⁰ |
| | Sodium permanganate | 1 × 10⁰ |
| | Potassium permanganate | 4.04 × 10⁻¹ |
| | Magnesium permanganate | 1 × 10¹ |
| | Calcium permanganate | 9.18 × 10⁰ |
| | Strontium permanganate | 7.67 × 10⁰ |
| | Barium permanganate | 2.01 × 10⁰ |
| | Zinc permanganate | 8.10 × 10⁻¹ |
| | Ferric permanganate | 1 × 10⁰ |

Low oxidizer concentrations may not oxidize a sufficient quantity of cerium, praseodymium, or terbium from the trivalent state to the tetravalent state. This would result in reduced corrosion-inhibiting performance. The redox potential of the coating solutions tends to decrease slowly with time (e.g., several days), so these solutions typically need additions of oxidizer to maintain the redox potential. The net redox potential of the coating solution is also a function of the surface area of the metal that has been coated.

5) Preparative Agent Concentrations

The concentration of the optional preparative agent is also important for the rinse and sealing solutions. If used, the concentration of the fluoride generally should not exceed 0.5 M (up to 5.0 M F⁻ can be used for some specialized applications, such as on anodized titanium or magnesium). Careful control of the available F⁻ should be exercised so that excessive back-etching of the existing barrier layer (e.g., phosphate or hydroxide/oxide) does not occur. In some applications (i.e., anodized aluminum that is to be color dyed) it may be desirable to have no preparative agent at all. Solubility values for many fluorides (the typical preparative agent) are given in Table 8. Of course, variations in the solution temperature and pH will change the solubilities of each of these preparative agents, but the values given below can be used as general approximations.

TABLE 8
Solubilities of Fluoride Preparative Agents
under Ambient Conditions [Maximum Allowable
Concentrations in Solution]
(At or near 25° C. and at or near pH 7)

| | | Solubility in |
|---|---|---|
| Fluoride Source | Example Precursor | Water (mole/L) |
| Simple Fluorides | Hydrofluoric acid | 75 wt. % |
| | Ammonium fluoride | 2.7 × 10¹ |
| | Lithium fluoride | 1.04 × 10⁻¹ |
| | Sodium fluoride | 1.01 × 10⁰ |
| | Potassium fluoride | 1.59 × 10¹ |
| | Potassium bifluoride | 5.25 × 10⁰ |
| | Rubidium fluoride | 1.25 × 10¹ |
| | Cesium fluoride | 2.42 × 10¹ |
| | Copper (II) fluoride | 4.62 × 10⁻¹ |
| | Silver (I) fluoride | 1.43 × 10¹ |
| | Zinc fluoride | 1.57 × 10⁻¹ |
| | Aluminum fluoride | 6.6 × 10⁻² |
| | Titanium fluoride | 1 × 10⁰ |
| | Zirconium fluoride | 8.3 × 10⁻² |
| | Germanium fluoride hydrate | 1 × 10⁻¹ |
| | Tin (II) fluoride | 1 × 10⁻¹ |
| | Tin (IV) fluoride | 1 × 10⁰ |
| | Vanadium fluoride | 1 × 10⁻¹ |
| | Niobium fluoride | 1 × 10⁰ |
| | Tantalum fluoride | 1 × 10⁻¹ |
| | Antimony (III) fluoride | 3.15 × 10⁻¹ |
| | Antimony (V) fluoride | 1 × 10⁰ |
| | Manganese (II) fluoride | 7.1 × 10⁻² |
| | Cobalt (II) fluoride | 1.55 × 10⁻¹ |
| Hexafluorozirconates | Ammonium fluorozirconate | 1 × 10⁻¹ |
| | Lithium hexafluorozirconate | 8 × 10⁻² |
| | Sodium hexafluorozirconate | 6 × 10⁻² |
| | Potassium hexafluorozirconate | 8.12 × 10⁻² |
| | Rubidium hexafluorozirconate | 8.48 × 10⁻² |
| | Cesium hexafluorozirconate | 1.12 × 10⁻¹ |
| Hexafluorotitanates | Ammonium hexafluorotitanate | 1 × 10⁻¹ |
| | Lithium hexafluorotitanate | 5 × 10⁻² |
| | Sodium hexafluorotitanate | 1 × 10⁻² |
| | Potassium hexafluorotitanate | 6.0 × 10⁻² |
| | Rubidium hexafluorotitanate | 2.5 × 10⁻² |
| | Cesium hexafluorotitanate | 5.5 × 10⁻² |
| Hexafluorosilicates | Ammonium hexafluorosilicate | 1.04 × 10⁰ |
| | Lithium hexafluorosilicate | 3.8 × 10⁰ |
| | Sodium hexafluorosilicate | 3.5 × 10⁻² |
| | Potassium hexafluorosilicate | 5.5 × 10⁻³ |
| | Rubidium hexafluorosilicate | 6.9 × 10⁻³ |
| | Cesium hexafluorosilicate | 2.3 × 10⁻² |
| | Silver (I) hexafluorosilicate | 1 × 10⁰ |
| | Magnesium hexafluorosilicate | 3.9 × 10⁰ |
| | Calcium hexafluorosilicate | 5 × 10⁻¹ |
| | Strontium hexafluorosilicate | 1.1 × 10⁻¹ |
| | Zinc hexafluorosilicate | 1.11 × 10⁰ |
| | Copper (II) hexafluorosilicate | 7.4 × 10⁰ |
| | Cobalt (II) hexafluorosilicate | 3.82 × 10⁰ |
| | Manganese (II) Fluorosilicate | 4.59 × 10⁰ |
| | Iron (II) hexafluorosilicate | 4.19 × 10⁰ |
| | Iron (III) hexafluorosilicate | “soluble” |
| Hexafluoroaluminates | Ammonium fluoroaluminate | 5.3 × 10⁻² |
| | Lithium hexafluoroaluminate | 6.6 × 10⁻³ |
| | Sodium hexafluoroaluminate | 2.9 × 10⁻³ |
| | Potassium fluoroaluminate | 6.1 × 10⁻³ |
| Tetrafluoroborates | Ammonium tetrafluoroborate | 2.4 × 10⁰ |
| | Lithium tetrafluoroborate | 5 × 10⁰ |
| | Sodium tetrafluoroborate | 9.8 × 10⁰ |
| | Potassium tetrafluoroborate | 3.5 × 10⁻² |
| | Rubidium tetrafluoroborate | 1 × 10⁻¹ |
| | Cesium tetrafluoroborate | 5 × 10⁻¹ |
| Hexafluorogermanates | Ammonium fluorogermanate | 1 × 10⁰ |
| | Lithium hexafluorogermanate | 1 × 10⁰ |
| | Sodium hexafluorogermanate | 1 × 10⁻² |
| | Potassium fluorogermanate | 2.2 × 10⁻² |
| | Rubidium fluorogermanate | 1.7 × 10⁻² |
| | Cesium hexafluorogermanate | 4.7 × 10⁻² |
| Hexafluorostannates | Ammonium fluorostannate | 1 × 10⁻¹ |
| | Lithium hexafluorostannate | 1 × 10⁻² |
| | Sodium hexafluorostannate | 1 × 10⁻² |
| | Potassium hexafluorostannate | 1.28 × 10⁻¹ |
| | Rubidium hexafluorostannate | 6.2 × 10⁻² |
| | Cesium hexafluorostannate | 7.9 × 10⁻² |
| Hexafluorohafnates | Ammonium hexafluorohafnate | 1 × 10⁰ |
| | Lithium hexafluorohafnate | 1 × 10⁻¹ |
| | Sodium hexafluorohafnate | 7 × 10⁻² |
| | Potassium hexafluorohafnate | 1.3 × 10⁻¹ |
| | Rubidium hexafluorohafnate | 1.9 × 10⁻¹ |
| | Cesium hexafluorohafnate | 1.7 × 10⁻¹ |
| Fluorogallates | Ammonium fluorogallate | 1 × 10⁻² |
| | Alkali/Alkaline fluorogallates | 1 × 10⁻² |
| | Silver (I) fluorogallate | 1 × 10⁰ |
| | Copper (II) fluorogallate | 1 × 10⁻² |
| | Zinc fluorogallate | 1 × 10⁻¹ |
| | Manganese (II), iron (II), and | 1 × 10⁻² |
| | cobalt (II) fluorogallates | |
| Hexafluorophosphates | Ammonium fluorophosphate | 1 × 10⁰ |
| | Lithium hexafluorophosphate | 2 × 10⁰ |
| | Sodium hexafluorophosphate | 5.6 × 10⁰ |
| | Potassium fluorophosphate | 5.1 × 10⁻¹ |
| | Rubidium fluorophosphate | 1 × 10⁻¹ |
| | Cesium hexafluorophosphate | 1 × 10⁻¹ |
| Hexafluoroantimonates | Ammonium fluoroantimonate | 4.7 × 10⁰ |
| | Lithium hexafluoroantimonate | 1 × 10⁰ |
| | Sodium hexafluoroantimonate | 4.97 × 10⁰ |
| | Potassium fluoroantimonate | 3.7 × 10⁰ |
| | Rubidium fluoroantimonate | 1.6 × 10⁰ |
| | Cesium hexafluoroantimonate | 5 × 10⁰ |
| Heptafluoroniobates | Lithium heptafluoroniobate | 5 × 10⁻¹ |
| | Sodium heptafluoroniobate | 5 × 10⁻² |
| | Potassium heptafluoroniobate | 2.6 × 10⁻¹ |
| | Rubidium heptafluoroniobate | 1 × 10⁻¹ |
| | Cesium heptafluoroniobate | 3 × 10⁻¹ |
| Heptafluorotantalates | Lithium heptafluorotantalate | 5 × 10⁻¹ |
| | Sodium heptafluorotantalate | 5 × 10⁻² |
| | Potassium heptafluorotantalate | 3 × 10⁻¹ |
| | Rubidium heptafluorotantalate | 1 × 10⁻¹ |
| | Cesium heptafluorotantalate | 3 × 10⁻¹ |

6) Solubility Control Agent Concentrations

The concentration of the optional solubility control agent can be any concentration up to its maximum solubility under ambient conditions. Exceeding the solubility will result in undissolved solid material that will not be available for adjusting the solubility of the cerium-, praseodymium-, or terbium-stabilizer complex. The solubilities of potential solubility control agents are not shown because of the large number of cationic or anionic species which can be used. Standard values for the solubilities of these materials in water can be used as the maximum allowable concentrations in the prepared solutions.

7) Rinse/Seal Solution pH

The rinse or seal solutions should have a slightly acidic or neutral pH so that a rise in pH caused by 1) interaction with the already-formed, hydrated barrier film (no preparative agent) or 2) barrier layer dissolution (with preparative agent) will result in a rise in local pore pH and the precipitation of the desired inhibitor species. Solution pH must not be so low that the pH rise during the rinsing or sealing process is insufficient to result in inhibitor precipitation. Very low pH values will result in excessive dissolution of the existing barrier film.

The maximum practical pH of the rinse or sealing solution is about 9, and the lowest practical pH is −1.5. Optimally, however, the pH of the rinse or sealing solutions should not be higher than about 8 or lower than about 1 or 2. For anodized aluminum that is to be colored, the pH range can be from about 4.5 to about 6.5. The pH of the tetravalent cerium, praseodymium, or terbium sealing or rinsing solutions should be checked periodically to confirm that it falls within operational parameters. Separate solutions that contain either valence stabilizers or optional solubility control agents generally do not require careful pH control.

8) Redox Potential of the Coating Solution

The necessary oxidation-reduction (redox) potential of the rinse or sealing solution is a function of both the solution pH and the cerium, praseodymium, or terbium concentration. Approximate values for the necessary redox potential of the cerium solution can be derived from the Pourbaix diagram for cerium and are shown in Table 9. Tetravalent cerium may be produced in solution at slightly lower redox values than those in Table 9 if the cerium is already complexed with suitable valence stabilizers. Tetravalent praseodymium or terbium may also be formed in a coating, provided that the redox potential is sufficiently high, and that the optimum valence stabilizer for Pr⁺⁴ and/or Th⁺⁴ is used. An approximate value of the necessary redox potential for Pr⁺⁴ and Th⁺⁴ can be derived by adding 0.3 to 0.4 V to those shown in Table 9.

TABLE 9
Approximate Potential as a Function of Rinse
or Sealing Solution pH

| | Minimum |
|---|---|
| pH | Redox Potential (V) |
| 0 | 1.7 |
| 1 | 1.6 |
| 2 | 1.5 |
| 3 | 1.3 |
| 4 | 1.1 |
| 5 | 1.0 |
| 6 | 0.8 |
| 7 | 0.7 |

These redox potentials can be achieved through chemical (or electrochemical) means. We have observed that the redox potential of these solutions will slowly drop over a period of several days. The redox potential of the rinse or sealing solution should be brought back up to those values shown in Table 9 if this occurs. Periodic evaluation of the redox potential of these solutions can be achieved using ASTM D 1498 (Oxidation-Reduction Potential of Water) or comparable test procedures. The redox potential of any post-treatment solution that contains valence stabilizer or optional additional solubility control agent does not require control.

9) Application Temperature

The application temperature can be any temperature between the freezing and boiling points of the rinse or sealing solution, although temperatures at or near ambient (20-25° C.) are desirable in view of process economics. A typical temperature range is therefore between about 20 and about 50° C. Application temperatures that are cooler than the typical range will result in a much slower coating deposition rate and may result in incomplete film formation. Temperatures higher than the typical range (e.g., about 50 to about 100° C.) can be used, especially to increase the hydration of the existing barrier layer. This will lead to a much more rapid pH rise in the pores to be treated, thereby further enhancing inhibitor formation and precipitation. If coloring is desired (i.e., on anodized aluminum), higher sealing temperatures will result in darker shades. However, the economics associated with a substantial temperature increase over ambient is balanced against the benefits derived from this additional energy expenditure, especially if less costly methods to reach the same performance (e.g., use of a preparative agent) are available.

10) Contact Time

The contact time for the solutions should be sufficient to allow the formation of a tetravalent cerium, praseodymium, or terbium inhibitor species within the pores of the treated coating. A minimum contact time of about 1 minute under ambient conditions to an average time of about 5 minutes should be appropriate. A maximum contact time of 30 minutes may be acceptable under some circumstances (i.e., for anodized aluminum). Longer immersion times will result in darker shades on colored coatings. Rinse or sealing solutions kept in contact with the work piece for longer times did not appear to produce adverse effects on the test specimens.

### A) General Application Process

The general process flow diagram for the application of the optimized tetravalent cerium, praseodymium, or terbium rinse or seal solutions is as follows for a typical work piece:

a) Precleaning (if required)

b) Masking (if required)

c) Alkaline cleaning/rinsing; or other cleaning process

d) Deoxidizing/pickling/rinsing (if required)

e) Formation of barrier film (e.g., those listed in Table 1)

f) Rinsing (if required)

g) Application of tetravalent cerium, praseodymium, and/or terbium rinsing or sealing solution

h) Rinsing (optional)

i) Post-coating treatment (if stabilizer or cerium, praseodymium, or terbium not included in original solution)

j) Rinsing

k) Hot water seal (optional)

l) Drying (if required)

m) Application of other coatings

Each of these processing steps are discussed briefly as follows:

a) Precleaning (if required)

Heavy oils or greases on the part to be coated are removed using an appropriate technique, such as vapor degreasing.

b) Masking (if required)

Any areas that are not to be coated with the barrier film are masked off using appropriate maskants. Any system component that may be adversely affected by the barrier film coating process should also be masked off.

c) Alkaline Cleaning/Rinsing

Alkaline cleaning is performed using appropriate alkaline cleaning solutions in accordance with manufacturers' specifications in order to remove small traces of oils or hydrocarbon contaminants on the metal surface. These alkaline cleaning solutions typically need elevated temperatures for application. Following alkaline cleaning, the metal piece should be rinsed while reducing as much drag-out as possible from the alkaline cleaning bath.

d) Deoxidizing/Pickling/Rinsing

Deoxidizing or pickling should be performed using appropriate deoxidizing solutions in accordance with performance specifications in order to remove the natural oxide film on the surface of the metal piece. Following deoxidizing or pickling, the metal piece is thoroughly rinsed while reducing as much drag-out as possible from the deoxidizing bath.

e) Formation of Barrier Coating

The barrier coating is formed either through immersion, spray application, fogging, or manual application using methodologies that are described for each specific process. Table 1 describes some of the barrier film formation processes that can be treated using the embodiments contained herein.

f) Rinsing (if required)

Standard rinse procedures are used. Rinsing after the formation of the barrier film is almost always necessary. For phosphate barrier films, this is especially important. This rinse helps to avoid blistering of any subsequently applied paint from residual phosphating solution, as well as to prevent contamination of the rinsing or sealing solution if the work piece is to be dipped. A thorough deionized water rinse, especially around holes or slots, or in crevices of the work piece, is frequently used. The temperature of these rinses is typically between about 20 and about 50° C., with exposure times of approximately 2 minutes. For some anodic coatings, agents such as bicarbonate, oxalic acid, or phthalic acid are sometimes added.

g) Application of Tetravalent Cerium, Praseodymium, and/or Terbium Rinsing or Sealing Solution

The rinsing or sealing solution is applied through immersion, spray application, fogging, or manual application using embodiments discussed herein.

h) Rinsing (optional)

Rinsing is typical after application of the cerium, praseodymium, and/or terbium rinsing or sealing solution. In some instances (e.g., if a subsequent valence stabilizer or solubility control agent solution is to be applied), it may not be advisable to rinse.

i) Post-Coating Treatment

If the tetravalent cerium, praseodymium, and/or terbium stabilizer is not included in the original rinse or sealing bath, then a second solution application (either by immersion, spray application, fogging, or manual application) is necessary. This second solution application would contain the cerium, praseodymium, and/or terbium valence stabilizer. If the valence stabilizer is contained in the first treatment (see step g) above) without cerium, praseodymium, or terbium then the cerium, praseodymium, or terbium would be included in this treatment. Likewise, if additional solubility control is necessary, then this can be achieved through the application of a post-treatment solution.

j) Rinsing

Standard rinse procedures are used.

k) Hot water seal (optional)

If further sealing of the coating (especially for anodic coatings) is desired, a hot water (>50° C.) seal using pure water can be applied. Bleaching of the coating to remove color can also be performed at this point.

l) Drying (if required)

Standard drying method may be used.

m) Application of other coatings

Application of other coatings is performed at this time. For items that are to be used as wear materials (i.e., manganese, zinc phosphate, or black oxide coatings from step e), this frequently involves an oil dip. For anodized coatings, a post-treatment composed of silicates, polymers, or lacquers is frequently applied.

While the invention has been described by reference to certain embodiments, it should be understood that numerous changes could be made within the spirit and scope of the inventive concepts described. Accordingly, it is intended that the invention not be limited to the disclosed embodiments, but that it have the full scope permitted by the language of the following claims.

We claim:

1. A corrosion-inhibiting seal for a barrier film comprising a rare earth element and a valence stabilizer combined to form a rare earth/valence stabilizer complex, wherein
the rare earth element is selected from cerium, praseodymium, terbium, or combinations thereof, and
at least one rare earth element is in the tetravalent oxidation state.

2. The corrosion-inhibiting seal of claim 1 wherein the rare earth/valence stabilizer complex has a solubility in water of between about 5×10⁻¹ and about 1×10⁻⁵ moles per liter of cerium, praseodymium, or terbium at about 25° C. and about 760 Torr.

3. The corrosion-inhibiting seal of claim 2 wherein the solubility in water of the rare earth/valence stabilizer complex is between about 5×10⁻² and about 5×10⁻⁵ moles per liter of cerium, praseodymium, or terbium at about 25° C. and about 760 Torr.

4. The corrosion-inhibiting seal of claim 1 wherein there is an electrostatic barrier layer around the rare earth/valence stabilizer complex in aqueous solution.

5. The corrosion-inhibiting seal of claim 1 wherein the rare earth/valence stabilizer complex acts as an ion exchange agent towards corrosive ions.

6. The corrosion-inhibiting seal of claim 1 wherein the barrier film comprises a compound selected from oxides, hydroxides, phosphates, carbonates, oxalates, silicates, aluminates, borates, polymers, or combinations thereof.

7. The corrosion-inhibiting seal of claim 1 wherein the rare earth/valence stabilizer complex has a central cavity containing a cerium, praseodymium, or terbium ion and an additional ion.

8. The corrosion-inhibiting seal of claim 7 wherein the additional ion is B⁺³, Al⁺³, Si⁺⁴, P⁺⁵, Ti⁺⁴, V⁺⁵, V⁺⁴, Cr⁺⁶, Cr⁺³, Mn⁺⁴, Mn⁺³, Mn⁺², Fe⁺³, Fe⁺², Co⁺², Co⁺³, Ni⁺², Ni⁺³, Ni⁺⁴, Cu⁺², Cu⁺³, Zn⁺², Ga⁺³, Ge⁺⁴, As⁺⁵, As⁺³, or Zr⁺⁴.

9. The corrosion-inhibiting seal of claim 1 wherein the valence stabilizer is selected from an inorganic valence stabilizer and an organic valence stabilizer.

10. The corrosion-inhibiting seal of claim 9 wherein the valence stabilizer is the inorganic valence stabilizer selected from molybdates, tungstates, vanadates, niobates, tantalates, tellurates, periodates, iodates, carbonates, antimonates, stannates, phosphates, nitrates, bromates, sulfates, titanates, zirconates, bismuthates, germanates, arsenates, selenates, borates, aluminates, silicates, or combinations thereof.

11. The corrosion-inhibiting seal of claim 10 wherein the valence stabilizer is the inorganic valence stabilizer selected from molybdates, tungstates, vanadates, niobates, tantalates, tellurates, periodates, iodates, carbonates, antimonates, stannates, phosphates, nitrates, bromates, sulfates, or combinations thereof.

12. The corrosion-inhibiting seal of claim 9 wherein the valence stabilizer is the organic valence stabilizer selected from monoamines; diamines; triamines; tetraamines; pentamines; hexamines; five- or six-membered heterocyclic rings containing one to four nitrogen atoms optionally having additional nitrogen, sulfur, or oxygen binding sites; five- or six-membered heterocyclic rings containing one or two sulfur atoms and having additional nitrogen binding sites; five- or six-membered heterocyclic rings containing one or two oxygen atoms and having additional nitrogen binding sites; (two-, three-, four-, six-, eight-, or ten-)membered nitrogen, nitrogen-sulfur, or nitrogen-oxygen macrocyclics; macrocyclic oligothioketones or dithiolenes; diazenes; thio-, amido-, or imido-derivatives of hypophosphoric, phosphoric, or diphosphoric acids and salts; thio-derivatives of hypophosphoric, phosphoric, or diphosphoric acids and salts; azo compounds, triazenes, formazans, azines, hydrazones, or Schiff Bases containing at least two azo, imine, or azine groups; azo compounds, triazenes, formazans, azines, hydrazones, or Schiff Bases; ortho-(for aryl) or alpha- or beta-(for alkyl) substituted azo compounds, triazenes, formazans, azines, hydrazones, or Schiff Bases; oximes; amidines and imido compounds; dithio ligands; amides; amino acids; N-(thio)acyl 7-aminobenzylidenimines; (thio)hydroxamates; alpha- or ortho-aminothio(di)carboxylic acids and salts; (thio)semicarbazones; (thio)acyl hydrazones; (thio)carbazones; silylaminoalcohols; thioalkyl amines and imines; hydroxyalkyl imines; (thio)aryl amines and imines; guanylureas; guanidinoureas; 2-nitrosophenols; 2-nitrophenols; N-nitrosohydroxylamines; 1,3-monothioketones; monothiomalonamides; 2-thioacylacetamides; 2-acylthioacetamides; dithiodicarbonic diamides; trithiodicarboxylic acids and salts; monothiocarbamates; monothioethers; dithioethers; trithioethers; tetrathioethers; pentathioethers; hexathioethers; disulfides; monophosphines; diphosphines; triphosphines; tetraphosphines; pentaphosphines; hexaphosphines; five- or six-membered heterocyclic rings containing one or two sulfur atoms optionally having additional sulfur, oxygen, or phosphorus binding sites; five- or six-membered heterocyclic rings containing one to three phosphorus atoms optionally having additional phosphorus, nitrogen, oxygen, or sulfur binding sites; five- or six-membered heterocyclic rings containing one to four nitrogen atoms and having additional phosphorus binding sites; five- or six-membered heterocyclic rings containing one or two oxygen atoms and optionally having additional sulfur or phosphorus binding sites; (five-, seven-, or nine-)membered nitrogen, nitrogen-sulfur, or nitrogen-oxygen macrocyclics; (two- to ten-)membered sulfur, sulfur-oxygen, or sulfur-phosphorus macrocyclics, not including oligothioketones or dithiolenes; (two- to ten-)membered phosphorus, nitrogen-phosphorus, or oxygen-phosphorus macrocyclics; (two- to ten-)membered oxygen macrocyclics; thio-, amido-, or imido-derivatives of phosphonic and diphosphonic acids and salts containing no sulfur binding sites; amido-, or imido-derivatives of hypophosphoric, phosphoric, or diphosphoric acids and salts containing no sulfur binding sites; dithioperoxydiphosphoramides; dithioperoxydiphosphoric acids and salts; monothioperoxydiphosphoramides; monothioperoxydiphosphoric acids and salts; monothiophosphoric acids; phosphoro(dithioperoxoic) acids and salts; azo compounds, triazenes, formazans, azines, or Schiff Bases; silylamines; silazanes; guanidines and diguanidines; pyridinaldimines; hydrazones; hydramides; nitriles; thioureas and thioamides; ureas and pseudoureas; biurets; monothio ligands; diketone ligands; dithioperoxydicarbonic acids and salts; dithioacyl disulfides; tetrathioperoxydicarbonic diamides; (hexa-, penta-, or tetra-)thioperoxydicarbonic acids and salts; 1,2-dithiolates; rhodanines; dithiocarbimates; (thio)xanthates; S-(alkyl- or aryl-thio)thiocarboxylic acids and salts; phosphinodithioformates; (thio)borates and (thio)boronates; (thio)arsonic acids and salts; (thio)antimonic acids and salts; phosphine and arsine sulfides or oxides; beta-hydroxyketones and -aldehydes; squaric acids and salts; carbonates; carbamates and carbimates; carbazates; imidosulfurous diamides; sulfurdiimines; thiocarbonyl and mercapto oximes; 2-nitrothiophenols; 2-nitrilo(thio)phenols; acylcyanamides; imidates; 2-amidinoacetates; beta-ketoamines; 3-aminoacrylamides and 3,3-diaminoacrylamides; 3-aminoacrylic acids and salts and 3-hydroxy-3-aminoacrylic acids and salts; 2-nitroanilines; amine and diazine N-oxides; hydrazides and semicarbazides; (amino- or imino-)aryl phosphines; (thio- or hydroxy-)aryl phosphines; arsines; five- or six-membered heterocyclic rings containing one arsenic atom optionally having additional arsenic binding sites; (two- to six-)membered arsenic macrocyclics; selenoethers; five- or six-membered heterocyclic rings containing one or two selenium atoms optionally having additional selenium binding sites; (two- to six-)membered selenium macrocyclics; 1,3-diselenoketones; 1,1-diselenolates; diselenocarbamates; selenophosphoric acids and salts; selenocarbonates; cyanide, isocyanide, and cyanamide ligands; nitrosyl and nitrite ligands; azide ligands; thiolates and selenolates; (thio)cyanate ligands; diene or bicyclic or tricyclic hydrocarbon ligands; carbonyl, halogen, oxo, and hydroxo ligands; or combinations thereof.

13. The corrosion-inhibiting seal of claim 12 wherein the organic valence stabilizer is selected from monoamines; diamines; triamines; tetraamines; pentamines; hexamines; five- or six-membered heterocyclic rings containing one to four nitrogen atoms optionally having additional nitrogen, sulfur, or oxygen binding sites; five- or six-membered heterocyclic rings containing one or two sulfur atoms and having additional nitrogen binding sites; five- or six-membered heterocyclic rings containing one or two oxygen atoms and having additional nitrogen binding sites; (two-, three-, four-, six-, eight-, or ten-)membered nitrogen, nitrogen-sulfur, or nitrogen-oxygen macrocyclics; macrocyclic oligothioketones or dithiolenes; diazenes; thio-, amido-, or imido-derivatives of hypophosphoric, phosphoric, or diphosphoric acids and salts; azo compounds, triazenes, formazans, azines, hydrazones, or Schiff Bases containing at least two azo, imine, or azine groups; azo compounds, triazenes, formazans, azines, hydrazones, or Schiff Bases; ortho-(for aryl) or alpha- or beta-(for alkyl) substituted azo compounds, triazenes, formazans, azines, hydrazones, or Schiff Bases; oximes; amidines and imido compounds; dithio ligands; amides; amino acids; N-(thio)acyl 7-aminobenzylidenimines; (thio)hydroxamates; alpha- or ortho-aminothio(di)carboxylic acids and salts; (thio)semicarbazones; (thio)acyl hydrazones; (thio)carbazones; silylaminoalcohols; thioalkyl amines and imines; hydroxyalkyl imines; (thio)aryl amines and imines; guanylureas; guanidinoureas; biurets; diketone ligands; amido- or imido-derivatives of hypophosphoric, phosphoric, or diphosphoric acids and salts; beta-hydroxyketones and -aldehydes; squaric acids and salts; carbonates; carbamates and carbimates; 2-nitrosophenols; 2-nitrophenols; N-nitrosohydroxylamines; 1,3-monothioketones; monothiomalonamides; 2-thioacylacetamides; 2-acylthioacetamides; dithiodicarbonic diamides; trithiodicarboxylic acids and salts; monothiocarbamates; (thio)cyanate ligands; or combinations thereof.

14. The corrosion-inhibiting seal of claim 12 wherein the organic valence stabilizer is the diazene selected from diazeneformimidamides, diazeneformamides, diazeneformothioamides, diazeneacetimidamides, diazeneacetothioamides, diazeneformimidic acids and salts, diazeneacetimidic acids and salts, diazenecarbothioic acids and salts, diazenecarbodithioic acids and salts, diazeneformimidothioic acids and salts, diazeneformaldehydes, diazeneformothioaldehydes, diazeneacetaldehydes, diazeneacetothioaldehydes, diazenediformamides, diazenediformothioamides, diazenediacetamides, diazenediacetothioamides, diazeneacetimidothioic acids and salts, imidoyldiazenes, diazenediformimidamides, diazenediacetimidamides, diazenediformimidic acids and salts, diazenediacetimidic acids and salts, diazenediformimidothioic acids and salts, diazenediacetimidothioic acids and salts, diazenedicarbothioic acids, diazenedicarbodithioic acids, diazeneformic acids, diazenediformic acids, diazeneacetic acids, diazenediacetic acids, diazenediformaldehydes, diazenediformothioaldehydes, diazenediacetaldehydes, diazenediacetothioaldehydes, diimidoyldiazenes, or combinations thereof.

15. The corrosion-inhibiting seal of claim 12 wherein the organic valence stabilizer is the thio-, amido-, or imido-derivative of hypophosphoric, phosphoric, or diphosphoric acids and salts selected from phosphoramidimidic triamides, phosphoramidimidic acids and salts, phosphorodiamidimidic acids and salts, phosphorodiamidimidothioic acids and salts, phosphoramidimidothioic acids and salts, phosphorodiamidimidodithioic acids and salts, phosphoramidimidodithioic acids and salts, (di- or mono-)thiohypophosphoric acids and salts, (di- or mono-)thiohypophosphoramides, phosphoramidic acids and salts, phosphorimidic acids and salts, (di- or mono-)thioimidodiphosphoric acids and salts, (di- or mono-)thiohydrazidodiphosphoric acids and salts, (di- or mono-)thioimidodiphosphoramides, (di- or mono-)thiohydrazidodiphosphoramides, phosphoric triamides, (di- or mono-)thiodiphosphoramides, (di- or mono-)thiodiphosphoric acids and salts, (tetra-, tri-, di-)thiophosphoric acids and salts, phosphoro(dithioperoxo)(mono-, di-, or tri-)thioic acids and salts, phosphorimido(mono-, di-, or tri-)thioic acids and salts, phosphorothioic triamides, phosphoramido(mono, di- or tri-)thioic acids and salts, phosphorodiamido(mono, di- or tri-)thioic acids and salts, or combinations thereof.

16. The corrosion-inhibiting seal of claim 12 wherein the organic valence stabilizer is the ortho-(for aryl) or alpha- or beta-(for alkyl) substituted azo compound, triazene, formazan, azine, hydrazone, or Schiff Base substituent selected from amino, imino, oximo, diazeno, hydrazido, thiol, mercapto, thiocarbonyl, hydroxy, carbox, and carbonyl substituents, or combinations thereof.

17. The corrosion-inhibiting seal of claim 12 wherein the organic valence stabilizer is the oxime selected from monooximes, dioximes, carbonyl oximes, imine oximes, hydroxy oximes, amino oximes, amido oximes, hydrazone oximes, azo oximes, or combinations thereof.

18. The corrosion-inhibiting seal of claim 12 wherein the organic valence stabilizer is the amidine and imido compound selected from amidines, diamidines, biguanides, biguanidines, diamidinomethanes, imidoylguanidines, amidinoguanidines, diformamidine oxides, diformamidine sulfides, diformamidine disulfides, imidodicarbonimidic acids and salts, diimidodicarbonimidic acids and salts, thioimidodicarbonimidic acids and salts, thiodiimidodicarbonimidic acids and salts, diimidoylimines, diimidoylhydrazides, imidosulfamides, diimidosulfamides, O-amidinocarbamates, O- or S-amidino(mono-, di-, or peroxy-)thiocarbamates, N-hydroxy(or N,N′-dihydroxy)amidines, diimidosulfuric acids and salts, or combinations thereof.

19. The corrosion-inhibiting seal of claim 14 wherein the organic valence stabilizer is the dithio ligand selected from dithioimidodialdehydes, dithiohydrazidodialdehydes, dithioimidodicarbonic acids and salts, dithiohydrazidodicarbonic acids and salts, 1,3-dithioketones, 1,2-dithioketones, dithiomalonamides, 2-thioacylthioacetamides, dithioacyl sulfides, trithiodicarbonic diamides, (penta-, tetra-, tri-)thiodicarbonic acids and salts, beta-mercaptothioketones and -aldehydes, N-(aminomethylthiol)thioureas, dithiooxamides, 1,1-dithiolates, (di- or per-)thiomonocarboxylic acids and salts, (tetra- or per-)thiodicarboxylic acids and salts, (di-, tri-, or per-)thiocarbonates, dithiocarbamates (including N-hydroxydithiocarbamates and N-mercaptodithiocarbamates), dithiocarbazates; or combinations thereof.

20. The corrosion-inhibiting seal of claim 14 wherein the organic valence stabilizer is the amide selected from monoamides, lactams, amidinoamides, guanidinoamides, imidoylamides, polyamides, polylactams, or combinations thereof.

21. The corrosion-inhibiting seal of claim 14 wherein the organic valence stabilizer is the thio-, amido-, or imido-derivative of phosphonic and diphosphonic acids and salts selected from phosphonitrile amides, phosphonimidic diamides, phosphonamidimidic acids and salts, phosphonamidimidothioic acids and salts, dithioimidodiphosphonic acids and salts, dithiohydrazidodiphosphonic acids and salts, dithioimidodiphosphonamides, dithiohydrazidodiphosphonamides, dithiodiphosphonamides, dithiodiphosphonic acids and salts, dithioperoxydiphosphonamides, dithioperoxydiphosphonic acids and salts, (di- and tri-)thiophosphonic acids and salts, phosphono(dithioperoxo)thioic acids and salts, phosphono(dithioperoxo)dithioic acids and salts, phosphonimidothioic acids and salts, phosphonimidodithioic acids and salts, phosphonothioic acids and salts, phosphonanidothioic acids and salts, phosphonamidimidodithioic acids and salts, monothioimidodiphosphonic acids and salts, monothiohydrazidodiphosphonic acids and salts, monothioimidodiphosphonamides, monothiohydrazidodiphosphonamides, monothiodiphosphonamides, monothiodiphosphonic acids and salts, monothioperoxydiphosphonamides, monothioperoxydiphosphonic acids and salts, monothiophosphonic acids and salts, phosphono(dithioperoxoic) acids and salts, or combinations thereof.

22. The corrosion-inhibiting seal of claim 12 wherein the organic valence stabilizer is the amido-, or imido-derivative of hypophosphoric, phosphoric, or diphosphoric acids and salts containing no sulfur binding sites selected from hypophosphoric acids and salts, hypophosphoramides, imidodiphosphoric acids and salts, hydrazidodiphosphoric acids and salts, imidodiphosphoramides, hydrazidodiphosphoramides, diphosphoramides, or combinations thereof.

23. The corrosion-inhibiting seal of claim 12 wherein the organic valence stabilizer is the amido-, or imido-derivative of phosphonic or diphosphonic acids and salts containing no sulfur binding sites selected from imidodiphosphonic acids and salts, hydrazidodiphosphonic acids and salts, imidodiphosphonamides, hydrazidodiphosphonamides, diphosphonamides, phosphonimidic acids and salts, phosphonamidic acids and salts, phosphonic diamides, or combinations thereof.

24. The corrosion-inhibiting seal of claim 12 wherein the organic valence stabilizer is the thiourea and thioamide selected from thioureas, thiocarboxamides, thioacylthioureas, acylthioureas, thioacylureas, thioaroylthioureas, aroylthioureas, thioaroylureas, thioimidates, thioguanylureas, guanidinothioureas, amidinothioamides, guanidinothioamides, imidoylthioamides, 3-aminothioacrylamides, thiohydrazides, thiosemicarbazides, (mono- and di-)thiobiurets, (mono- and di-)thioisobiurets, (mono- and di-)thiobiureas, N-(aminomethylol)thioureas, N-(aminomethylthiol)ureas, beta-mercaptocarboxamides, or combinations thereof.

25. The corrosion-inhibiting seal of claim 12 wherein the organic valence stabilizer is the biuret selected from biurets, triurets, isobiurets, biureas, triureas, acylureas, aroylureas, N-(aminomethylol)ureas, or combinations thereof.

26. The corrosion-inhibiting seal of claim 12 wherein the organic valence stabilizer is the monothio ligand selected from beta-aminothiones, 3-aminothioacrylic acids and salts, 3-mercapto-3-aminothioacrylic acids and salts, N-thioacyl benzylidenimines, thioimidodialdehydes, thiohydrazidodialdehydes, thioimidodicarbonic acids and salts, thiohydrazidodicarbonic acids and salts, 1,2-monothioketones, trithioperoxydicarbonic diamides, dithioperoxydicarbonic diamides, dithiodicarbonic acids and salts, trithioperoxydicarbonic acids and salts, beta-hydroxythioketones, beta-hydroxythioaldehydes, beta-mercaptoketones, beta-mercaptoaldehydes, monotbiooxamides, beta-mercaptocarboxylic acids and salts, beta-mercaptothiocarboxylic acids and salts, beta-hydroxythiocarboxylic acids and salts, S-alkylthiocarboxylic acids and salts, S-arylthiocarboxylic acids and salts, S-alkyldisulfidocarboxylic acids and salts, S-aryldisulfidocarboxylic acids and salts, monothiomonocarboxylic acids and salts, dithiodicarboxylic acids and salts, monothiocarbonates, monothiocarbazates, monothiocarbimates, mercaptoalcohols, silylmercaptoalcohols, or combinations thereof.

27. The corrosion-inhibiting seal of claim 12 wherein the organic valence stabilizer is the diketone ligand selected from imidodialdehydes, hydrazidodialdehydes, imidodicarbonic acids and salts, hydrazidodicarbonic acids and salts, imidodisulfamic acids and salts, imidodisulfuric acids and salts, 1,3-diketones, 1,2-diketones, malonamides, 2-acylacetamides, monothiodicarbonic diamides, monothiodicarbonic acids and salts, dithioperoxydicarbonic acids and salts, trithionic acids and salts, oxamides, dicarboxylic acids, or combinations thereof.

28. The corrosion-inhibiting seal of claim 12 wherein the organic valence stabilizer is the S-(alkyl- or aryl-thio)thiocarboxylic acid and salt selected from S-(alkylthio)thiocarboxylic acids and salts, S-(arylthio)thiocarboxylic acids and salts, S,S-thiobisthiocarboxylic acids and salts, S-(alkyldisulfido)thiocarboxylic acids and salts, S-(aryldisulfido)thiocarboxylic acids and salts, S,S′-disulfidobisthiocarboxylic acids and salts, or combinations thereof.

29. The corrosion-inhibiting seal of claim 12 wherein the organic valence stabilizer is the phosphine and arsine sulfide or oxide selected from phosphine P-sulfides, aminophosphine sulfides, arsine As-sulfides, aminoarsine sulfides, phosphine P-oxides, aminophosphine oxides, arsine As-oxides, aminoarsine oxides, or combinations thereof.

30. The corrosion-inhibiting seal of claim 12 wherein the solubility in water of the rare earth/valence stabilizer complex is adjusted by an addition of a substituent group on the organic valence stabilizer.

31. The corrosion-inhibiting seal of claim 30 wherein the solubility in water is increased by the addition of the substituent group selected from sulfonate groups (—SO₃⁻), carboxyl groups (—CO₂—), hydroxyl groups (—OH), ester groups (—CO₃—), carbonyl groups (═C═O), amine groups (—NH₂), nitrosamine groups (═N—N═O), carbonylnitrene groups (—CO—N), sulfoxide groups (═S═O), sulfone groups (═S[═O]₂), sulfinyl groups (—N═S═O), sulfodiimines (═S[═NH]₂), sulfonyl halide groups (—S[═O]₂X), sulfonamide groups (—S[═O]₂NH₂), monohalosulfonamide groups (—S[═O]₂NHX), dihalosulfonamide groups (—S[═O]₂MX₂), halosulfonate groups (—S[═O]₂OX), halosulfonate amide groups (═N—S[═O]₂X), aminosulfonate groups (═N—S[═O]₂OH), iminosulfonate groups (—N[SO₃⁻]₁₋₂), phosphonate groups (—PO₃⁻²), phosphonamide groups (—PO₂NH₂⁻), phosphondiamide groups (—PO[NH₂]₂), aminophosphonate groups (═N—PO₃⁻²), iminophosphonate groups (—N[PO₃⁻²]₁₋₂), or combinations thereof.

32. The corrosion-inhibiting seal of claim 30 wherein the solubility in water is decreased by the addition of the substituent group selected from nitro groups (—NO₂), perfluoroalkyl groups (—CₓF₂ₓ₊₁), perchloroalkyl groups (—CₓCl₂ₓ₊₁), nitramine groups (═N—NO₂), thioketone groups (═C═S), sulfenyl halide groups (—S—X), sulfur dihaloimide groups (—N═SX₂), or combinations thereof.

33. The corrosion-inhibiting seal of claim 12 wherein an electrostatic barrier layer of the rare earth/valence stabilizer complex is adjusted by an addition of a substituent group on the organic valence stabilizer.

34. The corrosion-inhibiting seal of claim 33 wherein the electrostatic barrier layer is increased by the addition of the substituent group selected from ketones (═C═O), thioketones (═C═S), amides (—C[═O]—NR₂), thioamides (—C[═S]—NR₂), nitriles or cyano groups (—CN), isocyanides (—NC), nitroso groups (—N═O), thionitroso groups (—N═S), nitro groups (—NO₂), azido groups (—N₃), cyanamide or cyanonitrene groups (═N—CN), cyanate groups (—O—CN), isocyanate groups (—N═C═O), thiocyanate groups (—S—CN), isothiocyanate groups (—N═C═S), nitrosamine groups (═N—N═O), thionitrosamine groups (═N—N═S), nitramine groups (═N—NO₂), thionitramine groups (═N—NS₂), carbonylnitrene groups (—CO—N), thiocarbonylnitrene groups (—CS—N), sulfenyl halides (—S—X), sulfoxides (═S═O), sulfones (═S[═O]₂), sulfinyl groups (—N═S═O), thiosulfinyl groups (—N═S═S), sulfenyl thiocyanato groups (—S—S—CN), sulfenyl cyanato groups (—S—O—CN), sulfodiimine groups (═S[═NH]₂), sulfur dihaloimido groups (—N═SX₂), sulfur oxide dihaloimido groups (—N═S[═O]X₂), aminosulfur oxide trihalide groups (═N—S[═O]X₃), sulfonyl azide groups (—S[═O]₂N₃), sulfonyl thiocyanate groups (—S[═O]₂SCN), sulfonyl cyanate groups (—S[═O]₂OCN), sulfonyl cyanide groups (—S[═O]₂CN), halosulfonate groups (—S[═O]₂OX), phosphonyl thiocyanate groups (—P[═O]OHSCN), phosphonyl cyanate groups (—P[═O]OHOCN), phosphonyl cyanide groups (—P[═O]OHCN), or combinations thereof.

35. The corrosion-inhibiting seal of claim 1 further comprising a solubility control agent.

36. The corrosion-inhibiting seal of claim 35 wherein the solubility control agent is a cationic solubility control agent or an anionic solubility control agent.

37. The corrosion-inhibiting seal of claim 36 wherein the solubility control agent is the cationic solubility control agent selected from H⁺; Li⁺; Na⁺; K⁺; Rb⁺; Cs⁺; NH₄⁺; Mg⁺²; Ca⁺²; Sr⁺²; Be⁺²; Ba⁺²; Y⁺³; La⁺³; Ce⁺³; Ce⁺⁴; Nd⁺³; Pr⁺³; Sc⁺³; Sm⁺³; Eu⁺³; Eu₊₂; Gd⁺³; Tb⁺³; Dy⁺³; Ho⁺³; Er⁺³; Tm⁺³; Yb⁺³; Lu⁺³; Ti⁺⁴; Zr⁺⁴; Ti⁺³; Hf⁺⁴; Nb⁺⁵; Ta⁺⁵; Nb⁺⁴; Ta⁺⁴; V⁺⁵; V⁺⁴, V⁺³, Mo⁺⁶; W⁺⁶; Mo⁺⁵; W⁺⁵; Mo⁺⁴; W⁺⁴, Cr⁺³; Mn⁺²; Mn⁺³; Mn⁺⁴; Fe⁺²; Fe⁺³; Co⁺²; Co⁺³; Ni⁺²; Ni⁺³; Ni⁺⁴; Ru⁺²; Ru⁺³; R⁺⁴; Rh⁺³; Ir⁺³; Rh⁺²; Ir⁺²; Pd⁺⁴; Pt⁺⁴; Pd⁺²; Pt⁺²; Os⁺⁴; Cu⁺; Cu⁺²; Cu⁺³; Ag⁺; Ag⁺²; Ag⁺³; Au⁺; Au⁺²; Au⁺³; Zn⁺²; Cd⁺²; Hg⁺; Hg⁺²; Al⁺³; Ga⁺³; Ga⁺; In⁺³; In⁺; Tl⁺³; Tl⁺; Ge⁺⁴; Ge⁺²; Sn⁺⁴; Sn⁺²; Pb⁺⁴; Pb⁺²; Sb⁺³; Sb⁺⁵; As⁺³; As⁺⁵; Bi⁺³; Bi⁺⁵; organic compounds containing at least one N⁺ site; organic compounds containing at least one phosphonium site; organic compounds containing at least one arsonium site; organic compounds containing at least one stibonium site; organic compounds containing at least one oxonium site; organic compounds containing at least one sulfonium site; organic compounds containing at least one selenonium site; organic compounds containing at least one iodonium site; quaternary ammonium compounds having a formula NR₄⁺, where R is an alkyl, aromatic, or acyclic organic constituent; or combinations thereof.

38. The corrosion-inhibiting seal of claim 37 wherein the cationic solubility control agent is selected from H⁺; Li⁺; Na⁺; K⁺; Rb⁺; Cs⁺; NH₄⁺; Mg⁺²; Ca⁺²; Sr⁺²; Y⁺³; La⁺³; Ce⁺³; Ce⁺⁴; Nd⁺³; Pr⁺³; Sc⁺³; Sm⁺³; Eu⁺³; Eu₊₂; Gd⁺³; Tb⁺³; Dy⁺³; Ho⁺³; Er⁺³; Tm⁺³; Yb⁺³; Lu⁺³; Ti⁺⁴; Zr⁺⁴; Ti⁺³; Hf⁺⁴; Nb⁺⁵; Ta⁺⁵; Nb⁺⁴; Ta⁺⁴; Mo⁺⁶; W⁺⁶; Mo⁺⁵; W⁺⁵; Mo⁺⁴; W⁺⁴, Mn⁺²; Mn⁺³; Mn⁺⁴; Fe⁺²; Fe⁺³; Co⁺²; Co⁺³; Ru⁺²; Ru⁺³; R⁺⁴; Rh⁺³; Ir⁺³; Rh⁺²; Ir⁺²; Pd⁺⁴; Pt⁺⁴; Pd⁺²; Pt⁺²; Cu⁺; Cu⁺²; Cu⁺³; Ag⁺; Ag⁺²; Ag⁺³; Au⁺; Au⁺²; Au⁺³; Zn⁺²; Al⁺³; Ga⁺³; Ga⁺; In⁺³; In⁺; Ge⁺⁴; Ge⁺²; Sn⁺⁴; Sn⁺²; Sb⁺³; Sb⁺⁵; Bi⁺³; Bi⁺⁵; organic compounds containing at least one N⁺ site; organic compounds containing at least one phosphonium site; organic compounds containing at least one stibonium site; organic compounds containing at least one oxonium site; organic compounds containing at least one sulfonium site; organic compounds containing at least one iodonium site; quaternary ammonium compounds having a formula NR₄⁺, where R is an alkyl, aromatic, or acyclic organic constituent; or combinations thereof.

39. The corrosion-inhibiting seal of claim 36 wherein the solubility control agent is the anionic solubility control agent selected from fluorotitanates, chlorotitanates, fluorozirconates, chlorozirconates, fluoroniobates, chloroniobates, fluorotantalates, chlorotantalates, molybdates, tungstates, permanganates, fluoromanganates, chloromanganates, fluoroferrates, chloroferrates, fluorocobaltates, chlorocobaltates, fluorozincates, chlorozincates, borates, fluoroborates, fluoroaluminates, chloroaluminates, carbonates, silicates, fluorosilicates, fluorostannates, nitrates, nitrites, azides, cyanamides, phosphates, phosphites, phosphonates, phosphinites, thiophosphates, thiophosphites, thiophosphonates, thiophosphinites, fluorophosphates, fluoroantimonates, chloroantimonates, sulfates, sulfites, sulfonates, thiosulfates, dithionites, dithionates, fluorosulfates, tellurates, fluorides, chlorides, chlorates, perchlorates, bromides, bromates, iodides, iodates, periodates, heteropolyanions, ferricyanides, ferrocyanides, cyanocobaltates, cyanocuprates, cyanomanganates, cyanates, cyanatoferrates, cyanatocobaltates, cyanatocuprates, cyanatomanganates, thiocyanates, thiocyanatoferrates, thiocyanatocobaltates, thiocyanatocuprates, thiocyanatomanganates, cyanamides, cyanamidoferrates, cyanamidocobaltates, cyanamidocuprates, cyanamidomanganates, nitritoferrates, nitritocobaltates, azides, (thio)carboxylates, di(thio)carboxylates, tri(thio)carboxylates, tetra(thio)carboxylates, (thio)phenolates, di(thio)phenolates, tri(thio)phenolates, tetra(thio)phenolates, (thio)phosphonates, di(thio)phosphonates, tri(thio)phosphonates, (thio)phosphonamides, di(thio)phosphonamides, tri(thio)phosphonamides, amino(thio)phosphonates, diamino(thio)phosphonates, triamino(thio)phosphonates, imino(thio)phosphonates, diimino(thio)phosphonates, (thio)sulfonates, di(thio)sulfonates, tri(thio)sulfonates, (thio)sulfonamides, di(thio)sulfonamides, tri(thio)sulfonamides, amino(thio)sulfonates, diamino(thio)sulfonates, triamino(thio)sulfonates, imino(thio)sulfonates, diimino(thio)sulfonates, (thio)borates, di(thio)borates, (thio)boronates, organic silicates, stibonates, cyanides, cyanochromates, cyanonickelates, cyanatochromates, cyanatonickelates, thiocyanatochromates, thiocyanatonickelates, cyanamidochromates, cyanamidonickelates, nitritonickelates, arsonates, diarsonates, triarsonates, organic selenates, diselenates, triselenates, arsenates, arsenites, fluoroarsenates, chloroarsenates, selenates, selenites, fluorothallates, chlorothallates, iodomercury anions, chloromercurates, bromomercurates, osmates, fluoronickelates, chromates, Reinecke's salt, vanadates, or combinations thereof.

40. The corrosion-inhibiting seal of claim 39 wherein the anionic solubility control agent is selected from fluorotitanates, chlorotitanates, fluorozirconates, chlorozirconates, fluoroniobates, chloroniobates, fluorotantalates, chlorotantalates, molybdates, tungstates, permanganates, fluoromanganates, chloromanganates, fluoroferrates, chloroferrates, fluorocobaltates, chlorocobaltates, fluorozincates, chlorozincates, borates, fluoroborates, fluoroaluminates, chloroaluminates, carbonates, silicates, fluorosilicates, fluorostannates, nitrates, nitrites, azides, cyanamides, phosphates, phosphites, phosphonates, phosphinites, thiophosphates, thiophosphites, thiophosphonates, thiophosphinites, fluorophosphates, fluoroantimonates, chloroantimonates, sulfates, sulfites, sulfonates, thiosulfates, dithionites, dithionates, fluorosulfates, tellurates, fluorides, chlorides, chlorates, perchlorates, bromides, bromates, iodides, iodates, periodates, heteropolyanions, ferricyanides, ferrocyanides, cyanocobaltates, cyanocuprates, cyanomanganates, cyanates, cyanatoferrates, cyanatocobaltates, cyanatocuprates, cyanatomanganates, thiocyanates, thiocyanatoferrates, thiocyanatocobaltates, thiocyanatocuprates, thiocyanatomanganates, cyanamides, cyanamidoferrates, cyanamidocobaltates, cyanamidocuprates, cyanamidomanganates, nitritoferrates, nitritocobaltates, azides, (thio)carboxylates, di(thio)carboxylates, tri(thio)carboxylates, tetra(thio)carboxylates, (thio)phenolates, di(thio)phenolates, tri(thio)phenolates, tetra(thio)phenolates, (thio)phosphonates, di(thio)phosphonates, tri(thio)phosphonates, (thio)phosphonamides, di(thio)phosphonamides, tri(thio)phosphonamides, amino(thio)phosphonates, diamino(thio)phosphonates, triamino(thio)phosphonates, imino(thio)phosphonates, diimino(thio)phosphonates, (thio)sulfonates, di(thio)sulfonates, tri(thio)sulfonates, (thio)sulfonamides, di(thio)sulfonamides, tri(thio)sulfonamides, amino(thio)sulfonates, diamino(thio)sulfonates, triamino(thio)sulfonates, imino(thio)sulfonates, diimino(thio)sulfonates, (thio)borates, di(thio)borates, (thio)boronates, organic silicates, stibonates, or combinations thereof.

41. The corrosion-inhibiting seal of claim 1 further comprising a lubricity agent.

42. The corrosion-inhibiting seal of claim 41 wherein the lubricity agent is selected from molybdenum disulfide, fluorinated hydrocarbons, perfluorinated hydrocarbons, graphite, soft metals, polymers, or combinations thereof.

43. The corrosion-inhibiting seal of claim 42 wherein the lubricity agent is the soft metal selected from tin, indium, silver, or combinations thereof.

44. The corrosion-inhibiting seal of claim 1 wherein the corrosion-inhibiting seal is colored.

45. The corrosion-inhibiting seal of claim 44 further comprising an agent which improves color-fastness of the corrosion-inhibiting seal.

46. The corrosion-inhibiting seal of claim 45 wherein the agent which improves color-fastness is selected from an active UV blocker, a passive UV blocker, a brightener, or a combination thereof.

47. The corrosion-inhibiting seal of claim 46 wherein the agent which improves color-fastness is the active UV blocker selected from carbon black, graphite, phthalocyanines, or combinations thereof.

48. The corrosion-inhibiting seal of claim 46 wherein the agent which improves color-fastness is the passive UV blocker selected from titanium oxide, tin oxide, lead oxide, silicon oxide, silicates, aluminosilicates, or combinations thereof.

49. The corrosion-inhibiting seal of claim 46 wherein the agent which improves color-fastness is the brightener selected from sulfonic acids, sulfonates, sulfonamides, sulfonic acids, sulfinates, sulfones, cyanides, nonionic surfactants, or combinations thereof.

50. The corrosion-inhibiting seal of claim 44 wherein the color is formed by a dye selected from vat dyes, mordant dyes, lake dyes, disperse dyes, azo dyes, triazine dyes, triphenylmethane dyes, azine dyes, formazan dyes, phthalocyanine dyes, Schiff Base dyes, naturally-occurring dyes, inorganic pigments, or combinations thereof.

51. The corrosion-inhibiting seal of claim 45 wherein the agent which improves color-fastness is an agent which prevents smudging.

52. The corrosion-inhibiting seal of claim 51 wherein the agent which prevents smudging is selected from phosphoric acid, metaphosphates, orthophosphates, pyrophosphates, polyphosphates, or combinations thereof.

53. The corrosion-inhibiting seal of claim 45 wherein the agent which improves color-fastness is a wetting agent.

54. The corrosion-inhibiting seal of claim 53 further comprising less than about 5 g/L of the wetting agent.

55. The corrosion-inhibiting seal of claim 53 wherein the wetting agent is a nonionic surfactant.

56. A method of making a corrosion-inhibiting sealing bath comprising:
providing a solvent;
providing a rare earth source wherein
the rare earth source is selected from a cerium source, a praseodymium source, a terbium source, or a combination thereof, and
at least one rare earth source is in the tetravalent oxidation state;
providing a valence stabilizer; and
combining the rare earth source and the valence stabilizer to form a rare earth/valence stabilizer complex.

57. The method of claim 56 wherein the solvent comprises water.

58. The method of claim 56 wherein
the cerium source is selected from a trivalent cerium source, a tetravalent cerium source, or a combination thereof;
the praseodymium source is selected from a trivalent praseodymium soure, a tetravalent praseodymium source, or a combination thereof; and
the terbium source is selected from a trivalent terbium source, a tetravalent terbium source, or a combination thereof.

59. The method of claim 56 further comprising oxidizing the rare earth source to form the at least one rare earth source in the tetravalent oxidation state.

60. The method of claim 59 wherein the rare earth source is oxidized by adding an oxidizer to the corrosion-inhibiting sealing bath.

61. The method of claim 60 wherein the oxidizer is a dissolved solid, a liquid, or a gas.

62. The method of claim 60 wherein the oxidizer is selected from peroxides, superoxides, persulfates, perborates, pernitrates, perphosphates, percarbonates, persilicates, peraluminates, pertitanates, perzirconates, permolybdates, pertungstates, pervanadates, organic peroxyacid derivatives, ozone, hypochlorites, chlorates, perchlorates, nitrates, nitrites, vanadates, iodates, hypobromites, chlorites, bromates, permanganates, periodates, dissolved oxygen, dissolved chlorine, dissolved fluorine, or combinations thereof.

63. The method of claim 59 wherein the rare earth source is oxidized by electrolysis.

64. The method of claim 56 wherein the cerium source is selected from cerium contained within a treated substrate, cerium (III) nitrate, cerium (III) sulfate, cerium (III) perchlorate, cerium (III) chloride, cerium (III) fluoride, cerium (III) bromide, cerium (III) iodide, cerium (III) bromate, cerium (III) fluosilicate, cerium (III) fluotitanate, cerium (III) fluozirconate, cerium (III) fluoborate, cerium (III) fluoaluminate, cerium (III) formate, cerium (III) acetate, cerium (III) propionate, cerium (III) butyrate, cerium (III) glycolate, cerium (III) lactate, cerium (III) sulfonate, cerium (III) alkyl sulfonate, cerium (III) alkoxysulfonate, cerium (III) aromatic sulfonate, cerium (III) aromatoxy sulfonate, cerium (III) sulfamate, cerium (III) alkyl phosphates, cerium (III) acetylacetonate, ammonium cerium (III) sulfate, ammonium cerium (III) nitrate, ammonium cerium (III) oxalate, magnesium cerium (III) sulfate, magnesium cerium (III) nitrate, alkali metal cerium (III) nitrate, alkali metal cerium (III) sulfate, cerium (III) carbonate, cerium (III) phosphate, cerium (III) sulfide, cerium (III) fluorocarbonate, cerium (III) benzoate, cerium (III) oxalate, cerium (III) malonate, cerium (III) tartrate, cerium (III) malate, cerium (III) citrate, cerium (III) thiocyanate, cerium (III) salicylate, cerium (III) oxide, cerium (III) hydroxide, cerium (IV) hydroxide species with a hydroxide content of less than or about 50%, cerium (IV) hydroxysulfate, cerium (IV) hydroxychloride, cerium (IV) hydroxynitrate, cerium (IV) hydroxyphosphate, cerium (IV) hydroxyperchlorate, cerium (IV) hydroxyacetate,cerium (IV) chloride, cerium (IV) fluoride, cerium (IV) perchlorate, cerium (IV) sulfate, cerium (IV) nitrate, cerium (IV) acetate, cerium (IV) propionate, cerium (IV) butyrate, ammonium cerium (IV) nitrate, ammonium cerium (IV) sulfate, magnesium cerium (IV) nitrate, magnesium cerium (IV) sulfate, alkali metal cerium (IV) nitrate, alkali metal cerium (IV) sulfate, bastnaesite, monazite, xenotime, loparite, lanthanite, rhabdophane, fergusonite, cebaite, aeschynite, lucasite, stillwellite, samarskite, parisite, gadolinite, fluocerite, cerianite, churchite, or combinations thereof.

65. The method of claim 56 wherein the praseodymium source is selected from praseodymium contained within a treated substrate, praseodymium nitrate, praseodymium sulfate, praseodymium perchlorate, praseodymium chloride, praseodymium fluoride, praseodymium bromide, praseodymium iodide, praseodymium bromate, praseodymium fluosilicate, praseodymium fluotitanate, praseodymium fluozirconate, praseodymium fluoborate, praseodymium fluoaluminate, praseodymium formate, praseodymium acetate, praseodymium propionate, praseodymium lactate, praseodymium benzenesulfonate, praseodymium acetylacetonate, ammonium praseodymium sulfate, ammonium praseodymium nitrate, magnesium praseodymium sulfate, magnesium praseodymium nitrate, alkali metal praseodymium nitrate, alkali metal praseodymium sulfate, bastnaesite, monazite, xenotime, loparite, lanthanite, rhabdophane, fergusonite, cebaite, aeschynite, lucasite, stillwellite, samarskite, parisite, gadolinite, fluocerite, cerianite, churchite, or combinations thereof.

66. The method of claim 56 wherein the terbium source is selected from terbium contained within a treated substrate, terbium nitrate, terbium sulfate, terbium perchlorate, terbium chloride, terbium fluoride, terbium bromide, terbium iodide, terbium bromate, terbium fluosilicate, terbium fluotitanate, terbium fluozirconate, terbium fluoborate, terbium fluoaluminate, terbium formate, terbium acetate, terbium propionate, terbium lactate, terbium benzenesulfonate, terbium acetylacetonate, ammonium terbium sulfate, ammonium terbium nitrate, magnesium terbium sulfate, magnesium terbium nitrate, alkali metal terbium nitrate, alkali metal terbium sulfate, bastnaesite, monazite, xenotime, loparite, lanthanite, rhabdophane, fergusonite, cebaite, aeschynite, lucasite, stillwellite, samarskite, parisite, gadolinite, fluocerite, cerianite, churchite, or combinations thereof.

67. The method of claim 56 wherein the valence stabilizer is selected from an inorganic valence stabilizer and an organic valence stabilizer.

68. The method of claim 56 further comprising adding a preparative agent to the corrosion-inhibiting sealing bath.

69. The method of claim 68 wherein the preparative agent is selected from fluorides, chlorides, bromides, acidic species, hydroxides, or combinations thereof.

70. The method of claim 69 wherein the preparative agent is a fluoride.

71. The method of claim 70 wherein the fluoride is selected from fluorozirconates, fluorotitanates, fluorosilicates, fluoroaluminates, fluoroborates, fluorogallates, fluoroindates, fluorogermanates, fluorostannates, fluorophosphates, fluoroarsenates, fluoroantimonates, fluorobismuthates, fluorosulfates, fluoroselenates, fluorotellurates, fluorocuprates, fluoroargentates, fluorozincates, fluorohafnates, fluorovanadates, fluoroniobates, fluorotantalates, fluoromolybdates, fluorotungstates, fluoroyttrates, fluorolanthanates, fluorocerates, fluoromanganates, fluoroferrates, fluoronickelates, fluorocobaltates, potassium fluoride, potassium hydrogen fluoride, sodium fluoride, sodium hydrogen fluoride, lithium fluoride, lithium hydrogen fluoride, ammonium fluoride, ammonium hydrogen fluoride, hydrofluoric acid, dissolved fluorine, organic fluorides, or combinations thereof.

72. The method of claim 69 wherein the preparative agent is an acidic species.

73. The method of claim 72 wherein the acidic species is selected from nitric acid, sulfuric acid, phosphoric acid, pyrophosphoric acid, hydrochloric acid, perchloric acid, hydrobromic acid, hydriodic acid, iodic acid, periodic acid, disulfuric acid, selenic acid, telluric acid, polyphosphoric acid, cyclophosphoric acid, phytic acid, boric acid, carboxylic acid, phosphonic acid, sulfonic acid, and acidic metal salts of titanium, zirconium, niobium, tantalum, molybdenum, tungsten, vanadium, aluminum, silicon, tin, antimony, bismuth, tellurium, yttrium, lanthanum, or combinations thereof.

74. The method of claim 56 further comprising providing a solubility control agent.

75. The method of claim 74 wherein the solubility control agent is selected from a cationic solubility control agent and an anionic solubility control agent.

76. The method of claim 75 wherein the solubility control agent is the cationic solubility control agent selected from H⁺; Li⁺; Na⁺; K⁺; Rb⁺; Cs⁺; NH₄⁺; Mg⁺²; Ca⁺²; Sr⁺²; Be⁺²; Ba⁺²; Y⁺³; La⁺³; Ce⁺³; Ce⁺⁴; Nd⁺³; Pr⁺³; Sc⁺³; Sm⁺³; Eu⁺³; Eu₊₂; Gd⁺³; Tb⁺³; Dy⁺³; Ho⁺³; Er⁺³; Tm⁺³; Yb⁺³; Lu⁺³; Ti⁺⁴; Zr⁺⁴; Ti⁺³; Hf⁺⁴; Nb⁺⁵; Ta⁺⁵; Nb⁺⁴; Ta⁺⁴; V⁺⁵; V⁺⁴, V⁺³, Mo⁺⁶; W⁺⁶; Mo⁺⁵; W⁺⁵; Mo⁺⁴; W⁺⁴, Cr⁺³; Mn⁺²; Mn⁺³; Mn⁺⁴; Fe⁺²; Fe⁺³; Co⁺²; Co⁺³; Ni⁺²; Ni⁺³; Ni⁺⁴; Ru⁺²; Ru⁺³; R⁺⁴; Rh⁺³; Ir⁺³; Rh⁺²; Ir⁺²; Pd⁺⁴; Pt⁺⁴; Pd⁺²; Pt⁺²; Os⁺⁴; Cu⁺; Cu⁺²; Cu⁺³; Ag⁺; Ag⁺²; Ag⁺³; Au⁺; Au⁺²; Au⁺³; Zn⁺²; Cd⁺²; Hg⁺; Hg⁺²; Al⁺³; Ga⁺³; Ga⁺; In⁺³; In⁺; Tl⁺³; Tl⁺; Ge⁺⁴; Ge⁺²; Sn⁺⁴; Sn⁺²; Pb⁺⁴; Pb⁺²; Sb⁺³; Sb⁺⁵; As⁺³; As⁺⁵; Bi⁺³; Bi⁺⁵; organic compounds containing at least one N⁺ site; organic compounds containing at least one phosphonium site; organic compounds containing at least one arsonium site; organic compounds containing at least one stibonium site; organic compounds containing at least one oxonium site; organic compounds containing at least one sulfonium site; organic compounds containing at least one selenonium site; organic compounds containing at least one iodonium site; quaternary ammonium compounds having a formula NR₄⁺, where R is an alkyl, aromatic, or acyclic organic constituent; or combinations thereof.

77. The method of claim 76 wherein the cationic solubility control agent is selected from H⁺; Li⁺; Na⁺; K⁺; Rb⁺; Cs⁺; NH₄⁺; Mg⁺²; Ca⁺²; Sr⁺²; Y⁺³; La⁺³; Ce⁺³; Ce⁺⁴; Nd⁺³; Pr⁺³; Sc⁺³; Sm⁺³; Eu⁺³; Eu₊₂; Gd⁺³; Tb⁺³; Dy⁺³; Ho⁺³; Er⁺³; Tm⁺³; Yb⁺³; Lu⁺³; Ti⁺⁴; Zr⁺⁴; Ti⁺³; Hf⁺⁴; Nb⁺⁵; Ta⁺⁵; Nb⁺⁴; Ta⁺⁴; Mo⁺⁶; W⁺⁶; Mo⁺⁵; W⁺⁵; Mo⁺⁴; W⁺⁴, Mn⁺²; Mn⁺³; Mn⁺⁴; Fe⁺²; Fe⁺³; Co⁺²; Co⁺³; Ru⁺²; Ru⁺³; R⁺⁴; Rh⁺³; Ir⁺³; Rh⁺²; Ir⁺²; Pd⁺⁴; Pt⁺⁴; Pd⁺²; Pt⁺²; Cu⁺; Cu⁺²; Cu⁺³; Ag⁺; Ag⁺²; Ag⁺³; Au⁺; Au⁺²; Au⁺³; Zn⁺²; Al⁺³; Ga⁺³; Ga⁺; In⁺³; In⁺; Ge⁺⁴; Ge⁺²; Sn⁺⁴; Sn⁺²; Sb⁺³; Sb⁺⁵; Bi⁺³; Bi⁺⁵; organic compounds containing at least one N⁺ site; organic compounds containing at least one phosphonium site; organic compounds containing at least one stibonium site; organic compounds containing at least one oxonium site; organic compounds containing at least one sulfonium site; organic compounds containing at least one iodonium site; quaternary ammonium compounds having a formula NR₄⁺, where R is an alkyl, aromatic, or acyclic organic constituent; or combinations thereof.

78. The method of claim 75 wherein the solubility control agent is the anionic solubility control agent selected from fluorotitanates, chlorotitanates, fluorozirconates, chlorozirconates, fluoroniobates, chloroniobates, fluorotantalates, chlorotantalates, molybdates, tungstates, permanganates, fluoromanganates, chloromanganates, fluoroferrates, chloroferrates, fluorocobaltates, chlorocobaltates, fluorozincates, chlorozincates, borates, fluoroborates, fluoroaluminates, chloroaluminates, carbonates, silicates, fluorosilicates, fluorostannates, nitrates, nitrites, azides, cyanamides, phosphates, phosphites, phosphonates, phosphinites, thiophosphates, thiophosphites, thiophosphonates, thiophosphinites, fluorophosphates, fluoroantimonates, chloroantimonates, sulfates, sulfites, sulfonates, thiosulfates, dithionites, dithionates, fluorosulfates, tellurates, fluorides, chlorides, chlorates, perchlorates, bromides, bromates, iodides, iodates, periodates, heteropolyanions, ferricyanides, ferrocyanides, cyanocobaltates, cyanocuprates, cyanomanganates, cyanates, cyanatoferrates, cyanatocobaltates, cyanatocuprates, cyanatomanganates, thiocyanates, thiocyanatoferrates, thiocyanatocobaltates, thiocyanatocuprates, thiocyanatomanganates, cyanamides, cyanamidoferrates, cyanamidocobaltates, cyanamidocuprates, cyanamidomanganates, nitritoferrates, nitritocobaltates, azides, (thio)carboxylates, di(thio)carboxylates, tri(thio)carboxylates, tetra(thio)carboxylates, (thio)phenolates, di(thio)phenolates, tri(thio)phenolates, tetra(thio)phenolates, (thio)phosphonates, di(thio)phosphonates, tri(thio)phosphonates, (thio)phosphonamides, di(thio)phosphonamides, tri(thio)phosphonamides, amino(thio)phosphonates, diamino(thio)phosphonates, triamino(thio)phosphonates, imino(thio)phosphonates, diimino(thio)phosphonates, (thio)sulfonates, di(thio)sulfonates, tri(thio)sulfonates, (thio)sulfonamides, di(thio)sulfonamides, tri(thio)sulfonamides, amino(thio)sulfonates, diamino(thio)sulfonates, triamino(thio)sulfonates, imino(thio)sulfonates, diimino(thio)sulfonates, (thio)borates, di(thio)borates, (thio)boronates, organic silicates, stibonates, cyanides, cyanochromates, cyanonickelates, cyanatochromates, cyanatonickelates, thiocyanatochromates, thiocyanatonickelates, cyanamidochromates, cyanamidonickelates, nitritonickelates, arsonates, diarsonates, triarsonates, organic selenates, diselenates, triselenates, arsenates, arsenites, fluoroarsenates, chloroarsenates, selenates, selenites, fluorothallates, chlorothallates, iodomercury anions, chloromercurates, bromomercurates, osmates, fluoronickelates, chromates, Reinecke's salt, vanadates, or combinations thereof.

79. The method of claim 78 wherein the anionic solubility control agent is selected from fluorotitanates, chlorotitanates, fluorozirconates, chlorozirconates, fluoroniobates, chloroniobates, fluorotantalates, chlorotantalates, molybdates, tungstates, permanganates, fluoromanganates, chloromanganates, fluoroferrates, chloroferrates, fluorocobaltates, chlorocobaltates, fluorozincates, chlorozincates, borates, fluoroborates, fluoroaluminates, chloroaluminates, carbonates, silicates, fluorosilicates, fluorostannates, nitrates, nitrites, azides, cyanamides, phosphates, phosphites, phosphonates, phosphinites, thiophosphates, thiophosphites, thiophosphonates, thiophosphinites, fluorophosphates, fluoroantimonates, chloroantimonates, sulfates, sulfites, sulfonates, thiosulfates, dithionites, dithionates, fluorosulfates, tellurates, fluorides, chlorides, chlorates, perchlorates, bromides, bromates, iodides, iodates, periodates, heteropolyanions, ferricyanides, ferrocyanides, cyanocobaltates, cyanocuprates, cyanomanganates, cyanates, cyanatoferrates, cyanatocobaltates, cyanatocuprates, cyanatomanganates, thiocyanates, thiocyanatoferrates, thiocyanatocobaltates, thiocyanatocuprates, thiocyanatomanganates, cyanamides, cyanamidoferrates, cyanamidocobaltates, cyanamidocuprates, cyanamidomanganates, nitritoferrates, nitritocobaltates, azides, (thio)carboxylates, di(thio)carboxylates, tri(thio)carboxylates, tetra(thio)carboxylates, (thio)phenolates, di(thio)phenolates, tri(thio)phenolates, tetra(thio)phenolates, (thio)phosphonates, di(thio)phosphonates, tri(thio)phosphonates, (thio)phosphonamides, di(thio)phosphonamides, tri(thio)phosphonamides, amino(thio)phosphonates, diamino(thio)phosphonates, triamino(thio)phosphonates, imino(thio)phosphonates, diimino(thio)phosphonates, (thio)sulfonates, di(thio)sulfonates, tri(thio)sulfonates, (thio)sulfonamides, di(thio)sulfonamides, tri(thio)sulfonamides, amino(thio)sulfonates, diamino(thio)sulfonates, triamino(thio)sulfonates, imino(thio)sulfonates, diimino(thio)sulfonates, (thio)borates, di(thio)borates, (thio)boronates, organic silicates, stibonates, or combinations thereof.

80. The method of claim 56 wherein the corrosion-inhibiting sealing bath has a concentration of cerium, praseodymium, or terbium of between a minimum concentration of about 1×10⁻⁴ moles/liter cerium, praseodymium, or terbium and a maximum concentration which is a maximum solubility of the cerium, praseodymium, or terbium source in the solvent at a temperature of the sealing bath.

81. The method of claim 60 wherein the corrosion-inhibiting sealing bath has a concentration of oxidizer of between a minimum concentration wherein a majority of the cerium, praseodymium, or terbium is oxidized to a tetravalent oxidation state and a maximum concentration which is the maximum solubility of the oxidizer in the solvent at a temperature of the sealing bath.

82. The method of claim 70 wherein the corrosion-inhibiting sealing bath has a concentration of preparative agent between a minimum concentration, wherein there is a fluoride-to-cerium, fluoride-to-praseodymium, or fluoride-to-terbium ratio of 0.05 and a maximum concentration, which is a maximum solubility of the preparative agent in the solvent at a temperature of the sealing bath.

83. The method of claim 72 wherein the corrosion-inhibiting sealing bath has a concentration of preparative agent between a minimum concentration, wherein there is an acidic species-to-cerium, acidic species-to-praseodymium, or acidic species-to-terbium ratio of 0.05 and a maximum concentration, which is a maximum solubility of the preparative agent in the solvent at a temperature of the sealing bath.

84. The method of claim 68 wherein the corrosion-inhibiting sealing bath has a concentration of the preparative agent of less than 5.0 M.

85. The method of claim 84 wherein the corrosion-inhibiting sealing bath has a concentration of the preparative agent of less than 0.5 M.

86. The method of claim 56 wherein the corrosion-inhibiting sealing bath has a concentration of valence stabilizer between a minimum concentration wherein there is a valence stabilizer-to-cerium, valence stabilizer-to-praseodymium, or valence stabilizer-to-terbium ratio of 0.010 and a maximum concentration which is a maximum solubility of the valence stabilizer in the solvent at a temperature of the sealing bath.

87. The method of claim 56 wherein the corrosion-inhibiting sealing bath has a pH of between about 0 and about 9.

88. The method of claim 87 wherein the corrosion-inhibiting sealing bath has a pH of between about 1 and about 8.

89. The method of claim 56 wherein the corrosion-inhibiting sealing bath has a temperature of between about 5° C. and about 100° C.

90. The method of claim 89 wherein the corrosion-inhibiting sealing bath has a temperature of between about 20° C. and about 50° C.

91. A method of applying a corrosion-inhibiting seal to a barrier film, comprising:
providing the barrier film to be treated;
contacting the barrier film with a first corrosion-inhibiting sealing bath comprising a first solvent and a rare earth source wherein
the rare earth source is selected from a cerium source, a praseodymium source, a terbium source, or a combination thereof, and
at least one rare earth source is in the tetravalent oxidation state; and contacting the barrier film with a valence stabilizer to form a seal comprising a rare earth/valence stabilizer complex.

92. The method of claim 91 wherein the valence stabilizer is added to the first corrosion-inhibiting sealing bath.

93. The method of claim 91 wherein the first solvent comprises water.

94. The method of claim 91 further comprising providing a second corrosion-inhibiting sealing bath comprising a second solvent and the valence stabilizer.

95. The method of claim 94 wherein the second solvent comprises water.

96. The method of claim 91 wherein the barrier film is a coating selected from oxides, hydroxides, phosphates, carbonates, oxalates, silicates, aluminates, borates, polymers, or combinations thereof.

97. The method of claim 91 wherein
the cerium source is selected from a trivalent cerium source, a tetravalent cerium source, or a combination thereof,
the praseodymium source is selected from a trivalent praseodymium source, a tetravalent praseodymium source, or a combination thereof, and
the terbium source is selected from a trivalent terbium source, a tetravalent terbium source, or a combination thereof.

98. The method of claim 91 further comprising oxidizing the rare earth source to form the at least one rare earth source in the tetravalent oxidation state.

99. The method of claim 98 wherein the rare earth source is oxidized in the first corrosion-inhibiting sealing bath.

100. The method of claim 98 wherein the rare earth source is oxidized in the seal.

101. The method of claim 98 wherein the rare earth source is oxidized by adding an oxidizer to the first corrosion-inhibiting sealing bath.

102. The method of claim 98 wherein the rare earth source is oxidized by electrolysis.

103. The method of claim 101 wherein the oxidizer is selected from a dissolved solid, a liquid, and a gas.

104. The method of claim 101 wherein the oxidizer is selected from peroxides, superoxides, persulfates, perborates, pernitrates, perphosphates, percarbonates, persilicates, peraluminates, pertitanates, perzirconates, permolybdates, pertungstates, pervanadates, organic peroxyacid derivatives, ozone, hypochlorites, chlorates, perchlorates, nitrates, nitrites, vanadates, iodates, hypobromites, chlorites, bromates, permanganates, periodates, dissolved oxygen, dissolved chlorine, dissolved fluorine, or combinations thereof.

105. The method of claim 91 wherein the cerium source is selected from cerium contained within a treated substrate, cerium (III) nitrate, cerium (III) sulfate, cerium (III) perchlorate, cerium (III) chloride, cerium (III) fluoride, cerium (III) bromide, cerium (III) iodide, cerium (III) bromate, cerium (III) fluosilicate, cerium (III) fluotitanate, cerium (III) fluozirconate, cerium (III) fluoborate, cerium (III) fluoaluminate, cerium (III) formate, cerium (III) acetate, cerum (III) propionate, cerium (III) butyrate, cerium (III) glycolate, cerium (III) lactate, cerium (III) sulfonate, cerium (III) alkyl sulfonate, cerium (III) alkoxysulfonate, cerium (III) aromatic sulfonate, cerium (III) aromatoxy sulfonate, cerium (III) sulfamate, cerium (III) alkyl phosphates, cerium (III) acetylacetonate, ammonium cerium (III) sulfate, ammonium cerium (III) nitrate, ammonium cerium (III) oxalate, magnesium cerium (III) sulfate, magnesium cerium (III) nitrate, alkali metal cerium (III) nitrate, alkali metal cerium (III) sulfate, cerium (III) carbonate, cerium (III) phosphate, cerium (III) sulfide, cerium (III) fluorocarbonate, cerium (III) benzoate, cerium (III) oxalate, cerium (III) malonate, cerium (III) tartrate, cerium (III) malate, cerium (III) citrate, cerium (III) thiocyanate, cerium (III) salicylate, cerium (III) oxide, cerium (III) hydroxide, cerium (IV) hydroxide species with a hydroxide content of less than or about 50%, cerium (IV) hydroxysulfate, cerium (IV) hydroxychloride, cerium (IV) hydroxynitrate, cerium (IV) hydroxyphosphate, cerium (IV) hydroxyperchlorate, cerium (IV) hydroxyacetate,cerium (IV) chloride, cerium (IV) fluoride, cerium (IV) perchlorate, cerium (IV) sulfate, cerium (IV) nitrate, cerium (IV) acetate, cerium (IV) propionate, cerium (IV) butyrate, ammonium cerium (IV) nitrate, ammonium cerium (IV) sulfate, magnesium cerium (IV) nitrate, magnesium cerium (IV) sulfate, alkali metal cerium (IV) nitrate, alkali metal cerium (IV) sulfate, bastnaesite, monazite, xenotime, loparite, lanthanite, rhabdophane, fergusonite, cebaite, aeschynite, lucasite, stillwellite, samarskite, parisite, gadolinite, fluocerite, cerianite, churchite, or combinations thereof.

106. The method of claim 91 wherein the praseodymium source is selected from praseodymium contained within a treated substrate, praseodymium nitrate, praseodymium sulfate, praseodymium perchlorate, praseodymium chloride, praseodymium fluoride, praseodymium bromide, praseodymium iodide, praseodymium bromate, praseodymium fluosilicate, praseodymium fluotitanate, praseodymium fluozirconate, praseodymium fluoborate, praseodymium fluoaluminate, praseodymium formate, praseodymium acetate, praseodymium propionate, praseodymium lactate, praseodymium benzenesulfonate, praseodymium acetylacetonate, ammonium praseodymium sulfate, ammonium praseodymium nitrate, magnesium praseodymium sulfate, magnesium praseodymium nitrate, alkali metal praseodymium nitrate, alkali metal praseodymium sulfate, bastnaesite, monazite, xenotime, loparite, lanthanite, rhabdophane, fergusonite, cebaite, aeschynite, lucasite, stillwellite, samarskite, parisite, gadolinite, fluocerite, cerianite, churchite, or combinations thereof.

107. The method of claim 91 wherein the terbium source is selected from terbium contained within a treated substrate, terbium nitrate, terbium sulfate, terbium perchlorate, terbium chloride, terbium fluoride, terbium bromide, terbium iodide, terbium bromate, terbium fluosilicate, terbium fluotitanate, terbium fluozirconate, terbium fluoborate, terbium fluoaluminate, terbium formate, terbium acetate, terbium propionate, terbium lactate, terbium benzenesulfonate, terbium acetylacetonate, ammonium terbium sulfate, ammonium terbium nitrate, magnesium terbium sulfate, magnesium terbium nitrate, alkali metal terbium nitrate, alkali metal terbium sulfate, bastnaesite, monazite, xenotime, loparite, lanthanite, rhabdophane, fergusonite, cebaite, aeschynite, lucasite, stillwellite, samarskite, parisite, gadolinite, fluocerite, cerianite, churchite, or combinations thereof.

108. The method of claim 91 wherein the valence stabilizer is selected from an inorganic valence stabilizer and an organic valence stabilizer.

109. The method of claim 91 wherein the barrier film is contacted with the first corrosion-inhibiting sealing bath by a process selected from immersion, spraying, fogging, wiping, and dipping.

110. The method of claim 94 wherein the barrier film is contacted with the second corrosion-inhibiting sealing bath by a process selected from immersion, spraying, fogging, wiping, and dipping.

111. The method of claim 91 further comprising adding a preparative agent to the first corrosion-inhibiting sealing bath.

112. The method of claim 111 wherein the preparative agent is selected from fluorides, chlorides, bromides, acidic species, hydroxides, or combinations thereof.

113. The method of claim 112 wherein the preparative agent is a fluoride.

114. The method of claim 113 wherein the fluoride is selected from fluorozirconates, fluorotitanates, fluorosilicates, fluoroaluminates, fluoroborates, fluorogallates, fluoroindates, fluorogermanates, fluorostannates, fluorophosphates, fluoroarsenates, fluoroantimonates, fluorobismuthates, fluorosulfates, fluoroselenates, fluorotellurates, fluorocuprates, fluoroargentates, fluorozincates, fluorohafnates, fluorovanadates, fluoroniobates, fluorotantalates, fluoromolybdates, fluorotungstates, fluoroyttrates, fluorolanthanates, fluorocerates, fluoromanganates, fluoroferrates, fluoronickelates, fluorocobaltates, potassium fluoride, potassium hydrogen fluoride, sodium fluoride, sodium hydrogen fluoride, lithium fluoride, lithium hydrogen fluoride, ammonium fluoride, ammonium hydrogen fluoride, hydrofluoric acid, dissolved fluorine, organic fluorides, or combinations thereof.

115. The method of claim 112 wherein the preparative agent is an acidic species.

116. The method of claim 115 wherein the acidic species is selected from nitric acid, sulfuric acid, phosphoric acid, pyrophosphoric acid, hydrochloric acid, perchloric acid, hydrobromic acid, hydriodic acid, iodic acid, periodic acid, disulfuric acid, selenic acid, telluric acid, polyphosphoric acid, cyclophosphoric acid, phytic acid, boric acid, carboxylic acid, phosphonic acid, sulfonic acid, and acidic metal salts of titanium, zirconium, niobium, tantalum, molybdenum, tungsten, vanadium, aluminum, silicon, tin, antimony, bismuth, tellurium, yttrium, lanthanum, or combinations thereof.

117. The method of claim 91 further comprising contacting the seal comprising the rare earth/valence stabilizer complex with a solubility control agent.

118. The method of claim 117 wherein the solubility control agent is added to the first corrosion-inhibiting sealing bath.

119. The method of claim 117 further comprising a second corrosion-inhibiting sealing bath comprising a second solvent, the valence stabilizer, and the solubility control agent.

120. The method of claim 119 wherein the second solvent is water.

121. The method of claim 117 wherein the solubility control agent is selected from a cationic solubility control agent and an anionic solubility control agent.

122. The method of claim 121 wherein the solubility control agent is a cationic solubility control agent selected from H⁺; Li⁺; Na⁺; K⁺; Rb⁺; Cs⁺; NH₄⁺; Mg⁺²; Ca⁺²; Sr⁺²; Be⁺²; Ba⁺²; Y⁺³; La⁺³; Ce⁺³; Ce⁺⁴; Nd⁺³; Pr⁺³; Sc⁺³; Sm⁺³; Eu⁺³; Eu₊₂; Gd⁺³; Tb⁺³; Dy⁺³; Ho⁺³; Er⁺³; Tm⁺³; Yb⁺³; Lu⁺³; Ti⁺⁴; Zr⁺⁴; Ti⁺³; Hf⁺⁴; Nb⁺⁵; Ta⁺⁵; Nb⁺⁴; Ta⁺⁴; V⁺⁵; V⁺⁴, V⁺³, Mo⁺⁶; W⁺⁶; Mo⁺⁵; W⁺⁵; Mo⁺⁴; W⁺⁴, Cr⁺³; Mn⁺²; Mn⁺³; Mn⁺⁴; Fe⁺²; Fe⁺³; Co⁺²; Co⁺³; Ni⁺²; Ni⁺³; Ni⁺⁴; Ru⁺²; Ru⁺³; R⁺⁴; Rh⁺³; Ir⁺³; Rh⁺²; Ir⁺²; Pd⁺⁴; Pt⁺⁴; Pd⁺²; Pt⁺²; Os⁺⁴; Cu⁺; Cu⁺²; Cu⁺³; Ag⁺; Ag⁺²; Ag⁺³; Au⁺; Au⁺²; Au⁺³; Zn⁺²; Cd⁺²; Hg⁺; Hg⁺²; Al⁺³; Ga⁺³; Ga⁺; In⁺³; In⁺; Tl⁺³; Tl⁺; Ge⁺⁴; Ge⁺²; Sn⁺⁴; Sn⁺²; Pb⁺⁴; Pb⁺²; Sb⁺³; Sb⁺⁵; As⁺³; As⁺⁵; Bi⁺³; Bi⁺⁵; organic compounds containing at least one N⁺ site; organic compounds containing at least one phosphonium site; organic compounds containing at least one arsonium site; organic compounds containing at least one stibonium site; organic compounds containing at least one oxonium site; organic compounds containing at least one sulfonium site; organic compounds containing at least one selenonium site; organic compounds containing at least one iodonium site; quarternary ammonium compounds having a formula of NR₄⁺, where R is an alkyl, aromatic, or acyclic organic constitutent; or combinations thereof.

123. The method of claim 122 wherein the cationic solubility control agent is selected from H⁺; Li⁺; Na⁺; K⁺; Rb⁺; Cs⁺; NH₄⁺; Mg⁺²; Ca⁺²; Sr⁺²; Y⁺³; La⁺³; Ce⁺³; Ce⁺⁴; Nd⁺³; Pr⁺³; Sc⁺³; Sm⁺³; Eu⁺³; Eu₊₂; Gd⁺³; Tb⁺³; Dy⁺³; Ho⁺³; Er⁺³; Tm⁺³; Yb⁺³; Lu⁺³; Ti⁺⁴; Zr⁺⁴; Ti⁺³; Hf⁺⁴; Nb⁺⁵; Ta⁺⁵; Nb⁺⁴; Ta⁺⁴; Mo⁺⁶; W⁺⁶; Mo⁺⁵; W⁺⁵; Mo⁺⁴; W⁺⁴, Mn⁺²; Mn⁺³; Mn⁺⁴; Fe⁺²; Fe⁺³; Co⁺²; Co⁺³; Ru⁺²; Ru⁺³; R⁺⁴; Rh⁺³; Ir⁺³; Rh⁺²; Ir⁺²; Pd⁺⁴; Pt⁺⁴; Pd⁺²; Pt⁺²; Cu⁺; Cu⁺²; Cu⁺³; Ag⁺; Ag⁺²; Ag⁺³; Au⁺; Au⁺²; Au⁺³; Zn⁺²; Cd⁺²; Al⁺³; Ga⁺³; Ga⁺; In⁺³; In⁺; Ge⁺⁴; Ge⁺²; Sn⁺⁴; Sn⁺²; Sb⁺³; Sb⁺⁵; Bi⁺³; Bi⁺⁵; organic compounds containing at least one N⁺ site; organic compounds containing at least one phosphonium site; organic compounds containing at least one stibonium site; organic compounds containing at least one oxonium site; organic compounds containing at least one sulfonium site; organic compounds containing at least one iodonium site; quarternary ammonium compounds having a formula of NR₄⁺, where R is an alkyl, aromatic, or acyclic organic constitutent; or combinations thereof.

124. The method of claim 121 wherein the solubility control agent is the anionic solubility control agent selected from fluorotitanates, chlorotitanates, fluorozirconates, chlorozirconates, fluoroniobates, chloroniobates, fluorotantalates, chlorotantalates, molybdates, tungstates, permanganates, fluoromanganates, chloromanganates, fluoroferrates, chloroferrates, fluorocobaltates, chlorocobaltates, fluorozincates, chlorozincates, borates, fluoroborates, fluoroaluminates, chloroaluminates, carbonates, silicates, fluorosilicates, fluorostannates, nitrates, nitrites, azides, cyanamides, phosphates, phosphites, phosphonates, phosphinites, thiophosphates, thiophosphites, thiophosphonates, thiophosphinites, fluorophosphates, fluoroantimonates, chloroantimonates, sulfates, sulfites, sulfonates, thiosulfates, dithionites, dithionates, fluorosulfates, tellurates, fluorides, chlorides, chlorates, perchlorates, bromides, bromates, iodides, iodates, periodates, heteropolyanions, ferricyanides, ferrocyanides, cyanocobaltates, cyanocuprates, cyanomanganates, cyanates, cyanatoferrates, cyanatocobaltates, cyanatocuprates, cyanatomanganates, thiocyanates, thiocyanatoferrates, thiocyanatocobaltates, thiocyanatocuprates, thiocyanatomanganates, cyanamides, cyanamidoferrates, cyanamidocobaltates, cyanamidocuprates, cyanamidomanganates, nitritoferrates, nitritocobaltates, azides, (thio)carboxylates, di(thio)carboxylates, tri(thio)carboxylates, tetra(thio)carboxylates, (thio)phenolates, di(thio)phenolates, tri(thio)phenolates, tetra(thio)phenolates, (thio)phosphonates, di(thio)phosphonates, tri(thio)phosphonates, (thio)phosphonamides, di(thio)phosphonamides, tri(thio)phosphonamides, amino(thio)phosphonates, diamino(thio)phosphonates, triamino(thio)phosphonates, imino(thio)phosphonates, diimino(thio)phosphonates, (thio)sulfonates, di(thio)sulfonates, tri(thio)sulfonates, (thio)sulfonamides, di(thio)sulfonamides, tri(thio)sulfonamides, amino(thio)sulfonates, diamino(thio)sulfonates, triamino(thio)sulfonates, imino(thio)sulfonates, diimino(thio)sulfonates, (thio)borates, di(thio)borates, (thio)boronates, organic silicates, stibonates, cyanides, cyanochromates, cyanonickelates, cyanatochromates, cyanatonickelates, thiocyanatochromates, thiocyanatonickelates, cyanamidochromates, cyanamidonickelates, nitritonickelates, arsonates, diarsonates, triarsonates, organic selenates, diselenates, triselenates, arsenates, arsenites, fluoroarsenates, chloroarsenates, selenates, selenites, fluorothallates, chlorothallates, iodomercury anions, chloromercurates, bromomercurates, osmates, fluoronickelates, chromates, Reinecke's salt, vanadates, or combinations thereof.

125. The method of claim 124 wherein the anionic solubility control agent is selected from fluorotitanates, chlorotitanates, fluorozirconates, chlorozirconates, fluoroniobates, chloroniobates, fluorotantalates, chlorotantalates, molybdates, tungstates, permanganates, fluoromanganates, chloromanganates, fluoroferrates, chloroferrates, fluorocobaltates, chlorocobaltates, fluorozincates, chlorozincates, borates, fluoroborates, fluoroaluminates, chloroaluminates, carbonates, silicates, fluorosilicates, fluorostannates, nitrates, nitrites, azides, cyanamides, phosphates, phosphites, phosphonates, phosphinites, thiophosphates, thiophosphites, thiophosphonates, thiophosphinites, fluorophosphates, fluoroantimonates, chloroantimonates, sulfates, sulfites, sulfonates, thiosulfates, dithionites, dithionates, fluorosulfates, tellurates, fluorides, chlorides, chlorates, perchlorates, bromides, bromates, iodides, iodates, periodates, heteropolyanions, ferricyanides, ferrocyanides, cyanocobaltates, cyanocuprates, cyanomanganates, cyanates, cyanatoferrates, cyanatocobaltates, cyanatocuprates, cyanatomanganates, thiocyanates, thiocyanatoferrates, thiocyanatocobaltates, thiocyanatocuprates, thiocyanatomanganates, cyanamides, cyanamidoferrates, cyanamidocobaltates, cyanamidocuprates, cyanamidomanganates, nitritoferrates, nitritocobaltates, azides, (thio)carboxylates, di(thio)carboxylates, tri(thio)carboxylates, tetra(thio)carboxylates, (thio)phenolates, di(thio)phenolates, tri(thio)phenolates, tetra(thio)phenolates, (thio)phosphonates, di(thio)phosphonates, tri(thio)phosphonates, (thio)phosphonamides, di(thio)phosphonamides, tri(thio)phosphonamides, amino(thio)phosphonates, diamino(thio)phosphonates, triamino(thio)phosphonates, imino(thio)phosphonates, diimino(thio)phosphonates, (thio)sulfonates, di(thio)sulfonates, tri(thio)sulfonates, (thio)sulfonamides, di(thio)sulfonamides, tri(thio)sulfonamides, amino(thio)sulfonates, diamino(thio)sulfonates, triamino(thio)sulfonates, imino(thio)sulfonates, diimino(thio)sulfonates, (thio)borates, di(thio)borates, (thio)boronates, organic silicates, stibonates, or combinations thereof.

126. The method of claim 91 wherein the first corrosion-inhibiting sealing bath has a concentration of cerium, praseodymium, or terbium of between a minimum concentration of about 1×10⁻⁴ moles/liter cerium, praseodymium, or terbium and a maximum concentration which is a maximum solubility of the cerium, praseodymium, or terbium source in the first solvent at a temperature of the sealing bath.

127. The method of claim 98 wherein the first corrosion-inhibiting sealing bath has a concentration of oxidizer between a minimum concentration wherein a majority of the cerium, praseodymium, or terbium is oxidized to a tetravalent oxidation state and a maximum concentration which is the maximum solubility of the oxidizer in the first solvent at a temperature of the sealing bath.

128. The method of claim 113 wherein the first corrosion-inhibiting sealing bath has a concentration of preparative agent between a minimum concentration, wherein there is a fluoride-to-cerium, fluoride-to-praseodymium, or fluoride-to-terbium ratio of 0.05 and a maximum concentration, which is a maximum solubility of the preparative agent in the first solvent at a temperature of the sealing bath.

129. The method of claim 115 wherein the first corrosion-inhibiting sealing bath has a concentration of preparative agent between a minimum concentration, wherein there is an acidic species-to-cerium, acidic species-to-praseodymium, or acidic species-to-terbium ratio of 0.05 and a maximum concentration, which is a maximum solubility of the preparative agent in the first solvent at a temperature of the sealing bath.

130. The method of claim 111 wherein the first corrosion-inhibiting sealing bath has a concentration of preparative agent of less than 5.0 M.

131. The method of claim 130 wherein the first corrosion-inhibiting sealing bath has a concentration of preparative agent of less than 0.5 M.

132. The method of claim 91 wherein the first corrosion-inhibiting sealing bath has a concentration of valence stabilizer between a minimum concentration wherein there is a valence stabilizer-to-cerium, valence stabilizer-to-praseodymium, or valence stabilizer-to-terbium ratio of 0.010 and a maximum concentration which is a maximum solubility of the valence stabilizer in the first solvent at a temperature of the sealing bath.

133. The method of claim 91 wherein the first corrosion-inhibiting sealing bath has a pH of between about 0 and about 9.

134. The method of claim 133 wherein the first corrosion-inhibiting sealing bath has a pH of between about 1 and about 8.

135. The method of claim 91 wherein the first corrosion-inhibiting sealing bath has a temperature of between about 5° C. and about 100° C.

136. The method of claim 135 wherein the first corrosion-inhibiting sealing bath has a temperature of between about 20° C. and about 50° C.

137. A corrosion-inhibiting seal for a barrier film comprising a rare earth element and a valence stabilizer combined to form a rare earth/valence stabilizer complex wherein
the rare earth element is selected from cerium, praseodymium, terbium, or combinations thereof,
at least one rare earth element is in the tetravalent oxidation state, and
the rare earth/valence stabilizer complex is sparingly soluble in water at about 25° C. and about 760 Torr.

138. A method of making a corrosion-inhibiting sealing bath comprising:
providing a solvent;
providing a rare earth source wherein
the rare earth source is selected from a cerium source, a praseodymium source, a terbium source, or a combination thereof, and
at least one rare earth source is in the tetravalent oxidation state;
providing a valence stabilizer; and
combining the rare earth source and the valence stabilizer to form a rare earth/valence stabilizer complex, wherein the rare earth/valence stabilizer complex is sparingly soluble in water at about 25° C. and about 760 Torr.

139. A method of applying a corrosion-inhibiting seal to a barrier film comprising:
providing the barrier film to be treated;
contacting the barrier film with a first corrosion-inhibiting sealing bath comprising a first solvent and a rare earth source wherein
the rare earth source is selected from a cerium source, a praseodymium source, a terbium source, or a combination thereof, and
at least one rare earth source is in the tetravalent oxidation state; and
contacting the barrier film with a valence stabilizer to form a seal comprising a rare earth/valence stabilizer complex, wherein the rare earth/valence stabilizer complex is sparingly soluble in water at about 25° C. and about 760 Torr.
